(19) United States
(12) Patent Application Publication
(10) Pub. No.: US 2026/0219761 A1
(43) Pub. Date: Jul. 30, 2026

(54) METHODS FOR VIRTUAL OBJECT MANIPULATIONS IN A VIRTUAL ENVIRONMENT

(71) Applicant: Apple Inc., Cupertino, CA (US)

(72) Inventors: Yiyao NIE, Santa Clara, CA (US); Christopher D. MCKENZIE, Burlingame, CA (US); Evgenii KRIVORUCHKO, San Francisco, CA (US); Rosha S. D SOUZA, Sunnyvale, CA (US)

(21) Appl. No.: 19/327,871

(22) Filed: Sep. 12, 2025

Related U.S. Application Data
(60) Provisional application No. 63/700,645, filed on Sep. 28, 2024.
(60) Provisional application No. 63/819,716, filed on Jun. 7, 2025.

(51) Int. Cl. G06F 3/04815; G06F 3/01; G06T 19/20

(52) U.S. Cl. CPC G06F 3/04815; G06F 3/017; G06T 19/20; G06T 2200/24; G06T 2219/2016

(57) ABSTRACT

In some embodiments, a computer system moves a virtual object in response to input. The computer system can display feedback indicating a location of an input. The computer system can transition a manipulation point between the input and an object center, use different object behaviors based on virtual parameters, pass control of the virtual object between a first input and a second input, and/or move the virtual object based on a grabbing region and a position of the input. The computer system can move the virtual object to a resting pose based on a resting behavior. The computer system can generate audio output corresponding to an object manipulation event. The computer system can move virtual object(s) based on a pivot point associated with attention of a user. The virtual object can rotate based on a translation movement of a first input element and a second input element.

### CROSS REFERENCE TO RELATED APPLICATIONS

This application claims the benefit of U.S. Provisional Application No. 63/819,716, filed Jun. 7, 2025, and U.S. Provisional Application No. 63/700,645, filed Sep. 28, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with virtual objects in a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays a virtual object, including moving the virtual object, in response to input. In some embodiments, the computer system displays visual feedback indicating a location of the input element. In some embodiments, moving the virtual object includes transitioning a manipulation point between the input and an object center of the virtual object, different object behaviors based on virtual parameters associated with the virtual object, passing control over the movement of the virtual object between a first input (e.g., a right hand) and a second input (e.g., a left hand), and/or moving the virtual object with respect to a grabbing region of the virtual object and a position of the input. In some embodiments, the computer system moves the virtual object to a respective resting pose that is based on a designated resting behavior of the virtual object. In some embodiments, a computer system generates an audio output corresponding to a respective object manipulation event. In some embodiments, a computer system moves a virtual object relative to a pivot point that is located based on attention of a user of the computer system relative to the virtual object. In some embodiments, a computer system rotates a virtual object in accordance with a translation movement of a first input element and a second input element.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the FIGS.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7CK illustrate exemplary ways in which a computer system facilitates manipulation of virtual objects in a three-dimensional environment in accordance with some embodiments.

FIG. 8 is a flowchart illustrating an exemplary method of displaying visual feedback indicating location of an input element in accordance with some embodiments.

FIG. 9 is a flowchart illustrating an exemplary method of gradually transitioning a manipulation point of a virtual object to an input element in accordance with some embodiments.

FIG. 10 is a flowchart illustrating an exemplary method of implementing different translation behaviors for virtual objects based on a value of a virtual parameter in accordance with some embodiments.

FIG. 11 is a flowchart illustrating an exemplary method of passing control of virtual objects to multiple input elements in accordance with some embodiments.

FIG. 12 is a flowchart illustrating an exemplary method of implementing selection regions for a virtual object in accordance with some embodiments.

FIG. 13 is a flowchart illustrating an exemplary method of moving a virtual object to a respective resting pose in accordance with some embodiments.

FIGS. 14A-14N illustrate exemplary ways in which a computer system moves virtual objects relative to a three-dimensional environment in accordance with some embodiments.

FIGS. 15A-15I illustrate examples of a computer system generating an audio output corresponding to a respective type of object manipulation event that is associated with spatial manipulation of a virtual object, in accordance with some embodiments.

FIG. 16 is a flowchart illustrating a method of generating an audio output corresponding to a respective object manipulation event in accordance with some embodiments.

FIGS. 17A-17K illustrate exemplary ways in which a computer system moves virtual objects relative to a pivot point defined based on attention of a user in accordance with some embodiments.

FIG. 18 is a flowchart illustrating an exemplary method of moving virtual objects relative to a pivot point defined based on attention of a user in accordance with some embodiments.

FIGS. 19A-19AN illustrate examples of a computer system applying transformations to a virtual object based on movement of one or more input elements, in accordance with some embodiments.

FIG. 20 is a flowchart illustrating an exemplary method of applying transformations to a virtual object based on movement of one or more input elements, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays visual feedback when an input element is near a virtual object. In some embodiments, while displaying, via the one or more display generation components, a first virtual object at a first location in a three-dimensional environment, the computer system detects, via the one or more input devices, that an input element satisfies one or more criteria, including a criterion that is satisfied when the input element is within a threshold distance of the first virtual object. In some embodiments, in response to detecting that the input element satisfies the one or more criteria, the computer system displays, via the one or more display generation components, visual feedback separate from a visual representation of the input element, wherein the visual feedback indicates a location of the input element relative to the first virtual object in the three-dimensional environment. In some embodiments, while displaying the visual feedback indicating the location of the input element relative to the first virtual object in the three-dimensional environment, the computer system detects movement of the input element relative to the first location in the three-dimensional environment. In some embodiments, in response to detecting the movement of the input element relative to the first location in the three-dimensional environment: in accordance with a determination that the input element did not perform a selection input directed to the first virtual object prior to the movement of the input element and continues to meet the one or more criteria, the computer system moves the visual feedback relative to the first virtual object in accordance with the movement of the input element without moving the first virtual object in the three-dimensional environment, wherein the visual feedback moves differently from movement of the visual representation of the input element. In some embodiments, in accordance with a determination that the input element performed a selection input directed to the first virtual object prior to the movement of the input element, the computer system moves the first virtual object in the three-dimensional environment in accordance with the movement of the input element.

In some embodiments, a computer system gradually transitions a manipulation point of a virtual object to an input element when moving a virtual object in response to movement of the input element. In some embodiments, while displaying, via the one or more display generation components, a virtual object within a three-dimensional environment, the computer system detects, via the one or more input devices, a first input provided by an input element, wherein a center of movement associated with the virtual object and an input center associated with the input element are separated by a first distance when a first portion of the first input is detected. In some embodiments, while detecting, via the one or more input devices, a second portion of the first input, after the first portion of the first input, that includes movement of the input element, in accordance with a determination that the movement of the input element satisfies one or more first criteria, as the input center associated with the input element moves, the computer system moves the virtual object relative to the input center associated with the input element in a manner that is selected so as to reduce a distance between the center of movement of the virtual object and the input center associated with the input element to less than the first distance.

In some embodiments, a computer system implements different translations behaviors for virtual object based on a virtual parameter associated with the virtual object. In some embodiments, while displaying, via the one or more display generation components, a virtual object in an environment, and while the virtual object is being controlled based on detected movement of an input element, the computer system detects, via the one or more input devices, movement of the input element. In some embodiments, in response to detecting the movement of the input element, the computer system moves the virtual object within the environment in accordance with the movement of the input element, including in accordance with a determination that the virtual object has a first value of a respective virtual parameter, moving the virtual object in a first manner in accordance with the movement of the input element; and in accordance with a determination that the virtual object has a second value of the respective virtual parameter, wherein the second value of the respective virtual parameter is different from the first value of the respective virtual parameter, moving the virtual object in a second manner in accordance with the movement of the input element, wherein the movement in the second manner is different from the movement in the first manner.

In some embodiments, a computer system transfers control of movement of a virtual object from a first input element to a second input element in response to the second input element meeting a handoff criterion. In some embodiments, while displaying, via the one or more display generation components, a virtual object in a three-dimensional environment, and while the virtual object is selected by a first input element, the computer system detects, via the one or more input devices, movement of the first input element. In some embodiments, in response to detecting the movement of the first input element, the computer system moves the virtual object in accordance with movement of the first input element. In some embodiments, in response to detecting the movement of the first input elements, after moving the virtual object in accordance with the movement of the first input element, the computer system detects, via the one or more input devices, a selection input by a second input element, different from the first input element. In some embodiments, after detecting the selection input by the second input element, the computer system detects movement of the second input element. In some embodiments, in response to detecting movement of the second input element, in accordance with a determination that the selection input by the second input element satisfies one or more handoff criteria for handoff of the virtual object between the first input element and the second input element, including a criterion that is satisfied when the selection input by the second input element was detected before selection of the virtual object by the first input element ended, the computer system moves the virtual object in accordance with movement of the second input element.

In some embodiments, a computer system utilizes one or more selection regions associated with a virtual object as centers of movement when moving a virtual object in a three-dimensional environment. In some embodiments, while displaying, via the one or more display generation components, a virtual object in a three-dimensional environment, the computer system detects, via the one or more input devices, a selection input directed to the virtual object. In some embodiments, in response to detecting the selection input, in accordance with a determination that the selection input is directed to a first portion of a selection region of the virtual object, the computer system uses a first point as a center of movement for controlling subsequent movement of the virtual object. In some embodiments, in response to detecting the selection input, in accordance with a determination that the selection input is directed to a second portion of the selection region of the virtual object, wherein the second portion of the selection region of the virtual object is different from the first portion of the selection region of the virtual object, the computer system uses a second point, different from the first point, as the center of movement for controlling subsequent movement of the virtual object.

In some embodiments, while displaying, via one or more display generation components, a virtual object, and while movement of the virtual object within a three-dimensional environment is controlled by movement of an input element, a computer system detects, via one or more input devices, an end of a first input associated with the input element. In some embodiments, in response to detecting the end of the first input, the computer system ceases control of the virtual object by the input element. In some embodiments, ceasing control of the virtual object by the input element includes, in accordance with a determination that the virtual object is designated as having a first resting behavior, moving the virtual object to a first resting pose in the three-dimensional environment after the end of the first input. In some embodiments, ceasing control of the virtual object by the input element includes, in accordance with a determination that the virtual object is designated as having a second resting behavior, different from the first resting behavior, moving the virtual object to a second resting pose, different from the first resting pose, in the three-dimensional environment after detecting the end of the first input.

In some embodiments, while displaying, via one or more display generation components, a first virtual object that can be spatially manipulated in a three-dimensional environment based on movement of a portion of a user of a computer system, the computer system detects, via one or more input devices, a first input directed to the first virtual object. In some embodiments, in response to detecting the first input, in accordance with a determination that the first input corresponds to a first type of object manipulation event that is associated with spatial manipulation of the first virtual object, the computer system performs a first operation associated with the first virtual object. In some embodiments, in response to detecting the first input, in accordance with a determination that the first input corresponds to a first type of object manipulation event that is associated with spatial manipulation of the first virtual object, the computer system generates, via one or more audio output devices, a first audio output corresponding to the first type of object manipulation event that is associated with spatial manipulation of the first virtual object. In some embodiments, in response to detecting the first input, in accordance with a determination that the first input corresponds to a second type of object manipulation event that is associated with spatial manipulation of the first virtual object, different from the first type of object manipulation event, the computer system performs a second operation associated with the first virtual object, different from the first operation. In some embodiments, in response to detecting the first input, in accordance with a determination that the first input corresponds to a second type of object manipulation event that is associated with spatial manipulation of the first virtual object, different from the first type of object manipulation event, the computer system generates, via the one or more audio output devices, a second audio output, different from the first audio output, corresponding to the second type of object manipulation event that is associated with spatial manipulation of the first virtual object.

In some embodiments, a computer system detects an input including movement. In some embodiments, the computer system moves the virtual object in accordance with a respective pivot point. In some embodiments, in accordance with a determination that attention of a user of the computer system is directed to a first location in the three-dimensional environment when the input is detected, the computer system moves the virtual object in accordance with the movement of the input and in accordance with a first pivot point that corresponds to the first location. In some embodiments, in accordance with a determination that attention of the user of the computer system is directed to a second location in the three-dimensional environment when the input is detected, the computer system moves the virtual object in accordance with the movement of the input and in accordance with a second pivot point that corresponds to the second location.

In some embodiments, while displaying, via the one or more display generation components, a first virtual object in a three-dimensional environment, a computer system detects, via the one or more input devices, a first input directed to the first virtual object, wherein the first input includes concurrent input from a first input element and a second input element that is different from the first input element. In some embodiments, in response to detecting the first input, in accordance with a determination that the first input includes translation movement of the first input element and the second input element corresponding to a translation input that has a first magnitude, the computer system rotates the first virtual object by a first amount in accordance with the translation movement of the first input element and the second input element. In some embodiments, in response to detecting the first input, in accordance with a determination that the first input includes translation movement of the first input element and the second input element corresponding to a translation input that has a second magnitude, different from the first magnitude, the computer system rotates the first virtual object by a second amount, different from the first amount, in accordance with the translation movement of the first input element and the second input element.

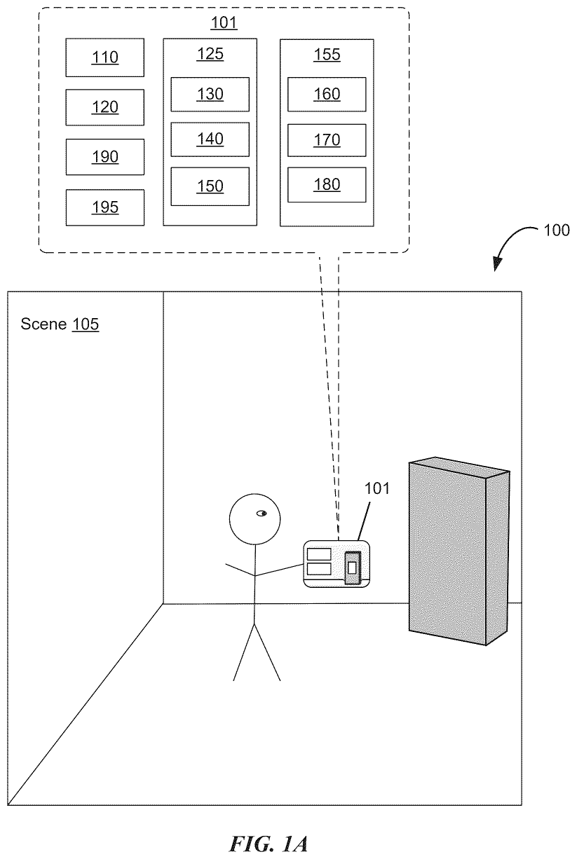

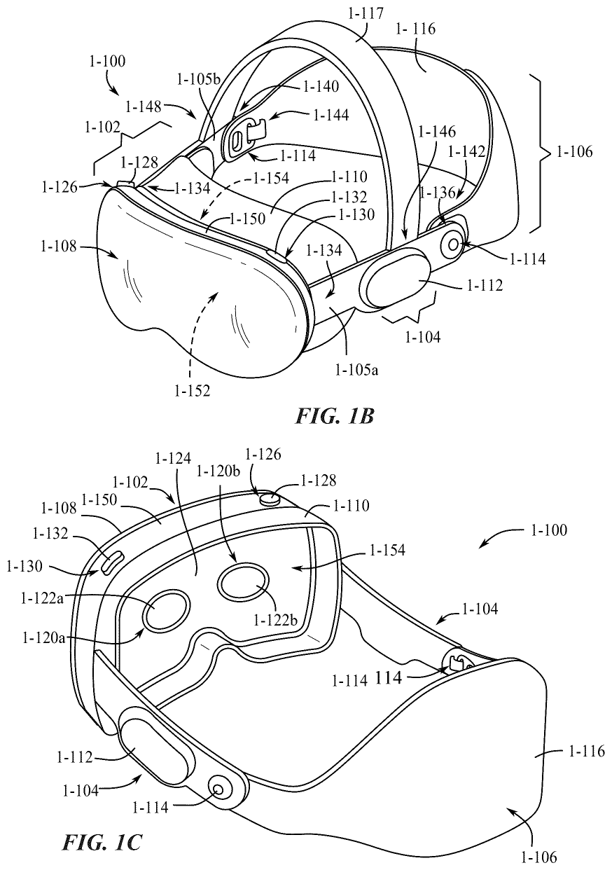

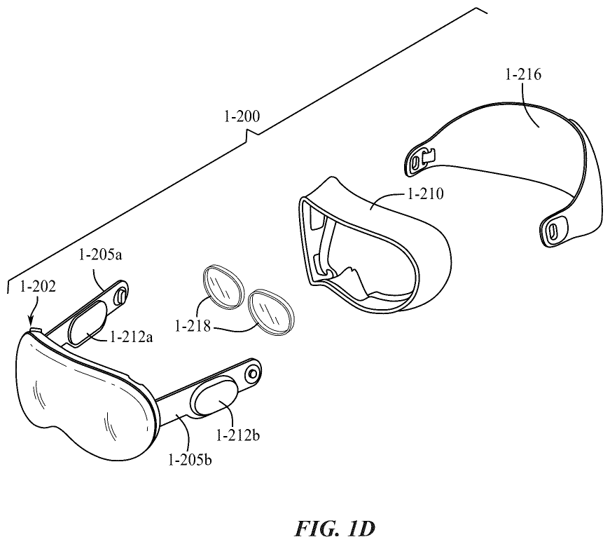

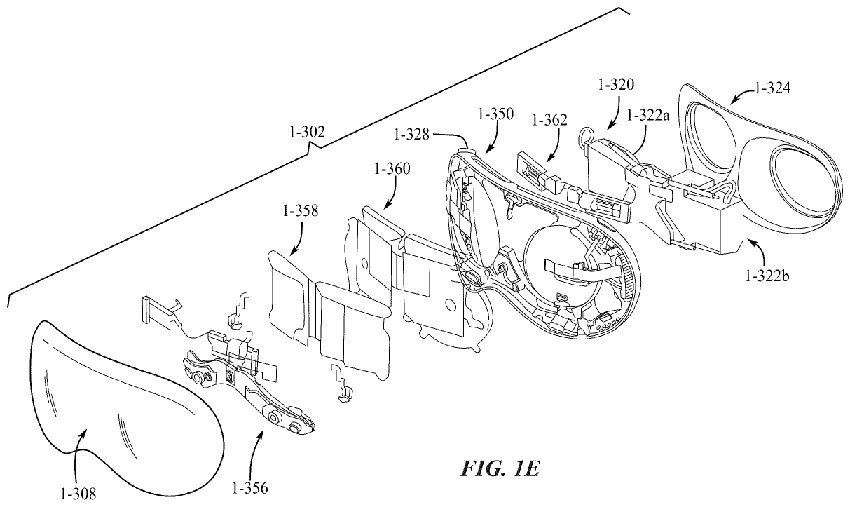

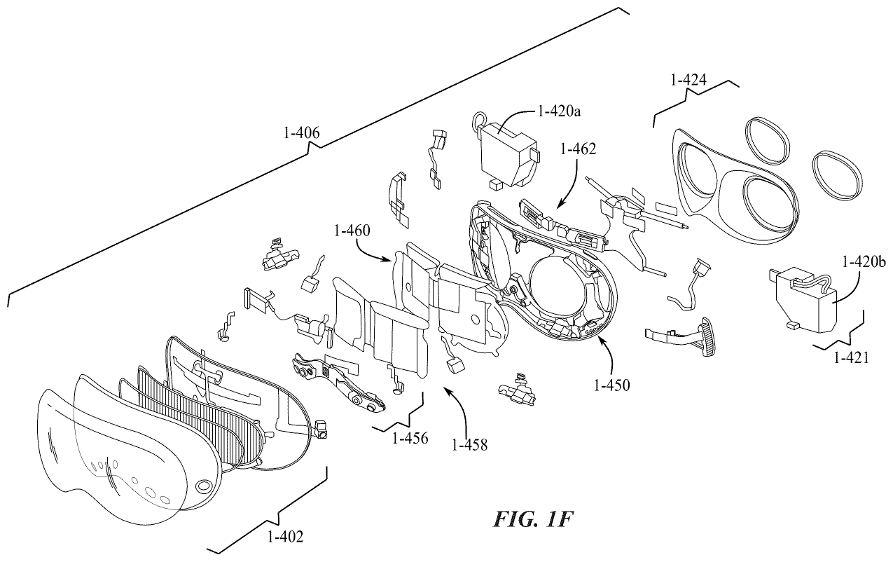

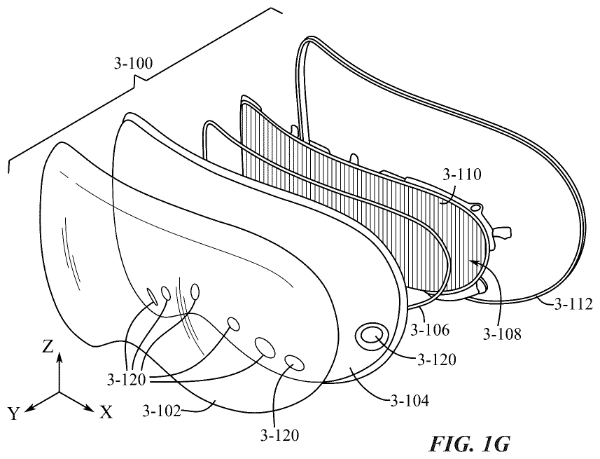

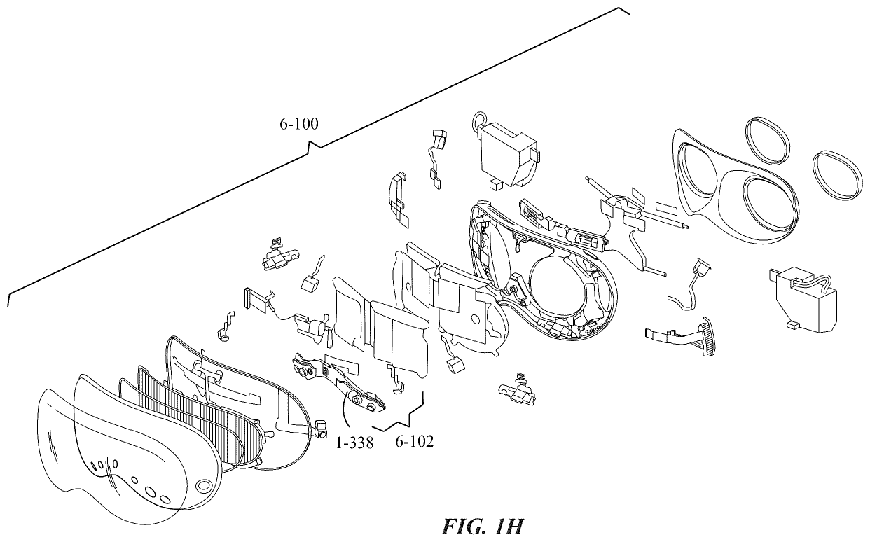

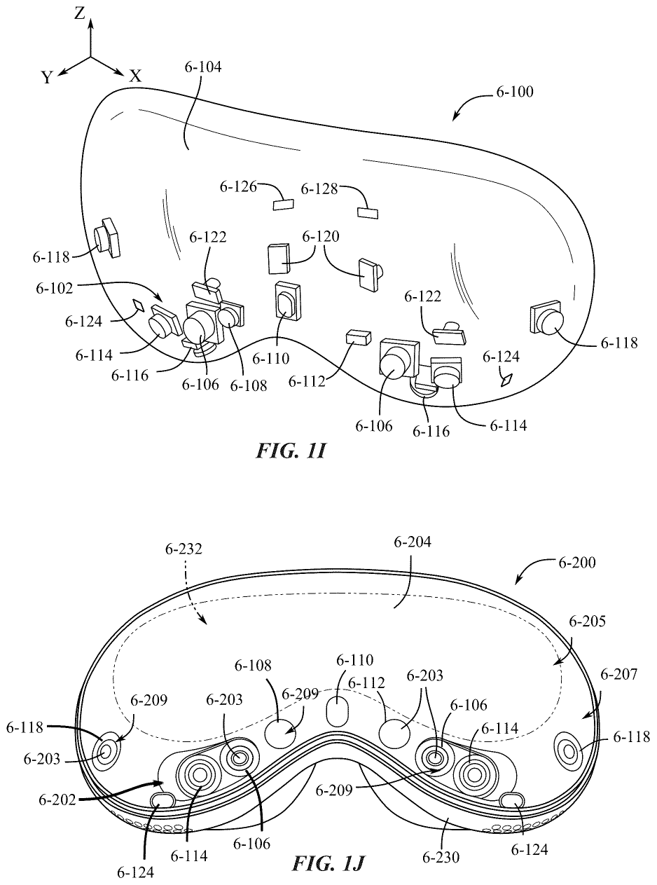

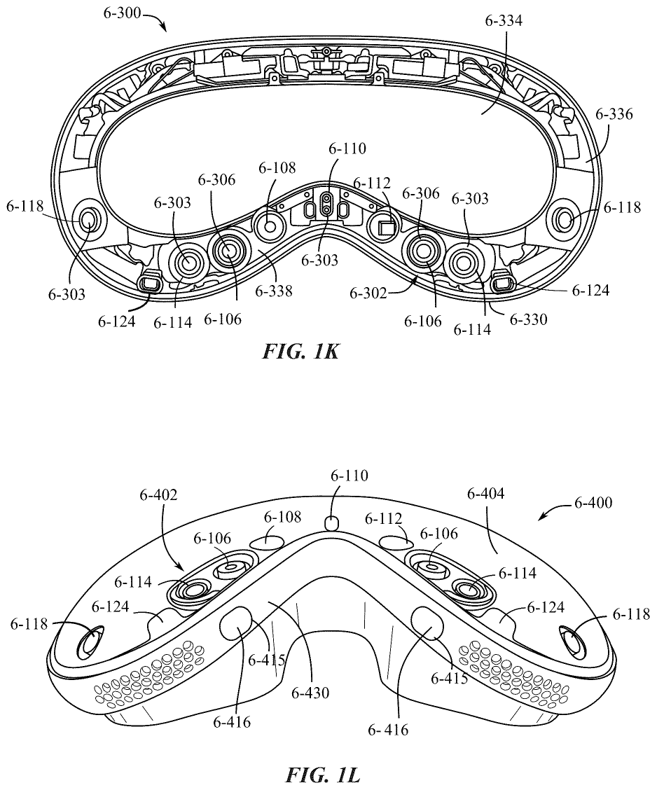

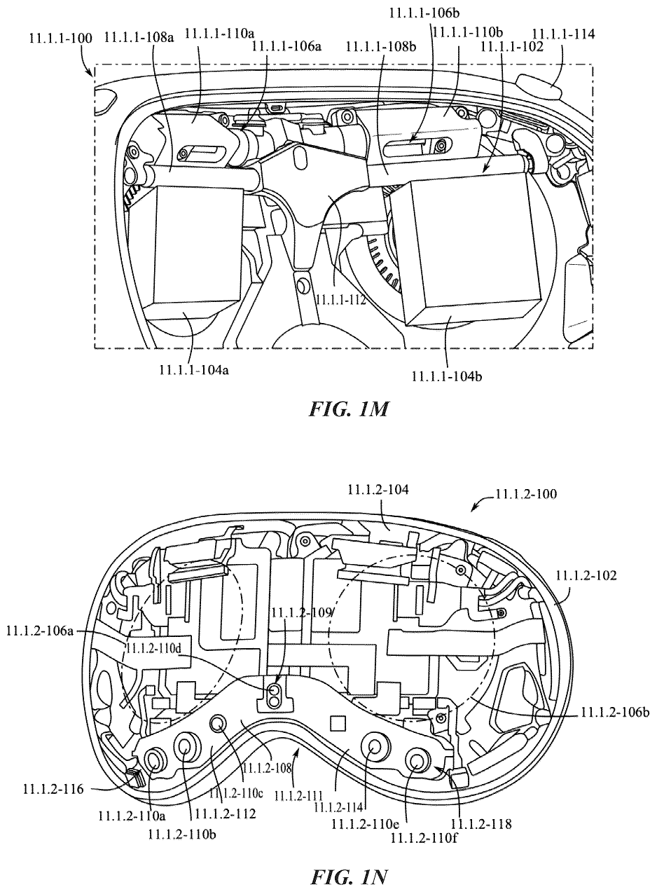

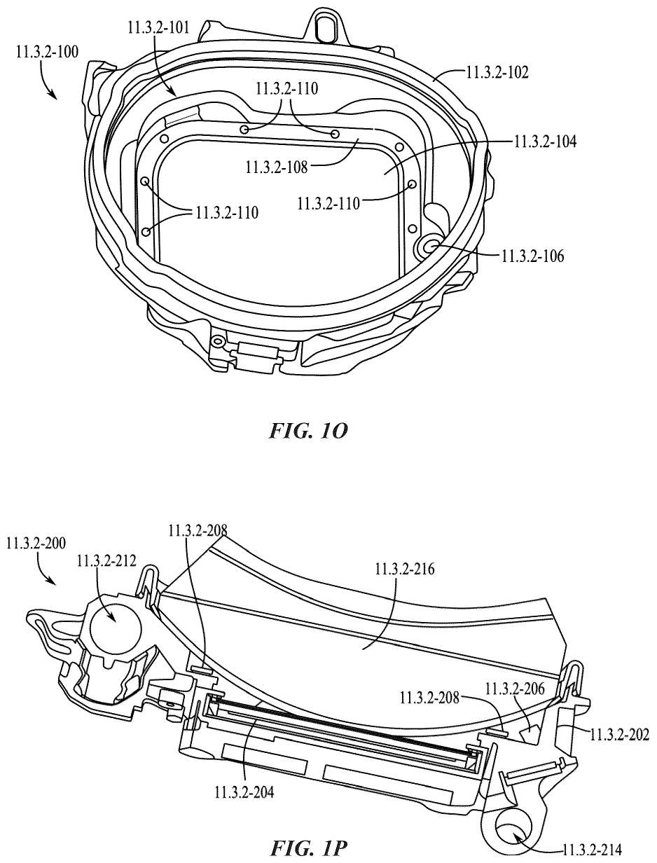

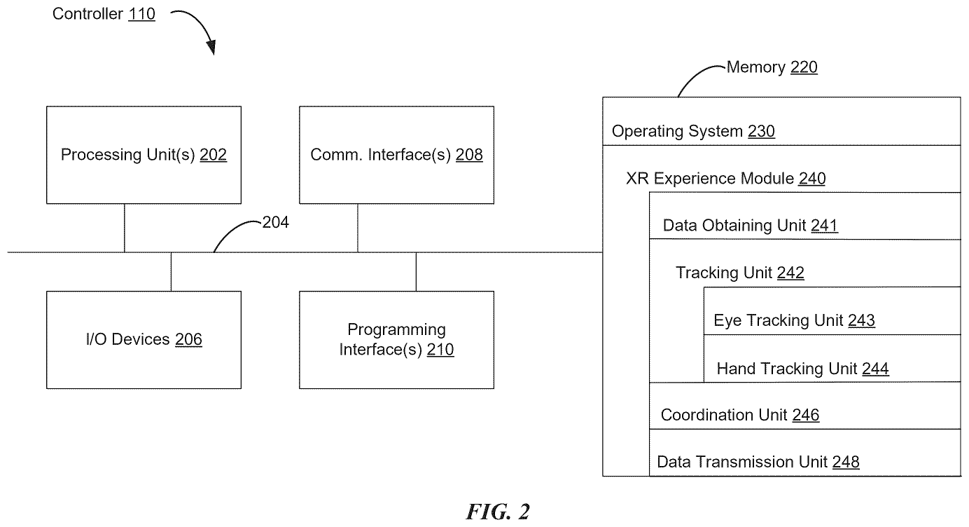

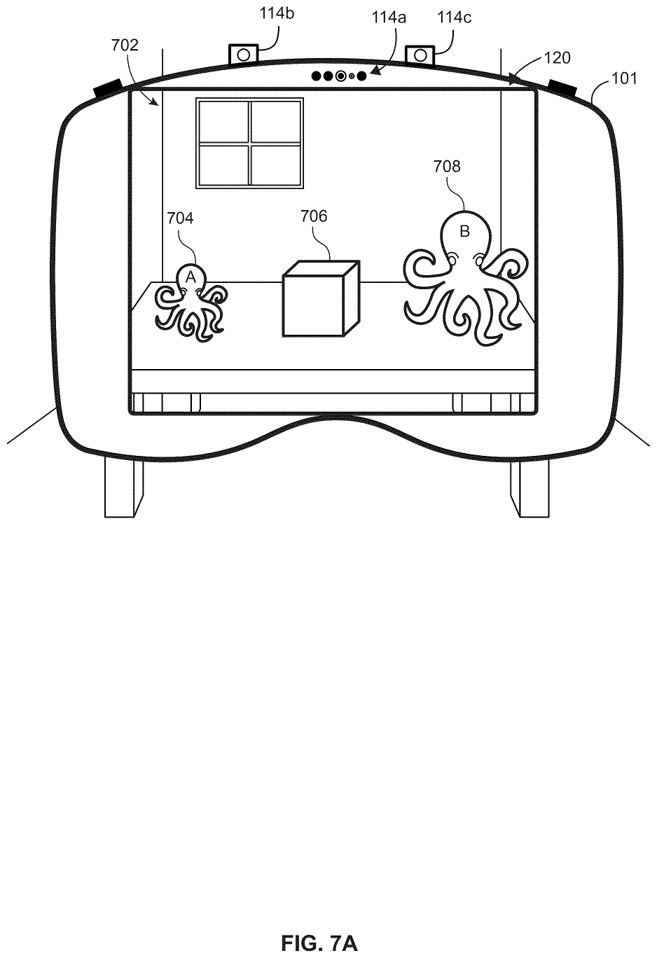

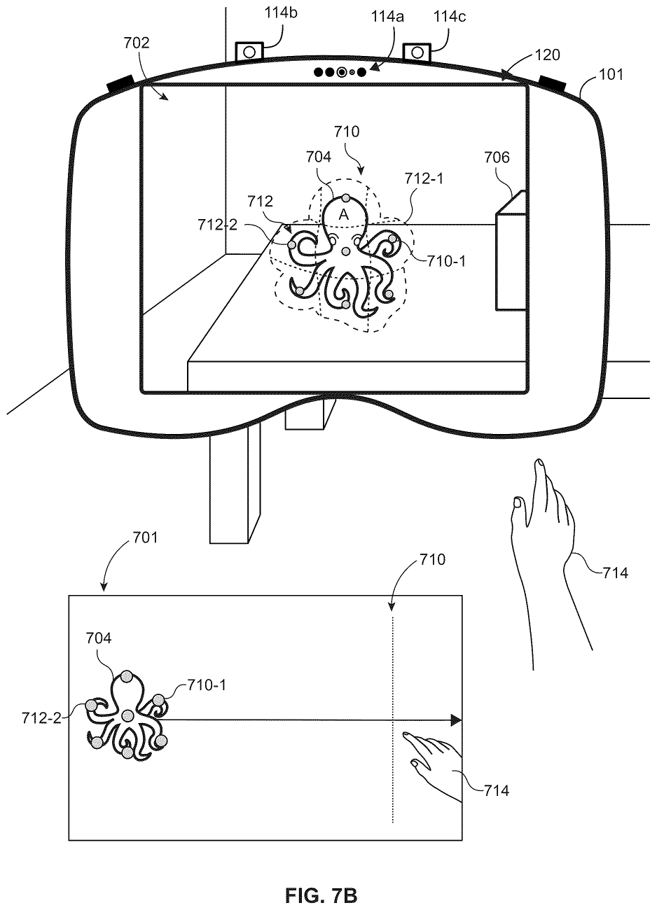

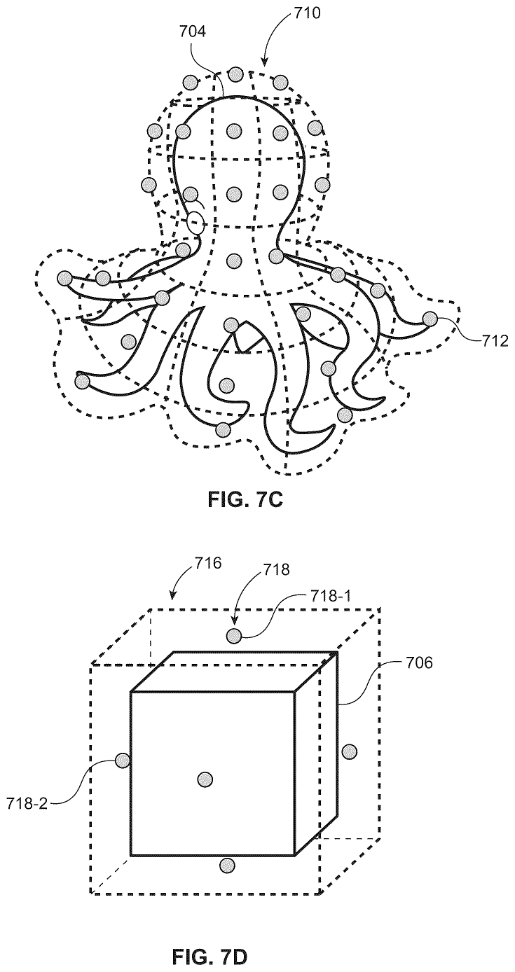

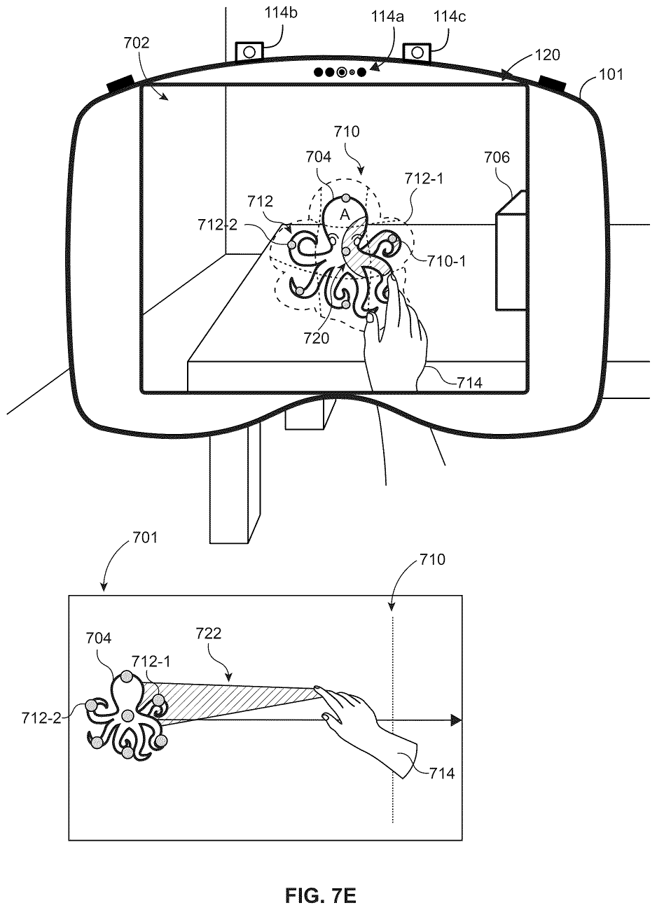

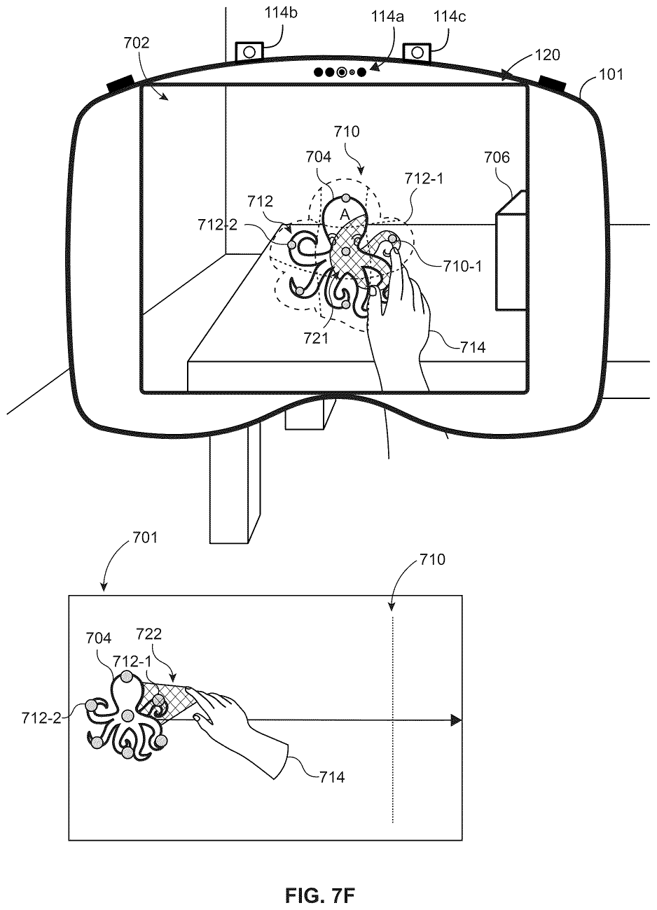

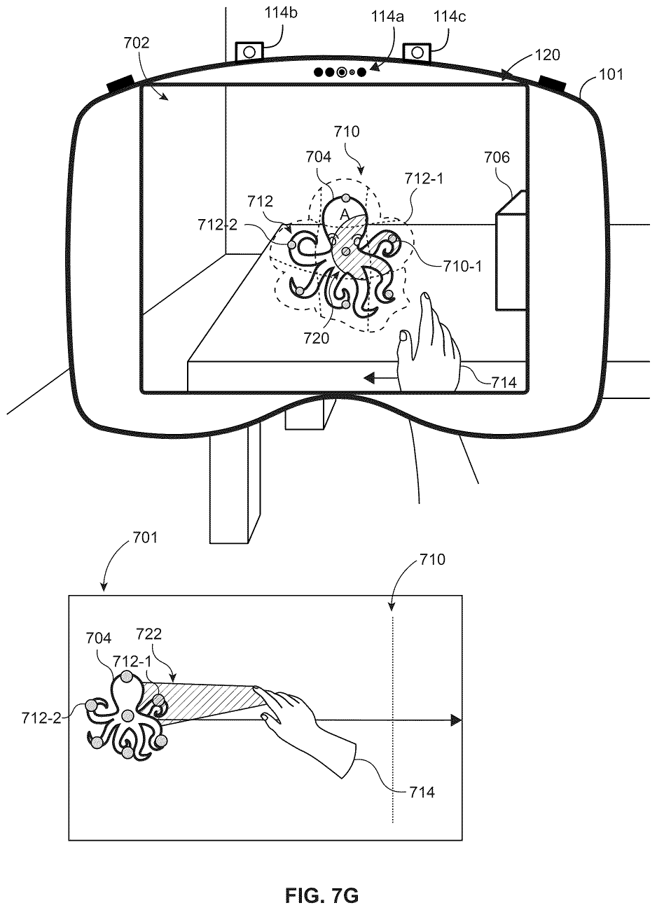

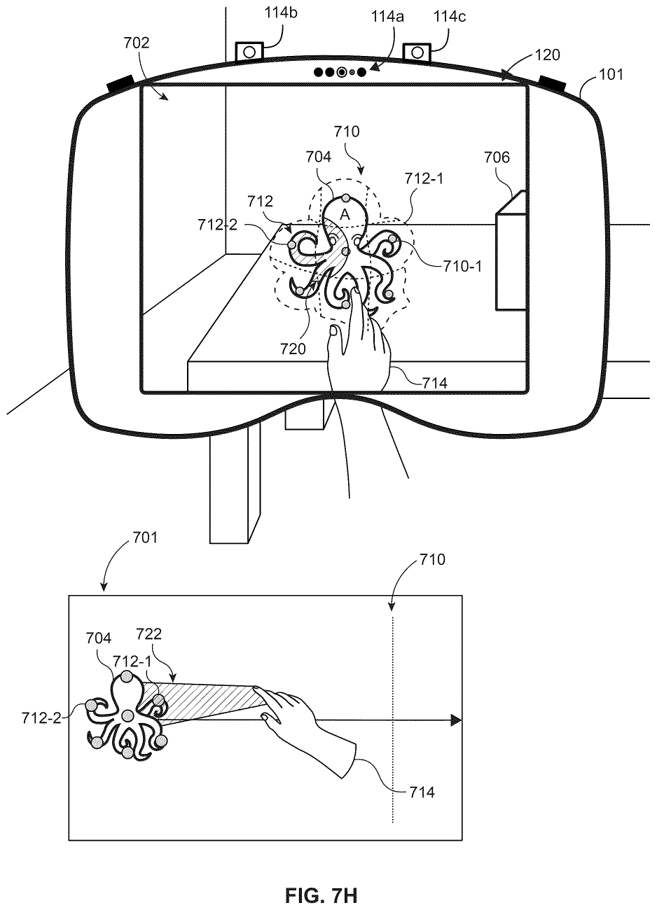

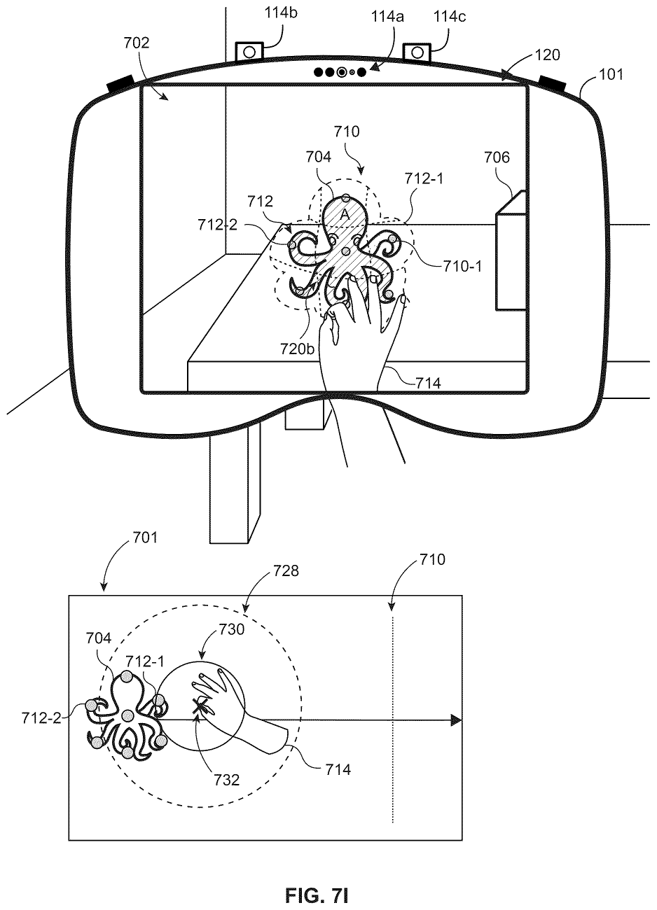

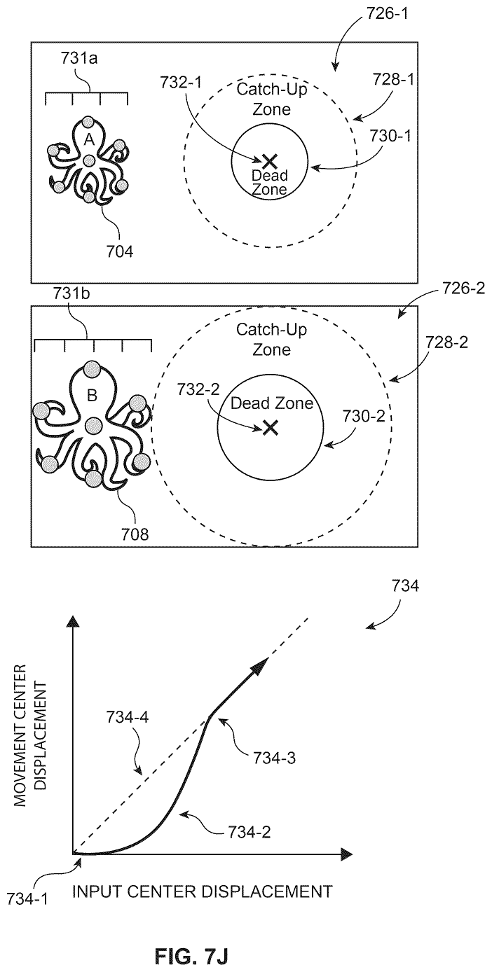

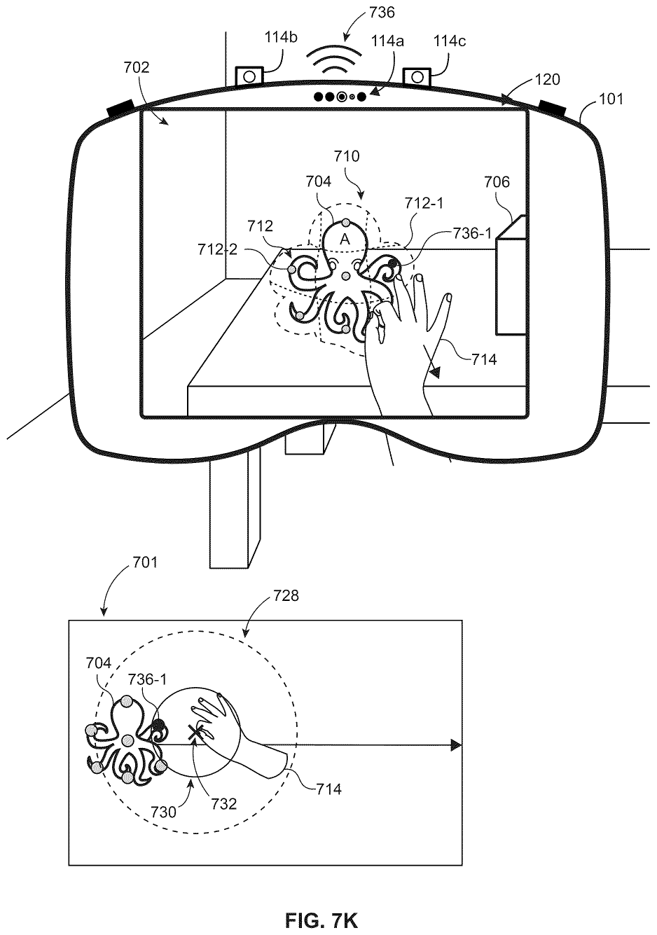

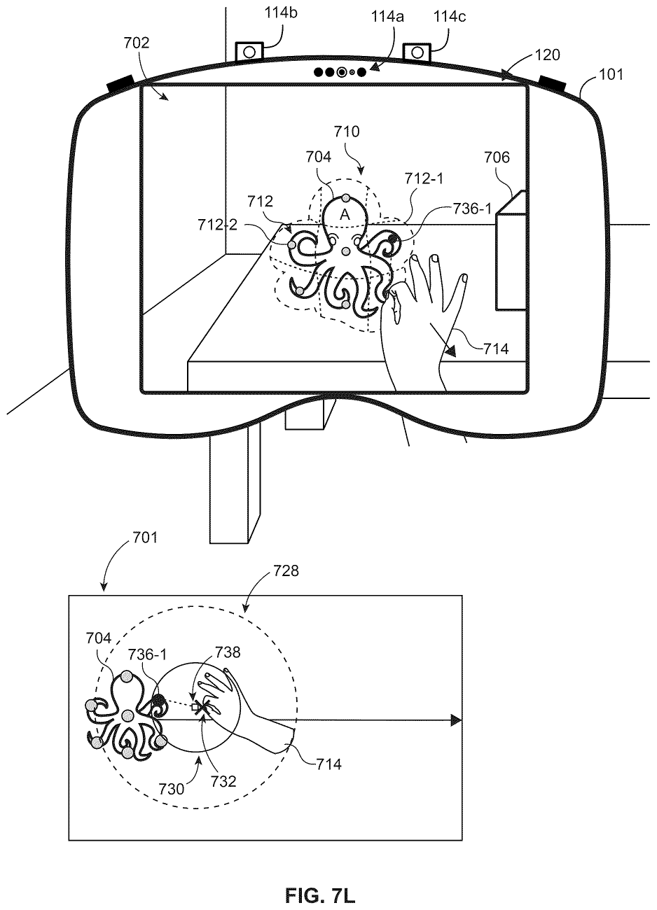

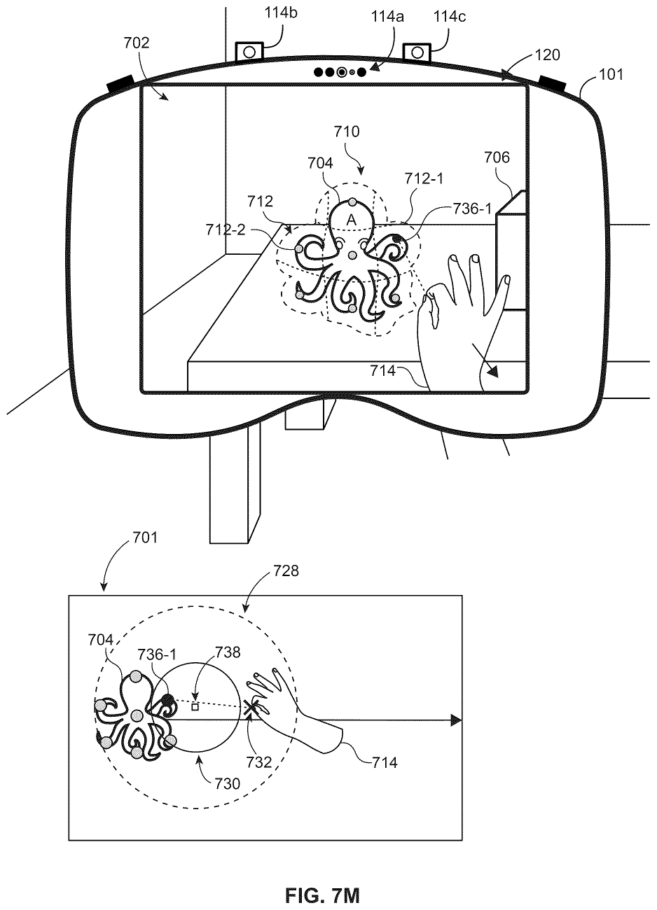

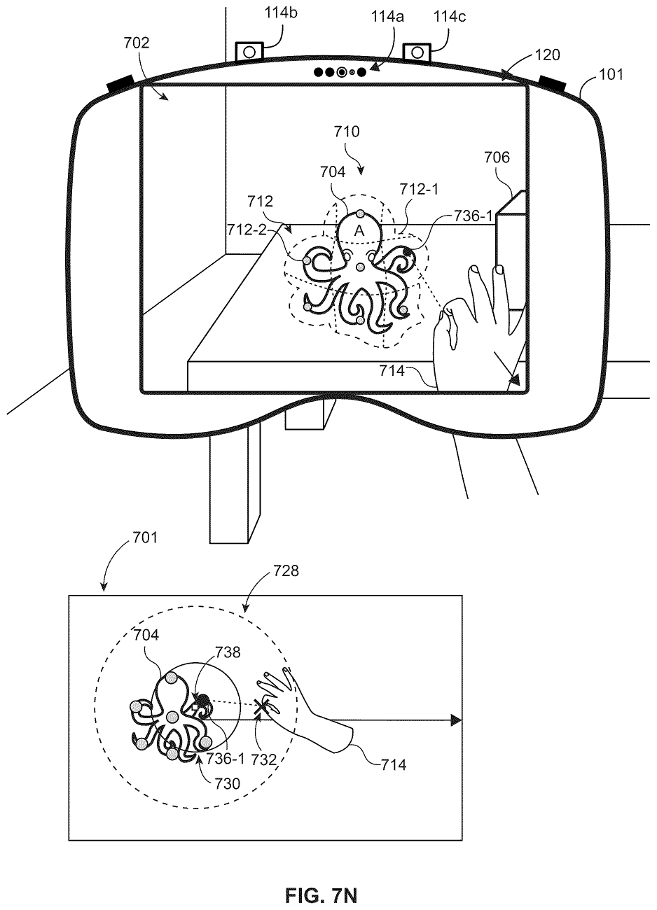

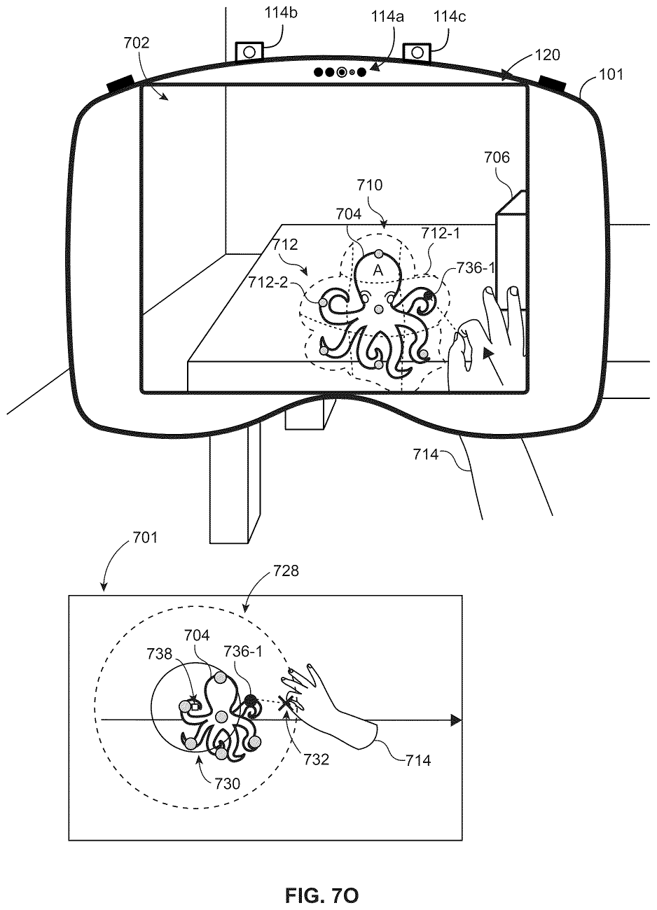

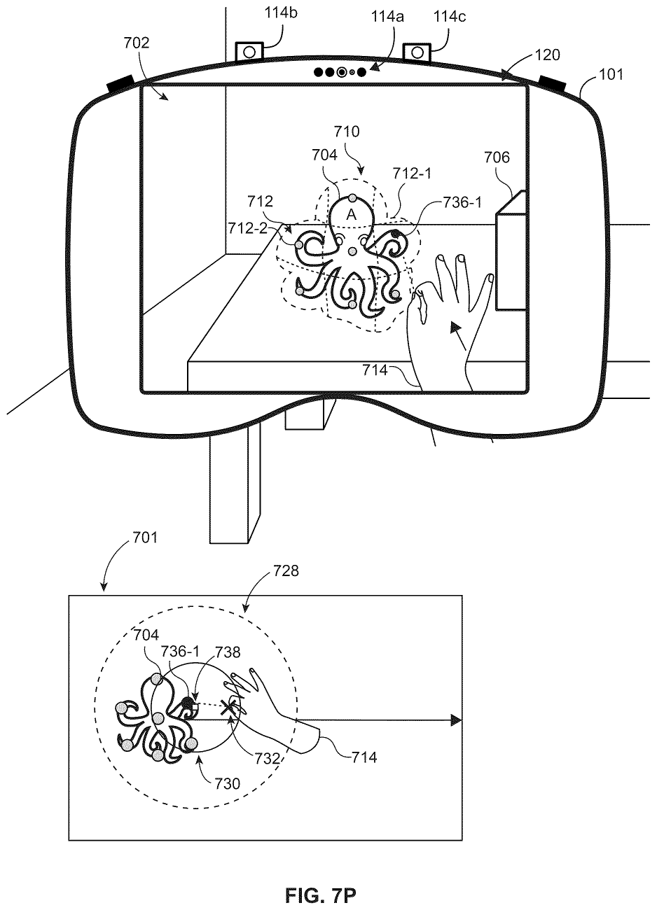

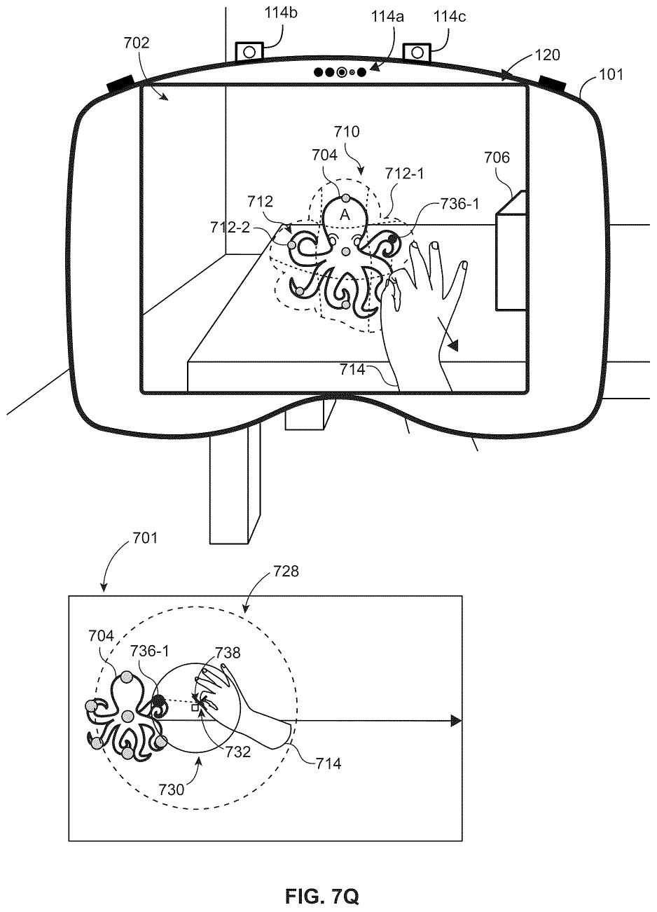

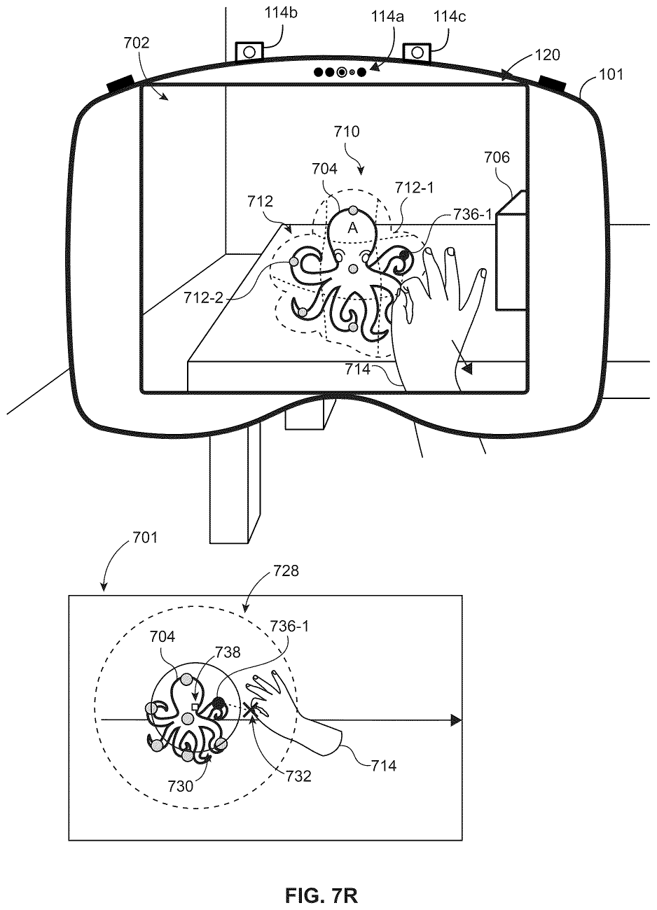

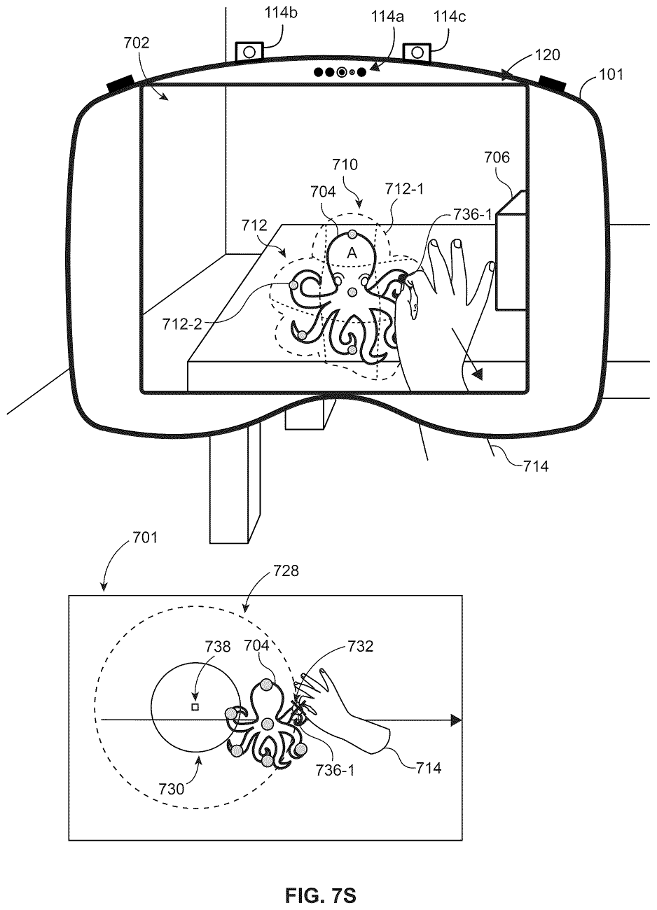

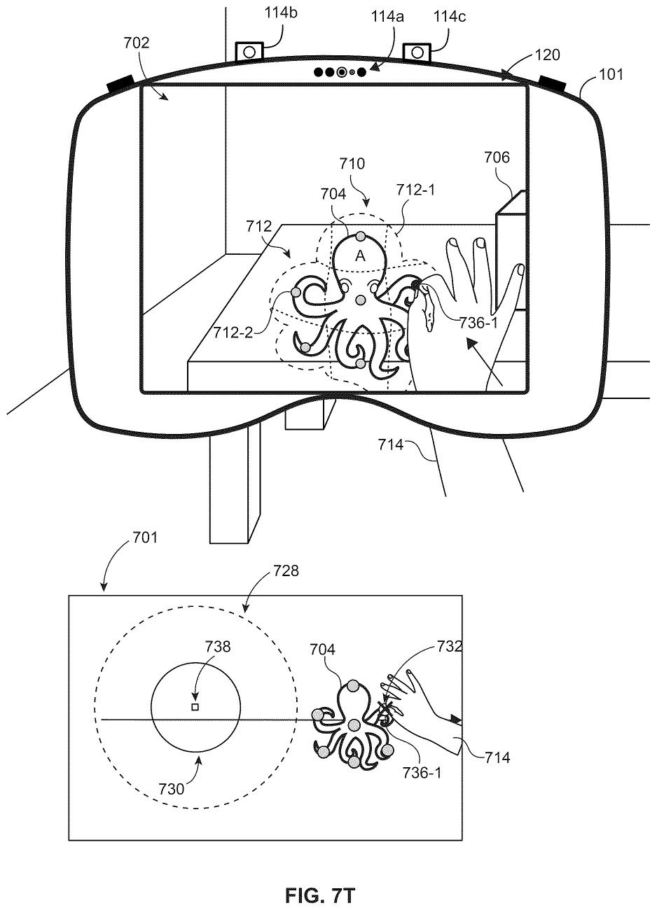

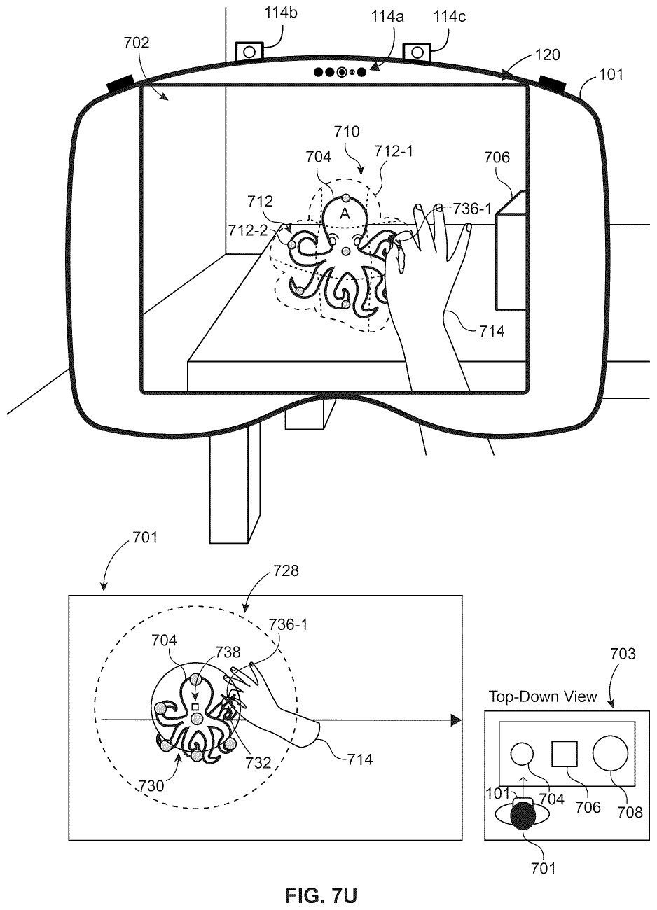

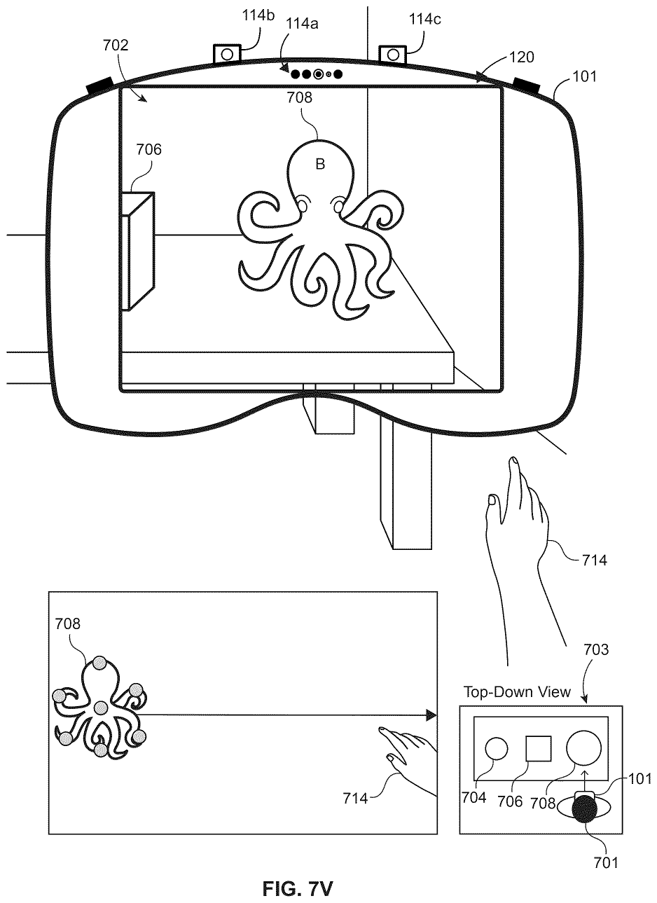

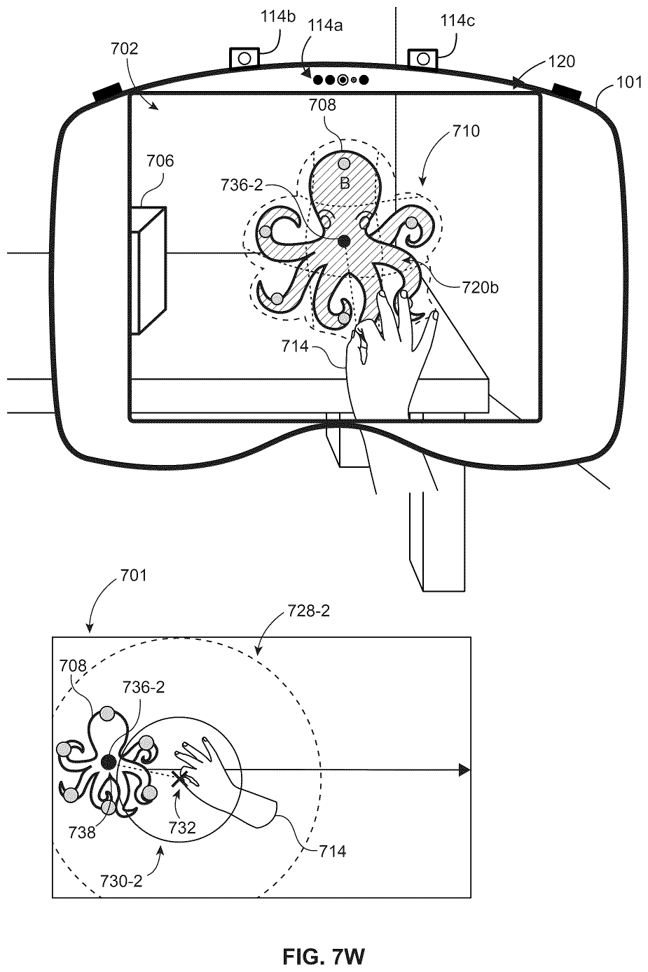

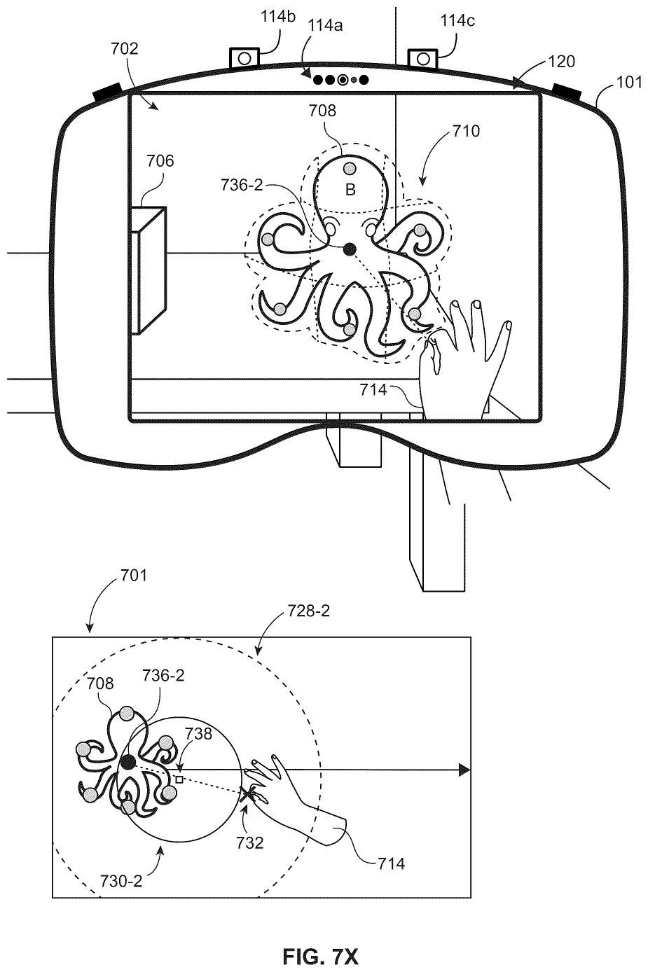

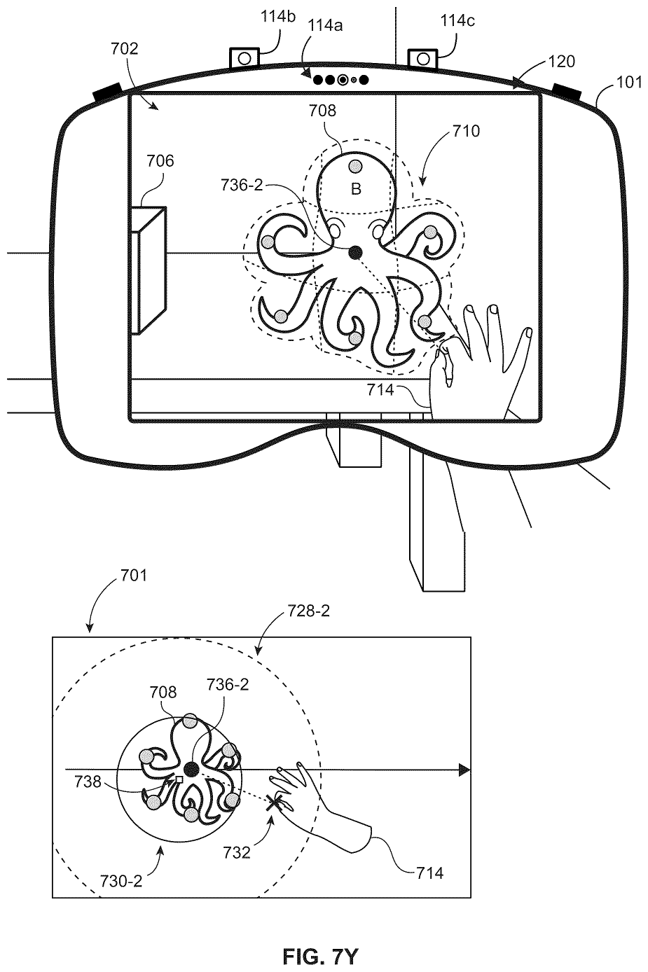

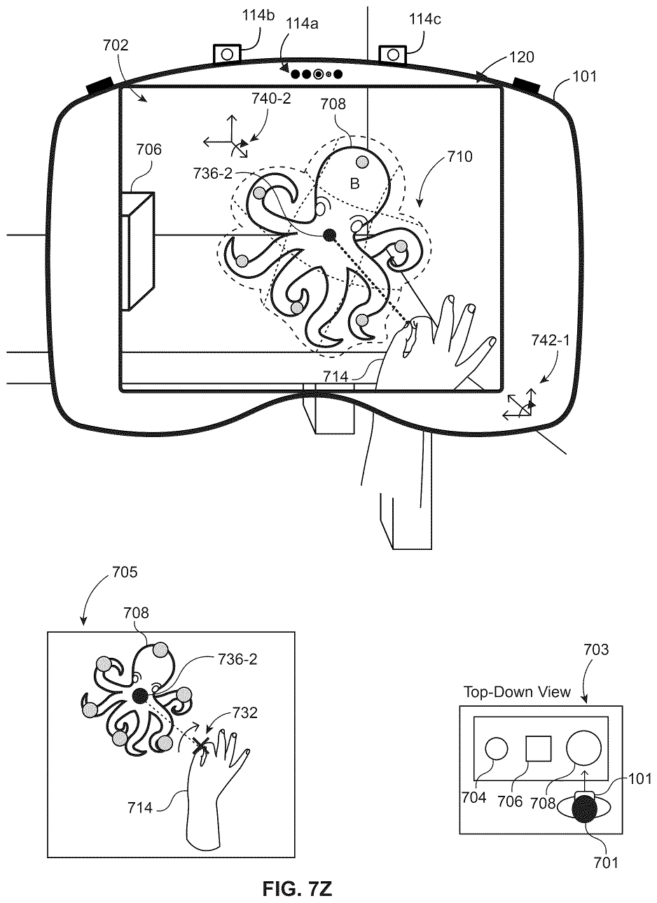

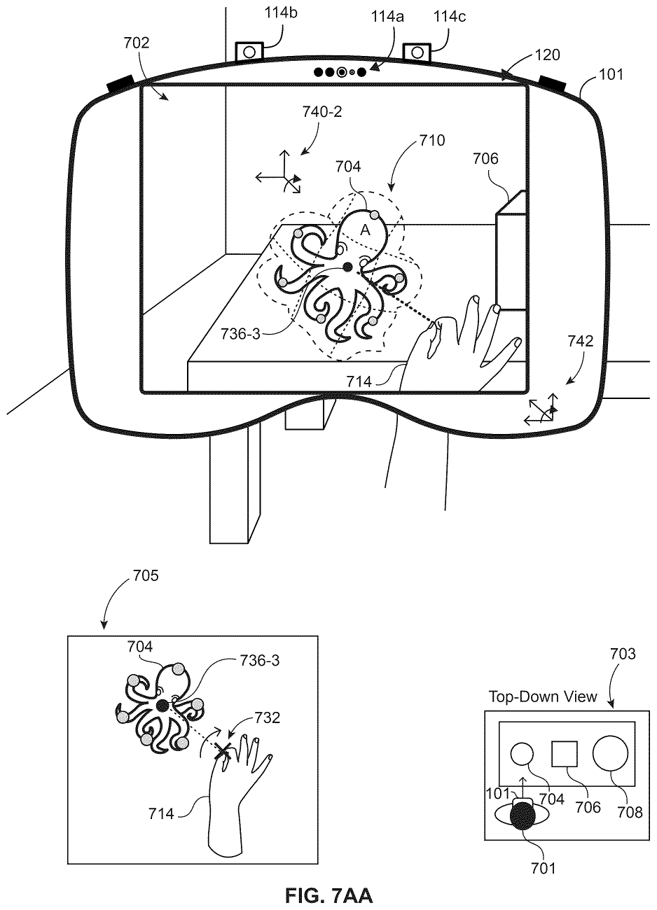

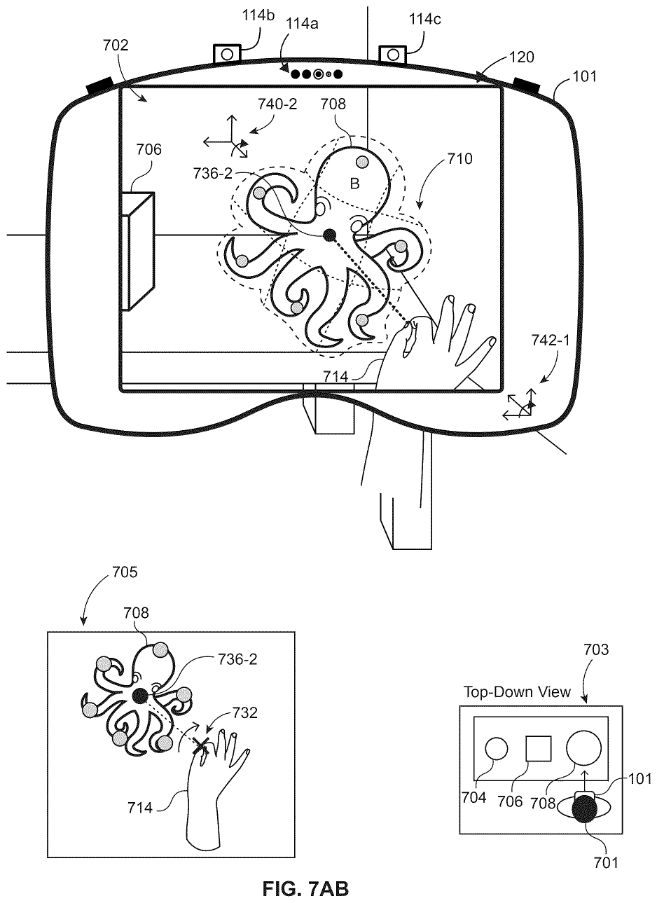

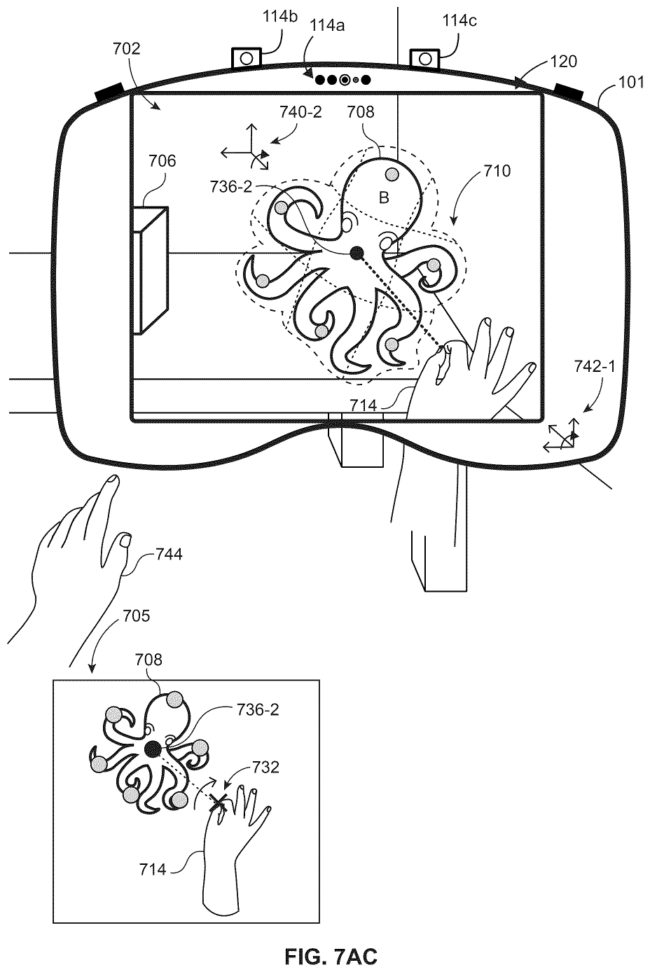

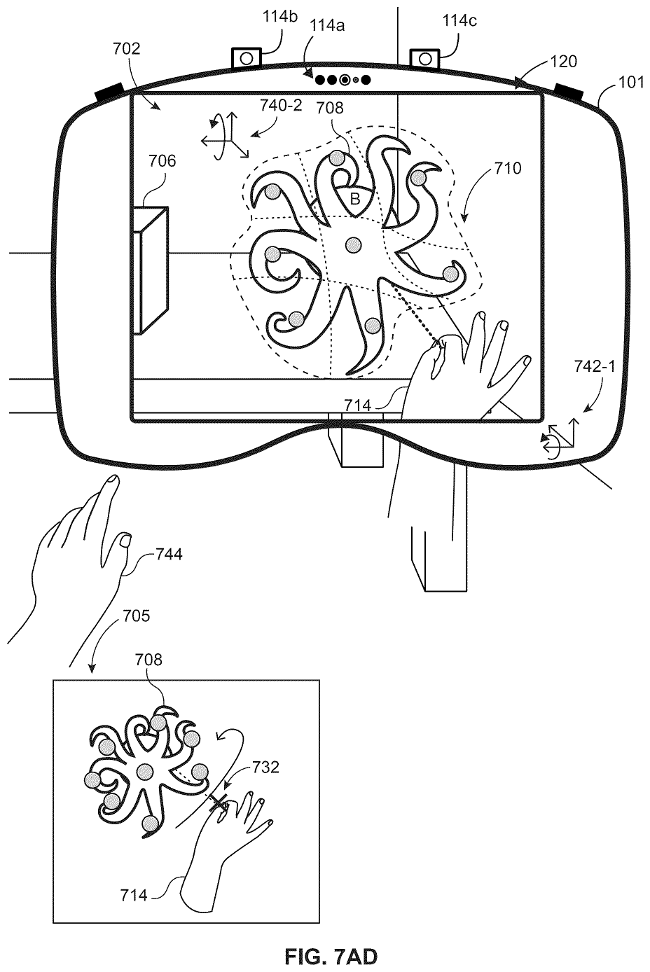

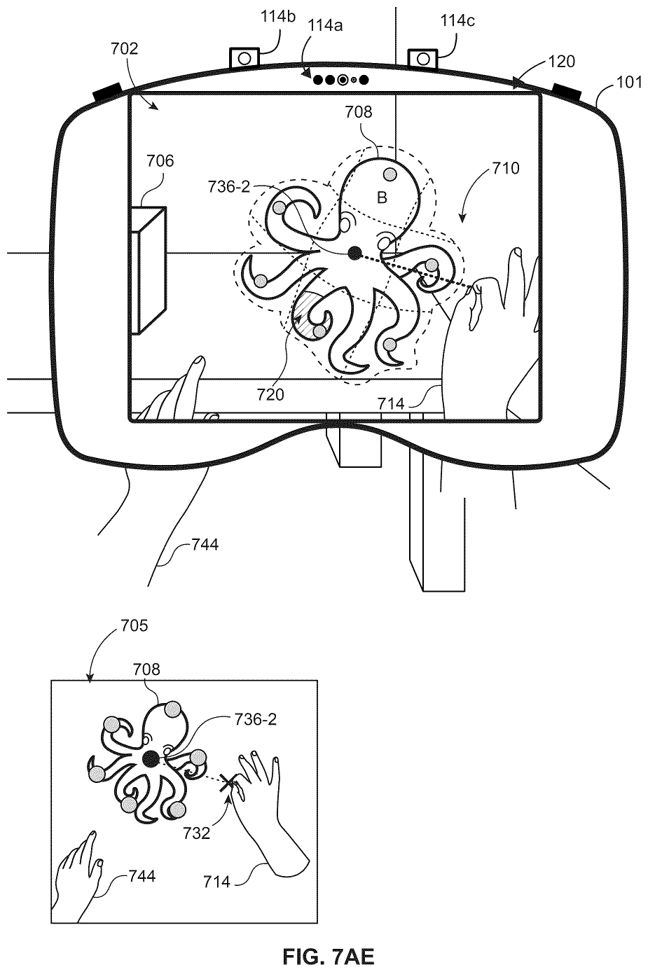

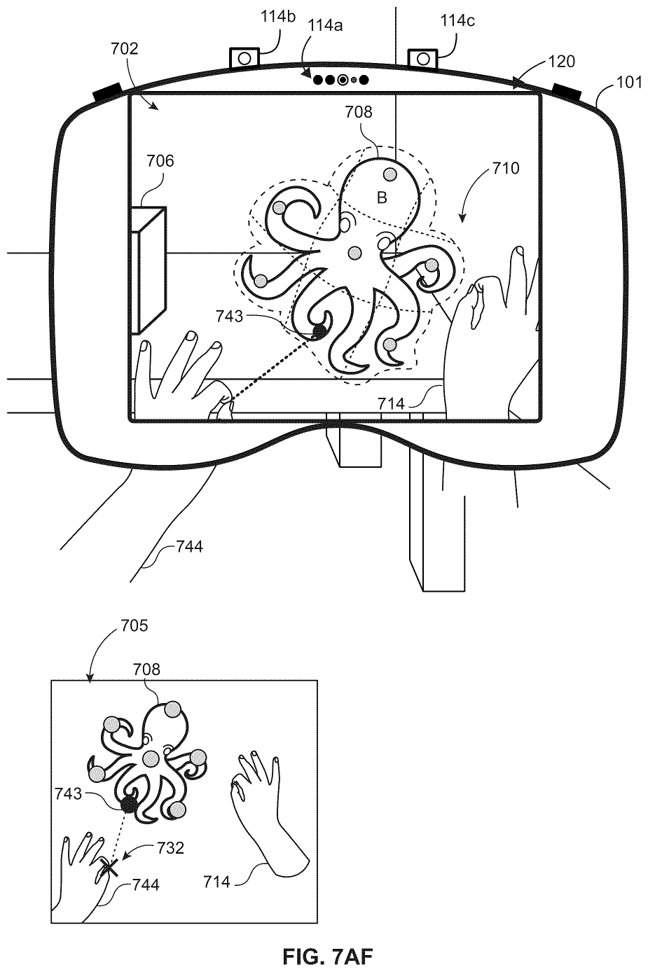

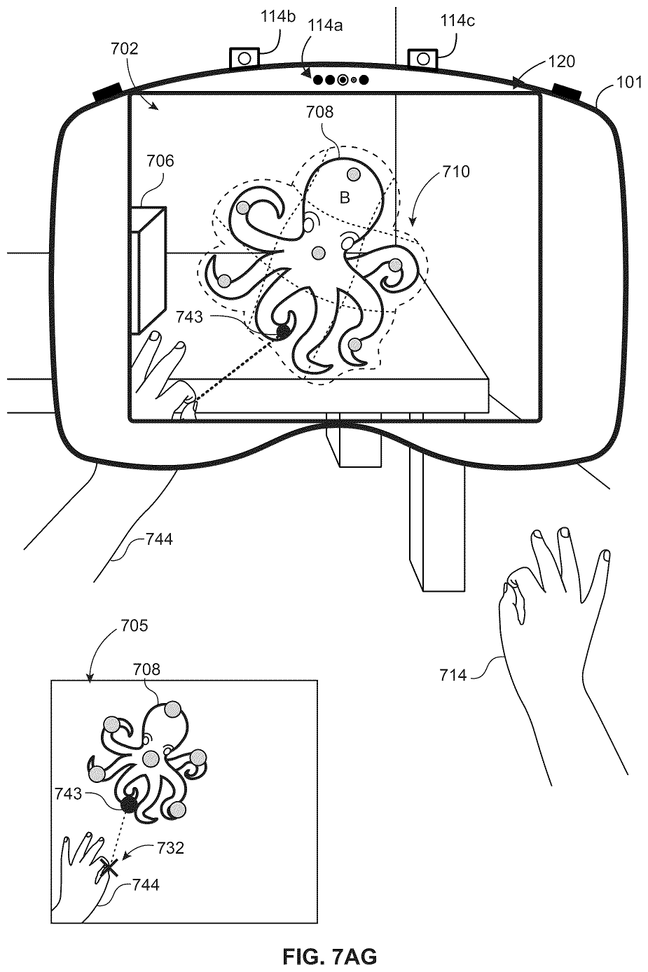

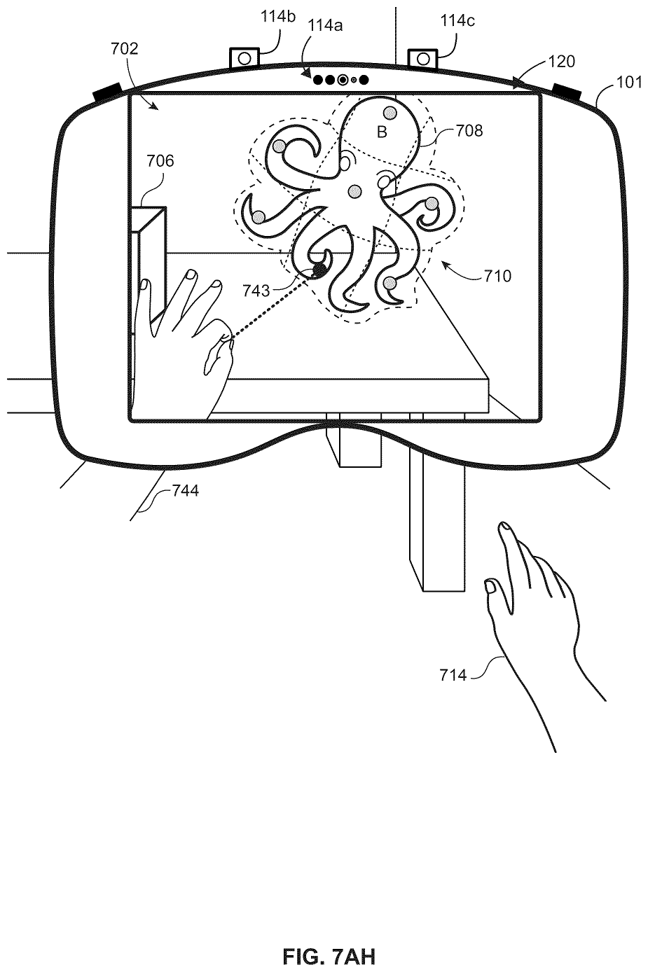

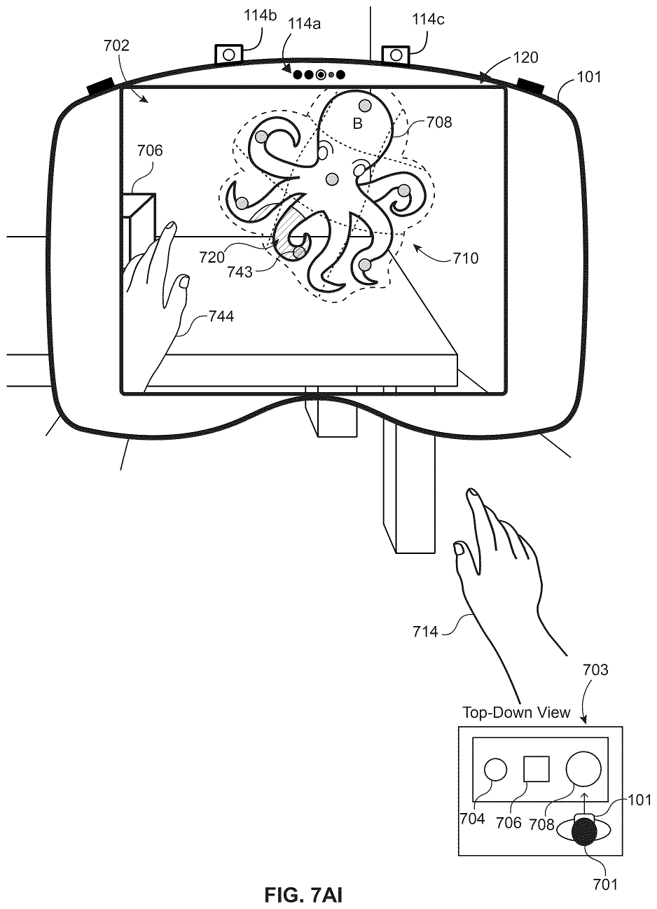

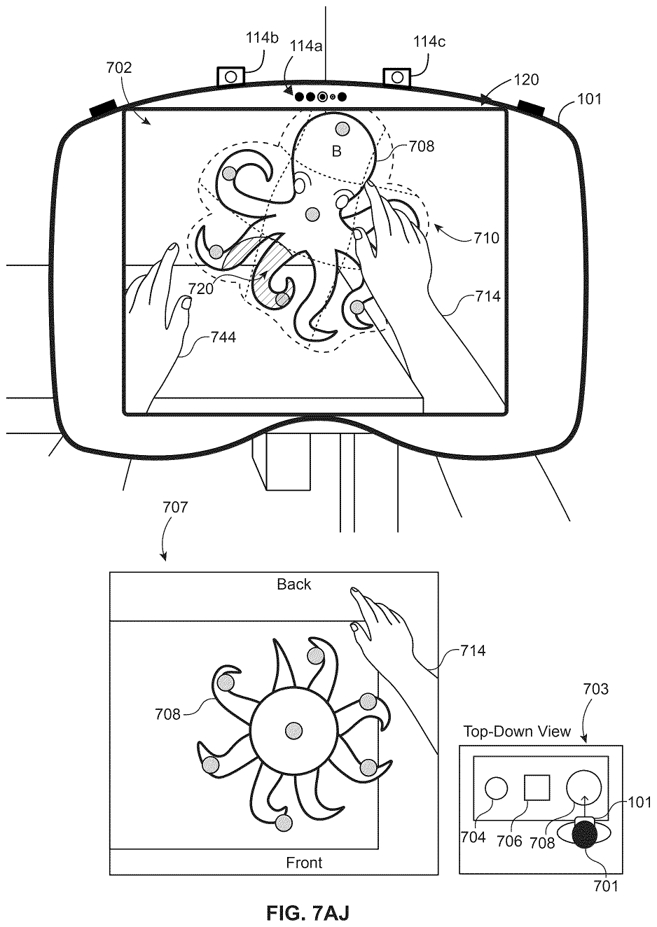

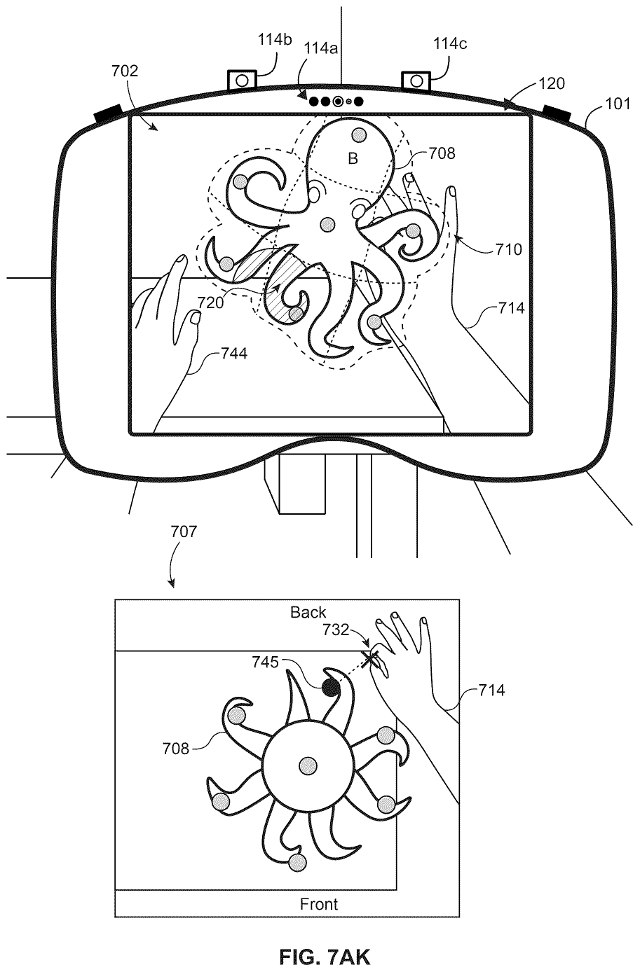

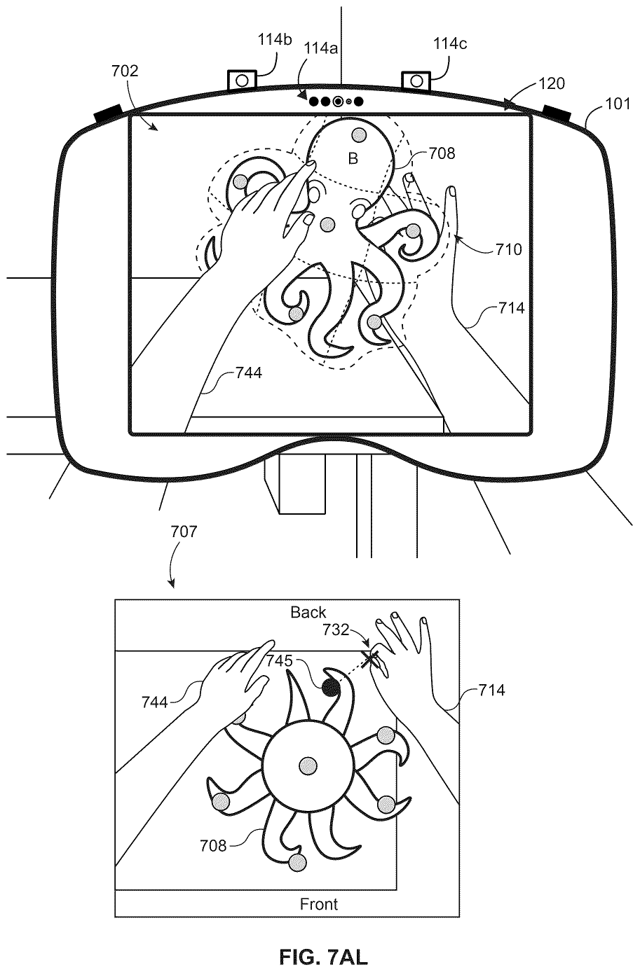

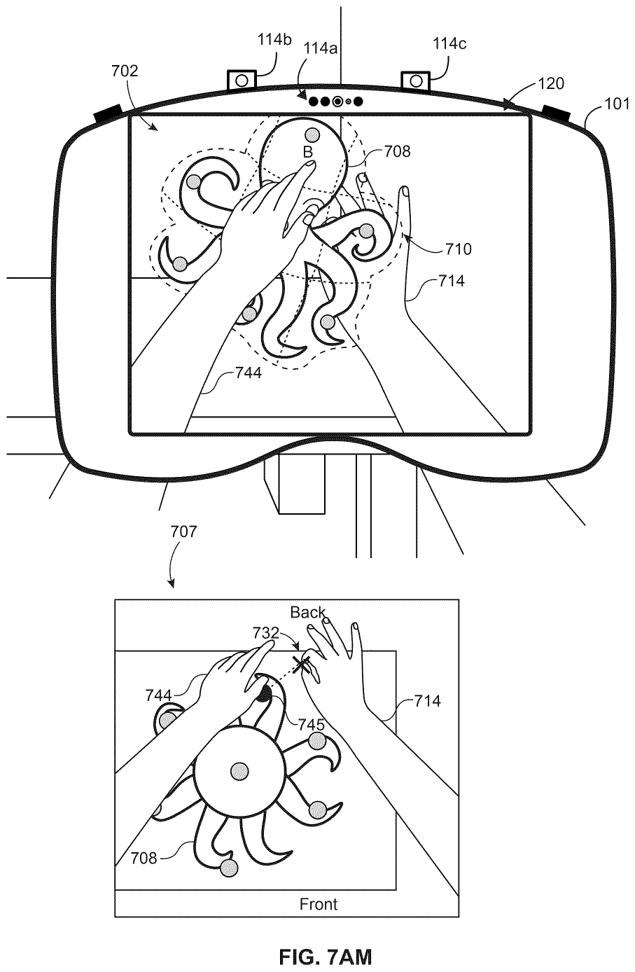

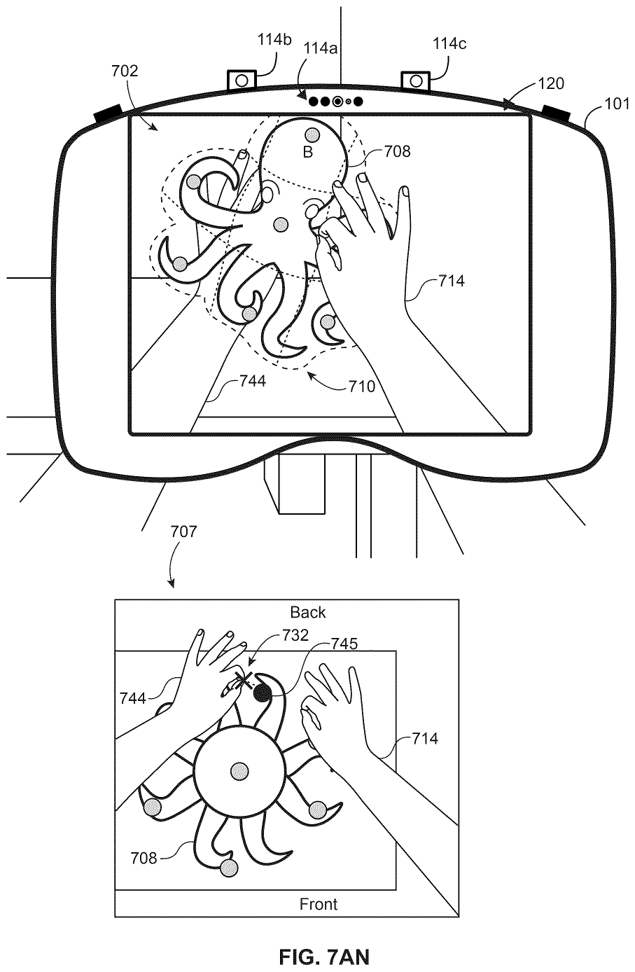

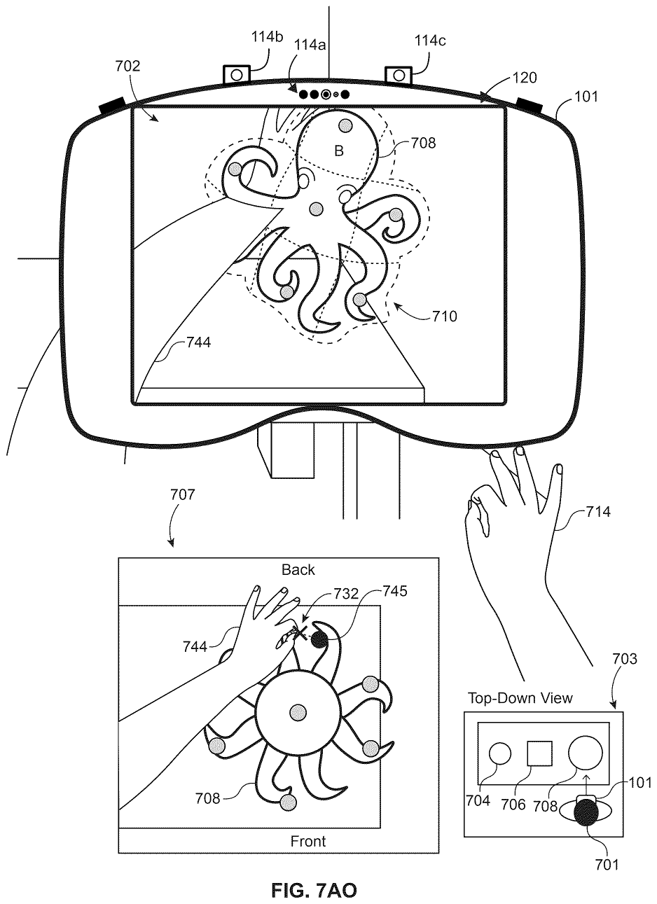

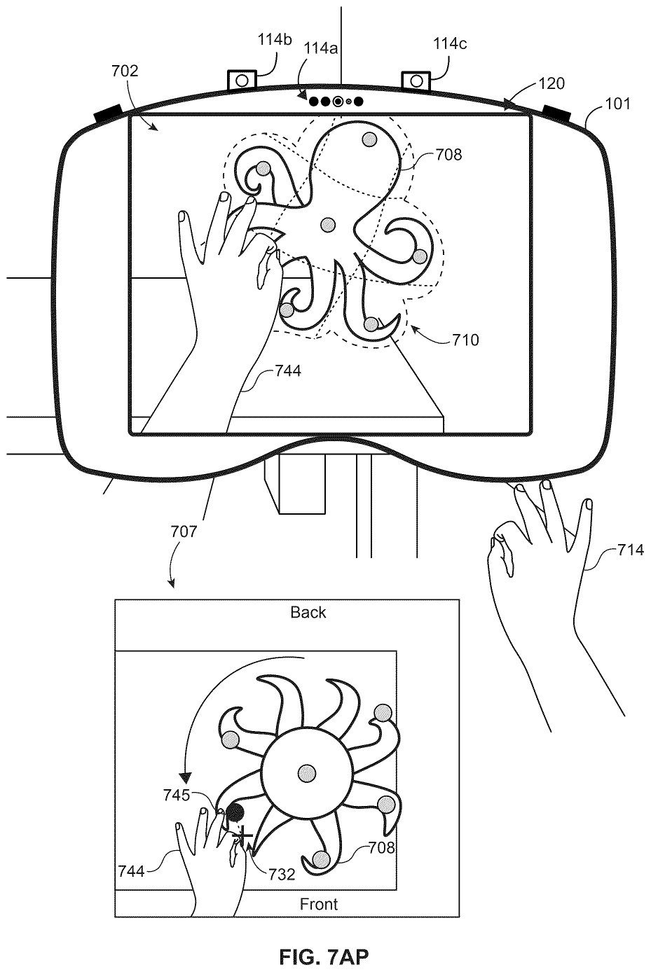

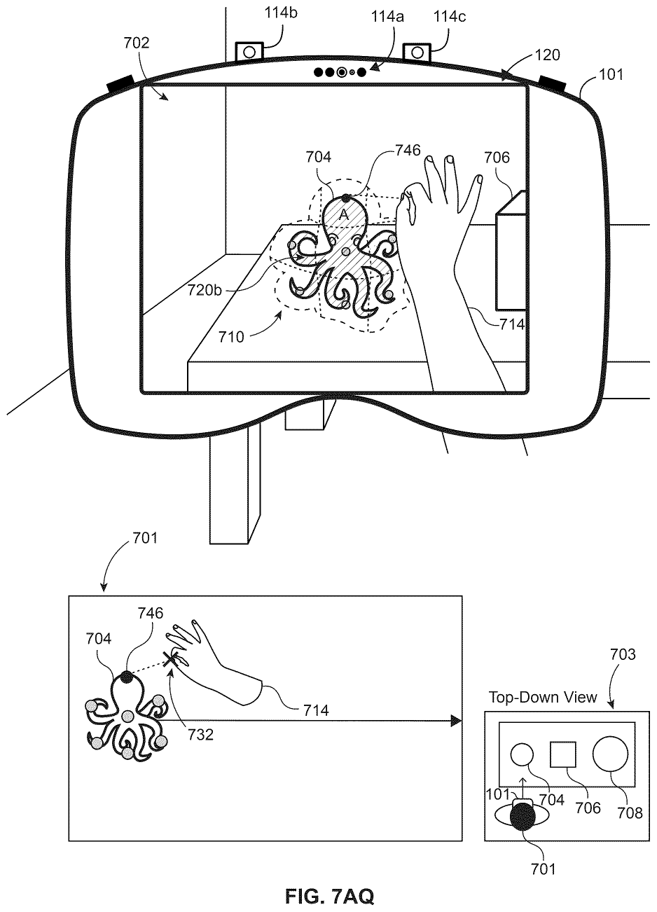

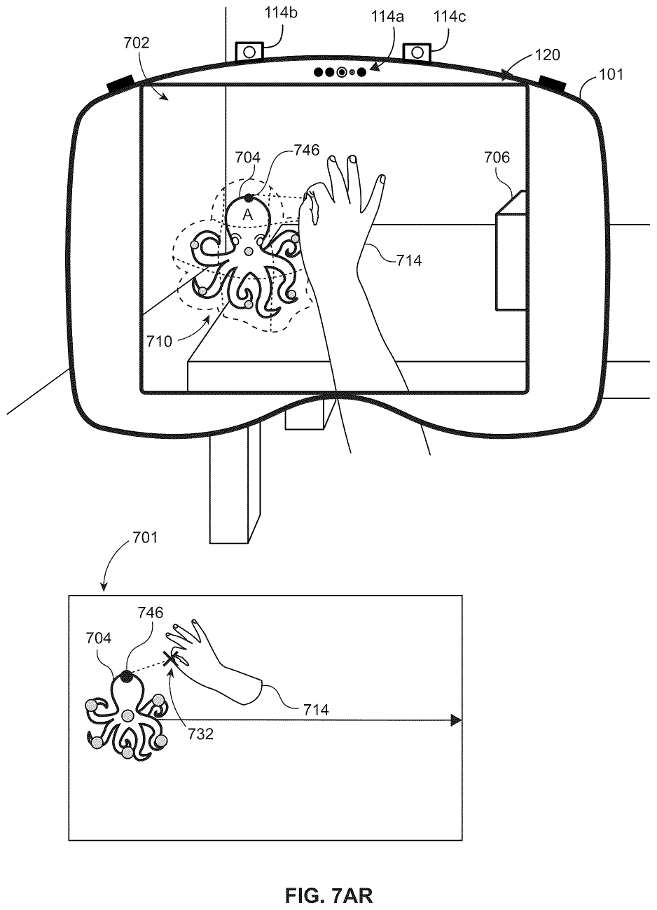

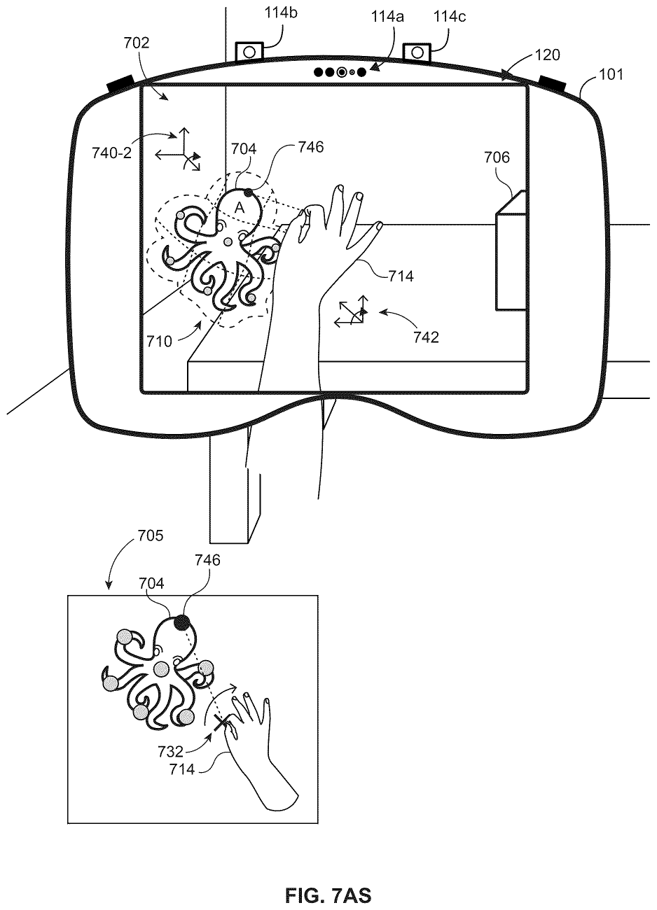

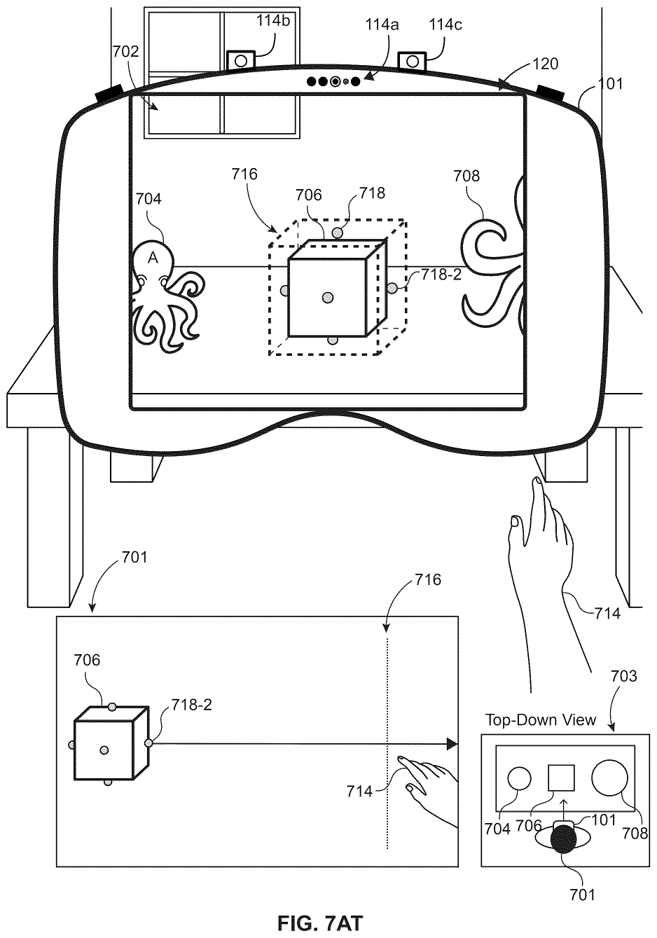

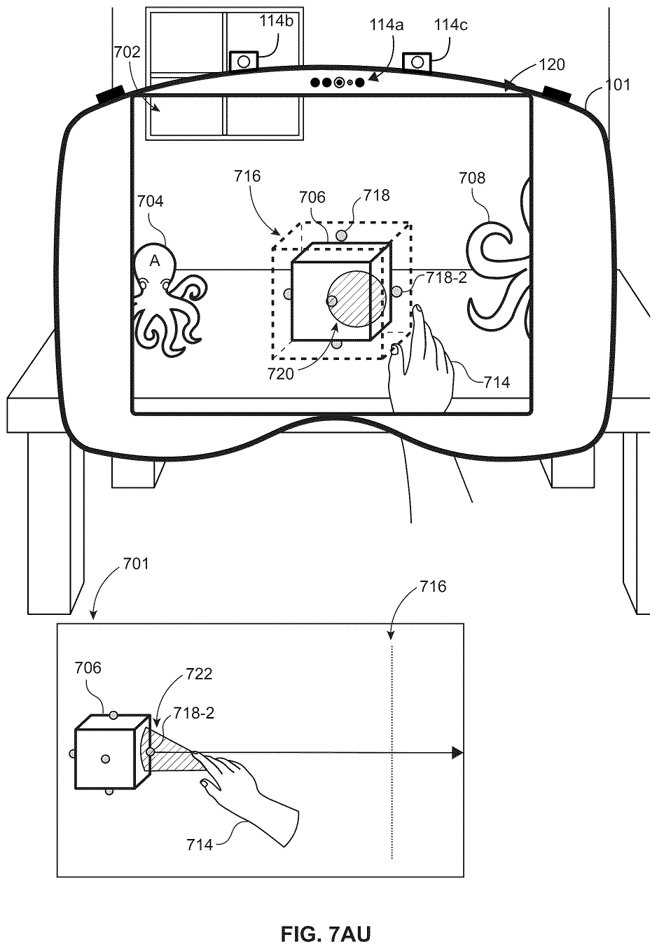

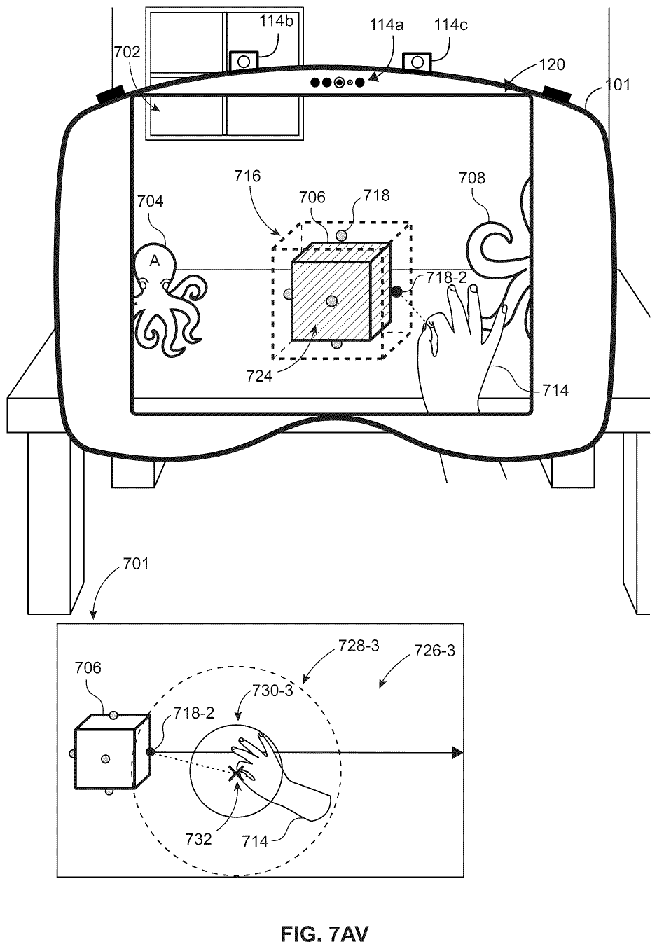

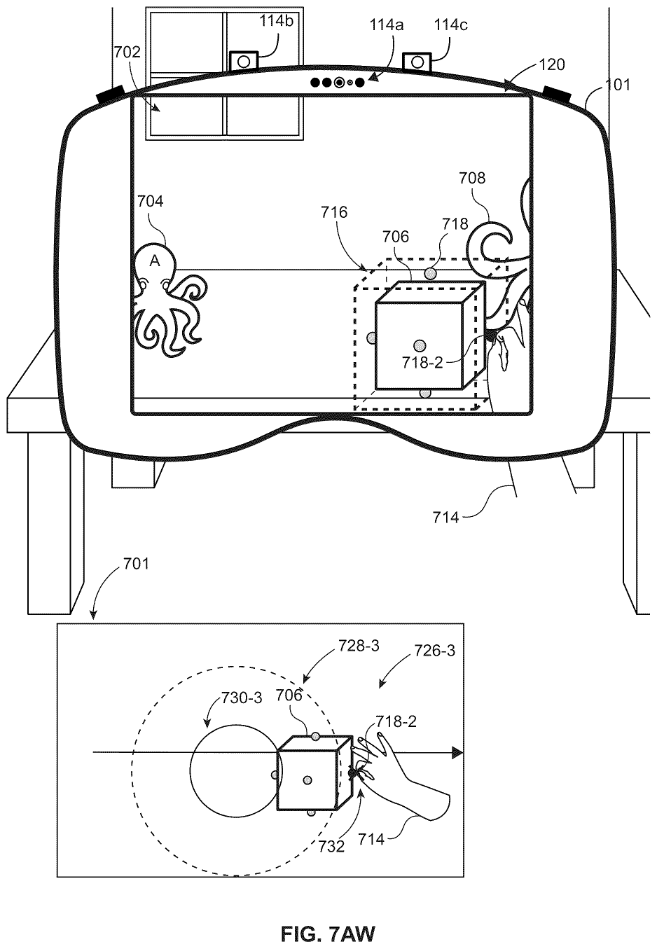

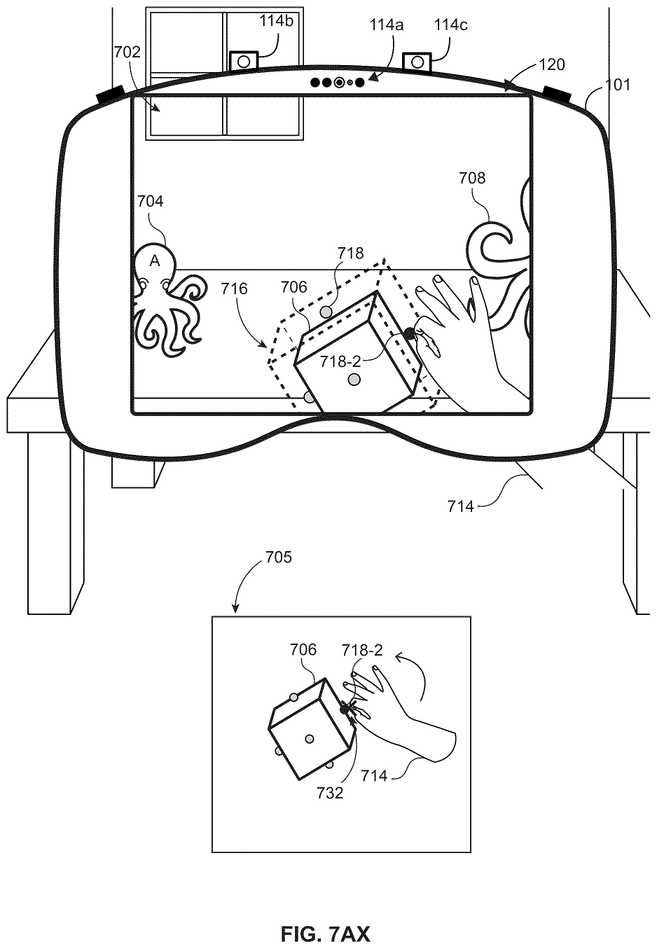

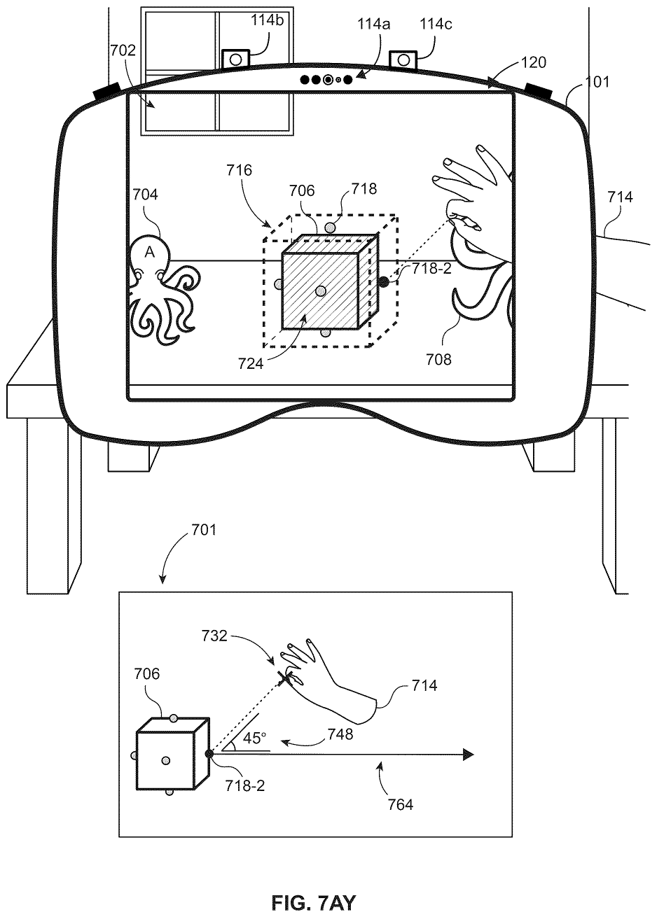

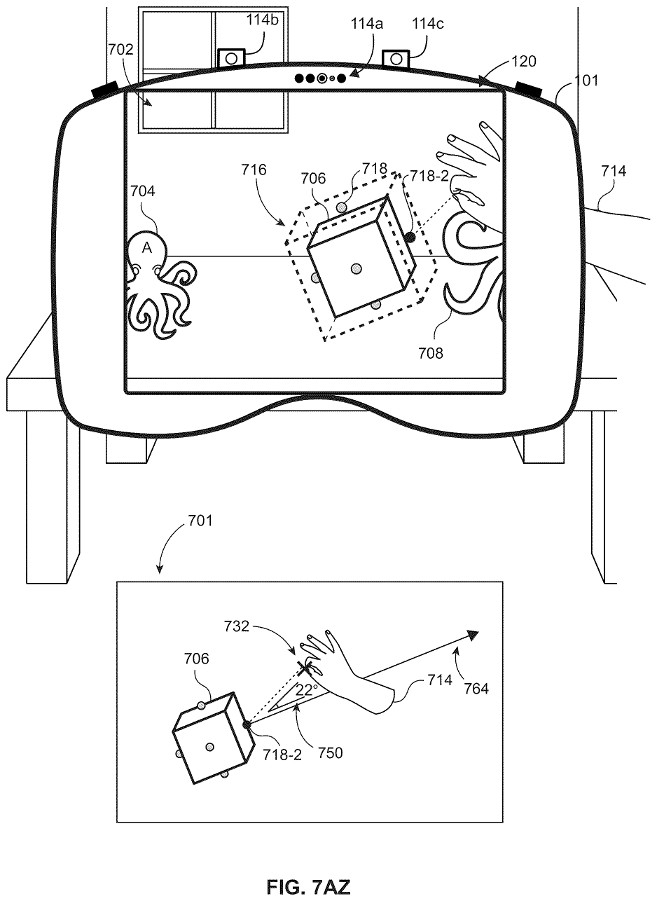

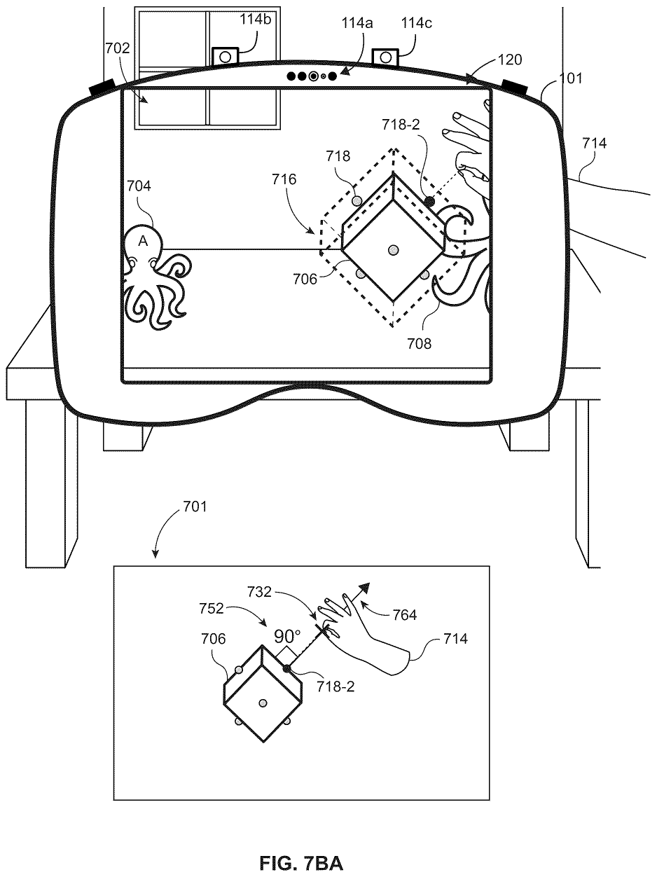

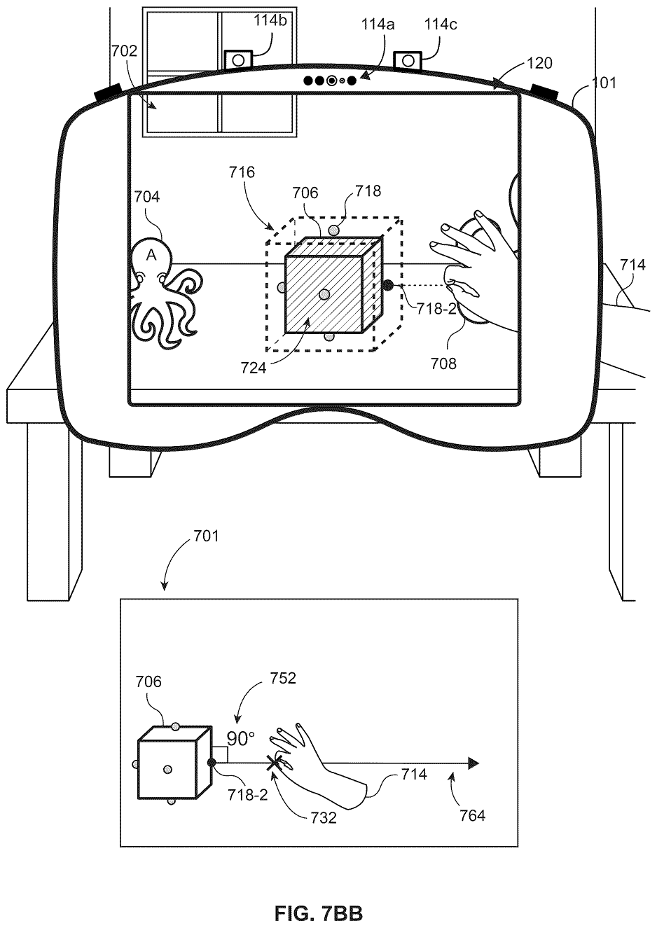

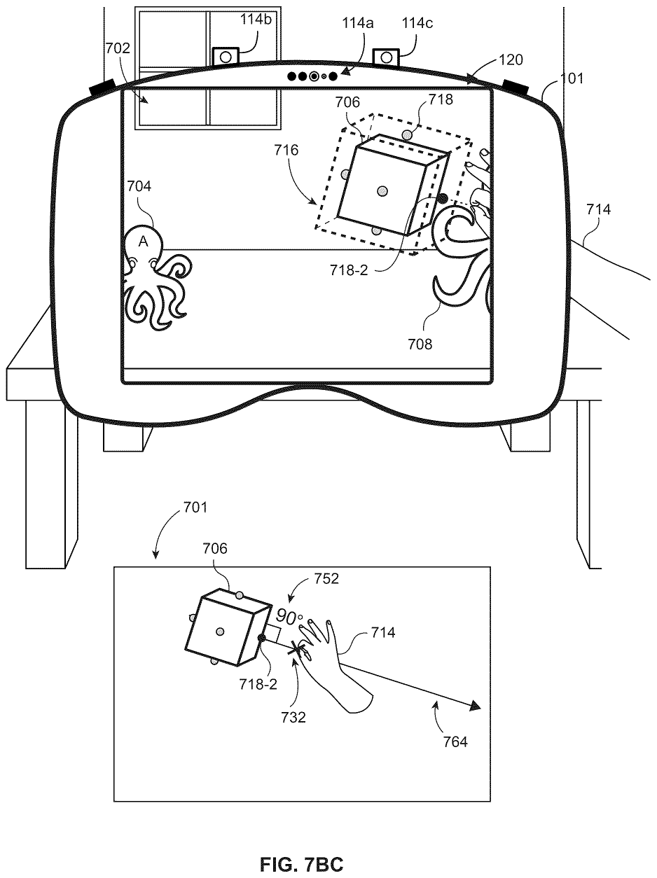

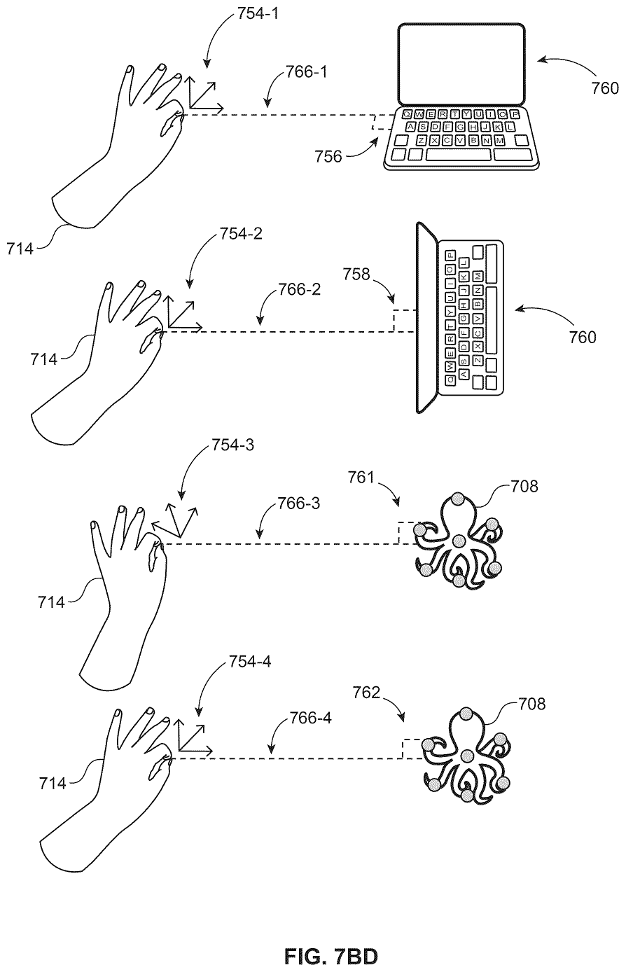

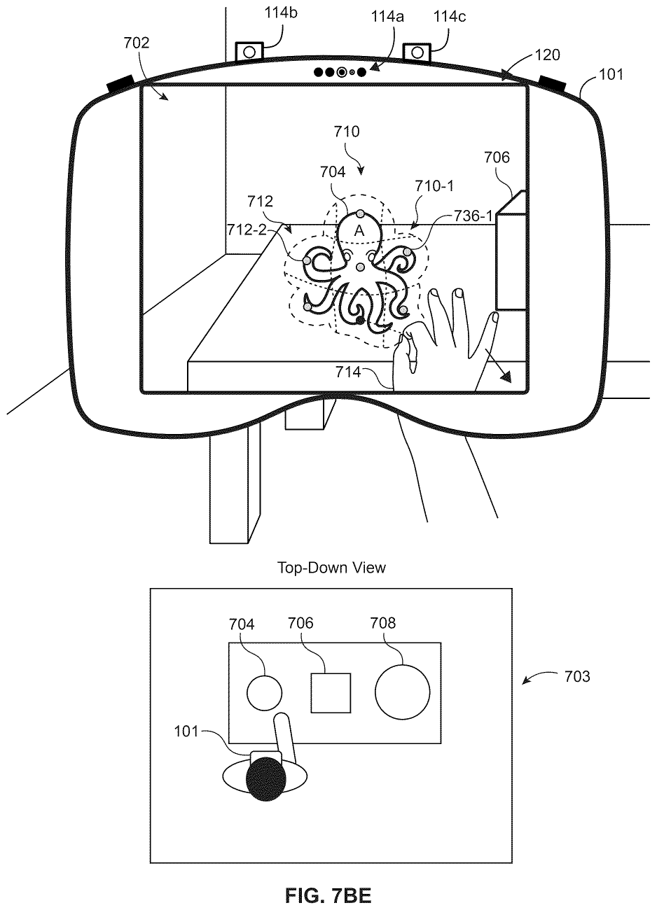

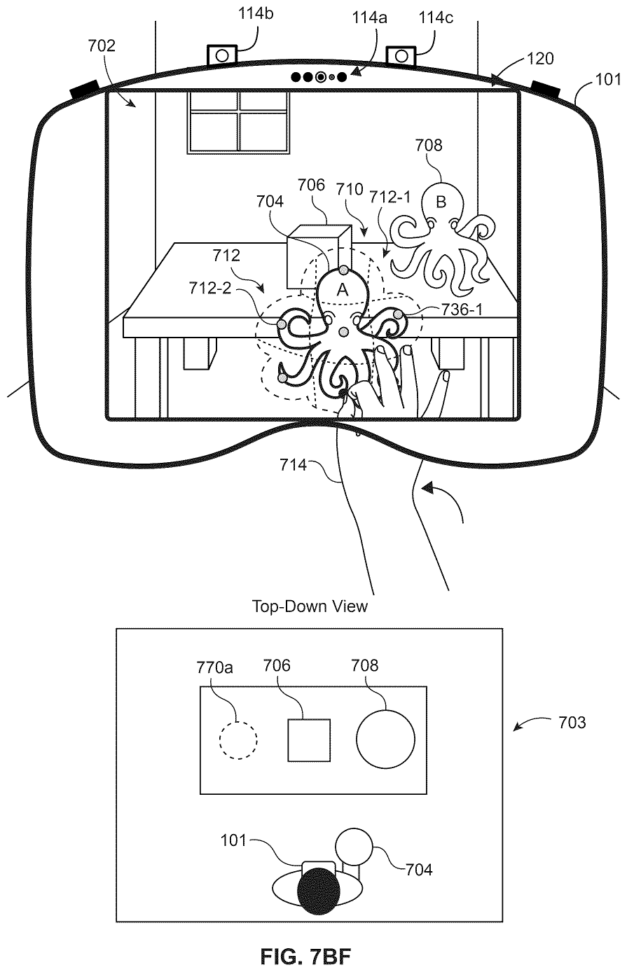

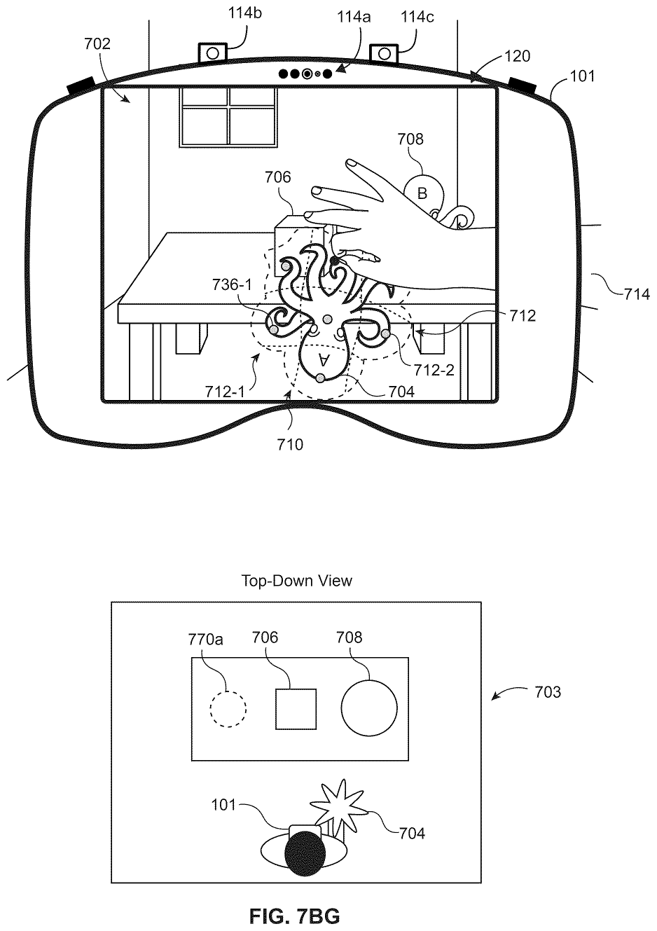

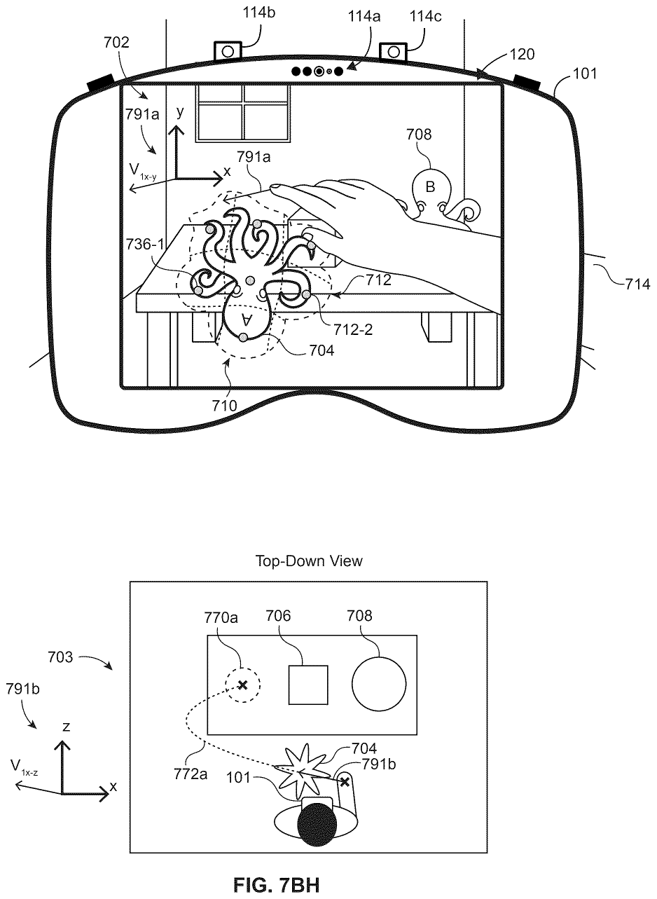

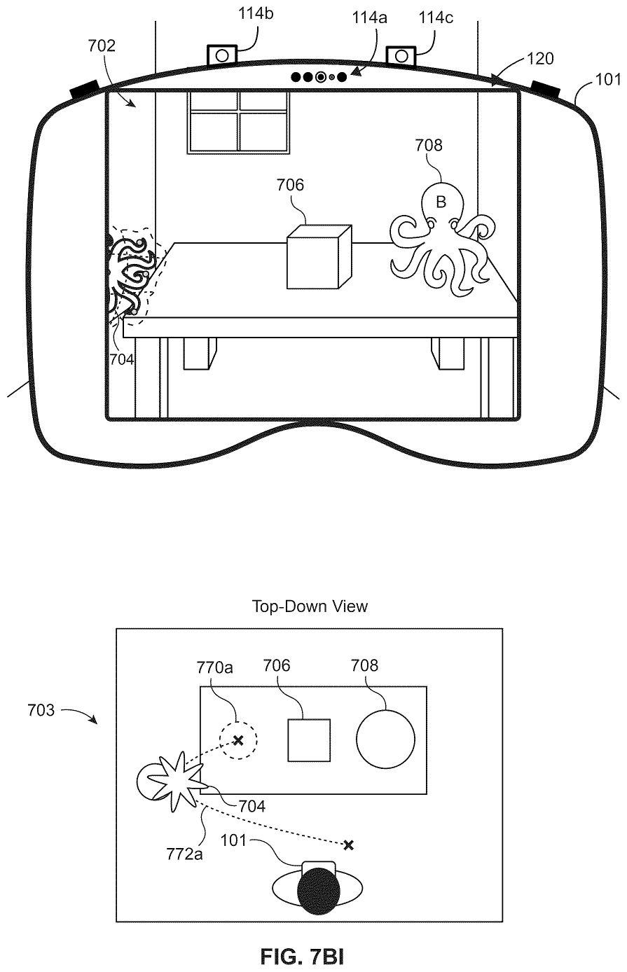

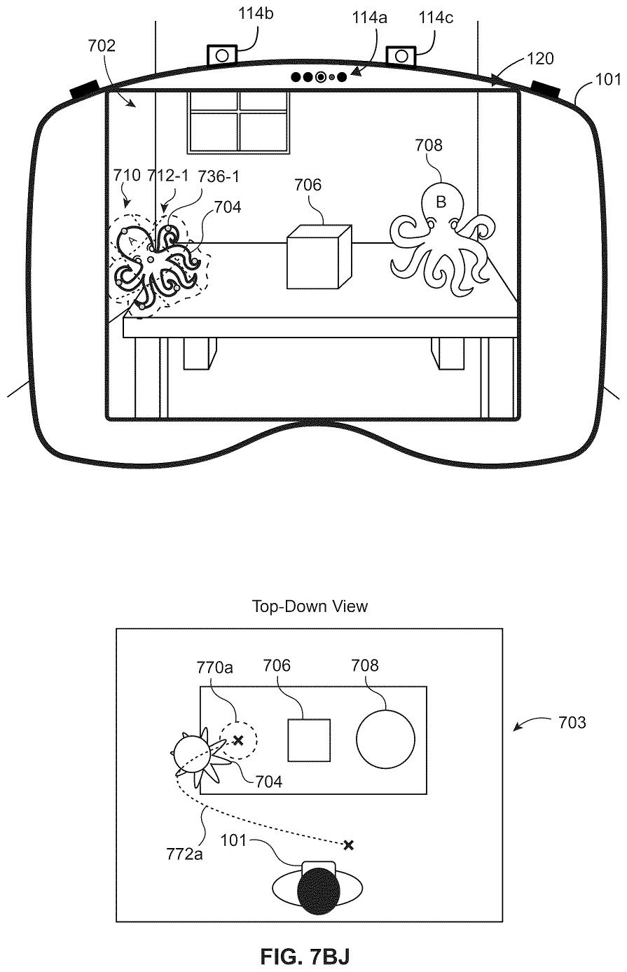

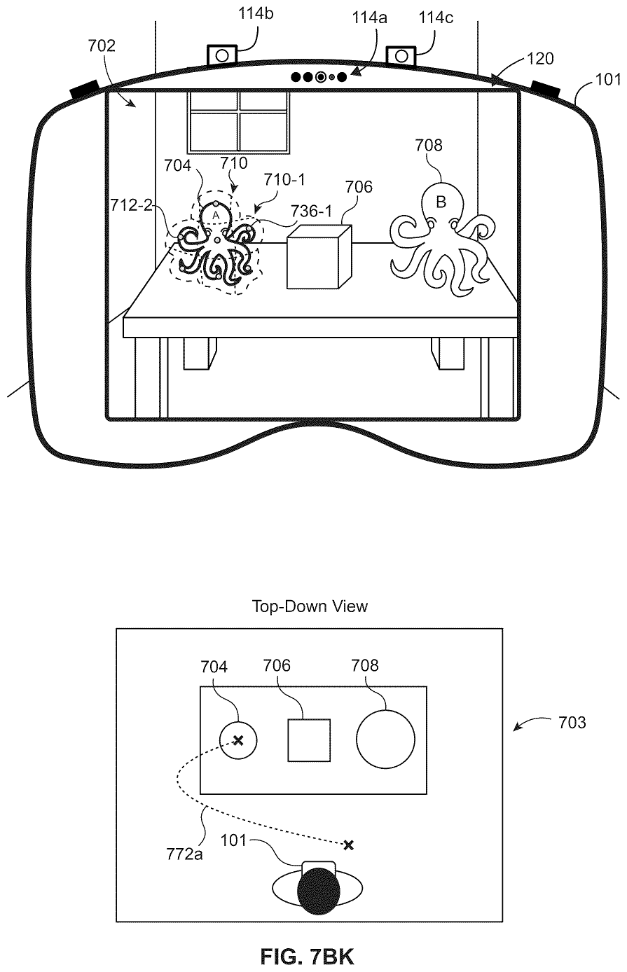

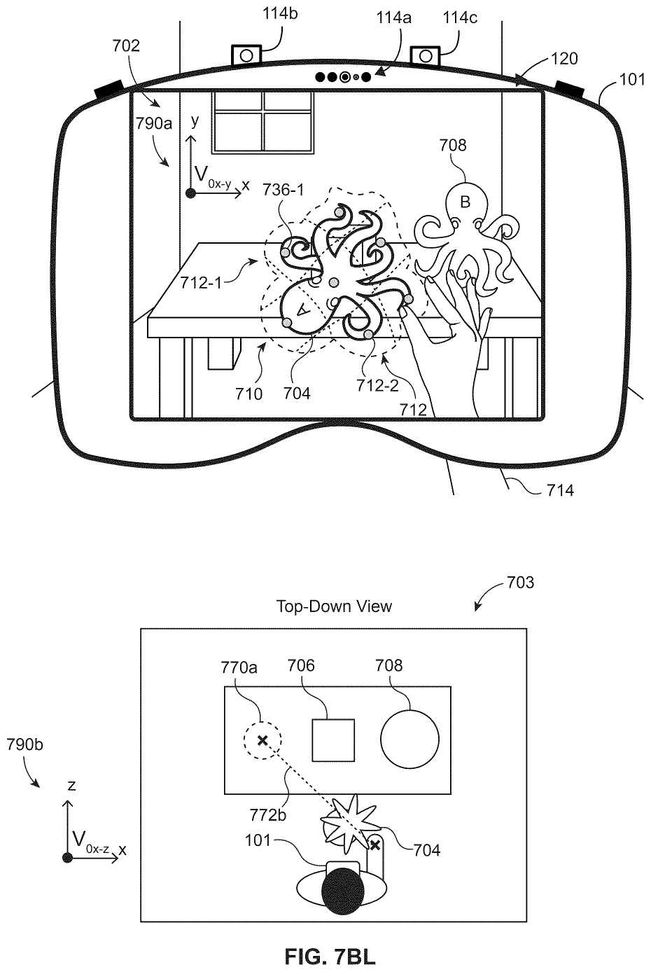

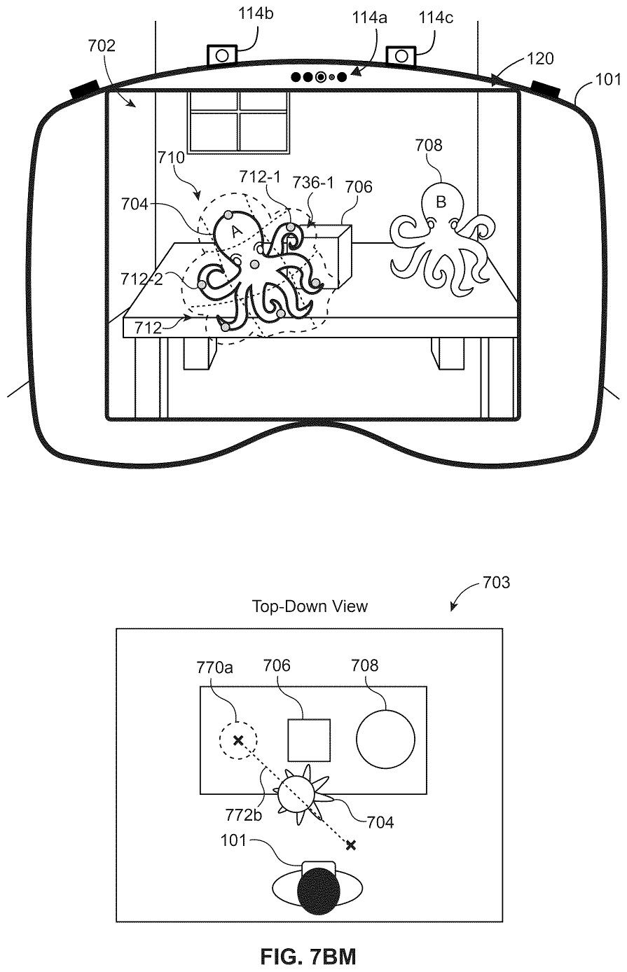

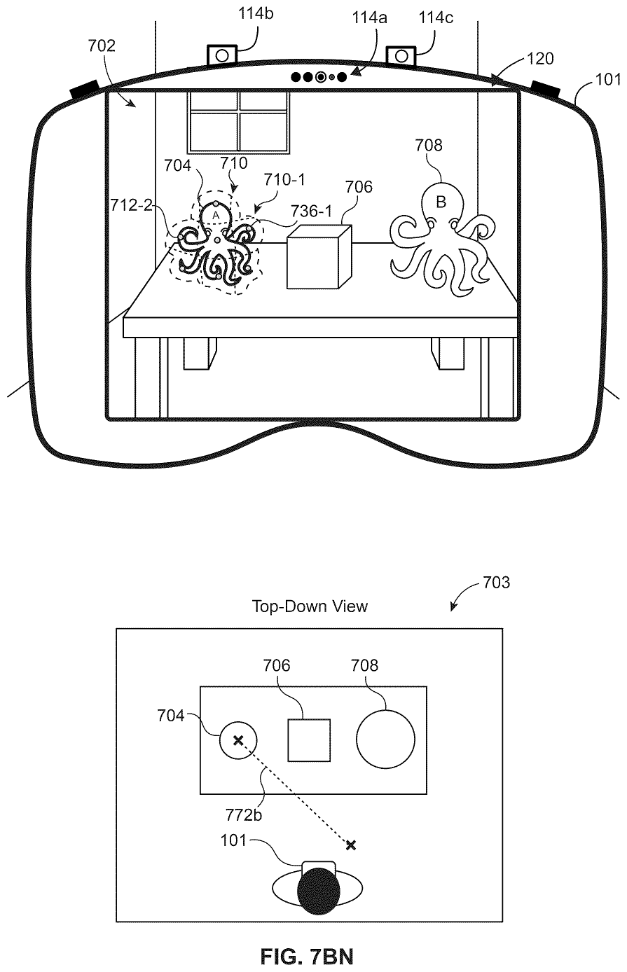

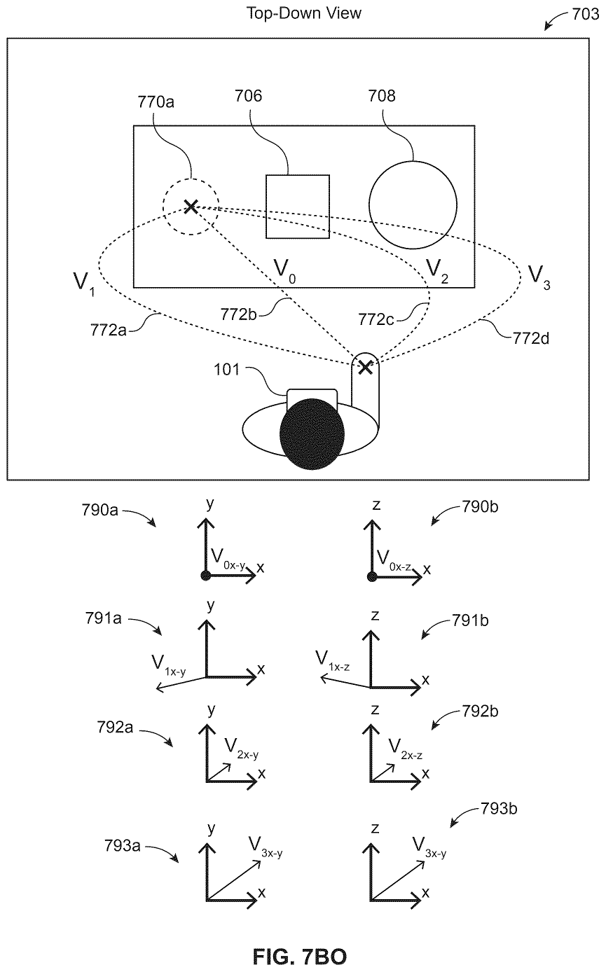

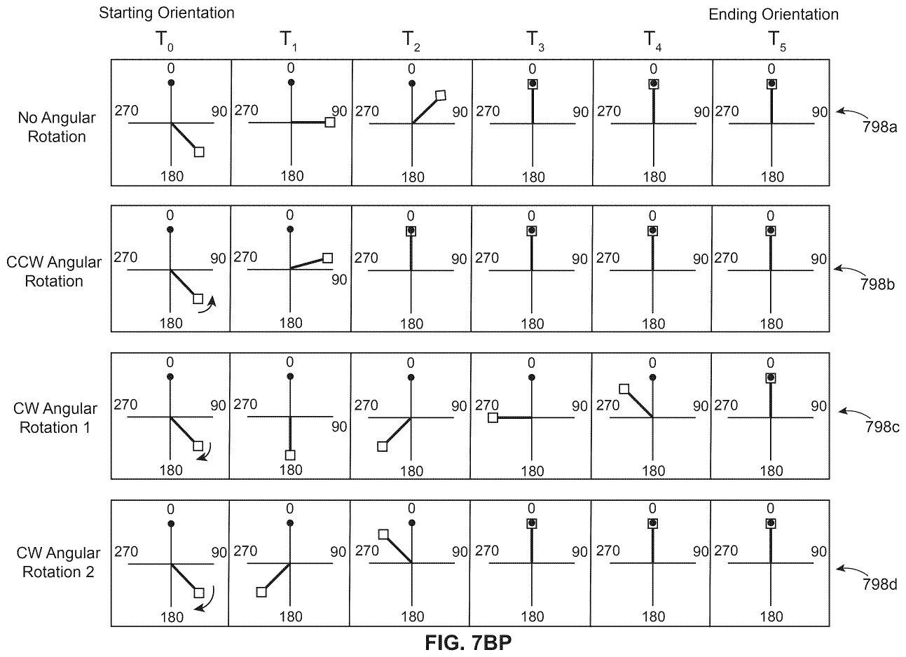

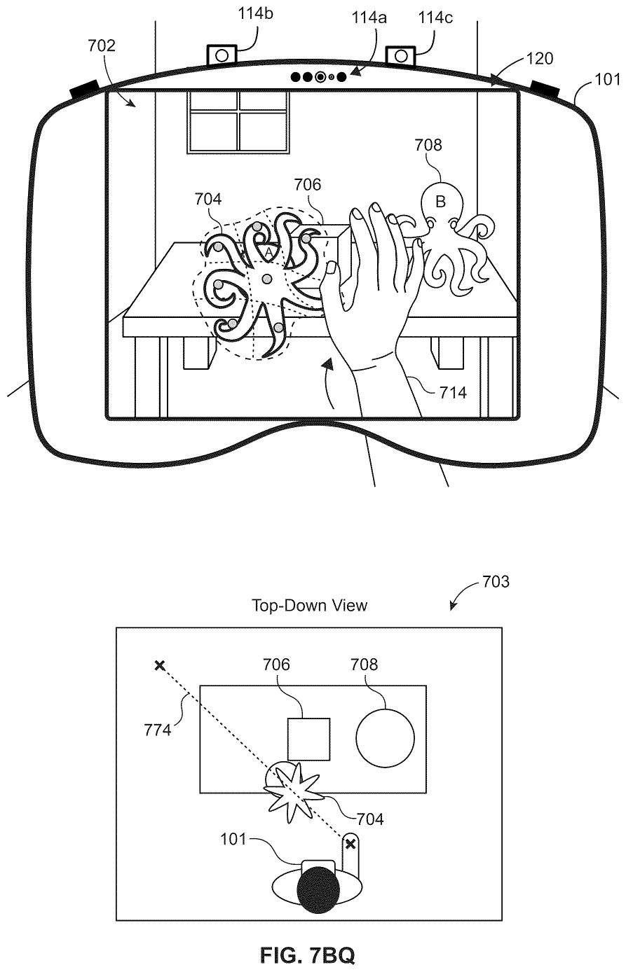

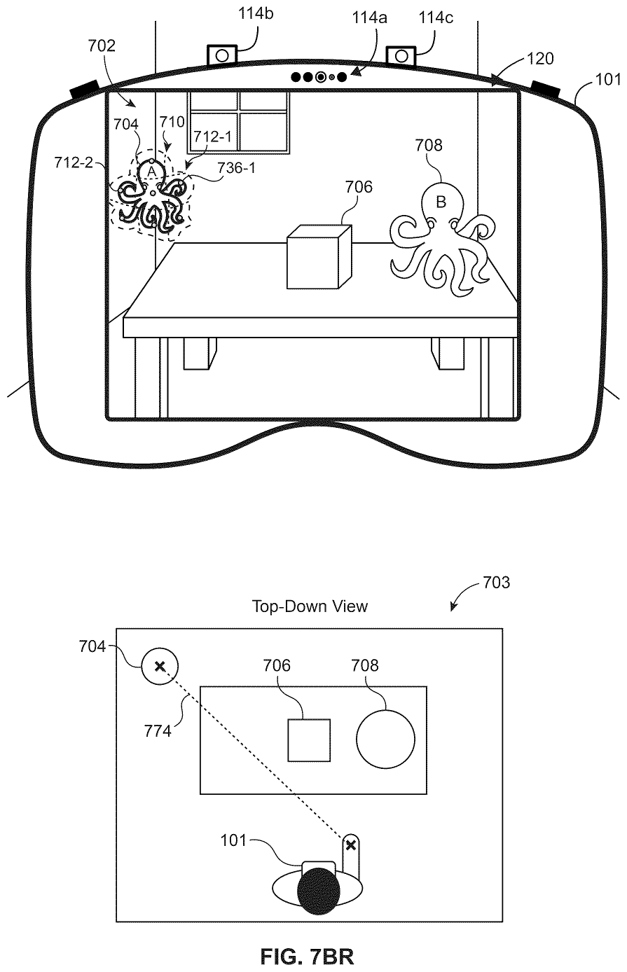

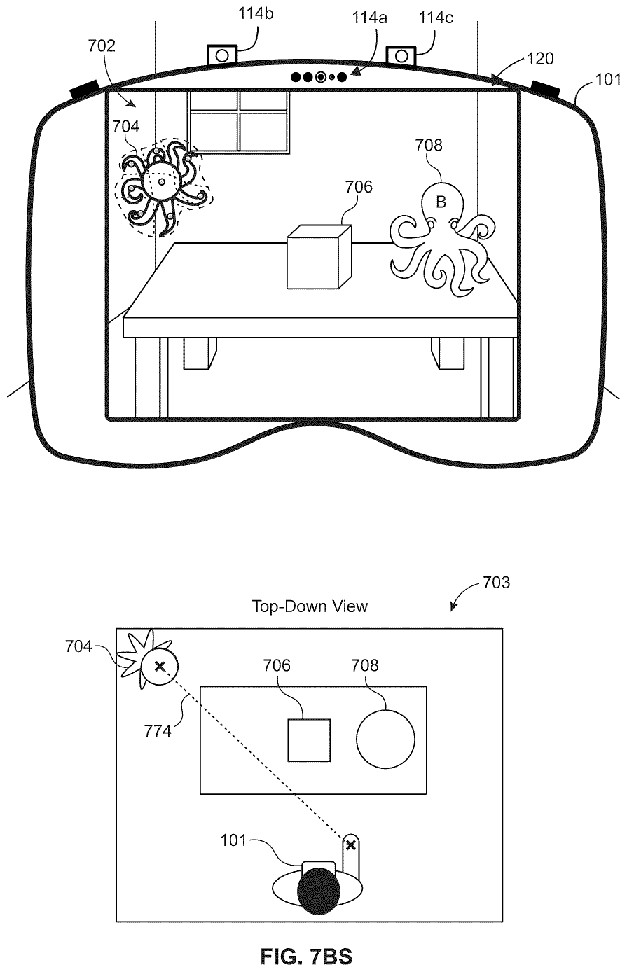

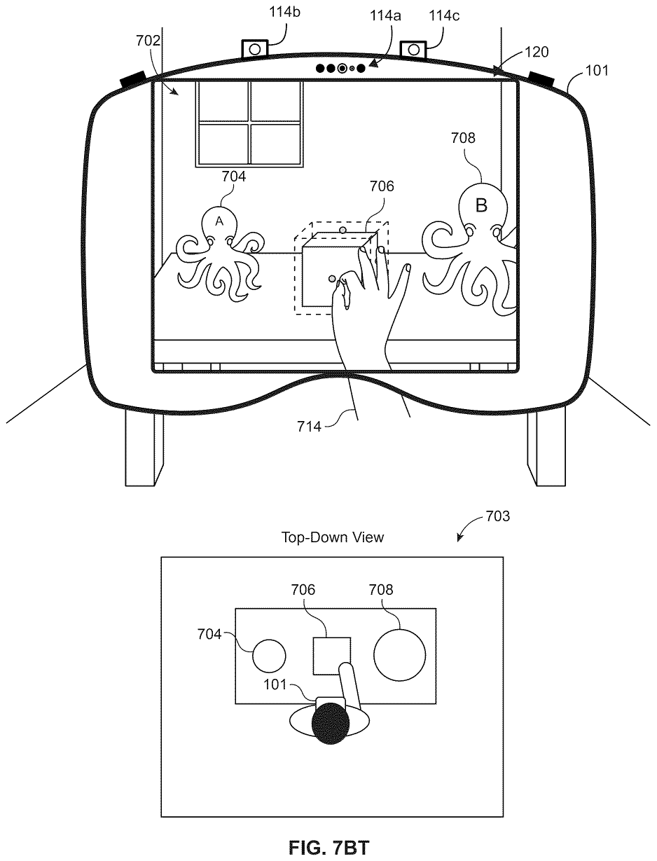

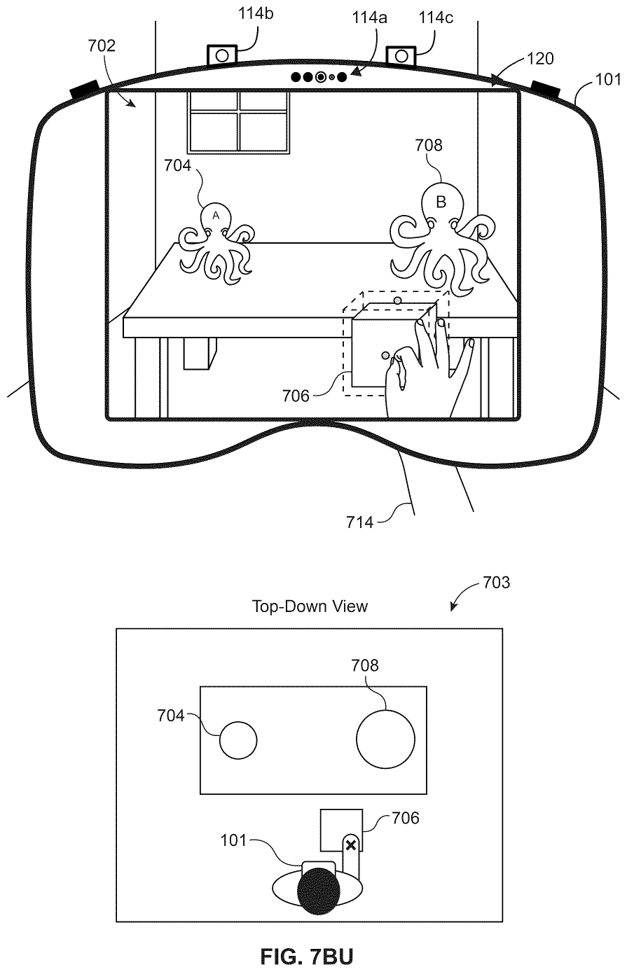

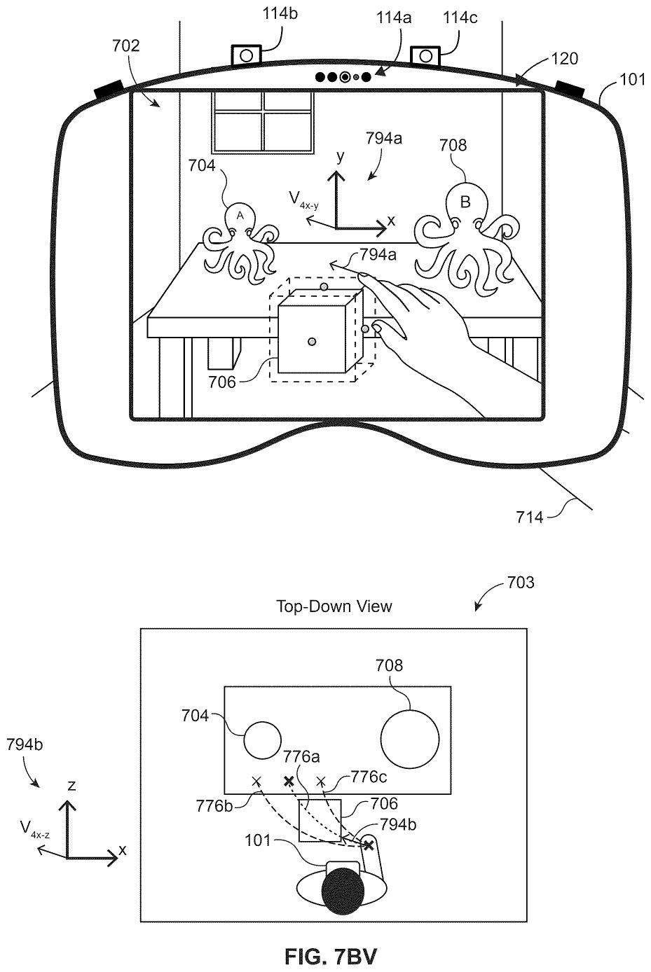

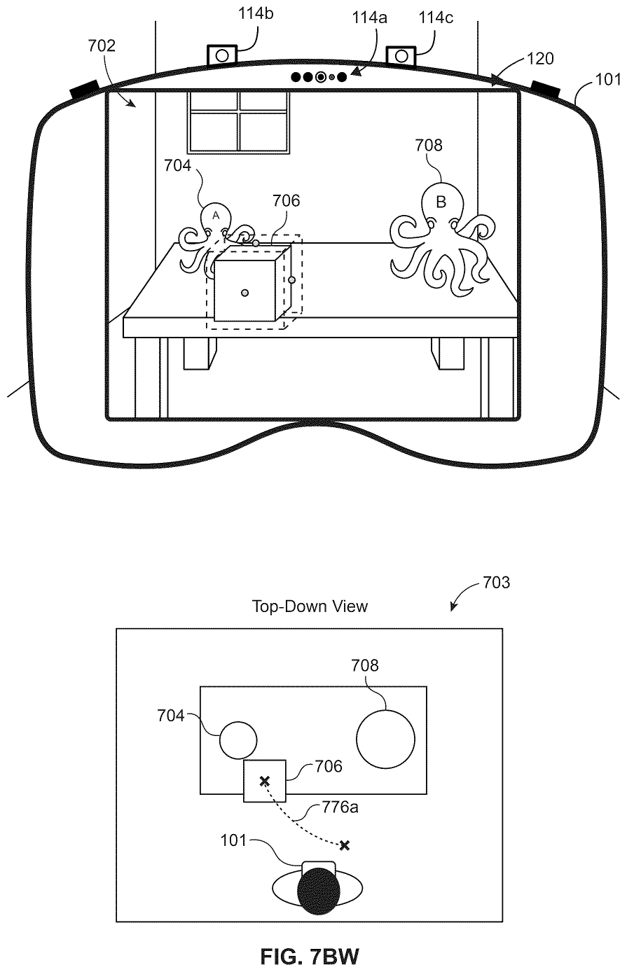

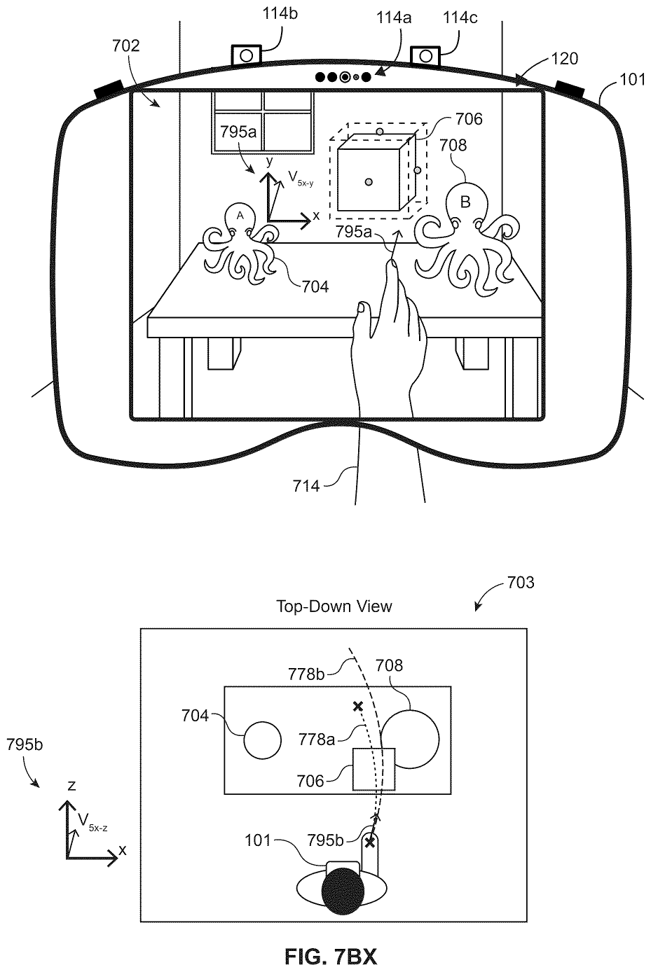

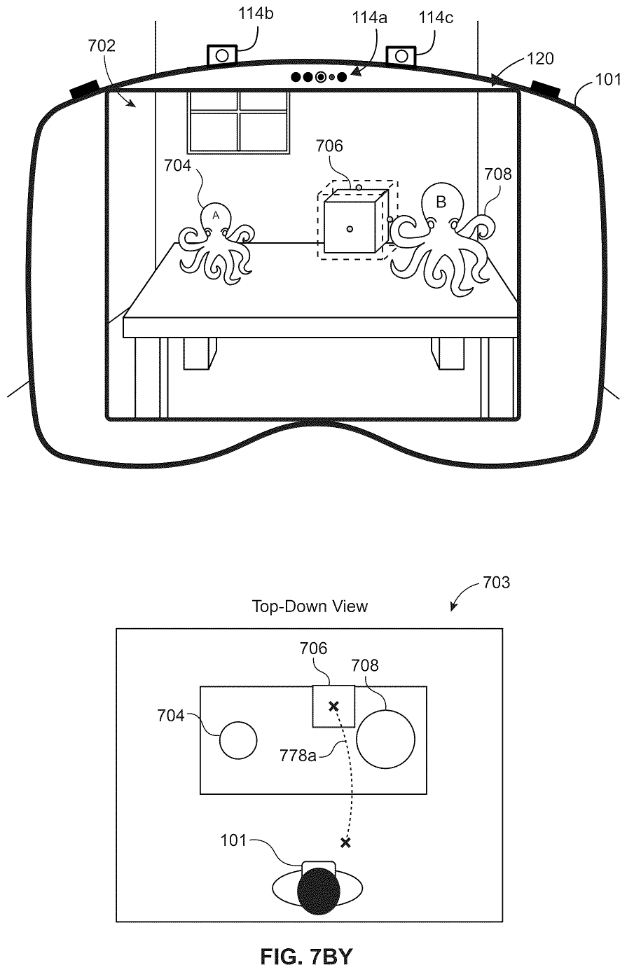

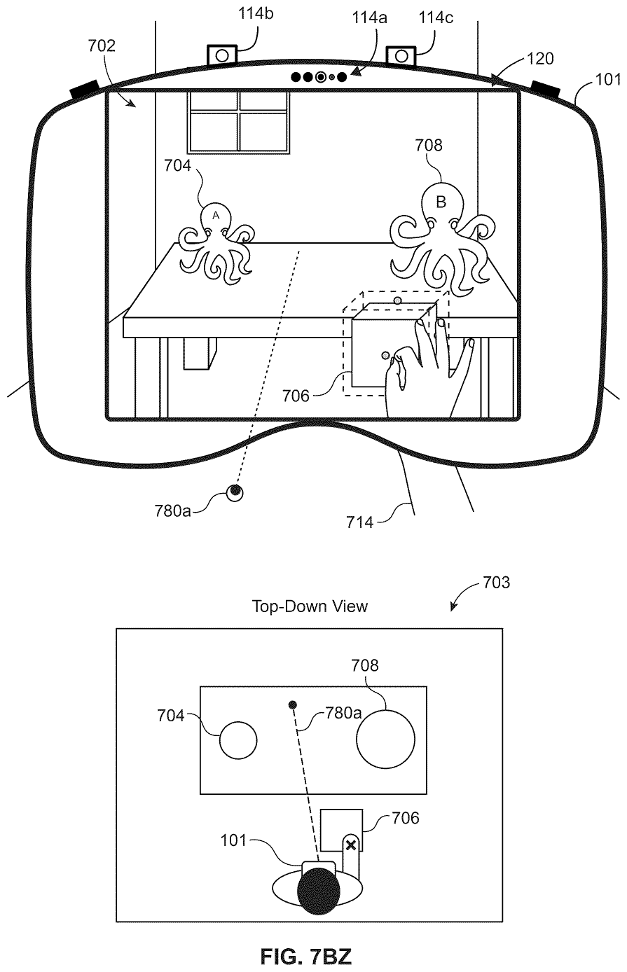

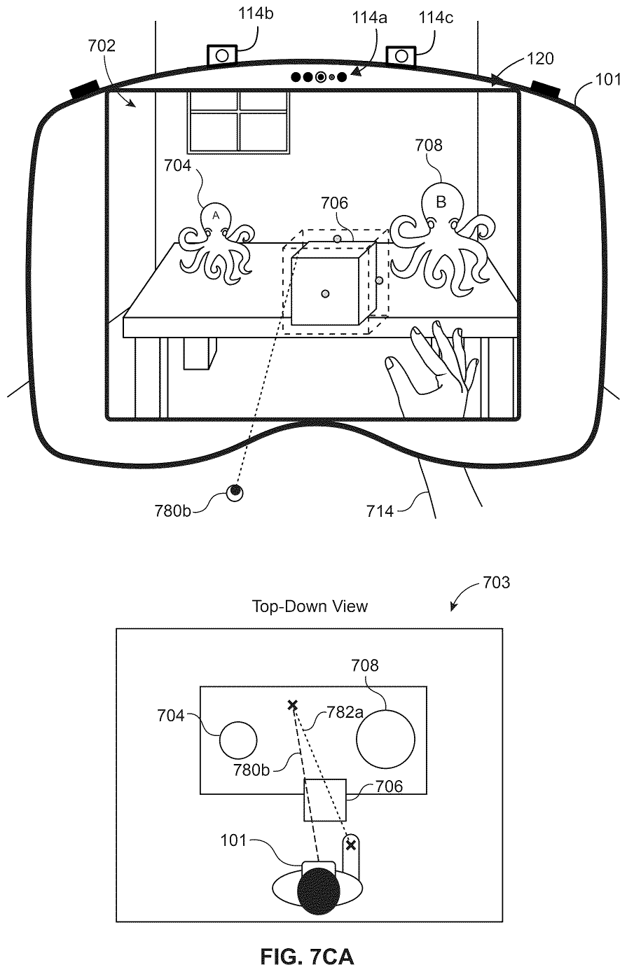

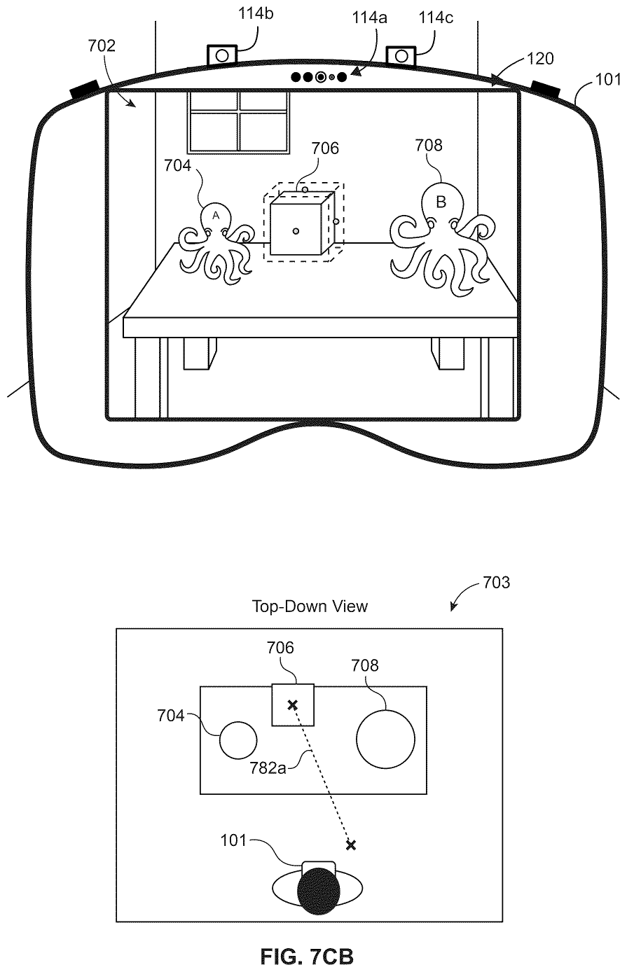

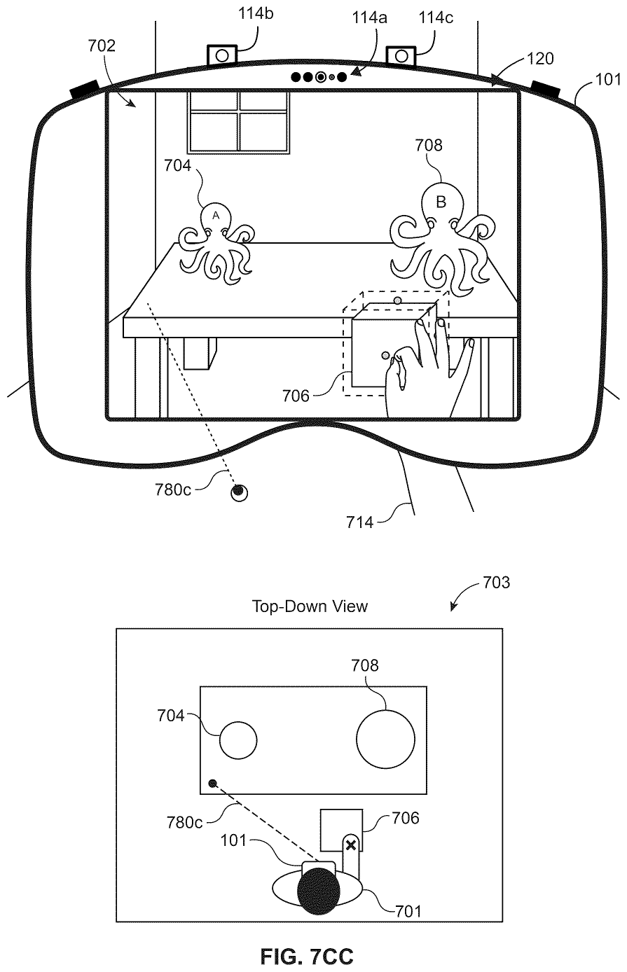

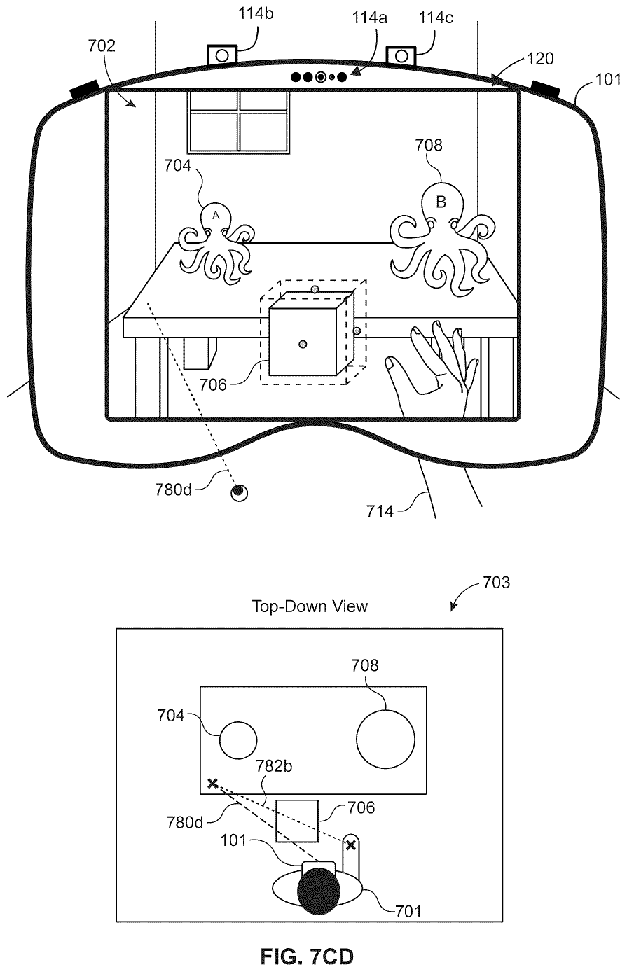

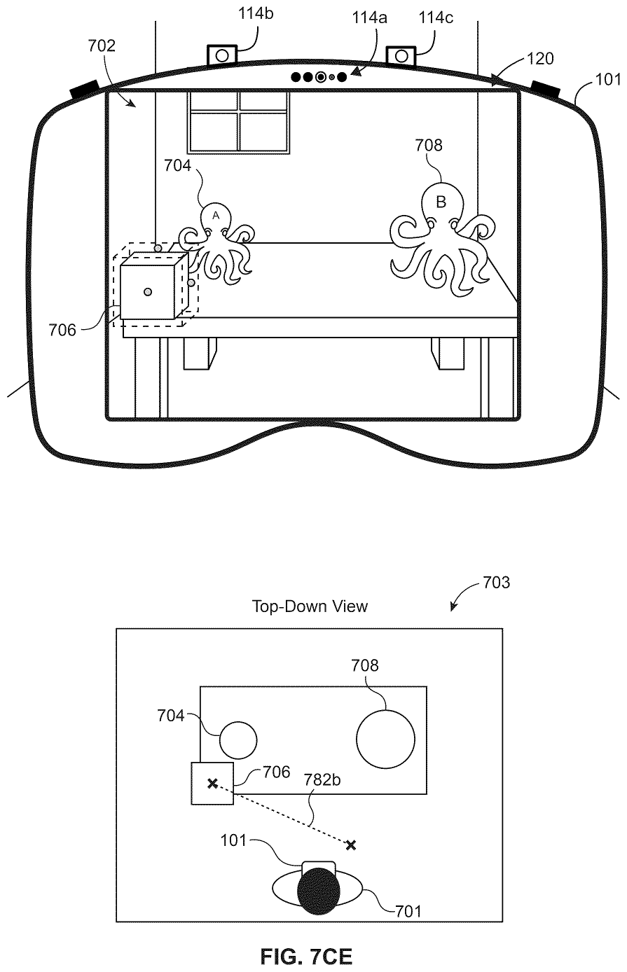

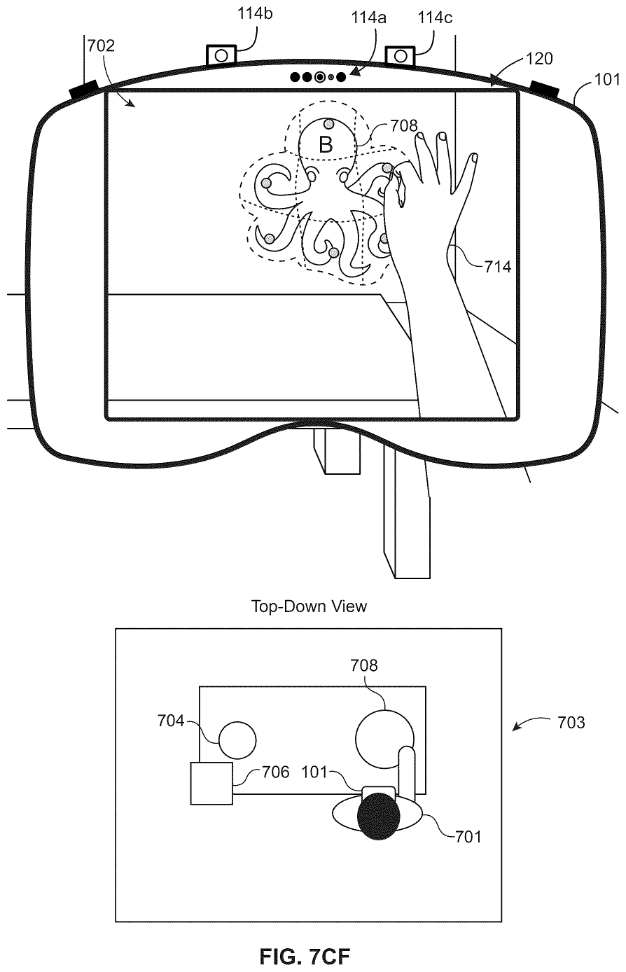

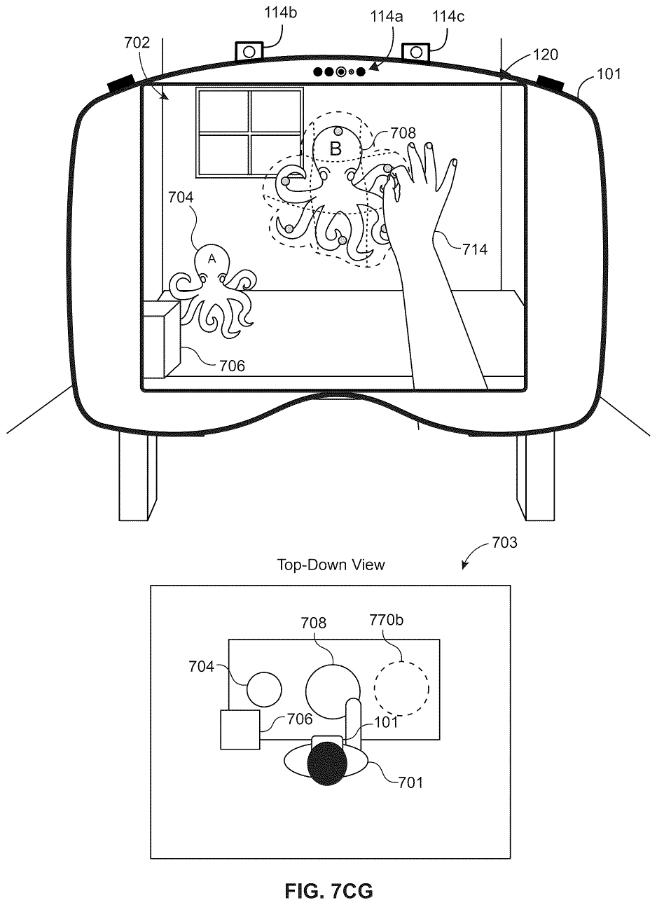

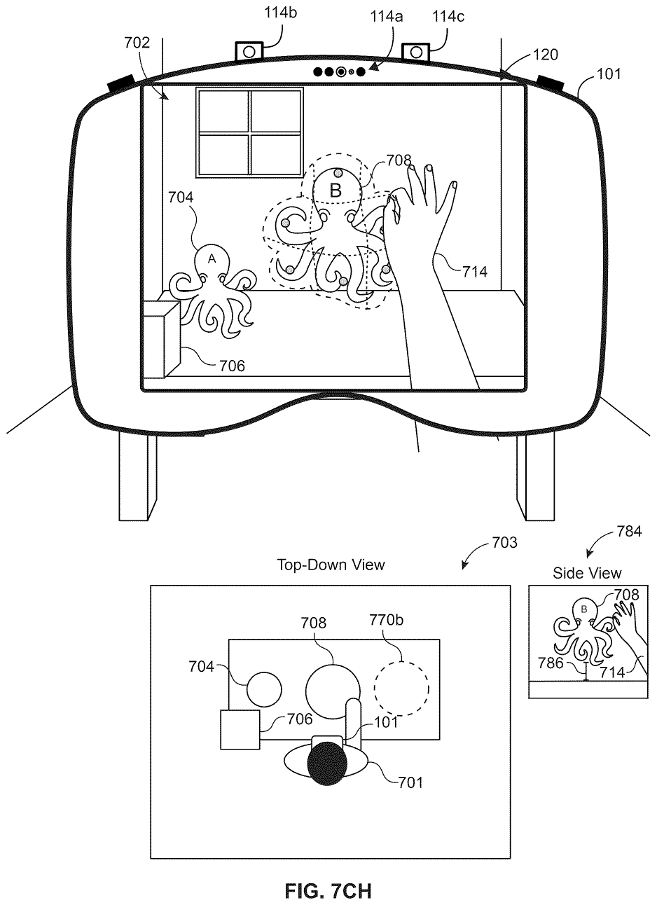

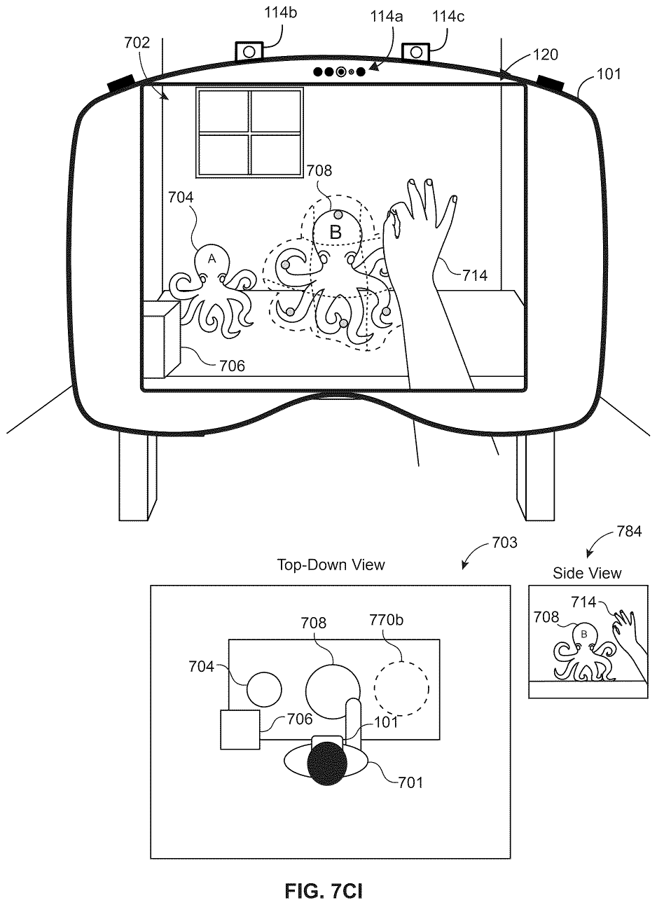

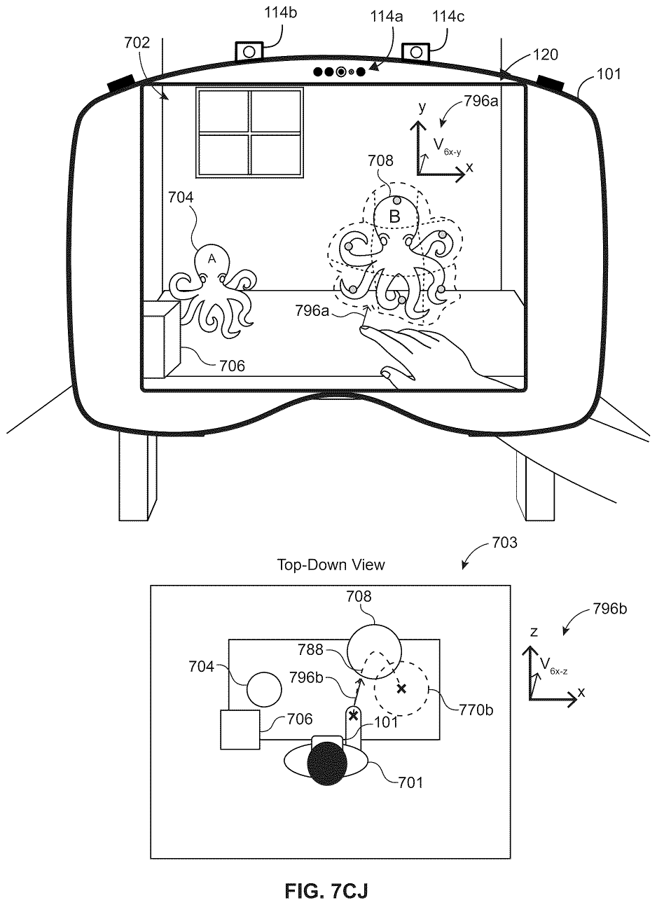

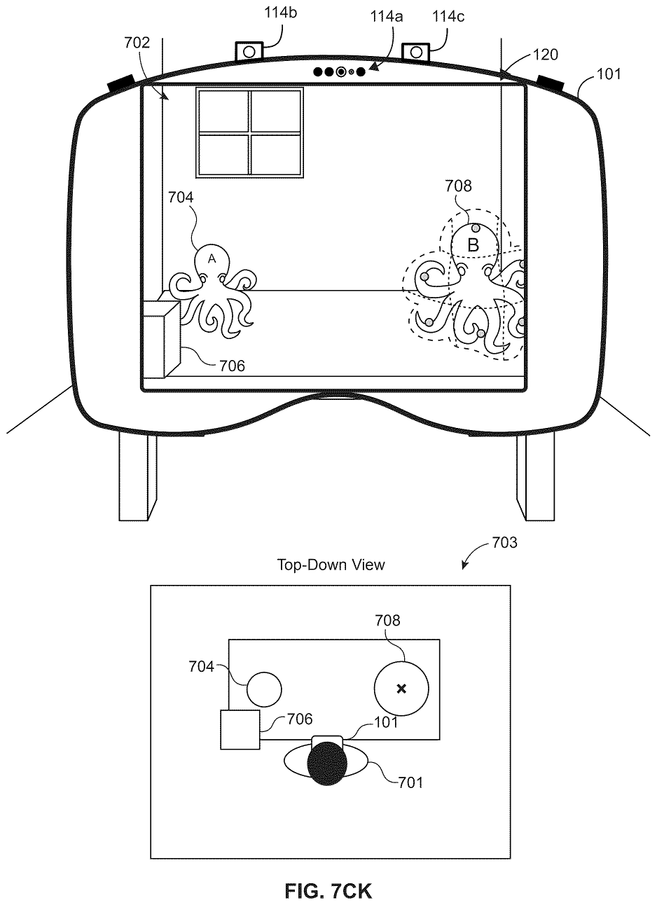

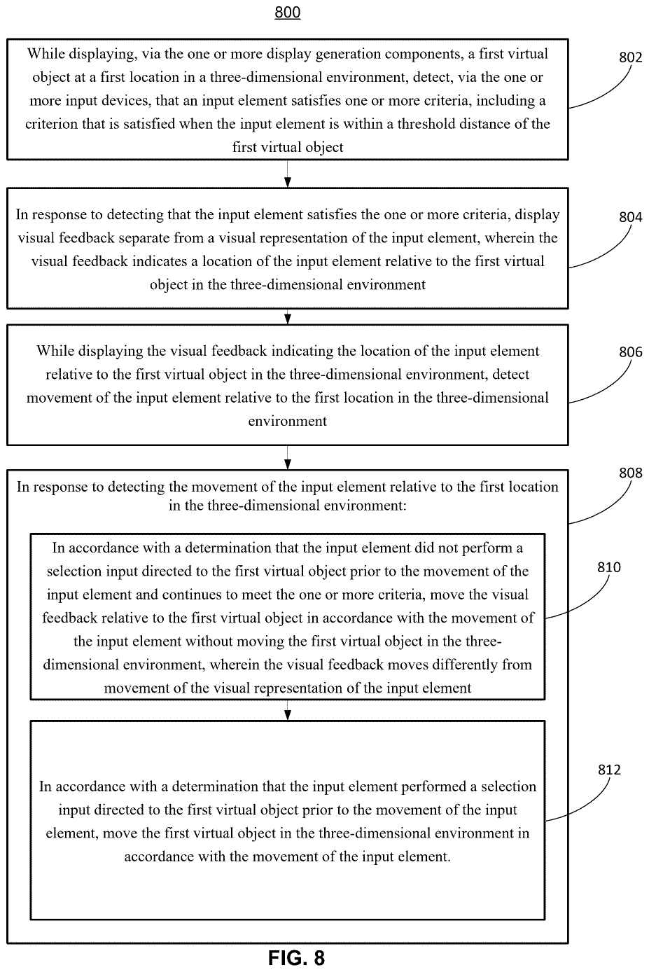

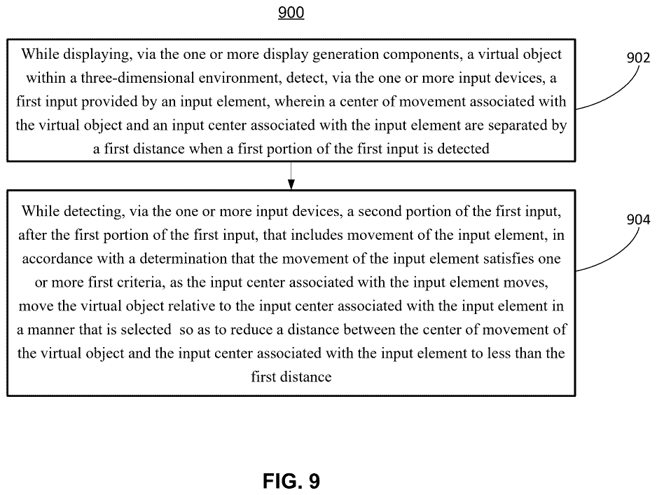

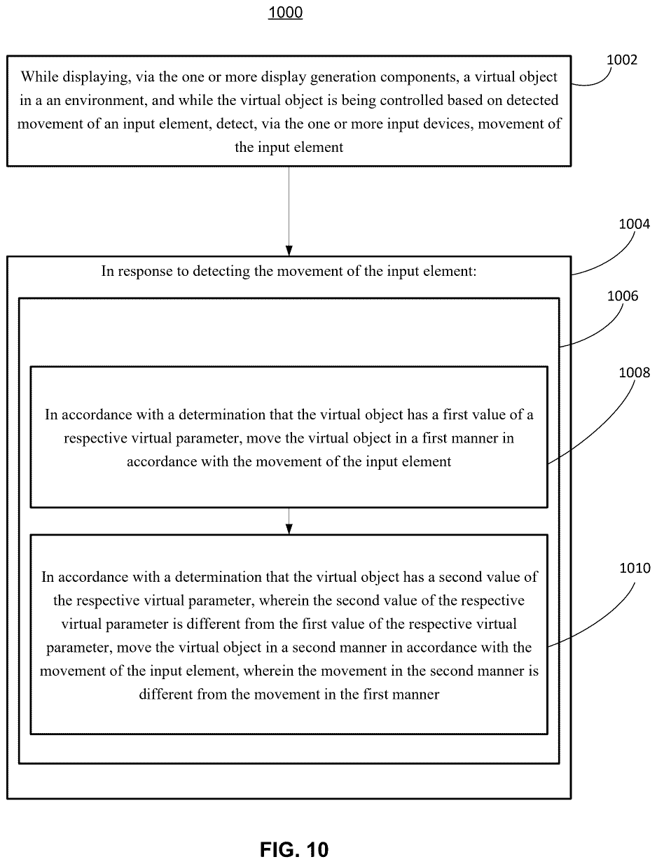

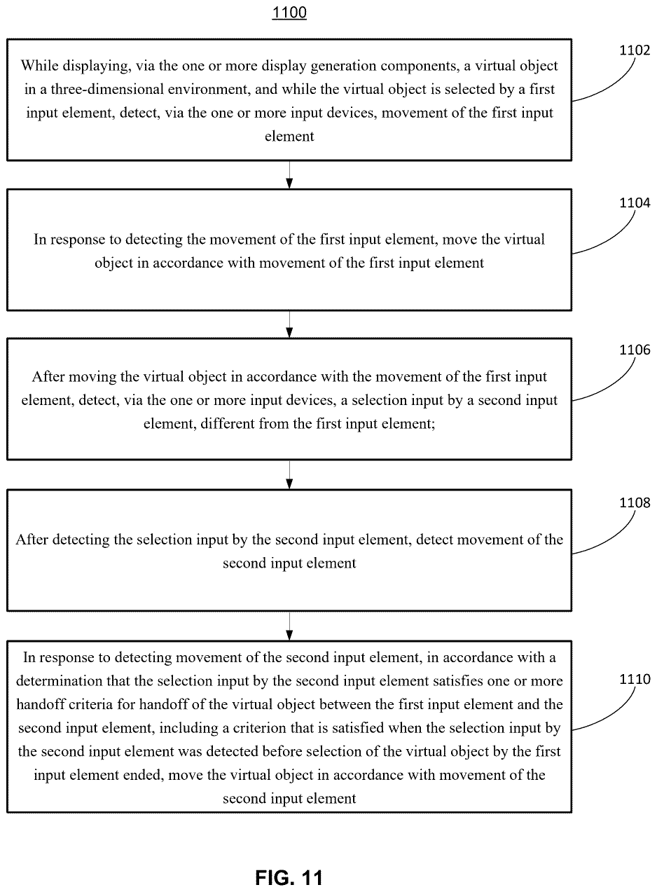

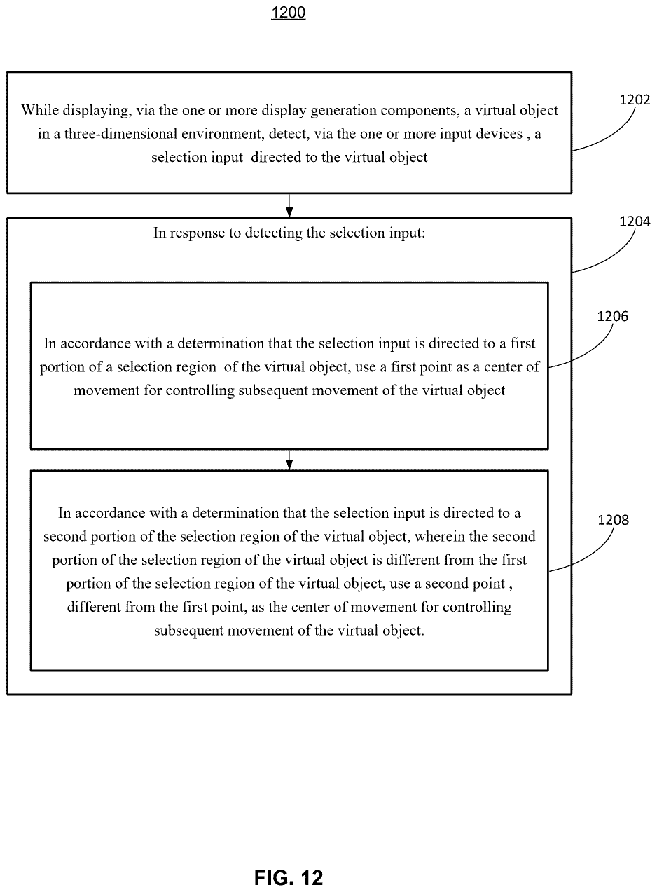

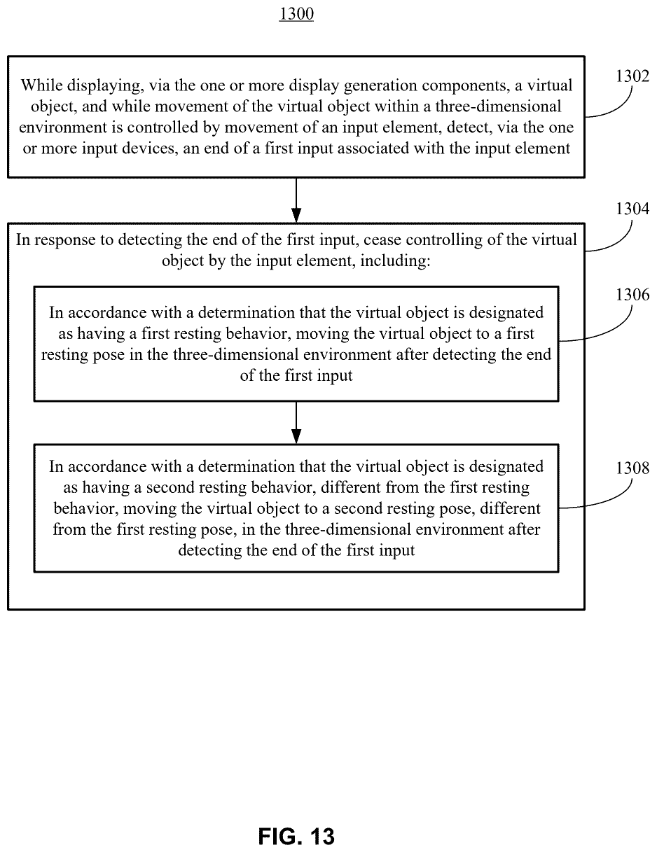

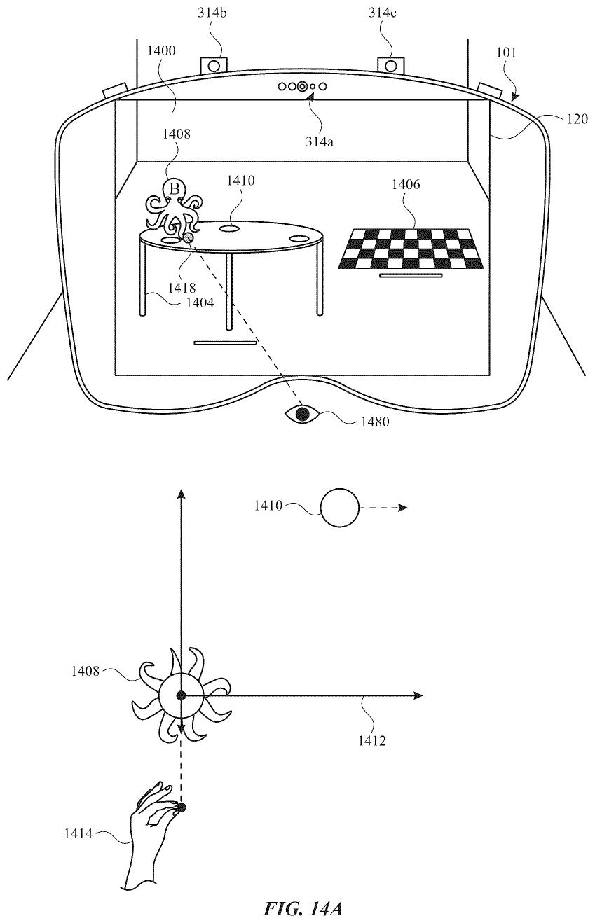

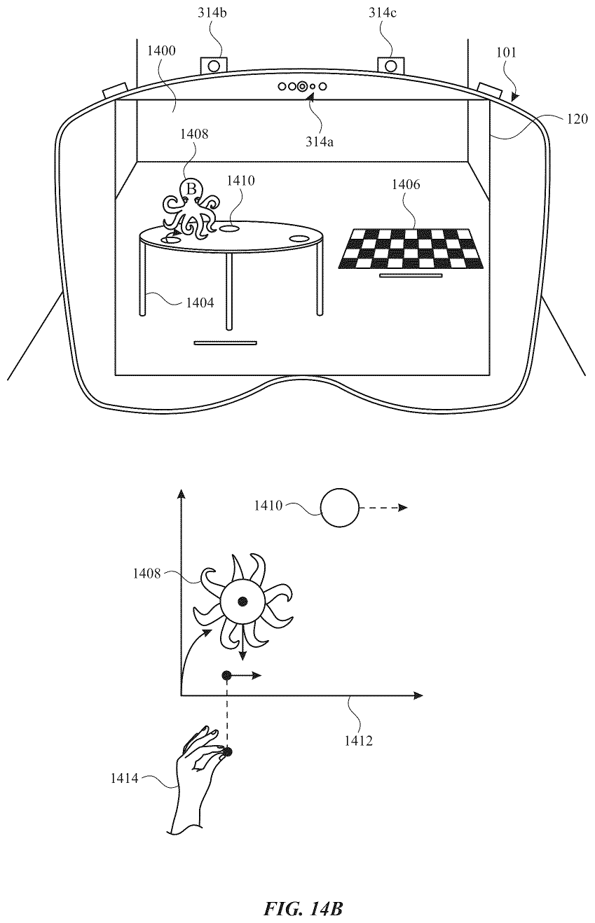

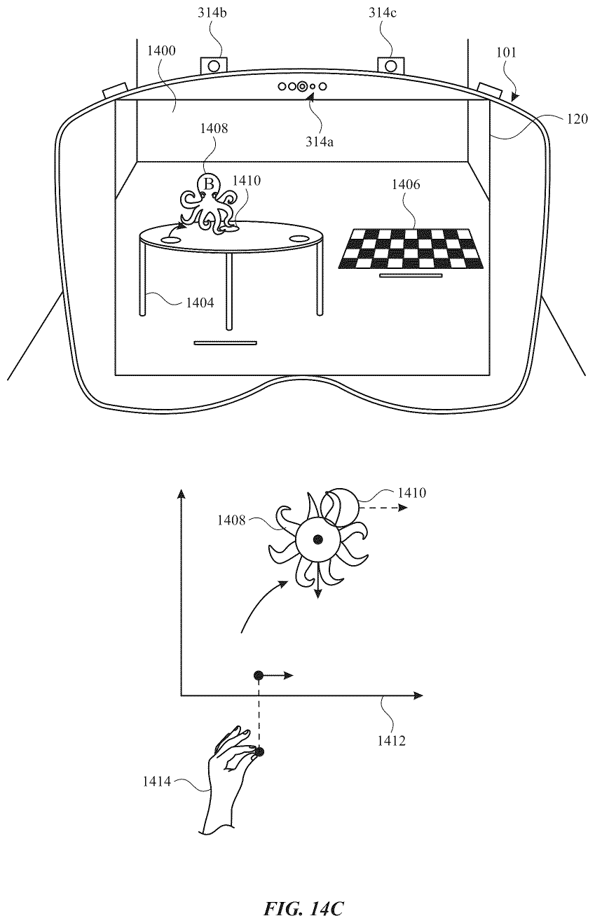

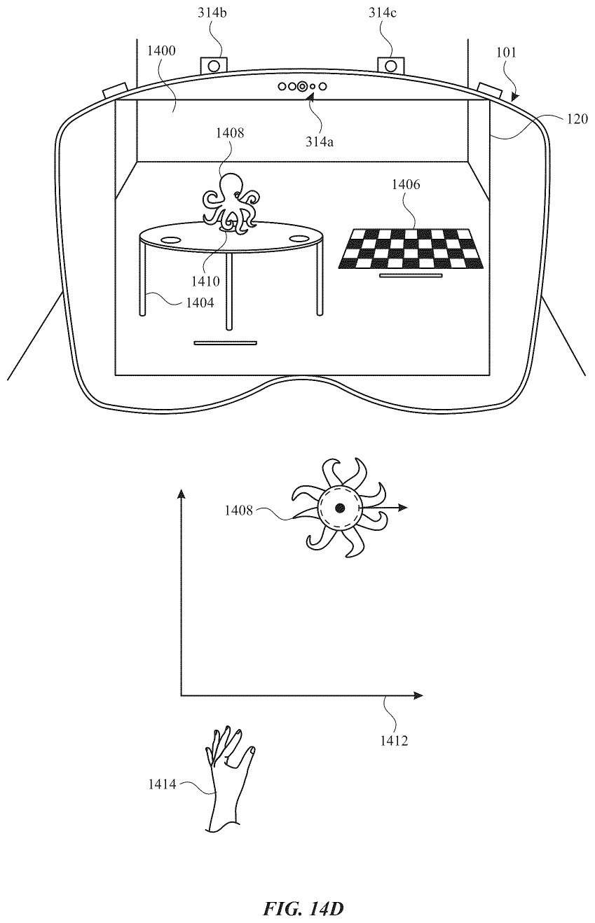

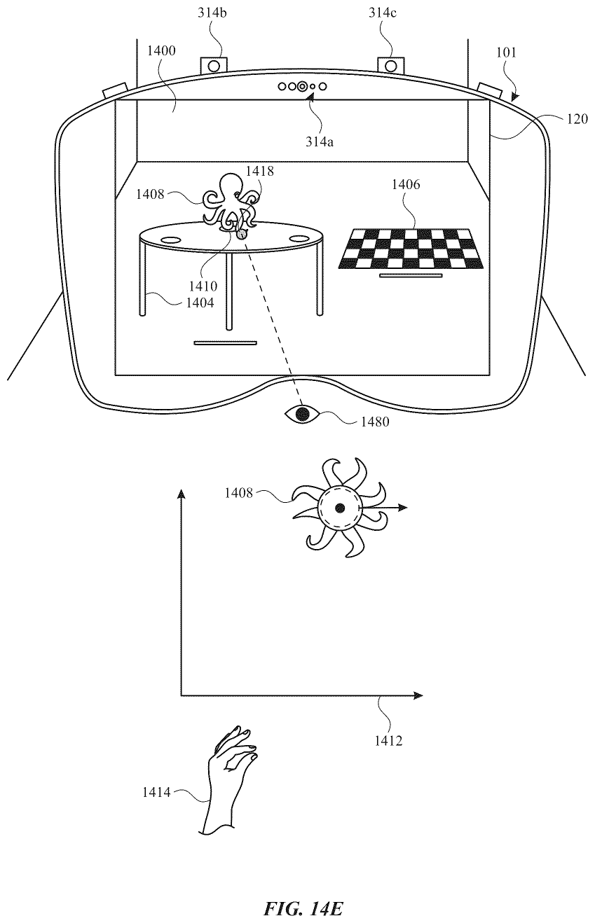

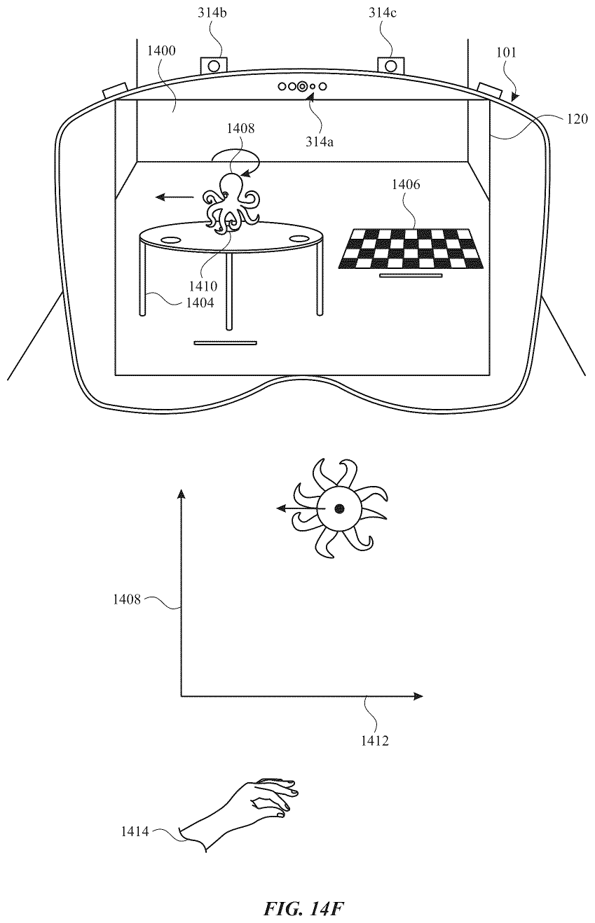

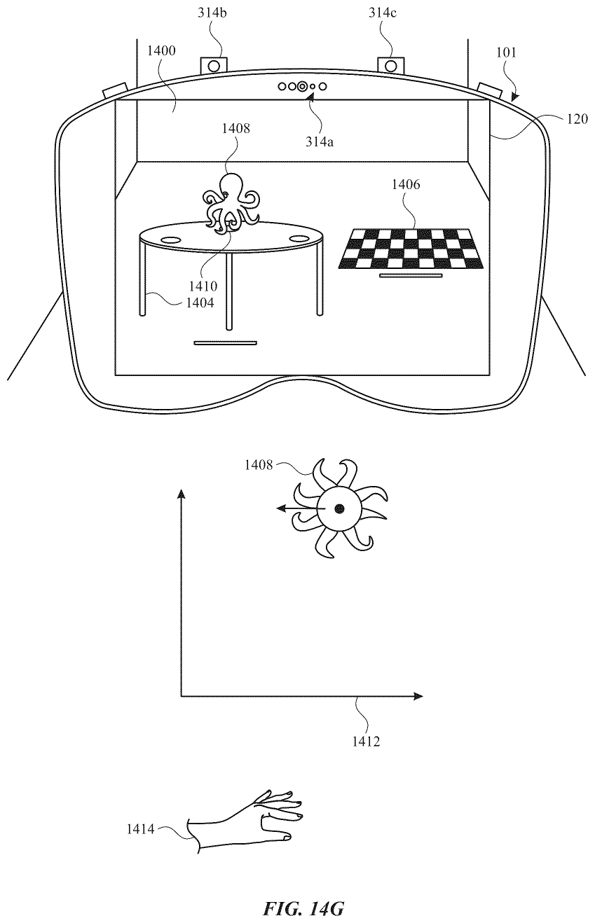

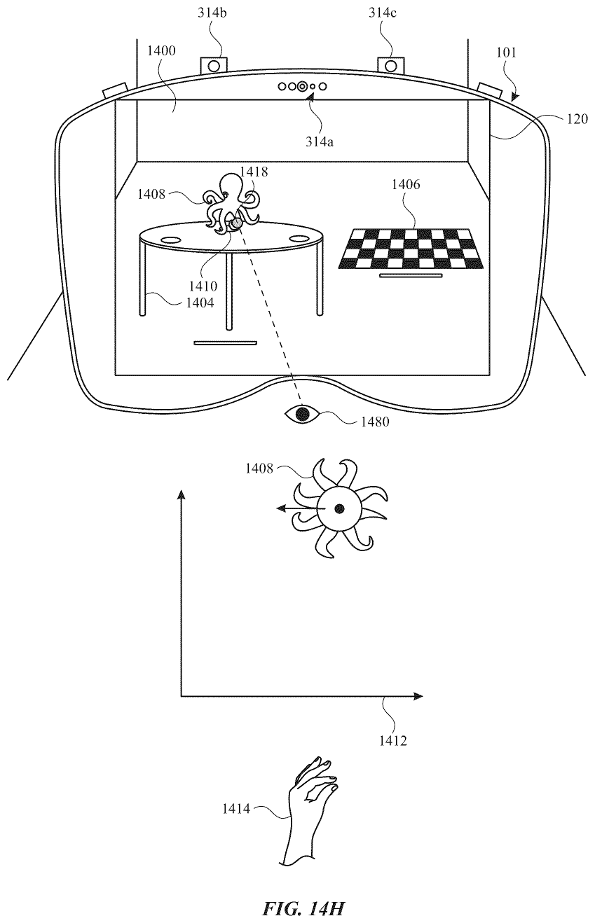

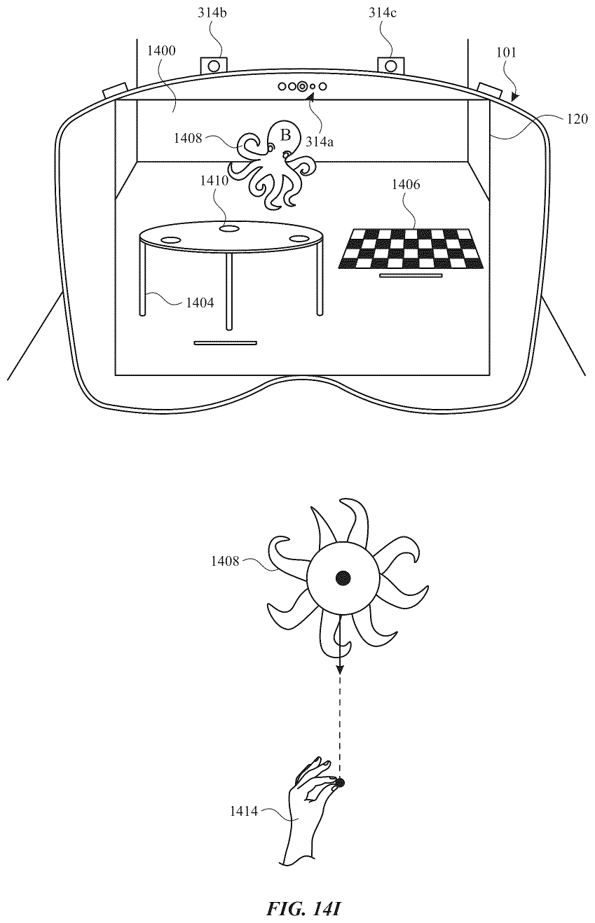

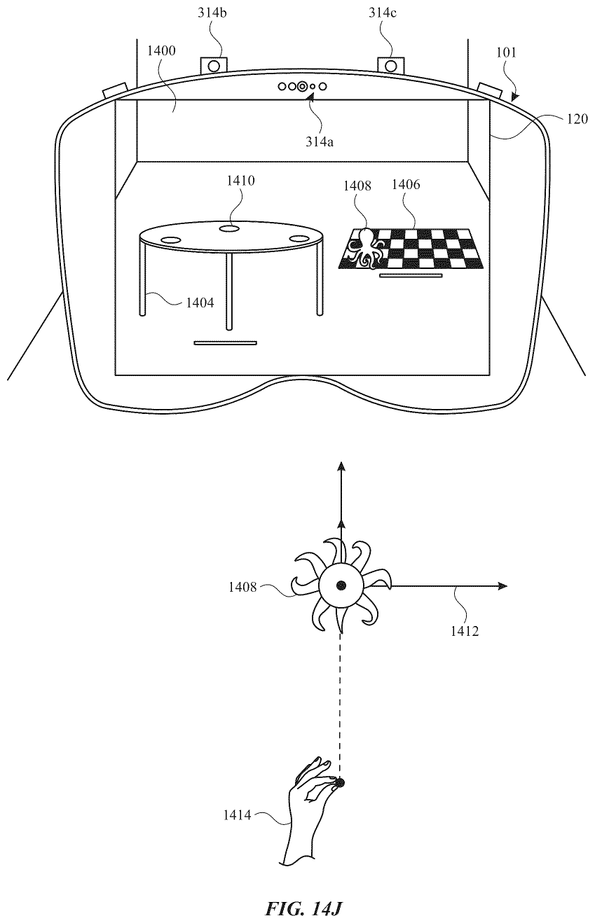

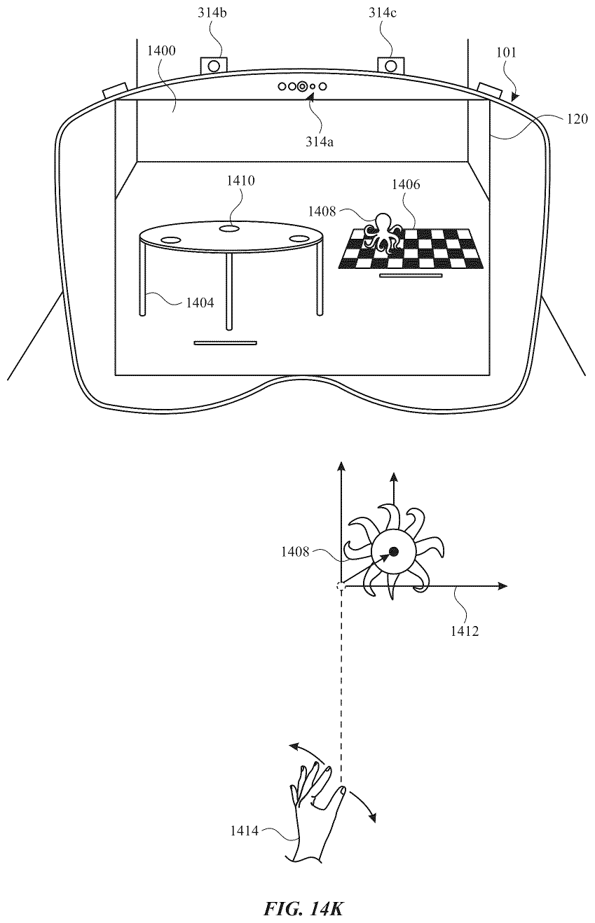

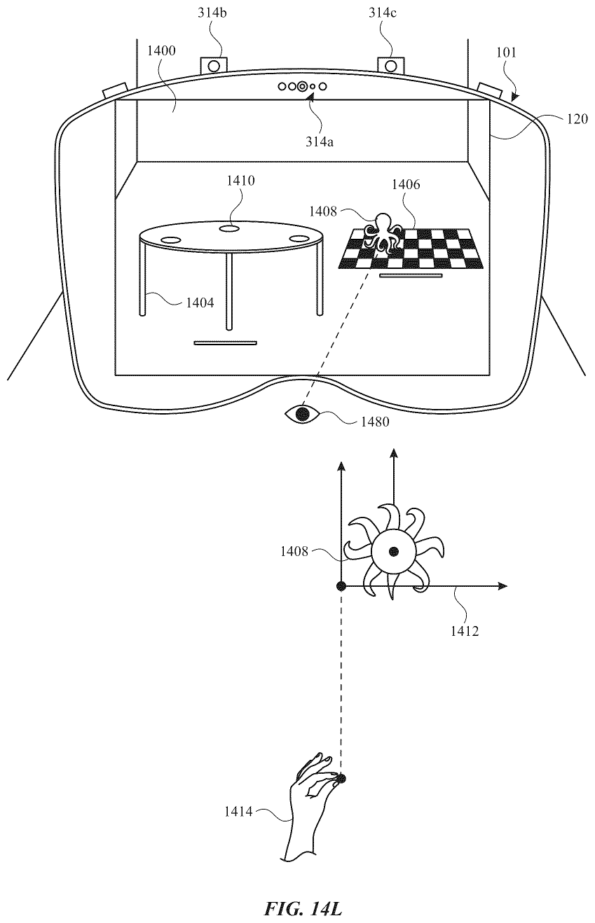

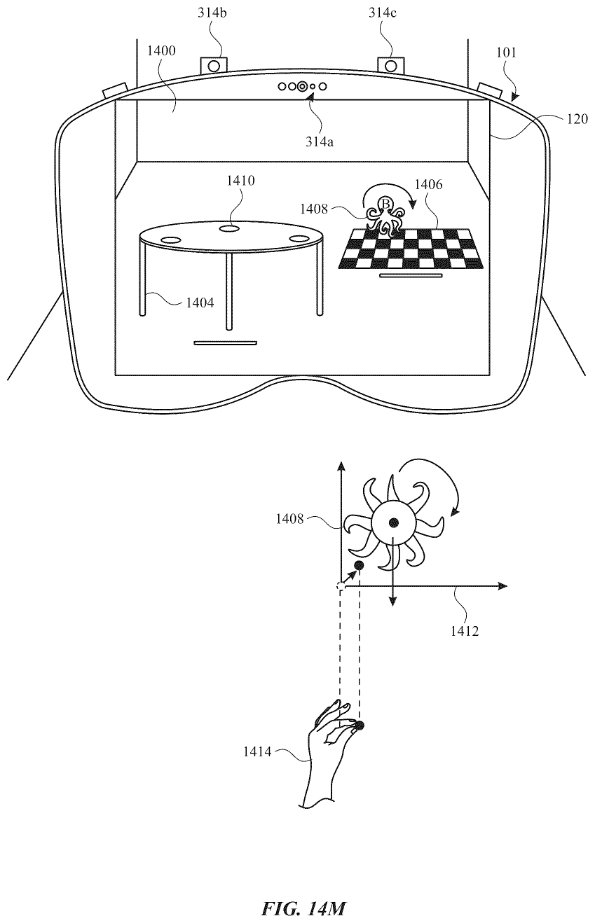

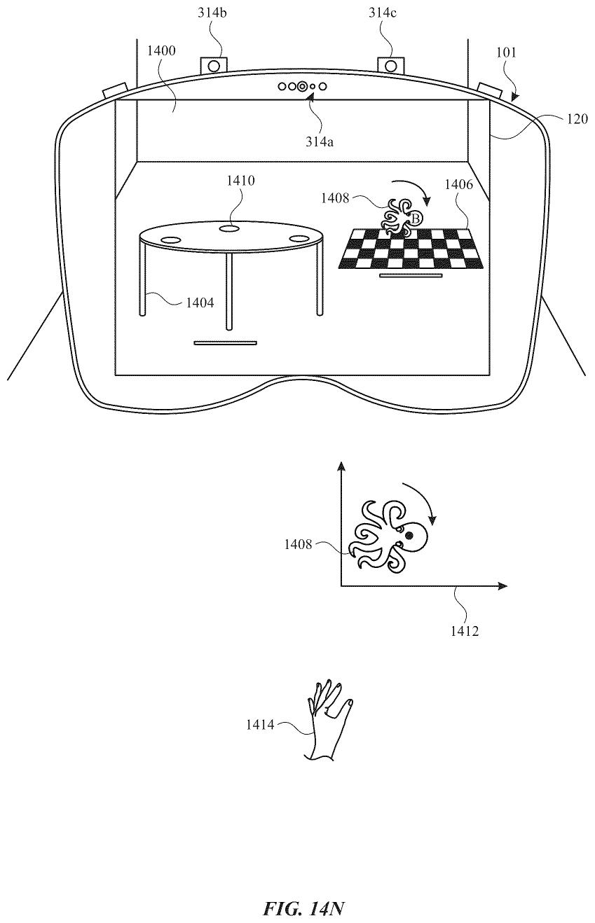

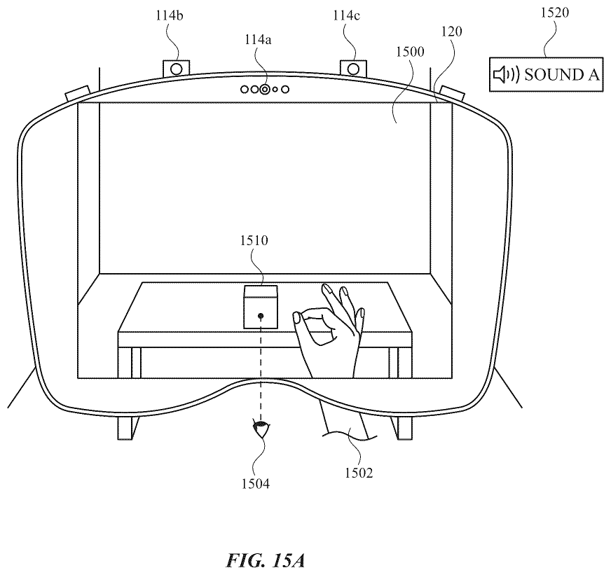

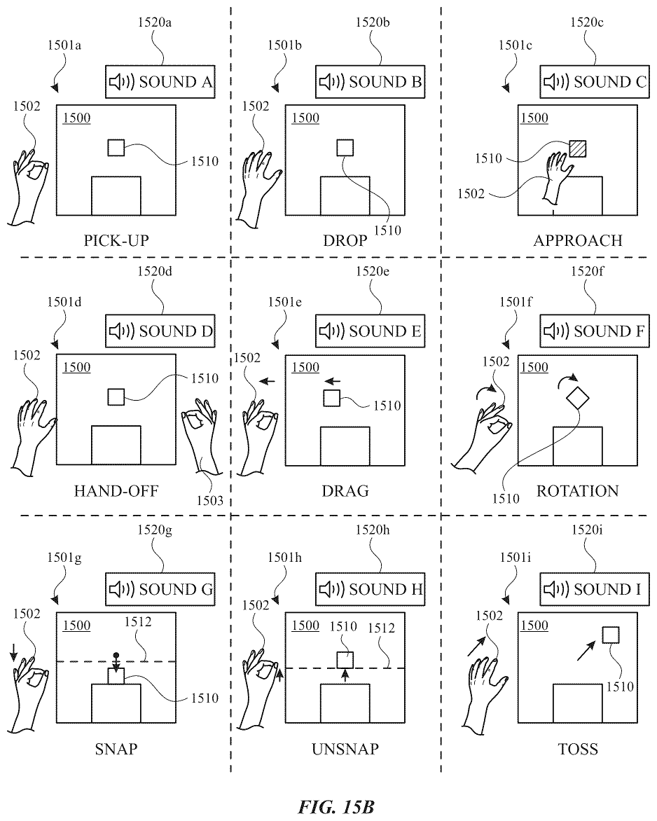

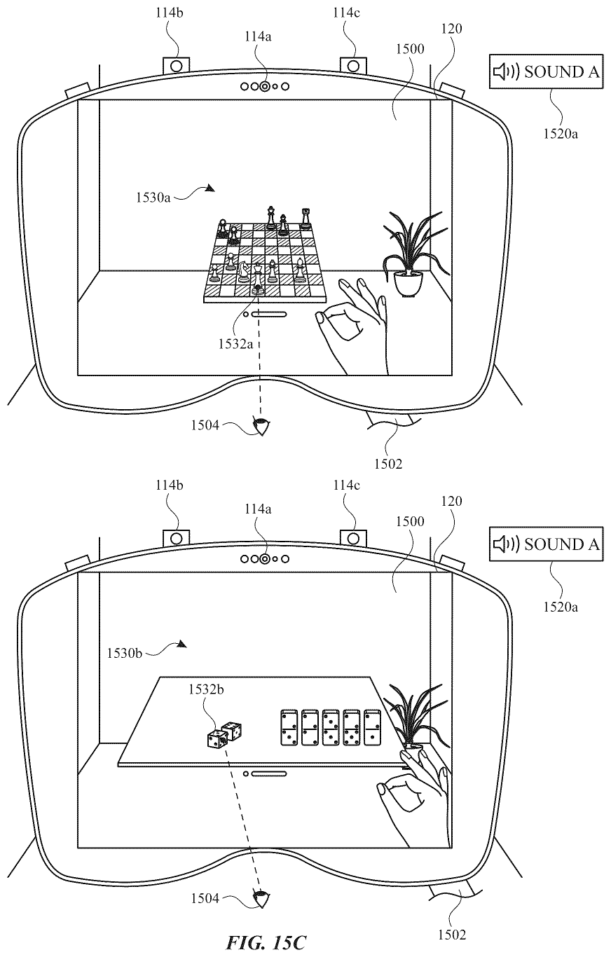

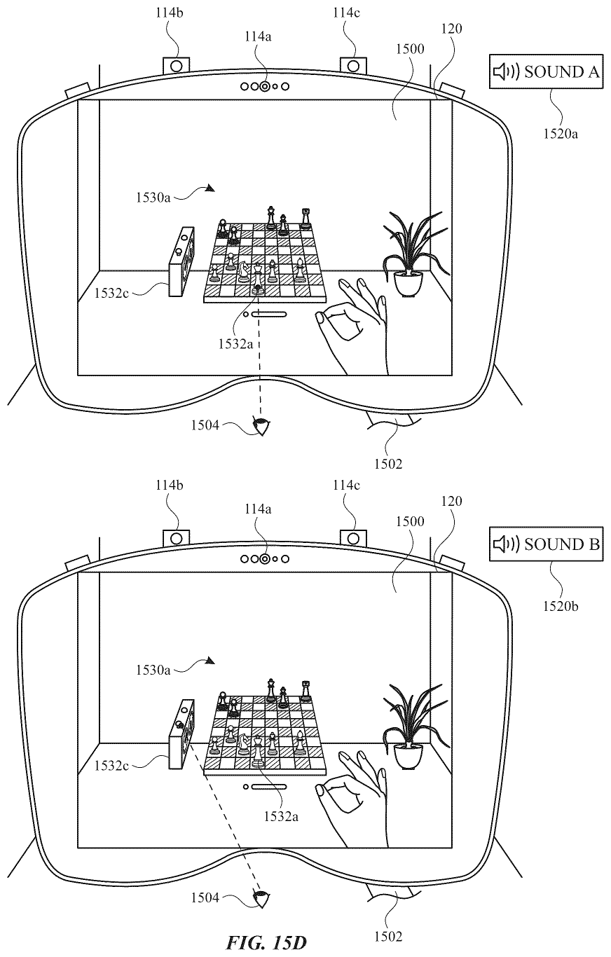

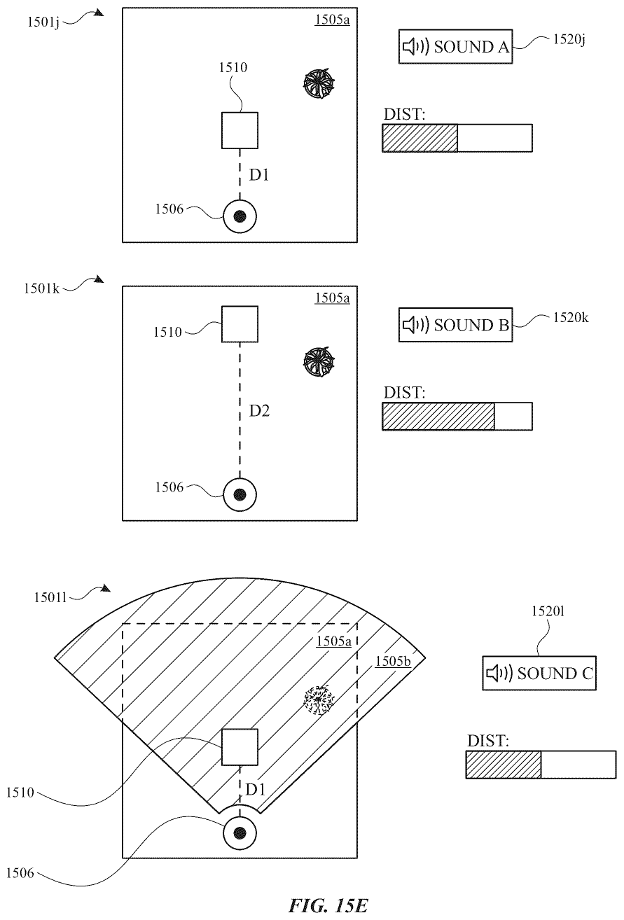

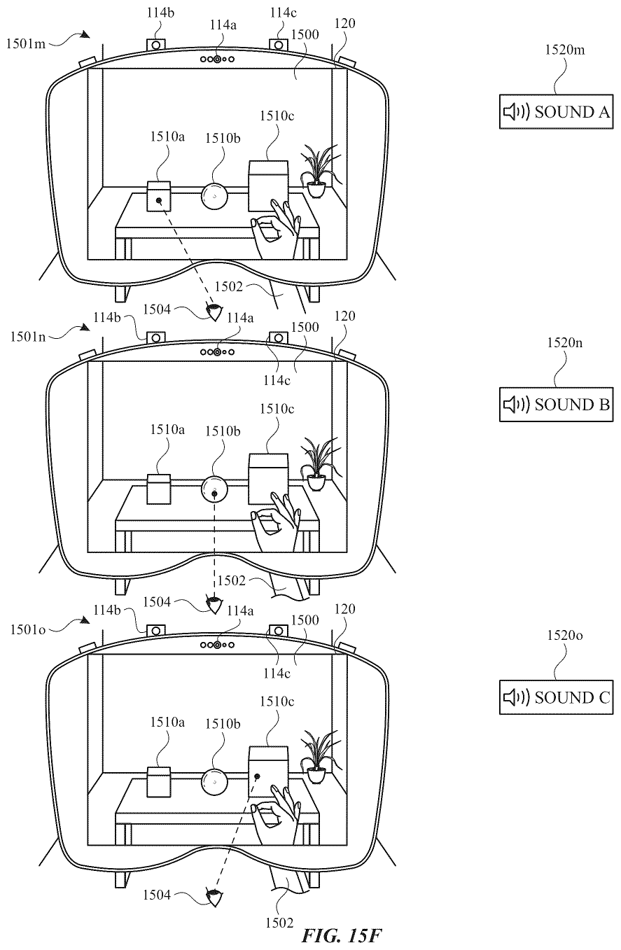

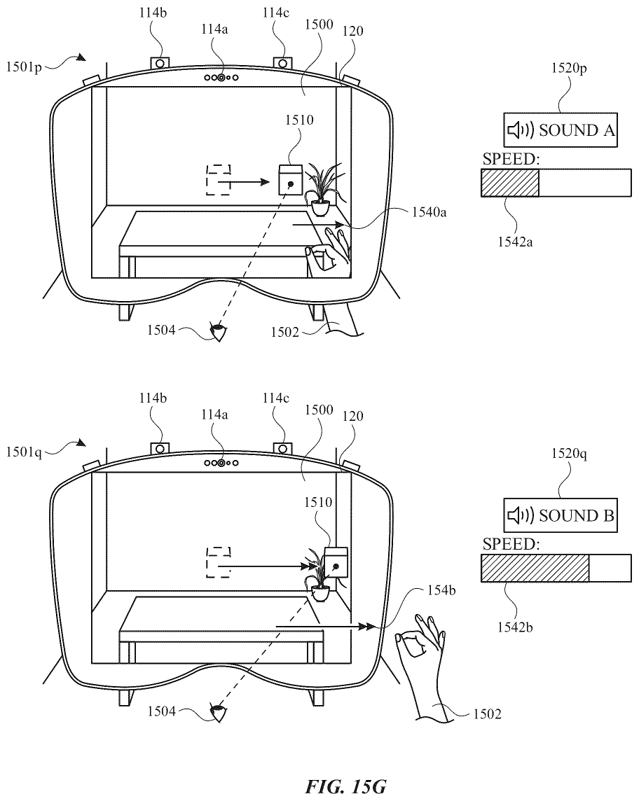

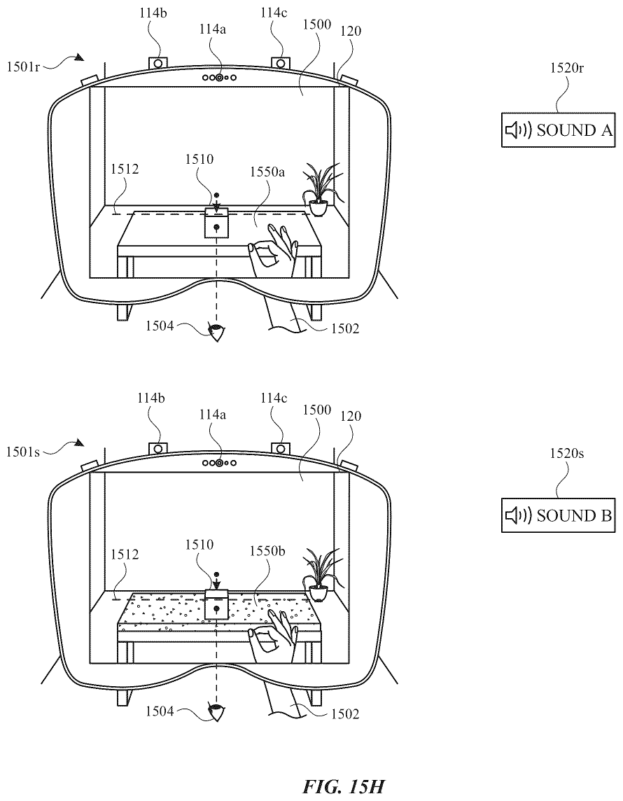

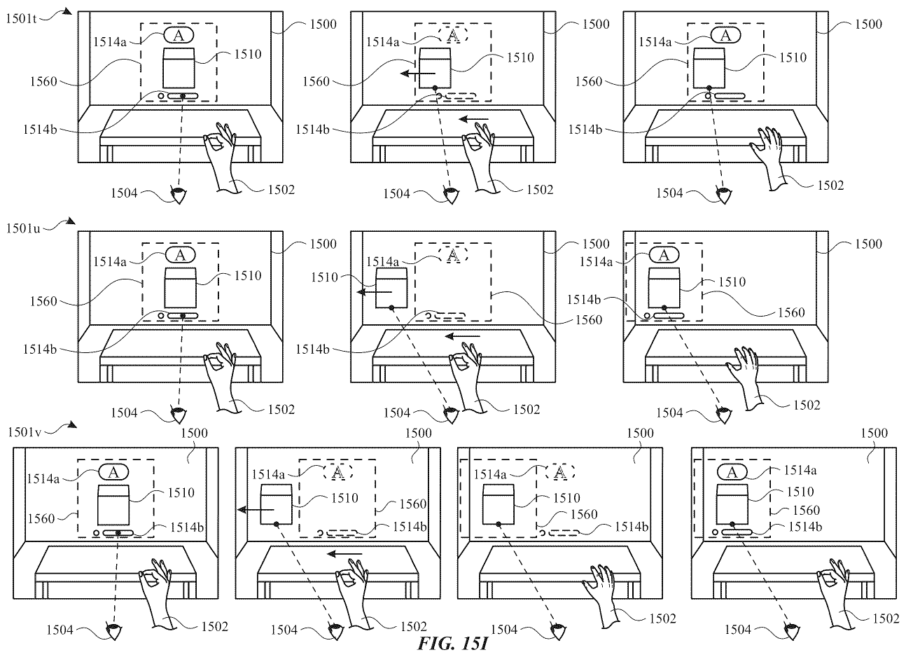

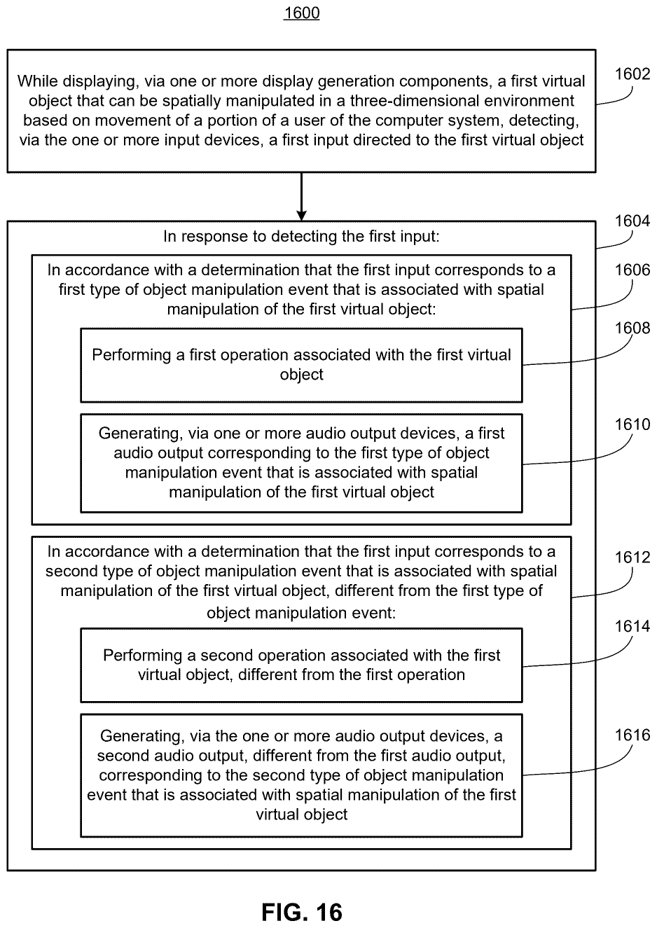

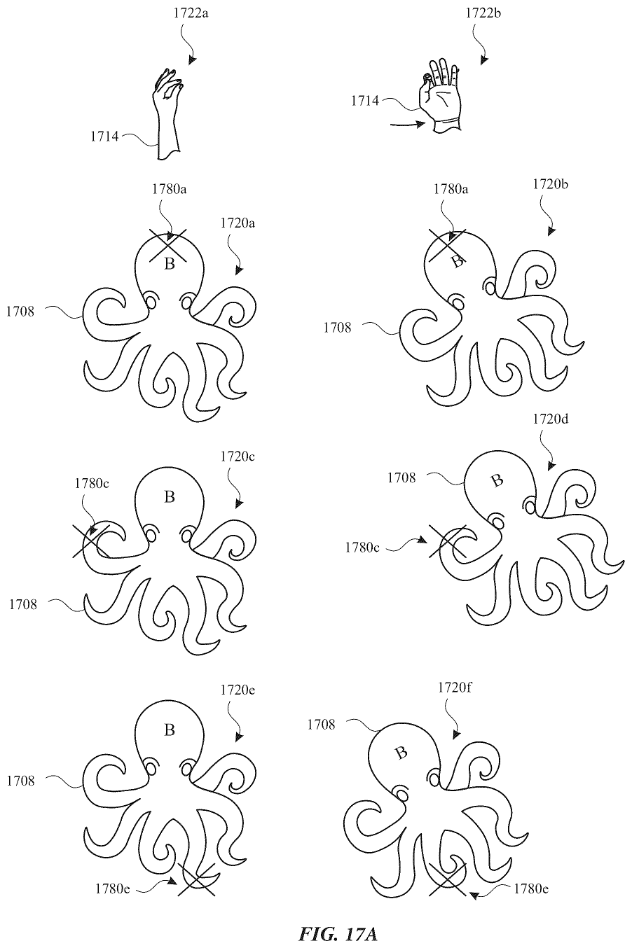

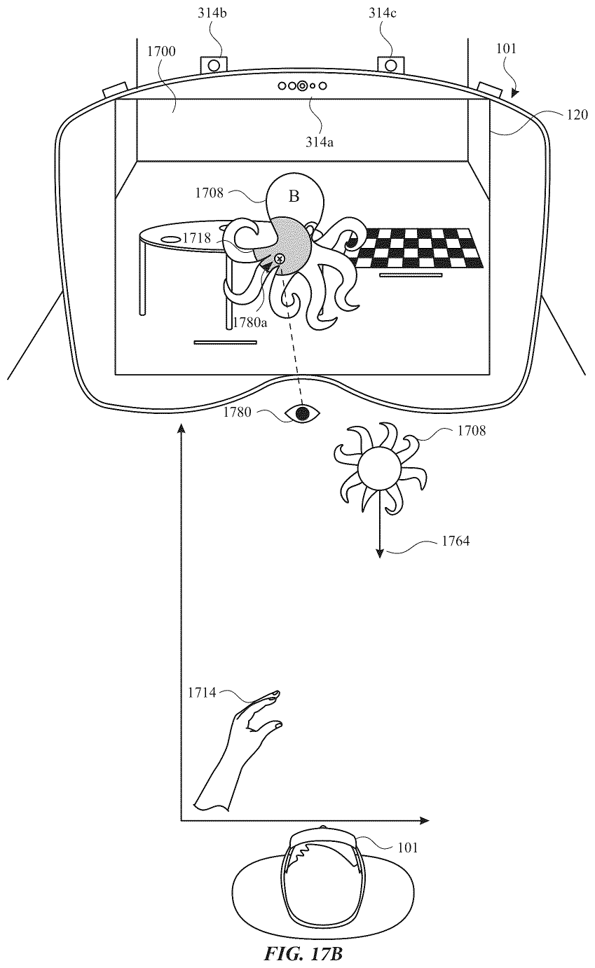

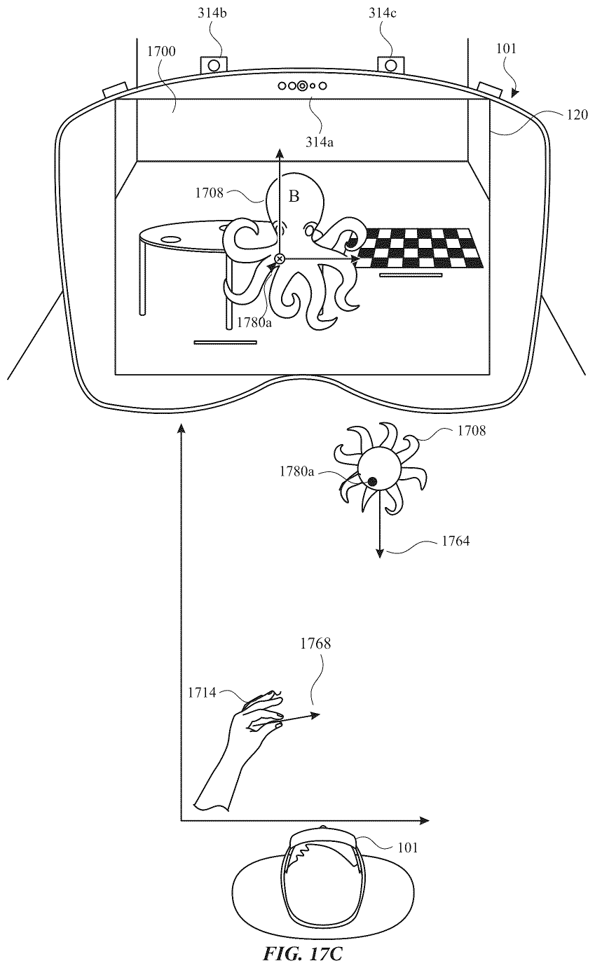

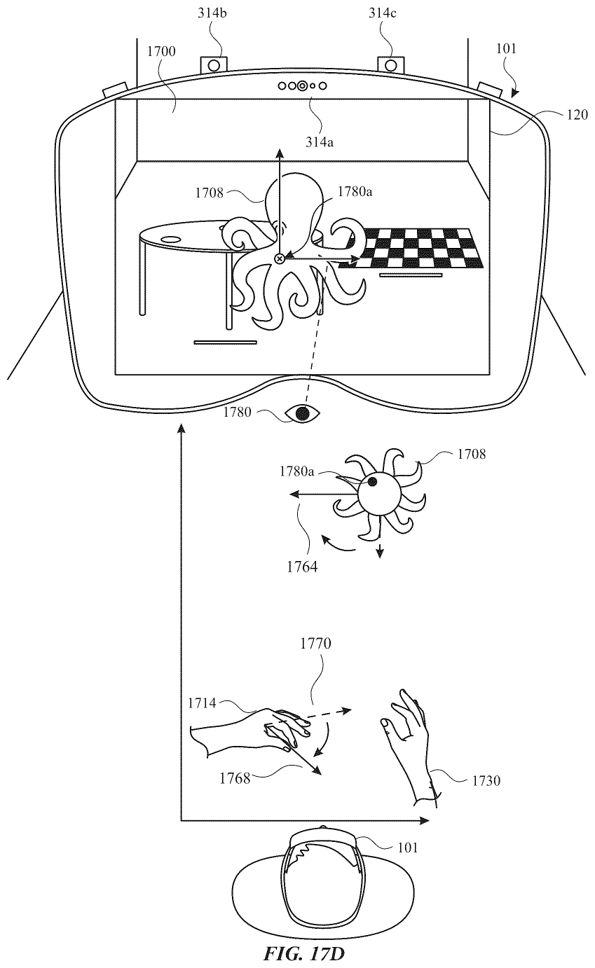

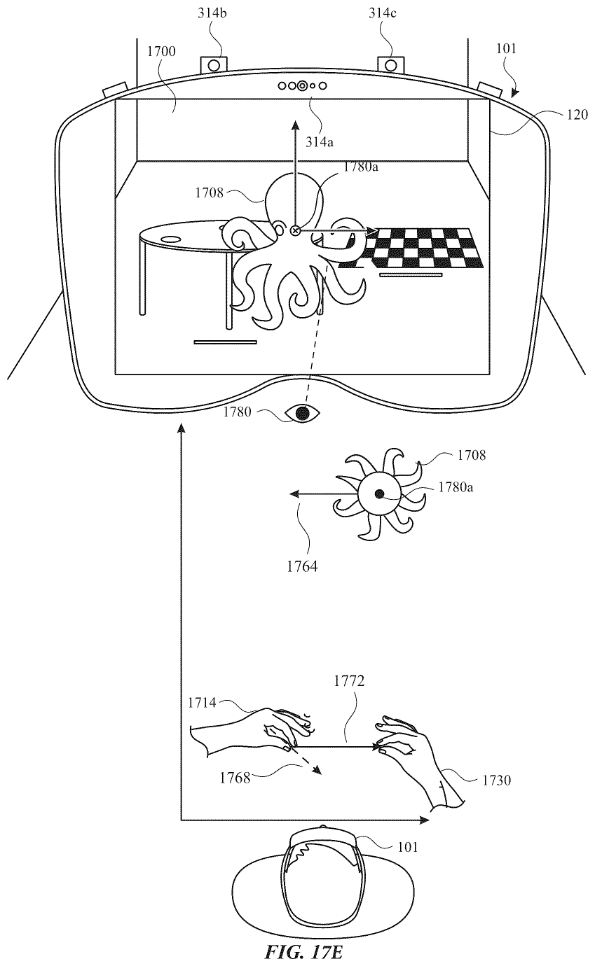

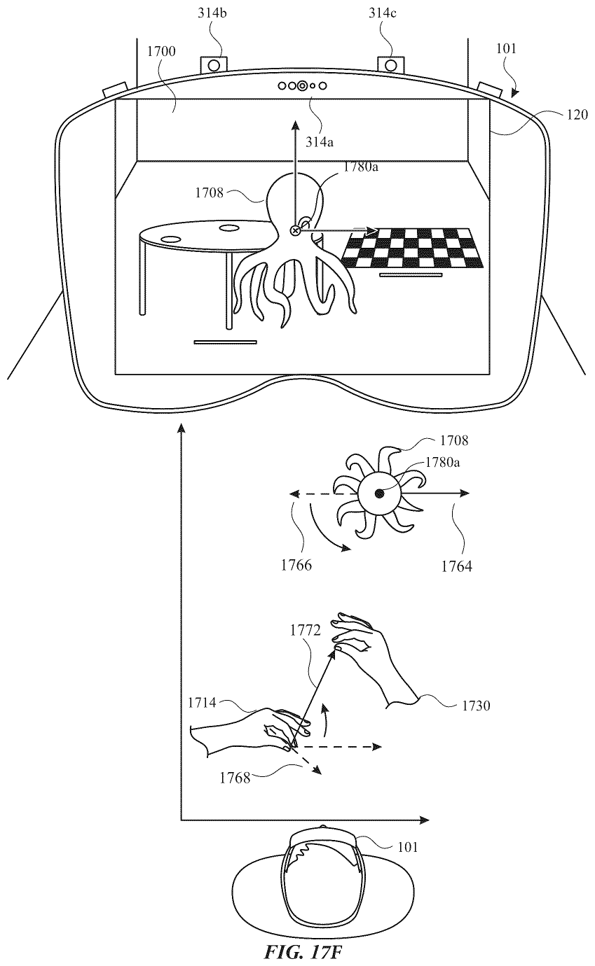

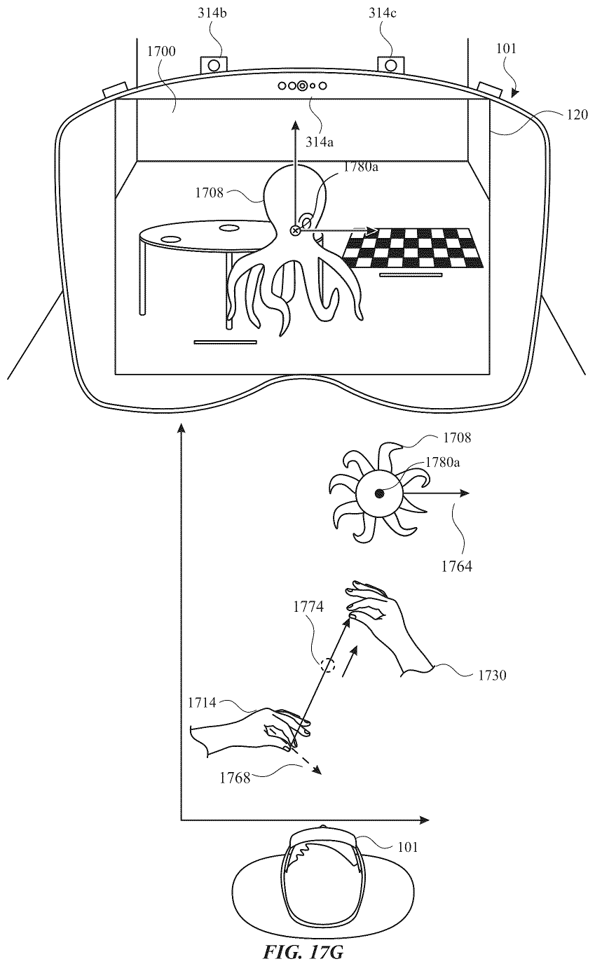

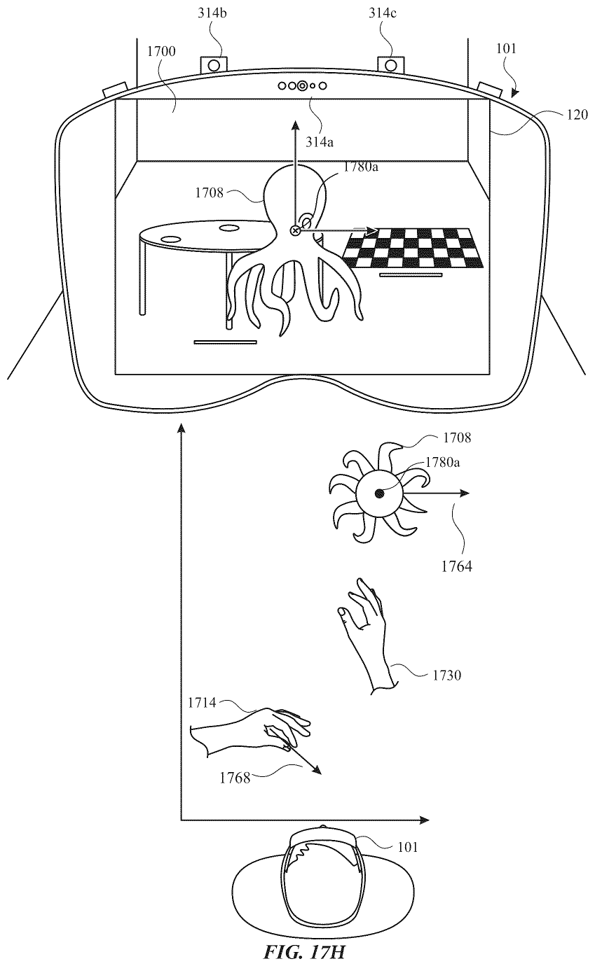

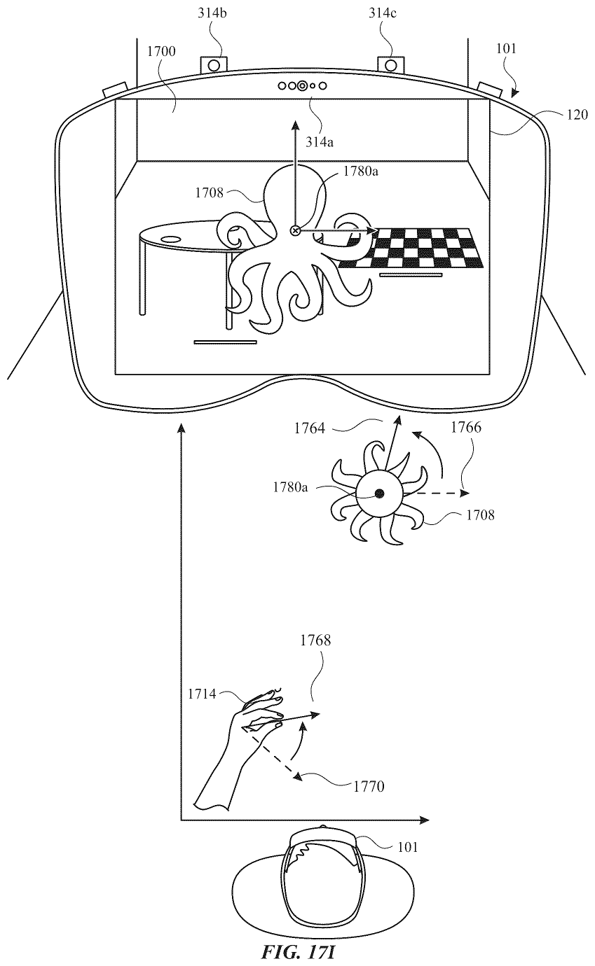

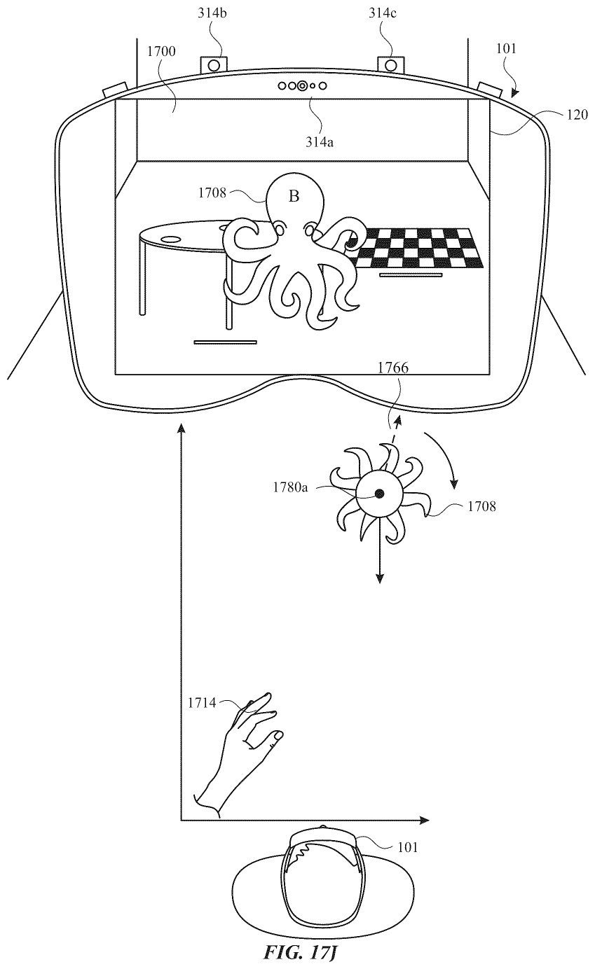

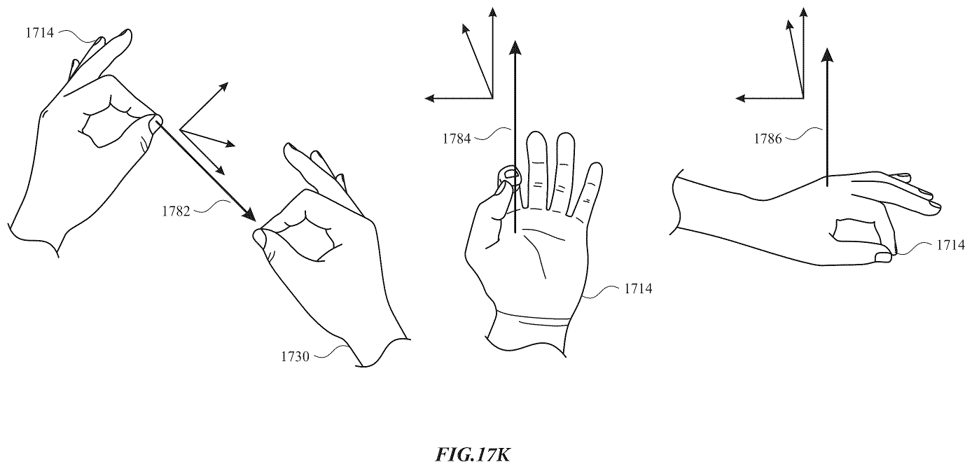

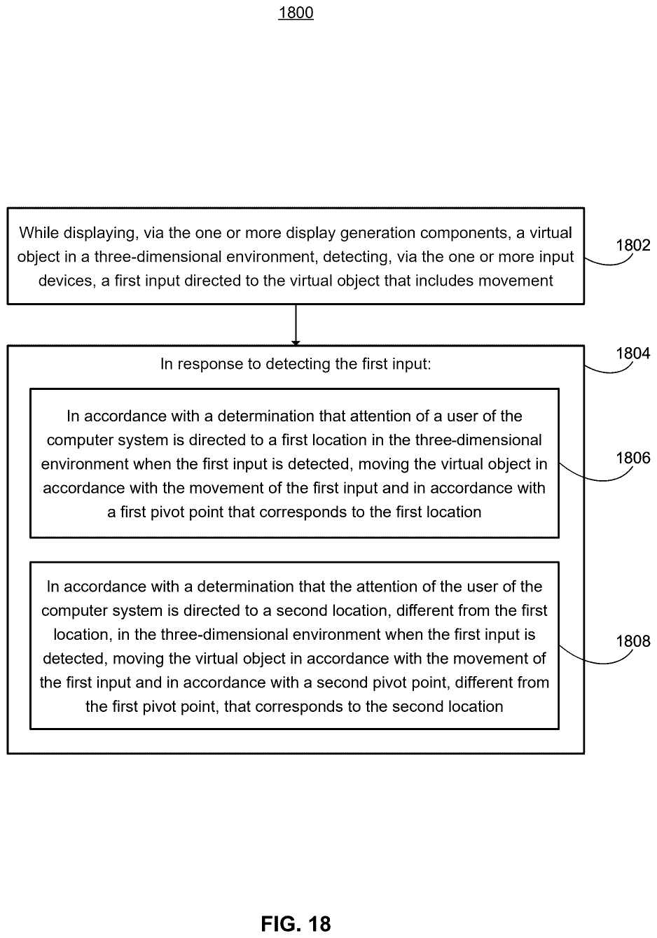

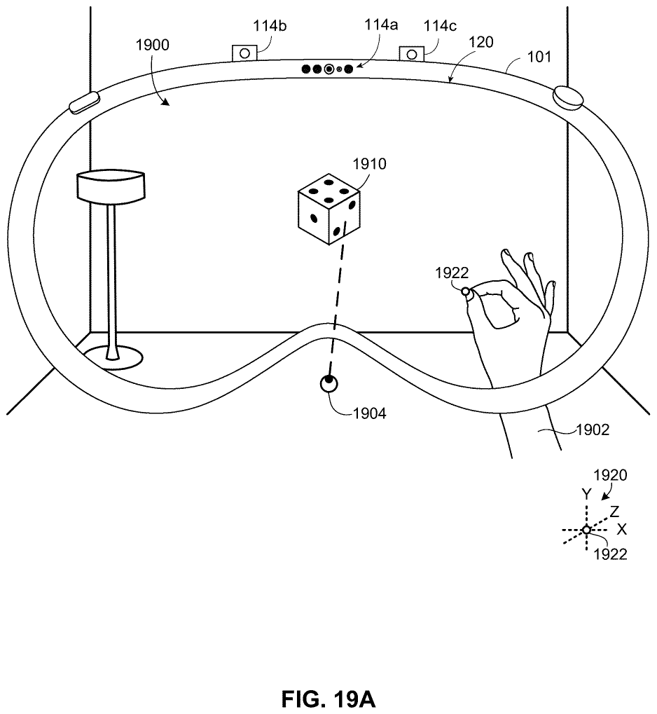

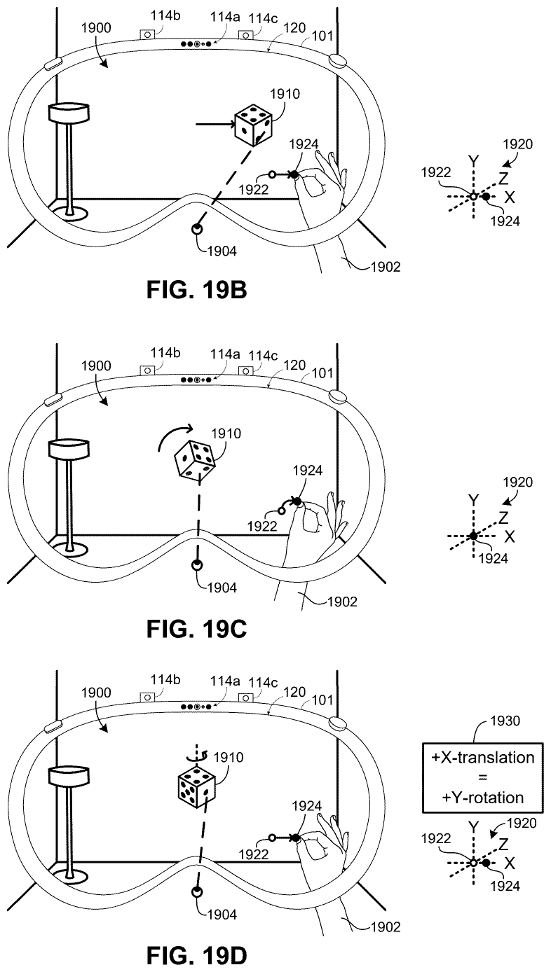

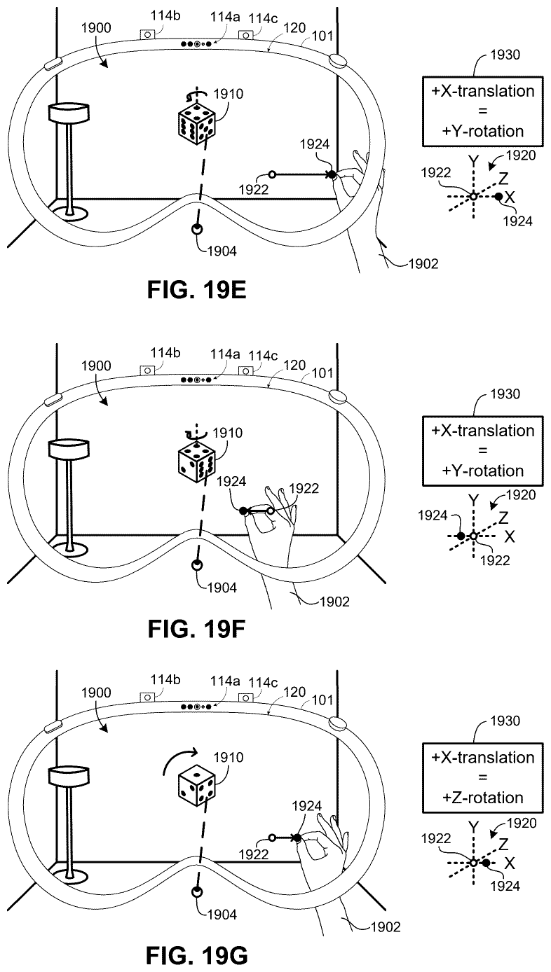

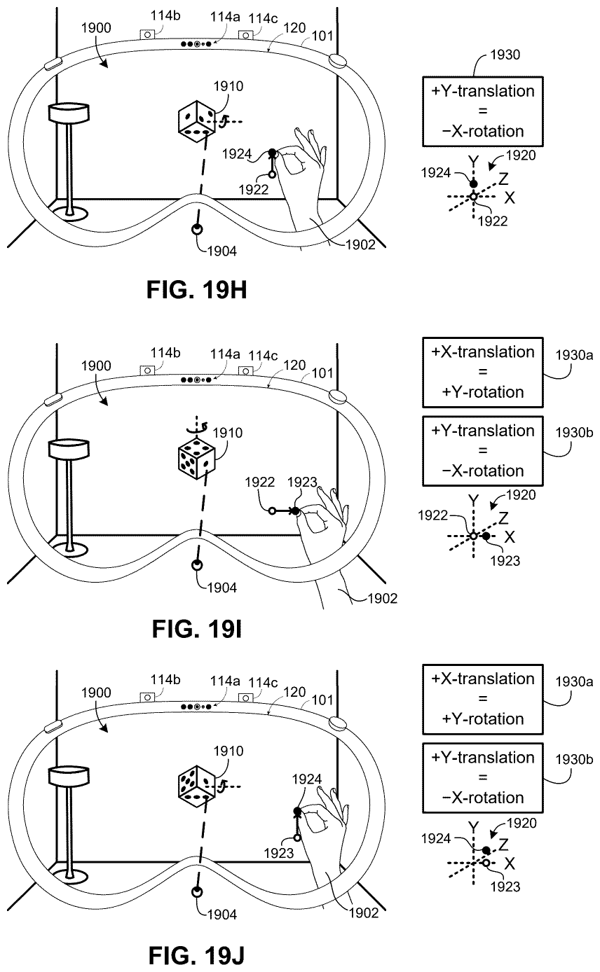

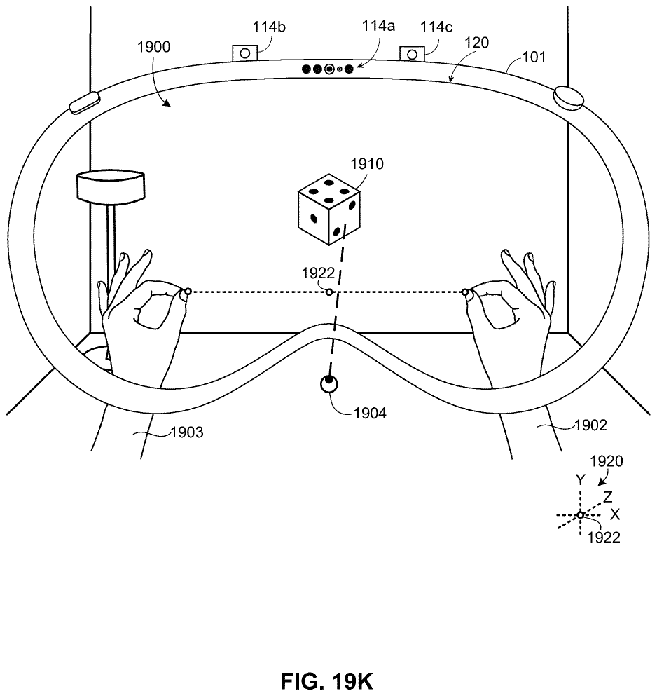

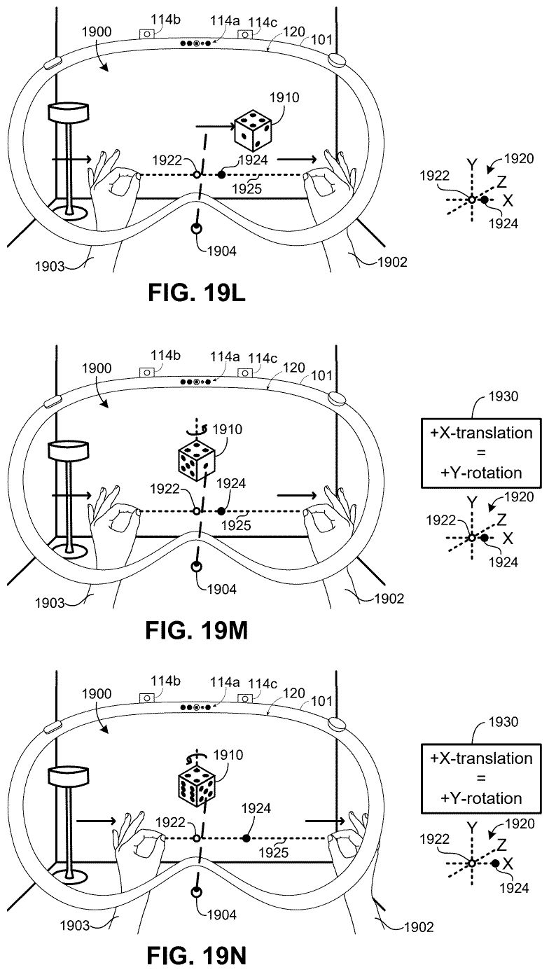

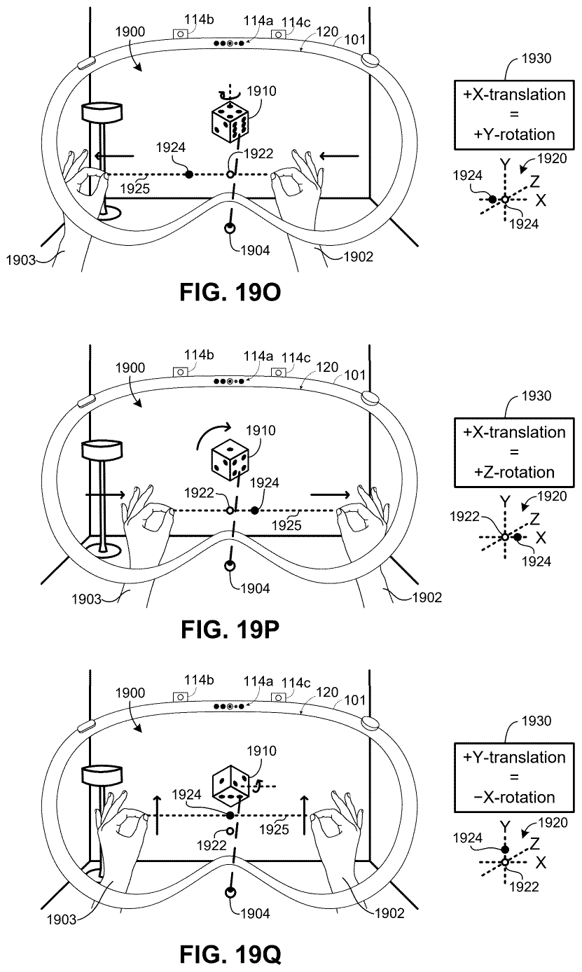

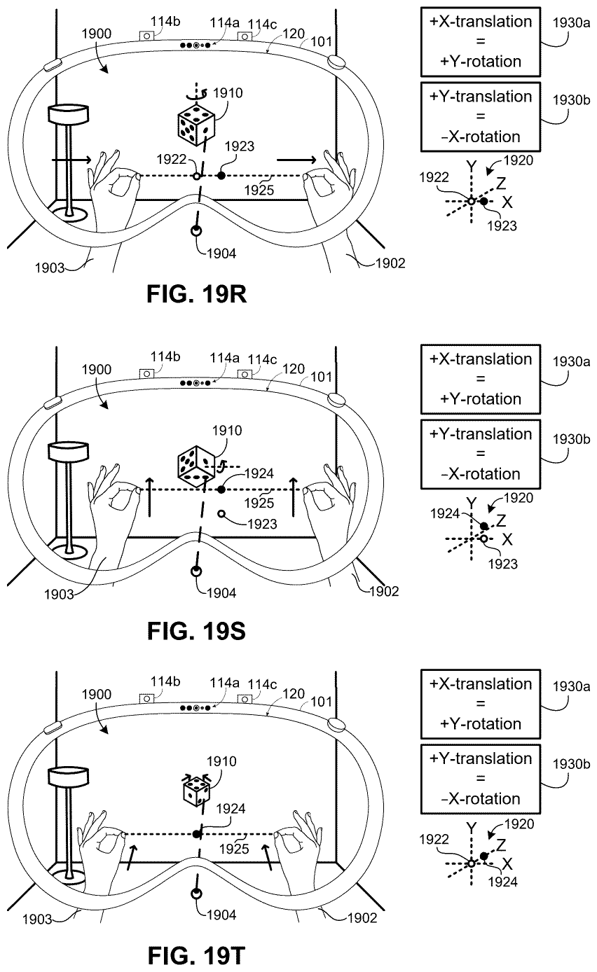

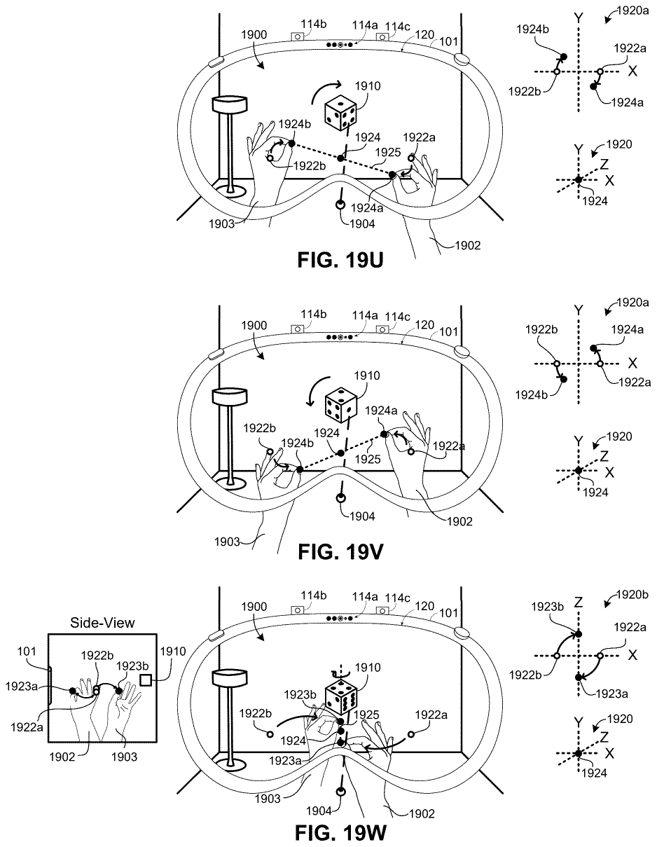

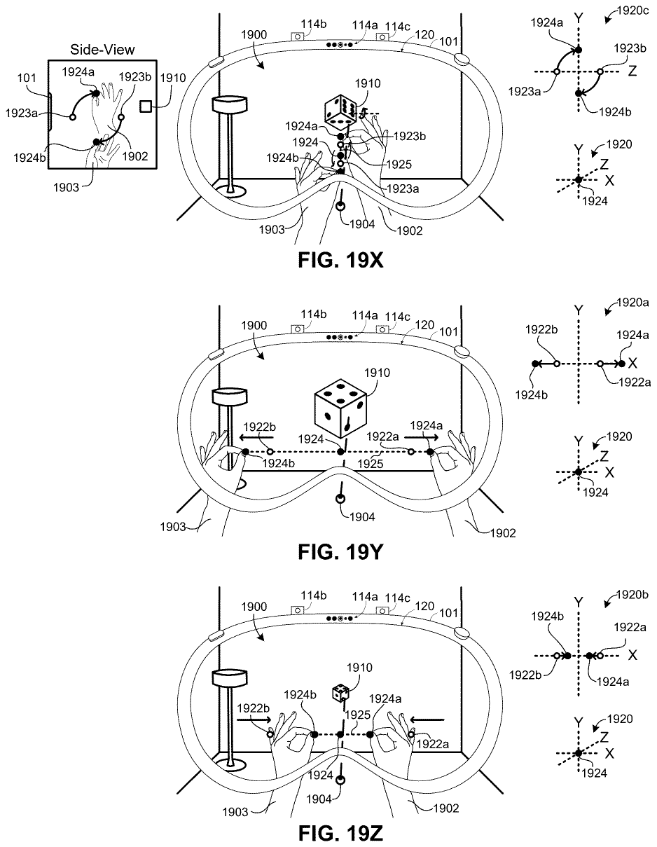

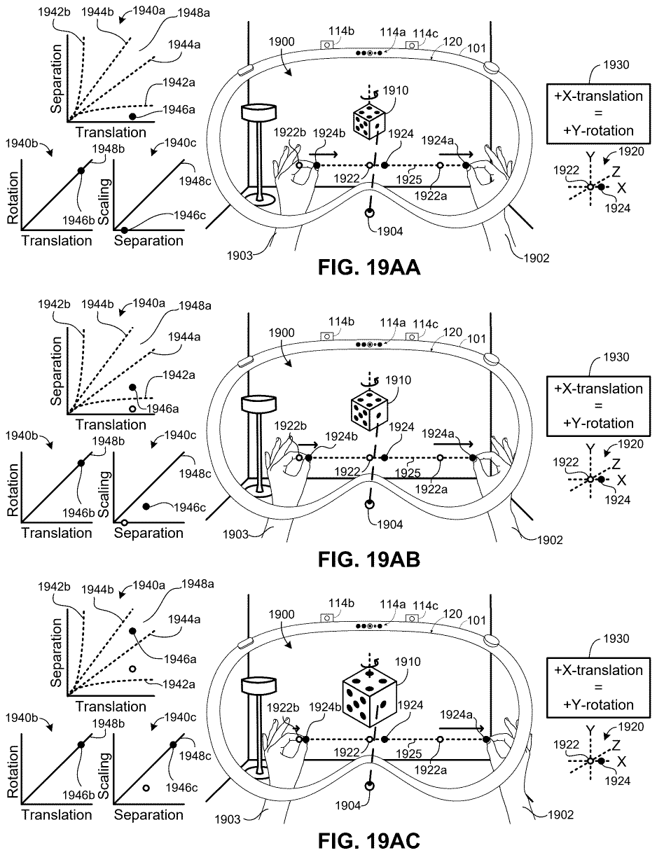

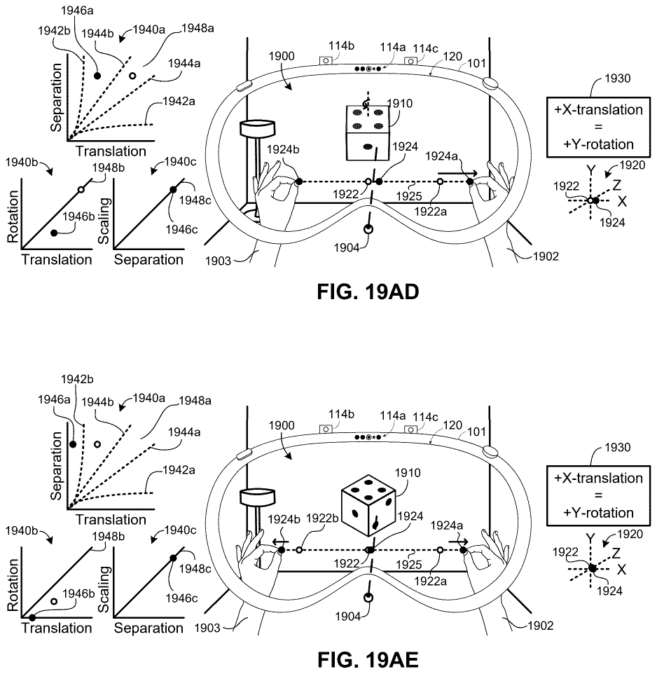

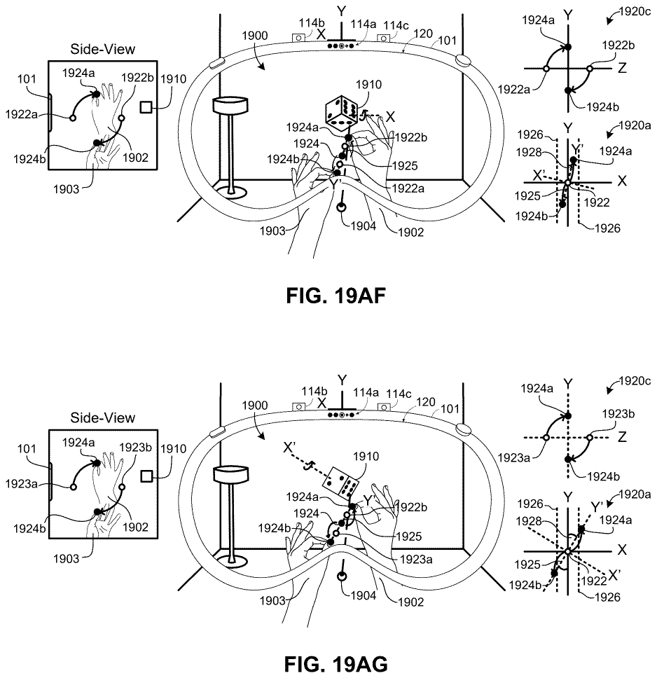

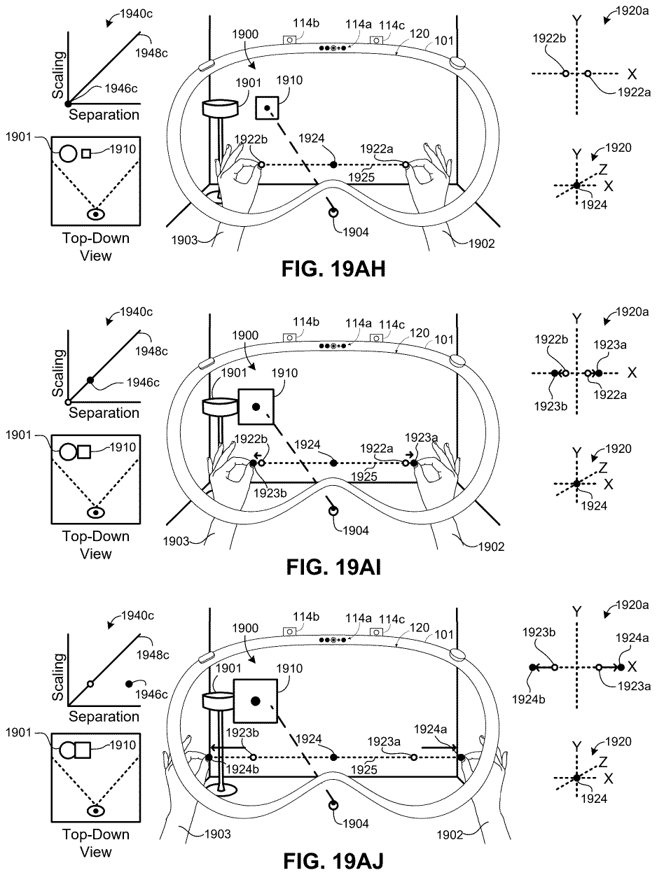

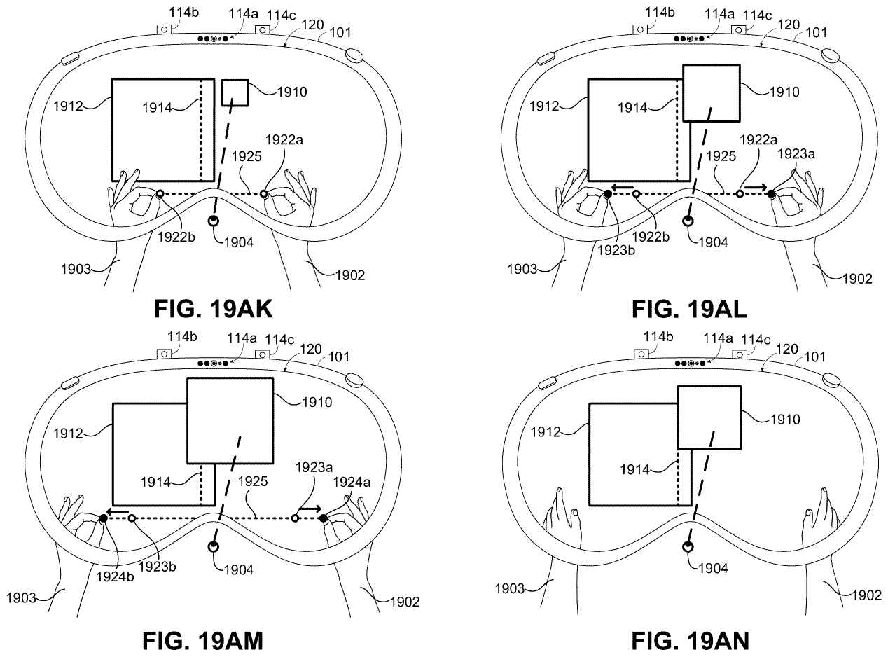

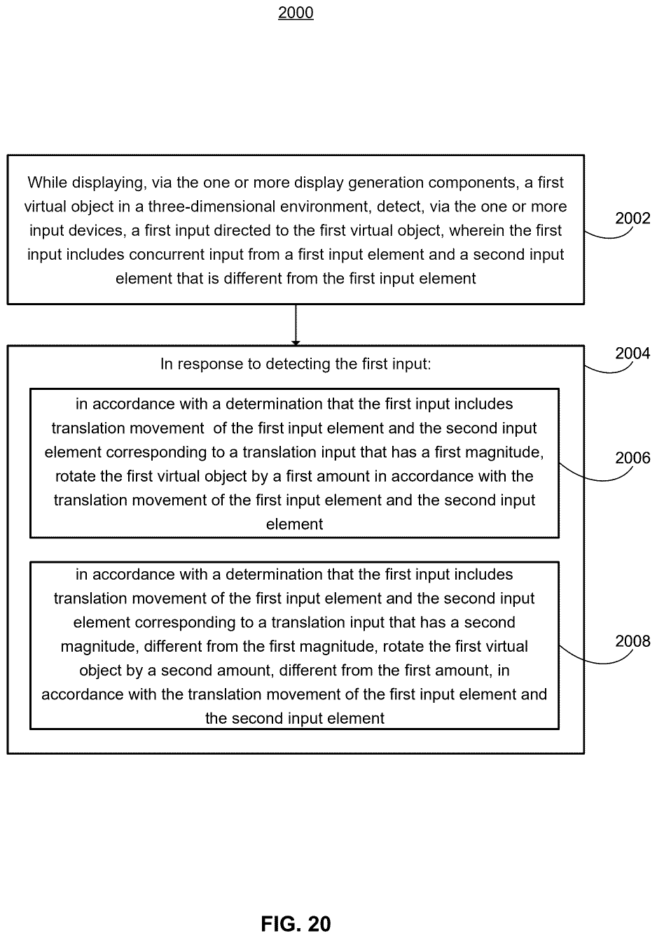

FIGS. 1A-6 provide a description of example computer systems for providing XR experiences to users (such as described below with respect to methods 800, 900, 1000, 1100, 1200, 1300, 1600, 1800, and/or 2000). FIGS. 7A-7CK illustrate example techniques of manipulating virtual objects in a three-dimensional environment in accordance with some embodiments. FIG. 8 is a flowchart illustrating a method of displaying visual feedback indicating location of an input element in accordance with some embodiments. The user interfaces in FIGS. 7A-7CK are used to illustrate the processes in FIG. 8. FIG. 9 is a flowchart illustrating a method of gradually transitioning a manipulation point of a virtual object to an input element in accordance with some embodiments. The user interfaces in FIGS. 7A-7CK are used to illustrate the processes in FIG. 9. FIG. 10 is a flowchart illustrating a method of implementing different translation behaviors for virtual objects based on a value of a virtual parameter in accordance with some embodiments. The user interfaces in FIGS. 7A-7CK are used to illustrate the processes in FIG. 10. FIG. 11 is a flowchart illustrating a method of passing control of virtual objects to multiple input elements in accordance with some embodiments. The user interfaces in FIGS. 7A-7CK are used to illustrate the processes in FIG. 11. FIG. 12 is a flow chart illustrating a method of implementing selection regions for a virtual object in accordance with some embodiments. The user interfaces in FIGS. 7A-7CK are used to illustrate the processes in FIG. 12. FIG. 13 is a flowchart illustrating a method of moving a virtual object to a respective resting pose that is based on a designated resting behavior of the virtual object. The user interfaces in FIGS. 7A-7CK are used to illustrate the processes in FIG. 13. FIGS. 14A-14N illustrate exemplary ways in which a computer system moves virtual objects relative to a three-dimensional environment in accordance with some embodiments. The user interfaces in FIGS. 14A-14N are used to illustrate the process in FIG. 10. FIGS. 15A-15I illustrate examples of a computer system generating an audio output corresponding to a respective type of object manipulation event that is associated with spatial manipulation of a virtual object in accordance with some embodiments. The user interfaces in FIGS. 15A-15I are used to illustrate the process in FIG. 16. FIGS. 17A-17K illustrate exemplary ways in which a computer system moves virtual objects relative to a pivot point defined based on attention of a user in accordance with some embodiments. FIG. 18 is a flowchart illustrating an exemplary method of moving virtual objects relative to a pivot point defined based on attention of a user in accordance with some embodiments. The user interfaces in FIGS. 17A-17K are used to illustrate the process in FIG. 18. FIGS. 19A-19AN illustrate exemplary ways in which a computer system applies transformations to a virtual object based on movement of one or more input elements, in accordance with some embodiments. FIG. 20 is a flowchart illustrating an example method of applying transformations to a virtual object based on movement of one or more input elements, in accordance with some embodiments. The user interfaces in FIGS. 19A-19AN are used to illustrate the process in FIG. 20.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

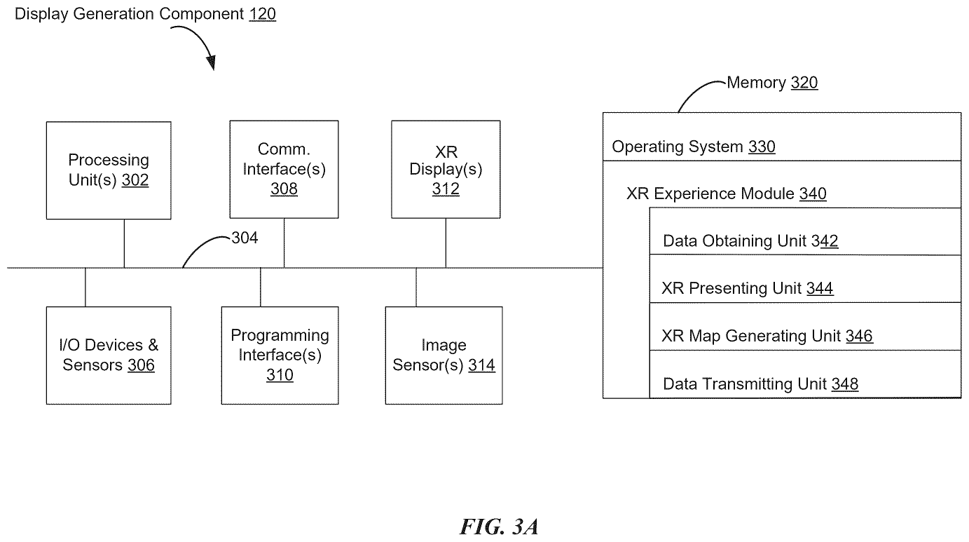

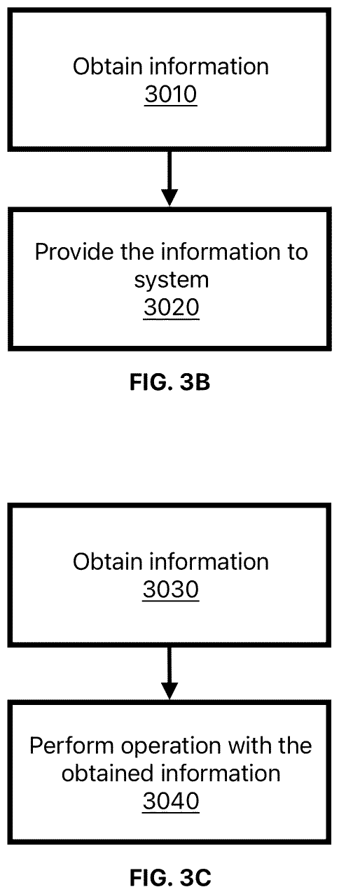

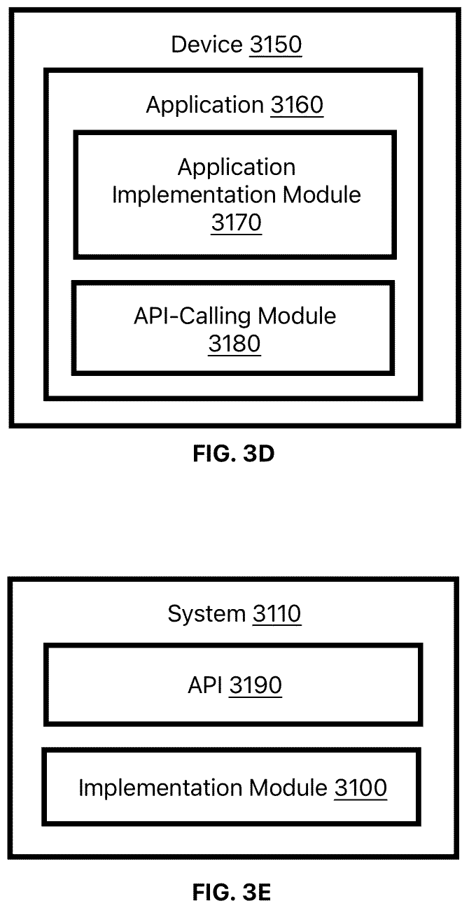

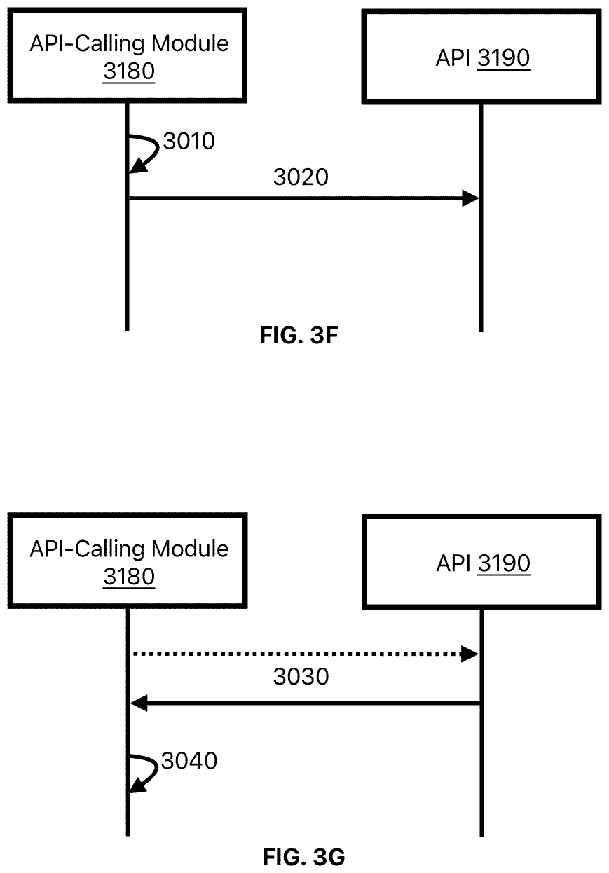

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 11) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other FIGS.) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent FIGS. referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent FIGS. and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other FIGS., the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other FIGS. shown and described herein. Likewise, any of the features, components, and/or parts, including the arrangements and configurations thereof shown and described with reference to any other FIG. shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processors 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processors 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

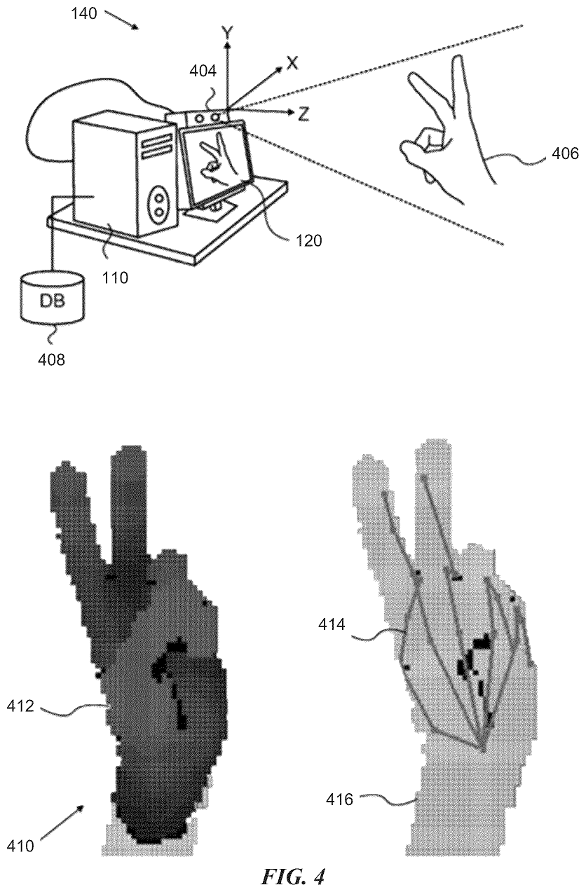

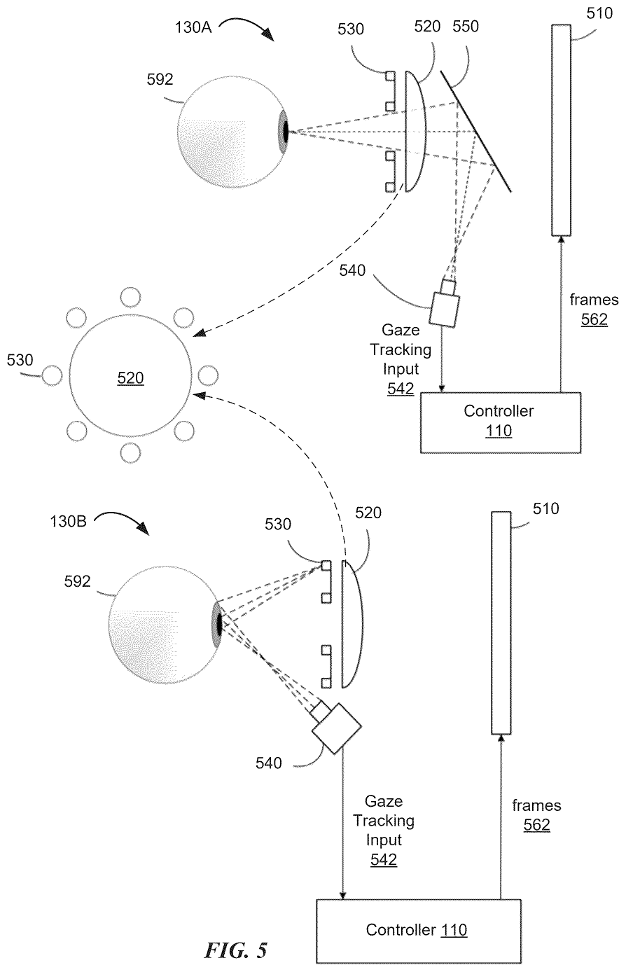

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8), method 900 (FIG. 9), method 1000 (FIG. 10), method 1100 (FIG. 11), method 1200 (FIG. 12), method 1300 (FIG. 13), method 1600 (FIG. 16), method 1800 (FIG. 18), and method 2000 (FIG. 20) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each of lenses 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

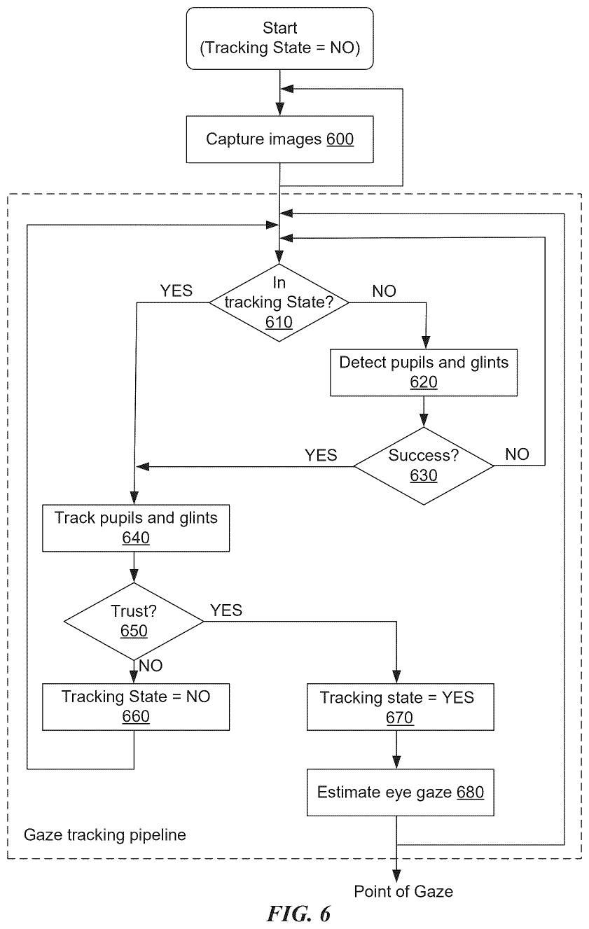

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIG. 7A through FIG. 7CK illustrate methods of moving virtual objects relative to a three-dimensional environment in accordance with some embodiments of the disclosure. Some embodiments of the disclosure are directed to displaying visual feedback while an input element is in a pre-selection state such as described with reference to method 800. Some embodiments of the disclosure are directed to the manner in which a virtual object moves related to an input center associated with an input element such as described with reference to method 900. Some embodiments of the disclosure are directed to moving a virtual object based upon a size and/or scale of the virtual object relative to a three-dimensional environment such as described with reference to method 1000. Some embodiments of the disclosure are directed to controlling movement of a virtual object with a first input element or with a second input element such as described with reference to method 1100. Some embodiments of the disclosure are directed to moving a virtual object based upon input directed to a selection region associated with the virtual object such as described with reference to method 1200. Some embodiments of the disclosure are directed to moving a virtual object to a respective resting pose in a three-dimensional environment that is based on a designated resting behavior of the virtual object such as described with reference to method 1300.

FIG. 7A illustrates a computer system 101 (e.g., tablet, smartphone, wearable computer, or head mounted device) displaying, via a display generation component (e.g., display generation component 120 of FIG. 1A such as a computer display, touch screen, or one or more display modules of a head mounted device), a three-dimensional environment 700 (e.g., an AR, AV, VR, MR, or XR environment) from a viewpoint of the user of the computer system 101 (e.g., tablet, smartphone, wearable computer, or head mounted device), for example, facing a back wall of the physical environment in which computer system 101 is located. In some embodiments, computer system includes a display generation component 120 and a plurality of image sensors 314a-314c (e.g., image sensors 314 of FIG. 3A). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101 (e.g., tablet, smartphone, wearable computer, or head mounted device). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

As shown in FIG. 7A, computer system 101 captures one or more images of the physical environment around computer system, including one or more objects in the physical environment around computer system 101. In some embodiments, computer system 101 displays representations of the physical environment included in three-dimensional environment 700. For example, three-dimensional environment 700 includes a view of a physical table, which is optionally an image of the physical table and/or is optionally physically visible via a transparent or semi-transparent material.

In FIG. 7A, three-dimensional environment 700 also includes one or more virtual objects. For example, as shown in FIG. 7A, the computer system 101 is displaying virtual objects 704, 706, and 708 in the three-dimensional environment 700 (e.g., an AR, AV, VR, MR, or XR environment). In some embodiments, the virtual object is or includes one or more of user interfaces of an application (e.g., an application running on the computer system 101 (e.g., tablet, smartphone, wearable computer, or head mounted device)) containing content (e.g., windows displaying photographs, playback user interface displaying content, and/or web-browsing user interface displaying text), three-dimensional objects (e.g., virtual clocks, virtual animals, virtual balls, and/or virtual cars) or any other element displayed by computer system 101 (e.g., tablet, smartphone, wearable computer, or head mounted device) that is not included in the physical environment of display generation component 120.

In some embodiments, a selection region is associated with a virtual object, as described further with reference to methods 800, 900, 1000, 1100, 1200, and/or 1300. In some embodiments, the selection region includes one or more volumes within a three-dimensional environment that at least partially surround a virtual object. In some embodiments, the selection region is or is not displayed by computer system 101. In some embodiments, in response to detecting input provided by an input element directed toward a virtual object, computer system 101 determines whether the input element is within and/or overlaps with a selection region that corresponds to the virtual object. In some embodiments, computer system 101 initiates operations to move a selected virtual object based upon the portion of the selection region that the input element is directed toward at a time that a selection input is initiated (e.g., at a time an air gesture is initiated, at a time when a button on a controller is pressed, and/or at a time when a surface such as a trackpad or a non-touch sensitive portion of a housing of a computer peripheral is contacted). FIGS. 7B through 7E illustrate various embodiments depicting interactions of an input element that are detected by computer system 101 and are directed to a virtual object, and/or depicting selection regions associated with virtual objects.

From FIG. 7A to FIG. 7B, the computer system 101 detects that the viewpoint of the user has shifted leftward relative to three-dimensional environment 702 and in response modifies the viewport of display 120 such that virtual object 704 occupies a central portion of display 120. In some embodiments, the user's viewpoint includes one or more of a user's position and/or perspective relative to three-dimensional environment 702. In some embodiments, selection regions are associated with virtual objects. For example, selection region 710 in FIG. 7B is associated with virtual object 704, surrounding the dimensions of virtual object 704. In some embodiments, selection region 710 comprises a plurality of regions. For example, region 712-1 corresponds to a center of movement 710-1 (described in further detail below), that are both associated with virtual object 704. Additionally, selection region 712-2 is associated with center of movement 712, which are both associated with virtual object 704. In some embodiments, the various selection regions that comprise selection region 710 are not displayed. Additionally or alternatively, centers of movement such as center of movement 710-1 and/or center of movement 712 are optionally not displayed.

In FIG. 7B, side view 701 illustrates a simplified profile view of hand 714 interacting with virtual object 704 in three-dimensional environment 702. For example, side view 701 includes virtual object 704 and a plurality of centers of movement overlaying virtual object 704, and includes a threshold corresponding to selection region 710 as indicated by a dashed line. In FIG. 7B, hand 714 is outside of selection region 710, and thus does not satisfy one or more criteria relating to displaying visual feedback indicating that hand 714 overlaps with selection region 710.

FIG. 7C illustrates an expanded view of virtual object 704 and selection region 710. In FIG. 7C, selection region 710 extends beyond the dimensions of virtual object 704, and is associated with a plurality of various selection regions. As shown in FIG. 7C, in some embodiments, the spatial profile of selection region 710 is based upon the spatial profile of virtual object 704. For example, selection region 710 has contours that follow the contours of virtual object 704 but are displaced from virtual object 704 such that selection region 710 surrounds virtual object 704. Additionally or alternatively, selection region 710 in FIG. 7C at some portions differs from the spatial profile of virtual object 704. In FIG. 7C, selection region 710 overlaps with and/or includes a plurality of centers of movement 712. The centers of movement—as described further at least with reference to method 900—optionally are selectable by an input element such as hand 714 and/or a controller. In some embodiments, by selecting a particular center of movement and/or directing input to a portion of a selection region that corresponds to a specific center of movement, computer system 101 initiates operations to move the selected virtual object relative to the selected center of movement in accordance with the movement of the input element. In some embodiments, the operations include rotating, translating, and/or at least temporarily forgoing rotating and/or translating of the virtual object relative to three-dimensional environment 702.

FIG. 7D illustrates virtual object 706 associated with selection region 716. In some embodiments, the spatial profile of a selection region is associated with a spatial profile of the corresponding virtual object 706. For example, selection region 716 in FIG. 7D is a cubic volume that is optionally not displayed in three-dimensional environment 702. Similarly to as described with reference to virtual objects 704, virtual object 706 is associated with a plurality of centers of movement 718, including center of movement 718-1, and including center of movement 718-2. Thus, virtual objects are optionally related to corresponding selection regions and/or centers of movement that are different based upon the dimensions, arrangement, and/or configuration of the virtual object. It is understood, however, that the examples illustrated in FIGS. 7C and 7D are merely exemplary. Selection regions and/or centers of movement for virtual objects are optionally configurable based upon the metadata and/or information provided by a computer system that provides to another computer system, and/or are optionally configurable by a computer system displaying the virtual objects. For example, selection region 716 optionally includes a different numbers of portions, a different number of centers of movement, a different spatial profile and/or distribution of the portions and/or centers of movement, and/or some combination thereof than as shown in FIG. 7D.

In some embodiments, computer system 101 displays a simulated glowing effect to visually indicate that an input element is within a selection region (e.g., within a threshold distance of portion(s) of a virtual object). As described with reference to FIGS. 7E through 7H and/or method 800, for example, in response to detecting movement of hand 714 relative to virtual object 704, computer system 101 initiates display and/or changes visual characteristic(s) of, a position of, and/or scale of a simulated glow 720 relative to virtual object 704. As described with reference to method 800, the simulated glow 720 is optionally moved in accordance with movement of an input element such as hand 714 as shown in FIG. 7E and/or a controller, however, the movement of the input element optionally differs from the movement of simulated glow 720. In some embodiments, the simulated glowing effect is displayed when one or more criteria are satisfied, such as a criterion satisfied when hand 714 is within a threshold distance of virtual object 704 (e.g., the threshold distance corresponding to the selection region 710, or to another threshold (e.g., 0.005, 0.01, 0.05, 0.1, 0.2, 0.3, 0.4, or 0.5 m)).

In some embodiments, simulated glow 720 is displayed within three-dimensional environment 700 overlaying portions of virtual object 704 indicating a spatial relationship between hand 714 and virtual object 704. In particular, as described with reference to method 800, computer system 101 displays simulated glow 720 indicating that hand 714 is capable of initiating movement of virtual object 704 in response to detecting a selection input, such as selection input(s) described with reference to methods 800, 900, 1000, 1100, 1200, and/or 1300. As described with reference to method 800, computer system 101 virtually casts simulated glow 720, in a manner that is similar to as though a simulated light emanates from a simulated light source coupled to a portion of the user's body. In FIG. 7E, computer system 101 casts simulated glow 720 emanating from a fingertip included in hand 714, toward virtual object 704.

In some embodiments, the portions of a virtual object that computer system 101 displays with the simulated glow effect corresponds to an intersection of a shape projected from an input element. For example, in FIG. 7E, computer system 101 casts a conical shape having a point corresponding to a fingertip of hand 714 away from the fingertip and displays the portions of virtual object 704 that intersect with the conical shape with the simulated glow 720 (and/or casts relative to a point on a housing of a controller). In some embodiments, portions of three-dimensional environment 700 that correspond to the casted conical shape and do not intersect with the virtual object are not displayed with the simulated glow effect. For example, as shown in FIG. 7E, regions of three-dimensional environment 700 that do not correspond to virtual object 704 (e.g., relative to the user's viewpoint in the three-dimensional environment 700) optionally are not displayed with the simulated glow 720, even when one or more physical light sources corresponding to the one or more simulated light sources would cast light to the regions of three-dimensional environment 700 that do not correspond to virtual object 704.

In some embodiments, simulated glow 720 is displayed with one or more visual characteristics. The visual characteristics, for example, optionally include one or more of an intensity, brightness, feathering radius, opacity, blurring effect, color, saturation, and/or some combination thereof. In FIG. 7E, computer system 101 displays simulated glow 720 with one or more first values of one or more of the visual characteristics described above. For example, simulated glow 720 in FIG. 7E is displayed with a first level of brightness, a first level of saturation, with a first feathering radius, and/or a first level of opacity. As described further in the figures that follow, computer system 101 optionally changes the position and/or levels of the first visual characteristics in response to detecting movement of the hand 714.

From FIG. 7E to FIG. 7F, computer system 101 detects movement of hand 714 drawing closer toward virtual object 704. For example, a distance between hand 714 and virtual object 704 decreases from FIG. 7E to FIG. 7F. In response to detecting such a decrease, computer system 101 optionally increases the size of simulated glow 720 to visually indicate that the hand 714 is progressively moving closer to virtual object 704. In FIG. 7F, computer system 101 displays simulated glow 721, which optionally has one or more different visual characteristics and/or levels of the visual characteristics that are different from simulated glow 720. For example, simulated glow 720 and 721 are optionally displayed with a same color, and/or are optionally displayed with different levels of brightness, different distances of respective feathering radii, and/or with different levels of opacity. Simulated glow 720, for example, is optionally displayed with a relatively lower level of brightness, a relatively greater feathering radius, and/or a relatively lower level of opacity as compared to levels of the same characteristics of simulated glow 721.

It is understood that in some embodiments, computer system 101 decreases the size of simulated glow 720 in response to detecting movement of hand 714 toward virtual object 704, in a manner that mimics the physical equivalent of a physical light source moving closer toward virtual object 704. For example, in response to detecting the movement of hand 714 from FIG. 7E to FIG. 7F, computer system 101 optionally decreases the size of simulated glow 720. In response to detecting movement of hand 714 moving away from virtual object 704, computer system 101 optionally increases the size of simulated glow 720. Additionally or alternatively, computer system 101 optionally changes opacity of simulated glow 720 and/or other visual characteristics such as brightness and/or feathering radius to mimic physical light sources. For example, computer system 101 optionally decreases opacity, brightness, and/or increases feathering radius as hand 714 moves away from virtual object 704 and/or increases opacity, brightness, and/or decreases the feathering radius as hand 714 moves toward virtual object 704.

From FIG. 7F to FIG. 7G, computer system 101 detects movement of hand 714 moving away from virtual object 704, and in response, changes the simulated glow that overlays virtual object 704. For example, computer system 101 optionally detects a change in distance between hand 714 and virtual object 704 from FIG. 7F to FIG. 7G that is a same as the change in distance described with reference to FIG. 7E to FIG. 7F, and in response, optionally changes the levels of visual characteristics of the simulated glow from the levels described with reference to simulated glow 721 in FIG. 7F to the levels of visual characteristics of simulated glow 720 in FIG. 7E. Accordingly, simulated glow 720 is optionally the same in FIG. 7E and FIG. 7G.

From FIG. 7G to FIG. 7H, computer system 101 detects movement of the hand 714 in a lateral direction relative to the viewpoint of the user, and in response, moves the displayed simulated glow effect in accordance with the movement of hand 714. For example, hand 714 moves in a lateral direction (e.g., leftward) from FIG. 7G to FIG. 7H, and does not move in a depth direction (e.g., along an axis extending from the viewpoint of the user toward virtual object 704). In response to detecting such movement, computer system 101 moves the simulated glow 720 leftward, by an amount that is the same as and/or is based upon the detected amount of leftward movement of hand 714. Thus, because the distance between hand 714 and virtual object 704 does not change, computer system 101 moves simulated glow 720 while forgoing changing of the visual characteristics of simulated glow 720. It is appreciated that in some embodiments, the amount that simulated glow 720 moves differs from movement of hand 714. For example, because simulated glow 720 is based upon casting of a simulated light source from a portion of hand 714, computer system 101 optionally moves the simulated glow 720 by a first distance in response to detecting hand 714 move by a second distance, optionally less than the first distance (e.g., similar to swiveling a physical light source by the second distance, and seeing a light pattern cast by the physical light source move by the first distance).

In some embodiments, in response to detecting selection input directed toward a virtual object, computer system 101 initiates display of visual feedback indicating that the virtual object is selected and/or that movement of an input element selecting the virtual object will initiate a process to move virtual object 704 toward the input element. For example, as illustrated in FIG. 7I, computer system 101 initiates display of simulated glow pulse 720b. As described with reference to method 800, the simulated glow pulse 720b is optionally an animation which optionally includes displaying a simulated glow effect that progressively illuminates one or more portions of virtual object 704. In some embodiments, the animation includes initiating display of the simulated glow pulse 720b with a first size relative to the three-dimensional environment consuming a first region of the surface of virtual object 704. In some embodiments, without detecting additional user inputs expressly requesting changing of the glow pulse 720b, the animation includes increasing the size of the glow pulse 720b and/or changing which region(s) of the surface of virtual object 704 are displayed with the glow pulse 720b over time. Additionally or alternatively, as illustrated, the animation optionally includes displaying the entirety of virtual object 704 with the simulated glow.

In some embodiments, the animation includes gradually changing one or more levels of visual characteristics of the simulated glow. For example, computer system 101 optionally increases the size of the simulated glow, changes the location of the simulated glow, increases and/or decreases a level of brightness, changes the level of opacity of the simulated glow, changes which region(s) are displayed with the simulated glow, changes the number of region(s) that are displayed with the simulated glow, and/or the like in response to detecting input selecting the virtual object 704. In some embodiments, the level of the visual characteristics when the animation initiates is the same as the level of visual characteristics of simulated glow 720 displayed immediately prior to detecting input selecting the virtual object. In some embodiments, the level of the visual characteristics is predetermined and/or differs from the level of visual characteristics of simulated glow 720 when the input selecting the virtual object is detected. In some embodiments, and as part of the animation described above, computer system 101 ceases displaying simulated glow 720 at the conclusion of the animation sequence described above. In some embodiments, once computer system 101 ceases displaying the simulated glow 720 as part of the animation sequence to indicate selection of the virtual object by the input element, computer system 101 begins to move virtual object 704 in accordance with movement of the input element (e.g., hand 714 and/or a controller).

FIG. 7J illustrates embodiments in which computer system 101 moves a virtual object in accordance with movement of an input element relative to a center of movement associated with the virtual object. Regions 726-1, for example, correspond to a plurality of regions (e.g., “Zones”) related to moving virtual object 704a. In some embodiments, virtual object 704 corresponds to an embodiment in which virtual object 704 is displayed with a first size 731a relative to a three-dimensional environment of computer system 101. In some embodiments, regions 726-1 includes a first region 730-1. In some embodiments, first region 730-1 is defined relative to a center of movement 732-1, indicated by a first circle illustrated with a solid pattern, centered on the center of movement 732-1. As described further with reference to method 900 and/or 1100, computer system 101 optionally initiates a process and/or operation to initiate movement of the center of movement selected by an input element toward an “input center,” which optionally corresponds to a location associated with an air gesture (e.g., a location at which fingers of hand 714 forming the air pinch meet as shown in FIG. 7I and/or a location included in and/or in proximity to a portion of a housing of a controller).

In some embodiments, the first region 730-1 is associated with forgoing movement of the virtual object in response to detecting movement of the input element. For example, in response to initially detecting movement of the input element to a position that is within first region 730-1, computer system 101 optionally forgoes movement of virtual object 704. Additionally or alternatively, while the location of the input element is maintained within the first region 730-1, computer system 101 optionally continues to forgo movement of virtual object 704. Thus, initiating movement of virtual object 704 in a manner that ultimately decreases a distance between the input center and the center of movement of virtual object 704 optionally includes forgoing movement (e.g., maintaining a location) of virtual object 704.

In some embodiments, regions 726-1 include a second region 728-1 associated with progressively moving virtual object 704 and/or the center of movement that the input element has selected toward the input center associated with the input element. In response to detecting movement of the input element beyond the first region 730-1 crossing into second region 728-1, computer system 101 optionally initiates the movement of virtual object 704 relative to a three-dimensional environment of computer system 101. In some embodiments, the second region 728-1 is associated with moving virtual object 704 in a manner that decreases the distance between the input center and the center of movement. For example, as illustrated in the plot 734, catch-up region 734-2 optionally illustrates the curve and/or relationship between displacement of the input center from its initial position and/or the corresponding movement of virtual object 704 and/or the center of movement of virtual object 704 relative to the input center. In particular, in FIG. 7J, the curve optionally is exponential and/or is similar to an exponential curve. Thus, plot 734 optionally illustrates that computer system 101 rapidly moves virtual object 704 to “catch up” with previous movement of the input element when the input element moves within the second region 728-1. Movement of virtual object 704 within a “catch-up zone” corresponding to second region 728-1 is described further with reference to at least methods 900 and/or 1100. It is understood that the axes labels included in plot 734 are merely exemplary, and that the quantities that dictate movement of a virtual object optionally are based upon one or more reference points different from those expressly labelled in plot 734. For example, the x-axis of plot 734 optionally corresponds to a cumulative distance moved by an input element. Additionally or alternatively, the y-axis of plot 734 optionally corresponds to a cumulative distance that a virtual object is moved by computer system 101. Additionally or alternatively, the plot 734 optionally includes a different number of functions, a different number of inflection points, different types of functions, a different arrangement of functions, different slopes, and/or some combination thereof.

Virtual object 708 is optionally a virtual object that is similar to virtual object 704, but corresponds a larger size, as indicated by the indication of first size 731a relative to virtual object 704 and an indication of second size 731b relative to virtual object 708. In some embodiments, virtual object 708 is associated with a set of regions 726-2 similar to regions 726-1. For example, regions 726-2 include a first region 730-2, which optionally corresponds to a dead zone region. Similarly, region 728-2 optionally is correspond to a catch-up region. As shown in FIG. 7J, regions 726-2 have sizes relative to a three-dimensional environment that correspond to a size of virtual object 708. For example, because virtual object 708 is bigger than virtual object 704, regions 726-2 are bigger than regions 726-1. Thus, even if a center of movement 732-2 of virtual object 708 were placed in a same location as center of movement 732-1, and an input element were control movement of both objects simultaneously, virtual objects 708 and 704 would move in different manners, and/or in accordance with different thresholds that define changes in movement of the respective virtual objects.

As described further herein with reference to methods 900 and/or 1100, computer system 101 optionally moves virtual object 704 and/or the center of movement selected by an input element in a manner such that the input center and the center of movement correspond to a same position in response to detecting movement of the input element. In some embodiments, computer system 101 detects a selection input provided by an input element directed to a portion of a selection region corresponding to a virtual object. In response to detecting the selection input, computer system 101 optionally initiates one or more operations to move a center of movement that is included in and/or corresponds to the selection region toward an input center, which optionally corresponds to a location of the input element. In some embodiments, computer system 101 determines a plurality of regions and/or zones of the three-dimensional environment 700 associated with moving the selected virtual object. In some embodiments, in response to detecting movement input provided by the input element, computer system 101 moves virtual object 704 in a manner to reduce a distance between the input center and the selected center of movement. FIGS. 7K through 7Y illustrate a plurality of embodiments in which computer system 101 moves virtual objects 704 and 708 relative to three-dimensional environment 702. It is understood embodiments described with reference to at least methods 800, 900, 1100, and/or 1200 optionally apply to the embodiments described with respect to FIGS. 7K through 7Y, and vice-versa.

In some embodiments, the manner in which a virtual object is moved is defined by a spatial relationship between the input center and the plurality of regions and/or zones. For example, a first region optionally is optionally a dead zone. In some embodiments, while the input element moves within the first region, computer system 101 forgoes movement of the virtual object. In some embodiments, in response to detecting the input element move out of the first region, computer system 101 initiates movement of the virtual object.

In some embodiments, a second region that surrounds the first region corresponds to a catch-up region. In some embodiments, while the input element moves within the catch-up region, computer system 101 moves the selected virtual object to cause the input center and the selected center of movement to converge. In some embodiments, such movement includes moving the virtual object in one or more directions and/or by one or more distances that are based upon, and at times are different from, one or more directions and/or one or more distances of input element movement. For example, the virtual object and the input element optionally move in a same direction and optionally move by different distances. As an additional example, the virtual object optionally moves a greater distance than a distance of detected input element movement. Additionally or alternatively, computer system 101 optionally moves the virtual object in a first direction and/or a second direction in response to detecting an input element move in a third direction (e.g., similar to, the same as, or different from the first direction or the second direction).

In some embodiments, when the input center reaches a boundary of the second region, computer system 101 moves the virtual object such that the input center and the center of movement converge at a same location. Additionally or alternatively, after detecting the input center reach the boundary of the second region, computer system 101 optionally moves the virtual object by a same, or by substantially the same distances and/or directions of input element movement. For example, the virtual object optionally tracks the movement of the input element (e.g., moves the virtual object by the same distance that computer system 101 detects the input element moving).

FIG. 7K illustrates initiation of selection of virtual object 704 by an input element that corresponds to hand 714 (and/or could additionally or alternatively correspond to a controller). For example, in response to detecting input by hand 714 as shown in FIG. 7I, computer system 101 selects center of movement 736-1. In some embodiments, computer system 101 presents feedback indicating that a virtual object is selected. For example, computer system 101 generates audio 736 in FIG. 7K in response to detecting input by hand 714. The audio is optionally a prerecorded and/or predetermined sound, which optionally is the same between different virtual objects and/or centers of movement, and/or optionally is different between different virtual objects and/or centers of movement. The feedback that computer system 101 optionally presents is described further with reference to at least method 800.

FIG. 7K includes side view 701, which illustrates the different regions and/or zones associated with moving virtual object 704. In some embodiments, computer system 101 determines and/or receives information defining a plurality of regions 726 that define the manner that virtual object moves in response to inputs requesting movement of the virtual object. For example, regions 726 includes a first region 730, optionally representative of a “dead zone” and/or region as described herein. Regions 726 further includes second region 728, which is optionally different from and/or contiguous with first region 730, optionally representative of a “catch up zone” and/or region as described herein. As described further at least with reference to method 900, the regions 726 are optionally defined relative to a location of a selection input, such as input 732 as shown in FIG. 7K. For example, the location of input 732 is a center of regions 730 and 728 in FIG. 7K.

FIG. 7L illustrates movement of an input element and maintaining of a position of a virtual object while the input is within first region 730. For example, in response to detecting movement of hand 714 from location 738 of selection input 732 as shown in FIG. 7K, to the location of input 732 as shown in FIG. 7L, computer system 101 forgoes movement of virtual object 704. As described further at least with reference to method 900, because the selecting input element (e.g., hand 714 in FIG. 7L and/or a controller) has moved less than a threshold distance and/or has not moved outside of first region 730, computer system 101 optionally forgoes movement of virtual object 704. Thus, minor variations in a location of hand 714 when input 732 is detected and/or as hand 714 begins to move optionally does not cause rapid, and potentially jarring movement of virtual object 704, thus visually smoothing the process by which hand 714 begins to move virtual object 704.

FIG. 7M illustrates movement of a virtual object based upon movement of an input element. For example, in response to detecting movement of hand 714 from as shown in FIG. 7L to as shown in FIG. 7M, computer system 101 initiates movement of virtual object 704 based upon movement of hand 714 away from location 738 (and/or based on movement input detected by a controller). In some embodiments, in response to detecting a selecting input element move outside of a dead zone region (e.g., first region 730), computer system 101 initiates movement of the virtual object. For example, computer system 101 optionally moves virtual object 704 in accordance with plot 734, gradually increasing the rate at which the virtual object 704 and/or center of movement 736-1 moves per unit of movement of hand 714. From FIG. 7M to FIG. 7N, computer system 101 moves virtual object 704 by a first distance that is less than a second distance of movement of hand 714. Thus, in some embodiments, computer system 101 dampens the initial movement of virtual object 704. It is understood, however, that one or more curves that are optionally different from those illustrated in plot 734 optionally dictate the movement of virtual object 704.

From FIG. 7M to FIG. 7N, computer system 101 detects hand 714 continue to move through the second region 728. From FIG. 7M to FIG. 7N, a distance that hand 714 moves is greater than a distance that object 704 and/or center of movement 736-1 moves. From FIG. 7N to FIG. 7O, computer system 101 detects further movement of hand 714 through second region 728. In some embodiments, computer system 101 moves a virtual object at a rate per unit movement of an input element that is greater than the rate of movement of the input element such that the virtual object 704 begins to “catch up” to the input element. For example, from FIG. 7N to FIG. 7O, a distance that object 704 and/or center of movement 736-1 moves is greater than a distance that hand 714 moves. Thus, from FIG. 7M through FIG. 7O, computer system 101 continues to move virtual object 704 in a manner that decreases a distance between the input center corresponding to input 732 and center of movement 736-1, gradually (or abruptly) changing the rate of the movement. For example, the distance of movement of hand 714 from FIG. 7M to FIG. 7N is optionally the same as from FIG. 7N to FIG. 7O, and computer system 101 optionally moves virtual object 704 by a first distance from FIG. 7M to FIG. 7N that is less than a second distance of movement from FIG. 7N to FIG. 7O.

In some embodiments, computer system 101 facilitates movement of a virtual object based upon movement of an input element moving toward the virtual object and/or toward a location that the input element initiates a selection input. For example, FIGS. 7O through 7Q illustrate embodiments in which hand 714 moves toward location 738 (and/or embodiments in which a controller moves toward, and/or causes a cursor to move toward location 738). In response to detecting such movement, computer system 101 optionally moves virtual object 704 back toward a location of virtual object 704 before selection of virtual object 704 was initiated. In some embodiments, the manner in which computer system 101 moves virtual object back toward the initial location of virtual object 704 increases (or maintains or decreases) the distance between a selected center of movement such as center of movement 736-1 and an input center of input 732. As described further with reference to method 900, however, it is understood that the aforementioned movement behaviors are merely exemplary.

From FIG. 7O to FIG. 7P, computer system 101 detects hand 714 move toward location 738 and in response, computer system 101 moves virtual object 704 and/or center of movement 736-1 toward their respective initial locations. For example, from FIG. 7O to FIG. 7P, computer system 101 moves the virtual object 704 back toward an initial location of virtual object 704 (e.g., the location of virtual object 704 as shown in FIG. 7I). In some embodiments, the distance that virtual object 704 is moved away from a selecting input element is based upon a movement curve, such as shown in plot 734. For example, computer system 101 optionally moves the virtual object 704 from FIG. 7O to FIG. 7P based upon the displacement of input center relative to location 738, such as based along the catch-up region 734-2 of plot 734.

In some embodiments, virtual object 704 is moved back toward an initial location (e.g., the location of virtual object 704 before a selection and/or movement inputs are initiated) in a manner that differs from its movement away from its initial location. For example, computer system 101 optionally moves virtual object 704 from a respective first to a respective second location that are optionally separated by a first distance in response to detecting hand 714 move from a first location to a second location (e.g., moving away from the initial location 738, and within second region 728). Immediately after moving virtual object 704 to the respective second location, computer system 101 optionally detects hand 714 move from the second location back to the first location. In response to detecting the movement of hand 714 back to the first location, computer system 101 optionally moves the virtual object 704 from the second location to a third location.

In some embodiments, the third location is between the first and the second location. Thus, in such embodiments, reversing movement of hand 714 moves the virtual object 704 more slowly than when initially moving virtual object 704. In some embodiments, the third location is closer to the initial location of virtual object 704 than the first location. Thus, in some embodiments, reversing movement of hand 714 moves the virtual object 704 more quickly than when initially moving virtual object 704.

From FIG. 7P to FIG. 7Q, computer system 101 detects hand 714 move toward location 738, and in response, moves virtual object 704 toward the location of virtual object 704 prior to initiating selection of virtual object 704. In some embodiments, the distance that hand 714 moves from FIGS. 7O to 7P is the same as the distance hand 714 moves from FIG. 7P to FIG. 7Q. In some embodiments, the distance that virtual object 704 moves from FIGS. 7O to 7P is the greater than, less than, or the same as the distance virtual object 704 moves from FIG. 7P to FIG. 7Q.

From FIG. 7Q to FIG. 7R, computer system 101 detects hand 714 move away from location 738, and in response, moves virtual object 704. In FIG. 7R, computer system 101 moves center of movement 736-1 in a manner selected to reduce the distance between center of movement 736-1 and the input center of input 732.

In some embodiments, when an input element used to select and move a virtual object moves a distance that is greater than a threshold distance (e.g., 0.05, 0.1, 0.2, 0.3, 0.4, 0.5, 0.75, or 1 m) away from a location at which the input element initially selected the virtual object, computer system 101 moves the virtual object such that a selected center of movement converges with an input center of the input element. For example, from FIG. 7R to FIG. 7S, hand 714 moves to an outer boundary of the second region 728 (e.g., to the edge of the catch-up zone region). In FIG. 7S, computer system 101 moved virtual object 704 such that center of movement 736-1 is at a same location as the input center of input 732. In some embodiments, after moving virtual object 704 to cause convergence between center of movement 736-1 and the input center, computer system 101 moves virtual object 704 to track the movement of the input center.

For example, from FIG. 7S to FIG. 7T, computer system 101 detects hand 714 move by a first distance and in a first direction, and in response, computer system 101 moves virtual object 704 by the first distance and the first direction. Additionally or alternatively, in accordance with a determination that hand 714 and/or input 732 moves in one or more first directions and/or by one or more first distances, computer system 101 optionally moves virtual object in the one or more first directions and/or by the one or more first distances.

FIG. 7U illustrates computer system 101 moving virtual object 704 after the input center of input 732 has moved beyond the second region 728. For example, from FIG. 7T to FIG. 7U, computer system 101 moves object 704 into the first region 730. In some embodiments, computer system 101 forgoes moving of virtual object 704 in accordance with the curves that dictate the initiation of movement of virtual object 704, such as those illustrated in plot 734. As shown in FIG. 7U, because computer system 101 caused convergence between the center of movement 736-1 and the input center corresponding to input 732 (e.g., in FIG. 7T), computer system 101 moves virtual object 704 by direction(s) and/or by amount(s) that correspond to the movement of input 732.

From FIG. 7U to FIG. 7V, computer system 101 detects that hand 714 ceases providing a selection input (e.g., hand 714 un-pinches the fingers of the hand thereby terminating the selection input), and the viewpoint of a user of computer system 101 changes rightward. In response to detecting the change in viewpoint, computer system displays virtual objects 706 and 708 as shown in FIG. 7V. Virtual object 708 is optionally similar to virtual object 704 illustrated in previous figures, and optionally is different at least with respect to simulated physical characteristics, such as a scale, mass, and/or density.

In FIG. 7W, computer system 101 detects hand 714 move in a manner that corresponds to selection input 732, directed to center of movement 736-2 of virtual object 708. In response to detecting the selection input, computer system 101 displays glow pulse 720b indicating the initiating of selection of virtual object 708. In some embodiments, computer system 101 determines (and/or receives an indication from another system that provides virtual content) a size of region associated with moving a virtual object. Regions 728-2 and/or 730-2, for example, are optionally larger than regions 728 and 730, respectively, because virtual object 708 is larger and/or has a virtual mass greater than a virtual mass of virtual object 704. Accordingly, the one or more curves that dictate the relationship between an input element (e.g. hand 714 and/or a controller) and a center of movement (e.g., center of movement 736-2 in FIG. 7W) for virtual object 708 are optionally different than similar one or more curves for virtual object 704, despite the virtual objects 704 and 708 sharing one or more virtual characteristics (e.g., virtual objects 704 and 708 are both virtual octopus having a similar arrangement of virtual tentacles).

From FIG. 7W to FIG. 7X, computer system 101 moves virtual object 708 by a first distance in response to detecting movement of hand 714 by a respective first distance. Similar to as described with reference to virtual object 704, computer system 101 optionally forgoes movement of virtual object 708 until the input performed by hand 714 moves beyond the region 730-2, as shown in FIG. 7X.

From FIG. 7X to FIG. 7Y, computer system 101 moves virtual object by a second distance in response to detecting movement of hand 714 by a respective second distance within region 728-2. Similar to as described with reference to virtual object 704, computer system 101 optionally moves virtual object 708 in a manner that decreases distance between center of movement 736-2 in accordance with movement of the input center corresponding to input 732, as shown by the movement of virtual object 708 toward input 732 in FIG. 7Y (and specifically in sideview 701). Thus, the manner by which computer system 101 smooths the “picking up” and/or initiating movement of a virtual object is optionally similar and/or different for virtual objects that have different simulated properties.

FIGS. 7Z through 7AD illustrate various embodiments of computer system 101 rotating a virtual object 708 in response to rotation of an input element while the virtual object is selected by the input element. In some embodiments, computer system 101 detects input requesting rotation of a virtual object. In some embodiments, the input includes a twisting of a hand along one or more axes, such as one or axes intersecting with an air pinch where two fingers of a user's hand meet. In some embodiments, computer system 101 rotates the virtual object along one or more axes that pass through a center of movement selected by an input element, such as the hand performing the air pinch. In some embodiments, computer system 101 rotates a virtual object by amounts that correspond to amounts of rotation of an input element. In some embodiments, the rotation of the virtual object is not subject to a “dead zone.” For example, computer system 101 optionally rotates the virtual object in response to detecting rotation of the air pinch, without forgoing of rotation in response to an initial amount of the rotation. In some embodiments, in response to detecting a threshold amount of rotation of an input element, computer system 101 rotates the virtual object by an amount greater than the rotation of the input element, at times referred to herein as “over-rotation” of the virtual object. In some embodiments, computer system 101 defines one or more over-rotation thresholds. In some embodiments, over-rotating the virtual object includes rotating the virtual object to assume a predetermined orientation and/or an orientation that is set relative to a dynamic condition (e.g., the viewpoint of the user, the position of content, an initial position and/or orientation of the virtual object when selection of the virtual object is initiated).

In FIG. 7Z, while the computer system detects that input 732 is selecting center of movement 736-2, computer system 101 detects hand 714 rotate by a first amount along a first axis, as shown in axes 742-1 in FIG. 7Z. In some embodiments, in response to detecting movement requests by an input element, computer system 101 determines whether the movement requests include a translation and/or a rotational component and correspondingly rotates and/or translates the selected virtual object. For example, because input 732 in FIG. 7Z included a rotational component (without including a translational component) including a twisting of an air pinch, computer system 101 forgoes translation rotates virtual object 708. In some embodiments, the amount of rotation of object 708 along a second axis of rotation (e.g., illustrated by the arrow curving along axes 740-2) is optionally the same as the amount of rotation of hand 714. In some embodiments, the rotation of virtual objects is performed in accordance with one or more characteristics described further with reference to method 900. In FIG. 7Z, glyph 705 illustrates a visually simplified model of the input performed by hand 714 and the corresponding moved of virtual object 708 that is displayed by computer system 101.

In some embodiments, the axis or axes of rotation of an input element are mapped to an axis or axes of rotation of a virtual object. For example, computer system 101 optionally determines an orientation of a Cartesian or a spherical coordinate system based upon an orientation of a hand of a user when initiating a selection input, and/or based upon an orientation of a virtual object relative to three-dimensional environment 702. In some embodiments, computer system 101 additionally determines an axis or axes of rotation of the virtual object based on its orientation relative to three-dimensional environment 702 and/or the user's viewpoint when the selection input is initiated. In some embodiments, computer system 101 maps components of the input element axes (e.g., hand, controller, or other computing peripheral) to the virtual object axes. Accordingly, computer system 101 is able to map rotation of the input element along one or more axes to affect rotation of the virtual object along one or more corresponding axes.

In some embodiments, the amount of rotation of a virtual object is independent of one or more of the virtual parameters that affect a size of a dead zone region and/or a catch up region that affects the translation and/or movement of a virtual object. For example, in FIG. 7AA, computer system 101 detects the user move to, select, and request rotation of virtual object 704 relative to center of movement 736-3. In some embodiments, the amount of rotation of hand 714 relative to an initial orientation of hand 714 when selecting virtual object 704 is the same as the initial orientation of hand 714 when selecting virtual object 708 in FIG. 7Z. Thus, the rotation of hand 714 causing rotation of virtual object 704 in FIG. 7AA is optionally the same amount of rotation of hand 714 as shown from FIG. 7Y to FIG. 7Z. Because computer system 101 optionally rotates virtual objects by the same amounts independently of virtual parameters such as scale, mass, and/or density of the virtual objects, virtual object 708 in FIG. 7Z and virtual object 704 in FIG. 7AA are displayed with a same orientation relative to three-dimensional environment 702.

From FIG. 7AA to FIG. 7AB, computer system 101 detects movement of the user's viewpoint back toward virtual object 708, and/or detects a resumption of selection of virtual object 708 by way of center of movement 736-2. From FIG. 7AB to FIG. 7AC, computer system 101 detects movement of hand 744 toward virtual object 708. In FIG. 7AC, because hand 744 is outside of the selection region 710 associated with virtual object 708, computer system 101 forgoes display of pre-selection feedback, such as the simulated glow 720 and/or 721 described above.

FIG. 7AD illustrates computer system 101 over-rotating virtual object 708. For example, in response to detecting rotation of hand 714 from FIG. 7AC to FIG. 7AD, computer system 101 rotates virtual object 708 by an amount that is greater than an amount of the rotation of hand 714. As indicated by the size of the curved rotational arrow around axes 742-1, for example, hand 714 rotates by a first angle along an axis parallel to the ground of three-dimensional environment 702, extending parallel to the dimensions of computer system 101. As indicated by the size of the curved rotational arrow along axes 740-2, computer system 101 rotates virtual object 740-2 by a second angle that is greater than the first angle (e.g., along the same axis, but centered on the selected movement center of virtual object 708.

In some embodiments, the orientation of virtual object 708 caused by over-rotation corresponds to a predetermined amount of rotation of virtual object 708. For example, the computer system 101 optionally rotates virtual object 708 at a first rate based on the amount of rotation of an input element such as hand 714 and/or a controller when initiating the rotation. After rotating virtual object 708 by a first amount (e.g., a first threshold such as 5, 10, 15, 30, 45, 60, 90, or 120 degrees), computer system 101 optionally changes (e.g., increases or decreases) the amount of rotation of virtual object 708 based on the amount of rotation of the input element to be a second rate, different from the first rate. Additionally or alternatively, after rotating virtual object 708 by the first amount, computer system 101 optionally rotates the virtual object 708 by a predetermined amount (e.g., 5, 10, 15, 30, 45, 60, 90, 120, or 180 degrees). For example, computer system 101 rotates virtual object 708 by 90 degrees from as shown in FIG. 7AC to as shown in FIG. 7AD in response to detecting a 10, 15, or 30 degree rotation of hand 714.

In some embodiments, the threshold amount of rotation at which the rate of rotation of virtual object 708 changes is axis-dependent. For example, a first axis of axes 740-2 is optionally associated with a first threshold value, and a second axis of axes 740-2 is optionally associated with a second threshold value, different from the first threshold value. Additionally or alternatively, the rate for each axis is optionally axis-dependent. For example, computer system 101 optionally over-rotates at a respective first rate along the first axis and/or over-rotates at a respective second rate, different from the respective first rate, along the second axis.

In some embodiments, computer system 101 allows selection of a center of movement of a virtual object based upon input detected from one or more input elements. For example, as described further with reference to method 1100, control of movement of virtual object 708 is optionally based upon which hand of a user of computer system 101 last-performed and/or is maintaining a selection input (and/or which of one or more controllers last-performed and/or is maintaining the selection input). Computer system 101 additionally or alternatively facilitates handoff of control of virtual objects between input elements. For example, while a first selection input performed by or performed using a first input element is maintained, computer system 101 optionally detects a second selection input performed by or performed using a second input element, and in response, computer system 101 optionally passes control of movement from the input element to the second input element.

In some embodiments, computer system 101 displays representations of the input element with visual appearance(s) and/or value(s) of one or more visual characteristics based upon which input element is controlling the movement of the virtual object. In this way, computer system 101 facilitates efficient movement of virtual objects and indicates to the user which of several input elements is controlling the movement. The handoff of control optionally reduces the amount of user input, and thereby the processing required to detect and perform operations based on the user input, otherwise required to control a virtual object with a single input element.

In FIG. 7AE, computer system 101 detects hand 744 move within the selection region 710 corresponding to virtual object 708, and in response, computer system 101 displays simulated glow 720 in FIG. 7AE indicating the proximity of hand 744 to virtual object 708. In FIG. 7AF, computer system 101 detects hand 744, move in a manner that corresponds to a selection input, such as an air pinch contacting a thumb and index finger. In response to detecting the air pinch, computer system 101 transitions movement control of virtual object 708 from hand 714 to hand 744 in FIG. 7AF. Because in FIG. 7AF the hand 744 selects a second center of movement 743, different from the center of movement 736-2 that hand 714 was selecting in FIG. 7AE, computer system 101 changes the display of center of movement 743 to indicate movement of virtual object 708 relative to center of movement 743. Further, computer system 101 displays center of movement 736-2 with a de-selected visual appearance (e.g., that is the same as or similar to other unselected centers of movement) in FIG. 7AF.

From FIG. 7AF to FIG. 7AG, computer system 101 detects movement of hand 714 and detects movement of hand 744. Because hand 714 is no longer controlling virtual object 708 in FIG. 7AG, movement of hand 714 away from virtual object 708 does not cause movement of virtual object 708 toward the user's viewpoint. It is understood that if hand 714 from FIG. 7AF to FIG. 7AG were the controlling input element, computer system 101 would optionally move virtual object 708 toward the user's viewpoint even though hand 714 is still engaged in a selection input (e.g., the hand is still maintaining an air pinch, and/or a controller is maintaining selection by way of maintaining selection of a button and/or contact with a surface such as a trackpad or housing of the controller). From FIG. 7AF to FIG. 7AG, computer system 101 detects leftward movement of hand 744 relative to the user's viewpoint, and in response, moves virtual object 708 leftward relative to three-dimensional environment 702 accordingly. It is understood that movement of virtual object by hand 744 optionally has one or more characteristics that are similar to, or the same as those described with reference to movement of virtual objects by hand 714 as described further herein.

In some embodiments, detecting that a selection input has ceased such as detecting that an air gesture has ceased, detecting that pressing of a button has ceased, toggling of a movement mode based on detection of a touch input on a trackpad or other detected surface, and/or some combination thereof causes computer system 101 to cease to control of movement of a virtual object based on detected inputs. In some embodiments, when computer system 101 detects ceasing of a selection input, and the corresponding input element that moves in a manner that corresponds to the selection input is not controlling the virtual object, computer system 101 forgoes ceasing of control of the virtual object by the corresponding input element (e.g., because the corresponding input element is not controlling the virtual object movement). For example, from FIG. 7AG to FIG. 7AH, computer system 101 detects hand 714 cease performance of the air pinch gesture while hand 744 maintains the air pinch gesture and moves relative to three-dimensional environment 702. In response to detecting the movement of hand 744, computer system 101 moves virtual object 708 in accordance with the movement of hand 744. In response to detecting the ceasing of the air pinch gesture by hand 714, computer system 101 forgoes ceasing control of movement of virtual object 708.

From FIG. 7AI to FIG. 7AJ, computer system 101 detects hand 744 ceasing the selection input air pinch gesture. In response to detecting the ceasing, computer system 101 changes the visual appearance of center of movement 743 to correspond to a de-selected appearance as shown in FIG. 7AI and initiates display of simulated glow 720 indicating that hand 744 is able to initiate movement of virtual object 708 when selection input is provided (e.g., because hand 744 is within a selection region associated with virtual object 708.

In some embodiments, computer system 101 displays representations of input elements based upon one or more display rules. For example, the rules optionally dictate the level of opacity, blurring effect, saturation, of images of hands of a user, of a controller peripheral, and/or a cursor corresponding to such input elements. In some embodiments, the rules optionally dictate the manner in which virtual obscuring of an input element and/or of virtual objects is resolved such that the input element and/or the virtual objects remain visible to the user. For example, as described further with reference to method 1100, computer system 101 optionally maintains and/or receives one or more set(s) of display rules. The display rules optionally include a first set of display rules that dictate the visual appearance of an input element that is controlling movement of the virtual object. Additionally, the display rules optionally include a second set of display rules that dictate the visual appearance of an input element that is not controlling movement of the virtual object. It is understood that although FIGS. 7AJ through 7AP illustrate embodiments of hands 714 and 744 being displayed and/or interacting with virtual object 708, computer system 101 optionally applies the same or similar display rules when interacting with other virtual objects in a manner similar to or the same as described with reference to FIGS. 7AJ through 7AP.

In some embodiments, computer system 101 detects and/or determines a spatial relationship between virtual content, input element(s), and/or a viewpoint of the user of computer system 101. For example, an input element is optionally further away from the viewpoint of the user than a virtual object, or vice-versa. In some embodiments, virtual content occupies one or more locations in the three-dimensional environment. In some embodiments, if a physical equivalent of the virtual content were placed in three-dimensional environment 702 at the location(s) of the virtual content, the physical equivalent would visually obstruct an input element such as a hand or a controller placed behind the physical equivalent relative to the viewpoint of the user. In such embodiments, the virtual content optionally is “virtually obscuring” an input element.

In some embodiments, computer system 101 modifies and/or ceases display of portion(s) of input element(s) and/or virtual content to resolve spatial conflicts of the input element(s) and/or of the virtual content. In some embodiments, the manner by which computer system 101 modifies displayed content includes mimicking the appearance of a physical visual obstruction. In some embodiments, the manner by which computer system 101 modifies displayed content differs from the appearance of a physical visual obstruction. For example, computer system 101 optionally displays virtual object 708 in its entirety, and optionally ceases display of portion(s) of hand 714 that reach behind virtual object, to mimic physical visual obstruction. Alternatively, computer system 101 optionally modifies display of the virtual object and/or input element to at least partially cause display and/or visibility of the virtual object and/or input element.

From FIG. 7AI to FIG. 7AJ, the user's viewpoint moves toward virtual object 708 and hand 714 reaches behind virtual object 708. In some embodiments, because input elements that are not selecting a virtual object are displayed with a second set of display rules, computer system 101 displays portion(s) of virtual objects and input elements such that the input element remains at least partially visible to the user, independently of whether there are virtual objects “in front” of the input element relative to the user's viewpoint. For example, in FIG. 7AJ, hand 714 has reached to a region that is behind virtual object 708 as illustrated in glyph 707. Glyph 707 is zoomed-in overhead view illustrating the spatial arrangement between virtual object 708 and input elements.

As shown in FIG. 7AJ, displaying hand 714 with the second set of display rules includes changing values of one or more visual properties of portion(s) of virtual object 708. For example, in FIG. 7AJ, computer system 101 determines which portion(s) of virtual object 708 virtually obstruct the hand. In some embodiments, computer system 101 modifies a value of opacity, saturation, color, brightness, a blurring effect, and/or a radius defining where the aforementioned value(s) are modified at least at the virtually obscuring portion(s) of the virtual object 708. As shown in FIG. 7AJ, for example, computer system 101 ceases display of portions of virtual object 708 and/or displays or allows visibility of hand 714.

From FIG. 7AJ to FIG. 7AK, computer system 101 detects hand 714 move in a manner corresponding to a selection input. In response to detecting the selection input, computer system 101 displays hand 714 in accordance with the first set of display rules. As described further with reference to method 1100, the first set of display rules optionally dictate the manner by which computer system 101 displays input elements that are actively selecting and/or controlling movement of virtual objects. For example, in FIG. 7AK, computer system 101 displays virtual object 708 as though virtually obscuring hand 714, thus mimicking the appearance of hand 714 grasping the rear of a physical equivalent to virtual object 708. It is noted that the position of hand 714 as indicated in glyph 707 is maintained from FIG. 7AJ to FIG. 7AK, and that due to selection of center of movement 745, computer system 101 changes the display rules applied to hand 714.

From FIG. 7AK to FIG. 7AL, computer system 101 detects a non-selecting hand 744 move behind virtual object 708, as shown in FIG. 7AL and spatially illustrated in glyph 707. In FIG. 7AL, computer system 101 applies the second set of display rules (or a different set of display rules that share some of the rules of the second set) to hand 714. Accordingly, as shown in FIG. 7AL, hand 744 is presented as though portions of virtual object 708 that would otherwise present a virtual obscuring of hand 744 are not displayed (or are displayed with modified values of visual properties such as a level of opacity that is lower than as shown in FIG. 7AK).

In some embodiments, the portion(s) of virtual content displayed with a modified values of visual properties changes in accordance with changes in the viewpoint of the user, movement of the input element, and/or movement of the virtual content. For example, from FIG. 7AL to FIG. 7AM, computer system 101 detects hand 714 move while input 732 is maintained, and in response, moves virtual object 708. Additionally, in response to detecting the movement of hand 714, computer system 101 changes the portion(s) of virtual object 708 that are displayed in accordance with the second set of display rules applied to hand 744 to reflect the updated spatial relationship between virtual object 708 and hand 744. In this way, virtual obscuring of hand 744 is optionally avoided by applying the second set of display rules. It is appreciated that in response to detecting changes in the viewpoint of the user, computer system 101 optionally updates the portion(s) of virtual object 708 displayed with the modified values of visual properties in accordance with updates to the portions of virtual content that present virtual obscuring of hand 744 and/or hand 714.

In some embodiments, in accordance with a determination that one or more handoff criteria are satisfied, computer system 101 ceases control of a virtual object by a first input element and shifts the control to a second input element. For example, from FIG. 7AM to FIG. 7AN, computer system 101 detects hand 744 form an air pinch directed to center of movement 745. In response to detecting the air pinch, computer system 101 shifts control of movement of virtual object 708 from hand 714 to hand 744, and changes the display rules that dictate the display and/or presentation of hand 714 and/or 744. For example, although hand 714 moves from FIG. 7AM to FIG. 7AN, computer system 101 forgoes movement of virtual object 708 because hand 744 assumes control of the movement. In FIG. 7AN, hand 744 is displayed with the first set of display rules, and hand 714 is displayed with the second set of display rules to indicate which hand is controlling virtual object 708.

From FIG. 7AN to FIG. 7AO, computer system 101 detects further movement of hand 714 and hand 744, and in response, moves virtual object 708 based on movement of hand 744 (without moving virtual object 708 in response to movement of hand 714). Despite computer system 101 detecting hand 714 maintaining a selection input from FIG. 7AN to FIG. 7AO, because hand 744 satisfied the handoff criteria, such as criterion satisfied when hand 744 moves in a manner corresponding to a selection input that is within a threshold distance of center of movement 745 (e.g., 0, 0.005, 0.01, 0.025, 0.03, 0.05, or 0.01 m), computer system 101 forgoes movement of virtual object 708 based on movement of hand 714. from FIG. 7AN to FIG. 7AO, computer system 101 moves virtual object 708 in accordance with movement of hand 744.

From FIG. 7AO to FIG. 7AP, computer system 101 detects input (e.g., movement) from hand 744 while selection input 732 is maintained. In some embodiments, the first set of display rules dictate that a selecting input element is displayed in front of virtual content when the selecting input element is closer to the viewpoint of the user than the virtual content. For example, as shown in glyph 707 in FIG. 7AP, because hand 744 is closer to the front of the table (e.g., where the user is standing), computer system 101 ceases display of portions of virtual object 708 virtually obscured by hand 744. Additionally or alternatively, due to translation and/or rotation of hand 744, virtual object 708 is rotated along an axis intersecting center of movement 745, extending parallel to an axis that pierces a center of virtual object 708.

FIGS. 7AQ-7AS illustrate the manner with which computer system 101 moves a virtual object in accordance with input from an input element directed to a center of movement different from another center of movement. For example, as shown in FIG. 7AQ, computer system 101 detects hand 714 direct an air pinch gesture toward center of movement 746. In response to detecting the input, computer system 101 displays a simulated glow pulse 720b. From FIG. 7AQ to 7AR, computer system 101 detects movement of hand 714 and in response, moves virtual object 704 in accordance with a spatial relationship between the input center 714 and center of movement 746. For example, the direction and/or distance that virtual object 704 moves is optionally predicated on the general behavior that selected centers of movement gradually are able to move toward an input center, such as input center 714. Thus, from FIG. 7AQ to 7AR, computer system 101 moves virtual object 704 in a direction and/or by a distance to cause convergence between center of movement 746 and input center 714. From FIG. 7AQ or FIG. 7AR to FIG. 7AS, computer system 101 detects rotation of hand 714, illustrates by the curved rotational arrow overlaying axes 742. In response to detecting the rotation of hand 714, computer system 101 rotates virtual object 704 in accordance with (e.g., in a direction and/or by an amount) that is similar to, or the same as the rotation of hand 714 as illustrated by the curved rotational arrow overlaying axes 740-2. Thus, similar to as described with other centers of movement here, computer system 101 optionally rotates virtual object 704 along an axis intersecting with center of movement 746 due to the selection of center of movement 746 by hand 714.

Some embodiments of the disclosure are directed to the manner by which computer system 101 changes or maintains an orientation of virtual content with respect to an orientation of an input element selecting the virtual content. For example, some virtual objects are associated with different portions of a selection region and/or different selection regions. In some embodiments, when computer system 101 detects input directed to different portions of the selection region and/or different selection regions, computer system 101 gradually changes the orientation of the virtual object while moving the virtual object to align the selection region with the input element. In some embodiments, computer system 101 detects a selection input from an input element having a respective orientation relative to a portion of a selection region, and while performing subsequent movement of the virtual object, maintains the respective orientation of the virtual object relative to the input element. Thus, in some embodiments, computer system 101 gradually causes alignment between virtual content and an input element without requiring the input element move in a prescribed manner that would expressly request the alignment (e.g., such as rotation of the input element). From FIG. 7AS to FIG. 7AT, computer system 101 detects the viewpoint of the user move to align with virtual object 706. Although optionally not shown, computer system 101 determines a selection region 716 associated with a plurality of centers of movement, such as center of movement 718 and/or 718-2. It is understood that selection region 716 and the centers of movement associated with virtual object 706 optionally have one or more characteristics that are similar to or the same as those described with reference to virtual objects 704 and 708. As shown in side view 701 in FIG. 7AT, computer system 101 detects hand 714 is outside a threshold distance of virtual object 706 and/or outside of selection region 716. Accordingly, computer system 101 forgoes display of a simulated glow in FIG. 7AT, indicating hand 714 is not close enough to select virtual object 706.

From FIG. 7AT to FIG. 7AU, computer system 101 detects hand 714 move within selection region 716, and in response, computer system 101 initiates display of simulated glow 720 overlaying virtual object 706. From FIG. 7AU to FIG. 7AV, computer system 101 detects hand 714 move in a manner corresponding to a selection input, and in response, computer system 101 displayed simulated glow pulse 724 indicating that selection of virtual object 706 initiates. As illustrated in side view 701, computer system 101 determines a plurality of regions 726-3 including a first region 730-3 and a second region 728-3, which respectively have one or more characteristics similar to or the same as those described with reference to regions 726, 730, and/or 728.

As described with reference to method 1000 and/or 1200, it is understood that the regions 726-3 optionally have shapes, sizes, and/or spatial distributions that are different from a shape and/or size of virtual object 706. For example, first region 730-3 optionally corresponds to a dead zone region. In some embodiments, when the input 732 moves within the first region 730-3 and/or before moving outside of first region 730-3, computer system 101 forgoes movement of virtual object 706. In some embodiments, when input 732 moves beyond region 730-3, within second region 728-3, and/or before moving beyond region 728-3, computer system 101 moves virtual object such that the selected center of movement 718-2 moves toward the input center location corresponding to input 732. In some embodiments, when computer system 101 detects the input center corresponding to input 732 in FIG. 7AV move beyond second region 728-3, computer system 101 moves the virtual object 706 such that movement center 718-2 moves in direction(s) and/or by amount(s) that are the same as the direction(s) and/or amount(s) of movement of the input center.

From FIG. 7AV to FIG. 7AW, computer system 101 detects movement of hand 714 while the selection input is maintained. In response to detecting movement of the selection input beyond second region 728-3 relative to the input center location when the selection of object 706 was initiated, computer system 101 moves virtual object such that center of movement 718-2 converges with, and remains attached to, the input center corresponding to input 732 in FIG. 7AW. From FIG. 7AW to FIG. 7AX, computer system 101 translates and/or rotates virtual object 706 by amounts and/or in directions that are the same as the amounts and/or directions of movement of input 732.

In some embodiments, computer system 101 changes an orientation of virtual object 706 with an axis associated with an input element. For example, FIG. 7AY illustrates computer system 101 detect an input 732 directed to center of movement 718-2 while an alignment vector 764 is non-parallel with an axis 768 associated with hand 714.

Axis 768 is optionally representative of one of a plurality of axes defined relative to an input center location. As described further with reference to method 900 and/or 1200, the input center is optionally a location associated with an input element used to define how the input element moves virtual content. For example, the input center is optionally a location where fingers of hand 714 meet while forming an air pinch gesture as shown in FIG. 7AY. In some embodiments, computer system 101 aligns axis 768, which has an origin corresponding to the input center, with an alignment vector 764 of virtual object 706. In some embodiments, the axis 768 is one of a plurality of mutually orthogonal axes sharing the input center as an origin. Additionally or alternatively, the plurality of axes optionally are arranged based on a spatial arrangement between physical features of hand 714, such as the arrangement of fingers and/or their spatial relationship relative to a point of a palm and/or a wrist of the user.

Alignment vector 764 optionally extends from a portion of virtual object 706. For example, alignment vector 764 optionally extends normal from a face of virtual object 706 and/or normal from a face of selection region 716 as shown in FIG. 7AY, at least in side view 701. As shown in FIG. 7AX, angle 748 (e.g., 45 degrees) defines the angular difference between the alignment vector 764 and the axis 768.

From FIG. 7AY to FIG. 7AZ, computer system 101 detects movement of hand 714 in one or more directions and/or by one or more distances, and while input 732 is maintained. In response to detecting the movement of hand 714, computer system 101 moves virtual object 706 to gradually align alignment vector 764 with axis 768, even when the movement of the hand 714 does not include rotational movement. For example, from FIG. 7AY to FIG. 7AZ, the angular offset decreases from angle 748 in FIG. 7AY to FIG. 7AZ, even when the input 732 does not include a rotational component twisting relative to the three-dimensional environment 702. As an example, if computer system 101 detects the movement of hand 714 from FIG. 7AY to FIG. 7AZ while alignment vector 764 and axis 768 are parallel, computer system 101 forgoes rotation of virtual object 706 (e.g., translates, but does not rotate virtual object 706).

From FIG. 7AZ to FIG. 7BA, computer system 101 rotates virtual object 706 to align with hand 714. From FIG. 7AZ to FIG. 7BA, computer system 101 detects translation of hand 714 (e.g., without including a rotational component) drawing upwards and rightwards in three-dimensional environment 702. In FIG. 7BA, computer system 101 rotates virtual object 706 such that the alignment vector 764 is parallel with and/or overlapping with the axis 768. Accordingly, in FIG. 7BA, axis 768 is orthogonal or normal to a surface of virtual object 706 and/or of selection region 716.

FIG. 7BB illustrates initiating selection of a virtual object such that an input element is aligned with an alignment vector of the virtual object. For example, in FIG. 7BB, computer system 101 detects input 732 is from hand 714, and an alignment axis associated with input 732 is parallel to and overlapping with alignment vector 764 as shown in side view 701. Accordingly, the alignment axis forms a ninety-degree angle 752 with virtual object 706 and/or selection region 716. From FIG. 7BB to FIG. 7BC, in response to detecting movement of the hand 714, computer system 101 determines that vector 764 is aligned and accordingly forgoes rotation of virtual object 706 attempting to align virtual object 706 with the axis associated with input 732.

FIG. 7BD illustrates various embodiments of alignment between alignment vectors of virtual objects and an axis associated with an input element. 754-1, for example, is a set of input element axes defining the relative orientation of the input element with respect to a three-dimensional environment. 766-1 is an alignment vector that forms a normal 756 with a portion of a selection region associated with virtual object 760 and/or a portion of virtual object 760. Because axes 754-1 are aligned such that the alignment vector 766-1 is normal to a virtual handle of virtual object 760, computer system 101 optionally forgoes rotating of virtual object with respect to axes 754-1 otherwise required to align alignment vector 766-1 with axes 754-1.

Axes 754-2, as a further example, illustrates alignment between axes 754-2 and a different virtual handle associated with virtual object 760. For example, alignment vector 766-2 extends normal 758 relative to a rear of a virtual display of virtual object 760. Thus, computer system 101 is capable of orienting virtual object 760 with different orientations, dependent upon the portion of a selection region that hand 714 directs input towards.

In some embodiments, computer system 101 does not rotate and/or does not require an alignment between axes associated with an input element and a virtual object when moving the virtual object. Optionally, the shape and/or spatial profile of the virtual object relates to the requirement or lack of requirement of alignment between input element axes and virtual objects axes. In some embodiments, alignment is required when a portion or all of a virtual object targeted by an input element corresponds to a uniform or well-understood shape, such as a virtual handle parallel to a rectilinear surface or line on a portion of the virtual object and/or a virtual handle aligned with a major axis of an elliptical or curved surface. In some embodiments, alignment is not required when a portion or all of the virtual object targeted by the input element corresponds to an abnormal, irregular, non-uniform, or a complex arrangement of different surfaces, curvatures, and/or lines of the virtual object. For example, axes 754-3 are non-parallel with respect to vector 766-3. Vector 766-3, as one example, optionally corresponds to a normal as indicated by angle 761 with respect to a portion of virtual object 708 (and/or with respect to a selection region that corresponds to virtual object 708). In some embodiments, computer system 101 detects selection by input element 714 while axes 754-3 are illustrated as shown in FIG. 7BD, and in response, initiates movement while forgoing the proactive reorientation operation(s) otherwise required to align axes 754-3 with vector 766-3. Accordingly, computer system 101 is capable of initiating movement of virtual object 708 even when axes 754-3 are askew relative to the vector 766-3. As shown by the alignment between 754-4 and vector 766-6 which forms a normal 762 with virtual object 708 (and/or with respect to a selection region that corresponds to virtual object 708), computer system 101 is capable of selecting and/or moving virtual object 708 when an axis included in axes 754-4 are included in, and/or overlap with vector 766-4.

FIGS. 7BE through 7CK illustrate examples of computer system 101 moving a virtual object in three-dimensional environment 702 to a respective resting pose that is based on a designated resting behavior of the virtual object such as described with reference to method 1300. In FIG. 7BE, computer system 101 detects a first selection input, performed by hand 714 of the user of computer system 101, directed toward virtual object 704. For example, the first selection input detected in FIG. 7BE has one or more characteristics of the selection input(s) described with reference to methods 800, 900, 1000, 1100, 1200, and/or 1300 (e.g., and/or the first input described with reference to method 1300). In some embodiments, in response to detecting the first selection input, computer system 101 controls movement of virtual object 704 in accordance with hand 714 (for instance in the manner described with respect to FIGS. 7K-7O). It is understood description of embodiments of computer system 101 performing operations in response to detecting input performed by hand 714 optionally applies to embodiments in which computer system 101 performs the operations in response to input from an input element different from hand 714, such as one or more controllers and/or other body parts of a user of computer system 101. For example, operations performed in response to detecting a selection input performed by hand 714 are additionally or alternatively performed in response to detecting an indication of selection of a controller button, one or more contacts between an object and a touch-sensitive or a non-touch sensitive surface included in a controller, and/or detecting one or more electrical impulses traveling in a body of a user that are detected by the controller.

From FIG. 7BE to FIG. 7BF, computer system 101 detects hand 714 move away from the table in three-dimensional environment 702 while still maintaining the first selection input (e.g., an air pinch). In response to detecting the movement of hand 714, computer system 101 moves virtual object 704 away from the table in three-dimensional environment 702 (e.g., the movement of virtual object 704 corresponds to the detected movement of hand 714 during the first selection input).

In some embodiments, in FIGS. 7BE to 7BF, virtual object 704 is designated as having a first resting behavior (e.g., having one or more characteristics of the first resting behavior and/or the second resting behavior described with reference to method 1300). For example, the first resting behavior includes a first set of spatial constraints for moving virtual object 704 after the end of the first selection input. Designating virtual object 704 with the first resting behavior optionally includes defining a first resting pose (e.g., location and/or orientation) in three-dimensional environment 702 that virtual object 704 rests at when movement of virtual object 704 is not controlled by an input element (e.g., hand 714 and/or a controller). For example, the first resting pose includes a predetermined location and/or orientation in the three-dimensional environment. In some embodiments, the first resting pose corresponds to the location and/or orientation of virtual object 704 shown in FIG. 7BE (e.g., the location and orientation that virtual object 706 was located at prior to being controlled by movement of hand 714 or a controller). In FIG. 7BF, top-down view 703 includes a representation of resting location 770a associated with the first resting pose. Thus, in some embodiments, when virtual object 704 is detected as no longer controlling movement of virtual object 704, computer system 101 moves virtual object 704 back to resting location 770a.

From FIG. 7BF to FIG. 7BG, computer system 101 detects rotation of hand 714 (e.g., counter-clockwise) while hand 714 maintains the selection input. In response to detecting the rotation of hand 714, computer system 101 rotates virtual object 704 to a different orientation in three-dimensional environment 702 (e.g., from an upright orientation to an upside-down orientation) in accordance with the magnitude and direction of rotation of hand 714.

From FIG. 7BG to FIG. 7BH, computer system 101 detects movement of hand 714 and also detects that the first selection input has been terminated (e.g., because hand 714 has released the air pinch). For example, from FIG. 7BG to FIG. 7BH, hand 714 moves leftward and ceases to perform an air pinch (e.g., the user of computer system 101 ceases to contact the thumb and the index finger of hand 714 during the leftward movement of hand 714). In some embodiments, from FIG. 7BG to FIG. 7BH, computer system 101 detects hand 714 moving with a first velocity and in a first direction represented by vectors 791a and 791b while terminating the first selection input. In some embodiments, vector 791a represents the first velocity of movement of hand 714 relative to an X-axis (e.g., horizontal axis from the current viewpoint of the user of computer system 101) and a Y-axis (e.g., vertical axis from the current viewpoint of the user of computer system 101) in three-dimensional environment 702. For example, vector 791a represents the first velocity including leftward movement of hand 714 relative to the X-axis and downward movement of hand 714 relative to the Y-axis in three-dimensional environment 702. In some embodiments, vector 791b represents the first velocity of movement of hand 714 relative to the X-axis and a Z-axis (e.g., axis in depth from the current viewpoint of the user of computer system 101) in three-dimensional environment 702. For example, vector 791b represents the first velocity including forward movement of hand 714 relative to the Z-axis in three-dimensional environment 702. In some embodiments, the first velocity of movement of hand 714 from FIG. 7BF to FIG. 7BG occurs before, during, and/or after the end of the first selection input (e.g., within 0.1, 0.2, 0.5, 1, 2, 5, or 10 seconds of the computer system 101 detecting the end of the first selection input). The first velocity of movement of hand 714 is optionally a translational velocity (e.g., the user does not rotate hand 714 from FIG. 7BG to FIG. 7BH). In some embodiments, vector 791b also includes a first magnitude (as represented by the length of vector 791b). The magnitude of vector 791b represents the speed at which hand 714 is moving when computer system 101 detects that the selection input is being terminated. In FIG. 7BH, in response to detecting the end of the first selection input and the movement of hand 714, computer system 101 ceases to move virtual object 704 in accordance with movement hand 714 and initiates movement of virtual object 704 to the first resting pose associated with the first resting behavior of virtual object 704.

FIGS. 7BH to 7BK illustrate computer system 101 moving virtual object 704 along a path 772a (shown in top-down view 703) in three-dimensional environment 702 to the resting location 770a associated with the first resting pose of virtual object 704. In some embodiments, path 772a is at least partially defined by one or more user input parameters (e.g., having one or more characteristics of the first user input parameter described with reference to method 1300) associated with the first input and/or the end of the first input. For example, the one or more user input parameters includes velocity of movement of hand 714 when computer system 101 detects the end of the first selection input. From FIG. 7BH to FIG. 7BI, computer system 101 initially moves virtual object 704 along a first portion of path 772a in accordance with the velocity, both speed and direction, of hand 714 when the selection input was detected as being terminated (e.g., movement along the first portion of path 772a has one or more characteristics of the first portion of movement of the virtual object described with reference to method 1300). In some embodiments, the direction, distance, and/or speed of movement of virtual object 704 along the first portion of path 772a corresponds to the first velocity of movement of hand 714 represented by vectors 791a and 791b (e.g., a direction and/or magnitude of the first velocity of movement of hand 714). From FIG. 7BI to FIG. 7BK, computer system 101 continues moving virtual object 704 to the resting pose associated with virtual object 704. Specifically, computer system 101 moves virtual object 704 along a second portion of path 722a (e.g., the movement of virtual object 704 along the second portion of path 722a occurs after the movement of virtual object 704 along the first portion of path 722a). In some embodiments, moving virtual object 704 along the second portion of path 722a includes moving virtual object 704 from a location in the three-dimensional environment 702 corresponding to the end of the first portion of path 722a (e.g., the location of virtual object 704 shown in FIG. 7BI) to the resting location 770a.

In some embodiments, while moving virtual object 704 to the first resting pose (e.g., including resting location 770a) in three-dimensional environment 702, computer system 101 transitions (e.g., gradually) from displaying a first portion of movement of virtual object 704 that includes moving virtual object 704 in accordance with the first velocity of movement of hand 714 (e.g., the movement of virtual object 704 shown from FIG. 7BH to FIG. 7BI) to displaying a second portion of movement that includes moving virtual object 704 in accordance with the first resting behavior of virtual object 704 (e.g., the movement of virtual object 704 shown from FIG. 7BI to FIG. 7BK). In some embodiments, during the first portion of movement of virtual object 704, computer system 101 moves virtual object 704 in three-dimensional environment 702 with a simulated inertia corresponding to the first velocity of movement of hand 714 (e.g., based on direction and/or magnitude of movement of hand 714). For example, as computer system 101 continues to move virtual object 704 after detecting the end of the first selection input, the movement of virtual object 704 becomes less influenced by the simulated inertia and more influenced by the first resting pose associated with the first resting behavior of virtual object 704. For example, in FIG. 7BI, the computer system 101 terminates the influence of the simulated inertia on the movement of virtual object 704 and transitions to moving virtual object 704 in a direction toward resting location 770a. In some embodiments, transitioning the movement of virtual object 704 includes curving the movement of virtual object 704 and/or changing the direction of movement gradually over a period of time (e.g., 0.1, 0.2, 0.5, 1, 2, 5, or 10 seconds).

In some embodiments, the first resting pose associated with the first resting behavior of virtual object 704 includes a first resting orientation (e.g., an upright orientation of virtual object 704), and moving virtual object 704 along path 772a to the resting location 770a includes rotating virtual object 704 to the first resting orientation. For example, as shown in FIGS. 7BG to 7BH, computer system 101 detects the end of the selection input while virtual object 704 has an upside-down orientation in three-dimensional environment 702 (e.g., due to the rotation of hand 714 from FIG. 7BF to FIG. 7BG). For example, from FIG. 7BH to FIG. 7BK, computer system 101 rotates virtual object 704 to the first resting orientation (e.g., an upright orientation of virtual object 704) while moving virtual object 704 along path 772a to the resting location 770a. The rotation of virtual object 704 from FIG. 7BH to FIG. 7BK to the first resting orientation optionally includes rotation in a direction that corresponds to the shortest orientation change from the initial orientation of virtual object 704 (e.g., the upside-down orientation shown in FIG. 7BH) to the first resting orientation (e.g., in a direction about an axis of virtual object 704 that includes less than 180 degrees of rotation). As illustrated in FIG. 7BK, computer system 101 terminates moving virtual object 704 once the virtual object 704 arrives at the resting location 770a at the resting orientation associated with the virtual object.

FIGS. 7BL to 7BN illustrate computer system 101 moving virtual object 704 along an alternative path (compared to path 772a shown in FIGS. 7BH to FIG. 7BK) to the first resting pose in response to detecting the end of the first selection input. FIG. 7BL illustrates an alternative end to the first selection input (compared to the end of the first selection input shown in FIGS. 7BG to 7BH) that includes no movement of hand 714 (e.g., no translational and/or rotational movement of hand 714). For example, FIG. 7BL illustrates vectors 790a and 790b a velocity with a magnitude of zero and no direction. FIG. In one or more examples, the user of computer system 101 ends the first selection input by ceasing to perform the air pinch with hand 714 (e.g., by ceasing contact between a thumb and index finger of hand 714) without moving hand 714 (e.g., relative to the X, Y, and/or Z-axis of the three-dimensional environment 702). In some embodiments, in response to detecting the end of the first selection input that does not include movement of hand 714, computer system 101 moves virtual object 704 along a path 772b in three-dimensional environment 702 to the resting location 770a. In some embodiments, as shown in FIGS. 7BL to 7BN, path 772b is a direct path to the resting location 770a. For example, in accordance with a determination that computer system 101 detects an end of the first selection input without movement of an input element, computer system 101 moves virtual object 704 directly to the first resting pose associated with the first resting behavior of virtual object 704.

In some embodiments, while moving virtual object 704 to the resting location 770a along path 772b in FIGS. 7BL to 7BN, computer system 101 rotates virtual object 704 to the first resting orientation associated with the first resting pose. The rotation of virtual object 704 from FIG. 7BL to FIG. 7BN to the first resting orientation optionally includes rotation in a direction that corresponds to the shortest orientation change from the initial orientation of virtual object 704 (e.g., the orientation of virtual object 704 when computer system 101 detects the end of the first selection input) to the first resting orientation (e.g., in a direction about an axis of virtual object 704 that includes less than 180 degrees of rotation).

FIG. 7BO illustrates alternative paths of movement of virtual object 704 to the resting location 770a in response to computer system 101 detecting the end of the first selection input. In some embodiments, paths 772a to 772d are defined by different velocities (e.g., translational velocities) of movement of hand 714 that are detected by computer system 101 before, during, and/or after the end of the first selection input (e.g., within 0.1, 0.2, 0.5, 1, 2, 4, or 10 seconds of the end of the first selection input). For example, in accordance with a determination that the first velocity of movement of hand 714 (e.g., represented by vectors 791a and 791b) is detected before, during, and/or after the end of the first selection input, computer system 101 moves virtual object 704 along path 772a to the resting location 770a shown in top-down view 703 (e.g., as shown and described with reference to FIGS. 7BH to 7BK). For example, in accordance with a determination that no movement of hand 714 (e.g., represented by zero vectors 790a and 790b) is detected before, during, and/or after (e.g., within 0.1, 0.2, 0.5, 1, 2, 5, or 10 seconds of) the end of the first selection input, computer system 101 moves virtual object 704 along path 772b to the resting location 770a shown in top-down view 703 (e.g., as shown and described with reference to FIGS. 7BL to 7BN).

In FIG. 7BO, top-down view 703 includes a path 772c of movement of virtual object 704 to the resting location 770a that is defined by a second velocity of movement of hand 714, different from the first velocity of movement of hand 714, detected by computer system 101 before, during, and/or after the end of the first selection input. In FIG. 7BO, the second velocity of movement of hand 714 is represented by vectors 792a and 792b. In some embodiments, the second velocity of movement of hand 714 includes a different direction of movement than the first velocity of movement of hand 714. For example, vector 792a represents the second velocity including rightward movement of hand 714 relative to the X-axis and upward movement of hand 714 relative to the Y-axis in three-dimensional environment 702 (e.g., compared to the leftward and downward movement of hand 714 represented by vector 791a of the first velocity of movement of hand 714). For example, vector 792b represents the second velocity including forward movement of hand 714 relative to the Z-axis in three-dimensional environment 702. In some embodiments, path 772c includes a different direction of movement to the first resting pose compared to path 772a based on the difference in the direction of the first velocity of movement of hand 714 and the direction of the second velocity of movement of hand 714.

In FIG. 7BO, top-down view 703 includes a path 772d of movement of virtual object 704 to the resting location 770a that is defined by a third velocity of movement of hand 714, different from the first and second velocity of movement of hand 714, detected by computer system 101 before, during, and/or after the end of the first selection input. In FIG. 7BO, the third velocity of movement of hand 714 is represented by vectors 793a and 793b. In some embodiments, the third velocity of movement of hand 714 includes a greater magnitude of movement of hand 714 than (and optionally the same direction of movement of hand 714 as) the second velocity of movement of hand 714. For example, vector 793a of the third velocity of movement of hand 714 has a greater magnitude than vector 792a of the second velocity of movement of hand 714, and vector 793b of the third velocity of movement of hand 714 has a greater magnitude than vector 792b of the second velocity of movement of hand 714. In some embodiments, moving virtual object 704 along path 772d includes moving virtual object 704 by a greater distance and/or with a greater speed in three-dimensional environment 702 compared to moving virtual object 704 along path 722c based on the third velocity of movement of hand 714 having a greater magnitude than the second velocity of movement of hand 714.

In some embodiments, in accordance with a determination that the computer system 101 detects movement of an input element (e.g., hand 714 and/or a controller) that includes an angular velocity (e.g., rotation relative to the three-dimensional environment 702) before, during, and/or after the end of the first selection input, the computer system 101 rotates virtual object 704 during the movement of virtual object 704 to the first resting pose with a rotational velocity (e.g., rotational speed and/or direction) that corresponds to the angular velocity of the input element. For example, the computer system 101 rotates virtual object 704 with the rotational velocity until virtual object 704 reaches the first resting orientation associated with the first resting pose (e.g., in accordance with a determination that virtual object 704 is at the first resting orientation in three-dimensional environment 702 during the movement of virtual object 704 to resting location 770a, computer system 101 ceases to rotate virtual object 704).

FIG. 7BP illustrates representations of different manners of rotation of virtual object 704 to the first resting orientation that are based on the angular velocity of hand 714 when the termination of the first selection input is detected. In some embodiments, rows 798a to 798d correspond to different manners of rotation (e.g., about a first axis, such as a Z-axis) of virtual object 704 from a starting orientation (e.g., an orientation virtual object 704 has when the end of the first selection input is detected by computer system 101) to an ending orientation (e.g., the first resting orientation associated with the first resting pose of virtual object 704). For example, the ending orientation (e.g., an orientation of zero degrees) represents virtual object 704 having an upright orientation in three-dimensional environment 702 (e.g., the orientation of virtual object 704 shown in FIG. 7BE), and the starting orientation (e.g., an orientation between 90 and 180 degrees) represents virtual object 704 having a tilted orientation in three-dimensional environment 702 (e.g., such a head of the octopus virtually represented by virtual object 704 is faced downward and to the right from the current viewpoint of the user of computer system 101). In some embodiments, rows 798a to 798d represent different manners of rotation of virtual object 704 over a period of time. For example, the period of time starts at time “To,” which is optionally when computer system 101 detects the end of the first selection input. For example, the manners of rotation of virtual object 704 represented by rows 798a to 798d include rotation of virtual object 704 from the starting orientation to the ending orientation (e.g., the first resting orientation) that concludes at different times (e.g., based on the angular direction and/or angular magnitude of rotation of virtual object 704, which corresponds to an angular direction and/or angular magnitude of movement of hand 714 detected by computer system 101 in conjunction with the end of the first selection input). For example, “T₁” is a time after “T₀,” “T₂” is a time after “T₁,” “T₃” is a time after “T₂,” “T₄” is a time after “T₃,” and “T₅” is a time after “T₄.” It should be understood that the manners of rotation shown and described with reference to FIG. 7BP may be applicable to rotation of the virtual object 704 about any axis of the virtual object 704 (e.g., an X, Y, and/or Z-axis of the virtual object 704).

In FIG. 7BP, first row 798a represents a first manner of rotation of virtual object 704 in three-dimensional environment 702 in response to computer system 101 detecting no angular rotation of an input element (e.g., no angular rotation of hand 714, a controller, and/or no rotation requested via input directed to the controller such as movement of a joystick and/or movement of an object across a housing of the controller) during the end of the first input. In some embodiments, in accordance with a determination that the end of the first selection input does not include angular rotation of an input element (e.g., hand 714 and/or a controller), computer system 101 rotates virtual object 704 in a direction corresponding to the shortest orientation change from the starting orientation to the ending orientation (e.g., in a direction that corresponds to less than 180 degrees of rotation about a respective axis of virtual object 704). As shown in first row 798a, virtual object 704 reaches the ending orientation (e.g., the first resting orientation) at time “T₃.”

In FIG. 7BP, second row 798b represents a second manner of rotation of virtual object 704 in three-dimensional environment 702 in response to computer system 101 detecting a first angular rotation of an input element (e.g., counter-clockwise rotation of hand 714 and/or of a controller). In some embodiments, the first angular rotation of the input element includes an angular direction that is same direction as the shortest orientation change from the starting orientation of virtual object 704 to the ending orientation of virtual object 704. In some embodiments, rotating virtual object 704 in the second manner represented by second row 798b includes rotating virtual object 704 with a greater speed than rotating virtual object 704 in the first manner represented by first row 798a (e.g., because in second row 798b, the end of the first selection input includes angular rotation of hand 714 in the same direction as the shortest orientation change of virtual object 704 to the ending orientation, while in first row 798a, the end of the first selection input does not include angular rotation of hand 714). As shown in second row 798b, virtual object 704 reaches the ending orientation (e.g., the first resting orientation) at time “T₂” earlier than time “T₃” (e.g., virtual object 704 reaches the first resting orientation quicker in second row 798b compared to first row 798a).

In FIG. 7BP, third row 798c represents a third manner of rotation of virtual object 704 in three-dimensional environment 702 in response to computer system 101 detecting a second angular rotation of an input element (e.g., clockwise rotation of hand 714 and/or of a controller). In some embodiments, the second angular rotation includes an angular direction that is different from the direction corresponding to the shortest orientation change from the starting orientation of virtual object 704 to the ending orientation of virtual object 704. In some embodiments, rotating virtual object 704 in the third manner represented by third row 798c includes rotating virtual object 704 in a different direction than rotating virtual object 704 in the first manner represented by first row 798a and/or the second manner represented by second row 798b. The second angular rotation associated with the input element optionally has the same magnitude as but different a direction than the first angular rotation associated with the input element. For example, in third row 798c, virtual object 704 rotates with the same speed as in second row 798b but in a different direction than in second row 798b (e.g., virtual object 704 rotates in a direction in third row 798c that does not correspond to the shortest orientation change to the ending orientation). Accordingly, as shown in third row 798c, virtual object 704 reaches the ending orientation (e.g., the first resting orientation) at time “T₅” later than time “T₂” and time “T₃” (e.g., it takes longer for virtual object 704 to reach the first resting orientation in third row 798c compared to second row 798b and/or first row 798a).

In FIG. 7BP, fourth row 798d represents a fourth manner of rotation of virtual object 704 in three-dimensional environment 702 in response to computer system 101 detecting a third angular rotation of an input element (e.g., clockwise rotation of hand 714 and/or of a controller). In some embodiments, the third angular rotation include a same direction as the second angular rotation (described with reference to third row 798c) but a greater magnitude. In some embodiments, rotating virtual object in the fourth manner represented by fourth row 798d includes rotating virtual object 704 with a greater speed than rotating virtual object 704 in the third manner represented by third row 798c. Accordingly, as shown in fourth row 798d, virtual object 704 reaches the ending orientation (e.g., the first resting orientation) at time “T₃” (e.g., virtual object 704 reaches the first resting orientation quicker in fourth row 798d compared to third row 798c).

FIGS. 7BQ to 7BR illustrate an alternative example of computer system 101 moving virtual object 704 in three-dimensional environment 702 in response to detecting the end of the first selection input. In some embodiments, in FIGS. 7BQ to 7BR, virtual object 704 is designated as having a second resting behavior (e.g., having one or more characteristics of the first resting behavior and/or the second resting behavior described with reference to method 1300). The second resting behavior is optionally different from the first resting behavior (e.g., the second resting behavior includes a second set of spatial constraints for moving virtual object 704 after the end of the first selection input, different from the first set of spatial constraints associated with the first resting behavior). For example, designating virtual object 704 with the second resting behavior includes defining a second resting orientation that virtual object 704 rests at in three-dimensional environment 702 without defining a respective resting location (e.g., virtual object 704 may rest at any location in three-dimensional environment 702). For example, the second resting orientation is an upright orientation and optionally has one or more characteristics of the first resting orientation described above. In some embodiments, the resting location of virtual object 704 in three-dimensional environment 702 is based on one or more user input parameters associated with the end of the first selection input (e.g., having one or more characteristics of the first user input parameter described with reference to method 1300). For example, the one or more user input parameters includes the translational of hand 714 when computer system 101 detects the end of the first selection input. Additionally, or alternatively, the second resting behavior of virtual object 704 optionally designates virtual object 704 to rest at any location in three-dimensional environment 702 that does not correspond to the surface of the table of three-dimensional environment 702 (e.g., at a location in open-space and/or above the table in three-dimensional environment 702).

In FIG. 7BQ, computer system 101 moves virtual object 704 along a path 774 in three-dimensional environment 702 in response to detecting an end of the first selection input that includes movement of hand 714. For example, the movement of hand 714 includes angular rotation (e.g., relative to an X-axis of virtual object 704). The starting orientation of virtual object 704 (e.g., the orientation of the virtual object 704 at the end of the first selection input) is optionally the orientation of virtual object 704 shown in FIG. 7BG. In some embodiments, in accordance with a determination that the end of the first selection input includes movement of hand 714 that includes angular rotation, computer system 101 rotates virtual object 704 in a respective direction corresponding to the angular rotation of hand 714. As shown in FIG. 7BQ, computer system 101 rotates virtual object 704 (e.g., with backwards rotation from the current viewpoint of the user of computer system 101) relative to the X-axis of virtual object 704.

In some embodiments, path 774 of movement of virtual object 704 shown in FIGS. 7BQ and 7BR is defined by one or more user input parameters associated with the end of the first input (e.g., having one or more characteristics of the first user input parameter described with reference to method 1300). For example, in response to detecting the end of the first selection input, computer system 101 moves virtual object 704 in a respective direction in three-dimensional environment 702 corresponding to a velocity of movement of hand 714 before, during, and/or after the end of the first selection input (e.g., path 774 is defined by the direction of movement of hand 714 or another input element such as a controller). For example, computer system 101 moves virtual object 704 to a distance in three-dimensional environment 702 (e.g., from a location of virtual object 704 at the end of the first selection input) corresponding to a velocity, acceleration, magnitude, and/or distance of movement of hand 714 before, during, and/or after the end of the first selection input (e.g., path 774 is defined by the direction, speed, acceleration, magnitude, and/or distance of movement of hand 714 or another input element such as a controller).

In FIG. 7BR, virtual object 704 reaches a second resting pose in the three-dimensional environment 702 (e.g., corresponding to the end of path 774). The second resting pose includes the second resting orientation associated with the second resting behavior of virtual object 704. For example, while moving along path 774 from FIG. 7BQ to FIG. 7BR, virtual object 704 reaches the second resting orientation. In some embodiments, in accordance with a determination that virtual object 704 reaches the second resting orientation while virtual object 704 is moving along path 774, computer system 101 ceases to rotate virtual object 704 (e.g., computer system 101 maintains display of virtual object 704 with the second orientation relative to three-dimensional environment 702). In some embodiments, the second resting pose includes a location in three-dimensional environment 702 that is based on the one or more user input parameters associated with the end of the first input. For example, from FIG. 7BQ to FIG. 7BR, computer system 101 moves virtual object 704 in three-dimensional environment 702 in accordance with a simulated inertia of the virtual object 704 corresponding to the velocity and/or angular rotation of hand 714 detected during the end of the first selection input. For example, the distance of movement of virtual object 704 from FIG. 7BQ to FIG. 7BR (e.g., the length of path 774) is proportional to the velocity, acceleration, magnitude, and/or distance of movement of hand 714 detected before, during, and/or after the end of the first selection input (e.g., the greater the speed, acceleration, magnitude, and/or distance of movement of hand 714, the greater the distance computer system 101 moves virtual object 704 by in three-dimensional environment 702). In some embodiments, in FIG. 7BR, computer system 101 ceases to move virtual object 704 in accordance with the simulated inertia of virtual object 704.

FIG. 7BS illustrates an alternative example to FIG. 7BR of virtual object 704 reaching a third resting pose, different from the second resting pose, at the end of path 774. In some embodiments, in FIG. 7BS, virtual object 704 is designated as having a third resting behavior, optionally different than the second resting behavior described above. For example, the third resting behavior includes a third set of spatial constraints for moving virtual object 704 after the end of the first selection input (e.g., different from the first set of spatial constraints associated with the first resting behavior and/or the second set of spatial constraints associated with the second resting behavior). For example, designating virtual object 704 with the third resting behavior does not include defining a respective resting location or a respective resting orientation in three-dimensional environment 702 that virtual object 704 is designated to rest at (e.g., and/or be moved to) when movement of virtual object 704 is not controlled by an input element, such as hand 714 and/or a controller (e.g., virtual object 704 may rest at any location or orientation in three-dimensional environment 702). For example, when virtual object 704 is designated as having the third resting behavior, the resting location and resting orientation computer system 101 moves virtual object 704 to is based on one or more user input parameters associated with the end of the first selection input (e.g., having one or more characteristics of the first user input parameter described with reference to method 1300). For example, the one or more user input parameters includes the translational and/or angular velocity of hand 714 when computer system 101 detects the end of the first selection input. Additionally, or alternatively, the third resting behavior of virtual object 704 optionally designates virtual object 704 to rest at any location in three-dimensional environment 702 that does not correspond to the surface of the table of three-dimensional environment 702 (e.g., at a location in open-space and/or above the table in three-dimensional environment 702).

The third resting pose of virtual object 704 shown in FIG. 7BS optionally includes the same resting location in three-dimensional environment 702 as the second resting pose of virtual object 704 shown in FIG. 7BR, but a different resting orientation. For example, because virtual object 704 is designated as having the third resting behavior (e.g., and virtual object 704 is not required to rest at the second resting orientation, such as in an upright orientation, in three-dimensional environment 702), computer system 101 continues to rotate virtual object 704 based on the angular rotation of hand 714 associated with the end of the first selection input (e.g., computer system 101 continues the rotation of virtual object 704 shown in FIG. 7BQ) during the movement of virtual object 704 along path 774. In some embodiments, from the starting location of virtual object 704 shown in FIG. 7BQ to the ending location of virtual object 704 shown in FIG. 7BS, computer system 101 moves and/or rotates virtual object 704 in three-dimensional environment 702 in accordance with a simulated inertia of virtual object 704 corresponding to the translational movement and/or angular velocity of hand 714 detected in conjunction with the end of the first selection input. For example, the distance of movement of virtual object 704 is proportional to the velocity, acceleration, magnitude, and/or distance of movement of hand 714 detected before, during, and/or after the end of the first selection input. For example, the rotational velocity and/or the amount of rotation of virtual object is proportional to the angular direction and/or angular magnitude of the angular velocity of the movement of hand 714 detected before, during, and/or after the end of the first selection input. In some embodiments, in FIG. 7BS, computer system 101 ceases to move (e.g., and ceases to rotate) virtual object 704 in accordance with the simulated inertia of virtual object 704.

FIGS. 7BT to 7CE illustrate examples of computer system 101 moving virtual object 706 in three-dimensional environment 702 in response to detecting an end of a second selection input. In FIG. 7BT, computer system 101 detects a second selection input, performed by hand 714 of the user of computer system 101, directed toward virtual object 706. For example, the second selection input detected by computer system 101 in FIG. 7BT has one or more characteristics of the selection input(s) described with reference to methods 800, 900, 1000, 1100, 1200, and/or 1300 (e.g., and/or the first input described with reference to method 1300). In some embodiments, in response to detecting the second selection input, computer system 101 permits hand 714 to control movement of virtual object 706.

From FIG. 7BT to FIG. 7BU, computer system 101 detects hand 714 move away from the table in three-dimensional environment 702 during the second selection input. In response to detecting the movement of hand 714, computer system 101 moves virtual object 706 away from the table in three-dimensional environment 702 (e.g., the movement of virtual object 706 corresponds to the detected movement of hand 714 during the second selection input).

FIGS. 7BV to 7BY illustrate examples of computer system 101 moving virtual object 706 to respective resting poses on the table in three-dimensional environment 702 in response to detecting an end of the second selection input. In some embodiments, in FIGS. 7BV to FIG. 7BY, virtual object 706 is designated as having a fourth resting behavior. For example, the fourth resting behavior includes a fourth set of spatial constraints for moving virtual object 704 after the end of the first selection input (e.g., different from the first set of spatial constraints associated with the first resting behavior, the second set of spatial constraints associated with the second resting behavior, and/or the third set of spatial constraints associated with the third resting behavior). Designating virtual object 706 with the fourth resting behavior optionally includes defining a region of three-dimensional environment 702 that virtual object 706 is designated to rest within when movement of virtual object 706 is not controlled by an input element (e.g., hand 714 and/or a controller). For example, the region of three-dimensional environment 702 corresponds to any location on the surface of the table (e.g., virtual object 706 is snapped to the surface of the table when the virtual object is at the resting pose associated with the virtual object). In some embodiments, the location on the table that the computer system 101 moves virtual object 706 to in response to detecting the end of the second selection input is based on a velocity (e.g., direction and/or magnitude) of movement of hand 714 detected during the end of the second selection input (e.g., and/or detected within 0.1, 0.2, 0.5, 1, 2, 5, or 10 seconds of the end of the second selection input).

Additionally, or alternatively, in some embodiments, designating virtual object 706 with the fourth resting behavior includes designating virtual object 706 to rest on any surface (e.g., real-world surface and/or virtual surface) in three-dimensional environment 702. For example, a respective resting surface is defined based on a representative gaze location detected by computer system 101 (e.g., having one or more characteristics of the representative gaze location described with reference to method 1300). For example, in response to detecting the end of the second selection input, in accordance with a determination that a representative gaze location corresponds to a first surface in three-dimensional environment 702, such as the surface of the table shown in FIGS. 7BV to 7BY, computer system 101 moves virtual object 706 to a first resting pose (e.g., location and/or orientation) on the first surface in three-dimensional environment 702 (e.g., the resting location and/or orientation of virtual object 706 on the first surface is based on a velocity and/or angular velocity of movement of hand 714 detected by computer system 101 during the end of the second selection input). For example, in response to detecting the end of the second selection input, in accordance with a determination that the representative gaze location corresponds to a second surface, different from the first surface, in three-dimensional environment 702, computer system 101 moves virtual object 706 to a second resting pose (e.g., location and/or orientation) on the second surface in three-dimensional environment 702 (e.g., the resting location and/or orientation of virtual object 706 on the second surface is based on a velocity and/or angular velocity of movement of hand 714 detected by computer system 101 during the end of the second selection input).

From FIG. 7BU to FIG. 7BV, computer system 101 detects movement of hand 714 and an end of the second selection input. For example, from FIG. 7BU to FIG. 7BV, hand 714 ceases to perform an air pinch and moves with a fourth velocity represented by vectors 794a and 794b. In some embodiments, vector 794a represents the fourth velocity of movement of hand 714 including leftward movement relative to the X-axis of three-dimensional environment 702 and upward movement relative to the Y-axis of three-dimensional environment 702. In some embodiments, vector 794b represents the fourth velocity of movement of hand 714 including forward movement relative to the Z-axis of three-dimensional environment 702. From FIG. 7BU to FIG. 7BV, computer system 101 optionally detects a representative gaze location corresponding to the table in three-dimensional environment 702 (e.g., computer system 101 detects a gaze of the user of computer system 101 directed to a respective location on the table).

In FIGS. 7BV to 7BW, in response to detecting the end of the second selection input and movement of hand 714, computer system 101 moves virtual object 706 to a first resting pose on the table in three-dimensional environment 702 along a path 776a (e.g., shown in top-down view 703). In some embodiments, because virtual object 706 is designated as having the fourth resting behavior, which designates movement of virtual object 706 to a location on the table in response to detecting the end of the second selection input, the movement of virtual object 706 after the end of the second selection input ends on the surface of the table regardless of a direction and/or magnitude of the fourth velocity of movement of hand 714. Moving virtual object 704 in accordance with a simulated inertia corresponding to the direction and/or magnitude of the fourth velocity of movement of hand 714 (e.g., and not in accordance with the fourth resting behavior of virtual object 704) optionally would not cause virtual object 706 to rest on the surface of the table in three-dimensional environment 702. For example, from FIG. 7BV to 7BW although the fourth velocity of movement of hand 714 optionally includes a magnitude that would not otherwise cause computer system 101 to move virtual object 704 with enough simulated inertia to reach the table in the three-dimensional environment 702, computer system 101 moves virtual object 706 by a distance that reaches the table in the three-dimensional environment 702. For example, from FIG. 7BV to FIG. 7BW, although the fourth velocity of movement of hand 714 optionally includes a direction (e.g., leftward and/or upward movement) that would not otherwise cause computer system 101 to move virtual object 704 with a simulated inertia with an ending location on the surface of the table, computer system moves virtual object 706 to a resting pose on the surface of the table.

Returning to FIG. 7BV, top-down view 703 includes representations of alternative paths of movement of virtual object 706 to the surface of the table in three-dimensional environment 702. In some embodiments, path 776b shown in top-down view 703 represents a path of movement of virtual object 706 that occurs based on the end of the second selection input including a first respective velocity of movement hand 714 that optionally includes a direction that is not toward the table (e.g., the direction of the first respective velocity is such that moving virtual object 706 based on the first respective velocity, and not based on the fourth resting behavior, causes virtual object 706 to not rest on the surface of the table). In some embodiments, because virtual object 706 is designated as having the fourth resting behavior which designates virtual object 706 to rest on the table, computer system 101 moves virtual object 706 to a resting location on the table regardless of the direction of the first respective velocity of hand 714. For example, path 776b includes a first portion of movement that is in a direction that is based on the respective velocity of hand 714, and a second portion of movement to the surface of the table. The first respective velocity of hand 714 optionally includes a magnitude that would not cause virtual object 706 to reach the surface of the table, as discussed below with reference to path 776c, and computer system 101 moves virtual object 706 to the surface of the table regardless of the magnitude of the first respective velocity.

Alternatively, in some embodiments, in response to detecting the end of the second selection input and the fourth velocity of movement of hand 714, in accordance with a determination that computer system 101 detects a representative gaze location directed toward a respective surface different from the surface of the table shown in FIGS. 7BV to 7BU (e.g., computer system 101 detects the representative gaze location in conjunction with the end of the second selection input), computer system 101 moves virtual object 706 to the respective surface in three-dimensional environment 702 optionally along a different path than paths 776a to 776c shown in top-down view 703 in FIG. 7BV (e.g., based on a velocity and/or angular velocity of hand 714 detected by computer system 101 in conjunction with the end of the second selection input).

In some embodiments, path 776c shown in top-down view 703 represents a path of movement of virtual object 706 that occurs based on the end of the second selection input including a second respective velocity of movement of hand 714 that includes a direction toward the table but optionally a magnitude that would not cause virtual object 706 to reach the surface of the table (e.g., the magnitude of the second respective velocity is such that moving virtual object 706 based on the second respective velocity, and not based on the fourth resting behavior, causes virtual object 706 to cease moving before reaching the table). In some embodiments, because virtual object 706 is designated as having the fourth resting behavior and which designates virtual object 706 to rest on the table, computer system 101 moves virtual object 706 to a resting location on the table regardless of the magnitude of the second respective velocity.

FIGS. 7BX to 7BY illustrate computer system 101 moving virtual object 706 to a second resting pose on the table, different from the first resting pose shown in FIG. 7BW, in response to detecting the end of the second selection input and movement of hand 714 that includes a fifth velocity of movement represented by vectors 795a and 795b. In some embodiments, vector 795a represents the fifth velocity of movement of hand 714 including rightward movement relative to the X-axis of three-dimensional environment 702 and upward movement relative to the Y-axis of three-dimensional environment 702. In some embodiments, vector 795b represents the fifth velocity of movement of hand 714 including forward movement relative to the Z-axis of three-dimensional environment 702. In some embodiments, the fifth velocity of movement of hand 714 shown in FIG. 7BX includes a greater magnitude of velocity than the fourth velocity of movement of hand 714 shown in FIG. 7BV.

From FIG. 7BX to FIG. 7BY, computer system 101 moves virtual object 706 along a path 778a to the second resting pose on the table. For example, because the fifth velocity of movement of hand 714 is greater than the fourth velocity of movement of hand 714, the second resting pose of virtual object 706 shown in FIG. 7BX is farther from the starting location of virtual object 706 (e.g., when the end of the second selection input is detected) than the first resting pose of virtual object 706 shown in FIG. 7BW. For example, in response to detecting the fourth velocity of movement of hand 714 during the end of the second selection input, computer system 101 moves virtual object 706 to a resting location at the front of the table in three-dimensional environment 702, and in response to detecting the fifth velocity of movement of hand 714 during the end of the second selection input, computer system 101 moves virtual object 706 to a resting location at the back of the table in three-dimensional environment 702.

Returning to FIG. 7BX, top-down view 703 includes a representation of an alternative trajectory 778b of movement of virtual object 706 in three-dimensional environment 702. For example, trajectory 778b corresponds to a path of movement that virtual object 706 would have if (i) virtual object 706 was not designated as having the fourth resting behavior; and (ii) the end of the second selection input included a respective velocity of movement of hand 714 with a magnitude greater than the fifth velocity of movement of hand 714. In some embodiments, because virtual object 706 is designated as having the fourth resting behavior in FIG. 7BX (e.g., which designates virtual object 706 to be moved to the surface of the table when the virtual object 706 comes to rest), in response to detecting movement of hand 714 that includes the respective velocity associated with trajectory 778b, computer system 101 moves virtual object 706 to the same second resting pose on the table that is shown in FIG. 7BY (e.g., despite the respective velocity including a magnitude that would otherwise cause virtual object 706 to move to a location in three-dimensional environment 702 that is farther than the back edge of the table).

FIGS. 7BZ to 7CE illustrate examples of computer system 101 moving virtual object 706 to respective resting poses in three-dimensional environment 702 based on a gaze of the user of the computer system detected before and/or in conjunction with detecting the end of the second selection input (e.g., within 0.1, 0.2, 0.5, 1, 2, 5, or 10 seconds of the end of the second selection input). In some embodiments, in FIGS. 7BZ to 7CE, virtual object 706 is designated as having a fifth resting behavior. In some embodiments, the fifth resting behavior includes a fifth set of spatial constraints (e.g., different from the sets of spatial constraints described above) for moving virtual object 704 after the end of the first selection input. Designating virtual object 706 as having the fifth resting behavior optionally includes permitting virtual object 706 to rest at any location on the surface of the table in three-dimensional environment 702 that is based on a representative gaze location that is detected before and/or in conjunction with the end of the second selection input (e.g., the representative gaze location has one or more characteristics of the representative gaze location described with reference to method 1300).

FIGS. 7BZ to 7CB illustrate computer system 101 moving virtual object 706 to a first location on the surface of the table in three-dimensional environment 702 that is based on a representative gaze location detected by computer system 101. In FIG. 7BZ, computer system 101 moves virtual object 706 in accordance with detected movement of hand 714 while computer system 101 detects that hand 714 maintains the second selection input (e.g., the user of computer system 101 has not yet ended the second selection input by ceasing to perform an air pinch with hand 714). In some embodiments, as shown in FIG. 7BZ, computer system 101 detects gaze 780a directed toward a first location on the table in three-dimensional environment 702. In some embodiments, computer system 101 detects the first location of gaze 780a while motion of the gaze of the user of computer system 101 is below a threshold amount of movement (e.g., as described with reference to method 1300).

From FIG. 7BZ to FIG. 7CA, computer system 101 detects an end of the second selection input. For example, computer system 101 detects that the user of computer system ceases to perform an air pinch with hand 714. In some embodiments, in FIG. 7CA, computer system 101 detects gaze 780b directed toward the first location on the table in three-dimensional environment 702 in conjunction with (e.g., concurrently with, just before, or just after) detecting the end of the second selection input. The end of the second selection input optionally does not include movement of hand 714.

From FIG. 7CA to FIG. 7CB, in response to detecting the end of the second selection input, computer system 101 moves virtual object 706 to the first location on the table in three-dimensional environment 702 along path 782a. For example, computer system 101 moves virtual object 706 along path 782a to the first location on the table based on the location of gaze 780a detected by computer system 101 in FIG. 7BZ (e.g., a gaze location detected while motion of the gaze is below a threshold amount of movement). Alternatively, for example, computer system 101 moves virtual object 706 along path 782a to the first location on the table based on the location of gaze 780b detected in FIG. 7CA (e.g., a gaze location detected in conjunction with the end of the second selection input). Path 782a optionally corresponds to a direct path of movement of virtual object 706 from the starting location of virtual object 706 (e.g., shown in FIG. 7BZ) to the first location on the table that gaze 780a and/or gaze 780b was directed to. In some embodiments, path 782a is a direct path to the first location because computer system 101 does not detect movement of hand 714 in conjunction with detecting the end of the second selection input. For example, in accordance with a determination that the end of the second selection input includes movement of hand 714, computer system 101 moves virtual object 706 to the first location on the table that gaze 780a and/or gaze 780b was directed to on a path (e.g., an indirect path) that is influenced by the movement of hand 714 (e.g., computer system 101 moves virtual object 704 on a first portion of the path with a simulated inertia corresponding to a velocity of movement of hand 714 and/or a controller).

FIGS. 7CC to 7CE illustrates computer system 101 moving virtual object 706 to a second location on the surface of the table in three-dimensional environment 702 that is based on a representative gaze location detected by computer system 101. In FIG. 7CC, hand 714 controls virtual object 706 during the second selection input (e.g., the user of computer system 101 has not yet ended the second selection input by ceasing to perform an air pinch with hand 714). In some embodiments, as shown in FIG. 7CC, computer system 101 detects gaze 780c directed toward a second location on the table in three-dimensional environment 702. In some embodiments, computer system 101 detects the second location of gaze 780c while motion of the gaze of the user of computer system 101 is below a threshold amount of movement (e.g., as described with reference to method 1300).

From FIG. 7CC to FIG. 7CD, computer system 101 detects an end of the second selection input. For example, the computer system 101 detects that the user of computer system 101 ceases to perform an air pinch with hand 714. In some embodiments, in FIG. 7CD, computer system 101 detects gaze 780d directed toward the second location on the table in three-dimensional environment 702 in conjunction with (e.g., concurrently with, just before, or just after) detecting the end of the second selection input. The end of the second selection input optionally does not include movement of hand 714.

From FIG. 7CD to FIG. 7CE, in response to detecting the end of the second selection input, computer system 101 moves virtual object 706 to the second location on the table in three-dimensional environment 702 along path 782b. For example, computer system 101 moves virtual object 706 along path 782b to the second location on the table based on the location of gaze 780c detected by computer system 101 in FIG. 7CC (e.g., a gaze location detected while motion of the gaze is below a threshold amount of movement). Alternatively, for example, computer system 101 moves virtual object 706 along path 782b to the second location on the table based on the location of gaze 780d detected in FIG. 7CD (e.g., a gaze location detected in conjunction with the end of the second selection input). Path 782b optionally corresponds to a direct path of movement of virtual object 706 from the starting location of virtual object 706 (e.g., shown in FIG. 7CC) to the second location on the table that gaze 780c and/or gaze 780d was directed to. In some embodiments, path 782b is a direct path to the second location because computer system 101 does not detect movement of hand 714 in conjunction with detecting the end of the second selection input (e.g., as described above with reference to path 782a).

FIGS. 7CF to 7CK illustrates computer system 101 moving virtual object 708 in three-dimensional environment 702 in response to detecting an end of a third selection input while virtual object 708 is snapped to the table in three-dimensional environment 702. In FIG. 7CF, the user of computer system 101 controls movement of virtual object 708 using hand 714 while performing a third selection input. For example, the third selection input has one or more characteristics of the selection input(s) described with reference to methods 800, 900, 1000, 1100, 1200, and/or 1300 (e.g., and/or the first input described with reference to method 1300).

From FIG. 7CF to FIG. 7CG, computer system 101 detects hand 714 (e.g., and/or the user of computer system 101) move leftward in three-dimensional environment 702 during the third selection input. In response to detecting the movement of hand 714, computer system 101 moves virtual object 708 leftward in three-dimensional environment 702 (e.g., the movement of virtual object 708 corresponds to the detected movement of hand 714).

In some embodiments, in FIGS. 7CF to 7CK, virtual object 708 is designated as having a sixth resting behavior. The sixth resting behavior optionally has one or more characteristics of the first resting behavior described above. For example, designating virtual object 708 with the sixth resting behavior includes defining a respective resting pose (e.g., location and/or orientation) in three-dimensional environment 702 that virtual object 708 is designated to rest at (e.g., and/or be moved to) when movement of virtual object 708 is not controlled by an input element (e.g., hand 714 and/or a controller). In some embodiments, in FIG. 7CG, top-down view 703 includes a representation of a resting location 770b associated with the sixth resting behavior of virtual object 708.

From FIG. 7CG to FIG. 7CH, computer system 101 detects hand 714 move downward in three-dimensional environment 702 during the third selection input. In response to detecting the movement of hand 714, computer system 101 moves virtual object 708 downward in three-dimensional environment 702 toward the surface of the table (e.g., the movement of virtual object 708 corresponds to the detected movement of hand 714).

In some embodiments, the movement of virtual object 708 shown in FIGS. 7CG to 7CH satisfies one or more snapping criteria (e.g., having one or more characteristics of the one or more snapping criteria described with reference to method 1300). For example, as shown in side view 784 in FIG. 7CH, virtual object 708 is moved within a threshold distance 786 of the surface of the table. In some embodiments, in accordance with a determination that the one or more snapping criteria are satisfied, computer system 101 snaps virtual object 708 to the surface of the table in FIG. 7CI (e.g., automatically and/or without further user input). For example, from FIG. 7CH to FIG. 7CI, computer system 101 moves virtual object 708 by a greater amount than the movement of hand 714 (e.g., the movement of virtual object 708 to the surface of the table is influenced by a snapping behavior of the virtual object 708 to the surface of the table in addition or alternatively to the movement of hand 714).

From FIG. 7CI to FIG. 7CJ, computer system 101 detects movement of hand 714 and an end of the third selection input. For example, from FIG. 7CI to FIG. 7CJ, while virtual object 708 remains snapped to the surface of the table in three-dimensional environment 702, computer system 101 detects the end of the third selection input and movement of hand 714 including a sixth velocity represented by vectors 796a and 796b. In some embodiments, vector 796a represents the sixth velocity of movement of hand 714 including rightward movement relative to the X-axis of three-dimensional environment 702 and upward movement relative to the Y-axis of three-dimensional environment 702. In some embodiments, vector 796b represents the sixth velocity of movement of hand 714 including forward movement relative to the Z-axis of three-dimensional environment 702.

From FIG. 7CJ to FIG. 7CK, computer system 101 moves virtual object 708 along a path 788 to the resting location 770b while maintaining virtual object 708 snapped to the surface of the table. In some embodiments, a first portion of movement of virtual object 708 along path 788 includes moving virtual object 708 along the surface of the table in a direction and/or with a speed that corresponds to the sixth velocity of movement of hand 714. In some embodiments, the location of virtual object 708 shown in FIG. 7CJ corresponds to end of the first portion of movement of virtual object 708 along path 788. In some embodiments, in a second portion of movement of virtual object 708 along path 788 (e.g., from the location of virtual object 708 shown in FIG. 7CJ to the resting location of virtual object 708 shown in FIG. 7CK), computer system 101 moves virtual object 708 to the resting location associated with the sixth resting behavior of virtual object 708 while maintaining virtual object 708 snapped to the surface of the table.

FIG. 14A through FIG. 14N illustrate methods of moving virtual objects relative to a three-dimensional environment in accordance with some embodiments of the disclosure. Some embodiments of the disclosure are directed to moving a virtual object based on one or more processes associated with applications, as described with reference to method 1000.

FIG. 14A illustrates a computer system 101 (e.g., tablet, smartphone, wearable computer, or head mounted device) displaying, via a display generation component (e.g., display generation component 120 of FIG. 1A such as a computer display, touch screen, or one or more display modules of a head mounted device), a three-dimensional environment 1400 (e.g., an AR, AV, VR, MR, or XR environment) from a viewpoint of the user of the computer system 101 (e.g., tablet, smartphone, wearable computer, or head mounted device), for example, facing a back wall of the physical environment in which computer system 101 is located. In some embodiments, computer system includes a display generation component 120 and a plurality of image sensors 314a-314c (e.g., of the one or more image sensors 314 as shown in FIG. 3A). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101 (e.g., tablet, smartphone, wearable computer, or head mounted device). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., based on gaze) of the user (e.g., internal sensors facing inwards towards the face of the user).

As shown in FIG. 14A, computer system 101 captures one or more images of the physical environment around computer system, including one or more objects in the physical environment around computer system 101. In some embodiments, computer system 101 displays representations of the physical environment included in three-dimensional environment 1400. For example, three-dimensional environment 1400 optionally presents an image of a physical pedestal, and/or the physical pedestal is optionally physically visible via a transparent or semi-transparent material.

In FIG. 14A, three-dimensional environment 1400 also includes one or more virtual objects. For example, as shown in FIG. 14A, the computer system 101 displays virtual objects 1404, 1406, and 1408 in the three-dimensional environment 1400 (e.g., an AR, AV, VR, MR, or XR environment). In some embodiments, the virtual object is or includes one or more of user interfaces of an application (e.g., an application running on the computer system 101 (e.g., tablet, smartphone, wearable computer, or head mounted device)) containing content (e.g., windows displaying photographs, playback user interface displaying content, and/or web-browsing user interface displaying text), three-dimensional objects (e.g., virtual clocks, virtual animals, virtual balls, and/or virtual cars) or any other element displayed by computer system 101 (e.g., tablet, smartphone, wearable computer, or head mounted device) that is not included in the physical environment of display generation component 120. For example, three-dimensional environment 1400 in FIG. 14A includes a volumetric virtual object 1408, that shares one or more characteristics and/or corresponds to virtual object 708 as described in greater detail herein.

In FIG. 14A, three-dimensional environment 1400 includes virtual object 1404, which optionally corresponds to a virtual table for interactive experiences such as virtual tabletop games. In some embodiments, virtual object 1404 corresponds to a first process, and/or a first software application. For example, virtual object 1404 is optionally generated using information received and/or obtained from the first process, which is optionally a process performed by the first software application and/or performed by computer system 101.

In FIG. 14A, three-dimensional environment 1400 includes virtual object 1406, which optionally corresponds to a virtual game board for interactive experiences such as virtual board games. In some embodiments, virtual object 1406 corresponds to a second process that is different from the first process, and/or a second software application that is different from the first software application. For example, virtual object 1406 is optionally generated using information received and/or obtained from the second process, which is optionally a process performed by the second software application and/or performed by computer system 101.

In FIG. 14A, computer system 101 displays virtual object 1408 (e.g., similar to, or the same as virtual object 708 described with reference to FIG. 7A). In particular, virtual object 1408 is displayed at a first position within the three-dimensional environment 1400. As shown in FIG. 14A, virtual object 1408 is within a first application boundary associated with the virtual object 1404. As described with reference to method 1000, an application boundary optionally defines a threshold distance that, when within the threshold distance, respective virtual objects move optionally move in accordance based on a customized pattern of movement and/or simulated physics defined by the process corresponding to an application. As shown in FIG. 14A, virtual object 1404 includes a predefined slot 1410. In some embodiments, the predefined slot corresponds to a position at which there is a simulated attraction of objects that optionally pulls the object when moved to within a threshold distance (e.g., 1, 2, 3, 5, 10, 20, 30, 50, 100, or 200 cm) of slot 1410. In FIG. 14A, computer system 101 detects attention 1480 of the user of computer system 101 directed to a position overlaying virtual object 1408. In FIG. 14A, visual feedback 1418 optionally corresponds to a target of attention 1480 of the user in three-dimensional environment 1400. In FIG. 14A, outside the dimensions of the housing of computer system 101, the position of hand 1414 is shown overhead relative to three-dimensional environment 1400. The overhead view of three-dimensional environment 1400 includes a set of axes 1412, which optionally illustrates the relative movement of virtual object 1408 away from its position as shown in FIG. 14A.

From FIG. 14A to FIG. 14B, computer system 101 detects hand 1414 move rightward and upward, relative to as shown in FIG. 14A. In some embodiments, the amount of translation of the hand 1414 and/or the directions of movement of hand 1414 are different from the path of movement of virtual object 1408. For example, the amount of upward movement of hand 1414 from FIG. 14A to FIG. 14B is optionally different from the amount of upward movement of virtual object 1408 from FIG. 14A to FIG. 14B. Additionally, the amount of rightward movement of hand 1414 from FIG. 14A to FIG. 14B is optionally different from the amount of rightward movement of virtual object 1408 from FIG. 14A to FIG. 14B. In particular, the first application associated with virtual object 1404 optionally defines a curved path of travel relative to the surface of virtual object 1404 toward the slot 1410 and/or in accordance with a movement scale parameter as described further at least with reference to method 1000. From FIG. 14B to FIG. 14C, computer system 101 detects hand 1414 move rightward, without detecting upward or downward movement relative to the position as shown in FIG. 14B. From FIG. 14B to FIG. 14C, computer system 101 moves virtual object 1408 rightward and upward, based on the rightward movement of hand 1414 with modifications defined by the first software application, causing a curved path of movement of virtual object 1408 that differs from a path of movement of hand 1414 and/or in accordance with a movement scale parameter as described further at least with reference to method 1000.

From FIG. 14C to FIG. 14D, computer system 101 detects a termination of input from hand 1414, including a de-pinching of fingers forming an air pinch gesture relative to the gesture as shown in FIG. 14C. The spatial arrangement of virtual object 1408 illustrated in FIG. 14D, for example. As described with reference to method 1000, in some embodiments, the first process associated with the first application that corresponds to virtual object 1404 optionally controls the spatial arrangement of virtual objects within the application boundary and/or that are being controlled using the first process. For example, the computer system 101 moves the virtual object 1408 to overlap with the slot 1410 from FIG. 14C to FIG. 14D, and optionally also rotates virtual object 1408 to face rightward relative to a viewpoint of a user of computer system 101. Thus, without detecting input expressly designating the translation and/or rotation of virtual object 1408, computer system 101 applies a custom behavior of virtual object, at least because the first process is being used to control movement of virtual object 1408.

In some embodiments, a respective process in control of a virtual object defines a set of object movement behaviors and/or simulated physics that dictates the movement of the virtual object, as described with reference to method 1000. For example, the respective process optionally defines a simulated set of physics which optionally enhances, dampens, and/or otherwise modifies the movement of virtual object. In some embodiments the simulated set of physics includes a degree of simulated gravity which affects the rate at which virtual objects are moved toward a ground of a three-dimensional environment and/or a strength of attraction between the virtual object and features included in virtual content that corresponds to the respective process, such as a volumetric virtual planet, such as in response to the termination of input by hand 1414 as shown from FIG. 14C to FIG. 14D. Additionally or alternatively, the respective process optionally dampens or enhances the distance which virtual dice and/or other objects are optionally thrown. For example, in response to detecting movement input directed to virtual dice, computer system 101 optionally detects a velocity of the movement input when selection input (e.g., air pinch contact between fingers, selection of a button, and/or a release of a finger from a trackpad) terminates. In accordance with a determination that the virtual object is being thrown within an application boundary corresponding to a first application, and that the simulated physics defined by the first application corresponding to a first throw dampening factor, computer system 101 optionally moves animates a virtual throwing of the virtual dice by a first distance. Additionally or alternatively, in accordance with a determination that the virtual object is being thrown within an application boundary corresponding to a second application, different from the first application, and that the simulated physics defined by the second application correspond to a second throw dampening factor, optionally different from the first throw dampening factor, computer system 101 optionally moves animates a virtual throwing of the virtual dice by a second distance, greater than or less than the first distance. For example, when the dampening factor is relatively larger, the dice cease movement relatively close to where the movement of the dice begins.

In FIG. 14E, computer system 101 detects attention 1480 directed to virtual object 1408, and in response, displays visual feedback 1418 indicating the position at which attention 1480 is directed to on virtual object 1408. From FIG. 14E to FIG. 14F, computer system 101 detects a rotation of hand 1414 by a first amount. In response to detecting the rotation of hand 1414 from FIG. 14E to FIG. 14F, computer system 101 “over-rotates” the virtual object 1408 as described with reference to methods 900, 1000, and/or 1100. As shown in FIG. 14F, computer system 101 rotates virtual object 1408 by 180 degrees relative to an axis extending normal to a surface of virtual object 1404 and extending through a center of virtual object 1408 (e.g., the center of the head of virtual object 1408). In some embodiments, the first process optionally defines a set of simulated physics and/or movement rules for virtual object 1408 such that virtual object 1408, while aligned with slot 1410, optionally rotates by an amount that is relatively greater than the amount of rotation of hand 1414.

From FIG. 14F to FIG. 14G, computer system 101 detects termination of input by hand 1414 including de-pinching of the index and thumb fingers. In response to detecting the termination of input from FIG. 14F to FIG. 14G, computer system 101 maintains the spatial arrangement of virtual object 1408 relative to three-dimensional environment 1400, keeping virtual object 1408 oriented leftward. In this way, the first process continues to optionally dictate and/or customize the manner by which the virtual object 1408 moves in accordance with input and/or termination of input by the user of computer system 101. In FIG. 14H, computer system detects attention 1480 directed to virtual object 1408, and in response, displays visual feedback 1418 indicating the location of attention 1480. Further, computer system 101 in FIG. 14H detects input including an air pinch by hand 1414.

From FIG. 14H to FIG. 14I, computer system 101 detects a pulling back of hand 1414 while the air pinch shown in FIG. 14H is maintained, and in response, moves virtual object away from virtual object 1404. In some embodiments, computer system 101 ceases control of movement of virtual object 1408 in accordance with the first process associated with virtual object 1404 in response to detecting the input shown from FIG. 14H to FIG. 14I. For example, because computer system 101 detects hand 1414 move by a first amount away from virtual object 1404, and/or in accordance with a determination that the input by hand 1414 corresponds to a request to move virtual object 1408 to a location in three-dimensional environment 1400 that is beyond the threshold distance corresponding to a first application boundary of virtual object 1404, computer system 101 controls virtual object 1408 in accordance with a manner of movement defined by an operating system of computer system 101. For example, from FIG. 14H to FIG. 14I, the operating system and/or a respective process associated with the operating system defines the spatial arrangement of virtual object 1408 relative to three-dimensional environment 1400. For example, from FIG. 14H to FIG. 14I, computer system 101 increases the scale of virtual object 1408 to correspond to a predefined scale and/or a relative scale defined by parameters of virtual object 1408. Additionally, in FIG. 14I, computer system 101 displays virtual object 1408 with a tilt relative to a vector extending normal to a floor of three-dimensional environment 1400, optionally reinforcing the termination of control of virtual object 1408 by the first process.

From FIG. 14I to FIG. 14J, computer system 101 detects movement of hand 1414 forward into three-dimensional environment relative to the viewpoint of the user of computer system 101. In response to detecting the forward movement of hand 1414 from FIG. 14I to FIG. 14J, computer system 101 determines that the location of virtual object 1408 optionally corresponds to a second application boundary, different from the first application boundary, that is associated with virtual object 1406. In some embodiments, the second application boundary is different from the first application boundary, such as defined by different one or more threshold distances, as described with reference to method 1000. Because the virtual object 1408 is moved to within the second application boundary, computer system 101 displays virtual object with a scale defined by the second process as shown in FIG. 14J. In particular, as shown in FIG. 14J, virtual object 1408 is decreased in scale relative to the scale as shown in FIG. 14I to accommodate the placement of virtual object 1408 on respective tiles included in the virtual game board corresponding to virtual object 1406.

In FIG. 14J, as shown in the overhead view of three-dimensional environment 1400, axes 1412 are illustrated again to indicate the origin of movement of virtual object 1408 relative to virtual object 1406. From FIG. 14J to FIG. 14K, computer system 101 detects termination of input by hand 1414 including de-pinching of the thumb and index finger of hand 1414. In response to detecting the termination, the second process controls movement of 1408 to coincide with a respective tile of the virtual game board corresponding to virtual object 1406. As shown in the overhead view of three-dimensional environment 1400, hand 1414 remains in place from FIG. 14J to FIG. 14K, but virtual object 1408 is moved upwards and/or rightwards to center virtual object 1408 on the respective tile. In this way, the second process optionally controls the spatial arrangement of virtual object relative to virtual object 1406 and/or three-dimensional environment 1400 while virtual object 1408 is within the second application boundary and/or corresponds to the virtual object 1406.

In FIG. 14L, computer system 101 detects attention 1480 directed to virtual object 1408 and detects hand 1414 provide a selection input including the air pinch while attention 1480 is directed to virtual object 1408. From FIG. 14L to FIG. 14M, computer system 101 detects hand 1414 move forward and rightward in three-dimensional environment 1400 as shown in the overhead view of three-dimensional environment 1400. In response to detecting the movement of hand 1414 from FIG. 14L to FIG. 14M, computer system 101 moves virtual object 1408 forward in three-dimensional environment (e.g., without rightward movement of virtual object 1408) due to the second process moving virtual object 1408 along a file of the virtual game board and/or not laterally relative to the virtual game board corresponding to virtual object 1406. In FIG. 14M, computer system 101 displays virtual object 1408 facing toward an edge of the virtual game board opposite the respective edge of the virtual game board virtual object 1408 is closest to. For example, virtual object 1408 is optionally representative of a chess pawn that is to be promoted to a chess queen, and accordingly is rotated to face toward the user's end of the virtual game board to indicate as such.

From FIG. 14M to FIG. 14N, computer system 101 detects termination of the input by hand 1414. In response to detecting the input, and because virtual object 1408 is to be promoted to a different role relative to the virtual game board, the second process indicates that virtual object is to be moved. Accordingly, from FIG. 14M to FIG. 14N, computer system 101 animates a toppling of the virtual object 1408 toward the ground of three-dimensional environment 1400.

FIG. 8 is a flowchart illustrating method 800 of displaying visual feedback indicating location of an input element in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system in communication with one or more display generation components and one or more input devices. For example, the computer system optionally is or includes a mobile device (e.g., a tablet, a smartphone, a media player, or a wearable device), a computer, a wearable device, and/or another electronic device. In some embodiments, the display generation component is a display integrated with the electronic device (optionally a touch screen display), external display such as a monitor, projector, television, or a hardware component (optionally integrated or external) for projecting virtual content or causing a virtual content to be visible to one or more users. In some embodiments, the one or more input devices include an electronic device or component capable of receiving a user input (e.g., capturing a user input and/nor detecting a user input.) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor). In some embodiments, the computer system is in communication with a hand tracking device (e.g., one or more cameras, depth sensors, proximity sensors, touch sensors (e.g., a touch screen, trackpad)). In some embodiments, the hand tracking device is a wearable device, such as a smart glove. In some embodiments, the hand tracking device is a handheld input device, such as a remote control or stylus.

In some embodiments, while displaying, via the one or more display generation components, a first virtual object at a first location in a three-dimensional environment, the computer system detects (802), via the one or more input devices, that an input element (e.g., a controller or hand that is optionally associated with a user of the computer system) satisfies one or more criteria, including a criterion that is satisfied when the input element is within a threshold distance of the first virtual object, such as hand 714 coming within a threshold distance of virtual object 704 in FIG. 7E.

In some embodiments, in response to detecting that the input element satisfies the one or more criteria, the computer system displays (804), via the one or more display generation components, visual feedback separate from a visual representation of the input element (e.g., an appearance of a hand or controller as visible through optical passthrough, an appearance of a hand or controller a displayed via virtual passthrough, and/or a virtual object that is displayed to represent a position of a hand or controller and tracks movement of the hand or controller), wherein the visual feedback indicates a location of the input element relative to the first virtual object in the three-dimensional environment (e.g., visual feedback that is displayed on, near, or otherwise connected to the first virtual object, such as being displayed on a surface of the first virtual object or on a fixed boundary around the first virtual object), such as simulated glow 720 in FIG. 7E. In some embodiments, the first virtual object shares one or more characteristics with the virtual objects described with respect to methods 900, 1000, 1100, 1200, and/or 1300. In some embodiments, the first virtual object is a representation of a three-dimensional object that is displayed in the three-dimensional environment, and the first virtual object is interactable such that the computer system performs one or more operations on the first virtual object in response to an input provided to the computer system. In some embodiments, the three-dimensional environment at least partially incorporates a representation of the real-world physical environment while using the computer system (e.g., via active or passive passthrough). In some embodiments, the three-dimensional environment is an extended reality (XR) environment, such as a virtual reality (VR) environment, a mixed reality (MR) environment, or an augmented reality (AR) environment. In some embodiments, the first virtual object is displayed at a particular location with the three-dimensional environment that is visible to the user of the computer system depending on the current viewpoint of the user within the three-dimensional environment. In some embodiments, the computer system performs one or more operations directed to the first virtual object in response to inputs received by an input element. In some embodiments, the input element refers to an object that provides inputs to the computer system and includes but is not limited, a hand or other portion of the user, a controller device, and/or other input device such as a track pad, mouse, and/or touch input device. In some embodiments, and using the example of the hand as an input element, the computer system detects and tracks a location of the hand in the three-dimensional environment. Thus, in some embodiments, the computer system detects the position of the hand of the user with respect to the first virtual object. In some embodiments, the computer system determines that the hand of the user (e.g., the input element) is within a threshold distance of the first virtual object, such as 0.1, 0.5, 1, 5, 10, 20, 50, or 100 cm (e.g., the input directed to the first virtual object is direct manipulation input that is intended to simulate directly interacting with the first virtual object). In some embodiments, if the computer system determines that the hand of the user is not near to the first virtual object, the computer system forgoes displaying the visual feedback. In some embodiments, the threshold distance is based on a grabbing region established around the first virtual object that shares one or more characteristics with the grabbing region described with respect to methods 900, 1000, 1100, 1200, and/or 1300. In some embodiments, if the input element is determined to be within the threshold distance of the first virtual object (e.g., near the object), and the computer system has not detected that the input element has performed the selection input, the computer system displays visual feedback at or near the first virtual object indicating that the input element is near (e.g., within the distance threshold of) the first virtual object, and is at a location from which the selection can be performed. In some embodiments, the visual feedback includes displaying one or more portions of the first virtual object and/or one or more portions of the three-dimensional environment near the first virtual object with a visual appearance including but not limited to, a specific color or range of colors, a specific brightness, tint, and/or luminescence that is distinguishable from the color, brightness, tint, and/or luminescence of the first virtual object (e.g., a glowing region that is similar to a light being cast from the input element onto the first virtual object, such as a virtual flashlight, or virtual light beam extending from the input element onto the first virtual object). In some embodiments, the visual feedback is configured to provide the user of the computer system with a visual indication that upon performing the selection input, the first virtual object will be controllable by the input element in accordance with the embodiments described herein. In some embodiments, the visual feedback is configured to provide an indication as to which portion of a virtual object will be interacted with in response to a selection input (described below). In some embodiments, since the visual feedback is optionally configured to indicate that the first virtual object will be selected upon the input element performing a selection input, the visual feedback is displayed while the input element is within the threshold distance of the first virtual object, but while the input element has yet to perform the selection input.

In some embodiments, while displaying the visual feedback indicating the location of the input element relative to the first virtual object in the three-dimensional environment, the computer system detects (806) movement of the input element relative to the first location in the three-dimensional environment, such as the movement of hand 714 in FIGS. 7E-7H.

In some embodiments, in response to detecting the movement of the input element (808) relative to the first location in the three-dimensional environment, in accordance with a determination that the input element did not perform a selection input directed to the first virtual object prior to the movement of the input element and continues to meet the one or more criteria, the computer system moves (810) the visual feedback relative to the first virtual object in accordance with the movement of the input element without moving the first virtual object in the three-dimensional environment, wherein the visual feedback moves differently from movement of the visual representation of the input element (e.g., because the visual feedback is displayed on, near, or otherwise connected to the first virtual object, such as being displayed on a surface of the first virtual object or on a fixed boundary around the first virtual object), such as the movement of simulated glow 720 in response to the movement of hand 714 in FIGS. 7E-7H. In some embodiments, if the computer system does not detect that a selection input (described herein) has been performed, in response to detecting the movement of the input element, the computer system moves the visual feedback in accordance with the movement of the input element. In some embodiments, the location at which the visual feedback is located within the three-dimensional environment is based on the location of input element within the three-dimensional environment. For instance, in the example where the input element is a hand, the location that the visual feedback is displayed corresponds to a location of the hand (e.g., a finger and/or other part of the hand). In some embodiments, the selection input refers to an air gesture or other predetermined pose/configuration of the input element that the computer system, upon detecting such selection input, causes the first virtual object to be controlled by the input element (e.g., the first virtual object moves in response to movement of the input element). In some embodiments, and while the input element is near (e.g., within the threshold distance) the first virtual object without having performed the selection input, the computer system in response to detecting movement of the input element, moves the visual feedback in accordance with the movement of the input element. In some embodiments, the direction and/or magnitude of the movement of the visual feedback corresponds to the direction and/or magnitude of the movement of the input element. For instance, in the example where the input element is hand, if the hand is detected as moving to the right (from the viewpoint of the user), the visual feedback will also move in the same (or corresponding) direction. In some embodiments, the distance the visual feedback moves in response to movement of the input element is proportional to the distance the input element moves (e.g., the distance is the same and or some multiple of the distance that the input element moves). In some embodiments, the first virtual object does not move when the visual feedback moves since the visual feedback is displayed only when the first virtual object is not selected, and the first virtual object only moves when the first virtual object is selected. Thus, the visual feedback optionally provides an indication to the user that the first virtual object has not been selected by the user of the computer system.

In some embodiments, in response to detecting the movement of the input element relative to the first location in the three-dimensional environment, in accordance with a determination that the input element performed a selection input directed to the first virtual object prior to the movement of the input element, the computer system moves (812) the first virtual object in the three-dimensional environment in accordance with the movement of the input element (e.g., while the visual representation of the input element moves), such as the movement of virtual object 704 in FIGS. 7K-7O. In some embodiments, the movement of the first virtual object is displayed without displaying and/or moving the visual feedback relative to the first virtual object. In some embodiments, the computer system in response to detecting a selection input (described herein) performed (or that is still being performed) near (e.g., within the threshold distance of) the first virtual object, and in response to movement of the input element, moves the first virtual object in accordance with the detected movement of the input element. In some embodiments, the direction and/or magnitude of the movement of the first virtual object corresponds to the direction and/or magnitude of the movement of the input element. In some embodiments, the movement of the first virtual object in accordance with the movement of the input element shares one or more characteristics of the movement of the first virtual object described with respect to methods 900, 1000, 1100, 1200, and/or 1300. Displaying visual feedback to indicate that a virtual object will be selected when a selection input is performed with an input element minimizes input errors associated with unintended selection of a virtual object, thereby conserving computing resources associated with correcting the input errors.

In some embodiments, the one or more criteria include a criterion that is satisfied when the input element is in a pre-selection state, such as hand 714 coming within a threshold distance of virtual object 704 without performing an air pinch selection input in FIGS. 7E-7H. In some embodiments, a pre-selection state refers to a state of the input element, detected by the computer system, that occurs prior to the input element performing the selection input. For example, if the input element is a controller (such as a game controller), the pre-selection state refers to the controller (either through detected motion of the controller and/or motion of a directional input on the controller) coming into proximity with the first virtual object (e.g., within the threshold distance of the first object). In some embodiments, the visual feedback is configured to indicate that the input element is within the threshold distance needed to select the first virtual object (e.g., take control of the first virtual object), but that the first virtual object has not been selected because the input element has not been detected by the computer system as having performed the selection input. Displaying visual feedback when the input element is in a pre-selection state to indicate that a virtual object will be selected when a selection input is performed with an input element minimizes input errors associated with unintended selection of a virtual object, thereby conserving computing resources associated with correcting the input errors.

In some embodiments, the input element is a portion of a hand of the user, such as hand 714 in FIG. 7E. In some embodiments, the portion of the hand of the user includes but is not limited to the fingers of the hand, the palm of hand, a wrist that is proximal to the hand, and the arm of the user. In some embodiments, and in the example where the hand of the user is the input element, the selection input is an air pinch gesture, and detecting that the hand of the user is in the pre-selection state includes detecting that the fingers of the user have not formed a pinch but are instead in some other state including but not limited to coming together to form the pinch and/or separated in a manner that indicates that the fingers are not pinched together to form the selection input. Displaying visual feedback when the hand of the user is in a pre-selection state to indicate that a virtual object will be selected when a selection input is performed with an input element minimizes input errors associated with unintended selection of a virtual object, thereby conserving computing resources associated with correcting the input errors.

In some embodiments, the pre-selection state is a pre-pinch gesture performed with the portion of the hand of the user, such as hand 714 maintaining a pose that is not an air pinch selection input in FIG. 7E. In some embodiments, a pre-pinch gesture refers to a specific configuration of the hand (e.g., a pose of the hand) that when detected by the computer system, indicates that the hand (e.g., the input element) is in a pose that indicates that a selection input is imminent. In some embodiments, the pre-selection gesture refers to a pose of the hand that is associated with or is part of an air pinch gesture that occurs prior to the fingers of the hand of the user coming together and touching. In some embodiments, if the hand/fingers of the user are not in a pose that is associated with an air pinch gesture, then the computer system optionally determines that pose of the hand is not in a pre-selection state. As an example, the computer system optionally determines that the hand is performing a pre-selection (e.g., pre-pinch) gesture/pose, when two of the fingers of the hand of the user are detected as being within a threshold distance (e.g., 0.01, 0.1, 0.5, 1, 5, or 10 cm) from one another thus indicating that a selection input (e.g., air pinch) will be performed imminently. In some embodiments, detecting the pre-pinch gesture also include detecting motion of the one or more fingers that is indicative of a selection input about to be performed. For instance, in addition or alternatively, the computer system detects the pre-pinch gesture when the computer detects that the fingers of the hand of the user are in motion and coming towards each other. Displaying visual feedback in response to detecting that the hand of the user is performing a pre-pinch gesture to indicate that a virtual object will be selected when a selection input is performed with an input element minimizes input errors associated with unintended selection of a virtual object, thereby conserving computing resources associated with correcting the input errors.

In some embodiments, the selection input directed to the first virtual object is an air pinch gesture performed with the portion of the hand of the user, such as the hand 714 performing an air pinch in FIG. 7I. In some embodiments, and in accordance with the input element being a portion of the hand of the user (described above), the selection gesture that is detected by the computer system is an air pinch of the fingers of the hand of the user. In some embodiments, the computer system detects an air pinch when one or more fingers are determined to have come into contact and/or are within some threshold distance (e.g., 0.001, 0.01, 0.1, or 1 cm) apart from one another. Determining a selection input has been performed in accordance with a determination that a hand of the user has performed a pinch minimizes errors associated with detecting false positives (e.g., detecting a selection input when no selection input was actually performed), thereby conserving computer resources associated with correcting false positive selection inputs.

In some embodiments, the visual feedback indicates a location of a center of the pre-selection state in the three-dimensional environment, such as the location of simulated glow 720 corresponding to the location of hand 714 in FIG. 7E. In some embodiments, a center of the displayed visual feedback is based on the location within the three-dimensional environment where the computer system determines that the center of the pre-selection state is located thus providing a visual indicator to the user of the approximate location where the first virtual object will be grabbed in response to a selection input. The grabbing behavior associated with the selection input shares one or more characteristics with the grabbing behavior described with respect to methods 900, 1000, 1100, 1200, and/or 1300. In some embodiments, the center of the pre-selection state of the input element is dependent on the shape of the pre-selection state (e.g., the shape of the hand that forms the pre-selection input). In some embodiments, if the computer system detects that the center of the pre-selection state of the input has moved, the computer system shifts the location of the display of the visual feedback accordingly. In some embodiments, the location of the display of the visual feedback is displayed by the computer system as a projection onto the surface of the first virtual object that emanates from the center of the pre-selection pose of the input element (e.g., a light beam or other simulated emitted light that emanates from the center of the pre-selection pose of the input element and is projected onto the surface of the first virtual object). In some embodiments, the center of the pre-selection state refers to a location on the input element where the movement of the first virtual object will be anchored to once the selection input is detected as having been completed in accordance with the examples described with respect to methods 900, 1000, 1100, 1200, and/or 1300. Displaying the visual feedback based on the location of the center of a pre-selection state minimizes input errors associated with unintended selection of a virtual object and minimizes errors associated with grabbing a virtual object at an erroneous location on the first virtual object, thereby conserving computer resources associated with correcting false positive selection inputs.

In some embodiments, the pre-selection state of the input element is a pre-selection pose associated with a hand grab gesture (e.g., a three, four, or five finger grab gesture), and the center of the pre-selection state of the input element corresponds to a center of a palm of a hand of the user performing the hand grab gesture, such as if in FIG. 7I, hand 714 performed a hand grab gesture with the center of the hand grab gesture located at the palm of hand 714. In some embodiments, a hand grab gesture refers to a gesture in which a plurality of the fingers of the hand are directed towards the first virtual object in a shape and motion that is similar to a hand grabbing a real-world object in a physical environment. In some embodiments, a pre-selection pose associated with the hand grab gesture refers to a pose of the hand that is associated with the five finger grab gesture prior to detecting that the five fingers of the hand have come together and are touching. In some embodiments, in response to detecting the hand of the user engaging in a hand grab, the computer system displays the visual feedback at a location that is based on the approximate location of the center of the palm of the hand of the user within the three-dimensional environment. Thus, in some embodiments, the computer system shifts the location in the three-dimensional environment at which the visual feedback is displayed based on movement of the palm of the hand of the user. Displaying the visual feedback based on the location of the center of a pre-selection state minimizes input errors associated with unintended selection of a virtual object and minimizes errors associated with grabbing a virtual object at an erroneous location on the first virtual object, thereby conserving computer resources associated with correcting false positive selection inputs.

In some embodiments, the pre-selection state of the input element is a pre-selection pose associated with a two-finger pinch, and the center of the pre-selection state of the input element corresponds to a center position between a first finger and a second finger of a hand of the user performing the two-finger pinch, such as the center of input 732 being location between the two fingers performing the two-finger pinch in FIG. 7I. In some embodiments, a two finger pinch refers to a gesture in which two fingers of the hand are directed towards the first virtual object in a shape and motion that is similar to a hand pinching a real-world object in a physical environment. In some embodiments, a pre-selection pose associated with the two-finger pinch refers to a pose of the hand that is associated with the two-finger pinch gesture prior to detecting that the two fingers of the hand have come together and are touching. In some embodiments, in response to detecting the hand of the user engaging in a two finger pinch, the computer system displays the visual feedback at a location that is based on the approximate location of the center of the two fingers (e.g., the center between the end of the first finger and the end of the second finger) within the three-dimensional environment. The center of the two-fingers is optionally where the computer system estimates the fingers will come together and touch each other when the two-finger pinch (e.g., air pinch) occurs. Thus, in some embodiments, the computer system shifts the location in the three-dimensional environment that the visual feedback is displayed based on movement of the center of the two fingers of the user forming the two finger pinch. Displaying the visual feedback based on the location of the center of a pre-selection state minimizes input errors associated with unintended selection of a virtual object and minimizes errors associated with grabbing a virtual object at an erroneous location on the first virtual object, thereby conserving computer resources associated with correcting false positive selection inputs.

In some embodiments, prior to detecting, via the one or more input devices, that the input element satisfies the one or more criteria, including the criterion that is satisfied when the input element is within the threshold distance of the first virtual object, the computer system displays the first virtual object without displaying the visual feedback, such as simulated glow 720 not being displayed because hand 714 is not within a threshold distance of virtual object 704 in FIG. 7B. In some embodiments, the visual feedback is displayed only when the computer system detects that the input element (e.g., the hand of the user) is within a selection region (e.g., within the threshold distance) of the virtual object described with respect to method 1100. Alternatively, the threshold distance is separate from the grabbing region described with respect to method 1100. In some embodiments, the threshold distance (e.g., 0.01, 0.1, 1, or 10 cm) is set to a distance that is associated with the hand engaging in a grabbing gesture to grab a virtual object. In some embodiments, the visual feedback is initially not displayed when the input element is beyond the threshold distance from the first virtual object (e.g., outside the selection region for the first virtual object). Displaying the visual feedback based on the location input element being within a threshold distance minimizes input errors associated with unintended selection of a virtual object and minimizes errors associated with grabbing a virtual object at an erroneous location on the virtual object, thereby conserving computer resources associated with correcting false positive selection inputs.

In some embodiments, while displaying the visual feedback indicating the location of the input element relative to the first virtual object in the three-dimensional environment, the computer system detects movement of the input element to a location further than the threshold distance from the first virtual object, such as if prior to the location of hand 714 in FIG. 7B, hand 714 was located within the threshold distance of virtual object 704 such as the location of hand 714 in FIG. 7E.

In some embodiments, in response to detecting the movement of the input element to the location further than the threshold distance from the first virtual object, the computer system ceases display of the visual feedback, such as if simulated glow 720 in FIG. 7E was no longer displayed in response to hand 714 no longer being within the threshold distance of virtual object 704. In some embodiments, if the computer system detects that the input element moves from being within the threshold distance of the first virtual object (e.g., within the selection region), to a location that is outside of the threshold distance, the computer system ceases displaying the visual feedback. In some embodiments, detecting that the input element is outside the threshold distance from the first virtual object indicates that the input element (e.g., the hand) is no longer imminently going to select the first virtual object and thus the computer system ceases display of the visual feedback. In some embodiments, if the computer system detects that the input element performs a selection input while it is outside the threshold distance from the first virtual object, the computer system forgoes selecting the first virtual object. In some embodiments, if the computer system detects that the input element is within the threshold distance of the first virtual object after having determined that the input element was outside of the threshold distance, the computer system redisplays the visual feedback. In some embodiments, ceasing display of the visual feedback is performed independently of whether the input element is in the pre-selection state (described herein). Thus, even if the input element is in the pre-selection state, in response to detecting that the input element has moved to a location further than the threshold distance, the computer system ceases display of the visual feedback. Ceasing display of the visual feedback based on the location input element being outside a threshold distance minimizes input errors associated with attempting to select a virtual object when the input element is outside of the threshold distance (and thus is not able to select the first virtual object) and minimizes errors associated with grabbing a virtual object at an erroneous location on the first virtual object, thereby conserving computer resources associated with correcting false positive selection inputs.

In some embodiments, the visual feedback includes a simulated glowing effect, such as simulated glow 720 in FIG. 7E. In some embodiments, a simulated glowing effect refers to displaying a region of the three-dimensional environment that corresponds to the visual feedback with one or more visual characteristics (e.g., luminosity, opacity, color, and/or brightness) that gives the region a glowing appearance (e.g., an appearance of simulated light emanating from the region). In some embodiments, the entirety of the region or a portion of the region associated with the visual feedback is displayed with the glowing effect. In one or more embodiments, an intensity of the glowing effect varies based on the proximity of the input element to the virtual object. For instance, if the input element is detected as being in close proximity to the virtual object versus being detected as being further out (but still within the threshold distance), the glowing effect is displayed with a higher intensity. In some embodiments, the intensity is varied by increasing or decreasing one or more of the visual characteristics associated with the glowing effect (e.g., increasing or decreasing the brightness of the region associated with the visual feedback and the glowing effect and/or increasing or decreasing the size of the region associated with the visual feedback and glowing effect). In some embodiments, the size of the simulated glowing effect is based on the distance of the input element from the virtual object. Displaying the visual feedback with a glowing effect minimizes input errors associated with inadvertent selection of the virtual object and minimizes errors associated with grabbing a virtual object at an erroneous location on the virtual object, thereby conserving computer resources associated with correcting false positive selection inputs.

In some embodiments, displaying the visual feedback includes displaying the simulated glowing effect on the first virtual object, such as simulated glow 720 being displayed on virtual object 704 in FIG. 7E. In some embodiments, the visual feedback is displayed on a surface of the first virtual object such that the simulated glowing effect is displayed as if the light emanating from the glowing effect is emanating from the first virtual object itself (e.g., the portion of the first virtual object that the visual feedback is displayed on). In some embodiments, the visual characteristics (e.g., radiance, brightness, or opacity) of the first virtual object at the portion of the visual feedback is displayed on are modified to cause the glowing effect to be displayed on the first virtual object. In some embodiments, if the computer system detects that the input element has moved such that the location the first virtual object on which the simulated glowing effect is displayed is to be modified, the computer system restores the portion of the first virtual object that is to be displayed without the visual feedback to the original visual characteristics of the first virtual object, and modifies alternative portions of the first virtual object corresponding to the visual feedback on the first virtual object. Displaying the visual feedback with a glowing effect on the virtual object minimizes input errors associated with inadvertent selection of the first virtual object and minimizes errors associated with grabbing a first virtual object at an erroneous location on the first virtual object, thereby conserving computer resources associated with correcting false positive selection inputs.

In some embodiments, displaying the visual feedback includes displaying the visual feedback as if projected on a surface of the first virtual object, such as simulated glow 720 being displayed on the surface of virtual object 704 in FIG. 7E. In some embodiments, the visual feedback is projected on the surface of the first virtual object as if was being projected from the input element (e.g., a simulated light that emanates from the input element and is projected onto the surface of the first virtual object). In some embodiments, the visual feedback is displayed on the surface of the first virtual object such that one or more portions of the surface of the first virtual object are displayed with visual characteristics that are associated with the visual feedback (e.g., brightness, opacity, and/or feathering). In some embodiments, if the computer system detects that the input element has moved such that the location the first virtual object on which visual feedback is displayed is to be modified, the computer system restores the portion of the first virtual object that is to be displayed without the visual feedback to the original visual characteristics of the first virtual object, and modifies alternative portions of the first virtual object corresponding to the visual feedback on the virtual object. Displaying the visual feedback on a surface of the first virtual object minimizes input errors associated with inadvertent selection of the first virtual object and minimizes errors associated with grabbing a first virtual object at an erroneous location on the first virtual object, thereby conserving computer resources associated with correcting false positive selection inputs.

In some embodiments, the one or more criteria include a criterion that is satisfied when the input element is within a selection region associated with the first virtual object, such as hand 714 being within selection region 710 in FIG. 7E. In some embodiments, the selection region refers to a region that surrounds the first virtual object such that if a selection input is detected as occurring within the selection region, the input element will select the object, and if the selection input is detected as occurring outside the selection region, the first virtual object will not be selected. In some embodiments, the selection region (e.g., grabbing area) shares one or more characteristics with the selection region/grabbing area described with respect to method 1200. In some embodiments, the selection region is associated with the hand engaging in a grabbing gesture to grab a virtual object. In some embodiments, the visual feedback is initially not displayed when the input element is beyond the selection region (e.g., outside the selection region). In some embodiments, the threshold distance that determines whether to display the visual feedback corresponds to the outer bounds of the selection region. In some embodiments, the selection region associated with the virtual object is a three-dimensional volume (e.g., within the three-dimensional environment). Displaying the visual feedback based on the location input element being within a selection area associated with the first virtual object minimizes input errors associated with unintended selection of a first virtual object and minimizes errors associated with grabbing a virtual object at an erroneous location on the first virtual object, thereby conserving computer resources associated with correcting false positive selection inputs.

In some embodiments, in accordance with a determination that the input element is a first distance from the first virtual object, the computer system displays the visual feedback with a first set of one or more values for a first set of one or more visual characteristics, such as displaying simulated glow 720 with a first size in FIG. 7E based on the distance of hand 714 from virtual object 704.

In some embodiments, in accordance with a determination that the input element is a second distance from the first virtual object, different from the first distance, the computer system displays the visual feedback with a second set of one or more values, different from the first set of one or more values, for the first set of one or more visual characteristics, such as the size of simulated glow 720 increasing in FIG. 7F in response to hand 714 moving closer to virtual object 704. In some embodiments, the visual feedback includes one or more visual characteristics (e.g., size, shape, brightness, brightness, opacity, and/or feathering). In some embodiments, the intensity and/or parameters (e.g., values) associated with the visual characteristics are modified (e.g., the one or more values) based on a determination of the determined distance between the input element and the first virtual object. For instance, the brightness and size of the visual feedback optionally increase as the distance between the input element and the first virtual object decreases, and optionally decrease as the distance between the first virtual object and the input element increases. In some embodiments, certain visual characteristics increase as the distance between the first virtual object and the input element decreases, and decrease as distance between the virtual object and the input increases. For instance, the size of the visual feedback optionally increases when the input element moves away from the first virtual object and decreases when the input element moves closer to the first virtual object. Changing the appearance of the visual feedback based on the distance between the input element and the virtual object minimizes input errors associated with unintended selection of a virtual object and minimizes errors associated with grabbing a virtual object at an erroneous location on the virtual object, thereby conserving computer resources associated with correcting false positive selection inputs.

In some embodiments, moving the visual feedback relative to the first virtual object in accordance with the movement of the input element without moving the first virtual object in the three-dimensional environment comprises, in accordance with detecting the input element at a first input location in the three-dimensional environment, displaying the visual feedback at a first feedback location in the three-dimensional environment, wherein the first feedback location corresponds to the first input location of the input element, such as the location of simulated glow 720 corresponding to the location of hand 714 in FIG. 7G. In some embodiments, displaying the visual feedback at a first feedback location in the three-dimensional environment refers to a location in the three-dimensional environment where a center of the visual feedback is displayed. In some embodiments the location where the visual feedback is displayed is based on the location of the input element within the three-dimensional environment. For instance, in the example where the input element is a hand of user, when the hand satisfies the one or more criteria (e.g., is within the threshold distance of the first virtual object), the computer system determines the location of the hand (e.g., an input center associated with the hand) and displays the visual feedback based on the determination of the location of the hand. In some embodiments, the relationship between the location of the input element and the visual feedback (e.g., the first feedback location) is configured to make it appear as though the input element is casting a shadow on the first virtual object.

In some embodiments, moving the visual feedback relative to the first virtual object in accordance with the movement of the input element without moving the first virtual object in the three-dimensional environment comprises, in accordance with detecting movement of the input element to a second input location, different from the first input location in the three-dimensional environment, displaying the visual feedback at a second feedback location in the three-dimensional environment, different from the first feedback location in the three-dimensional environment, wherein the second feedback location corresponds to the second input location of the input element, such as the location of simulated glow 720 moving from the location in FIG. 7G to the location in FIG. 7H in response to movement of hand 714. In some embodiments, the computer system moves the location of the visual feedback in accordance with detected movement of the input element. For instance, if the computer system detects that the input element moves while displaying the visual feedback, and the computer system detects that the input element continues to satisfy the one or more criteria (e.g., that the input element stays within the threshold distance from the first virtual object) the computer system will move the visual feedback in accordance with movement of the input element. In some embodiments, the computer system will continue to move the visual feedback in accordance with the input element until the computer system detects that the input element no longer satisfies the one or criteria at which time the computer system will cease displaying the visual feedback, for instance because the input element is detected as having moved outside of the threshold distance. Changing the location the visual feedback based on the determined location of the input element minimizes input errors associated with unintended selection of a virtual object and minimizes errors associated with grabbing a virtual object at an erroneous location on the virtual object, thereby conserving computer resources associated with correcting false positive selection inputs.

In some embodiments, the input element performed the selection input directed to the first virtual object prior to the movement of the input element. In some embodiments, in response to detecting the selection input directed to the first virtual object, the computer system presents, via one or more output devices, audio feedback corresponding to the selection input, such as if an audio feedback was presented by computer system 101 in response to detecting hand 714 performing selection input 732 in FIG. 7I. In some embodiments, the audio feedback includes one or more audio characteristics (e.g., tone, volume, bass, treble, and/or reverb) that distinguishes the audio feedback from other audio that is output by the computer system. In some embodiments, the audio feedback is output in response to detecting the selection input and is configured to provide the user with an indication that the first virtual object has been selected and is now being controlled by the input element (e.g., movement of the input element will cause the first virtual object to move accordingly). In some embodiments, the one or more output devices include audio speakers that are part of and/or are communicatively coupled to the computer system. Providing audio feedback when a virtual object is selected minimizes input errors associated with unintended movement of the virtual object based on movement of the input element when the virtual object is selected, thereby conserving computer resources associated with correcting false positive selection inputs.

In some embodiments, the input element performed the selection input directed to the first virtual object prior to the movement of the input element, such as hand 714 performing selection input 732 in FIG. 7I. In some embodiments in response to detecting the selection input directed to the first virtual object, the computer system displays, via the one or more display generation components, visual feedback, separate from the visual representation of the input element, indicating selection of the first virtual object, such as displaying simulated glow 720 in FIG. 7I. In some embodiments, the selection visual feedback includes one or more visual characteristics (e.g., brightness, color, opacity, and/or shape) that visually distinguish the selection visual feedback from the visual feedback associated with the input element being in a pre-selection state. In some embodiments, the selection visual feedback is displayed at a location that is different from the location at which the visual feedback associated with the pre-selection state is displayed. In some embodiments, the selection visual feedback is displayed in proximity to the first virtual object that has been selected by the selection input thereby providing an indication of which virtual object has been selected by the selection input. Providing a selection visual feedback when a virtual object is selected minimizes input errors associated with unintended movement of the virtual object based on movement of the input element when the virtual object is selected, thereby conserving computer resources associated with correcting false positive selection inputs.

In some embodiments displaying the visual feedback, separate from the visual representation of the input element, indicating the selection of the first virtual object includes ceasing display of the visual feedback indicating the location of the input element relative to the first virtual object in the three-dimensional environment, such as both simulated glow 720 and simulated glow pulse 720b ceasing to be displayed in FIG. 7I when hand 714 is controlling movement of virtual object 704. In some embodiments, the selection visual feedback is displayed temporarily (e.g., the selection visual feedback appears when the selection input is detected but then disappears after a predefined amount of time). In some embodiments, the predefined amount of time (e.g., 0.1, 0.5. 1, 3, 5, and/or 10 seconds) is configured to provide the user enough time to determine that the first virtual object has been selected due to a selection input. Providing a selection visual feedback that eventually ceases to be displayed when a virtual object is selected minimizes input errors associated with unintended movement of the virtual object based on movement of the input element when the virtual object is selected, thereby conserving computer resources associated with correcting false positive selection inputs.

In some embodiments, ceasing display of the visual feedback indicating the location of the input element relative to the first virtual object in the three-dimensional environment comprises displaying an animation associated with the visual feedback indicating the location of the input element relative to the first virtual object in the three-dimensional environment, such as simulated glow pulse 720b in FIG. 7I. In some embodiments, when the computer system initiates ceasing display of the visual feedback, the computer system displays an animation sequence that ends with the visual feedback no longer being displayed. For instance, the computer system displays the visual feedback as expanding outward while simultaneously fading out the feedback so that when the animation sequence is terminated the visual feedback is no longer displayed. In some embodiments, and in the example where the visual feedback is displayed on a surface of the first virtual object, the animation sequence begins with the visual feedback being displayed only on a portion of the surface of the first virtual object. The animation sequence optionally includes the visual feedback expanding over time (e.g., such that it eventually covers a greater amount of the surface of the first virtual object before the visual feedback is modified to no longer be visible in the three-dimensional environment). Providing a selection visual feedback that eventually ceases to be displayed when a virtual object is selected minimizes input errors associated with unintended movement of the virtual object based on movement of the input element when the virtual object is selected, thereby conserving computer resources associated with correcting false positive selection inputs.

In some embodiments, prior to detecting the input element performing the selection input directed to the first virtual object, the visual representation of the input element has a first degree of visual prominence relative to the first virtual object, such as the visual prominence of hand 714 in FIG. 7AJ.

In some embodiments, while the input element is performing the selection input directed to the first virtual object, the visual representation of the input element has a second degree of visual prominence, different from the first degree of visual prominence, relative to the first virtual object, such as the visual prominence of hand 714 in FIG. 7AK. In some embodiments, the first degree and the second degree of visual prominence share one or more characteristics with the display rules (e.g., visual prominence rules) of the input element before and after performing a selection input described with respect to methods 1000 and 1100. In some embodiments, the first degree of prominence includes controlling the visibility of the input element to ensure that the hand of the user is visible in the three-dimensional environment based on the location of the hands with respect to the first virtual object in the three-dimensional environment. For instance, when the position of the hand of the user is between the first virtual object and the current viewpoint, to ensure that the hands are visible, the computer system reduces the visual prominence of the first virtual object (or some portion thereof) corresponding to the location of the hands, such that the hands are visible to the user of the computer system (e.g., from the current viewpoint of the user). In some embodiments, the first degree of visual prominence is displayed when the input element has not been detected as having performed a selection input directed to the first virtual object, and thus is not being controlled by the input element (e.g., the hand of the user). In some embodiments, the computer system, transitions from the first degree of visual prominence to the second degree of visual prominence by changing one or more visual characteristics associated with the first degree of visual prominence (e.g., brightness, contrast, color saturation, opacity, and/or feathering). In some embodiments, the second degree of visual prominence is less than the first degree of visual prominence. In some embodiments, the input element is displayed with the second degree of visual prominence by the computer system when the computer system detects that the input element is further away from viewpoint of the user than the first virtual object. In some embodiments, if the computer system detects that the input element is closer to the viewpoint of the user than the first virtual object, the computer system forgoes displaying the input element with the second degree of visual prominence. In some embodiments, when the input element is displayed with the second degree of visual prominence, the computer system displays only the portion of the input element that is further away from the viewpoint of the user, and is behind the first virtual object (e.g., the portion of the input element that is visually obscured by the first virtual object). Providing a selection visual feedback that includes changing the visual prominence of the input element when the input element is detected as performing a selection input minimizes input errors associated with unintended movement of the first virtual object based on movement of the input element when the first virtual object is selected, thereby conserving computer resources associated with correcting false positive selection inputs.

In some embodiments, when the visual representation of the input element has the first degree of visual prominence, the visual representation of the input element has a first degree of opacity, and when the visual representation of the input element has the second degree of visual prominence, the visual representation of the input element has a second degree of opacity, less than the first degree of opacity, such as the change of the opacity of hand 714 from FIG. 7AJ to FIG. 7AK. In some embodiments, transitioning from the first degree of visual prominence to the second degree of visual prominence includes reducing the opacity of the representation of the input element (or optionally a portion thereof) such that the input element is at least minimally transparent such that objects (such as the first virtual object) that spatially overlap with the input element are visible in addition to the input element being visible as well. In some embodiments, decreasing the opacity of the representation of the input element shares one or more characteristics with the display rules and decreasing the opacity of the representation of the input element described with respect to method 1200. Providing visual feedback corresponding to selection that includes changing the visual prominence of the input element by changing the opacity of the representation of the input element when the input element is detected as performing a selection input minimizes input errors associated with unintended movement of the first virtual object based on movement of the input element when the first virtual object is selected, thereby conserving computer resources associated with correcting false positive selection inputs.

In some embodiments, in accordance with a determination that a portion of the first virtual object is closer to a viewpoint of the user than a portion of the input element when the first virtual object has the second degree of visual prominence, the computer system displays the portion of the first virtual object such that the portion of the first input element is visually obscured by the portion of the first virtual object from the viewpoint of the user, such as virtual object 708 obscuring hand 714 in FIG. 7AK. In some embodiments, when the visual representation of the input element is displayed with the second degree of visual prominence, the representation is displayed according to depth sorting rules wherein when the computer system detects that the first virtual object and the portion of the hand of the user are in spatial conflict (e.g., occupy the same area in the three-dimensional environment from the viewpoint of the user), the computer system displays whichever of the input element and the first virtual object are closer to the viewpoint of the user, while obscuring the other. For instance, in the example of the hand of user as the input element, while the first virtual object is subject to the control of the hand of the user, if the computer system detects that the hand is behind the first virtual object while it has grabbed the object (from the viewpoint of the user), the computer system displays the first virtual object while obscuring the hand of the user (e.g., not displaying the hand of the). In some embodiments, if the computer system detects that the hand of the user ceases controlling the virtual, the computer system reverts to displaying the hand with the first degree of visual prominence such that the computer system would display the hand of the user even if spatially the hand is behind the first virtual object. In some embodiments, the depth sorting rules share one or more characteristics with the depth sorting rules described with respect to method 1100. In some embodiments, if the computer system detects that the hand of the user ceases controlling the virtual or otherwise within the selection region associated with the first virtual object, the computer system reverts to displaying the hand with the first degree of visual prominence such that the computer system would display the hand of the user even if spatially the hand is behind the first virtual object. Providing a selection visual feedback that includes using depth sorting to decide which of the input element or the virtual to display when the one is behind the other from the perspective of the user, minimizes input errors associated with unintended movement of the first virtual object based on movement of the input element when the first virtual object is selected, thereby conserving computer resources associated with correcting false positive selection inputs.

In some embodiments, in accordance with a determination that the portion of the first virtual object is further away from the viewpoint of the user than the portion of the input element when the first virtual object has the second degree of visual prominence, the computer system presents a representation of the portion of the first input element such that the portion of the first virtual object is visually obscured by the representation of the portion of the first input element from the viewpoint of the user, such as virtual object 708 being obscured by hand 714 in FIG. 7AN. In some embodiments, displaying the first virtual object and the input element according to depth sorting rules includes displaying the input element and obscuring the first virtual object when the object is further from the viewpoint of the user than the input element. In some embodiments, presenting the representation of the portion of the first input element refers to either actively displaying a representation or otherwise making visible the first input element. In some embodiments, the representation of the portion of the first input element is actively displayed by the computer system, or is passively visible via the one or more display generation components of the computer system. Providing a selection visual feedback that includes using depth sorting to decide which of the input element or the virtual to display when the one is behind the other from the perspective of the user, minimizes input errors associated with unintended movement of the first virtual object based on movement of the input element when the first virtual object is selected, thereby conserving computer resources associated with correcting false positive selection inputs.

In some embodiments, while the input element is performing the selection input directed to the first virtual object, such as hand 744 performing an air pinch gesture in, the computer system in FIG. 7AN detects, via the one or more input devices, that a different input element satisfies one or more second criteria, including a criterion that is satisfied when the different input element is within a threshold distance of the first virtual object, such as hand 744 being within a threshold distance of virtual object 708 in FIG. 7AN. In some embodiments, the one or more second criteria share one or more characteristics of one or more criteria described herein.

In some embodiments, in response to detecting that the different input element satisfies the one or more second criteria, the computer system displays, via the one or more display generation components, visual feedback associated with the different input element separate from a visual representation of the different input element, wherein the visual feedback associated with the different input element indicates a location of the different input element relative to the first virtual object in the three-dimensional environment, such as simulated glow 720 in FIG. 7AN. In some embodiments, and while a first input element is controlling the first virtual object (e.g., the first input element has selected the first virtual object and is controlling the movement of the first virtual object), the computer system transfers control of the first virtual object from the first input element to the second input element when certain criteria are met as described with respect to method 1100. In some embodiments, and while the first input element controls the first virtual object, if the computer system detects that a second input element (e.g., the other hand of the user) satisfies the one or second criteria for displaying the visual feedback of a pre-selection state of the different input element, the computer displays visual feedback associated with the second input element that shares one or more characteristics with the visual feedback associated with the input element described herein. In some embodiments, the threshold distance used with the different input element is the same and/or optionally different than the threshold distance used to with respect to the input element. Displaying visual feedback to indicate that a virtual object will be selected when a selection input is performed with a second input element while being controlled with a first input element minimizes input errors associated with unintended selection of a virtual object, thereby conserving computing resources associated with correcting the input errors.

In some embodiments, prior to detecting the movement of the input element relative to the first location in the three-dimensional environment, the computer system detects a respective input with the input element (e.g., as described with reference to method 1600). In some embodiments, in response to detecting the respective input with the input element, in accordance with a determination that the respective input included a selection input directed to the first virtual object, the computer system outputs, via one or more output devices (e.g., one or more speakers, earbuds, and/or headphones) that are in communication with the computer system, respective audio feedback corresponding to the selection input, such as audio feedback including audio output 1520 as shown in FIG. 15A.

In some embodiments, in response to detecting the respective input with the input element, in accordance with a determination that the respective input did not include a selection input directed to the first virtual object, the computer system forgoes outputting, via one or more output devices (e.g., one or more speakers, earbuds, and/or headphones) that are in communication with the computer system, the respective audio feedback corresponding to the selection input (e.g., not outputting audio corresponding to the respective input or outputting different audio feedback corresponding to the respective input that is different from the respective audio feedback that indicates the selection input), such as if computer system 101 were to forgo generating of audio output 1520 as shown in FIG. 15A.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIG. 9 is a flowchart illustrating method 900 of gradually transitioning a manipulation point of a virtual object to an input element in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a computer system in communication with one or more input devices and one or more display generation components. In some embodiments, the computer system, one or more input devices, and/or one or more display generation components have one or more characteristics similar to or the same as described with reference to methods 800, 1000, 1100, 1200, and/or 1300. In some embodiments, while displaying, via the one or more display generation components, a virtual object within a three-dimensional environment, the computer system detects (902), via the one or more input devices, a first input provided by an input element, (e.g., a hand or controller that is optionally associated with a user of the computer system), such as hand 714 performing an air pinch gesture to select virtual object 704 in FIG. 7I. In some embodiments, a center of movement associated with the virtual object and an input center associated with the input element are separated by a first distance when a first portion of the first input is detected (e.g., when the input starts such as with a selection input like a pinch in an air pinch and drag gesture, touchdown for a touch and drag input, or a button press for a controller select and drag input), such as the distance between input 732 and virtual object 704 in FIG. 7K In some embodiments, as described further herein, the computer system detects one or more inputs such as one or more air gestures selecting and/or initiating movement of a virtual object. For example, the computer system optionally detects an air pinch gesture including contacting of fingers of one or more hands of a user (e.g., one or more input elements associated with the user), an air pointing gesture including directing of one or more fingers toward the virtual object, and/or an air swiping including movement of one or more fingers in similar and/or same directions, generally directed toward the virtual object. In some embodiments, the one or more inputs include pointing, movement, selection of button(s), contacts with non-touch sensitive surface(s) and/or touch-sensitive surface(s), movement of such contacts, movement of a joystick, and/or some combination thereof directed to a controller and indicated to the computer system by the controller or detected by sensors included in the computer system. For example, the controller and/or computer system optionally detect and/or receive an indication of pressing of a button and/or a movement of a joystick included in the controller. Additionally or alternatively, the controller is optionally a motion controller, and optionally detects pointing and/or movement of the controller relative to a position in the three-dimensional environment corresponding to the simulated position where the virtual object is displayed. In some embodiments, concurrent or in succession with detecting one or more of such inputs, the computer system detects gaze directed to the virtual object and initiates performance of one or more operations that are forgone when the computer system does not detect gaze directed to the virtual object. It is understood that the first input, and additional or alternative inputs described herein optionally have one or more characteristics of input(s) described with reference to the present method, and/or described with reference to methods 800, 1000, 1100, 1200, and/or 1300. As referred to herein, the input center of the input element is optionally a location in the three-dimensional environment that the computer system optionally uses to determine the direction and/or magnitude of movement of the input element. The input center optionally corresponds to a location of one or more body parts of a body of a user of the computer system. For example, the input center optionally corresponds to a location where a thumb and an index finger forming an air pinch gesture meet, a location of a center of a palm of the user's hand, a location extended away from the user's body originating from such locations, and/or the location of one or more knuckles of the user's hand. Additionally or alternatively, the input center corresponds to a position of a portion of a housing of a controller, such as a tip of a first end of an oblong controller, a center of the controller, a calculated position relative to the housing such as a point in the three-dimensional environment offset from the housing of the controller, centered between transmitters included in the controller, and the like. It is understood that some embodiments are described with reference to input(s) provided by a hand of the user, and that aspects of such embodiments optionally apply to embodiments in which the controller provides the input(s) to interact with virtual objects. As described further herein, in some embodiments, the computer system performs one or more pickup smoothing operations. Pickup smoothing operations optionally include operations that define the manner in which a virtual object moves in response to initially being selected and/or moved (e.g., in response to and/or in accordance with one or more air gestures, voice commands, and/or inputs detected via a hardware peripheral). In some embodiments, the computer system displays a virtual object at a location within a three-dimensional environment, as described further with reference to methods 800, 1000, 1100, 1200, and/or 1300. In some embodiments, the three-dimensional environment has one or more characteristics similar to or the same as described with reference to with reference to methods 800, 1000, 1100, 1200, and/or 1300. In some embodiments, the virtual object has one or more characteristics of virtual objects described with reference to methods 800, 1000, 1100, 1200, and/or 1300. For example, the virtual object optionally is or optionally includes a user interface for an application stored in memory of the computer system, such as a two-dimensional window that includes an interaction surface that includes the user interface. It is understood that the virtual object is additionally or alternatively a three-dimensional virtual object, as described with reference to the virtual octopus, chess piece, and/or unicorn herein. Virtual objects are optionally displayed via the one or more display generation components, but optionally are not physical, tactile objects in the physical environment included in the three-dimensional environment of the user of the computer system. For example, the computer system optionally displays a virtual chess piece, octopus, die, toy unicorn and/or some combination thereof within an extended reality (XR) environment that the user's hand is unable to grasp or touch. In some embodiments, the first input includes one or more inputs requesting movement of the virtual object relative to the three-dimensional environment. For example, the first input includes movement of an input element, such as moving of one or more hands and/or fingers of the user that are optionally assuming an air pose and/or air gesture. In response to detecting the first input, and when one or more criteria are satisfied (e.g., when the air pinch gesture is within a threshold distance of the location and/or of the virtual object, as described with reference to at least method 1200, and/or when the air pinch gesture moves a distance greater than a threshold distance relative to the center of movement (e.g., 0.005, 0.01, 0.025, 0.05, 0.07, 0.1, 0.15, 0.25, 0.5, 1, 2.5, or 5 cm)), the computer system optionally moves the virtual object in accordance with the first input, as described further herein. In some embodiments, the first portion of the movement of the input element corresponds to movement of one or more fingers of the hand of the user (e.g., in an air pinch gesture), optionally without detecting movement of the hand of the user. In some embodiments, when the first input is detected (e.g., the first portion of the first input), the computer system determines and/or obtains an indication of a separation between the input center corresponding to the input element and a “center of movement” of the virtual object. As referred to herein, the center of movement of a virtual object is optionally a location in a three-dimensional environment that defines simulated movement of the virtual object. As an example, the movement center is optionally a handle and/or pivot point for the virtual object. As described with reference to method 1200, the computer system optionally uses the center of movement as a reference point for determining translation and/or rotation of the virtual object in response to detecting one or more inputs provided by the input element. In some embodiments, the center of movement is defined for one or more moveable virtual objects in a three-dimensional environment. In some embodiments, a respective virtual object is associated with a plurality of centers of movement and/or is associated with a region of the three-dimensional environment associated with moving the respective virtual object, as described with reference to method 1200. In some embodiments, the center of movement of the virtual object is not displayed. For example, the computer system optionally defines a first center of movement of a virtual octopus located along an axis centered with and passing through a top of a head of the virtual octopus. Additionally or alternatively, the computer system optionally defines a second center of movement along the same axis, some distance below the tentacles of the virtual octopus, and one or more movement additional centers of movement arranged radially along a circle that is normal to and centered on the axis. The indication of such centers of movement optionally is obtained from software applications that are used to generate and/or provide the first virtual object. In some embodiments, the three-dimensional environment is a physical environment, a virtual environment (VR), an augmented reality (AR) environment, and/or an extended reality (XR) environment that is visible and/or displayed via the display generation of the computer system. It is understood that such three-dimensional environment(s) optionally have one or more characteristics that are similar to, or the same as described with reference to methods 800, 1000, 1100, 1200, and/or 1300.

In some embodiments, while (e.g., and/or in response to) detecting, via the one or more input devices, a second portion of the first input, after the first portion of the first input, that includes movement of the input element, such as movement of hand 714 in FIGS. 7K-7O (e.g., a drag input that occurs after an air pinch and while the air pinch is still being held or before de-pinch has been detected (e.g., while contact between fingers forming the air pinch are maintained), a drag input that occurs after a button press and while the button is still being held or before button up has been detected, and/or a drag input that occurs on a touch-sensitive surface after touchdown and before liftoff has occurred or before liftoff has been detected), in accordance with a determination that the movement of the input element satisfies one or more first criteria, as the input center associated with the input element moves, the computer system moves (904) the virtual object relative to the input center associated with the input element in a manner that is selected (e.g., automatically by the computer system) so as to reduce a distance between the center of movement of the virtual object and the input center associated with the input element to less than the first distance such as computer system 101 moving virtual object 704 closer to center of movement 736-1 in response to movement of hand 714 while maintaining a selection input. In some embodiments, the computer system dynamically selects a movement direction and/or amount for the virtual object so as to reduce the distance between the center of movement of the virtual object and the input center associated with the input element even if the movement of the input element is in a different direction and/or changes in direction, which keeps the center of movement of the virtual object moving progressively toward the input center associated with the input element as the input progresses even if the input changes in direction or starts in a different direction. For example, the second portion of the first input optionally includes movement of a hand of the user in one or more directions that is included in a series of movements (e.g., and/or included in a single continuous movement that comprises the first and second portion of movement), such as movement of the hand while the hand is holding an air pinch gesture. Additionally or alternatively, the second portion of the first input optionally includes one or more movements of a joystick, a contact on a trackpad, and/or some combination thereof that request movement of the virtual object. In some embodiments, the virtual object translates within the three-dimensional environment relative to the center of movement when the one or more first criteria are satisfied, described further with reference to pick up smoothing operations and/or with reference to forgoing movement in response to a respective portion (e.g., an initial portion) of the first input. For example, in response to detecting a first movement including translation of an air pinch gesture, the computer system optionally translates the virtual object in one or more directions and by one or more magnitudes (e.g., distances, speeds, and/or magnitudes of acceleration) in the one or more directions that are similar to, based upon, or the same as one or more directions of movement of the input element by one or more magnitudes in the one or more directions. In response to detecting such one or more movements, the computer system optionally moves the input center in the one or more directions by one or more magnitudes based upon (e.g., relatively greater or lesser than) one or more magnitudes of the input element movement. In some embodiments, when the movement of the input satisfies the one or more first criteria, the computer system moves the virtual object and/or the center of movement of the virtual object toward the input center. In some embodiments, the reducing of the distance between the center of movement and/or the input center includes moving the virtual object such that the center of movement of the virtual object tracks the input center, such that the center of movement of the virtual object and the input center are at substantially the same location (e.g., at the same location or locations that are less than a threshold distance apart (e.g., 0, 0.05, 0.1, 0.5, 1, 2.5, or 5 cm)). In some embodiments, moving the virtual object relative to the input center includes reducing the distance between the center of movement of the virtual object and the input center to be less than the first distance, but greater than a minimum threshold distance (e.g., 0. 0.1, 0.2, 0.5. 1 cm). Thus, in response to detecting the first input including input element movement that satisfies the one or more first criteria, the computer system optionally moves the virtual object and/or the object center of movement toward the input center of the input element, which optionally includes reducing the distance between the center of movement and the input center. Moving the center of movement associated with the virtual object relative to the input center of the input element provides a gradual initiation of movement of the virtual object, thus reducing visual jitter that is displayed when virtual objects quickly move such that particular portions of the virtual object completely align and/or overlap with an input center of an air gesture.

In some embodiments, the input center associated with the input element corresponds to a location in the three-dimensional environment associated with a plurality of fingers forming an air gesture such as the input center of hand 732 in FIG. 7O.

In some embodiments, the computer system determines and/or defines input centers for a plurality of body parts (e.g., for a left hand and a right hand, different input centers for different air gestures (e.g., air pinches, air pointing including extending of a finger, air closing of one or more fingers), different input centers for different portions of a hand of the user's body)). In some embodiments, the location corresponding to the input center in the three-dimensional environment corresponds to the determined and/or detected position of one or more of the plurality of body parts. For example, the input center is optionally a location where an index finger and thumb contact to form an air pinch gesture, a distal end of a finger pointing in an air pointing gesture, and/or a center of a first formed by a hand of the user. In some embodiments, the input optionally corresponds to a location extended away from portion(s) of the user's body, such as fingers brought within a threshold distance (e.g., 0, 0.05, 0.1, 0.5, 1, 2.5, or 5 cm) but not contacting each other. Defining the input center as corresponding to a location related to an air gesture reduces the need for a controller peripheral that is required to dictate the input center location, thus reducing processing and/or system complexity required to interface with the controller peripheral.

In some embodiments, the center of movement corresponds to a virtual handle associated with moving the virtual object relative to the three-dimensional environment, such as if instead of moving to the input center of hand 714 (e.g., the point where the fingers of hand 714 come together to form the air pinch) in FIG. 7O, virtual object 704 is moved in accordance with movement of a virtual handle (e.g., that is optionally not displayed) that is being controlled by the input center 732 of hand 714. For example, the center of movement optionally corresponds to a virtual handle related to a virtual object. In some embodiments, the virtual handle optionally shares one or more characteristics of the handles described with reference to method 1200. In some embodiments, in response to input(s) moving the input center relative to the virtual object, the computer system causes movement of the virtual handle to correspond to the input center, and/or causes movement of the virtual handle. In some embodiments, the computer system moves the virtual object relative to the virtual handle as though a physical equivalent of the handle were physically coupled to a physical equivalent of the virtual object, such as when the input center location corresponds to the center of movement. In some embodiments, the virtual handle is not displayed. In other embodiments, the virtual handle is displayed. In some embodiments, the center of movement is determined relative to a location corresponding to the virtual handle. For example, the center of movement optionally corresponds to a center of an oblong handle that is spatially offset from and parallel to an edge of a virtual housing of a virtual laptop. In some embodiments, the virtual handle corresponds to something that is displayed, such as a displayed handle of a virtual toolbox. In some embodiments, the virtual handle has one or more characteristics of the selection region and/or movement center(s) described with reference to method 1200. In some embodiments, the center of movement relative to the virtual handle is an extremity of the virtual handle, such as an endpoint of the oblong portion of the handle. Using a virtual handle to define a center of movement for the virtual object mimics physical interactions with a physical handle, thereby reducing the user's cognitive load by leveraging the user's understanding of physical phenomena as a basis for interaction with virtual objects.

In some embodiments, the center of movement is associated with (e.g., is within) a selection region of the virtual object, for example selection region 710 of virtual object 704 in FIG. 7C. In some embodiments, the center of movement is included in a selection region associated with the virtual object. In some embodiments, the selection region and/or the center of movement has one or more characteristics similar to or the same as the selection region(s) and/or center(s) of movement described with reference to method 1200. In some embodiments, a spatial relationship between the center of movement and the corresponding virtual object are fixed, irrespective of movement of the virtual object relative to the three-dimensional environment. In some embodiments, in response to detecting inputs moving the virtual object, the computer system moves the virtual object (e.g., as described further herein) and maintains the spatial relationship (e.g., a distance and/or orientation) between the virtual object and the corresponding object center(s) of movement that were determined and/or defined prior to detecting movement input(s). In some embodiments, the computer system defines and/or obtains an indication of the locations and/or the fixed spatial relationship between the virtual object and one or more centers of movement. Using a location corresponding to a selection region allows the user to initiate movement of the virtual object with respect to a plurality of locations corresponding to the selection region, thus improving the ability of the user to select and move the virtual object with respect to a most convenient location within the selection region, thus reducing user input required to move the input element toward a center of movement in a manner that could obscure the virtual object.

In some embodiments, the movement of the input element in the second portion of the first input includes a first amount of movement. In some embodiments, in response to detecting the first amount of movement the virtual object is moved with a second amount less than the first amount of movement, such as the movement of virtual object 704 in response to movement of hand 714 (while engaged in a selection input) in FIG. 7L (e.g., an amount of movement that increases the distance between the center of movement of the virtual object and the input center associated with the input element to less than the first distance that is detected prior to moving the virtual object relative to the input center associated with the input element in the manner that is selected so as to reduce the distance between the center of movement of the virtual object and the input center associated with the input element to less than the first distance). In some embodiments, the second portion of the first input causes movement of the input center by a first magnitude (e.g., a first amount of movement), and, in response to detecting the first amount of movement, the virtual object is moved (e.g., relative to the three-dimensional environment) by a second magnitude, different from (e.g., less than) the first magnitude (e.g., a second amount of movement). For example, in some embodiments, prior to the moving the virtual object relative to the input center so as to reduce the distance between the center of movement of the virtual object and the input center, the computer system moves the virtual object slower than the movement of the input center thereby increasing the distance between the center of the movement of the virtual object and the input center For example, the computer system optionally moves the virtual object and/or the center of movement of the virtual object by a magnitude that is relatively less than a magnitude of movement of the input element (e.g., a magnitude corresponding to a distance, speed, and/or acceleration). In some embodiments, the computer system initially forgoes movement of the virtual object in response to detecting a respective first portion of the second input including movement by a non-zero magnitude relative to three-dimensional environment, such as movement of a hand forming an air pinch gesture by a first distance. For example, the computer system optionally detects a first distance of movement of an air pinch gesture, and in response, optionally moves the virtual object and/or the center of movement by a second distance that is less than the first distance. Additionally or alternatively, the first magnitude optionally corresponds to a degree of movement of a joystick and/or a trackpad included in a controller in communication with the computer system. In this example, the computer system optionally moves the virtual object by a first distance which when the virtual object has moved more than a threshold amount before detecting the movement of the joystick and/or a contact on a trackpad, or optionally moves the virtual object by a second distance, which is less than a first distance, when the virtual object has not moved more than the threshold amount before detecting the movement of the joystick and/or contact on the trackpad. Thus, the computer system optionally attenuates the degree to which the virtual object is moved in response to detecting a respective portion of the input, such as when the virtual object and/or center of movement is in the process of moving toward the input center in the manner selected by the computer system. It is understood that description of moving the virtual object relative to the input center in a particular manner described with respect to the second portion of the first input herein additionally applies to additional or alternative portions of input(s), such as the first portion of the first input described with reference to method 900 and/or other portion(s) of the first input and/or other portion(s) of other input(s), such as a second or third input moving the virtual object. Moving the virtual object and/or the center of movement by a distance that is less than a distance of movement of the input center and/or the input element reduces the likelihood that the virtual object is moved in a direction and/or by a distance that is different from what the user desires, thus reducing user input required to correct for erroneous movement of the virtual object and thereby reducing power consumption required to detect the erroneous inputs.

In some embodiments, the computer system moves the virtual object with the second amount less than the first amount of movement, in which, while an amount of the movement of the input element included in the second portion of the first input is less than a threshold amount of movement, the computer system forgoes moving the virtual object, such as virtual object 704 not moving in response to movement of hand 714 (while engaged in a selection input) in FIG. 7L, and, in response to detecting the amount of the movement of the input element in the second portion of the first input being greater than the threshold amount of movement, the computer system initiates the moving of the virtual object relative to the input center, such as the movement of virtual object 704 in response to movement of hand 714 in FIGS. 7M-7N. As described with reference to “easing in” to the movement of the virtual object, in some embodiments, the computer system forgoes movement of the virtual object (at least temporarily) in response to detecting a portion of an input. In some embodiments, the computer system forgoes movement of the virtual object in response to detecting movement of the input element when the input element and/or the input center have not moved a threshold distance (e.g., 0.1, 0.25, 0.5, 1, 1.5, 2, 2.5, 3, 5, or 7 cm) from a location of the input center relative to the initial detection of the selection input of the virtual object directed to the virtual object. For example, the one or more first criteria described with reference to method 900 optionally include a criterion that is satisfied when the input element has moved an amount greater than the threshold amount from the location corresponding to the input center when the input initiated, such as when an air gesture has moved by a distance greater than the threshold distance. Additionally or alternatively, the second portion of the first input optionally includes a degree of movement indicated by joystick movement and/or contact on a trackpad included in a controller in communication with the computer system. In such examples, the computer system optionally forgoes movement until the joystick has been tilted to a degree greater than a threshold degree (e.g., 5, 10, 15, 20, 25, 30, 35, 40, 45, 50, or 60 degrees) and/or been tilted for a period of time greater than a threshold period of time (e.g., 0.01, 0.025, 0.05, 0.075, 0.1, 0.15, 0.2, 0.3, or 0.5 seconds) and/or until the contact on the trackpad moves by a distance greater than the threshold distance. Thus, the first amount of movement is optionally greater than the second amount of movement of the virtual object (e.g., due to the non-movement of the virtual object). After the air gesture, joystick movement, and/or contact on a trackpad move by the degree and/or distance greater than the respective thresholds, the computer system optionally moves the virtual object to reduce the distance between the input center and the center of movement associated with the object. For example, in some embodiments, moving the virtual object to reduce the distance between the input center and the center of movement associated with the object includes moving the virtual object by an amount greater than the amount of the movement of the input element in the second portion of the first input (e.g., including accelerating the virtual object to catch up to the input element after having initially moved slower than the input element). In some embodiments, the computer system forgoes movement of the virtual object in response to detecting movement of the input element, such as when the input element and/or the input center have not moved the threshold distance from the time that a corresponding selection of the virtual object was detected. For example, the computer system optionally forgoes movement of the virtual object until the input center and/or input element have moved in one or more directions by the threshold amount. Forgoing movement of the virtual object until an input element moves by an amount greater than a threshold amount reduces the likelihood the user erroneously moves the virtual object in an unintended direction while moving the input element, thus reducing power consumption required to detect and perform operations relating to input(s) associated with the erroneous movement of the virtual object.

In some embodiments, in accordance with a determination that a value of a virtual parameter associated with the virtual object is a first value, the threshold amount of movement is a first threshold magnitude, such as the size of first region 730-1 corresponding to virtual object 704 in FIG. 7J (e.g., threshold movement distance and/or movement speed). For example, the virtual parameter optionally corresponds to a characteristic of the virtual object, such as a scale relative to the three-dimensional environment, a simulated mass or weight of the virtual object, and/or a type of the virtual object (e.g., a virtual window including a user interface for an internet browser, a simulated volumetric object such as a racecar, and/or a notification virtual object associated with an operating system of the computer system). The value of the parameter is optionally quantitative or qualitative, such as a first size, a first simulated mass of the virtual object, and/or a first type of the virtual object. In some embodiments, the value and/or the parameter have one or more characteristics similar to or the same as one or more characteristics of the virtual parameter(s) described with reference to method 1000.

In some embodiments, in accordance with a determination that the value of the virtual parameter associated with the virtual object is a second value, different from the first value, the threshold amount of movement is a second threshold magnitude (e.g., threshold movement distance and/or movement speed), different from the first threshold magnitude, such as region 732-2 corresponding to virtual object 708 in FIG. 7AJ being larger than zone 732-1 in FIG. 7J due to the size of virtual object 708 being larger than virtual object 704. For example, when the virtual object corresponds to a second size, second simulated mass, and/or second type, the computer system optionally moves the virtual object in a manner differently from if the virtual object were of the first size, first simulated mass, and/or first type. As one example, the computer system, optionally increases the value of the threshold magnitude at which movement of the virtual object is initiated for objects that are relatively larger relative to the three-dimensional environment and/or objects that are relatively higher in simulated mass, as compared to a relative decrease in the threshold magnitude for objects that are relatively smaller and/or lower simulated mass. In some embodiments, the computer system optionally increases and/or decreases the value of the threshold magnitude at which movement of the virtual object is initiated linearly in accordance with a size of an object. For example, the threshold magnitude associated with a first object is optionally 10%, 15%, or 25% larger than a threshold magnitude associated with a second object when the value of the parameter corresponding to the first object is 10%, 15%, or 25% greater than the value of the parameter corresponding to the second object. Additionally or alternatively, in some embodiments, the computer system optionally increases and/or decreases the value of the threshold magnitude non-linearly in accordance with a size of an object. For example, the threshold magnitude associated with a first object is optionally 15%, 25%, or 45% larger than a threshold magnitude associated with a second object when the value of the parameter corresponding to the first object is 10%, 15%, or 25% greater than the value of the parameter corresponding to the second object. Changing the value of the threshold that gates movement of the virtual object reduces the likelihood that large and/or important virtual objects are moved by an amount greater than intended, which obscures other aspects of the three-dimensional environment and reduces user input correcting for the unintended movement, and thereby reduces processing required for the user input.

In some embodiments, in accordance with a determination that the value of the virtual parameter associated with the virtual object is a third value, different from the second value and different from the first value, the threshold amount of movement is a third threshold magnitude, different from the second threshold magnitude and different from the first threshold magnitude, such as if a movement region associated with a virtual object that was larger than both virtual object 704 and virtual object 708 in FIG. 7J was larger than both regions 732-1 and 732-2. For example, the third value optionally has one or more characteristics that are similar to or the same as described with reference to the first value and/or the second value. In some embodiments, the value(s) and/or the parameter have one or more characteristics similar to or the same as one or more characteristics of the virtual parameter(s) described with reference to method 1000. In some embodiments, in response to detecting inputs changing the scale and/or simulated mass of the virtual object such as scaling a virtual window and/or separating a monolithic virtual object into a pair of volumetric virtual objects, the computer system changes the value of the virtual parameter of the virtual object. In such an embodiment, the computer system moves the virtual object relative to the changed value of the virtual parameter, rather than an initial value of the virtual parameter before the virtual object is changed. Including a potentially wide range or spectrum of values for the virtual parameter improves the granularity, precision, and sensitivity with which the system can affect or dictate movement or stasis of the virtual object, thus reducing the amount of input required to adjust and otherwise correct for erroneous movement of the virtual object based upon a lack of movement granularity, thereby reducing processing required to perform and/or correct for the erroneous movement.

In some embodiments, the virtual parameter is associated with a size of the virtual object relative to the three-dimensional environment, such as illustrated by the sizes of virtual object 704 and virtual object 708 in FIG. 7J. For example, the virtual object is optionally displayed with a size, such as with a virtual height, width, length, surface area, and/or volume in the three-dimensional environment. In some embodiments, the size includes some or all of such dimensions. In some embodiments, the size of the virtual object has one or more characteristics similar to or the same as one or more characteristics of the size(es) of virtual objects described with reference to method 1000. In some embodiments, the virtual parameter is a first value when the virtual object is a first size, or is a second value, greater than or less than the first value, when the virtual object is a second size (e.g., larger than or smaller than the first size). For example, the virtual parameter value is optionally increased when the first virtual object is scaled in response to one or more inputs scaling the virtual object, or is optionally decreased when the virtual object is scaled in response to one or more inputs scaling the virtual object (or vice-versa). Setting the value of the threshold distance based on the size and/or scale of the virtual object relative to the three-dimensional environment conveys a sense that the virtual object is relatively “easier” or more difficult to move in response to inputs requesting such movement, thus reinforcing the user's perception of movement mechanics of virtual content thereby reducing cognitive load of the user.

In some embodiments, the virtual parameter is associated with a simulated mass of the virtual object, such as if the difference between the sizes of region 732-1 and 732-2 was in response to virtual object 708 having a greater simulated mass than virtual object 704 in FIG. 7J. For example, the virtual object is optionally associated with a simulated mass or weight. In some embodiments, the simulated mass and/or weight of the virtual object has one or more characteristics similar to or the same as one or more characteristics of the simulated mass and/or weight of virtual objects described with reference to method 1000. In some embodiments, the simulated mass or weight is based upon the size of the virtual object. For example, relatively larger virtual objects optionally correspond to relatively greater virtual masses, as compared to relatively smaller virtual objects that correspond to relatively lesser virtual masses. In some embodiments, the virtual object is additionally associated with one or more densities. In some embodiments, the computer system determines the value of the virtual parameter based upon the one or more of the virtual objects (e.g., relatively greater for greater densities, and/or relatively less for less densities, or vice-versa). Thus, in some embodiments, the virtual parameter is a first value when the virtual object is a first simulated mass, or is a second value, greater than or less than the first value, when the virtual object is a second simulated mass (e.g., larger than or smaller than the first size). In some embodiments, the simulated mass is at least based upon a class of the virtual object. For example, a virtual window is optionally associated with a relatively low virtual mass, as compared to a volumetric virtual object such as a truck corresponding to a relatively higher virtual mass. Setting the value of the threshold distance based on the simulated mass of the virtual object relative to the three-dimensional environment conveys a sense that the virtual object is relatively “easier” or more difficult to move in response to inputs requesting such movement, thus reinforcing the user's perception of movement mechanics of virtual content thereby reducing cognitive load of the user.

In some embodiments, the second portion of the first input includes a translation component and a rotation component (such as illustrated by the movement of hand 714 in FIG. 7Y to 7Z), and moving the virtual object with the second amount less than the first amount of movement includes, translating the virtual object in accordance with less than the translation component of the second portion of the first input that includes movement of the input element, and rotating the virtual object in accordance with the rotation component of the second portion of the first input, such as illustrated by the movement of virtual object 708 in FIGS. 7Y-7Z in response to movement of hand 714. In some embodiments, the movement of the input element in the second portion of the first input includes a translation component and a rotation component. In some embodiments, the computer system rotates the virtual object by a first amount in response to detecting the movement of the input element, including detecting a rotation component of the movement of the input element corresponding to rotation of the input element and/or the input center by a second amount. In some embodiments, the first and the second amount are the same amount. For example, the computer system optionally detects twisting of an air pinch gesture along a first axis (corresponding to rotation of the hand of the user while holding the air pinch gesture), and in response, optionally rotates the virtual object about the first axis by a same amount of the rotation of the air pinch gesture. In some embodiments, the first and the second amount are different. For example, in some embodiments, the computer system optionally detects a first amount of rotation or angular displacement of a rotation of an air pinch gesture about a first axis, and in response, optionally rotates or angularly displaces the virtual object about an axis (e.g., the first axis or a second axis corresponding to the first axis) by a second amount of rotation, less than the first amount of rotation.

In some embodiments, a portion of the input includes a translation component and/or a rotational component. In some embodiments, the translation component and/or the rotational component—and the translation and/or rotation of the virtual object performed based upon the translation component and/or the rotational component-share one or more characteristics with the input(s) and/or movement(s) of the virtual object described with reference method 1000. For example, a translational component includes movement along an axis of movement, the distance that the input center changes in one or more directions, such as a point in space where fingers of a user forming an air pinch gesture move. The rotational component, for example, optionally includes one or more degrees of rotation about one or more axes (e.g., mutually orthogonal axes) that intersect at the point in space where the fingers of the user meet. Additionally or alternatively, the translation component optionally corresponds to a tactile input provided to a controller and indicated to the computer system by the controller, such as movement of a joystick, dragging of a contact on a housing of the controller, and/or a number of selections of a hardware button included in the controller. The rotational component for the controller optionally includes a similar tactile input provided by a second controller, and/or optionally includes a movement of the controller along one or more axes relative to the housing of the controller. In some embodiments, the second portion of the input includes a movement of a joystick and/or a contact on a trackpad included in a controller, such as tilting of the joystick and/or sliding of the contact while a virtual or hardware button is selected (or after detecting selection of a button initiating a rotational mode). In some embodiments, the computer system detects translation and/or rotation of the input element concurrently or separately. In some embodiments, the computer system translates and/or rotates the virtual object concurrently or separately based upon the movement of the input element.

In some embodiments, in response to detecting an amount of movement of the input center and/or the input element, the computer system moves the virtual object differently when the virtual object is being rotated as compared to when the virtual object is being translated, and/or in accordance with a determination that the virtual object has moved by an amount greater than a threshold amount as described further herein. For example, the computer system optionally detects or receives an indication of movement of a joystick by a first degree that is included in the first input. In response to detecting the joystick movement, and in accordance with a determination that the joystick movement corresponds to a request to translate the object, the computer system optionally moves the virtual object by a first or a second distance, contingent upon whether the virtual object has moved greater than the threshold amount. In accordance with a determination that the joystick movement corresponds to a request to rotate the object, the computer system optionally rotates the virtual object by a corresponding degree, optionally irrespective of how much-if any-rotation of the virtual object preceded the detection of the movement of the joystick (e.g., while the first input is ongoing).

In some embodiments, the one or more first criteria include a criterion that is satisfied when the first input includes a request to translate the virtual object relative to the three-dimensional environment. In some embodiments, the computer system detects, via the one or more input devices, a second input provided by the input element, different from the first input. In some embodiments, the second input includes a request to rotate the virtual object relative to the three-dimensional environment. In some embodiments, in response to detecting the second input, the computer system rotates the virtual object in accordance with the second input, wherein the rotating includes an amount of rotation of the virtual object along a first axis that corresponds to an amount of rotation of the input element along a second axis. Rotating the virtual object by an amount that corresponds to rotation of the input element reduces the amount of rotation of the input element required to rotate the virtual object, thus reducing power consumption required to detect additional rotation of the input element required to affect the rotation of the virtual object.

In some embodiments, while an amount of the movement of the second portion of the first input is below a threshold amount of movement, the computer system moves the virtual object relative to the input center at a first rate of movement relative to the movement of the input element, including moving the virtual object relative to the input center associated with the input element in a manner that is selected so as to reduce a distance between the center of movement of the virtual object and the input center associated with the input element to less than the first distance such as the movement of virtual object 704 in response to movement of hand 714 when the virtual object is within second region 728 in FIGS. 7M-7O (e.g., as described with reference to method 900). For example, before the center of movement and/or the virtual object are moved in accordance with the first input by an amount that is less than a threshold amount (e.g., 0.1, 0.25, 0.5, 1, 1.5, 2, 2.5, 3, 5, or 7 cm), the computer system optionally moves the virtual object at a first rate in response to detecting a portion of the first input (e.g., no movement, or less movement than an amount of input element movement). The rate of movement, for example, optionally corresponds to a distance of movement per unit of movement of the input element and/or the input center. In some embodiments, the rate corresponds to a velocity of the virtual object relative to a velocity of the input element. Described an additional way, the virtual object optionally moves at a rate that is based upon the rate of movement the input element. That rate is optionally less than the rate of movement of the input element, such as a 0.75 cm of movement per 1 cm movement of an air pinch.

In some embodiments, in response to detecting that the amount of the movement second portion of the first input is above the threshold amount of movement, the computer system moves the virtual object relative to the input center at a second rate of movement, greater than the first rate of movement, relative to the movement of the input element, such as the rate of movement of virtual object 704 being greater in FIG. 7N than it is in FIG. 7O. In some embodiments, in response to and/or in accordance with a determination that the movement of the selection input and/or the input center is greater than the threshold amount, the computer system optionally changes from moving the virtual object and/or the center of movement based upon a first rate, and optionally initiates movement of the virtual object by a second rate, optionally different from (e.g., greater than or less than) the first rate. For example, the computer system optionally moves the virtual object by 0.9 cm, 1 cm, or 1.25 cm per 1 cm of movement of the air pinch in a direction that is the same as the initial movement of the air pinch. In some embodiments, the velocity at which the virtual object moves after the movement of the input center exceeds the threshold amount of movement is greater than the velocity of the virtual object prior to when the input center exceeds the threshold amount of movement. In some embodiments, the rate of movement of the object before and/or after reaching the threshold amount of movement is variable. For example, the rate optionally follows a curve formed between displacement of the input center from its initial location when the first input is detected and the displacement of the center of movement of the virtual object. The curve is optionally piece-wise and/or includes multiple portion that respectively correspond to different rates of the movement of the virtual object, that follow different functions (e.g., logarithmic, linear, constant, and/or some combination thereof) and/or that include different concavity of the portions of the curve changing as a function of input center displacement. It is understood that the curve(s) that dictate the rate of movement of the virtual object as a function of input center displacement optionally is similar, different, or the same for different virtual objects. Moving the virtual object at a rate that changes after the input element and/or input center moves by an amount greater than the threshold amount modified how quickly or slowly the computer system causes convergence between the virtual object and the input center, thus reducing the likelihood that the virtual object moves erroneously and/or that the user is required to provide superfluous inputs to expedite the movement of the virtual object, thereby reducing power consumption of the computer system requires for such inputs.

In some embodiments, the center of movement of the virtual object and the input center associated with the input element correspond to a same location in the three-dimensional environment while a respective portion of the second portion of the first input is being detected, such as virtual object 704 being at the same location as the input center (e.g., the pinched fingers) of hand 714 in FIG. 7S. For example, after the input element and/or input center moves an amount that is greater than a second threshold amount, (e.g., 1, 1.5, 2, 2.5, 3, 5, 7, 10, or 15 cm) while the first input is ongoing, the computer system optionally moves the virtual object such that the input center and the center of movement of the virtual object correspond to a same location in the three-dimensional environment. In some embodiments, in response to detecting initiation of a selection input, the computer system initiates movement of the virtual object in the manner described with reference to method 900. In some embodiments, the manner includes initially forgoing movement of the virtual object until the input element and/or input center moves an amount greater than the threshold amount described with reference to method 900 (or the manner includes initially moving the virtual object at a rate of movement less than a rate of movement of the input element). In some embodiments, while the selection input is maintained, and after the input element and/or input center moves greater than the threshold amount, the computer system performs pick up smoothing, moving the virtual object to catch up with movement of the input element (e.g., while contact with a trackpad on a controller is maintained, after a selection mode is enabled by pressing a button, and/or while an air gesture is maintained). In some embodiments, the pick up smoothing operation includes the moving of the virtual object at a rate such that as the input center moves, the virtual object and/or center of movement converges on the location corresponding to the input center. In some embodiments, the virtual object is moved such that the center of movement overlaps with and/or is located at a location of the input center. In some embodiments, the virtual object continues to move with the input center, such that the input center and the center of movement of the virtual object move in the same direction(s) and/or by the same amount(s). In some embodiments, the second threshold is defined relative to the location where the input center corresponds to when the first input is initiated. In some embodiments, the computer system moves the virtual object thereafter such that the input center and the center of movement of the virtual object continue to correspond to a same location. For example, in response to detecting movement of the input element and/or the input center, the computer system optionally moves the center of movement to the same location as the input center in accordance with a determination that while the first input was ongoing, the input element and/or input center moved beyond the second threshold amount from the initial location of the input center when the first input begins. In some embodiments, after the input element moves beyond the second threshold amount and while the first input is ongoing, the computer system moves the virtual object and/or center of movement by one or more magnitudes and/or in one or more directions in response to detecting movement of the input element and/or input center by the same magnitudes and/or in the same one or more directions. Thus, the computer system optionally causes the virtual object to move in a manner such that the center of movement identically, or nearly identically, tracks movement of the input element. Moving the center of movement of the virtual object to correspond to a same location as the input center reduces the likelihood that there is a spatial disconnect between the virtual object and the input center, thus reducing the likelihood the user provides inputs moving the virtual object erroneously due to the disconnect, and thereby reducing processing required to perform operations related to the inputs.

In some embodiments, moving the virtual object in accordance with the movement of the input element comprises changing, over time, a rate of movement of the virtual object toward the input element relative to the movement of the input element, such as the rate of movement of virtual object 704 changing as hand 714 moves through second region 728 in FIGS. 7R-7S. For example, as described herein, the computer system optionally moves the virtual object at one or more rates per unit measure of movement of the input element and/or input center. In some embodiments, a unit measure of movement of the input element and/or input center includes a predefined measure of a change in a position, velocity, and/or acceleration of the input element and/or input center. For example, in some embodiments, a unit measure of movement of the input element and/or input center is a predefined unit of measure of movement of the input element and/or input center, including unit measure(s) of change(s) in position (e.g., unit measure of a change in position, such as corresponding to 1 cm) of the input element and/or input center, unit measure(s) of change(s) in velocity (e.g., unit measure of a rate of change in the position, such as corresponding to 1 cm per second) of the input element and/or input center, unit measure(s) of change(s) in acceleration (e.g., unit measure of a change in the velocity, such as corresponding to 1 cm per squared second) of the input element and/or input center, and/or the like. For example, in some embodiments, moving the virtual object at one or more rates per unit measure of movement of the input element and/or input center includes moving the virtual object at a first rate (e.g., a first velocity) per centimeter of measured movement of the input element and/or input center (e.g., moving the virtual object at the first rate for the first centimeter of the measured movement of the input element and/or input center), moving the virtual object at a second rate (e.g., a second velocity different from the first velocity) per centimeter of measured movement of the input element and/or input center (e.g., moving the virtual object at the second rate for the second centimeter of the measured movement of the input element and/or input center), and/or the like. For example, in some embodiments, moving the virtual object at one or more rates per unit measure of movement of the input element and/or input center includes changing, over time, a rate of movement of the virtual object toward the input element relative to the movement of the input element, such as in accordance with unit measures of the changes in movements (e.g., including changes in position, rates of the changes in position or velocity, and/or rates of the changes in velocity or acceleration) of the input element and/or the input center. Additionally or alternatively, in some embodiments, moving the virtual object at one or more rates per unit measure of movement of the input element and/or input center includes changing, over time, a rate of movement of the virtual object relative to the movement of the input element (e.g., as in increasing the distance to simulate the virtual object moving slower than the input center so that the net effect is that the input center gets further away from object), as described above. That rate is optionally variable, and optionally follows the “curve” between displacement of the input element and displacement of the center of movement of the virtual object described herein. Thus, the rate of virtual object movement (e.g., as described above) optionally changes over a period of time during which the input element moves. It is understood that the description of moving the virtual object relative to the movement of the input element includes moving the virtual object to simulate relative movement of the virtual object based on movement of the input element over time, in addition to or in the alternative to moving the virtual object in accordance with an amount and/or direction of movement of the input element. Additionally or alternatively, the rate is optionally based upon the velocity of the virtual object relative to a velocity of the input element, in a manner similar to or the same as described with reference to a distance of virtual object movement relative to a distance of input element movement. For example, the first input optionally includes a third portion of the first input, different from the first portion, the second portion. In some embodiments, in response to detecting the portion of the first input, the computer system continues to move the virtual object relative to the input center in the manner that is selected to reduce the distance between the center of movement of the virtual object and the input center, including moving the virtual object by a third distance per unit of movement of the input element, different from the second distance per unit of movement of the input element. Changing the rate at which the virtual object moves relative to movement of the input element reduces the amount of input required by the user to expressly change the rate, thus reducing user input- and any processing required to detect the user input—that is required to request the change in the rate.

In some embodiments, the second portion of the first input includes a respective first portion and a respective second portion, in which the respective first portion occurs prior to the respective second portion, and the computer system changes the rate of movement of the virtual object toward the input element relative to the movement of the input element over time, such as the rate of movement of virtual object 704 changing as hand 714 moves through second region 728 in FIGS. 7R-7S. In some embodiments, in response to (and/or while) detecting the first respective portion of the second portion of the first input, the computer system increases the rate of movement of the virtual object toward the input element relative to the movement of the input element over time, such as the rate of movement of virtual object 704 changing as hand 714 moves through second region 728 in FIGS. 7R-7S.

As described further herein, the computer system optionally changes the rate at which the virtual object moves relative to movement of the input element. For example, the computer system optionally and/or gradually increases the rate that the virtual object and/or center of movement are moved per unit of movement of the input element. In some embodiments, the gradual increase in the rate is performed in response to detecting that the input element has moved by an amount that is greater than the threshold amount described herein (e.g., a threshold distance (e.g., 0.1, 0.25, 0.5, 1, 1.5, 2, 2.5, 3, 5, or 7 cm)). In some embodiments, the computer system gradually increases the rate as an amount of time from when the selection input moving the virtual object was detected increases. Changing the rate at which the virtual object moves relative to movement of the input element reduces the amount of input required by the user to expressly change the rate such as to increase the rate, thus reducing user input- and any processing required to detect the user input—that is required to increase the change in the rate.

In some embodiments, the second portion of the first input includes a first respective portion and a second respective portion, in which the first respective portion occurs prior to the second respective portion, and changing the rate of movement of the virtual object toward the input element relative to the movement of the input element over time comprises in response to (and/or while) detecting the second respective portion of the second portion of the first input, decreasing the rate of movement of the virtual object toward the input element relative to the movement of the input element over time, such as the rate of movement of object 704 decreasing when the virtual object 704 approaches the outer boundary of second region 728 in FIG. 7S.

As described further herein, the computer system optionally changes the rate at which the virtual object moves relative to movement of the input element. For example, the computer system optionally and/or gradually increases (or decreases) the rate that the virtual object and/or center of movement are moved per unit of movement of the input element. In some embodiments, the gradual increase in the rate is performed in response to detecting that the input element has moved by an amount that is greater than the threshold amount described herein (e.g., a threshold distance (e.g., 0.1, 0.25, 0.5, 1, 1.5, 2, 2.5, 3, 5, or 7 cm)) and/or less than a second threshold amount described herein associated with moving the virtual object to track the input element (e.g., 1, 1.5, 2, 2.5, 3, 5, 7, 10, or 15 cm). For example a first distance per unit of movement of the center of movement associated with the respective first portion of the first input is optionally greater than a second distance per unit of movement of the center of movement associated with the respective second portion of the first input. As described herein with reference to the “curve” relating the virtual object and input element movement, the computer system optionally moves the virtual object in accordance with one or more functions that change in value and/or concavity as the movement input progresses. For example, the computer system optionally initially eases the virtual object movement into movement, optionally moving the virtual object at an initial rate that gradually increases as the input center moves away from its initial location at the time it initiates the selection input. In some embodiments, the rate increases and/or peaks throughout a middle portion of the input that follows the initial input element movement. In some embodiments, after the increasing and/or the peaking the rate, the computer system gradually eases out of the picking smoothing and/or the “catching up” of the virtual object toward the input element. For example, in response to detecting a final portion of the input while the center of movement remains offset from the input center, the electronic device optionally decreases the rate of virtual object movement relative to input center movement to be less than the peak and/or the middle portion of the input, such as until the center of movement and the input center coincide. Changing the rate at which the virtual object moves relative to movement of the input element reduces the amount of input required by the user to expressly change the rate such as to increase the rate, thus reducing user input—and any processing required to detect the user input—that is required to increase the change in the rate.

In some embodiments, the computer system moves the virtual object relative to the input center associated with the input element in a manner that is selected so as to reduce the distance between the center of movement of the virtual object and the input center associated with the input element to less than the first distance, such as the distance of virtual object 704 from hand 714 (and specifically the pinch of hand 714) decreasing in FIGS. 7R-7S.

In some embodiments, in accordance with a determination that the distance between the center of the movement of the virtual object and the input center associated with the input element is the first distance when the first input is detected, the computer system moves the virtual object a second distance per unit of movement of the input element, such as the rate of movement of virtual object 704 changing as hand 714 moves through second region 728 in FIGS. 7R-7S.

In some embodiments, in accordance with a determination that the distance between the center of the movement of the virtual object and the input center associated with the input element is a third distance when the first input is detected, different than the first distance, the computer system moves the virtual object by a fourth distance per unit of movement of the input element, different than the second distance per unit of movement of the input element, such as if hand 714 were closer to virtual object 704 and thus the rate of the movement were to be slower as hand 714 moved virtual object 704 through second region 728 in FIG. 7R-7S. In some embodiments, the computer system moves the virtual object by a distance and/or at a rate that is variable based upon a spatial relationship between the input center and the center of movement of the virtual object that exists when a selection input directed to the virtual object is detected. For example, the computer system optionally moves the virtual object at a first rate (e.g., a distance per unit movement of the input element) in accordance with a determination that the input center and the virtual object are separated by a first distance when the first input is detected in response to detecting the second portion of the first input. Additionally or alternatively, the computer system optionally moves the virtual object by a second rate (e.g., a second distance per unit movement of the input element greater than or less than the first distance per unit movement) in accordance with a determination that the input center and the virtual object are separated by a second distance, different from the first distance, when the first input directed to the virtual object is detected and in response to detecting the second portion of the first input. In some embodiments, the first distance is greater than the second distance, and the first rate is greater than the second rate. Thus, in response to detecting a same distance of input element movement, the computer system optionally moves the virtual object by a third or a fourth distance, based upon the first or the second distance per unit movement of the input. Moving the virtual object by different distances based upon an initial separation between the virtual object and the input element when selection of the virtual object is detected expedites the movement of the virtual object toward the input center, thus reducing additional user input that is otherwise required to expedite the movement, thereby reducing power consumption required to detect the additional user input.

In some embodiments, the movement of the input element of the second portion of the first input is in a first direction, in which the first input includes a third portion that includes movement of the input element in a second direction, different from the first direction occurring after the first portion and the second portion, such as the movement of virtual object 704 in FIGS. 7P-7Q in a direction that is opposite the direction of movement of virtual object 704 with respect to FIGS. 7K-7O. For example, the first direction is optionally along an axis that extends between the input element and/or the input center and the center of movement of the virtual object (e.g., the axis is not displayed, and/or is established when the first input is initially detected). In some embodiments, the second portion of the first input is detected when and/or after the input center and the center of movement correspond to a same location. In other embodiments, the second portion of the first input is detected when the input center and the center of movement do not yet correspond to the same location. In some embodiments, the first direction is in a direction that is away from the virtual object, and toward the input element (e.g., the location of the input element at the time the selection input was detected), along the axis. In some embodiments, the second direction opposes the first direction along the same axis. Thus, the computer system optionally detects an initial “pulling” of the input element away from the virtual object associated with the second portion of the first input, and optionally detects a subsequent “pushing” of the input element toward the virtual object associated with the third portion of the first input. It is understood that the movement of the virtual object and/or input element optionally are not strictly along a single axis, but are optionally along a plurality of axes. It is further understood that the computer system optionally generates a composite of the movement of the input element along the plurality of axes relative to the center of movement of the virtual object, and optionally moves the virtual object along the plurality of axes in a manner similar to or the same as described with reference to the individual axis described herein.

In some embodiments, while displaying, via the one or more display generation components, the virtual object within the three-dimensional environment, after moving the virtual object in response to detecting the second portion of the first input in accordance with the determination that the movement of the input element satisfies the one or more first criteria, and in response to detecting, via the one or more input devices, the third portion of the first input, the computer system moves the virtual object relative to the input center associated with the input element in a manner that does not (and/or is selected so as to not to) reduce the distance between the center of movement of the virtual object and the input center associated with the input element, such as the computer system moving virtual object 704 in accordance with the movement of hand 714 without reducing the distance between hand 714 and virtual object 704 in FIG. 7P-7Q. For example, the computer system optionally moves the virtual object in the manner that reduces the distance between the virtual object and/or the center of movement relative to the input center, as described with reference to method 900, in response to detecting the second portion of the first input.

In some embodiments, the computer system moves the virtual object in response to detecting the third portion of the first input in a manner that optionally has one or more characteristics similar to, different from, and/or the same as the manner described with reference to method 900. In some embodiments, the manner in which the virtual object is moved in response to the third input includes maintaining and/or increasing the distance between the input center and the virtual object and/or center of movement. For example, the manner optionally includes maintaining distance in response to detecting a first sub-portion of the third portion of the first input, such as moving the virtual object and/or the center of movement along the axis between the center of movement and the input center. In some embodiments, the manner optionally includes increasing the distance in response to detecting a second sub-portion of the third portion of the first input (e.g., detected after the first sub-portion, or before the first sub-portion). Moving the virtual object in the manner that is selected to not reduce the distance between the center of movement of the virtual object and the input center reduces the amount of input element movement required to move the virtual object in the third direction, thus reducing processing required to detect the aggregate amount of input element movement required to move the virtual object in a direction that is different from and/or opposes an initial direction of movement of the virtual object.

In some embodiments, moving the virtual object in the manner that does not (and/or is selected so as to not to) reduce the distance between the center of movement of the virtual object and the input center associated with the input element includes increasing the distance between the center of movement of the virtual object and the input center associated with the input element, such as the distance between hand 714 and virtual object 704 increasing from FIG. 7P to FIG. 7Q. For example, the virtual object optionally is moved at a first rate per unit of movement of the input element that is greater than the rate of movement of the input element. Similarly to as described with reference to the “curve(s)” that optionally dictate the rate and/or amount of virtual object movement relative to displacement of the input element, the manner that includes increasing the distance between the center of movement and the input center optionally is based upon and/or follow the curve(s) related to moving the virtual object in the second direction (e.g., reducing the distance between the center of movement and the input center). In some embodiments, in response to detecting the increasing of displacement of the input center from its initial location, the computer system moves the virtual object in accordance with a first direction along the curve(s). In some embodiments, in response to detecting the decreasing of the displacement of the input center from its initial location, the computer system moves the virtual object in accordance with a second direction along the curve(s), opposing the first direction. Thus, the rate at which the virtual object is moved as the input element is “pushed” toward the virtual object is optionally variable as the input element is progressively moved toward the location of the input center that exists when the first input is initiated. Increasing the distance between the center of movement and the input center reduces the amount of user input required to move the virtual object away from the input center, thereby reducing processing required to detect the user input.

In some embodiments, the movement of the input element of the second portion of the first input is in a first direction, and the first input includes a third portion that includes movement of the input element in a second direction, different from the first direction occurring after the first portion and the second portion, such as illustrated by movement of virtual object 704 by hand 714 in FIG. 7T. For example, as described with reference to the axis that extends between the virtual object and the input center when the first input is initially detected, as described above.

In some embodiments, while displaying, via the one or more display generation components, the virtual object within the three-dimensional environment, after moving the virtual object in response to detecting the second portion of the first input in the manner that is selected to reduce the distance between the distance between the center of movement of the virtual object and the input center associated with the input element, the computer system detects, via the one or more input devices, the third portion of the first input (e.g., hand 714 changing directions in FIG. 7T). For example, the third portion of the first input is similar to or the same as the third input described further above.

In some embodiments, in response to detecting the third portion of the first input, the computer system moves the virtual object in accordance with the third portion of the first input, in a manner that is selected so as to maintain the distance between the movement of the virtual object and the input center associated with the input element, such as in FIG. 7T to 7U wherein virtual object 704 moves according to the movement of hand 714. For example, similarly to and/or differently from as described with reference to increasing the distance between the input center and the center of movement of the virtual object, the computer system optionally moves the virtual object along the axis, forgoing reducing of the distance. In some embodiments, the computer system maintains the distance between the input center and the center of movement in response to detecting the third portion of the first input. In some embodiments, the distance is maintained until the virtual object and/or center of movement are returned to their original locations relative to the three-dimensional environment when the first input was initially detected. In response to detecting further movement of the input element, the computer system optionally forgoes further movement of the virtual object along the axis in the second direction. In some embodiments, in accordance with a determination that the input element continues movement in the second direction after the virtual object is returned to its initial location, the computer system again-initiates movement of the virtual object. For example, in accordance with a determination that the movement of the input element is greater than the threshold distance (e.g., 0.1, 0.25, 0.5, 1, 1.5, 2, 2.5, 3, 5, or 7 cm) from the location of the input center along the second direction (e.g., past the virtual object, relative to the initial location of the input center when the first input is detected), the computer system moves the virtual object in the manner that is selected so as to reduce the distance between the input center and the center of movement of the virtual object. Maintaining the distance between the virtual object and the input element reduces the likelihood that the virtual object moves too far or not far enough relative to an input moving the virtual object, thus reducing user inputs—and thereby associated processing required to detect the user input—that are required to correct for excess or a lack of movement.

In some embodiments, the movement of the input element of the second portion of the first input is in a first direction, and the first input includes a third portion that includes movement of the input element in a second direction, different from the first direction occurring after the first portion and the second portion, such as hand 714 in FIG. 7O changing direction as compared to the direction of movement of hand 714 in FIG. 7N. For example, as described with reference to the axis that extends between the virtual object and the input center when the first input is initially detected as described above.

In some embodiments, while displaying, via the one or more display generation components, the virtual object within the three-dimensional environment, after moving the virtual object in response to detecting the second portion of the first input in accordance with the determination that the movement of the input element satisfies the one or more first criteria, and in response to detecting, via the one or more input devices, the third portion of the first input, such as the movement of hand 714 in FIG. 7O (for example, the third portion of the first input is optionally similar to or the same as the third input described further above) in accordance with a determination that the moving of the virtual object in accordance with the second portion of the first input includes moving the virtual object to an updated location where the center of movement corresponds to the location of the input center, the computer system moves the virtual object in a respective first manner that is selected so as to maintain the distance between the center of movement of the virtual object and the input center, such as the movement of virtual object 704 in response to movement of hand 714 in FIGS. 7O to 7P. For example, the computer system optionally moves the virtual object in a manner that does not reduce (e.g., maintains) the distance between the center of movement of the virtual object and the input center as described further herein using similar terms and expressions. As one example, the center of movement and/or the input center optionally correspond to a same location; thus, the computer system optionally moves the center of movement in a set of one or more directions and/or by a one or more distances that are the same as included in movement of the input center. In some embodiments, the computer system determines that the center of movement corresponds to the location of the input center when both correspond to a same location in the three-dimensional environment.

In some embodiments, in accordance with a determination that the moving of the virtual object in accordance with the second portion of the first input includes moving the virtual object to an updated location where the center of movement is different from the location of the input center, the computer system moves the virtual object in a respective second manner, different from the respective first manner, that is selected so as to increase the distance between the center of movement of the virtual object and the input center, such as movement of virtual object 704 in response to movement of hand 714 in FIGS. 7P-7Q. For example, the computer system optionally moves the virtual object in a manner that that increases, rather than reduces, the distance between the center of movement of the virtual object. In some embodiments, the increasing includes moving the virtual object in one or more directions and/or by one or more distances. In some embodiments, the direction(s) and/or distance(s) are based upon or the directly oppose the direction(s) and/or distance(s) of movement of the virtual object away from its initial location before the selection input was detected. In some embodiments, the computer system moves the virtual object in a manner consistent with curve(s) of movement associated with the virtual object, as described further above. For example, the computer system optionally moves the virtual object by a distance and/or in a direction that is based upon the amount of displacement of the input center from its previous position, and/or follow the one or more mathematical functions between the input center and center of movement displacement. Thus, the computer system optionally moves the virtual object while maintaining or increasing the distance between the center of movement and the input center. Moving the virtual object in different manners facilitates rapid reversion of the virtual object to its initial location and/or improves the likelihood that the virtual object that has been moved a significant amount remains virtually attached to the input center, thus reducing user inputs otherwise required to affect a similar arrangement between virtual object and input element, thereby reducing processing required for the user inputs.

It should be understood that the particular order in which the operations in method 900 have been described is merely exemplary and is not intended to indicate that the described order is the only order in which the operations could be performed. One of ordinary skill in the art would recognize various ways to reorder the operations described herein. In some embodiments, aspects/operations of method 900 may be interchanged, substituted, and/or added between these methods. For example, various object manipulation techniques and/or object movement techniques of method 900 is optionally interchanged, substituted, and/or added between these methods. For brevity, these details are not repeated here.

FIG. 10 is a flowchart illustrating method 1000 of implementing different translation behaviors for virtual objects based on a value of a virtual parameter in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a computer system in communication with one or more inputs devices and one or more display generation components. The computer system optionally shares one or more characteristics of the computer systems described with respect to methods 800, 900, 1100, 1200, and/or 1300. The display generation component optionally shares one or more characteristics of the display generation component described with respect to methods 800, 900, 1100, or 1200. The one or more input devices optionally share one or more characteristics of the input devices described with respect to methods 800, 900, 1100, 1200, and/or 1300.

In some embodiments, while displaying, via the one or more display generation components, a virtual object in an environment (e.g., a three-dimensional environment) and while the virtual object is being controlled based on detected movement of an input element (e.g., a controller or hand that is optionally associated with a user of the computer system), the computer system detects (1002), via the one or more input devices (e.g., one or more remote body tracking devices such as cameras, motion sensors, proximity sensors or depth sensors), movement of the input element, such as detecting hand 714 moving in FIGS. 7K-7O. In some embodiments, the computer system displays a virtual object in an environment, such as a three-dimensional environment, and/or the like. In some embodiments, the virtual object is controllable by an input element. For example, in some embodiments, the virtual object is controllable based on detected movement of the input element. In some embodiments, the control of the virtual object shares one or more characteristics of the control described with respect to methods 800, 900, 1100, 1200, and/or 1300. Additionally or alternatively, in some embodiments, the input element includes a controller and/or a hand of or associated with the user. In some embodiments, the environment includes a three-dimensional environment that at least partially incorporates a representation of the real-world physical environment while using the computer system (e.g., via active or passive passthrough). In some embodiments, the environment is an extended reality (XR) environment, such as a virtual reality (VR) environment, a mixed reality (MR) environment, or an augmented reality (AR) environment. In some embodiments, the virtual object includes a virtual object that is not part of the real-world physical environment but that is visible in the environment via the display generation component. Examples of the virtual object optionally include a representation of a real or imaginary three-dimensional object, such as a stuffed animal, a chess piece, a box, or the like. In some embodiments, the virtual object is interactive based on inputs provided by the user of the computer system. In some embodiments, the input includes, but is not limited to, air gestures, movement of one or more of the user's hands, movement of a portion of one or more of the user's hands (also referred to as an “input element”), and the like. In some embodiments, the input is provided by one or more input elements. For example, in some embodiments, the input element includes a portion of the user's hand (e.g., when the user's hand is used as the input or to otherwise provide input to the computer system). In some embodiments, when the user's hand is used as the input element, the one or more input elements include one or more fingers of the user's hand. In some embodiments, the input includes, but is not limited to, an input gesture such as an air gesture, and the like. For example, in some embodiments, the input includes one or more air gestures such as an air-pinch and a release gesture; an air-pinch and drag gesture; an air-pinch, drag, and release gesture; and the like. In some embodiments, while displaying the virtual object in the environment, the computer system detects movement of the input, including movement of the input element. In some embodiments, detecting movement of the input, including movement of an input element of the input, includes detecting a predefined input directed to the virtual object. Examples of the movement of the input element include movement of the user's hand while the user's hand maintains an air pinch hand shape. For example, in some embodiments, detecting a predetermined input directed to a virtual object includes detecting movement of a hand of a user towards the virtual object located at an initial position, detecting one or more first air gestures such as an air-pinch directed to the virtual object and located within a predetermined threshold distance from the virtual object, detecting movement of the hand of the user away from the initial position of the virtual object, detecting one or more second air gestures such as a drag gesture during the movement of the hand of the user away from the initial position of the virtual object, and the like. Additionally or alternatively, in some embodiments, detecting movement of the input element includes detecting movement of a hand of a user relative to a viewpoint of the user, such as towards the viewpoint, away from the viewpoint, vertically with respect to the viewpoint, and/or horizontally with respect to the viewpoint. In some embodiments, the predefined input is defined by or selected at the computer system or an application associated with the virtual object. In some embodiments, the predetermined input includes input corresponding to a predetermined input gesture (e.g., an air gesture such as an air-pinch).

In some embodiments, in response to detecting (1004) the movement of the input element, the computer system moves (1006) the virtual object within the environment in accordance with the movement (e.g. in accordance with the detected movement) of the input element, such as the moving virtual object 704 in accordance with movement of hand 714 in FIGS. 7K-7O. In some embodiments, the computer system moves the virtual object within the environment in response to detecting the movement of the input element. For example, if the computer system detects an input corresponding to a first predefined input gesture such as an “air-pinch” gesture directed to the virtual object, the computer system moves the virtual object based on the movement of the input element following detection of the first predefined input gesture (e.g., while the air pinch hand gesture is maintained). In some embodiments, the computer system continues to move the virtual object based on the movement of the input element following the detection of the first predefined input gesture. In some embodiments, if the computer system detects an input corresponding to a second predefined input gesture, different from the first predetermined input gesture, such as a “reverse air-pinch” gesture directed to the virtual object (e.g., release of the air pinch hand gesture), the computer system ceases moving the virtual object based on the movement of the input element. In some embodiments, moving the virtual object includes translating the virtual object, rotating the virtual object, or translating and rotating the virtual object. For example, in some embodiments, moving the virtual object based on the detected movement of the input element includes moving the virtual object, including changing the position, velocity, or acceleration of the virtual object, based on the detected movement of the input element. For example, in some embodiments, moving the virtual object based on the detected movement of the input element includes moving the virtual object such that the movement of the virtual object corresponds in direction and/or magnitude with the movement of the input element. Additionally or alternatively, moving the virtual object based on the detected movement of the input element optionally includes mapping the movement of the virtual object to the movement of the input element. In some embodiments, the movement of the virtual object is mapped to the movement of the input element proportionally, or is otherwise defined such that a ratio between the change in position, velocity, or acceleration of the virtual object and the change in position, velocity, or acceleration of the input element is equivalent (e.g., the ratio between the change in velocity of the virtual object to the change in velocity of the input element is, or otherwise corresponds to, a ratio of 1:1). Additionally or alternatively, the movement of the virtual object is mapped to the movement of the input element unproportionally, or is otherwise defined such that a ratio between the change in position, velocity, or acceleration of the virtual object and the change in position, velocity, or acceleration of the input element is amplified or reduced (e.g., the ratio between the change in velocity of the virtual object to the change in velocity of the input element is, or otherwise corresponds to, a ratio of 2:1, 1:2, or the like).

In some embodiments, moving (1006) the virtual object within the environment in accordance with the movement (e.g. in accordance with the detected movement) of the input element includes, in accordance with a determination that the virtual object has a first value of a respective virtual parameter (e.g., a simulated physical property), the computer system moves (1008) the virtual object in a first manner in accordance with the movement of the input element, such as the movement of virtual object 704 in accordance with the movement of hand 714 in FIG. 7K-7O, with the movement based on the size of virtual object 704 (e.g., in accordance with movement of the input element along a respective movement path). In some embodiments, the virtual object is associated or defined in connection with, or otherwise includes, one or more virtual object parameters (also referred to as “virtual parameter(s)”). Examples of the virtual parameters associated with the virtual object optionally include characteristics such as position and orientation in the environment, size, shape, simulated/estimated mass, simulated/estimated weight, or the like. Additionally or alternatively, examples of the virtual parameters associated with the virtual object optionally include derived characteristics such as moment of inertia of the object (e.g., based on the shape of the virtual object), and the like. For example, in some embodiments, when the virtual parameter includes a size of the virtual object in the environment, a first value of a respective virtual parameter corresponds to a first magnitude of the volume of the virtual object. Additionally or alternatively, in some embodiments, when the virtual parameter includes a first shape of the virtual object in the environment, and a first value of the virtual parameter represents the first shape of the virtual object. In some embodiments, the virtual parameter is defined independently of a positional state (e.g., position, orientation and/or distance) of the virtual object relative to the viewpoint of the user and/or the environment. For example, in some embodiments, the virtual parameter is independent of the distance of the virtual object from the viewpoint, independent of a position of the virtual object relative to the viewpoint and/or independent of an orientation of the virtual object relative to the viewpoint. In some embodiments, when the computer system determines that the virtual object has the first value of the first parameter, the computer system moves the virtual object in a first manner in accordance with the movement of the input element. For example, in some embodiments, the computer system moves the virtual object in the first manner in accordance with detected movement of the input element. For example, in some embodiments, moving the virtual object in the first manner includes moving the virtual object based on the first value of the first parameter, including rotating the virtual object at a first rate of rotation based on the first value of the first parameter in response to detecting the movement of the input element, in which the movement of the input element includes rotation of the input element. As another example, in some embodiments, moving the virtual object in the first manner includes moving the virtual object based on the first value of the first parameter, including translating the virtual object at a first rate of speed based on the first value of the first parameter in response to detecting the movement of the input element, in which the movement of the input element includes translation of the input element.

In some embodiments, moving (1006) the virtual object within the environment in accordance with the movement (e.g. in accordance with the detected movement) of the input element includes, in accordance with a determination that the virtual object has a second value of the respective virtual parameter, wherein the second value of the respective virtual parameter is different from the first value of the respective virtual parameter, the computer system moves (1010) the virtual object in a second manner in accordance with the movement of the input element, such as the movement of virtual object 708 being different than the movement of virtual object 704 in response to movement of hand 714 due to the size of virtual object 708 being larger than virtual object 704 as illustrated in FIG. 7J as well as FIGS. 7K-7O compared with FIGS. 7W-7Y (e.g., in accordance with movement of the input element along the respective movement path), wherein the movement in the second manner is different from the movement in the first manner. In some embodiments, the second value of the virtual parameter corresponds to a second magnitude, different from the first magnitude, of the virtual object. Additionally or alternatively, in some embodiments, the second value of the virtual parameter represents a second shape of the virtual object. In some embodiments, when the computer system determines that the virtual object has a second value, different from the first value, of the first parameter, the computer system moves the virtual object in a second manner, different from the first manner, in response to detecting the movement of the input element. For example, in some embodiments, moving the virtual object in the second manner includes moving the virtual object based on the second value of the first parameter, including rotating the virtual object at a second rate of rotation, different from the first rate of rotation, in response to detecting the movement of the input element, in which the movement of the input element includes rotation of the input element. As another example, in some embodiments, moving the virtual object in the second manner includes moving the virtual object based on the second value of the first parameter, including translating the virtual object at a second rate of speed, different from the first rate of speed, in response to detecting the movement of the input element, in which the movement of the input element includes translation of the input element. Moving a virtual object in an environment, such as a three-dimensional environment, and/or the like, differently, based on detected movement of an input element and one or more values of a virtual parameter associated with the virtual object improves user experience of the computer system by facilitating intuitive operation of the computer system by the user, thereby reducing input errors, and improving the functionality of the computer system and the efficiency of the user interaction with the computer system.

In some embodiments, the determination that the virtual object has the first value of the respective virtual parameter includes determining that a size of the virtual object is a first size, such as the size of virtual object 704 in FIG. 7J. In some embodiments, the determination that the virtual object has the second value of the respective virtual parameter includes determining that the size of the virtual object is a second size, different from the first size, such as virtual object 708 being larger than virtual object 704 as illustrated in FIG. 7J. In some embodiments, a virtual object reflects, is reflective of, and/or is otherwise defined in connection with one or more respective virtual parameters. In some embodiments, the one or more virtual parameters of a virtual object include a respective virtual parameter that reflects or is otherwise reflective of a size of the virtual object. For example, in some embodiments, the computer system determines that a virtual object has a first value of a respective virtual parameter when the computer system determines that the size of the virtual object is a first size. Additionally or alternatively, in some embodiments, the computer system determines that the virtual object has a second value, different from the first value, of the respective virtual parameter when the computer system determines that the size of the virtual object is a second size, different from the first size. In some embodiments, the size of the virtual object indicates, reflects, is reflective of, and/or otherwise corresponds to a volume of the virtual object. Additionally or alternatively, in some embodiments, the size of the virtual object indicates, reflects, is reflective of, and/or otherwise corresponds to a two-dimensional size of the virtual object (e.g., as in a profile view of the virtual object or in representing the virtual object in two dimensions). Determining one or more values of a respective virtual parameter corresponding to a size associated with a virtual object, in which the one or more values include, for example, a first value of the size of the virtual object, and a second value of the size, different from the first value of the size, of the virtual object, or the like, improves the user experience by enabling and providing for a greater range of interactions between the user and the virtual object, such as in enabling different object interaction behaviors based on the size of the virtual object, resizing of the virtual object, and the like, thereby facilitating intuitive operation of the computer system, reducing input errors, and improving the functionality of the computer system and the efficiency of the user interaction with the computer system.

In some embodiments, the determination that the virtual object has the first value of the respective virtual parameter includes determining that a simulated mass of the virtual object is a first weight, such as if virtual object 704 has a simulated mass that was proportional to its size in FIG. 7J. In some embodiments, the determination that the virtual object has the second value of the respective virtual parameter includes determining that the simulated mass of the virtual object is a second weight, different from the first weight, such as if virtual object 708 had a larger simulated mass than virtual object 704 because virtual object 708 is larger than virtual object 704 in FIG. 7J. In some embodiments, the one or more virtual parameters of a virtual object include a respective virtual parameter that reflects or is otherwise reflective of a simulated mass of the virtual object. For example, in some embodiments, the computer system determines that a virtual object has a first value of a respective virtual parameter when the computer system determines that the simulated mass of the virtual object is a first weight. Additionally or alternatively, in some embodiments, the computer system determines that the virtual object has a second value, different from the first value, of the respective virtual parameter, when the computer system determines that the simulated mass of the virtual object is a second weight, different from the first weight. In some embodiments, the computer system determines the simulated mass of the virtual object based on the size of the virtual object, as described herein. Additionally or alternatively, in some embodiments, the computer system determines the simulated mass of the virtual object based on the size of the virtual object and/or a density associated with the virtual object. For example, in some embodiments, the computer system determines that a virtual object has a first value of a respective virtual parameter when the computer system determines that the density of the virtual object is a first density and a first size. Determining one or more values of a respective virtual parameter corresponding to a simulated mass associated with a virtual object, in which the one or more values include, for example, a first value of the weight of the virtual object, and a second value of the weight, different from the first value of the weight, of the virtual object, or the like improves the user experience by enabling and providing for a greater range of interactions between the user and the virtual object, such as in enabling different object interaction behaviors based on the weight of the virtual object, and the like, thereby facilitating intuitive operation of the computer system, reducing input errors, and improving the functionality of the computer system and the efficiency of the user interaction with the computer system.

In some embodiments, moving the virtual object in the first manner in accordance with the movement of the input element includes moving the virtual object with a first amount of delay relative to the movement of the input element, for instance virtual object 704 moves with a delay that is proportional to the size of region 732-1 in FIG. 7J. In some embodiments, moving the virtual object in the second manner in accordance with the movement of the input element includes moving the virtual object with a second amount of delay, different from the first amount delay, relative to the movement of the input element, such as virtual object 708 moving with a delay that is proportional to region 732-2 (which is larger than region 732-1 associated with virtual object 704) in FIG. 7J. In some embodiments, when the computer system moves a virtual object in the first manner relative to the movement of the input element, including moving the virtual object based on a first value of a respective parameter, the computer system moves the virtual object with a first amount of delay based on the first value of the respective parameter relative to the movement of the input element. As an example, in some embodiments, an amount of delay with which the computer system moves a virtual object corresponds to an interval between a first time instance, at which the computer system detects movement of the input element, and a second time instance, after the first time instance, at which the computer system moves the virtual object, such as in accordance with the movement of the input element. In this example, the amount of delay corresponds to a duration of the interval between the first time instance and the second time instance. Additionally or alternatively, in some embodiments, when the computer system moves the virtual object in the second manner, including moving the virtual object based on a second value of the respective parameter, the computer system moves the virtual object with a second amount of delay, different from the first amount of delay, based on the second value of the respective parameter relative to the movement of the input element. For example, in some embodiments, the first amount of delay corresponds to a first time interval (e.g., 1 s), and the second amount of delay corresponds to a second time interval (e.g., 0.5 s or 1.5 s), different from the first time interval. For example, in some embodiments, when the computer system determines the second value of the respective parameter is greater than the first value of the respective parameter, the computer system moves the virtual object with the second amount of delay, greater than the first amount of delay, based on the second value of the respective parameter relative to the movement of the input element. As another example, in some embodiments, when the computer system determines the second value of the respective parameter is less than the first value of the respective parameter, the computer system moves the virtual object with the second amount of delay, less than the first amount of delay, based on the second value of the respective parameter relative to the movement of the input element. Moving a virtual object with different amounts of delay based on different values of a virtual parameter associated with the virtual object enables simulation of different object manipulation behaviors, realistic or otherwise, in connection with the virtual object, which facilitates intuitive operation (e.g., as in simulating realistic object manipulation behavior for a virtual object that has a small size, mass, and/or density, such as by moving the virtual object with a small amount of delay in accordance with movement of an input element), enables and facilitates immersion, reduces input errors, and reduces power consumption, thereby improving the overall functionality of the computer system and the efficiency of the user interaction with the computer system.

In some embodiments, the first value of the respective virtual parameter corresponds to a first simulated inertia of the virtual object, such as if the size of region 732-1 based on the simulated inertia of virtual object 704 in FIG. 7J. In some embodiments, the second value of the respective virtual parameter corresponds to a second simulated inertia of the virtual object, different from the first simulated inertia of the first virtual object, such as if the size of region 732-2 was based on the simulated inertia of virtual object 708 which is larger than the simulated inertia of virtual object 704 in FIG. 7J. In some embodiments, the first value of the respective parameter associated with the virtual object corresponds to a first simulated inertia of the virtual object. Additionally or alternatively, in some embodiments, the second value of the respective parameter associated with the virtual object corresponds to a second simulated inertia of the virtual object, different from the first simulated inertia of the virtual object. In some embodiments, moving a first virtual object with a first simulated inertia includes moving the first virtual object with a first amount of delay. Additionally or alternatively, in some embodiments, moving a second virtual object with a second simulated inertia, different from the first simulated inertia, includes moving the second virtual object with a second amount of delay, different from the first amount of delay. In some embodiments, when the first simulated inertia is greater than the second simulated inertia, the first amount of delay is greater than the second amount of delay. As an example, in some embodiments, simulated inertia of a virtual object is reflected by the degree of simulated resistance with which the computer system moves the virtual object (e.g., a respective virtual object, when at rest, tends to stay at rest, and when in motion, tends to stay in motion), according to detected movement of the input element of the selection input. For example, in some embodiments, for a virtual object for which a value of the simulated inertia is positive, the movement of the virtual object is mapped to the movement of the input element unproportionally (e.g., to simulate the virtual object's resistance to changes in motion), or is otherwise defined such that a ratio between the change in position, velocity, or acceleration of the first virtual object and the change in position, velocity, or acceleration of the input element is reduced (e.g., the ratio between the change in velocity of the virtual object to the change in velocity of the input element is, or otherwise corresponds to, a ratio of 1:2, or the like. Additionally or alternatively, in some embodiments, for a virtual object for which a value of the simulated inertia is positive, the computer system maps the movement of the input element to the movement of the virtual object, including adjusting the mapping of the movement of the input element to the movement of the virtual object at one or more predetermined rates over time (e.g., to simulate the gradual acceleration and/or deceleration of the virtual object according to the movement of the input element over a time period during which the virtual object is subjected to manipulation, such as in accordance with the movement of the input element). For example, in some embodiments, for a virtual object defined in connection with one or more virtual parameters, including a respective virtual parameter for which the first value corresponds to a first size of the virtual object, a first shape of the virtual object, a first simulated mass and/or weight of the virtual object, and/or the like, the computer system determines an associated value of the first simulated inertia according to the first value defining the size of the virtual object, the shape of the virtual object, and/or the simulated mass and/or weight of the virtual object. Additionally or alternatively, in some embodiments, for a virtual object defined in connection with one or more virtual parameters, including a respective virtual parameter for which the second value, different from the first value, corresponds to a size of the virtual object, a shape of the virtual object, a simulated mass and/or weight of the virtual object, and/or the like, the computer system determines an associated value of the second simulated inertia according to the second value defining the size of the virtual object, the shape of the virtual object, and/or the simulated mass and/or weight of the virtual object. In some embodiments, the computer system moves the virtual object with the first amount of delay according to the first simulated inertia derived from or otherwise corresponding to the first value of the respective parameter of the virtual object, relative to the movement of the input element. Additionally or alternatively, in some embodiments, the computer system moves the virtual object with the second amount of delay according to the second simulated inertia derived from or otherwise corresponding to the second value of the respective parameter of the virtual object, relative to the movement of the input element. Additionally or alternatively, in some embodiments, the computer system moves the virtual object with one or more amounts of delay, as described herein, including moving the virtual object according to values of one or more respective virtual parameters associated with respective measures of simulated inertia of the virtual object, and/or moving the virtual object according to an initial motion state of the virtual object prior to detecting the associated movement of the input element (e.g., by which the computer system moves the virtual object), In this example, the initial motion state of the virtual object corresponds to a state of motion of the virtual object prior to the instance at which the associated movement of the input element is detected (e.g., where the computer system moves the virtual object according to the associated movement of the input element). Moving a virtual object in an environment such as a three-dimensional environment in different manners according to different values of a virtual parameter associated with the virtual object, such as in moving the virtual object with different amounts of delay according to different values of a virtual parameter corresponding to the simulated inertia of the virtual object, improves the user experience by enabling different object interaction behaviors for virtual objects, thereby improving physical realism of the interactions between the user and the computer system, reducing input errors, and improving the functionality of the computer system and the efficiency of the user interaction with the computer system.

In some embodiments, the first value of the respective virtual parameter corresponds to a first size of the first virtual object, such as region 732-1 being based on the size of virtual object 704 in FIG. 7J. In some embodiments, the first value of the respective parameter associated with the virtual object corresponds to a first size of the virtual object. In some embodiments, the second value of the respective virtual parameter corresponds to a second size of the first virtual object, smaller than the first size of the first virtual object, such as region 732-1 being based on the size of virtual object 708 in FIG. 7J. Additionally or alternatively, in some embodiments, the second value of the respective parameter associated with the virtual object corresponds to a second size of the virtual object, smaller than the first size of the virtual object.

In some embodiments, the first amount of delay is larger than that second amount of delay, such as region 732-2 associated with virtual object 708 being larger than region 732-1 associated with virtual object 704 due to the difference in size between virtual object 704 and virtual object 708. In some embodiments, when the computer system moves the virtual object in the first manner, the computer system moves the virtual object with the first amount of delay according to the first value of the respective parameter relative to the movement of the input element. Additionally or alternatively, in some embodiments, when the computer system moves the virtual object in the second manner, the computer system moves the virtual object with the second amount of delay, smaller than the first amount of delay, according to the second value of the respective parameter relative to the movement of the input element. As an example, in some embodiments, the first value of the respective parameter associated with the virtual object corresponds to the first size of the virtual object, which is greater than the second value of the respective parameter associated with the virtual object that corresponds to the second size of the virtual object such that the computer system moves the virtual object with the first size with the first amount of delay, in which the first amount of delay is greater than the second amount of delay with which the computer system moves the virtual object in the second manner according to the second size of the virtual object. Moving a virtual object according to different values of a virtual parameter corresponding to different sizes of the virtual object such that bigger virtual objects are moved with greater amounts of delay and smaller objects are moved with lesser amounts of delay improves the physical realism of interactions between the user and virtual objects which minimizes input errors associated with unintended selection of a virtual object, thereby conserving computing resources associated with correcting the input errors.

In some embodiments, moving the first virtual object in the first manner includes varying an amount of delay of moving the first virtual object relative to the movement of the input element over time from the first amount of delay in a first respective manner, such as the movement of virtual object 704 through region 728 in FIG. 7M-7O. In some embodiments, when the computer system moves the virtual object in the first manner, the computer system changes or otherwise varies, in a first respective manner, an amount or magnitude of the first amount of delay with which the computer system moves the virtual object relative to the movement of the input element over time. For example, in some embodiments, varying, in the first respective manner, the amount or magnitude of the first amount of delay with which the computer system moves the virtual object, relative to the movement of the input element, includes varying a simulated input latency of the input corresponding to the movement of the input element, relative to the movement of the virtual object. In some embodiments, the simulated input latency of the input corresponding to the movement of the input element, relative to the movement of the virtual object, refers to the duration of an interval between a first time instance, at which the computer system detects movement of the input element, and a second time instance, after the first time instance, at which the computer system moves the virtual object. Additionally or alternatively, in some embodiments, varying the simulated input latency includes changing or otherwise varying the duration of the interval between the first time instance and the second time instance. In some embodiments, varying, in the first respective manner, the amount or magnitude of the first amount of delay with which the computer system moves the virtual object includes changing (e.g., reducing or increasing) the amount or magnitude of the first amount of delay, and/or otherwise changing (e.g., reducing or increasing) the simulated input latency of the input corresponding to the movement of the input element, relative to the movement of the virtual object, at a first predetermined rate of change. In some embodiments, changing the simulated input latency of the input at the first predetermined rate of change includes changing the amount or magnitude of the first amount of delay at a linear rate. For example, in some embodiments, changing (e.g., reducing or increasing) the simulated input latency of the input at the first predetermined rate of change includes changing the amount or magnitude of the first amount of delay with which the computer system moves the virtual object relative to the movement of the input element, such as at a rate of a first quantity of time per unit time (e.g., as in reducing the amount or magnitude of the first amount of delay at a rate of −0.01 s per second). Additionally or alternatively, in some embodiments, changing the simulated input latency of the input at the first predetermined rate of change includes changing the amount or magnitude of the first amount of delay at a non-linear rate. Additionally or alternatively, in some embodiments, changing the simulated input latency of the input at the first predetermined rate of change includes changing the amount or magnitude of the first amount of delay exponentially, at a corresponding rate of change and according to a magnitude of the simulated input latency at a given instance in time.

In some embodiments, moving the first virtual object in the second manner includes varying the amount of delay of moving the first virtual object relative to the movement of the input element from the second amount of delay in a second respective manner, different from the first respective manner, such as the movement of virtual object 708 through second region 728 in FIGS. 7X-7Y moving in a different manner than the movement of virtual object 704 through the second region as illustrated in FIGS. 7M-7O. Additionally or alternatively, in some embodiments, when the computer system moves the virtual object in the second manner, the computer system changes or otherwise varies, in a second respective manner, different from the first respective manner, an amount or magnitude of the second amount of delay with which the computer system moves the virtual object relative to the movement of the input element over time. For example, in some embodiments, varying, in the second respective manner, the amount or magnitude of the second amount of delay with which the computer system moves the virtual object includes changing (e.g., reducing or increasing) the amount or magnitude of the second amount of delay, and/or otherwise changing (e.g., reducing or increasing) the simulated input latency of the input corresponding to the movement of the input element, relative to the movement of the virtual object, at a second predetermined rate of change, different from the first predetermined rate of change. In some embodiments, changing the simulated input latency of the input at the second predetermined rate of change includes changing the amount or magnitude of the second amount of delay at a linear rate. For example, in some embodiments, changing (e.g., reducing or increasing) the simulated input latency of the input at the second predetermined rate of change includes changing the amount or magnitude of the second amount of delay with which the computer system moves the virtual object relative to the movement of the input element, such as at a rate of a second quantity of time per unit time (e.g., as in reducing the amount or magnitude of the second amount of delay at a rate of −0.05 s per second), different from the first quantity of time per unit time. Additionally or alternatively, in some embodiments, changing the simulated input latency of the input at the second predetermined rate of change includes changing the amount or magnitude of the second amount of delay at a non-linear rate. Additionally or alternatively, in some embodiments, changing the simulated input latency of the input at the second predetermined rate of change includes changing the amount or magnitude of the second amount of delay exponentially, at a corresponding rate of change and according to a magnitude of the simulated input latency at a given instance in time. Moving a virtual object in an environment such as a three-dimensional environment in different respective manners, including changing the simulated input latency of the input corresponding to the movement of the input element, relative to the movement of the virtual object, improves the user experience by enabling different object interaction behaviors for virtual objects, thereby improving physical realism of the interactions between the user and the computer system, reducing input errors, and improving the functionality of the computer system and the efficiency of the user interaction with the computer system.

In some embodiments, the movement of the input element includes a rotation component, such as the rotation component on input 732 in FIG. 7AA. In some embodiments, the movement of the input element includes a rotation component. In some embodiments, in response to detecting the movement of the input element, and in accordance with a determination that the virtual object has a first size, the computer system rotates the virtual object within the environment by a first amount in accordance with the rotation component of the movement of the input element, such as the rotation of virtual object 704 in FIG. 7AA. In some embodiments, when the computer system determines that a virtual object has a first value of a respective virtual parameter by which a size of the virtual object is defined, the computer system determines that the size of the virtual object is a first size (e.g., based on a magnitude of the first value of the respective virtual parameter). In some embodiments, when the movement of the input element includes a rotation component, and the first value of the respective virtual parameter that reflects the size of the virtual object is determined to be a first size, the computer system moves, in response to detecting the movement of the input element, the virtual object in the first manner relative to the movement of the input element, including rotating the virtual object by a first amount based on the rotation component of the movement of the input element. For example, in some embodiments, such as in instances where the input element is a hand, the rotation component of the input element includes angular displacement and/or rotational movement of the hand about an axis (e.g., as in rotation of the hand caused by rotation of a wrist attached to the hand). In some embodiments, the first amount by which the virtual object is rotated, based on the rotation component of the movement of the input element, is proportional to a measure of a magnitude of the rotation component of the movement of the input element. For example, in some embodiments, in response to detecting the movement of the input element, in which the movement of the input element includes a rotation component having a magnitude of 90 degrees, and according to a determination that the virtual object has a first size, the computer system rotates the virtual object by the first amount, in which the first amount corresponds to an angular displacement of the virtual object about an axis by 90 degrees. Additionally or alternatively, in some embodiments, when the movement of the input element includes a translation component (e.g., translation of the input element over a first distance corresponding to 1 m), and the first value of the respective virtual parameter by which the size of the virtual object is defined is determined to be the first size, the computer system moves, in response to detecting the movement of the input element, the virtual object in a manner relative to the movement of the input element, including translating the virtual object by a first translation amount (e.g., translation of the virtual object over the first distance corresponding to 1 m) based on the translation component of the movement of the input element.

In some embodiments, in accordance with a determination that the virtual object has a second size, different from the first size, the computer system rotates the virtual object within the environment by the first amount in accordance with the rotation component of the movement of the input element, such as the rotation of virtual object 708 (which is larger than virtual object 704) in FIG. 7Z. Additionally or alternatively, in some embodiments, when the computer system determines that the virtual object has a second value of the respective virtual parameter by which the size of the virtual object is defined, the computer system determines that the size of the virtual object is a second size (e.g., based on a magnitude of the second value of the respective virtual parameter), different from the first size. In some embodiments, when the movement of the input element includes a rotation component, and the second value of the respective virtual parameter by which the size of the virtual object is defined is determined to be a second size, different from the first size, the computer system moves, in response to detecting the movement of the input element, the virtual object in the second manner relative to the movement of the input element, including rotating the virtual object by the first amount based on the rotation component of the movement of the input element. For example, in some embodiments, in response to detecting the movement of the input element, in which the movement of the input element includes a rotation component having a magnitude of 90 degrees, and according to a determination that the virtual object has a second size, different from the first size, the computer system rotates the virtual object by the first amount, in which the first amount corresponds to an angular displacement of the virtual object about an axis by 90 degrees. Additionally or alternatively, in some embodiments, when the movement of the input element includes a translation component (e.g., translation of the input element over a first distance corresponding to 1 m), and the second value of the respective virtual parameter by which the size of the virtual object is defined is determined to be a second size, greater than the first size, the computer system moves, in response to detecting the movement of the input element, the virtual object in a manner relative to the movement of the input element, including translating the virtual object by a second translation amount (e.g., translation of the virtual object over a second distance, less than the first distance, corresponding to 0.5 m), different from the first translation amount, based on the translation component of the movement of the input element. Moving a virtual object in an environment such as a three-dimensional environment, including rotating the virtual object by the first amount regardless of differences in the values of the respective virtual parameter by which different sizes of the virtual object are defined, enables consistent and uniform interactions between the user and virtual objects in the environment for specific subsets of predetermined interactions associated with specific types of movements of the input element, thereby improving the user experience by reducing input errors (e.g., less cognitive load required of the user in determining how much rotation required for rotating virtual objects of different sizes), and improving the functionality of the computer system and the efficiency of the user interaction with the computer system.

In some embodiments, rotating the virtual object within the environment by the first amount in accordance with the rotation component of the movement of the input element includes rotating the virtual object proportionally with the rotation component of the movement of the input element, such as the rotation amount of virtual object 708 being in proportion to the amount of rotation of hand 714 as illustrated in FIGS. 7Z and 7AB. In some embodiments, when the movement of the input element includes a rotation component, and the first value of the respective virtual parameter by which the size of the virtual object is defined is determined to be a first size, the computer system moves the virtual object in the first manner relative to the movement of the input element, including rotating the virtual object by the first amount based on the rotation component of the movement of the input element. In some embodiments, rotating the virtual object by the first amount based on the rotation component of the movement of the input element includes rotating the virtual object proportionally to a measure of the magnitude of the rotation component of the movement of the input element. For example, in some embodiments, rotating the virtual object proportionally to a measure of the magnitude of the rotation component of the movement of the input element includes rotating the virtual object according to the measure of the rotation component of the movement of the input element at a ratio of 1:1 (e.g., rotating the virtual object by an amount corresponding to the measure of the magnitude of the rotation component of the movement of the input element), 1:2 (e.g., rotating the virtual object by an amount corresponding to half of the measure of the magnitude of the rotation component of the movement of the input element), 1:4, 4:1, 2:1, and/or the like. Moving a virtual object in an environment such as a three-dimensional environment, including rotating the virtual object by the first amount proportionally to a measure of the magnitude of the rotation component of the movement of the input element enables consistent and uniform interactions between the user and virtual objects in the environment for specific subsets of predetermined interactions associated with specific types of movements of the input element, thereby improving the user experience by reducing input errors (e.g., less cognitive load required of the user in determining how much rotation required for rotating virtual objects of different sizes), and improving the functionality of the computer system and the efficiency of the user interaction with the computer system.

In some embodiments, the movement of the input element includes a rotation component with a first amount of rotation relative to a shared frame of reference (e.g., an axis, or a set of axes) between the environment and a physical environment of a user of the computer system, such as the frame of reference of 742-1 in FIG. 7Z. In some embodiments, the movement of the input element includes a rotation component. In some embodiments, a measure of the rotation component of the movement of the input element is determined relative to a shared frame of reference between the environment and the physical environment in which the computer system is located. In some embodiments, the shared frame of reference corresponds a spatial coordinate system such as a Cartesian coordinate system, a spherical coordinate system, and/or the like. For example, in some embodiments, the shared frame of reference by which the measure of the rotation component of the movement of the input element is determined is defined in terms of coordinates defined in the environment, where the coordinates defined in the environment correspond with physical coordinates of the physical environment in which the computer system is located. As another example, in some embodiments, the frame of reference by which a measure of the rotation component of the movement of the input element is determined is defined in terms of coordinates defined relative to a position of a viewpoint of the user in the physical environment in which the computer system is located, where the position of the viewpoint of the user in the physical environment corresponds to the position of the viewpoint of the user in the environment. In some embodiments, the frame of reference by which a measure of the rotation component of the movement of the input element is determined is defined in terms of a frame of refence defined in connection with the spatial position and/or the spatial orientation of the input element in the physical environment.

In some embodiments, in response to detecting the movement of the input element, the computer system rotates the virtual object by a second amount of rotation, greater than the first amount of rotation, relative to the shared frame of reference, such as if virtual object 708 were rotated more than the amount of rotation of hand 714 in FIG. 7Z. In some embodiments, when the magnitude of the rotation of the rotation component of the movement of the input element includes or is otherwise determined, with reference to the shared frame of reference, to correspond to a first amount of rotation, the computer system rotates the virtual object by a second amount of rotation, greater than the first amount of rotation, in the environment. In some embodiments, rotating the virtual object by the second amount of rotation includes rotating the virtual object by an amount proportional to a measure of the magnitude of the first amount of rotation, such as at a ratio of 2:1, 3:1, 4:1, and/or the like, as described herein. For example, in some embodiments, in response to detecting the movement of the input element, in which the movement of the input element includes a rotation component having a first amount of rotation such as a magnitude of 90 degrees, the computer system rotates the virtual object by a second amount, greater than the first amount, in which a ratio of the second amount of rotation to the first amount of rotation is 2:1, such that the second amount of rotation corresponds to an angular displacement of the virtual object corresponding to 180 degrees. Moving a virtual object in an environment such as a three-dimensional environment, including rotating the virtual object by the second amount of rotation, greater than the first amount of rotation, enables dynamic, application- and/or condition-specific interactions between the user and virtual objects in the environment for specific subsets of predetermined interactions associated with specific types of movements of the input element, such as movements of the input element including a rotation component, thereby improving the user experience by enabling dynamic, context-based control, and improving the functionality of the computer system and the efficiency of the user interaction with the computer system.

In some embodiments, the movement of the input element includes a rotation component, such as the rotation of hand 714 in FIG. 7AD. In some embodiments, in response to detecting the movement of the input element, and in accordance with a determination that the rotation component of the movement of the input element includes rotation about a first axis, such as the rotating of input 732 rotating about axis 742-1 in FIG. 7AC (e.g., includes at least some rotation about the first axis, is rotation about the first axis, and/or primarily includes rotation about the first axis), the computer system rotates the virtual object in accordance with a first multiplier of the rotation component of the movement of the input element, such as virtual object 708 moving by a first multiplier about the Y-axis from FIG. 7AC to FIG. 7AD. In some embodiments, when the movement of the input element includes a rotation component, the computer system determines an axis of rotation of the rotation component. In some embodiments, the computer system determines the axis of rotation of the rotation component relative to a shared frame of reference between the environment and the physical environment in which the computer system is located, as described herein. For example, in some embodiments, the axis of rotation of the rotation component includes rotation about an axis corresponding to an X-, Y-, or Z-axis of the shared frame of reference. In some embodiments, detecting the movement of the input element includes detecting a rotation of the input element relative to one or more axis in a shared frame of reference between the environment and the physical environment in which the computer system is located. In some embodiments, the one or more points in the shared frame of reference include one or more points corresponding to an initial position of the input element, a position of a viewpoint of the user, a position in the environment corresponding to a position in the physical environment in which the computer is located, and/or the like.

For example, in some embodiments, the one or more points in the shared frame of reference include a first subset of points from the one or more points in the shared frame of reference. In some embodiments, the computer system determines that the axis of rotation of the rotation component is a first axis of rotation when the computer system detects first movement(s) of the input element relative to the first subset of the one or more points in the shared frame of reference. For example, in some embodiments, detecting the first movement(s) of the input element includes detecting the rotation component of the input element, and determining a position and/or orientation of an axis of rotation of the rotation component of the input element based on a measure of the detected rotation component relative to the first subset of the one or more points in the shared reference frame.

As another example, in some embodiments, the computer system determines the position and/or orientation of the axis of rotation of the rotation component of the input element based on input from the input element when the input element is or includes one or more input devices, such as when the input element includes a controller, in which the input from the controller includes data from an accelerometer and/or gyroscope (e.g., of the controller), including first data indicating or otherwise corresponding to a first amount of change of the angular position of the controller about a first axis of rotation. In this example, in some embodiments, the computer system determines that the axis of rotation of the rotation component of the input element is the first axis of rotation based on (e.g., by derivation from) the first data indicating or otherwise corresponding to the first amount of change of the angular position of the controller.

In some embodiments, when the computer system determines that the axis of rotation of the rotation component is a first axis of rotation, the computer system rotates the virtual object about the first axis of rotation by a first amount of rotation corresponding to a first product of a first multiplier and a measure of the amount of rotation of the rotation component of the input element about the first axis of rotation. For example, in some embodiments, when the computer system determines that the axis of rotation of the rotation component is the first axis of rotation, the computer system rotates the virtual object about the first axis of rotation by a first amount of rotation, such as an amount of rotation corresponding to 2 revolutions, corresponding to a multiple of 2 of the measured amount of rotation of the rotation component of the input element about the first axis of rotation, where the measured amount of the rotation component is 1 revolution, and/or the like.

In some embodiments, in accordance with a determination that the rotation component of the movement of the input element includes rotation about a second axis such as the rotating of input 732 rotating about axis 742-1 in FIG. 7AC (e.g., includes at least some rotation about the second axis, is rotation about the second axis, and/or primarily includes rotation about the second axis), different from the first axis, the computer system rotates the virtual object in accordance with a second multiplier of the rotation component of the movement of the input element, different from the first multiplier, such as virtual object moving by a second multiplier (different from the multiplier associated with the Y-axis) about the X-axis from FIG. 7AC to FIG. 7AD. In some embodiments, the axis of rotation is a second axis of rotation, different from the first axis of rotation.

For example, in some embodiments, the one or more points in the shared frame of reference include a second subset of points, different from the first subset of points, from the one or more points in the shared frame of reference. In some embodiments, the computer system determines that the axis of rotation of the rotation component is a second axis of rotation when the computer system detects second movement(s) of the input element, different from the first movement(s) of the input element, relative to the second subset of the one or more points in the shared frame of reference. For example, in some embodiments, detecting the second movement(s) of the input element includes detecting the rotation component of the input element, and determining a position and/or orientation of an axis of rotation of the rotation component of the input element based on a measure of the detected rotation component relative to the second subset of the one or more points in the shared reference frame.

As another example, in some embodiments, the computer system determines the position and/or orientation of the axis of rotation of the rotation component of the input element based on input from one or more input devices of the input element, such as when the input element includes a controller, in which the input from the controller includes data from an accelerometer and/or gyroscope (e.g., of the controller), including second data, different from the first data, indicating or otherwise corresponding to a second amount of change of the angular position of the controller about a second axis of rotation, different from the first axis of rotation. In this example, in some embodiments, the computer system determines that the axis of rotation of the rotation component of the input element is the second axis of rotation based on (e.g., by derivation from) the second data indicating or otherwise corresponding to the second amount of change of the angular position of the controller.

In some embodiments, when the computer system determines that the axis of rotation of the rotation component is a second axis of rotation, the computer system rotates the virtual object at a second amount of rotation corresponding to a second product of a second multiplier and a measure of the amount of rotation of the rotation component of the input element about the second axis of rotation. For example, in some embodiments, when the computer system determines that the axis of rotation of the rotation component is the second axis of rotation, the computer system rotates the virtual object at the second amount of rotation, such as at an amount of 3 revolution, corresponding to a multiple of 3 of the measured amount of the rotation component of the input element about the second axis of rotation, where the measured amount of the rotation component is 1 revolution, and/or the like.

In some embodiments, when the computer system determines that the rotation component of the movement of the input element includes rotation about the first axis and rotation about the second axis, the computer system rotates the virtual object about the first axis and the second axis, as described above. For example, in some embodiments, in response to detecting movement of the input element including rotation about the second axis, the computer system rotates the virtual object about the second axis of rotation (e.g., by the second amount of rotation corresponding to the second product of the second multiplier and the measure of the amount of rotation of the rotation component of the input element about the second axis of rotation). Additionally or alternatively, in some embodiments, while rotating the virtual object about the second axis of rotation, and in response to detecting movement of the input element including rotation about the first axis, the computer system additionally rotates the virtual object about the first axis of rotation (e.g., by the first amount of rotation corresponding to the first product of the first multiplier and the measure of the amount of rotation of the rotation component of the input element about the first axis of rotation).

Moving the virtual object, including rotating the virtual object in accordance with a multiplier based on the axis of rotation about which the input element is rotating enables dynamic, application- and/or condition-specific interactions between the user and virtual objects in an environment such as a three-dimensional environment for specific subsets of predetermined interactions associated with specific types of movements of the input element, such as movements of the input element including a rotation component, thereby improving the user experience by enabling dynamic, context-based control, and improving the functionality of the computer system and the efficiency of the user interaction with the computer system.

In some embodiments, the first multiplier is above 1, and the second multiplier is not above 1, such the multiplier associated with rotation about the Y-axis being not above 1, and the multiplier associated with rotation about the X-axis being greater than 1 in FIG. 7AD. In some embodiments, when the computer system determines that the axis of rotation of the rotation component of the input element is the first axis of rotation, the computer system rotates the virtual object by a first amount of rotation corresponding to a first product of a first multiplier and a measure of the amount of rotation of the rotation component of the input element about the first axis of rotation. In some embodiments, the first multiplier corresponds to a multiple of the rotation component of the input element, in which the multiple is of a value greater than 1 (e.g., 1.5, 2, 3, 4, 5). In some embodiments, when the computer system determines that the axis of rotation of the rotation component is the second axis of rotation, the computer system rotates the virtual object by a second amount of rotation corresponding to a second product of a second multiplier and a measure of the amount of rotation of the rotation component of the input element about the second axis of rotation. In some embodiments, the second multiplier corresponds to a multiple of the rotation component of the input element, in which the multiple is of a value that does not exceed 1 (e.g., 0.5, 0.25, 0.1, 0.05). Moving the virtual object, including rotating the virtual object in accordance with a multiplier based on the axis of rotation about which the input element is rotating, where values of the multiplier are selected based on the axis of rotation about which the input element is rotating, enables dynamic, application- and/or condition-specific interactions between the user and virtual objects in an environment such as a three-dimensional environment for specific subsets of predetermined interactions associated with specific types of movements of the input element, such as movements of the input element including a rotation component, thereby improving the user experience by enabling dynamic, context-based control, and improving the functionality of the computer system and the efficiency of the user interaction with the computer system.

In some embodiments, the second multiplier is below 1, such as the multiplier associated with rotation about the Y-axis being below 1 in FIG. 7AD. In some embodiments, when the computer system determines that the axis of rotation of the rotation component of the input element is the second axis of rotation, the computer system rotates the virtual object by a second amount of rotation corresponding to a second product of a second multiplier and a measure of the amount of rotation of the rotation component of the input element about the second axis of rotation. In some embodiments, the second multiplier corresponds to a multiple of the rotation component of the input element, in which the multiple is of a value below 1 (e.g., 0.5, 0.25, 0.1, 0.05, −0.05, −0.25, −0.1). Moving the virtual object, including rotating the virtual object in accordance with a multiplier based on the axis of rotation about which the input element is rotating, where values of the multiplier are selected based on the axis of rotation about which the input element is rotating, and values of the multiplier are below 1, enables dynamic, application- and/or condition-specific interactions between the user and virtual objects in an environment such as a three-dimensional environment for specific subsets of predetermined interactions associated with specific types of movements of the input element, such as movements of the input element including a rotation component, thereby improving the user experience by enabling dynamic, context-based control, and improving the functionality of the computer system and the efficiency of the user interaction with the computer system.

In some embodiments, in accordance with a determination that the virtual object is a first virtual object, the computer system selects a first value for the first multiplier of the rotation component, such as the multipliers associated with virtual object 708 illustrated in FIG. 7AD. In some embodiments, when the virtual object is a first virtual object, and the movement of the input element includes a rotation component, the computer system determines an axis of rotation of the rotation component of the input element, and rotates the virtual object by a first amount of rotation corresponding to a first product of a first multiplier and a measure of the amount of rotation of the rotation component of the input element about a first axis of rotation when the axis of rotation is a first axis of rotation. In some embodiments, a value of the first multiplier is selected based on a determination that the virtual object is the first virtual object.

In some embodiments, in accordance with a determination that the virtual object is a second virtual object, different from the first virtual object, the computer system selects a second value, different from the first value, for the first multiplier of the rotation component, such as the multiplier for rotation selected for virtual object 706 in FIG. 7AX. In some embodiments, when the virtual object is a second virtual object, different from the first virtual object, and the movement of the input element includes a rotation component, the computer system determines an axis of rotation of the rotation component of the input element, and rotates the virtual object by a second amount of rotation, different from the first amount of rotation, corresponding to a second product of a second multiplier and a measure of the amount of rotation of the rotation component of the input element about a second axis of rotation when the axis of rotation is a second axis of rotation. In some embodiments, a value of the second multiplier is selected based on a determination that the virtual object is the second virtual object. Moving the virtual object, including rotating the virtual object in accordance with a multiplier selected in accordance with a determination that the virtual object is a first virtual object and/or a second virtual object enables dynamic, application- and/or condition-specific interactions between the user and virtual objects in an environment such as a three-dimensional environment for specific types of virtual objects, thereby improving the user experience by enabling dynamic, context-based control of virtual objects based on the properties of the virtual objects themselves, which improves the functionality of the computer system and the efficiency of the user interaction with the computer system.

In some embodiments, the determination that the virtual object has the first value of the respective virtual parameter includes determining that the virtual object has a first initial status prior to being controlled based on the detected movement of the input element, such as if the size of region 732-1 associated with virtual object 704 were based on the initial status of virtual object 704 prior to being controlled in FIG. 7J. In some embodiments, the determination that the virtual object has the second value of the respective virtual parameter includes determining that the virtual object has a second initial status, different from the first initial status, prior to being controlled based on the detected movement of the input element, such as if the size of region 732-2 associated with virtual object 708 were based on the initial status of virtual object 708 prior to being controlled in FIG. 7J. In some embodiments, when the computer system determines that the virtual object has the first value of the first parameter, the computer system moves the virtual object in the first manner in response to detecting the movement of the input element. In some embodiments, determining that the virtual object has the first value of the first parameter includes determining a first initial status of the virtual object prior to moving the virtual object in the first manner in response to detecting the movement of the input element. For example, in some embodiments, determining the first initial status of the virtual object includes determining a first initial state of motion of the virtual object, determining a first initial position of the virtual object, determining a first initial orientation of the virtual object, and/or the like. Accordingly, in some embodiments, the computer system moves the virtual object in the first manner in accordance with a determination as to the first initial status of the virtual object in response to detecting the movement of the input element. In some embodiments, when the computer system determines that the first initial status of the virtual object corresponds to a state of the virtual object in which the virtual object is at rest or otherwise not in motion, the computer system moves the virtual object in the first manner in accordance with the determination as to the first initial status of the virtual object in response to detecting the movement of the input element, including moving the virtual object with a delay (e.g., with respect to movement of the input element, such that the movement of the virtual object in response to the movement of the input element lags the movement of the input element). In some embodiments, the delay between the movement of the input element and the movement of the virtual objects varies as a function of time. For example, in some embodiments, when the computer system determines that the first initial status of the virtual object corresponds to a state of the virtual object in which the virtual object is at rest or otherwise not in motion, the computer system moves the virtual object with an initial delay (e.g., 1 s), and varies the amount of delay as the movement of the input element continues. For example, in some embodiments, varying the amount of the delay (e.g., from 1 s) includes reducing an amount of the delay by a predetermined amount (e.g., 0.1 s) for every second the movement of the input element is detected. For example, if the delay has a duration of 1 second initially (e.g., the movement of the virtual object lags the movement of the input element by 1 second), the computer system reduces the delay, for instance by 0.1 second, for every second the movement of the input element is detected, such that, after 1 second, the delay is 0.9 seconds, after 2 seconds, the delay is 0.8 seconds, and so on. In some embodiments, the delay eventually approaches 0 seconds such that the movement of the virtual object tracks with the movement of the input element. In some embodiments, when the computer system determines that the virtual object has the second value of the first parameter, the computer system moves the virtual object in the second manner in response to detecting the movement of the input element. In some embodiments, determining that the virtual object has the second value of the second parameter includes determining a second initial status of the virtual object, different from the first initial status of the virtual object, prior to moving the virtual object in the second manner in response to detecting the movement of the input element. For example, in some embodiments, determining the second initial status of the virtual object includes determining a second initial state of motion of the virtual object, determining a second initial position of the virtual object, determining a second initial orientation of the virtual object, and/or the like. Accordingly, in some embodiments, the computer system moves the virtual object in the second manner in accordance with a determination as to the second initial status of the virtual object in response to detecting the movement of the input element. In some embodiments, when the computer system determines that the second initial status of the virtual object corresponds to a state of the virtual object in which the virtual object is in motion at a first velocity, the computer system moves the virtual object in the second manner, different from the first manner, in accordance with the determination as to the second initial status of the virtual object in response to detecting the movement of the input element, including moving the virtual object with a second delay, including varying the amount of second delay, as described herein. Additionally or alternatively, in some embodiments, moving the virtual object in the second manner includes moving the virtual object in accordance with the movement of the input element, including a velocity of the movement of the input element. For example, in some embodiments, when the computer system determines that the second initial status of the virtual object corresponds to a state of the virtual object in which the virtual object is in motion in an upwards direction (e.g., vertically), the computer system moves the virtual object with the second delay (e.g., 0.05, 0.1, or 0.2 s). In some embodiments, moving the virtual object with the second delay includes varying the amount of the second delay at a rate (e.g., reducing the amount of the first delay at a linear rate such as by reducing the delay by 0.1 s, 0.02 s. or 0.3 s for every second that the delay is applied) according to the velocity of the movement of the input element relative to the velocity of the virtual object according to the second initial status when the direction of the movement of the input element is downwards relative to the upwards motion of the virtual object in the second state. For example, in some embodiments, the rate of change of the delay is changed at a rate (e.g., of −0.1 seconds of delay per second of unit time), such as from a first, initial amount of delay (e.g., 1 second) to a second amount of delay (e.g., 0.9 seconds), to a third amount of delay (e.g., 0.8 seconds), and so on. As another example, moving the virtual object with the second delay includes varying the amount of the second delay at a predetermined rate, such as described above with reference to the first delay. As another example, in some embodiments, when the computer system determines that the second initial status of the virtual object corresponds to a state of the virtual object in which the virtual object is in motion in an upwards direction (e.g., vertically), the computer system moves the virtual object with the second delay (e.g., 1 second), including varying the amount of the second delay by a predetermined amount of time (e.g., 0.1 seconds per second of detecting the movement of the input element). For example, in some embodiments, varying the amount of the second delay, where an initial duration of the second delay is 1 second, includes reducing the duration of the second delay by a predetermined amount of time such as −0.1 seconds per second of detecting the movement of the input element such that the second delay is initially 1 second, subsequently, after detecting the movement of the input element for 1 second, the duration of the second delay is changed from 1 second to 0.9 seconds (thereby changing the delay at a rate of −0.1 seconds per second), after detecting the movement of the input element for 1 additional second (i.e., 2 seconds total), the duration of the second delay is changed from 0.9 second to 0.8 seconds, after detecting the movement of the input element for 1 additional second (i.e., 3 seconds total), the duration of the second delay is changed from 0.8 second to 0.7 seconds, and so on. In some embodiments, the varying the amount of the delay (e.g., the first delay, the second delay) includes changing the delay at a linear rate, changing the delay at a nonlinear rate, and/or the like. Additionally or alternatively, in some embodiments, varying the amount of the delay (e.g., the first delay, the second delay) includes changing the delay in accordance with a determination as to the velocity of the movement of the input element relative to the velocity of the virtual object according to the second initial status, such as when the direction of the movement of the input element is upwards relative to the upwards motion of the virtual object in the second state, and/or the like. Moving the virtual object based on an initial status of the virtual object enables the electronic device to simulate inertia of virtual objects in response to detecting movement of the input element, thereby enabling dynamic, application- and/or condition-specific interactions between the user and virtual objects in an environment such as a three-dimensional environment for specific types of virtual objects, thereby improving the user experience by enabling dynamic, context-based control of virtual objects based on the properties of the virtual objects themselves, which improves the functionality of the computer system and the efficiency of the user interaction with the computer system.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by generating audio corresponding to interaction with a virtual object) enhances the operability of the device by reducing accidental and mistaken inputs, reducing energy usage by the device. Providing additional control options (such as by moving a virtual object in accordance with a process or application associated with the virtual object and/or using values of a respective parameter defined by the process and/or a setting of the virtual object) without cluttering the UI with additional displayed controls enhances the operability of the device by reducing unnecessary inputs and/or steps to navigate through different user interfaces or sets of controls, reducing energy usage by the device. Performing an operation when a set of conditions has been met without requiring further user input (such as by assuming a spatial relationship of a virtual object when the virtual object is moved away from virtual content and/or with a movement path that is based on a process associated with the virtual object) enhances the operability of the device by reducing unnecessary inputs and/or steps to navigate through different user interfaces or sets of controls, reducing energy usage by the device.

In some embodiments, the respective virtual parameter is a movement scale parameter that defines a relationship between magnitude of movement of the input element and magnitude of movement of the virtual object (e.g., as described with reference to method 1000), such as the scaling movement of hand 1414 to correspond to the movement of virtual object 1408 as shown in FIG. 14B to as shown in FIG. 14C. For example, some or all virtual object displayed by the computer system are configured with a virtual parameter that defines the amount of movement of the virtual object performed by the computer system per unit of movement of the input element. In some embodiments, in accordance with a determination that the virtual parameter corresponds to a first value, the magnitude of movement of a virtual object per unit of input movement is a respective first value, based on the first value. For example, the first value corresponds to 0.01, 0.05, 0.1, 0.25, 0.5, 1, 2, 3, 5, 7, or 10 cm of the virtual object per 1 cm of movement of included in a movement input. In some embodiments, in accordance with a determination that the virtual parameter corresponds to a second value, different from the first value, the magnitude of movement of a virtual object per unit of input movement is a respective second value, based on the second value and different from the first value. For example, the second value corresponds to 0.05, 0.1, 0.25, 0.5, 1, 2, 3, 5, 7, or 10 m per unit 1 cm of movement included in the movement unit. It is understood that the computer system optionally uses a plurality of different values for a plurality of different types of objects, different from the first and/or the second value, such as a value for large virtual objects that are displayed with a size similar to a physical object in the virtual object. In some embodiments, a developer that corresponds to a virtual object defines the value of the virtual parameter. In some embodiments, the computer system determines the value of the virtual parameter based on a type of the virtual object. For example, a developer of a first virtual object configures the first virtual object as a virtual window for a user interface. Accordingly, the computer system optionally determines that the first virtual object is to be configured with a respective virtual parameter having the second value described above. Additionally or alternatively, developer optionally indicates a setting for the first virtual object which, when read by the computer system, is used to configure the first virtual object with the second value. Additionally or alternatively, a second virtual object which is displayed with a size that fits on surface (e.g., of a table, of furniture, and/or of a virtual game board) is optionally configured by the computer system as having a respective virtual parameter having the first value described above.

In some embodiments, while displaying the virtual object, wherein the virtual object has the first value of the respective virtual parameter, the computer system displays, via the one or more display generation components, a second virtual object, wherein second virtual object has a third value of the respective virtual parameter, different from the first value of the respective virtual parameter, such as a virtual object that is different from virtual object 1408 in FIG. 14B, optionally corresponding to virtual object 704 as shown in FIG. 7A, that has a value of the virtual parameter different from the value of the virtual parameter for virtual object 1408. For example, the second virtual object is optionally displayed in the three-dimensional environment of the computer system having a third value of the respective virtual parameter that shares one or more characteristics and/or is different from the first value and/or the second value described herein. In some embodiments, the second virtual object has the first value or the second value of the respective virtual parameter, as described with reference to method 1000 and/or the virtual object herein that has the first or the second value of the respective virtual parameter.

In some embodiments, while displaying the second virtual object and while the second virtual object is being controlled based on detected movement of the input element, the computer system detects, via the one or more input devices, respective movement of the input element, such as movement of hand 1414 from FIG. 14A to FIG. 14B. In some embodiments, while displaying the virtual object and/or the second virtual object (e.g., separately, sequentially, or concurrently), the computer system detects an input directed to a respective virtual object (e.g., the second virtual object). In some embodiments, the input includes selection input directed to the respective virtual object (e.g., an air pinch, an air tap, selection of a button on a controller, and/or attention (e.g., based on gaze and/or a focus selector such as a cursor)). In some embodiments, the input includes a respective movement in at least a first direction (e.g., movement of an air gesture, movement of an object across a trackpad, and/or movement of a joystick included in a controller). In some embodiments, the input includes a respective first amount of movement in the first direction. In some embodiments, the respective movement of the input element has one or more characteristics of the movement of the input element described with reference to method 1000.

In some embodiments, in response to detecting the respective movement of the input element, the computer system moves the second virtual object within the environment in accordance with the movement (e.g. in accordance with the detected movement) of the input element, such as if computer system 101 were to move virtual object 704 illustrated in FIG. 7A in accordance with movement of hand 1414 from FIG. 14A to FIG. 14B, including, in accordance with a determination that the second virtual object has the third value of the respective virtual parameter, such as if the respective parameter of virtual object 704 as shown in FIG. 7A were to have a third value of a simulated mass, moving the second virtual object in a third manner, different from the first manner, such as if virtual object 704 were to be moved with a path, in one or more directions, and/or by one or more amounts that differs from the movement of virtual object 1408 from FIG. 14A to FIG. 14B. In some embodiments, in response to detecting the input, and in accordance with a determination that the respective virtual object is the virtual object, the computer system moves the virtual object in the three-dimensional environment by a first amount based on the first value of the respective parameter for the virtual object (e.g., equal to scaling of the respective first amount of movement by the first value). In some embodiments, in response to detecting the input, and in accordance with a determination that the respective virtual object is the second virtual object, the computer system moves the second virtual object by a second amount, different from the first amount, based on the third value of the respective parameter for the second virtual object (e.g., equal to a scaling of the respective first amount of movement by the third value). In some embodiments, whether the respective virtual object is the virtual object or the second virtual object, the computer system moves the respective virtual object in a respective first direction based on the first direction (e.g., similar to or the same as the first direction). In this way, the computer system optionally moves the respective virtual object by an amount that is based on the value of the respective virtual parameter (e.g., corresponding to the first manner and/or second manner described above).

In some embodiments, in response to detecting the respective movement of the input element, the computer system moves the second virtual object in accordance with the movement of the input element, such as in the first manner and/or the second manner described with reference to method 1000. In some embodiments, moving the second virtual object in accordance with the input element includes, in accordance with a determination that the second virtual object has the first value of the respective virtual parameter, moving the second virtual object in a third manner, different from the first manner and/or different from the second manner. In some embodiments, moving the second virtual object in accordance with the input element includes, in accordance with a determination that the second virtual object has the second value of the respective virtual parameter, moving the second virtual object in a fourth manner, different from the first manner, different from the second manner, and/or different from the third manner. In some embodiments, the third manner is similar to, or the same as the first manner. In some embodiments, the fourth manner is similar to, or the same as the second manner.

In some embodiments, the computer system detects, via the one or more input devices, termination of control of the movement of the virtual object based on movement of the input element, such as terminating of the air pinch formed by hand 1414 as shown in FIG. 14D. For example, detecting the termination of control of the movement of the virtual object includes detecting separating of two fingers forming an air pinch, movement of a fingers off of a trackpad, selection of button (e.g., ending a selection mode enabled in response to detecting a first selection of the button), and/or detecting an input that is different from an ongoing movement input (e.g., pressing of a button while an air gesture is ongoing, selection of a virtual button with an air tap while the air gesture is ongoing, and/or a voice command directed to a virtual object other than the virtual object while moving the virtual object with a controller input). In some embodiments, the termination of control has one or more characteristics of similar terminating and/or ceasing of control described with reference to methods 900, 1000, 1100, and/or 1200.

In some embodiments, in response to detecting the termination of control of the movement of the virtual object based on movement of the input element, in accordance with the determination that the virtual object has the first value of the respective virtual parameter, the computer system performs a first object positioning operation, such as the positioning and/or movement of virtual object 1408 from FIG. 14C to FIG. 14D. In some embodiments, the first value corresponds to an immediate ceasing of movement of the virtual object, a continued movement of the virtual object, or a “snapping” of the virtual object in response to the termination of control. In some embodiments, first object positioning operation includes one or more characteristics of similar positioning and/or movement operations based on the one or more snapping criteria described with reference to method 1300. In some embodiments, a “positioning operation” defines how the computer system moves a virtual object to a position in the three-dimensional environment. For example, the computer system optionally ceases display of the virtual object at the position and/or orientation of the virtual object that exists when the termination of the movement of the virtual object is detected. Additionally or alternatively, the first positioning operation optionally includes moving the virtual object with an amount of simulated momentum based on speed of the movement of the input when the termination of the control of the movement of the virtual object is detected. Additionally or alternatively, the first positioning operations optionally includes moving the virtual object such that a portion of the virtual object moves toward and/or orients to be parallel with a surface, such as moving a virtual car so that the bottom of the virtual car is on top of a physical or virtual table. In this way, in response to detecting termination of the control of the movement of the virtual object, the computer system optionally moves the virtual object to assume a first spatial relationship relative to the three-dimensional environment.

In some embodiments, in response to detecting the termination of control of the movement of the virtual object based on movement of the input element, in accordance with the determination that the virtual object has the second value of the respective virtual parameter, the computer system performs a second object positioning operation, different from the first object positioning operation, such as moving of virtual object 1408 from the spatial arrangement shown in FIG. 14J to the spatial arrangement shown in FIG. 14K. In some embodiments, the second value corresponds to an immediate ceasing of movement of the virtual object, a continued movement of the virtual object, or a “snapping” of the virtual object in response to the termination of control (e.g., the virtual object can be configured to continue moving or snap, corresponding to the first and second value, respectively). In some embodiments, the second positioning operation includes snapping the virtual object to a predetermined orientation and/or spatial arrangement relative to the three-dimensional environment, or to a surface that exists in the three-dimensional environment. In some embodiments, second object positioning operation includes one or more characteristics of similar positioning and/or movement operations based on the one or more snapping criteria described with reference to method 1300. For example, the computer system rotates and/or translates the virtual object to align an axis associated with the virtual object with a plane corresponding to the surface. In some embodiments, the snapping includes moving the virtual object until a planar surface of the virtual object with the plane of the surface is parallel with the plane. Additionally or alternatively, the axis associated with the virtual object aligns with a longest dimension of the virtual object (e.g., extending perpendicular through a circular surface of a virtual cylinder, extending parallel to a surface of a virtual smartphone, and/or extending through a top of a head of a virtual doll)). In this way, in response to detecting termination of the control of the movement of the virtual object, the computer system optionally moves the virtual object to assume a second spatial relationship relative to the three-dimensional environment, different from the first spatial relationship described above.

In some embodiments, moving the virtual object in the first manner includes (e.g., as described above with reference to method 1000), providing input movement information associated with movement of the input element to an application associated with the virtual object, such as the first application described with reference to virtual object 1404 which optionally receives the input movement information corresponding to movement of hand 1414 from as shown in FIG. 14A to the position as shown in FIG. 14B. For example, the computer system optionally transmits and/or indicates the amount of movement of the input element and/or the one or more directions of movement of the input element to the application. In some embodiments, the input movement information corresponds to one or more speeds, velocities, accelerations, and/or position of the input element. In some embodiments, the application that corresponds to the virtual object receives the input movement information and generates object movement information (e.g., an object movement specification) as described in greater detail below.

In some embodiments, the application is represented by a user interface included in the virtual object. In some embodiments, the application creates the virtual object. In some embodiments, the application points the computer system to one or more servers that store assets to generate the virtual object, which the computer system is able to request and in return receive the assets used to display the virtual object. In some embodiments, the application controls the appearance of the virtual object and/or settings of the virtual object.

In some embodiments, moving the virtual object in the first manner includes (e.g., as described above with reference to method 1000) moving the virtual object in accordance with an object movement specification associated with the virtual object from the application associated with the virtual object and the provided movement information, such as moving virtual object 1404 from the position as shown in FIG. 14A to the position as shown in FIG. 14B. In some embodiments, the object movement specification refers to information pertaining to the movement of the virtual object based on the input movement information. In some embodiments, the application defines the manner by which virtual objects move in the three-dimensional environment of the computer system. For example, the application optionally generates one or more parameters and/or one or more vectors indicative of movement of the virtual object included in the “object movement specification.” For example, the computer system optionally receives, from the application, virtual object movement information. In some embodiments, the movement information includes one or more coordinates, one or more positions, one or more speeds, one or more accelerations, and/or some combination of simulated kinematic information that defines the manner by which the application intends to move the virtual object in the three-dimensional environment and/or relative to assets associated with the application. In some embodiments, the movement information is or is a part of the received object movement specification. For example, the computer system optionally moves the virtual object with a path and/or with a sequence of movements based on the movement information from the application relative to a virtual window including a user interface for the application and/or a volumetric object produced by the application, such as a virtual game board, a virtual table, and/or a virtual model arena. In some embodiments, the virtual object movement information indicates that the virtual object is to be moved through or to one or more squares on a chessboard displayed by the computer system; in response to receiving such information, the computer system optionally displays the virtual object moving through and/or to the one or more squares. In some embodiments, the virtual object movement information indicates that the virtual object should be rotated based on translational movement of the input element. In response to receiving the virtual object information, the computer system optionally rotates the virtual object by a first amount in accordance with a determination the virtual object movement information includes rotation by a respective first amount, based on the first amount. In response to receiving the virtual object information, the computer system optionally rotates the virtual object by a second amount, different from the first amount, in accordance with a determination that the virtual object movement information includes rotation by a respective second amount, different from the respective first amount (e.g., the second amount is based on the respective second amount). In some embodiments, the computer system receives the input movement information, and in response, moves the virtual object in a manner defined by a process associated with an application that the virtual object is associated with. For example, as described in greater detail herein, in response to receiving the input movement information, the computer system moves the virtual object in a first manner in accordance with a determination that the virtual object is moved within an “application boundary” corresponding to a first application or moves the virtual object in a second manner, different from the first manner, in accordance with a determination that the virtual object is moved within an application boundary corresponding to a second application, different from the first application.

In some embodiments, the input movement information includes information specifying a path of movement of the input element, such as a path of movement of hand 1414 as shown in FIGS. 14A through 14C. For example, the input movement information includes a sequence of one or more movements and/or instances of stasis (e.g., stillness, and/or a no movement) of an input element as described with reference to methods 800, 900 and/or in greater detail herein corresponding to the path of movement of the input element. For example, the input movement information (e.g., including translation and/or rotation of an input element) optionally includes an arc of movement of the input element relative to the three-dimensional environment. In some embodiments, the arc movement of the input element includes a first degree of curvature, a second degree of curvature, or some other degree of curvature. In some embodiments, the arc movement of the input element includes movement of the input element by a first distance, a second distance, or some other distance. Additionally or alternatively, the input movement information optionally includes a sequence of translational movements in three dimensions.

In some embodiments, the object movement specification includes information specifying a path of movement of the virtual object, such as a path through the positions of virtual object 1408 as shown in FIGS. 14A through 14C. In some embodiments, the virtual object movement information (e.g., corresponding to the object movement specification) includes a sequence of one or more movements and/or instances of stasis of the virtual object corresponding to the path of movement of the virtual object. For example, in response to detecting the arc movement of the input element described above, the computer system moves the virtual object in an arc that differs with respect to curvature and/or distance of movement.

In some embodiments, the path of movement of the input element is different than the path of movement of the virtual object, such as a path through the positions of hand 1414 as shown in FIGS. 14A through 14C. For example, the computer system optionally moves the virtual object along an arc having a degree of curvature that is based on the distance that the input element moves. In some embodiments, in accordance with a determination that the distance traveled by the input element corresponds to a first distance, the computer system moves the virtual object by the first distance (or by a respective first distance, different from but based on the first distance). Additionally or alternatively, in accordance with a determination that the distance traveled by the input element corresponds to a first distance, the computer system optionally moves the virtual object by a respective distance along an arc having a respective first degree of curvature, different from the first degree of curvature of the movement of the input element. In some embodiments, in accordance with a determination that the distance traveled by the input element corresponds to the second distance, the computer system moves the virtual object by the respective distance along an arc having a respective second degree of curvature, different from the respective first degree of curvature of the movement of the virtual object and/or different from the first degree of curvature of the movement of the input element. In some embodiments, the movement of the virtual object includes rotation of the virtual object by an amount that is the same as or differs from an amount of rotation of the input element indicated in the input movement information.

In some embodiments, the path of movement of the virtual object differs from the path of the input element based on virtual content displayed in the three-dimensional environment, such as slot 1410 as shown in FIG. 14A. For example, the computer system optionally displays a virtual game board upon which the virtual object is displayed in the three-dimensional environment when a sequence of translational inputs is detected. In response to detecting the sequence of inputs, the computer system optionally determines the path of movement of the virtual object based on the sequence of inputs if the virtual game board were not present. For example, the computer system optionally determines that the virtual object would be moved from a first position in the three-dimensional environment to a second position in the three-dimensional environment based on the input, absent the virtual game board. Due to the presence of the game board, the computer system optionally detects the second position is within a threshold distance (e.g., 0.01, 0.05, 0.1, 0.5, 1, 2.5, or 5 cm) of content included in the game board, such as slot for a tabletop character, a square on a chessboard, and/or a center of a virtual town in third person game. In accordance with a determination that the second position is within the threshold distance, the computer system forgoes movement of the virtual object to the second position (and/or animates the virtual object passing through the second position, without ceasing movement at the second position (e.g., forgoing the ceasing of movement)). In some embodiments, the computer system displays the virtual object and/or moves the virtual object to a third position corresponding to the content in the game board, thus causing the virtual object to follow a path of movement that differs from the movement of the input element and/or the virtual object. In some embodiments, the sequence of inputs specifying a plurality of different positions and/or movements of the virtual object. In some embodiments, the movement of the virtual object varies based on being within the threshold distance of one or more instances content on a virtual game board, such as moving the virtual object to the one or more instances of the content (e.g., slots on a game board, squares on a chessboard, and/or grooves in a virtual table).

In some embodiments, the first value of the respective virtual parameter is determined by an application that is associated with the virtual object, such as a value of a parameter of virtual object 1408 defined by the first software application that corresponds to virtual object 1404 as shown in FIG. 14A. In some embodiments, the first value is selected by the application from a plurality of available values for the respective virtual parameter, such as the first application corresponding to virtual object 1404 as shown in FIG. 14A selecting the value for the respective virtual parameter of virtual object 1408 from a plurality of values for virtual object 1408. In some embodiments, a process is associated with a virtual object. For example, the process optionally is a process performed by the application of a developer of the virtual object. Additionally or alternatively, the process is optionally performed by the computer system using information sent to and/or received from the virtual object. In some embodiments, an application is associated with a virtual object because movement of the virtual object is defined by the application and/or based on behaviors defined by the application. Additionally or alternatively, the virtual object is optionally generated by the application and/or is identified by information received from the application. In some embodiments, the virtual object is displayed within and/or overlaying a user interface for the application, such as displaying in a virtual window for the application. Additionally or alternatively, the virtual object is optionally placed on a surface of virtual objects received from the application, such as a virtual game board and/or model for a physical object (e.g., while a user interface for the virtual object is not displayed). In some embodiments, the value of the respective parameter is selected by the process and/or application for the virtual object (e.g., because the process and/or application is used to display of the virtual object). In some embodiments, the plurality of values of the respective virtual parameter is managed by the computer system and is selected by the process and indicated to the computer system by the process. For example, the process optionally is used to determine the value of the respective virtual parameter (e.g., the first value, the second value, or another value) of the virtual object. As a further example, the respective virtual parameter optionally corresponds to a value representing a degree of simulated magnetism of the virtual object relative to other content in the three-dimensional environment, a degree to which the virtual object travels along an arc in response to translation of the input element, and/or a degree of curvature of the arc that is selected from a plurality of values. In some embodiments, the plurality of values of the respective virtual parameter is managed by the process. In some embodiments, in accordance with a determination that the process indicates that the respective virtual parameter corresponds to a first parameter, the first value and the second value of the respective virtual parameter are selected from a first plurality of values. In some embodiments, in accordance with a determination that the process associated with the virtual object indicates that the respective virtual parameter corresponds to a second parameter, different from the first parameter, the first value and the second value of the respective virtual object are selected from a second plurality of values, different from the first plurality of values.

In some embodiments, moving the virtual object within the environment in accordance with the movement (e.g. in accordance with the detected movement) of the input element includes, in accordance with a determination that the movement of the input element corresponds to moving the virtual object within an application boundary, moving the virtual object in accordance with user input in a first manner, such as moving virtual object 1408 through the positions of virtual object 1408 as shown in FIGS. 14A through 14C while virtual object 1408 is within an application boundary corresponding to virtual object 1404. In some embodiments, the application boundary refers to a bounding three-dimensional boundary that defines the area/and our volume that is occupied by the graphical content of the application in the three-dimensional environment and/or surrounds the graphical content of the application. For example, in response to detecting the input element has moved a distance beyond a threshold distance (e.g., 0.1, 0.5, 1, 2, 3, 5, 10, 20, 30, 50, or 100 cm) away from the application boundary, the computer system optionally moves the virtual object to assume a spatial arrangement (e.g., the first spatial arrangement) relative to the three-dimensional environment, or relative to the application boundary. In some embodiments, moving the virtual object in the first manner includes moving the virtual object in accordance with user input of the input element and/or in accordance with an application that corresponds to the application boundary, as described in greater detail herein.

In some embodiments, moving the virtual object within the environment in accordance with the movement (e.g. in accordance with the detected movement) of the input element includes, in accordance with a determination that the movement of the input element corresponds to moving the virtual object out of the application boundary, such as virtual object 1408 outside of the application boundary as shown in FIG. 14I, moving the virtual object outside of the application boundary in a second manner, different from the first manner, wherein moving the virtual object in the second manner includes moving the virtual object to have a first spatial arrangement relative to the three-dimensional environment in response to detecting the virtual object move outside of the application boundary, such as moving virtual object 1408 to assume the spatial relationship relative to three-dimensional environment 1400 as shown in FIG. 14I. For example, the computer system optionally detects input moving the virtual object outside of the application boundary, and in response, animates and/or instantaneously displays the virtual object with the first spatial arrangement, as described in greater detail below. In this way, the computer system optionally moves the virtual object in a second manner which optionally includes displaying the virtual object with the first spatial arrangement automatically in response to detecting the input moving the virtual object outside of the application boundary. In some embodiments, moving the virtual object in the second manner and/or displaying the first spatial arrangement optionally includes moving and/or displaying the virtual object with an orientation relative to the three-dimensional environment that is independent of rotation of the input element controlling movement of the virtual object. For example, while moving the virtual object in accordance with the second manner, the computer system optionally forgoes rotation of the virtual object in response to detecting a twisting of a hand performing an air pinch gesture or a controller performing a selection input. While the virtual object is within the application boundary (e.g., and/or moving in the first manner), the computer system optionally rotates the virtual object in response to detecting the twisting of the air pinch gesture. In some embodiments, the computer system enables other aspects of movement of the virtual object (e.g., translation, but optionally not rotation) based on movement of the input element outside of the application boundary. For example, irrespective of whether the virtual object is within the application boundary and/or outside of the application boundary, the computer system optionally detects movement of the input element and in response, optionally translates the virtual object based on the movement of the input element as described in greater detail herein.

In some embodiments, the spatial arrangement includes a predefined spatial arrangement, such as aligning a virtual phone such that a front surface of the virtual phone is parallel to shoulders of the viewpoint of the user and/or a plane intersecting the head of the user and perpendicular to the floor of the user, such as the spatial arrangement of virtual object 1408 as shown in FIG. 14I. In some embodiments, the spatial arrangement is defined relative to a surface of the virtual content, such as moving a base of a virtual candle to be oriented such that the bottom surface of the candle and a tabletop that the candle was placed upon are parallel. Additionally or alternatively, the computer system optionally displays the virtual object with a size and/or shape included in the first spatial arrangement. For example, the computer system increases the size of a virtual game piece to be larger than before being moved beyond the threshold distance from the virtual table. Additionally or alternatively, the computer system optionally changes a spatial profile of a virtual avatar from having two-dimensional, humanlike shape when displayed in a user interface for editing the virtual avatar to being displayed within three-dimensions in the three-dimensional environment in response to detecting the input element moved beyond the threshold distance.

In this way, the computer system optionally changes the virtual object in response to detecting the input element has moved away from an application boundary by more than the threshold amount. In some embodiments, the spatial arrangement is defined for the virtual object, irrespective of whether the virtual object is being moved in the first manner or the second manner. For example, in accordance with a determination that the movement of the input element corresponds to move the virtual object away from an application boundary associated with an application by an amount greater than a threshold amount, the moving of the virtual object in the first manner includes displaying the virtual object with the first spatial arrangement in the three-dimensional environment. Additionally, in accordance with a determination that the movement of the input element corresponds to move the virtual object away from the application boundary associated with an application by an amount greater than a threshold amount, the moving of the virtual object in the second manner optionally includes displaying the virtual object with the first spatial arrangement in the three-dimensional environment.

In some embodiments, moving the virtual object in the first manner includes, in accordance with a determination that the movement of the virtual object is within an application boundary (e.g., as described in greater detail herein), such as virtual object 1408 moving within application boundary of virtual object 1404 as shown in FIGS. 14A through 14D, moving the virtual object in accordance with a movement specification associated with the application (e.g., that has one or more characteristics of other movement specifications described herein), such as a movement specification corresponding to the application associated with virtual object 1404 as shown in FIG. 14A. In some embodiments, the computer system moves a virtual object based on a set of behaviors indicated by the process associated with the virtual object (e.g., the application that generates the virtual object and/or dictates the appearance and/or movement of the virtual object). For example, the computer system optionally dictates the manner by which the virtual object moves in the three-dimensional environment, as described in greater detail with reference to moving the virtual object with a path of movement that differs from path of movement of an input element. In some embodiments, the movement is within the application boundary (e.g., a threshold distance (e.g., 0.1, 0.5, 1, 2, 3, 5, 10, 20, 30, 50, or 100 cm) of virtual content controlled by the application)).

In some embodiments, moving the virtual object in the first manner includes, in accordance with a determination that the movement of the virtual object is outside of the application boundary and that a first setting associated with the virtual object is enabled, moving the virtual object independent of the movement specification associated with the application (e.g., that has one or more characteristics of other movement specifications described herein), such as when a setting for virtual object 1408 is enabled, and computer system 101 moves virtual object 1408 as shown in FIG. 14I. In some embodiments, when the first setting of the virtual object is enabled, the movement of the virtual object (e.g., the movement specification) is not used to specify movement of the virtual object after the virtual object has been moved outside a threshold distance (e.g., 0.1, 0.5, 1, 2, 3, 5, 10, 20, 30, 50, or 100 cm) from virtual content that corresponds to the process and/or outside the application boundary. For example, the computer system optionally moves the virtual object in accordance with behaviors dictated the computer system and optionally forgoes using any customized movement specifications and/or patterns indicated by the process. In some embodiments the first setting is configured by the computer system. In some embodiments, the first setting is configured by the process and/or a developer of the virtual object. As described in greater detail below, the virtual object movement that is independent of the movement specification optionally corresponds to moving the virtual object based on the direct movements of the input element that the computer system detects (e.g., movement of the virtual object in the same directions and/or by same amounts of movement of the input element corresponding to a default behavior) and/or based on manner that the computer system dictates, such as displaying the virtual object with the first spatial arrangement (e.g., a predetermined spatial arrangement and/or a spatial arrangement that does not permit rotation of the virtual object) as described in greater detail herein. In some embodiments, the computer system facilitates movement of the virtual object outside of a first application boundary corresponding to a first application and into a second application boundary corresponding to a second application, different from the first application. For example, while maintaining the input moving the virtual object outside of the application boundary (e.g., the first application boundary), the computer system detects movement input such as movement of an air pinch and/or a focus selector moving the virtual object into a threshold distance (e.g., 0, 1, 2, 5, 10, 15, 20, 30, 50, 100, 300, or 500 cm) corresponding to the second application boundary. In response to detecting the input terminate while the virtual object is within the second application boundary, the computer system optionally initiates control of movement of the virtual object based on information indicated by the second application. For example, the computer system moves the virtual object to a predetermined location within the second application boundary, such as a slot in a virtual tabletop game for an avatar in response to detecting the input that terminates while the virtual object is within the second application boundary. In this way, the first application associated with the first application boundary optionally does not control the display and/or movement of the virtual object (e.g., because the second application controls the display and/or movement of the virtual object).

In some embodiments, moving the virtual object in the first manner includes, in accordance with the determination that the movement of the virtual object is outside of the application boundary and that the first setting associated with the virtual object is disabled, moving the virtual object in accordance with the movement specification associated with the application, such as if when the setting for virtual object 1408 is disabled, and computer system 101 moves virtual object 1408 as though the virtual object 1404 and/or the application associated with virtual object 1404 were to define the path of movement of virtual object 1408 in FIG. 14I. In some embodiments, when the first setting is disabled, the movement of the virtual object (e.g., the movement specification) is continually specified by the process and/or defined based on results of the process, even when the virtual object has been moved outside a threshold distance from virtual content that corresponds to the process. For example, the computer system optionally moves the virtual object in accordance with behaviors dictated by an application, even when moved outside the threshold distance from a user interface for the virtual content, outside the threshold distance from a volumetric object for the virtual object, and/or in accordance with a determination that the computer system detected input selecting one or more buttons and/or provided a voice command to allow the virtual object to move away from the virtual content. In some embodiments, while the input moving the virtual object is maintained and when the first setting is disabled, the computer system detects termination of the input while the virtual object is within the second application boundary described above. In some embodiments, in response to detecting the termination of the input and because the first setting is disabled, the computer system forgoes moving of the virtual object to within the second application boundary. For example, the computer system moves the virtual object to a location in the three-dimensional environment outside of the second application boundary. In some embodiments, the computer system detects the termination of the input when the second setting is disabled, and in response, displays the virtual object within the second application boundary, but moves the virtual object in accordance with the movement specification associated with the first application described above.

In some embodiments, the virtual object moves in accordance with, or independently of custom movement specified by the process based on the first setting associated with the virtual object, such as a setting for virtual object 1404 as shown in FIG. 14A. For example, in response to detecting a movement input including movement of an air pinch, an object across a trackpad, and/or a joystick, the computer system moves the virtual object. In some embodiments, the movement of the virtual object when the first setting is disabled is the same as the movement of the virtual object while the virtual object is moving within virtual content (e.g., near a virtual tabletop game, across a user interface, and/or across a virtual game board). In some embodiments, the movement of the virtual object when the first setting is disabled is different from when the virtual object is not moving within the virtual content. For example, in response to detecting one or more first directions of movement of the input element and that the first setting is disabled, the computer system moves the virtual object in the one or more first directions (or some other set of directions that are based on the one or more first directions. For example, in response to detecting the one or more first directions of movement of the input element and that the virtual object is moving within and/or near the virtual content associated with the process, the computer system moves the virtual object in the one or more first directions (or the other set of directions that are based on the one or more first directions, as described previously). In some embodiments, in response to detecting one or more first directions of movement of the input element and that the first setting is enabled, the computer system moves the virtual object in one or more respective first directions that differ from the one or more first directions (e.g., zig-zagging a game piece to avoid an obstacle or snapping a virtual brick onto a virtual wall). It is understood that similar to the description of the direction of movement of the virtual object, the computer system optionally moves the virtual object by one or more amounts that are based on whether the first setting is enabled, and/or whether the first setting is disabled.

In some embodiments, moving the virtual object in the first manner includes, in accordance with a determination that the movement of the virtual object is within a first application boundary associated with the first application, moving the virtual object in accordance with a first movement specification associated with the first application (e.g., that has one or more characteristics of other movement specifications described herein), such as virtual object 1408 moving within the application boundary of virtual object 1404 as shown in FIGS. 14A through 14D in accordance with a first movement specification defined based on the application used to generate virtual object 1404. For example, as described in greater detail herein, the computer system optionally moves the virtual object in accordance with a movement specification corresponding to a first process (e.g., a first application) associated with the virtual object. In some embodiments, the first process is associated with first virtual content, such as a first user interface or volumetric object for a first application. The virtual object, for example, is optionally a virtual soldier that the computer system translates in two dimensions (e.g., laterally across a checkerboard or between virtual campsites arranged in rows and columns) in response to detecting movement input. In some embodiments, the application boundary surrounds or is defined by the dimensions of the virtual object, as described in greater detail herein. In some embodiments, while the virtual object is moving or is to be moved in accordance with the first movement specification, the computer system detects movement input. For example, the computer system detects movement of an air pinch in a first direction and by a first amount, movement of a contact across a trackpad in a first direction and by a first amount, and/or tilting of a joystick in a first direction and/or by a first amount. In some embodiments, in response to detecting the movement input, the computer system moves the virtual object in a first manner based on the first movement specification. For example, the computer system moves the virtual object by a respective first direction based on or the same as the first direction, and/or moves the virtual object by a respective first amount based on or the same as the first amount.

In some embodiments, moving the virtual object in the first manner includes, in accordance with a determination that the movement of the virtual object is within a second application boundary associated with a second application, different from the first application, moving the virtual object in accordance with a second movement specification, different from the first movement specification, associated with the second application (e.g., that has one or more characteristics of other movement specifications described herein), such as virtual object 1408 moving within the application boundary of virtual object 1406 as shown in FIGS. 14J through 14N in accordance with a second movement specification defined based on the application used to generate virtual object 1406. In some embodiments, the second process is associated with second virtual content, such as a second user interface or volumetric object for a second application. In some embodiments, the second process, second virtual content, the second user interface, second volumetric object, and/or second application are different from the first process, first virtual content, the first user interface, first volumetric object, and/or first application. The virtual object, for example, is optionally a virtual soldier that the computer system translates in three dimensions in response to detecting movement input in accordance with a determination that the virtual object is moving within virtual content and/or an application boundary for the second process (e.g., second application). For example, in response to detecting a rotational input, the computer system optionally rotates the virtual object when associated with the second application, and optionally translates the virtual object (e.g., without rotating the virtual object) when associated with the first application. In this way, the computer system optionally forgoes moving the virtual object based on an object movement specification when the virtual object is not associated with virtual content and/or a process for the object movement specification.

In some embodiments, while the virtual object is moving or is to be moved in accordance with the second movement specification, the computer system detects movement input, such as movement of hand 1414 as shown from FIG. 14J to FIG. 14K. For example, the computer system detects movement of the air pinch in the first direction and by the first amount, movement of the contact across the trackpad in the first direction and by the first amount, and/or tilting of the joystick in the first direction and/or by the first amount. In some embodiments, in response to detecting the movement input, the computer system moves the virtual object in a second manner, different from the first manner, based on the second movement specification. For example, the computer system moves the virtual object in a respective second direction, different from the respective first direction, based on or the same as the first direction. Additionally or alternatively, the computer system optionally moves the virtual object by a second amount, different from the first amount, and/or based on or the same as the first amount. In this way, in response to detecting a same movement input, the computer system optionally moves the virtual object in one or more directions and/or by one or more amounts that are defined by a respective movement specification.

In some embodiments, the computer system facilitates and dragging of virtual object away from the first content corresponding to the first process and toward the virtual content corresponding to the second process, such as dragging virtual object 1408 from as shown in FIG. 14A to the position as shown in FIG. 14J. For example, before detecting input moving the virtual object away from first virtual content (e.g., application boundary associated with the first application), the computer system detects input directed to the virtual object while the virtual object is associated with the virtual content and in response, moves the virtual object in accordance with the first object movement specification described above. In some embodiments, the movement of the virtual object is dictated at least in part by the virtual content that the virtual object is associated with (e.g., dragged and dropped into the first content or dragged and dropped into the second content).

In some embodiments, the moving of the virtual object in accordance with the input element includes moving the virtual object away from first virtual content (e.g., application boundary associated with the first application) in accordance with a first portion of the movement of the input element, and moving the virtual object toward second virtual content, different from the first virtual content, in accordance with a second portion of the movement of the input element (e.g., application boundary associated with the second application). In some embodiments, the computer system detects a termination of the first selection input, and in response, moves the virtual object toward the second virtual content and/or associating the virtual object with the second virtual content (and, optionally, not the first virtual content). In some embodiments, the computer system detects respective input including a second selection input, different from the first selection input, from the input element, and movement of the input element while the second selection input is maintained. In some embodiments, in response to detecting the respective input and in accordance with a determination that a position of the virtual object corresponds to the second virtual content, the computer system moves the virtual object in a manner that is dictated by the second process, as described above. In some embodiments, the moving in the manner dictated by the second process is enabled immediately and/or automatically in response to the virtual object moving within, for example, and application boundary for the second process. In some embodiments, when moving the virtual object outside of the application boundary for the first process and outside the application boundary for the second process, the computer system moves the virtual object with a default set of behaviors not based on the first and/or second processes (e.g., movement of the virtual object in the same directions and/or by same amounts of movement of the input element).

In some embodiments, while displaying, via the one or more display generation components, the virtual object in the environment, the computer system detects, via the one or more input devices, input interacting with the virtual object, such as selection of virtual object 1408 as shown in FIG. 14A. For example, the input includes selection input directed to the virtual object (e.g., an air tap, air pinch, and/or pressing of a button on a controller). Additionally or alternatively, the input includes one or more of the inputs and/or interactions described with reference to method 1600.

In some embodiments, in response to detecting the input interacting with the virtual object, in accordance with a determination that a setting associated with the virtual object corresponds to a first value, the computer system interacts with the virtual object in accordance with the input interacting with the virtual object, such as selecting virtual object 1408 as shown in FIG. 14A, and the computer system generates, via one or more audio output devices (e.g., one or more speakers, earbuds, or headphones) that are in communication with the computer system, a first audio corresponding to the interaction with the virtual object, such as audio output 1520 corresponding to a detected object pick-up event as shown in FIG. 15A. For example, as described with reference to method 1600, the computer system optionally generates audio in accordance with a determination that a setting associated with the virtual object is configured (e.g., enabled, and/or otherwise set such that interaction with the virtual object causes the computer system to generate audio). In some embodiments, the setting is defined by a process associated with the virtual object, such as an application corresponding to the virtual object as described in detail with respect to other processes and/or applications herein. The interaction, for example, includes selecting the virtual object, moving the virtual object, modifying the virtual object, and/or otherwise interacting with the virtual object (e.g., and/or optionally does not include ceasing interaction with the virtual object).

In some embodiments, in response to detecting the input interacting with the virtual object, in accordance with a determination that the setting associated with the virtual object corresponds to a second value, different from the first value, the computer system interacts with the virtual object in accordance with the input interacting with the virtual object, such as described above with respect to virtual object 1408 and selection input as shown in FIG. 14A, and the computer system forgoes generating the first audio corresponding to the interaction with the virtual object, such as forgoing generating of the audio output 1520 as shown in FIG. 15A. For example, the computer system optionally does not generate the first audio and/or other audio that corresponds to the interaction with the virtual object.

In some embodiments, before detecting movement of the input element, the computer system displays, via the one or more display generation components, one or more system controls associated with the virtual object at a first location in the three-dimensional environment concurrently while displaying the virtual object in the environment, such as an oblong selectable option displayed below virtual object 1404 as shown in FIG. 14A, wherein the one or more system controls has a respective spatial relationship relative to the virtual object, such as the selectable option displayed parallel to the ground of three-dimensional environment 1400 and under the virtual object 1404 in FIG. 14A. For example, the computer system optionally displays one or more system controls for performing operations associated with the virtual object. In some embodiments, the one or more system controls include a “grabber,” corresponding to a selectable option that is selectable to initiate movement of the virtual object in the environment. In some embodiments, the grabber is displayed below virtual object relative to a ground in the environment, corresponding to the first location. Additionally or alternatively, the grabber is displayed along an edge of the virtual object (e.g., on a left side or a right side of the virtual object relative to the position at which the virtual object is displayed in the viewport). In some embodiments, the one or more system controls have a respective spatial relationship with respect to each other that remains fixed (at least temporarily). For example, the computer system displays an oblong grabber below the virtual object, extending parallel to the floor of the environment and/or in a plane corresponding to a front surface of the virtual object and/or a bounding box that surrounds a volumetric virtual object. In some embodiments, the one or more system controls are respectively selectable to perform one or more operations associated with the virtual object. For example, a first selectable option is optionally selectable to cease display of the virtual object and a second selectable option is optionally selectable to initiate a process to share the virtual object with a respective computer system, different from the computer system, and/or otherwise managing control of the virtual object (e.g., closing other virtual objects while maintain display of the virtual object and/or displaying one or more menus for controlling the virtual object). In some embodiments, the one or more system controls are displayed with respective first levels of visual prominence (e.g., a first level of brightness, opacity, saturation, and/or blurring effect) before the movement of the input element is detected. In some embodiments, the first spatial relationship refers to an orientation of the system controls (e.g., a distance and/or a direction) relative to the virtual object.

In some embodiments, after detecting the movement of the input element, the computer system displays, via the one or more display generation components, the one or more system controls associated with the virtual object at a second location, different from the first location, in the three-dimensional environment concurrently with displaying the virtual object in the environment, wherein the one or more system controls at the second location has the respective spatial relationship relative to the virtual object (e.g., a different location in the physical environment than where the one or more system controls were displayed before detecting movement of the input element when the virtual object was displayed at the first location in the three-dimensional environment), such as computer system 101 displaying the selectable option having the spatial relationship relative to virtual object 1404 (e.g., the same spatial relationship as shown in FIG. 14A) in a different location in three-dimensional environment 1400 than as shown in FIG. 14A based on movement of the input element directed to the selectable option and/or directed toward virtual object 1404. In some embodiments, the computer system re-displays or maintains display of the one or more system controls in response to detecting a termination of the movement of the input element and/or in accordance with a determination that the movement of the input element is less than a threshold amount (e.g., less than 0.1, 0.2, 0.3, 0.4, 0.5, 1, 2, or 5 cm). In some embodiments, at the re-displayed position (e.g., the second location), the one or more system controls including the selectable option optionally have the same spatial relationship relative to the virtual object that existed prior to detecting the movement of the input element. Additionally or alternatively, the computer system optionally maintains the spatial relationship (e.g., the first spatial relationship) between the one or more system controls and the virtual object while the movement input is ongoing. In some embodiments, the computer system ceases display of the one or more system controls including the selectable option in response to detecting the movement input. For example, in response to detecting movement input that includes movement greater than the threshold amount, the computer system ceases display of the one or more system controls including the selectable option and/or reduces the level of visual prominence of the one or more controls (e.g., the computer system displays the one or more controls with respective second levels of visual prominence, less than the respective first levels of visual prominence (e.g., with a second level of brightness less than the first level, with a second level of opacity less than the first level, with a second level of saturation less than the first level, and/or with a blurring effect greater than included in the first level of visual prominence)). In some embodiments, in response to detecting the movement input terminate and/or be less than the threshold amount over a period of time (e.g., 0.1, 0.2, 0.5, 0.75, 1, 1.5, 2, or 3 seconds), the computer system re-displays and/or increases the level of visual prominence of the one or more system controls, including the selectable option, such as back to the first respective level of visual prominences. In some embodiments, the computer system re-displays and/or increases the level of visual prominence of the one or more system controls in response to detecting input directed to the virtual object and/or a respective system control included in the one or more system controls. In some embodiments, the computer system detects input directed to a respective system control. In response to detecting the input directed to the respective system control, the computer system optionally performs one or more operations based on the selected system control. For example, the computer system optionally ceases display of the virtual object in response to detecting selection input (e.g., attention and/or an air pinch, tapping of a trackpad or non-touch sensitive surface while a focus selector is directed to the respective system control, and/or a voice command) directed to the first selectable option described above. Additionally or alternatively, the computer system optionally displays a menu for otherwise managing movement and/or display of the virtual object in accordance with a determination that the selection input is maintained for a period of time greater than the threshold period of time described above (e.g., and/or forgoes the ceasing display of the virtual object). In some embodiments, the computer system displays a menu and/or initiates sharing of the virtual object in response to detecting selection input directed to the second selectable option (e.g., an air pinch, air tap, button press, or other selection input while attention based on gaze, head direction, and/or a cursor position is directed to the second selectable option) described above.

It should be understood that the particular order in which the operations in method 1000 have been described is merely exemplary and is not intended to indicate that the described order is the only order in which the operations could be performed. One of ordinary skill in the art would recognize various ways to reorder the operations described herein. In some embodiments, aspects/operations of method 1000 may be interchanged, substituted, and/or added between these methods. For example, various object manipulation techniques and/or object movement techniques of method 1000 is optionally interchanged, substituted, and/or added between these methods. For brevity, these details are not repeated here.

FIG. 11 is a flowchart illustrating method 1100 of passing control of virtual objects to multiple input elements in accordance with some embodiments. In some embodiments, the method 1100 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1100 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1100 are, optionally, combined and/or the order of some operations is, optionally, changed.

In some embodiments, method 1100 is performed at a computer system in communication with one or more inputs devices and one or more display generation components. For example, the computer system, the one or more inputs devices, and/or the one or more display generation components have one or more characteristics similar to or the same as similar devices and/or components described with reference to methods 800, 900, 1000, 1200, and/or 1300.

In some embodiments, while displaying, via the one or more display generation components, a virtual object in a three-dimensional environment, and while the virtual object is selected by a first input element (e.g., a controller or hand that is optionally associated with a first hand of a user of the computer system such as a right hand), the computer system detects (1102), via the one or more input devices, movement of the first input element, such as virtual object 704 moving in accordance with movement of hand 714 in FIGS. 7K-7O. In some embodiments, the selection of the virtual object by the first input element is based on a selection input by the first input element (e.g., a pinch for an air pinch and drag input, a button press for a controller drag input, and/or a touch down for a touch and drag input).

In some embodiments, in response to detecting the movement of the first input element, the computer system moves (1104) the virtual object in accordance with movement of the first input element, such as virtual object 704 moving in accordance with movement of hand 714 in FIGS. 7K-7O (e.g., moving the virtual object in a direction based on a direction of movement of the first input element and/or moving the virtual object by an amount that is based on an amount of movement of the first input element). For example, as described with reference to methods 800, 900, 1000, 1200, and/or 1300, the computer system optionally detects movement of the first input element in a first direction by a first amount, and optionally moves the virtual object in a second direction based on the first direction (e.g., similar to, the same as, and/or opposing the first direction) by a second amount (e.g., similar to, the same as, and/or otherwise based upon the first amount). In some embodiments, the computer system detects movement of the first input element in a third direction by a third amount and moves the virtual object in a fourth direction based on the third direction (e.g., different from the first, second and/or third directions, and similar to or opposing the third direction) and by a fourth amount (e.g., similar to, the same as, and/or otherwise based upon the third amount).

In some embodiments, after moving the virtual object in accordance with the movement of the first input element, the computer system detects (1106), via the one or more input devices, a selection input (e.g., a pinch for an air pinch and drag input, a button press for a controller drag input, and/or a touch down for a touch and drag input) by a second input element (e.g., a controller or hand that is optionally associated with a second hand of a user of the computer system such as a left hand), different from the first input element, such as the selection input 732 performed by hand 744 in FIG. 7AF. For example, the virtual object and/or the three-dimensional environment have one or more characteristics similar to or the same as similar objects and/or three-dimensional environments described with reference to methods 800, 900, 1000, 1200, and/or 1300. In some embodiments, the computer system detects a first selection input as described with reference to methods 800, 900, 1000, 1200, and/or 1300. In some embodiments, the first selection input is an air gesture, as described with reference to methods 800, 900, 1000, 1200, and/or 1300. In some embodiments, while the first selection input is maintained, the computer system controls movement of the virtual object based on the movement of the first input element, thus providing the first selection input and/or first input element with control of the virtual object. Accordingly, it is understood that the first selection input optionally initiates selecting of the virtual object by the first input element. In some embodiments, control of a respective virtual object is maintained while a selection input satisfies one or more criteria, such as criteria that are respectively satisfied when the input element maintains an air pose included in the air gesture (e.g., an air pinch, an air pointing of one or more fingers, and/or an air curling of one or more fingers), satisfied when the one or more handoff criteria relative to another input element not controlling the virtual object are not satisfied, and/or satisfied when an input element providing the controlling input at least partially maintains an air gesture (e.g., at least a thumb and index finger maintain an air pinch gesture, optionally irrespective of the contacting of additional finger(s) with the thumb)). In some embodiments, when the selection input does not satisfy the one or more handoff criteria, the computer system ceases control of the respective virtual object based upon the input element. For example, the computer system optionally controls the virtual object in accordance with a determination that a first air pinch gesture formed by a first hand of a user of the computer system is optionally directed to (e.g., is within a threshold distance of, as described with reference to method 800) the virtual object. Additionally or alternatively, the control of the virtual object is optionally initiated in response to detecting a contact with a trackpad, a voice command, another air gesture (e.g., an air pointing and/or an air curling of finger(s)), and/or a pressing of a button and/or surface included in a pointing peripheral, such as an oblong pointing device included in the one or more input devices in communication with the computer system, and/or is optionally maintained while such an input is maintained (e.g., contact with the trackpad is maintained, a voice command terminating control is not yet detected, the other air gesture is maintained, and/or the pressing of the button and/or surface is maintained (e.g., and/or an alternative pressing terminating the control is not-yet detected)). In some embodiments, while the first input element is controlling the virtual object, the computer system moves the virtual object in accordance with movement of the first input element as described with reference to methods 900, 1000 and/or 1200. For example, the computer system optionally moves the virtual object by one or more magnitudes (e.g., distances, speeds, and/or magnitudes of acceleration) in one or more directions that are based upon (e.g., similar to, the same as, proportional to, and/or inversely proportional to) one or more magnitudes of movement of the first input element in one or more directions. Such movement optionally includes translation and/or rotation of the virtual object relative to translation and/or rotation of the input element, as described with reference to methods 900, 1000, 1200, and/or 1300. In some embodiments, while the first input element controls the virtual object, the computer system detects a second selection input, similar to but different from the first selection input. For example, the second selection input optionally includes one or more air gestures performed by a second input element (e.g., a second hand of the user, a second hardware peripheral, and/or a second finger) while the first selection input is maintained, such as while an air pinch gesture provided by the first input element is maintained, while a contact with a trackpad is ongoing (e.g., and/or is continuous from the moment that a finger contacted the trackpad to initiate the first selection input), and/or while a button on a hardware peripheral such as an oblong pointing device is directed to the virtual object.

In some embodiments, after detecting the selection input by the second input element, the computer system detects (1108) movement of the second input element, such as the movement of hand 744 in FIGS. 7AN to 7AO (e.g., a pinch for an air pinch and drag input, a button press for a controller drag input, and/or a touch down for a touch and drag input). For example, the selection input performed and/or provided by the second input element has one or more characteristics similar to or the same as described with reference to the selection input performed and/or provided by the first input element, but is optionally performed by a different hand, performed by a different controller, performed while a different button is being pressed, and/or performed by a different portion of the user's body. In some embodiments, the computer system detects movement of the second input element such as movement of the user's hand, movement of a controller, movement of a joystick, and/or some combination thereof.

In some embodiments, in response to detecting movement of the second input element, in accordance with a determination that the selection input by the second input element satisfies one or more handoff criteria for handoff of the virtual object between the first input element and the second input element, including a criterion that is satisfied when the selection input by the second input element was detected before selection of the virtual object by the first input element ended, the computer system moves (1110) the virtual object in accordance with movement of the second input element, such as the movement of virtual object 708 in FIGS. 7AN to 7AO (e.g., moving the virtual object in a direction based on a direction of movement of the second input element and/or moving the virtual object by an amount that is based on an amount of movement of the second input element). For example, without detecting one or more intervening inputs between detecting the selection input by the second input element and performing operations related to the selection input by the second input element, and when the one or more handoff criteria are satisfied, the computer system optionally passes control of the virtual object from the first input element to the second input element (as described further herein with reference to forgoing control of the movement with the first selection input and/or initiating control of the movement with the second selection input). In some embodiments, the one or more handoff criteria include respective criterion that are respectively satisfied when: the second selection input is detected while the first selection input is maintained (e.g., before the selection input by the first input element ends), the second selection input corresponds to a location within a threshold distance (e.g., 0.005, 0.01, 0.05, 0.1, 0.15, 0.25, 0.5, 0.75, 1, 1.25, or 1.5 m) of a portion of the virtual object, the second selection input includes a gesture that is similar to or the same as an air gesture included in the first selection input, and/or the second selection input is detected within a threshold amount of time (e.g., 0.005, 0.01, 0.05, 0.1, 0.15, 0.25, 0.5, 0.75, 1, 1.25, 1.5, 2, or 3 seconds) of termination of the first selection input, Handing control of the virtual object from a first input element to a second input element frees the user to use the first input element to provide additional or alternative inputs.

In some embodiments, in response to detecting the selection input by the second input element, and in accordance with the determination that the selection input by the second input element satisfies the one or more handoff criteria, the computer system initiates control of the virtual object by the second input element, such as initiation of control by hand 744 in FIG. 7AF. In some embodiments, in response to detecting the selection input by the second input element, and in accordance with the determination that the selection input by the second input element satisfies the one or more handoff criteria, the computer system optionally passes control of the virtual object from the first input element to the second input element, including initiating the control of the virtual object by the second input element, as described above. For example, as described with reference to method 1100, the computer system optionally initiates control of the virtual object by the second input element in accordance with movement input(s) provided by the second input element and/or optionally forgoes control of the virtual object in accordance with movement input(s) provided by the first input element in response to detecting the selection input by the second input element. For example, after detecting the selection input performed by the second input element that satisfies the one or more handoff criteria, the computer system optionally detects input requesting movement of the virtual object, such as movement of the first hand of the user and/or movement of a joystick of a controller in communication with the computer system. In some embodiments, in response to such input provided by the first input element, the computer system forgoes movement of the virtual object. In some embodiments, irrespective of the one or more directions and/or the amount of movement of the first input element, the computer system forgoes movement of the virtual object, even when the first input element is maintaining a selection air gesture (e.g., an air pinch, an air point, an air curling of finger(s)) and/or when the first input element has not provided a request to disable a movement mode of the virtual object, such as selection of a virtual or hardware button associated with the controller. Initiating control of the virtual object in response to the input provided by the second input element reduces user inputs required to expressly shift control of the virtual object between the input element, thereby reducing power consumption required to perform operations related to the user inputs.

In some embodiments, (optionally while detecting the selection input by the second input element and) in response to detecting the movement of the second input element, and in accordance with a determination that the selection input by the second input element does not satisfy the one or more handoff criteria, the computer system forgoes moving of the virtual object in accordance with the movement of the second input element, such as if the selection input 732 of hand 744 did not meet the selection criteria in FIG. 7AF. For example, when the selection input provided by the second input element does not satisfy the handoff criterion or criteria, the computer system optionally forgoes movement of the virtual object in response to detecting input(s) requesting movement of the virtual object. As an example, the computer system optionally detects an air gesture provided by the second hand of the user that is outside the threshold distance described with reference to method 1100 and/or an input directed to a trackpad included in a controller in communication with the computer system while a virtual cursor indicating a selection location of the controller is outside of the threshold distance from the virtual object. In some embodiments, the computer system does not move the virtual object in response to the aforementioned inputs (e.g., the air gesture and/or controller input). In some embodiments, after detecting the input does not satisfy the one or more handoff criteria, the computer system detects input requesting virtual object movement by the first input element, and in response, moves the virtual object based upon the movement of the first input element. Forgoing changing of control between input elements reduces the likelihood that the location of the virtual object is undesirably changed relative to the three-dimensional environment, thus reducing user input and thereby processing required to detect the user input associated with correcting for the undesired change of the location of the virtual object.

In some embodiments, in response to detecting the selection input by the second input element and the movement of the second input element, and in accordance with a determination that the selection input by the second input element does not satisfy the one or more handoff criteria, the computer system forgoes the moving of the virtual object in accordance with the movement of the first input element and the movement of the second input element, such as with virtual object 708 in FIG. 7AI. In some embodiments, the computer system optionally passes control of the virtual object between (e.g., from) the first input element and (e.g., to) the second input element in response to detecting the selection input that satisfies the one or more handoff criteria, including when the first input element is maintaining a selection input and/or mode of the virtual object and the input by the second input element is detected. For example, the computer system optionally detects the selection input by the second input element when the selection input element by the first input element is being maintained (e.g., while an air gesture by the first hand of the user is maintained, while button is being pressed, while contact is maintained with a trackpad, after a virtual setting enabling object movement by a controller has been enabled by a voice input or a pressing of a button and before the setting is disabled by another voice input or another pressing of the button). In such an example, the computer system optionally cedes control of the virtual object to the second input element. In particular, in response to detecting movement requested by input provided by the first input element, the computer system optionally forgoes movement of the virtual object. In some embodiments, in response to detecting the selection input by the second input element before the selection of the virtual object by the first input element ended, and in accordance with a determination that the selection input by the second input element does not satisfy the one or more handoff criteria, including a criterion (e.g., a second criterion) that is not satisfied when a duration of the selection input does not exceed a predetermined threshold, the computer system optionally foregoes movement of the virtual object in accordance with movement of the first input element and/or movement of the second input element. Thus, the computer system optionally overrides performing of the virtual object in accordance with input by the first input element because the second input element satisfied the one or more handoff criteria. In some embodiments, the computer system detects the input by the second input element that does not satisfy the one or more handoff criteria, and in response, forgoes control of the virtual object by the second input element and additionally or alternatively ceases control of the virtual object by the first input element. Shifting control of the virtual object from the first input element to the second input element reduces user input required to disable movement of the virtual object in accordance with input by the first input element, thereby reducing processing required to perform operations expressly requesting the disabling of movement by the first input element.

In some embodiments, the computer system moves the virtual object in accordance with the movement of the input element, including, in accordance with detecting movement of the input element to a first location in a physical environment, moving the virtual object in the three-dimensional environment to a second location in the three-dimensional environment, such as virtual object 708 moving from the location in FIG. 7AL to the location in FIG. 7AM in response to movement of hand 714.

In some embodiments, the computer system moves the virtual object in accordance with the movement of the input element, including, in accordance with detecting movement of the input element to a third location in the physical environment, different from the first location, moving the virtual object in the three-dimensional environment to a fourth location in the three-dimensional environment, different from the second location, such as if hand 714 moved further in FIG. 7AM and in response virtual object 708 also moved in accordance with the movement of hand 714. In some embodiments, the computer system changes a location of the virtual object in the three-dimensional environment in one or first directions and by one or more first magnitudes based upon one or more second directions and one or more second magnitudes of the moving of the respective input element in a physical environment. For example, the computer system optionally detects movement of the input element to a first location in the physical environment, and optionally moves the virtual object to a second location in the three-dimensional environment. In some embodiments, the relative displacement of the input element between the initial location and the first location in the physical environment is similar or otherwise corresponds in direction(s) and/or distance(s) to the displacement of the virtual object between the initial location and the second location in the three-dimensional environment. Additionally or alternatively, in some embodiments, in response to detecting movement of the input element to a third location (e.g., different from the first location) in the physical environment, the computer system optionally moves the virtual object to a fourth location (e.g., different from the second location) in the three-dimensional environment. Thus, it is understood that moving the virtual object in the three-dimensional environment in accordance with and/or based upon movement of an input element in the physical environment optionally includes moving the virtual object in one or more directions corresponding to one or more directions of the input element, and/or optionally includes moving the virtual object by one or more distances corresponding to one or more distances of movement of the input element (e.g., the first input element and/or the second input element). In some embodiments, the computer system is agnostic to the particular input element that moves a virtual object. For example, the computer system optionally moves the virtual object in a first direction and by a second distance in the three-dimensional environment in response to detecting either the first input element move in a second direction (e.g., different from, similar to, or the same as the first direction) by a first distance in the physical environment or in response to detecting the second input element move in the first direction by the first distance in the physical environment. Additionally or alternatively, the computer system optionally moves the virtual object in the first direction and by a third distance in the three-dimensional environment in response to detecting the first input element move in the second direction by a fourth distance in the physical environment and/or in response to detecting the second input element move in the second direction by the fourth distance in the physical environment. It is understood that the computer system's agnosticism as to an input element that provides the input is optionally contingent or based upon a determination as to whether the input element has and/or has (e.g., for over a predetermined threshold time period) control of the virtual object. For example, the virtual object moves in accordance with the movement of the first input element while the selection input provided by the first input element is maintained. Moving the virtual object by a distance and/or in a direction based upon movement of an input element in a respective direction and/or respective distance reduces the likelihood that the virtual object is moved in an undesired manner, thus reducing user input required to correct for the undesired movement of the virtual object, and thereby reducing processing required to perform operations related to the user input.

In some embodiments, the movement of the input element includes a translation component, such as movement of hand 714 in FIGS. 7AL-7AM. In some embodiments, in accordance with a determination that the translation component of the movement of the input element is a first amount of translation, the computer system moves the virtual object in the three-dimensional environment by a first distance, such as virtual object 708 moving from the location in FIG. 7AL to the location in FIG. 7AM in response to movement of hand 714. For example, the computer system optionally detects translation and/or rotation of the input element relative to the three-dimensional environment, such as along a rectangular and/or spherical coordinate system(s) defined relative to a viewpoint of a user of the computer system and/or defined relative to the three-dimensional environment. For example, the computer system optionally detects a translation component, including translation of the input element in one or more directions while an air gesture orientation is maintained relative to the three-dimensional environment. Additionally or alternatively, the computer system optionally detects a rotation component, such as a rotation of the air gesture relative to a set of mutually orthogonal axes that intersect at a location corresponding to the input center of the air gesture (e.g., the input center described with reference to at least method 900). Thus, input provided by an input element optionally comprises a translation and/or a rotation component. For example, the computer system optionally moves the virtual object by the first distance that is based upon the amount and/or distance of movement of the input element. In some embodiments, the distance of virtual object movement is different from a distance of movement of the input element, such as when the distance moved per unit distance of movement of the input element is greater than or less than one. For example, the computer system optionally moves the virtual object and/or a center of movement (“center of movement” or “movement center”) associated with the virtual object at a rate that is based upon, but is different from a rate of movement of the input element as described further at least with reference to method 900. In some embodiments, the computer system moves the virtual object by a distance that is a same as a distance of movement of the input element. For example, in response to detecting the input element move by 1, 3, or 5 cm, the computer system optionally moves the virtual object by 1, 3, or 5 cm (e.g., the virtual object movement can be by a distance that is the same as, or a multiple of the distance of input element movement). In some embodiments, moving of the respective input element includes translation in a first direction of the one or more directions. In some embodiments, moving of the virtual object relative to the three-dimensional environment includes translation in a respective first direction that is similar to, the same as, or based upon the first direction.

In some embodiments, in accordance with a determination that the translation component of the movement of the input element is a second amount of translation, different from the first amount of translation, the computer system moves the virtual object in the three-dimensional environment by a second distance, different from the first distance, such as if virtual object 708 moved further in FIG. 7AM in response to further movement of hand 714. In some embodiments, in accordance with a determination that the moving of the respective input element includes translation in a second direction, different from the first direction described herein, the computer system translates the virtual object relative to the three-dimensional environment in a respective second direction, different from the respective first direction. As an example, the computer system optionally translates the virtual object (e.g., while maintaining an orientation of the virtual object relative to the viewpoint of the user) along an axis extending normal to the viewpoint of the user and parallel to a floor of the three-dimensional environment. The translation along the axis, for example, optionally is away from the viewpoint or toward the viewpoint, based upon a determination that the input element provides input such as translation of an air pinch toward or away from the viewpoint of the user along the same axis. Additionally or alternatively, the computer system optionally moves the virtual object along the axis in response to detecting a joystick or contact on a touch-sensitive surface of a controller in a first or a second direction. Additionally or alternatively, the computer system optionally obtains an indication of the controller moving along the axis and in response, optionally moves the virtual object in accordance with the indication of the controller movement, optionally similar to or the same as described with reference to translation of the air pinch (and/or another gesture). Translating the virtual object relative to the three-dimensional environment based upon translation of the input element improves the likelihood that the virtual object is moved in keeping with the user's intent, thus reducing user input and processing associated with the user input required to correct for erroneous movement of the virtual object.

In some embodiments, the movement of the input element includes a rotational component, such as the rotation of hand 714 in FIG. 7Z, and moving the virtual object in accordance with the movement of the input element includes, in accordance with a determination that the rotational component of the movement of the input element is a first amount of rotation along a first input axis, rotating the virtual object in the three-dimensional environment by a second amount along a first object axis, such as the rotation of virtual object 708 in response to the rotation of hand 714 in FIG. 7Z.

In some embodiments, the computer system rotates the virtual object relative to the center of movement in response to detecting a rotation of the input element. For example, in response to detecting a first rotation of a hand and/or the fingers (e.g., input element) forming an air pinch gesture, and in accordance with a determination that the first rotation is a first amount of rotation, such as along and/or about a first input axis, the computer system optionally rotates the virtual object by a second amount of rotation, such as along and/or about a first object axis (e.g., corresponding to the first input axis). In some embodiments, the first object axis optionally extends through the center of movement that was closest to where the input center was located when the movement input is initiated (e.g., the air pinch, a palm of the hand, and/or one or more knuckles of the hand). In some embodiments, the rotational axis further extends through and/or tangent to a respective portion of the object. For example, the rotational axis optionally extends through a center of the virtual object and/or a prominent feature of the virtual object (e.g., the center of a face of an animal object, a largest subportion of the virtual object such as a center of a bowed portion of a gourd, and/or an application-defined point within and/or on a surface of the virtual object). In some embodiments, as described further herein, the computer system optionally rotates the virtual object in accordance with and/or based upon rotation of the air gesture relative to the three-dimensional environment. In some embodiments, the rotation of the virtual object is performed in response to detecting rotational input with the input element, such as irrespectively of whether the one or more first criteria are satisfied. For example, as described further herein, the computer system optionally defines a set of axes relative to an input center such as the intersection of fingers forming an air pinch gesture, and optionally determines rotation of the input element relative to the set of axes. In some embodiments, in response to detecting the rotation of the input element, the computer system rotates the virtual object by an amount that is similar to or the same as the rotation of the input element, and/or along an axis that is based upon the axis of rotation of the input element. For example, the axes are optionally aligned with aspects of the three-dimensional environment and/or relative to the viewpoint of the user, such as a respective first input axis parallel to the floor of the three-dimensional environment, a respective first object axis extending away from the viewpoint of the user and/or extending through a portion of the user's body forming the air gesture, a respective second input axis extending perpendicular to the floor, and the like. For example, in response to detecting 5, 10, 20, 30, or 45 degrees of rotation along one or more axes associated with the input element, the computer system optionally rotates the virtual object along one or more axes associated with the virtual object by 5, 10, 20, 30, or 45 degrees. In such an example, the axes of rotation of the input element and of the virtual object are optionally the same or different from each other. In some embodiments, the axes of rotation for the input element and the virtual object are generated based upon a reference coordinate system, such as a coordinate system mapped to the three-dimensional environment of the user.

In some embodiments, the axes are determined relative to the input element, such as the set of orthogonal axes extending through a location where several pinched fingers of a user's hand meet, and/or oriented relative to the user's hand based upon the spatial relationship between the portions of the user's hand that form the air gesture. In response to detecting the rotation of the input element, the computer system optionally the amount of rotation of the input element along one or more of the axes. In some embodiments, the computer system maps between the axes associated with the input element, and/or axes intersecting and/or associated with the virtual object. The axes, for example, optionally include a set of mutually orthogonal axes intersecting with a portion of the three-dimensional environment associated with the virtual object such as a center, an edge, and/or a location extended away from the virtual object such as a virtual handle associated with moving the virtual object. In some embodiments, computer system optionally maps the rotation along the input element axes and optionally performs rotation of the virtual object to resolve any misalignment between the input element and the virtual object axes. It is understood that additional or alternative determinations of changing of orientation are optionally made and/or are optionally detected by the computer system, and optionally are used to rotate the virtual object based upon the changing of the orientation of the input element.

In some embodiments, moving the virtual object in accordance with the movement of the input element includes, in accordance with a determination that the rotational component of the movement of the input element is a third amount of rotation along a second input axis, rotating the virtual object in the three-dimensional environment by a fourth amount along a second object axis, wherein the second input axis is different from the first input axis, and the second object axis is different from the first object axis, such as the rotation of virtual object 708 in response to a different rotation amount and about a different axis of rotation in FIG. 7CC. In some embodiments, in response to detecting the rotational component of the movement of the input element, the computer system optionally rotates the virtual object by the fourth amount, such as along and/or about the second object axis (e.g., corresponding to the second input axis), in accordance with a determination that the third amount of rotation of the rotational component of the movement of the input element is along and/or about the second input axis. In some embodiments, the second input axis is different from the first input axis, as described above. Additionally or alternatively, in some embodiments, the second object axis is different from the first object axis, as described above. For example, the computer system optionally detects that the rotational component of the input element movement includes the rotation along the second input axis and optionally performs rotation of the virtual object along the second object axis. In some embodiments, the amount of rotation along the second object axis is based upon the amount of rotation of the second input axis. In some embodiments, the third amount and/or the fourth amount have one or more characteristics similar to or the same as the first amount and/or the second amount. In some embodiments, the second input axis and/or the second object axis have one or more characteristics similar to or the same as the first input axis and/or the first object axis. In some embodiments, the rotational component of the input element includes rotation along a plurality of axes, and in such embodiments, the computer system rotates the virtual object along a plurality of axes. It is understood that the computer system optionally rotates the virtual object based upon rotation of a controller and/or a joystick included in the controller, similar to or the same as described with reference to rotation of the virtual object based upon an air gesture. Rotating the virtual object based upon rotation of the input element provides an intuitive mechanism for rotating the virtual object, thus reducing the likelihood the user rotates the virtual object in a manner that is not intended or desired, reducing the need for inputs to correct for the unintended rotation and thereby reducing processing required to perform operations related to the inputs.

In some embodiments, the one or more handoff criteria include a criterion that is satisfied when a distance between a location corresponding to the second input element is within a threshold distance of the virtual object when the second input is detected, such as the distance between hand 744 and virtual object 708 in FIG. 7AF. For example, the computer system optionally hands control of the virtual object to the second input element when the selection input by the second input element is optionally sufficiently close to the virtual object and/or a center of movement associated with the virtual object, as described with reference at least to method 900. In some embodiments, the computer system detects, obtains an indication of, and/or determines the location corresponding to the second input element. For example, the computer system optionally defines a location of an input center associated with the second input element corresponding to a position of a cursor, a position of finger(s) forming an air gesture, and/or a position offset from a portion of a body of a user performing an air gesture. In some embodiments, in response to detecting the second input element, the computer system determines whether the distance between the location of the input center and a movement center (“movement center” or “center of movement”) of the virtual object and/or the virtual object is less than or equal to a threshold distance (e.g., 0, 0.5, 1, 1.5, 2, 2.5, 3, 4, 5, 7.5, or 10 cm). In some embodiments, the threshold distance has one or more characteristics of the selection region described with reference to methods 800, 900, 1000, 1200, and/or 1300 herein. When the distance is less than and/or equal to the threshold distance, the threshold-distance related criterion is satisfied, and the computer system optionally passes control of the virtual object to the second input element. When the distance is greater than the threshold distance, the computer system optionally determines that the second input element is relatively too far away to be permitted to move the virtual object, and optionally forgoes passing of control to the second input element. In some embodiments, while the second input element is controlling movement of the virtual object, the computer system optionally detects a selection input provided by the first input element, and optionally determines whether the first input element is within the threshold distance. In response to the selection input by the first input element, the computer system optionally passes control to the first input element in accordance with a determination that the one or more handoff criteria, including the criterion related to the threshold distance between a location corresponding to the input element and the virtual object, is satisfied. Handing off the virtual object between input elements when the selecting input element is within the threshold distance of the virtual object reduces the likelihood that the selecting input erroneously changes the control of the virtual object when too far away from the virtual object, thus reducing user input required to correct for the unwanted change in control, thereby reducing power consumption required to perform operations related to the user input.

In some embodiments, in response to detecting the selection input by the second input element (and optionally before a selection input from the first input element directed to the virtual object is terminated and/or while the selection input from the first input element directed to the virtual object is ongoing), and in accordance with the determination that the selection input by the second input element satisfies the one or more handoff criteria, the computer system forgoes moving the virtual object in accordance with movement of the first input element (and/or ceasing control of the virtual object by the first input element), such as virtual object 708 no longer moving in accordance with hand 714 in FIG. 7AG. For example, as described further herein, the computer system optionally detects the selection input by the second input element while the first input element is moving the virtual object (and/or is controlling the movement of the virtual object, but is static). In response to detecting the selection input by the second input element, the computer system optionally passes control of movement of the virtual object to the second input element. For example, in some embodiments, the computer system optionally passes the control of the movement of the virtual object between (e.g., from) the first input element and (e.g., to) the second input element in response to detecting the selection input by the second input element, before detecting movement of the second input element. As part of or after passing the control of movement to the virtual object and/or before the selection input by the second input element is terminated (e.g., before an air pinch gesture is released, before contact with a button on a controller is released, and/or before a button is toggled to disable the control of movement of the virtual object), the computer system optionally forgoes movement of the virtual object in response to detecting movement of the first input element. For example, the computer system optionally detects, via the one or more input devices, movement of the first input element (e.g., while the first input element maintains a selection air gesture such as an air pinch, while a button on a controller is being pressed, and/or before an express disabling of a selection by the first input element is detected such as a pressing of a button)), and in response, optionally forgoes moving of the virtual object because the second input element is controlling the virtual object. It is understood that while the first input element is controlling the virtual object, the computer system optionally forgoes control of the virtual object by the second input element, optionally in a manner similar to or the same as described with reference to the first input element. Forgoing control of movement of the virtual object by the first input element irrespective of whether the corresponding selection input is ongoing reduces the likelihood that the user erroneously moves the virtual object based on movement of the first input element and/or provides conflicting request to move the virtual object, thus reducing the need for user inputs correcting for erroneous movement and/or lack of movement of the virtual object, thereby reducing processing required to perform operations related to the user inputs.

In some embodiments, while moving the virtual object in accordance with the movement of the first input element, the computer system controls visibility of a representation of the first input element according to a first set of display rules, and controls visibility of a representation of the second input element according to a second set of display rules, different from the first set of display rules, such as the display of hand 714 (which is controlling the virtual object 708) and the display of hand 744 (which is not controlling the virtual object 708) in FIG. 7AL. For example, the computer system optionally manages display of the representation of the input element, such as cursors, virtual reproductions of portions of the user's body, visual effects applied and that overlay physical passthrough facilitating visibility of the user's body, and/or other representations of where the user's selection input are directed to relative to the three-dimensional environment using one or more displays rules. For example, in some embodiments, the display rules dictate the visual appearance of the visual representation, such as the level of opacity, the radius and/or intensity of a blurring effect, and/or a level of saturation with which the representation (and/or portions of the representation) are displayed. In some embodiments, the display rules dictate the manner in which the computer system resolves simulated depth conflicts. For example, in some embodiments, simulated depth conflicts optionally include instances in which one or more portions of the virtual object appear hidden or otherwise obscured behind one or more portions of the representation of the input element, or vice-versa as viewed from the perspective of the user in the three-dimensional environment. In some embodiments, in the example of simulated depth conflicts, when the computer system detects that the virtual object and the portion of the input element (e.g., hand of the user) are in spatial conflict (e.g., occupy the same area in the three-dimensional environment from the viewpoint of the user), the computer system displays whichever of the input element and the virtual object are closer to the viewpoint of the user, while obscuring the other. For instance, in the example of the hand of user as the input element, while the virtual object is subject to the control of the hand of the user, if the computer system detects that the hand is behind the virtual object while it has grabbed the object (e.g., from the viewpoint of the user), the computer system displays the virtual object while obscuring the hand of the user (e.g., not displaying the hand of the user. In some embodiments, the second set of display rules for the second input element that is not controlling movement of the virtual is different than the first set of display rules that are applied to the input element that is controlling movement of the virtual object. For instance, in some embodiments, the second input element is always displayed regardless of whether one or more virtual objects are in spatial conflict with the second input element (from the viewpoint of the user) and regardless of whether the second input element is further away or closer to the viewpoint of the user, when there is a spatial conflict.

In some embodiments, in response to detecting the selection input by the second input element that satisfies the one or more handoff criteria, the computer system changes display rules by which the visibility of the representation of the first input element or the representation of the second input element is controlled, such as the displaying of hand 714 (which is no longer controlling virtual object 708) and the displaying of hand 744 (which is now controlling virtual object 708) in FIG. 7AN. In some embodiments, the computer system changes the set of display rules that are applied to the representation of the input element in response to detecting that the input element passes control of the movement of the virtual object to another input element, and/or that the input element inherits control of the movement of the virtual object. For example, the computer system optionally decreases a level of opacity of a portion of the virtual object that presented a simulated depth conflict prior to detecting the selection input. Additionally or alternatively, the computer system optionally increases a level of opacity of portions of the virtual object that presented with the simulated depth conflict with another representation of another input element before the selection input was detected. In some embodiments, the “changed” display rules have one or more characteristics similar to or the same as one or more characteristics of displaying representation of input elements and/or virtual objects described with reference to method 800. In some embodiments, while the virtual object is selected by a respective first input element (e.g., the first and/or second input element), and the computer system displays, via the one or more display generation components, a portion of a respective first representation of the respective first input element with a visual appearance corresponding to a first visual appearance in accordance with the one or more first rules. In some embodiments, in response to detecting, via the one or more input devices, the selection input by a respective second input element (e.g., the second and/or first input element), and in accordance with the determination that the selection input by the respective second input element satisfies the one or more handoff criteria, the computer system changes the visual appearance of a representation of the respective first input element to correspond to a first updated visual appearance in accordance with the one or more second rules, different from the one or more first rules. Displaying the representation of the input element in accordance with different sets of display rules reduces movement of the input element required to resolve simulated depth conflict, thereby improving efficiency of human-computer interactions.

In some embodiments, changing display rules by which the visibility of the representation of the first input element or the representation of the second input element is controlled includes changing display rules by which the visibility of the representation of the first input element is controlled, such as the change of the display of hand 714 from FIG. 7AM to FIG. 7AN. For example, the computer system optionally displays the representation of the first input element and/or the second input element in accordance with the one or more display rules described further herein. In some embodiments, while the first input element (or the second input element) is controlling the virtual object, the computer system detects the selection input and/or determines that the one or more handoff criteria are satisfied, and changes the display rules applied to the first input element (and/or the second input element), by which the visibility of the representation of the first input element and/or the representation of the second input element is controlled. For example, in some embodiments, changing the display rules by which the visibility of the representation of the first input element is controlled optionally includes initially controlling visibility of the representation of the first input element according to the first set of display rules, and subsequently, such as in response to detecting the selection input by the second input element and/or determining that the one or more handoff criteria are satisfied, controlling visibility of the representation of the first input element according to the second set of display rules that were being applied to the second input element when it was not controlling the movement of the virtual object. As another example, the computer system optionally changes a rule dictating the visual appearance of one or more portions of the representation of the first input element, such as a rule dictating whether the representation of the input element is displayed “in front of” or “behind” one or more portions of the virtual object. At times, such a rule is referred to as a depth sorting rule. In some embodiments, the input element(s) that are not controlling the movement of the virtual object are displayed appearing as though in front of the virtual object, independently of the simulated depth of the virtual object and/or a location of the input element relative to the three-dimensional environment and/or the viewpoint of the user. For example, the representation of the input element is optionally one or more images and/or reproductions of the hand of the user. In accordance with the depth sorting rule, the computer system optionally changes display of one or more portions of the virtual object that virtually obscure the representation of the hand, optionally including changing level of opacity of the one or more portions of the virtual object, such as ceasing display of the one or more portions and/or reducing the level of opacity of the one or more portions. In some embodiments, displaying the representation of the first input element according to the first set of display rules comprises displaying the representation of the first input element with a first visual characteristic, and wherein displaying the representation of the first input element according to the second set of display rules comprises displaying the representation of the first input element with a second visual characteristic, different from the first visual characteristic. Changing the display rules for the first input element when the second input element selects the virtual object improve user awareness about a spatial relationship between the first input element and the virtual object, thus reducing movement of the input element required to improve such awareness, and thereby improving efficiency of interaction with the computer system.

In some embodiments, changing display rules by which the visibility of the representation of the first input element or the representation of the second input element is controlled includes changing display rules by which the visibility of the representation of the second input element is controlled, such as the change of the display of hand 744 from FIG. 7AM to FIG. 7AN. For example, the computer system optionally displays the representation of the first input element and/or the second input element in accordance with the one or more display rules described further herein. In some embodiments, while the first input element is controlling the virtual object, the computer system detects the selection input and/or determines that the one or more handoff criteria are satisfied so as to transfer control of the virtual object to the second input element. In response to detecting the handoff (e.g., change in control from the first element to the second element), the computer system changes the display rules applied to the second input element (and/or the first input element), by which the visibility of the representation of the second input element is controlled. For example, in some embodiments, changing the display rules by which the visibility of the representation of the second input element is controlled optionally includes initially controlling visibility of the representation of the second input element according to the second set of display rules, and subsequently, such as in response to detecting the selection input by the second input element and/or determining that the one or more handoff criteria are satisfied, controlling visibility of the representation of the second input element according to the first set of display rules. Alternatively, in some embodiments, the computer system goes from displaying the second input element according to the second set of display rules, to a third set of display rules that are different from the second set of display rules and the first set of display rules. In some embodiments, as described with reference to the one or more display rules herein, the computer system optionally changes the visual appearance of the second input element that provides the selection input and/or assumes control of movement of the virtual object. In some embodiments, the change in visual appearance includes displaying a visual characteristic of the virtual object with an updated value, such as increasing the level of opacity of a portion of the virtual object that presents a simulated depth conflict with the representation of the input element. In some embodiments, the change includes reducing a level of opacity of a portion of the representation of the input element that presents the simulated depth conflict with the portion of the virtual object, such as ceasing display of a cursor, and/or displaying the virtual object overlaying a representation of the user's hand. In some embodiments, displaying the representation of the second input element according to the first set of display rules comprises displaying the representation of the second input element with a first visual characteristic, and displaying the representation of the first input element according to the second set of display rules comprises displaying the representation of the second input element with a second visual characteristic, different from the first visual characteristic. Changing the display rules for the second input element reduces user input required to view and/or interact with the virtual object, thereby reducing processing required to perform operations related to the user input.

In some embodiments, the first set of display rules and the second set of display rules include one or more display rules by which to control a level of visual prominence of the representation of the first input element relative to a level of visual prominence of the virtual object and a level of visual prominence of the representation of the second input element relative to the level of visual prominence of the virtual object, such as illustrated by the display of hand 714 and hand 744 in FIG. 7AN. In some embodiments, the first set of display rules and/or the second set of display rules include one or more display rules by which to control a level of visual prominence of the representation of the first input element, the representation of the second input element, the virtual object, and/or one or more objects and/or representations located in proximity with the representation of the first input element relative to one another, the representation of the second input element, and/or the virtual object. In some embodiments, the first set of display rules and/or the second set of display rules include one or more display rules by which to control the level of visual prominence of the representation of the first input element relative to the level of visual prominence of the virtual object, such as to increase (or decrease) visibility of the representation of the first input element relative to the visibility of the virtual object. For example, in some embodiments, in accordance with a determination that the first input element is controlling the virtual object, and in accordance with a determination that the first input element is behind the virtual object relative to the virtual object as viewed from the perspective of the user, the computer system controls the level of visual prominence of the representation of the first input element relative to the level of visual prominence of the virtual object to decrease the visibility the representation of the first input so that the virtual object obscures the representation of the first input element according to one or more depth sorting rules. In some embodiments, changing the visual prominence of a first portion of the virtual object relative to a background and/or one or more objects (e.g., one or more object located in proximity with the virtual object) in the three-dimensional environment and/or of a first portion of a representation of an input element (e.g., the representation of the first input element and/or the representation of the second input element) includes increasing transparency of the portion, decreasing brightness, contrast, and/or color saturation of the portion, changing a size and/or scale of the portion, changing a position and/or depth of the portion, and/or increasing a magnitude and/or size of an effect (e.g., of an applied animation such as movement and/or a blur effect) applied to the portion. Additionally or alternatively, in some embodiments, changing the visual prominence of a first portion of the virtual object relative to a background and/or one or more objects in proximity with the virtual object in the three-dimensional environment includes increasing transparency of the one or more objects, decreasing brightness, contrast, and/or color saturation of the one or more objects, changing a size and/or scale of the one or more objects, changing a position and/or depth of the one or more objects, and/or increasing a magnitude and/or size of an effect (e.g., of an applied animation such as movement and/or a blur effect) applied to the one or more objects. In some embodiments, the display rules relate to which of the representation of the input element or the virtual object are displayed when a depth conflict exists, as described further herein. In some embodiments, the computer system ensures that the hand of the user is visible in the three-dimensional environment based on the location of the hands with respect to content in the three-dimensional environment. For example, when the virtual object is between the virtual object and the current viewpoint, to ensure that the hands are visible, the computer system reduces the visual prominence of the virtual object (or some portion thereof) corresponding to the location of the hands, such that the hands are visible to the user of the computer system (e.g., from the current viewpoint of the user). In some embodiments, controlling visual prominence (e.g., including changing the visual prominence of a virtual object and/or representation of an input element) includes one or more of controlling a shape, feather treatments, brightness, opacity, matting, color, and the like. In some embodiments, controlling visual prominence includes changing the level of visual prominence, including changing a size of region, changing the spatial profile, changing a feathering radius, changing a brightness level, an opacity level, includes changing a matting region, and/or includes changing between contrast and/or colors. For example, in some embodiments, the computer system controls visual prominence of the virtual object and/or the representation of the input element, and the like. Displaying the virtual object and/or a representation of the input element in accordance with rules associated with a level of visual prominence indicates which input element is controlling movement of the virtual object and/or preserves visibility of the input element and/or the virtual object, thus reducing user input required to cause display and/or visibility of the input element and/or the virtual object, thereby reducing processing required to perform operations related to the user input.

In some embodiments, controlling the visibility of the representation of the first input element according to the first set of display rules includes presenting the representation of the first input element according to a first set of visual prominence rules that control a visual prominence of an input element (optionally relative to the virtual object) when the input element is in control of movement of the virtual object, such as the display of hand 714 in FIG. 7AM while hand 714 controls virtual object 708.

In some embodiments, controlling the visibility of the representation of the second input element according to the second set of display rules includes presenting the representation of the second input element according to a second set of visual prominence rules, different from the first set of visual prominence rules, that control a visual prominence of the input element (optionally relative to the virtual object) when the input element is not in control of the movement of the virtual object, such as the display of hand 744 in FIG. 7AM while hand 744 is not controlling virtual object 708. For example, in some embodiments, presenting the representation of a portion of the first input element refers to either actively displaying a representation of, or otherwise making visible, the first input element. Additionally or alternatively, in some embodiments, the representation of the portion of the first input element is actively displayed by the computer system, or is passively visible via the one or more display generation components of the computer system.

In some embodiments, the first set of visual prominence rules include display rules that control the visual prominence of a representation of an input element (e.g., the first input element when the first input element is in control of movement of a virtual object), including controlling the visual prominence of one or more portions of the representation of the input element. Additionally or alternatively, in some embodiments, the first set of visual prominence rules include display rules that control the visual prominence of a virtual object, including controlling the visual prominence of one or more portions of the virtual object. Additionally or alternatively, in some embodiments, the second set of visual prominence rules include display rules that control the visual prominence of a representation of an input element (e.g., the second input element when the second input element is not in control of the movement of the virtual object), including controlling the visual prominence of one or more portions of the representation of the input element.

In some embodiments, the computer system controls (e.g., increases or decreases) the visibility of the representation of the input element relative to the visibility of the virtual object when the input element is in control of movement of the virtual object (e.g., when the first input element is in control of movement of the virtual object) and/or when the input element is not in control of movement of the virtual object (e.g., when the second input element is not in control of movement of the virtual object while the first input element is in control of movement of the virtual object). For example, as described further herein, the computer system optionally applies the first set of displays rules (e.g., a first set of one or more display rules), including a first set of visual prominence rules, to the first input element, when the first input element is controlling (e.g., the movement of) the virtual object. Additionally or alternatively, the computer system optionally applies the second set of display rules (e.g., a second set of one or more display rules), including a second set of visual prominence rules, to the second input element, when the second input element is not controlling (e.g., the movement of) the virtual object. As described further herein, in some embodiments, the computer system optionally changes the display rules for either or both of the input elements (e.g., the first input element and/or the second input element) in response to detecting a selection input corresponding to a command to control the movement of the virtual object. Additionally or alternatively, in some embodiments, the computer system optionally changes the display rules for either or both of the input elements (e.g., the first input element and/or the second input element) in response to detecting a selection input that passes control from the first input element to the second input element, or vice-versa.

In some embodiments, while displaying, via the one or more display generation components, the virtual object in the three-dimensional environment, and in response to detecting a change of control of the virtual object from the first input element to the second input element, the computer system displays, via the one or more display generation components, a portion of a respective second representation of a respective second input element accordance with one or more third rules, different from the second rules. In some embodiments, the one or more first rules are the same as the one or more third rules. Alternatively, the one or more third rules are different from the one or more first rules that are used for the first input element when the first input element is controlling movement of the virtual object. Displaying the virtual object and/or a representation of the input element in accordance with rules associated with a level of visual prominence indicates which input element is controlling movement of the virtual object, thus reducing user input erroneously provided by a non-controlling input element, thereby reducing processing required to perform operations related to the user input.

In some embodiments, the computer system presents the representation of the first input element according to the first set of visual prominence rules. In some embodiments, in accordance with a determination that at least a portion of the virtual object presents a simulated depth conflict with at least a portion of the representation of the first input element relative to a viewpoint of the user, and that the portion of the virtual object is closer to the viewpoint than at least a portion of the representation of first input element, the computer system displays the portion of the virtual object with a first level of visual prominence, and displays the portion of the first representation of the first input element with a second level of visual prominence, less than the first level of visual prominence, such as the level of visual prominence of virtual object 708 relative to hand 714 in FIG. 7AM. In some embodiments, the simulated depth conflicts share one or more characteristics with the simulated depth conflicts described herein. In some embodiments, displaying the portion of the virtual object with a first level of visual prominence, and displaying the portion of the first representation of the first input element with a second level of visual prominence, less than the first level of visual prominence, shares one or more characteristics with controlling the visibility of the representation of the first input element according to the first set of display rules and controlling the visibility of the representation of the second input element according to the second set of display rules (e.g., while moving the virtual object in accordance with the movement of the first input element), as described herein.

Additionally or alternatively, in some embodiments, displaying the portion of the virtual object with a first level of visual prominence, and displaying the portion of the first representation of the first input element with a second level of visual prominence shares one or more characteristics with displaying the visual representation of the input element according to depth sorting rules, as described with respect to method 800. For example, in some embodiments, displaying the portion of the virtual object with a first level of visual prominence, and displaying the portion of the first representation of the first input element with a second level of visual prominence, less than the first level of visual prominence, includes changing a rule dictating the visual appearance of one or more portions of the representation of the first input element, (e.g., as in changing a rule dictating whether the representation of the input element is displayed “in front of” or “behind” one or more portions of the virtual object), according to one or more depth sorting rules, as described herein. In some embodiments, the computer system determines that the simulated depth conflict exists in accordance with a determination that input element and the virtual object are coincident within the field of view of the user (e.g., the input element and virtual object occupy the same area, but not the same volume within the three-dimensional environment). In some embodiments, in accordance with a determination that at least a portion of the virtual object presents a simulated depth conflict with at least a portion of the representation of the first input element relative to the viewpoint of the user, and that the portion of the first input element is closer to the viewpoint than the portion of the representation of the virtual object, the computer system displays the at least a portion of the first representation of the first input element with a third level of visual prominence, greater than the first level. Displaying the virtual object and the representation of the input element with respective level of visual prominences based upon the display rules improves visibility of and/or an ability to interact with the virtual object while the input element moves the virtual object, thereby improving user interaction efficiency by reducing input required to move the input element resolving obscuring of the virtual object.

In some embodiments, the second set of visual prominence rules includes presenting the representation of the second input element with a third level of visual prominence, such as the level of visual prominence of hand 744 in FIG. 7AM. In some embodiments, the computer system displays the representation of the second input element with the third level of visual prominence, regardless of whether there is a simulated depth conflict with the virtual object and regardless of whether the input element is closer or further from the viewpoint of the user than the virtual object. In some embodiments, the simulated depth conflicts share one or more characteristics with the simulated depth conflicts described herein and/or described with respect to method 800. In some embodiments, the computer system optionally detects movement of the second input element before the selection input by the second input element (e.g., as described with reference to method 1100) is detected. In some embodiments, independently of whether the movement of the second input element moves in front of, behind, and/or overlapping with the virtual object, the computer system maintains display of the representation of the second input element. For example, the computer system optionally reduces the level of visual prominence of the at least portion of the virtual object such that the representation second input element optionally remains visible to the user, mimicking the appearance of the representation of the second input remaining in front of the virtual object. For example, in accordance with a determination that at least a portion of the virtual object presents a simulated depth conflict with at least a portion of the representation of the second input element relative to a viewpoint of the user, and that the at least portion is closer to the viewpoint than an at least a portion of the representation of first input element, the computer system optionally displays the at least a portion of the virtual object with a first level of visual prominence, and optionally displays the at least a portion of the first representation of the respective first input element with a second level of visual prominence, greater than the first level of visual prominence. Displaying the representation of the input element a level of visual prominence that is greater than a level of visual prominence of the portion of the virtual object that presents a simulated depth conflict reduces movement of the input element required to view and/or interact with the virtual object, thus improving the likelihood that the user is able to move the virtual object relative to a desired movement center, thereby reducing user input and associated processing required to correct for undesired movement of the virtual object.

In some embodiments, while moving the virtual object in accordance with the movement of the first input element, a first center of movement associated with the virtual object is at a first location in the three-dimensional environment corresponding to a first input center associated with the first input element, such as the center of movement associated with virtual object 708 moving from 736-2 in FIG. AE. For example, the computer system optionally moves the virtual object relative to a center of movement and/or an input center, described further with reference to method 900. In some embodiments, the computer system moves the virtual object in a manner to reduce a distance between the center of movement and the input center, such as away from the first location.

In some embodiments, in response to detecting the selection input by the second input element that satisfies the one or more handoff criteria in accordance with the movement of the second input element, the computer system moves a second center of movement associated with the virtual object toward (and/or to) a second location in the three-dimensional environment corresponding to a second input center associated with the second input element (e.g., that is different from the first input center associated with the first input element), such as the center of movement associated with virtual object 708 moving to 742 in FIG. 7AF from its location in FIG. 7AE in response to the shift of control of the virtual object 708 from hand 714 to hand 744 in FIG. 7AF. In some embodiments, the moving of the virtual object in accordance with the movement of the first input element includes moving the virtual object relative to a first input center associated with the first input element as the first input element moves, and the moving of the virtual object in accordance with the movement of the second input element includes moving the virtual object relative to a second input center associated with the second input element as the second input element moves (e.g., as described with reference to method 900). In some embodiments, moving the virtual object relative to the input center (e.g., first input center or the second input center) associated with the input element (e.g., the first input element or the second input element) as the input element moves includes moving, locating, and otherwise associating a position of the center of movement (e.g., including a first center of movement and/or a second center of movement) of the virtual object with a location (e.g., a first location or a second location) in the three-dimensional environment corresponding to the input center (e.g., a first location corresponding to the first input center or a second location corresponding to the second input center) associated with the input element. For example, in some embodiments, the center of movement of the virtual object shares one or more characteristics with the center of movement described with reference to method 1200. In some embodiments, after associating the position of the center of movement of the virtual object with a location in the three-dimensional environment corresponding to an input center associated with an input element, such as in associating the position of the center of movement of the virtual object with a first location corresponding to a first input center associated with a first input element, and in response to detecting a selection input by a second input element (e.g., that satisfies the one or more handoff criteria in accordance with the movement of the second input element), the computer system optionally moves the center of movement (e.g., including the first center of movement and/or a second center of movement) of the virtual object from the first location (e.g., a current, previous, or otherwise pre-existing location with which the center of movement is associated) based on or in accordance with the movement of the second input element. In some embodiments, the computer system moves the center of movement of the virtual object to a second location in the three-dimensional environment in accordance with a measure of the movement of the second input element. For example, in some embodiments, after detecting the selection input by the second input element, and in accordance with the movement of the second input element (e.g., including movement of the second input element detected subsequent to detecting the selection input by the second input element), the computer system optionally moves the center of movement of the virtual object to a second location (e.g., and from the first location) located in the three-dimensional environment corresponding to the input center (e.g., a second input center) associated with the input element (e.g., the first input element or the second input element). As described with reference to method 900, the computer system optionally does not move the virtual object toward the second input center associated with the second input element, at least until the computer system optionally detects the selection input by the second input element that satisfies the one or more handoff criteria, such as described with reference to method 1100. In some embodiments, the computer system optionally instantaneously moves the virtual object from corresponding to the input center associated with the first input element, to corresponding to the input center corresponding to the second input element when control of the virtual object is shifted from the first input element to the second input element. Moving the virtual object in accordance with movement of the first input element or in accordance with movement of the second input element reduces the likelihood that the virtual object is moved based upon movement of two input elements concurrently, thus reducing the likelihood that the virtual object is moved erroneously relative to the three-dimensional environment based upon concurrent movement requests, and thereby reducing processing required to perform the erroneous movement.

In some embodiments, the computer system moves the center of movement associated with the virtual object toward (and/or to) the second location in the three-dimensional environment corresponding to the input center associated with the second input element gradually, such as in accordance with the movement (e.g., in accordance with detected movement) of the second input element, such as if the movement of the center of movement to 743 from 736-2 were gradual from FIG. 7AE to FIG. 7AF. In some embodiments, the moving of the virtual object relative to the second input center includes moving the virtual object relative to the second input center in a manner that is selected to reduce a distance between a first center of movement associated with the virtual object and the second input center, as described with reference to method 900. Moving the virtual object gradually toward the input center reduces additional user input otherwise required to cause convergence between the center of movement and the input center, thereby inefficiencies incurred by requiring the separate user input to affect the movement of the virtual object toward the input center.

In some embodiments, the first center of movement associated with the virtual object is different than the second center of movement associated with the virtual object, such as center of movement 743 being different from center of movement 736-2 in FIGS. 7AE-7AF. In some embodiments, the moving of the virtual object relative to the first input center includes moving the virtual object relative to the first input center in a manner that is selected to reduce a distance between a second center of movement associated with the virtual object, different from the first center of movement, and the first input center, as described with reference to method 900. Thus, the computer system optionally moves the virtual object relative to a center of movement and/or an input center associated with where a corresponding selection input is directed to. Moving the virtual object toward different input centers associated with respective input elements reduces the distance that the virtual object has to move due to the movement of the virtual object decreasing the distance toward whichever input element is controlling the movement of the virtual object, as opposed to moving toward an input center that is not controlling the movement of the virtual object.

In some embodiments, in response to detecting the first selection input, and in accordance with a determination that a location of the first input element relative to the virtual object corresponds to a first portion of the virtual object, the first center of movement associated with the virtual object corresponds to a first location relative to the virtual object, such as the location of center of movement 736-2 in FIG. 7AE. For example, as described with reference to method 1200, the computer system optionally moves the virtual object relative to a center of movement that is selected as corresponding to a location of an input element that provides the selection input. Thus, the center of movement optionally corresponds to a first center of movement when the selection input by the first element is at the first location (e.g., closer to the first center of movement than any other center of movement associated with the virtual object, and/or a first center of movement corresponding to a selection region that the input element is located when the selection input is detected).

In some embodiments, in accordance with a determination that the location of the first input element relative to the virtual object corresponds to a second portion of the virtual object, different from the first portion of the virtual object, the first center of movement associated with the virtual object corresponds to a second location relative to the virtual object, different from the first location, such as the location of center of movement of 743 in FIG. 7AF. For example, the center of movement optionally corresponds to a second center of movement, different from the first center of movement, when the selection input by the first element is at the second location (e.g., closer to the second center of movement than any other center of movement associated with the virtual object). Accordingly, in response to detecting subsequent movement of the selection input in response to and/or after the selection input by the first input element is detected, the computer system optionally moves the virtual object relative to the selected center of movement and/or the input center of the first input center. It is understood that the movement of the virtual object relative to selection input by the second input element is optionally similar to or the same as described with reference to the first input element. For example, in some embodiments, selection of the second center of movement of the virtual object by the second input element optionally shares one or more characteristics with the selection of the first center of movement of the virtual object by the first input element, as described herein. Thus, the computer system optionally moves the virtual object to decrease the distance between an input center of an input element while the input element controls the virtual object, and between a particular center of movement associated with the virtual object (e.g., the nearest center of movement, or the center of movement corresponding to the region of the three-dimensional environment that the input element occupies and/or is associated with a particular center of movement). Moving the virtual object relative to a particular center of movement reduces the amount of movement of the virtual object required to cause the center of movement to correspond to the input center, thereby reducing processing required to display needless movement.

In some embodiments, in response to detecting the selection input by the second input element, in accordance with the determination that the selection input by the second input element satisfies the one or more handoff criteria for handoff of the virtual object between the first input element and the second input element, such as input by hand 714 as shown in FIG. 7AN, the computer system generates, via one or more output devices (e.g., one or more speakers, earbuds, and/or headphones) that are in communication with the computer system, first audio feedback corresponding to handoff of the virtual object between the first input element and the second input element, such as audio output 1520d as shown in FIG. 15B. For example, the computer system optionally generates audio indicating that the one or more handoff criteria were satisfied. In this way, the computer system optionally generates the first audio to indicate that the handoff of movement of the virtual object from the first input element to the second input element is successful and/or completed. In some embodiments, the first audio has one or more characteristics similar to or the same as audio described with reference to method 1600. For example, the first audio optionally includes first one or more tones optionally generated concurrently and/or in succession. In some embodiments, the first audio includes audio characteristics, such as a level of bass, midrange, and/or treble frequency ranges, a sound effect included in the first audio, and/or a direction of playback of the first audio (e.g., forwards or backwards).

In some embodiments, in response to detecting the selection input by the second input element, in accordance with a determination that the selection input by the second input element does not satisfy the one or more handoff criteria for handoff, the computer system generates, via one or more output devices (e.g., one or more speakers, earbuds, and/or headphones) that are in communication with the computer system, second audio feedback, different from the first audio feedback, such as audio feedback that is different from audio output 1520 as shown in FIG. 15B. For example, the computer system optionally generates audio indicating that the one or more handoff criteria were not satisfied. In this way, the computer system optionally generates the second audio, different from the first audio, to indicate that the handoff of movement of the virtual object from the first input element to the second input element is not successfully completed. In some embodiments, the second audio has one or more characteristics similar to or the same as audio described with reference to method 1600. In some embodiments, the computer system detects selection input by the second input element while the first input element is not controlling the virtual object, and in response, generates the second audio.

In some embodiments, the computer system does not generate the second audio indicating that the one or more handoff criteria are not satisfied, such as forgoing generating audio output 1520d from FIG. 15B. For example, the computer system optionally generates the first audio in response to detecting the selection input by the second input element that satisfies the one or more handoff criteria, but optionally does not generate the second audio in response to detecting selection input by the second input element that does not satisfy the one or more handoff criteria. In this way, the computer system optionally generates audio for successful handoff between the first input and second input element, and optionally does not generate audio for unsuccessful handoff between the first and the second input element. Additionally or alternatively, the computer system optionally generates the second audio in response to detecting selection input by the first input element cease without detecting selection input by the second input element. In some embodiments, the sequence of the one or more tones is unique to the first and the second audio, respectively. For example, the generating the first audio optionally includes generating first tones in a first ordered sequence, and generating the second audio optionally includes generating the first tones in a second ordered sequence that differs from the first ordered sequence. Additionally or alternatively, the second audio optionally includes different tones than the tones included in the first audio. In some embodiments, the audio characteristics of the second audio differ from audio characteristics of the first audio. For example, the first audio and the second audio optionally include different respective levels of bass, midrange, and/or treble frequency ranges, sound effects, and/or directions of playback of audio (e.g., the first audio corresponds to playing audio forwards and the second audio correspond to playing the same audio backwards). Generating the first or the second audio based on the satisfaction or lack of satisfaction of the one or more handoff criteria indicates whether the second input element is controlling movement of the virtual object, thus reducing inputs erroneously attempting to re-select and/or move the virtual object that the user potentially provides if the controlling input element is not made clear based on the audio feedback, thereby reducing processing required to perform operations based on the erroneous inputs.

It should be understood that the particular order in which the operations in method 1100 have been described is merely exemplary and is not intended to indicate that the described order is the only order in which the operations could be performed. One of ordinary skill in the art would recognize various ways to reorder the operations described herein. In some embodiments, aspects/operations of method 1100 may be interchanged, substituted, and/or added between these methods. For example, various object manipulation techniques and/or object movement techniques of method 1100 is optionally interchanged, substituted, and/or added between these methods. For brevity, these details are not repeated here.

FIG. 12 is a flow chart illustrating method 1200 of implementing selection regions for a virtual object in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at a computer system in communication with one or more inputs devices and one or more display generation components. The computer system optionally shares one or more characteristics of the computer systems described with reference to methods 800, 900, 1000, 1100, and/or 1300. The display generation component optionally shares one or more characteristics of the display generation component described with reference to methods 800, 900, 1000, 1100, and/or 1300. The one or more input devices optionally share one or more characteristics of the input devices described with reference to methods 800, 900, 1000, 1100, and/or 1300.

In some embodiments, while displaying, via the one or more display generation components, a virtual object in a three-dimensional environment, the computer system detects (1202), via the one or more input devices (e.g., one or more remote body tracking devices such as cameras, motion sensors, proximity sensors or depth sensors), a selection input (e.g., an object selection input) directed to the virtual object, such as the selection input performed by hand 714 in FIG. 7I. In some embodiments, the computer system displays a virtual object in a three-dimensional environment. The three-dimensional environment optionally shares one or more characteristics of the three-dimensional environment described with reference to methods 800, 900, 1000, 1100, and/or 1300. The virtual object optionally shares one or more characteristics of the virtual object described with reference to methods 800, 900, 1000, 1100, and/or 1300. In some embodiments, the input shares one or more characteristics of the input described with reference to methods 800, 900, 1000, 1100, and/or 1300. Additionally or alternatively, in some embodiments, the input includes, but is not limited to, a selection input. In some embodiments, the selection input includes input indicating selection of a virtual object from a plurality of virtual objects in the three-dimensional environment. For example, in some embodiments, the computer system detects the selection input in connection with a virtual object from the plurality of virtual objects while displaying the plurality of virtual objects in the three-dimensional environment.

In some embodiments, the selection input includes one or more air gestures corresponding to a selection gesture, grabbing gesture (e.g., hand grab gesture), a grasping gesture, or the like (“selection gesture” or “grabbing gesture”), such as the air pinch performed by hand 714 in FIG. 7I. In some embodiments, detecting the selection input includes detecting a predetermined sequence of movements associated with the user's hands, including one or more movements in which the user extends an open hand towards an object, and closes or retracts one or more fingers of the user's hand around the object from an initially extended position (e.g., in which the user's fingers were initially extended). For example, in some embodiments, the selection input includes, but is not limited to, movement relative to a position of a virtual object in the three-dimensional environment. In some embodiments, detecting the selection input includes detecting movement of the selection input, including movement of an input element of the selection input after the initial selection of the virtual object. In some embodiments, the input element shares one or more characteristics of the input described with reference to methods 800, 900, 1000, 1100, and/or 1300. In some embodiments, an input element of the selection input refers to an object by which inputs are detected, received at, or otherwise input to the computer system. For example, in some embodiments, an input element of the selection input includes a hand or other portion of the user. In some embodiments, using the example of the hand as an input element, the computer system detects and tracks a location of the hand in the three-dimensional environment. In some embodiments, moving the virtual object shares one or more characteristics of the movement of the virtual object such as described with respect to 800, 900, 1000, 1100, and/or 1300. In some embodiments, the computer system performs one or more operations directed to the first virtual object after detecting the selection input in connection with the virtual object, and in connection with one or more inputs received after detecting the selection input. For example, in some embodiments, the computer system performs one or more operations directed to the first virtual object in response to inputs received by an input element. In some embodiments, the one or more operations directed to the first virtual object include moving the first virtual object. For example, moving the virtual object optionally includes moving the virtual object based on movement of the input element, including translating the virtual object, rotating the virtual object, and/or translating and rotating the virtual object.

Additionally or alternatively, in some embodiments, the selection input includes controller input received at the computer system from one or more input devices such as if instead of detecting a hand gesture, the computer system detected a selection input being performed on a controller that is communicative coupled to the computer system. For example, in some embodiments, the one or more input devices include one or more hardware controllers (e.g., gamepad), one or more pointing devices (e.g., mouse), one or more touch interfaces (e.g., trackpad, touchpad, or touchscreen), and/or the like. Additionally or alternatively, in some embodiments, the one or more input devices include one or more input mechanisms such as one or more directional control mechanisms (e.g., joystick, thumbstick, lever connected to pivot, and/or scroll wheel) configured to be actuated by the user in one or more directions, one or more button mechanisms configured to be pressed or otherwise actuated by the user (e.g., start button, select button, bumper button, z-button, face button, mouse button, and/or scroll wheel button), one or more touch interfaces (e.g., trackpad, touchpad, and/or touchscreen) configured to receive one or more touch gestures, and/or the like. In some embodiments, the controller input includes analog or discrete data corresponding to actuation of the directional control mechanism, including displacement or movement of the directional control mechanism (e.g., from an initial zero-input position) and indicating or otherwise corresponding to a direction and extent of displacement associated with the actuation of the directional hardware control mechanism. Additionally or alternatively, in some embodiments, the controller input includes analog or discrete data corresponding to motion of the user's finger across a touch interface, a position of the user's finger at a position on the touch interface, motion of a pointing device relative to a surface, and/or the like. Additionally or alternatively, in some embodiments, the controller input includes analog or discrete data corresponding to actuation of the one or more selection mechanisms, including one or more button presses, and/or the like. For example, in some embodiments, detecting a selection input including controller input includes detecting a predetermined sequence of input corresponding to analog or discrete data (e.g., directional input, mouse movement, or touch gesture) corresponding to movement of a cursor within the three-dimensional environment (e.g., towards an object such as a virtual object), and analog or discrete data (e.g., button press) corresponding to an action such as selection of an object at the location of the cursor (e.g., selection of an object such as a virtual object or a portion of the object). In some embodiments, an input element of a selection input including controller input refers to an object by which inputs are detected, received, or otherwise input to the computer system. For example, in some embodiments, an input element of the selection input includes one or more hardware controllers (e.g., gamepad), one or more pointing devices (e.g., mouse), one or more touch interfaces (e.g., trackpad, touchpad, or touchscreen), and/or the like, and/or other input device such as a track pad, mouse, and/or touch input device. In some embodiments, using the example of the one or more hardware controllers as an input element, the computer system detects and tracks a location of a cursor associated with the input element based on analog and/or discrete input corresponding to directional input received at the computer system for moving the cursor throughout the three-dimensional environment.

In some embodiments, in response to detecting (1204) the selection input, and in accordance with a determination that the selection input is directed to a first portion of a selection region (e.g., grabbing region) of the virtual object, the computer system uses (1206) a first point (e.g., within the first portion of the selection region) as a center of movement for controlling subsequent movement of the virtual object (e.g., based on subsequent movement of an input element that is associated with the selection input), such as center of movement 736-1 being used to control movement of virtual object 704 in FIG. 7K. In some embodiments, in response to detecting the selection input, the computer system determines if the selection input is directed to a virtual object. In some embodiments, detecting a selection input including one or more air gestures directed to a virtual object shares one or more characteristics of detecting an input, such as described with reference to methods 800, 900, 1000, 1100, and/or 1300.

For example, in some embodiments, detecting the selection input includes determining if the selection input is directed to a portion of a selection region of a virtual object. In some embodiments, the selection region of a virtual object corresponds to an area or volume defined about the virtual object by which the computer system detects, responds to, and facilitates interactions with the virtual object based on input such as selection region 710 being defined as a volume about virtual object 704 in FIG. 7C. In some embodiments, the selection region of a virtual object includes one or more segments or portions (also referred as “selection portion(s)”). For example, in some embodiments, a virtual object is defined in connection with or otherwise includes one or more portions (also referred to as “surface portion(s)”), and the selection region of the virtual object is defined about the virtual object such that one or more selection portions of the selection region are respectively defined in association about, with, or to otherwise correspond to, one or more surface portions of the virtual object, respectively, such as region 712-1 associated with virtual object 704 in FIG. 7E. For example, in some embodiments, the one or more portions of the selection region are sub-volumes of the selection region.

For example, in some embodiments, defining the selection region of the virtual object includes defining a first selection portion from the one or more selection portions of the selection region in association with a first surface portion from the one or more surface portions of the virtual object, such as region 712-1 being associated with a surface portion of virtual object 704 in FIG. 7E. In some embodiments, defining the first selection portion of the selection region in association with the first surface portion of the virtual object includes defining the first selection portion at a position (also referred to as “selection position”) based on or relative to a position (also referred to as “surface position”) of the first surface portion of the virtual object. For example, in some embodiments, the first selection portion is defined at a first selection position based on a first surface position of the first surface portion of the virtual object such that the first selection portion is offset from the first surface portion of the virtual object at a first predetermined distance (also referred to as “selection region offset” or “selection region distance”). Additionally or alternatively, in some embodiments, defining the selection region of the virtual object includes defining a first selection portion from the one or more selection portions of the selection region in association with a first surface portion and a second surface portion from the one or more surface portions of the virtual object. In some embodiments, defining the first selection portion of the selection region in association with the first surface portion and the second surface portion of the virtual object includes defining the first selection portion at a selection position based on or relative to the positions of the first surface portion and the second surface portion of the virtual object, such as the position of region 712-1 with respect to the surface of virtual object 704. For example, in some embodiments, the first selection portion is defined at a first selection position based on an average position (also referred to as “average surface position”) of the first surface position of the first surface portion and the second surface position of the second surface portion. Additionally or alternatively, in some embodiments, defining a first selection portion of the selection region includes defining the first selection portion at a position in the three-dimensional environment.

Examples of the virtual object optionally include a representation of any real or imaginary object, such as an octopus, unicorn, box, or the like. For example, in some embodiments, for a virtual object including a representation of an octopus (e.g., such as virtual object 704 and virtual object 708 in FIG. 7A), the selection region of the representation of the octopus is defined about the representation of the octopus such that the one or more portions of the selection region are respectively defined in association with one or more portions of the representation of the octopus, respectively. For example, in some embodiments, the selection region of a virtual object is defined to correspond in shape with the virtual object, such as the shape of selection region 710 corresponding to the shape of virtual object 704 in FIG. 7C. Furthermore, in some embodiments, for a virtual object of a first size, the selection region of the virtual object is defined with a second size, greater than the first size. In some embodiments, for the virtual object including the representation of the octopus, the selection region is defined such that the one or more portions of the selection region include a top portion, associated with a top portion of the representation of the octopus, a front portion, associated with a front portion of the representation of the octopus, and one or more additional portions, respectively associated with the one or more portions of the representation of the octopus.

In some embodiments, the virtual object includes one or more points. In some embodiments, the one or more points correspond to respective handles (that are optionally not displayed) to which reference is made for changing, tracking, or manipulating the spatial position or orientation of the virtual object in response to input detected at, to, or within a selection region of the virtual object, such as center of movement 712 in FIG. 7C. In some embodiments, the one or more points are respectively defined to correspond in spatial position and orientation to the spatial positions and orientations of the one or more portions of the selection region, respectively, such as center of movement 718-1 corresponding to the center of region 716 in FIG. 7D. For example, in some embodiments, a first point from the one or more points is defined based on or to otherwise correspond in spatial position and orientation (also referred to as “anchor position”) to a spatial position and orientation of a first selection portion from the one or more selection portions of the selection region of the virtual object. In some embodiments, the first point is defined to include an initial spatial position substantially coinciding with, spatially located at, or otherwise corresponding to the spatial position and orientation of the first selection portion, such as at a center of the first selection portion. Additionally or alternatively, in some embodiments, the first point is defined to include an initial spatial orientation substantially normal or otherwise corresponding to an orientation of a surface at the center of the first selection portion.

In some embodiments, when the computer system determines that the selection input is directed to the first selection portion of the selection region of a virtual object, the computer system defines the first point as a center of movement located at a first position associated with the virtual object, such as computer system 101 controlling movement of virtual object 704 in accordance with movement of hand 714 from center of movement 712 due to selection input 732 being directed to selection region 710 in FIG. 7BE. In some embodiments, the center of movement of a virtual object refers to a point or region defined in association with the virtual object at a first position located relative to the portion of the selection region of the virtual object to which the selection input is directed, through which movement, including translation and rotation, of the selection input is transferred or otherwise applied to the virtual object. In some embodiments, defining the first point as the center of movement includes locating the center of movement at the first position associated with the virtual object. In some embodiments, the first position associated with the virtual object includes a first position and a first orientation of the first point, respectively corresponding to the spatial position and orientation of the first selection portion to which the selection input is directed.

Accordingly, in some embodiments, the computer system defines a first point from the one or more points of the virtual object as the first point corresponding to the center of movement (e.g., such as center of movement 712), in which the first point is defined at a first position located at the portion of the selection region to which the selection input is directed. For example, the associated portion of the virtual object optionally includes that portion of the virtual object nearest to or in proximity with the portion of the selection region at which the selection input is detected, such as center of movement 712 being used when hand 714 performs a selection input directed at selection region 712-1 in FIG. 7B. As an example, the selection region of a virtual object can be defined such that when the computer system detects a selection input located at a selection region that coincides with a top portion of the virtual object, where the selection input corresponds to the user grabbing or otherwise selecting a top portion of the virtual object, the computer system displays the virtual object, including presenting the virtual object with predetermined movement characteristics, to provide interactions, manipulations, and movements of and with the virtual object based on the selection input.

In some embodiments, the computer system determines that a selection input including one or more air gestures is directed to a first portion of a selection region of a virtual object when a location at which the selection input is detected (e.g., the location at which two fingers of the hand of the user have come together and touched in the air pinch shape) is detected within the first portion of the selection region, or within a predetermined threshold distance of the first portion of the selection region, when the selection input is initially detected (e.g., when the two fingers initially touch, a touch input is detected, and/or a button is pressed), such as input 732 being directed to selection region 712-1 in FIG. 7I. In some embodiments, the location at which two fingers of the hand of the user come together and touch in the air pinch hand shape is different from a location of the first point. In some embodiments, if the location at which the two fingers of the hand of the user come together and touch in the air pinch hand shape is outside of the first portion of the selection region, or outside the predetermined threshold distance of the first portion of the selection region, the selection input is not directed to the virtual object.

Additionally or alternatively, in some embodiments, the computer system determines that a selection input including controller input is directed to a first portion of a selection region of a virtual object when a controller input corresponding to a button press and/or a touch input is detected at a point in time during which a location of a cursor element associated with the controller input is positioned at or within the first portion of the selection region, or within a predetermined threshold distance of the first portion of the selection region, when the selection input is initially detected (e.g., when the button is pressed; when the touch input is detected), such as if the computer system 101 controlled movement of virtual object 704 in FIGS. 7K-7O in response to input from a controller that was communicatively to the electronic device. In some embodiments, the location of the cursor element at the point in time at which the button press and/or the touch input is detected is different from the location of the first point. In some embodiments, if the location at which the cursor element is located during the point in time at which the button press and/or the touch input is detected is determined to be or otherwise detected at a positioned outside of the first portion of the selection region, or outside the predetermined threshold distance of the first portion of the selection region, the selection input is not directed to the virtual object.

In some embodiments, when the computer system detects a selection input including one or more air gestures directed to a portion of a selection region of a virtual object, followed by movement of the selection input, the computer system moves the virtual object based on the selection input and based on the portion of the selection region that has been determined to have been grabbed or otherwise selected based on the selection input such as computer system 101 moving virtual object 704 in accordance with the detected movement of hand 714 in FIGS. 7K-7O. Additionally or alternatively, in some embodiments, when the computer system detects a selection input including controller input (e.g., button press) directed to a portion of a selection region of a virtual object, followed by movement of the selection input (e.g., in response to receiving one or more controller inputs corresponding to actuation of a directional control mechanism from an initial zero-input position), the computer system moves the virtual object, based on the selection input and based on the portion of the selection region that has been determined to have been grabbed or otherwise selected based on the selection input. For example, in some embodiments, moving the virtual object based on the selection input and based on the selection region that has been grabbed or otherwise selected by the selection input includes moving the virtual object based on the spatial position and orientation of the selection input, at the point in time at which the selection input has been determined to be directed to the first selection portion, relative to the spatial position and orientation of the center of movement (e.g., as defined in association with and otherwise corresponding to the point located at the first position associated with the virtual object) of the selection region that has been grabbed by the selection input. For example, in some embodiments, moving the virtual object based on the selection input and based on the selection region that has been grabbed by the selection input includes fixing the relative spatial arrangement of the selection input relative to the first selection portion of the selection region that has been grabbed by the selection input during the movement. Additionally or alternatively, in some embodiments, moving the virtual object based on the selection input and based on the selection region that has been grabbed by the selection input optionally includes varying the relative spatial arrangement of the selection input relative to the first selection portion of the selection region that has been grabbed by the selection input during the movement based on one or more characteristics of the movement. For example, in some embodiments, the distance between the selection input and the virtual object is increased in response to increasing speed of the movement.

In some embodiments, in response to detecting (1204) the selection input, and in accordance with a determination that the selection input is directed to a second portion of the selection region of the virtual object, in which the second portion of the selection region of the virtual object is different from the first portion of the selection region of the virtual object, the computer system uses (1208) a second point (e.g., within the second portion), different from the first point, as the center of movement for controlling subsequent movement of the virtual object (e.g., based on subsequent movement of an input element that is associated with the selection input), such as center of movement 746 being used to control virtual object 746 \in FIG. 7AR. In some embodiments, the selection input including one or more air gestures is determined to be directed to a second portion of the selection region when a position at which two fingers of the hand of the user come together and touch in the air pinch hand shape is detected within the second portion of the selection region, or within a predetermined threshold distance of the second portion of the selection region, when the selection input is initially detected (e.g., when the two fingers initially touch). In some embodiments, the location at which two fingers of the hand of the user come together and touch in the air pinch hand shape is different from a location of the second point. In some embodiments, if the location at which the two fingers of the hand of the user come together and touch in the air pinch hand shape is outside of the second portion of the selection region, or outside the predetermined threshold distance of the second portion of the selection region, the selection input is not directed to the virtual object. Additionally or alternatively, in some embodiments, the selection input including controller input is determined to be directed to a second portion of the selection region when a controller input corresponding to a button press and/or a touch input is detected at a point in time during which a location of a cursor element associated with the controller input is positioned at or within the second portion of the selection region, or within a predetermined threshold distance of the second portion of the selection region, when the selection input is initially detected (e.g., when the button is pressed; when the touch input is detected). In some embodiments, the location at which the location of the cursor element associated with the controller input is positioned at or within the second portion of the selection region when the selection input is initially detected is different from a location of the second point. In some embodiments, if the location at which the location at which the location of the cursor element associated with the controller input is positioned at or within the second portion of the selection region when the selection input is initially detected is outside of the second portion of the selection region, or outside the predetermined threshold distance of the second portion of the selection region, the selection input is not directed to the virtual object. In some embodiments, when the computer system determines that the selection input is directed to a portion of a selection region of the virtual object, the computer system defines a second point, different from the first point, as a center of movement at a second position associated with the virtual object, different from the first position associated with the virtual object. The second point optionally shares one or more characteristics of the first point described above. Accordingly, in some embodiments, the computer system defines a second point as corresponding to the center of movement, in which the second point is defined at a second position, different from the first position. For example, the associated portion of the virtual object optionally includes that portion of the virtual object nearest to or in proximity with the portion of the selection region at which the selection input is detected. In some embodiments, the computer system moves the virtual object with movement characteristics (e.g., magnitude, velocity, acceleration and/or direction) based on the relative positioning of the selection input and the virtual object at the time the selection input is initially detected. Moving a virtual object in a three-dimensional environment based on a center of movement corresponding to the region at which a selection input grabs the virtual object improves user experience of the computer system by facilitating intuitive operation of the computer system by the user based on realistic and/or flexible object manipulation behaviors of the virtual object, thereby reducing input errors, and improving the functionality of the computer system and the efficiency of the user interaction with the computer system.

In some embodiments, the selection input is associated with an input element. In some embodiments, after detecting the selection input associated with the input element, the computer system detects movement of the input element, such as detecting the movement of hand 714 in FIGS. 7K-7O.

In some embodiments, in response to detecting the movement of the input element associated with the selection input, and in accordance with a determination that the selection input was directed to the first portion of the selection region, the computer system moves the virtual object using the first point as the center of movement for controlling the subsequent movement of the virtual object, such as moving virtual object 704 using the center of movement 736-1 in response to movement of hand 714 in FIGS. 7K-7O.

In some embodiments, in accordance with a determination that the selection input is directed to the second portion of the selection region, the computer system moves the virtual object using the second point as the center of movement for controlling the subsequent movement of the virtual object, such as moving virtual object 704 using center of movement 746 in response to movement of hand 714 in FIGS. 7AR-7AS. In some embodiments, the selection input is associated with or otherwise includes an input element. In some embodiments, the input element shares one or more characteristics with the input element described with reference to methods 800 and/or 900. For example, in some embodiments, the input element includes a hand or other portion of the user. Additionally or alternatively, in some embodiments, the input element includes one or more hardware controllers, one or more pointing devices, one or more touch interfaces, and/or the like. In some embodiments, after detecting the selection input (e.g., directed to the virtual object) associated with the input element, the computer system detects movement of the input element associated with the selection input. In some embodiments, in response to detecting the movement of the input element, the computer system controls movement of the virtual object (e.g., moves the virtual object in accordance with the movement of the input element). In some embodiments, the computer system controls the movement of the virtual object, including controlling subsequent movement of the virtual object, according to one or more determinations as to the detected movement of the input element (e.g., after having detected the selection input associated with the input element). In some embodiments, the computer system controls the movement of the virtual object, including controlling the subsequent movement of the virtual object, based on a determination as to the portion of a selection region of the virtual object to which the selection input was directed when the selection input was initially detected. In some embodiments, the selection region of the virtual object shares one or more characteristics with the selection region described with reference to methods 800, 900, 1000, and/or 1100. For example, in some embodiments, when the computer system determines that the selection input was directed to the first portion of the selection region of the virtual object, the computer system controls the movement of the virtual object, including controlling the subsequent movement of the virtual object using the first point as the center of movement (e.g., the computer system moves the object with reference to the center of movement), in which the first point is located at the first position associated with the virtual object. In some embodiments, the computer system controls the movement of the virtual object by transferring or otherwise applying movement, including translation and/or rotation, to the virtual object through the center of movement located at the first position. As another example, in some embodiments, when the computer system determines that the selection input was directed to the second portion of the selection region of the virtual object, the computer system controls the movement of the virtual object, including controlling the subsequent movement of the virtual object using the second point as the center of movement, in which the second point is located at the second position associated with the virtual object. In some embodiments, the computer system controls the movement of the virtual object by transferring or otherwise applying movement, including translation and/or rotation, to the virtual object through the center of movement located at the second position. In some embodiments, controlling the movement of the virtual object includes moving the virtual object in accordance with the movement of the input element, including moving the virtual object in accordance with a direction and/or magnitude of the movement of the input element. For example, in some embodiments, when the computer system determines that the movement of the input element includes movement in a first direction (e.g., upwards) and at a first rate (e.g., 1 m/s), the computer system moves the virtual object in a second direction (e.g., upwards) corresponding to the first direction at a second rate (e.g., 1 m/s), corresponding to the first rate. Moving a virtual object in a three-dimensional environment using the point at which the selection input is initially directed improves user experience of the computer system by enabling realistic object manipulations and interactions based on the portions of the virtual object to which the selection input is initially directed, thereby facilitating intuitive operation of the computer system by the user based on realistic and/or flexible object manipulation behaviors of the virtual object, thereby reducing input errors, and improving the functionality of the computer system and the efficiency of the user interaction with the computer system.

In some embodiments, in response to detecting the selection input, and in accordance with a determination that the selection input is not directed to any portion of the selection region, the computer system forgoes moving the virtual object (and/or forgoing initiating control of the virtual object by an input element providing the selection input), such as if input 732 was not directed to a region of virtual object 704 and thus virtual object 704 was not moved in response to movement of hand 714 in FIGS. 7K-7O. In some embodiments, the selection input is associated with or otherwise includes an input element. In some embodiments, the input element shares one or more characteristics with the input element described with respect to method 800. For example, in some embodiments, the input element includes a hand or other portion of the user. Additionally or alternatively, in some embodiments, the input element includes one or more hardware controllers, one or more pointing devices, one or more touch interfaces, and/or the like. In some embodiments, in response to detecting the selection input, the computer system foregoes moving the virtual object in accordance with a determination that the selection input is not directed to any portion of the selection region (e.g., of the virtual object). For example, in some embodiments, if the position at which the selection input is detected is located position outside the predetermined threshold distance from the first portion of the selection region of the virtual object and/or the second portion of the selection region of the virtual object, the computer system determines that the selection input is not directed to any portion of the selection region of the virtual object. In some embodiments, when the computer system determines that the selection input is not directed to any portion of the selection region of the virtual object, the computer system forgoes moving the virtual object (e.g., does not move the virtual object in response to movements of the input element). Forgoing moving a virtual object in a three-dimensional environment in response to detecting the selection input and in accordance with a determination that the selection input is not directed to any portion of the selection region of the virtual object improves user experience of the computer system by enabling realistic object manipulations and interactions based on the portions of the virtual object to which the selection input is initially directed, thereby facilitating intuitive operation of the computer system by the user based on realistic and/or flexible object manipulation behaviors of the virtual object, thereby reducing input errors, and improving the functionality of the computer system and the efficiency of the user interaction with the computer system.

In some embodiments, in response to detecting the selection input, and in accordance with a determination that the selection input is directed to the first portion of the selection region of the virtual object and the selection input is positioned within a first threshold distance from the first portion of the selection region, the computer system anchors the virtual object to the selection input during subsequent movement of the virtual object, such as anchoring virtual object 704 to movement of hand 714 in response to the selection input 732 being directed to center of movement 736-1 and within a threshold distance of virtual object 704 in FIGS. 7K-7O. In some embodiments, controlling the subsequent movement of the virtual object includes anchoring the virtual object to the selection input during subsequent movement of the virtual object. For example, in some embodiments, anchoring refers to the manner in which the computer system controls the subsequent movement of the virtual object relative to subsequent movement of the input element, in which a spatial arrangement of the virtual object and the input element remain substantially fixed during the subsequent movement of the virtual object (e.g., such that during the subsequent movement of the virtual object, the virtual object moves with or according to the movement of the input element as if it is being pulled by the input element). For example, in some embodiments, the computer system anchors the virtual object to the selection input during the subsequent movement of the virtual object according to a determination that the selection input is directed to the first portion of the selection region of the virtual object. Additionally or alternatively, in some embodiments, the computer system anchors the virtual object to the selection input during the subsequent movement of the virtual object according to a determination that the selection input is positioned within a first predetermined threshold distance from the first portion of the selection region of the virtual object. Anchoring the virtual object to the selection input during the subsequent movement of the virtual object improves the user experience of the computer system by enabling realistic object manipulations and interactions based on relative spatial relationships between objects and/or the user in the three-dimensional environment, thereby improving immersion and facilitating intuitive interaction between the user and the computer system, reducing input errors, and improving the functionality of the computer system and the efficiency of the user interaction with the computer system.

In some embodiments, the computer system anchors the virtual object to the selection input. For example, in some embodiments, in accordance with a determination that the selection input has a first orientation relative to the selection region, the computer system anchors the virtual object to the selection input in a first manner, such as the virtual object 706 being anchored to input 732 based on its orientation relative to input 732 in FIGS. 7AY-7BA.

In some embodiments, in accordance with a determination that the selection input has a second orientation relative to the selection region when performed, the computer system anchors the virtual object to the selection input in a second manner, different from the first manner, such as the manner in which virtual object 706 is anchored to input 732 based on the orientation of virtual object 706 relative to input 732 in FIG. 7AB. In some embodiments, the computer system anchors the virtual object to the selection input in a first manner according to a determination as to a first spatial position and/or a first spatial orientation of the selection input relative to the virtual object when the selection input is detected or otherwise determined to be directed to the first portion of the selection region of the virtual object. For example, in some embodiments, anchoring the virtual object to the selection input in the first manner optionally includes fixing the selection input and the virtual object in a first spatial arrangement in which a relative spatial position and/or spatial orientation of the selection input relative to the virtual object is substantially constant over a first interval (e.g., the orientation of the selection input relative to the virtual object stays constant). In some embodiments, the first spatial arrangement of the selection input and the virtual object corresponds to the arrangement of the selection input and the virtual object at the point in time at which the selection input was determined to be directed to the first selection portion. In some embodiments, the first spatial arrangement of the selection input and the virtual object corresponds to an arrangement of the selection input and the virtual object in which the selection input is oriented at a 45° angle relative to a portion of the selection region of the virtual object. In some embodiments, the computer system anchors the virtual object to the selection input in a second manner, different from the first manner, according to a determination as to a second spatial position and/or a second spatial orientation of the selection input when the selection input is detected or otherwise determined to be directed to the first portion of the selection region of the virtual object. For example, in some embodiments, anchoring the virtual object to the selection input in the second manner includes fixing the selection input and the virtual object in a second spatial arrangement, different from the first spatial arrangement, in which a relative spatial position and/or spatial orientation of the selection input relative to the virtual object is substantially constant over the first interval. In some embodiments, the second spatial arrangement of the selection input and the virtual object corresponds to the arrangement of the selection input and the virtual object at the point in time at which the selection input was determined to be directed to the first selection portion. For example, in some embodiments, the second spatial arrangement of the selection input and the virtual object corresponds to an arrangement of the selection input and the virtual object in which the selection input is oriented normal to, or otherwise at a right angle relative to, a portion of the selection region of the virtual object. Anchoring in various manners according to determinations as to the spatial position and/or the spatial orientation of the selection input relative to the virtual object at the point in time at which the selection input is detected or otherwise determined to be directed to a portion of the virtual object improves the user experience of the computer system by enabling realistic object manipulations and interactions based on relative spatial relationships between objects and/or the user in the three-dimensional environment, thereby improving immersion and facilitating intuitive interaction between the user and the computer system, reducing input errors, and improving the functionality of the computer system and the efficiency of the user interaction with the computer system.

In some embodiments, the selection region of the virtual object has a first volume and the virtual object has a second volume, less than the first volume, such as selection region 710 having a larger volume than virtual object 704 in FIG. 7C. In some embodiments, the selection region of the virtual object shares one or more characteristics with the selection region described with reference to methods 800, 900, 1000, and/or 1100. For example, in some embodiments, the selection region of the virtual object corresponds to an area or volume defined about the virtual object, including one or more selection portions defined in association with one or more surface portions of the virtual object. For example, in some embodiments, the one or more selection portions are defined at respective positions based on respective surface positions of the virtual object, such that the one or more selection portions are respectively offset from respective surface portions of the virtual object at respective, predetermined distances. Accordingly, in some embodiments, the selection region of the virtual object encapsulates and/or surrounds the virtual object. For example, in some embodiments, the selection region of the virtual object has a first volume and the virtual object has a second volume, less than the first volume. Defining a selection region of a virtual object such that the selection region has a volume greater than a volume of the virtual object enables improves the user experience of the computer system by enabling dynamic and realistic or otherwise “true-to-form” object manipulations of virtual objects thereby improving immersion and facilitating intuitive interaction between the user and the computer system, reducing input errors, and improving the functionality of the computer system and the efficiency of the user interaction with the computer system.

In some embodiments, the selection region of the virtual object is distributed about the virtual object non-uniformly, such as if selection region 710 was not uniformly distributed around virtual object 704 in FIG. 7C. In some embodiments, the selection region of the virtual object corresponds to an area or volume defined about the virtual object, including one or more selection portions defined in association with one or more surface portions of the virtual object. Additionally or alternatively, in some embodiments, the selection region of the virtual object is arranged or otherwise distributed about the virtual object non-uniformly. For example, in some embodiments, for a virtual object from the plurality of virtual objects in the three-dimensional environment, the computer system distributes the selection region of the virtual object about the virtual object non-uniformly, in which the one or more selection portions are defined or otherwise respectively distributed at respective positions based on respective surface positions of the virtual object, such that the one or more selection portions are respectively offset from respective surface portions of the virtual object at respective, predetermined distances. In some embodiments, the one or more selection portions of the selection region of the virtual object are respectively distributed based on respective positions of the one or more surface portions of the virtual object such that the selection region of the virtual object is arranged or otherwise distributed about the virtual object non-uniformly with respect to the surface of the virtual object. For example, in some embodiments, distributing the selection region of a virtual object about the virtual object non-uniformly includes distributing or otherwise positioning a first selection portion from the one or more selection portions of the selection region at a first distance from a first surface portion of the virtual object, and distributing or otherwise positioning a second selection portion from the one or more selection portions of the selection region at a second distance, different from the first distance, from a second surface portion, different from the first surface portion, of the virtual object. Additionally or alternatively, in some embodiments, the selection region of the virtual object extends from the surface of the virtual object, including from the one or more surface portions of the virtual object to the one or more selection portions of the selection region of the virtual object, such as from the first surface portion of the virtual object to the first selection portion of the selection region, from the second surface portion of the virtual object to the second selection portion of the selection region, and/or the like. Additionally or alternatively, in some embodiments, the first selection portion and the second selection portion include respective, adjacently arranged selection portions from the one or more selection portions of the selection region of the virtual object, such that the first distance at which the first selection portion is distributed and the second distance at which the second selection portion is distributed correspond to an instance of non-uniformity of the selection region of the virtual object. Additionally or alternatively, in some embodiments, the one or more selection portions are defined at respective positions based on respective surface positions of the virtual object, such that the one or more selection portions are respectively offset from the respective surface positions of the virtual object at respective, predetermined, and non-uniform distances. For example, in some embodiments, when the computer system distributes a selection region about a virtual object non-uniformly, the respective offsets of one or more adjacently positioned selection portions are offset at different distances relative to each other. For example, in some embodiments, a first selection portion from one or more adjacently positioned selection portions is defined at a first respective position based on a first surface position of the virtual object, in which the first respective position is offset at a first predetermined distance from the first surface position, and a second selection portion from the one or more adjacently positioned selection portions is defined at a second respective position, different from the first respective position, based on a second surface position of the virtual object, in which the second respective position is offset at a second predetermined distance, different from the first predetermined distance, from the second surface position. Defining the selection region so as to be distributed about the virtual object non-uniformly improves the user experience of the computer system by enabling dynamically defined object manipulations and interactions based on predetermined parameters selected as a matter of design, thereby improving immersion and facilitating intuitive interaction between the user and the computer system, reducing input errors, and improving the functionality of the computer system and the efficiency of the user interaction with the computer system.

In some embodiments, in accordance with a determination that the virtual object is a first virtual object, the selection region has a first volume in the three-dimensional environment, such as the volume of selection region 710 associated with virtual object 704 in FIG. 7C. In some embodiments, in accordance with a determination that the virtual object is a second virtual object, different from the first virtual object, the selection region has a second volume, different than the first volume, in the three-dimensional environment, such as the volume of selection region 716 associated with virtual object 706 being different than the volume of selection region 710 associated with virtual object 704 in FIG. 7D. In some embodiments, the selection input includes input indicating selection of a virtual object from a plurality of virtual objects in the three-dimensional environment. In some embodiments, a selection region of the virtual object has a first volume according to a determination that the virtual object is a first virtual object. In some embodiments, a selection region of the virtual object has a second volume, different than the first volume, according to a determination that the virtual object is a second virtual object. For example, in some embodiments, the difference in the second volume of the selection region of the virtual object relative to the first volume of the selection region of the virtual object corresponds to the difference in volume between the first virtual object and the second virtual object. In some embodiments, the volume of the selection region of a virtual object is proportional the volume of the virtual object. For example, in some embodiments, determining that the virtual object is a first virtual object includes determining that the selection region of the first virtual object has a first volume and the first virtual object has a second volume, less than the first volume (e.g., the volume of the first virtual object is less than the volume of the selection region of the first virtual object). Additionally or alternatively, in some embodiments, determining that the virtual object is a second virtual object includes determining that the selection region of the second virtual object has a third volume and the second virtual object has a fourth volume, less than the third volume (e.g., the volume of second first virtual object is less than the volume of the selection region of the second virtual object). Additionally or alternatively, in some embodiments, when the second volume of the first virtual object is greater than the fourth volume of the second virtual object, the first volume of the selection region of the first virtual object is greater than the third volume of the selection region of the second virtual object (e.g., if the volume of the first virtual object is greater than the volume of the second virtual object, the volume of the selection region of the first virtual object is greater than the volume of the selection region of the second virtual object). Defining the selection region of a virtual object according to determinations as to an identity of virtual objects from a plurality of virtual objects improves the user experience of the computer system by enabling a variety of object manipulation behaviors of virtual objects in the three-dimensional environment, thereby improving immersion and facilitating intuitive interaction between the user and the computer system, reducing input errors, and improving the functionality of the computer system and the efficiency of the user interaction with the computer system.

In some embodiments, in accordance with a determination that the virtual object is a first virtual object, the selection region has a first shape, such as the shape of selection region 710 associated with virtual object 704 in FIG. 7C. In some embodiments, in accordance with a determination that the virtual object is a second virtual object, different from the first virtual object, the selection region has a second shape, different from the first shape of the first virtual object, such as selection region 716 associated with virtual object 706 in FIG. 7D. In some embodiments, the selection input includes input indicating selection of a virtual object from a plurality of virtual objects in the three-dimensional environment. In some embodiments, the selection region of the virtual object has a first shape according to a determination that the virtual object is a first virtual object. In some embodiments, the selection region of the virtual object has a second shape, different than the first shape, according to a determination that the virtual object is a second virtual object. For example, in some embodiments, if the virtual object is a first virtual object having a box shape, then the selection region of the first virtual object has a box shape. As another example, in some embodiments, if the virtual object is a second virtual object having a ball shape, then the selection region of the second virtual object has a ball shape. In some embodiments, the shape of the selection region does not correspond to the shape of the virtual object. For instance if the virtual object has an irregular shape, then the selection region of the virtual object optionally has a box shape or a spherical shape. In some embodiments, differently-shaped irregular virtual objects have different shapes for their corresponding selection regions (e.g., one having a spherical selection region, and another having a box-shaped selection region). Defining the shape of a virtual object according to determinations as to an identity of virtual objects from a plurality of virtual objects improves the user experience of the computer system by enabling a variety of object manipulation behaviors of virtual objects in the three-dimensional environment, thereby improving immersion and facilitating intuitive interaction between the user and the computer system, reducing input errors, and improving the functionality of the computer system and the efficiency of the user interaction with the computer system.

In some embodiments, the center of movement corresponds to a point about which the virtual object rotates during the subsequent movement of the virtual object, such as virtual object 708 rotating about center of movement 736-2 in FIG. 7Y. In some embodiments, when the computer system determines that the selection input is directed to a selection portion of the selection region of a virtual object, the computer system defines a point as a center of movement located at a position associated with the virtual object. In some embodiments, the center of movement shares one or more characteristics with the center of movement described with reference to methods 800, 900, and/or 1000. In some embodiments, the center of movement is defined to correspond to a point about which the virtual object rotates during the subsequent movement of the virtual object. For example, in some embodiments, when the computer system has determined that the input element of the selection input is directed to a portion of the selection region of the virtual object (e.g., in response to detecting an associated selection input at a first time), the computer system defines the center of movement to correspond to a point from the one or more points associated with the virtual object for use as a handle to which reference will be made during the subsequent (e.g., after the first time) movement of the virtual object. In some embodiments, after (e.g., after the first time) the computer system has determined that the input element of the selection input is directed to a selection portion of the selection region of the virtual object, the computer system controls the subsequent movement of the virtual object in accordance with one or more determinations (e.g., at respective times after the first time) as to subsequent movement of the input element of the selection input (e.g., at the respective times after the first time). For example, in some embodiments, controlling the subsequent movement of the virtual object in accordance with the one or more determinations as to subsequent movement of the input element of the selection input includes detecting the subsequent movement of the input element, including detecting an amount of rotation of the input element during the subsequent movement relative to a first point or axis of rotation, and controlling the subsequent movement of the virtual object in accordance with the one or more determinations as to subsequent movement of the input element, including rotating the virtual object by an amount corresponding to the amount of rotation of the input element about a second point or axis of rotation corresponding to the first point or axis of rotation. In some embodiments, the point corresponding to the center of movement is selected from the one or more points of the virtual object, or otherwise defined, in accordance with a determination that a spatial position and/or orientation of a point at which the selection input is detected corresponds in position and/or orientation with the position and/or orientation of the portion of the selection region of the virtual object to which the input element of the selection input was directed (e.g., according to a determination that the selection input was detected within the first portion of the selection region, or within a predetermined threshold distance of the first portion of the selection region). Defining the center of movement to correspond to a point about which the virtual object rotates during the subsequent movement of the virtual object improves the user experience by enabling a variety of object manipulation behaviors of virtual objects in the three-dimensional environment, thereby improving immersion and facilitating intuitive interaction between the user and the computer system, reducing input errors, and improving the functionality of the computer system and the efficiency of the user interaction with the computer system.

In some embodiments, in response to detecting the selection input, and in accordance with a determination that the selection input is directed to the first portion of the selection region, the computer system displays the virtual object at a first orientation with respect to an input element associated with the selection input during the subsequent movement of the virtual object, such as the orientation of virtual object 704 in response to detection of selection input 732 directed to center of movement 736-1 in FIGS. 7K-7O.

In some embodiments, in accordance with a determination that the selection input is directed to the second portion of the selection region, the computer system displays the virtual object at a second orientation, different from the first orientation, with respect to the input element associated with the selection input during the subsequent movement of the virtual object, such as the orientation of virtual object 704 in response to detection of selection input 732 directed to center of movement in FIGS. 7AR-7AS. In some embodiments, when the computer system determines that the selection input is directed to a portion of the selection region corresponding to the first selection portion of the selection region of the virtual object, the computer system displays the virtual object (e.g., a surface of the virtual object) at a first orientation with respect to the input element associated with the selection input during the subsequent movement of the virtual object. In some embodiments, the input element shares one or more characteristics with the input element described with reference to methods 800 and/or 900. For example, in some embodiments, the input element includes a hand or other portion of the user. Additionally or alternatively, in some embodiments, the input element includes one or more hardware controllers, one or more pointing devices, one or more touch interfaces, and/or the like. In some embodiments, when the computer system determines that the selection input is directed to a portion of the selection region corresponding to the second selection portion of the selection region of the virtual object, the computer system displays the virtual object at a second orientation, different from the first orientation, with respect to the input element associated with the selection input during the subsequent movement of the virtual object. Displaying the virtual object according to determinations as to the portion of the selection region to which the selection input is directed improves the user experience of the computer system by enabling a variety of object manipulation behaviors of virtual objects in the three-dimensional environment, thereby improving immersion and facilitating intuitive interaction between the user and the computer system, reducing input errors, and improving the functionality of the computer system and the efficiency of the user interaction with the computer system.

In some embodiments, displaying the virtual object at the first orientation with respect to the input element associated with the selection input includes displaying the virtual object such that the input element is perpendicular to a surface of the virtual object that is closest to the center of movement of the virtual object, such as hand 714 (and specifically the air pinch) being perpendicular surface of virtual object that is closest to center of movement 736-1. In some embodiments, displaying the virtual object at the first position and/or first orientation with respect to the input element associated with the selection input includes displaying the virtual object such that the input element is perpendicular to a surface of the virtual object that is closest to the center of movement of the virtual object. In some embodiments, displaying the virtual object at the first orientation with respect to the input element associated with the selection input includes displaying the virtual object such that the input element is oriented at an angle of alignment corresponding to an arrangement in which the virtual object is displayed such that the input element is perpendicular to a surface (e.g., surface portion) of the virtual object that is closest to the center of movement of the virtual object. For example, in some embodiments, the angle of alignment is measured relative to or between a longitudinal axis of the input element and a vector oriented perpendicular to the surface of the virtual object that is closest to the center of movement of the virtual object. For example, in some embodiments, displaying the virtual object such that the input element is perpendicular to the surface of the virtual object that is closest to the center of movement of the virtual object includes determining that the selection input, including the input element, is directed to a selection portion of the selection region of the virtual object at which a point of reference was defined in association with the center of movement, and detecting the input element of the selection input at a location corresponding to the position at which the center of movement is located in association with the virtual object. Additionally or alternatively, in some embodiments, displaying the virtual object such that the input element is perpendicular to the surface of the virtual object that is closest to the center of movement of the first virtual object includes displaying the virtual object and the input element in a display arrangement in which the angle of alignment corresponds to the angle of alignment between the input element and a vector oriented perpendicular to the surface portion of the virtual object that is closest to the center of movement of the virtual object at the point in time at which the input element is detected as being directed to the virtual object, and is oriented at first angle of alignment relative to the virtual object. For example, in some embodiments, the computer system displays the virtual object at the first orientation such that the input element is perpendicular to the first selection portion of the selection region of the virtual object at the first point corresponding to the center of movement of the virtual object located at the first position associated with the virtual object. In some embodiments, the first point is defined to include an initial spatial orientation substantially normal or otherwise corresponding to an orientation of a surface of the virtual object at the center of the first selection portion. Displaying the virtual object at the first orientation such that the input element is perpendicular to the surface of the virtual object closest to the center of movement of the virtual object improves the user experience of the computer system by enabling realistic object manipulation behavior of and by virtual objects in the three-dimensional environment, thereby improving immersion and facilitating intuitive interaction between the user and the computer system, reducing input errors, and improving the functionality of the computer system and the efficiency of the user interaction with the computer system.

In some embodiments, in response to detecting the selection input, and in accordance with a determination that the virtual object is a first virtual object, the computer system displays the virtual object at a first orientation with respect to an input element associated with the selection input during the subsequent movement of the virtual object, such as the orientation of virtual object 760 with respect to hand 714 illustrated in FIG. 7BD. In some embodiments, in accordance with a determination that the virtual object is a second virtual object, different from the first virtual object, the computer system displays the virtual object at a second orientation, different from the first orientation, with respect to the input element associated with the selection input during the subsequent movement of the virtual object, such as the orientation of virtual object 708 with respect to hand 714 illustrated in FIG. 7BD. In some embodiments, the computer system displays the virtual object at the first orientation with respect to the input element associated with the selection input during the subsequent movement of the virtual object while controlling the subsequent movement of the virtual object (e.g., according to one or more determinations as to the detected movement of the input element), as described herein. For example, in some embodiments, when the computer system determines that the selection input is directed to a first portion of a selection region of a virtual object, such as of a first virtual object, the computer system defines a center of movement in connection with the first virtual object at a first point (e.g., from the one or more points associated with the first virtual object) at the first portion of the selection region of the first virtual object (e.g., for use as a handle to which reference is made during the subsequent movement of the first virtual object) for controlling the subsequent movement of the first virtual object, as described herein. As another example, in some embodiments, when the computer system determines that the selection input is directed to a second portion of a selection region of a virtual object, such as of a second virtual object, the computer system defines a center of movement in connection with the second virtual object, such as at a second point, different form the first point, at the second portion of the selection region of the second virtual object for controlling the subsequent movement of the second virtual object, as described herein. In some embodiments, the selection input includes input indicating selection of a virtual object from a plurality of virtual objects in the three-dimensional environment. In some embodiments, when the computer system determines that the virtual object is the first virtual object, the computer system displays the first virtual object at a first orientation with respect to an input element associated with the selection input during the subsequent movement of the virtual object. In some embodiments, the input element shares one or more characteristics with the input element described with reference to methods 800 and/or 900. In some embodiments, the first orientation at which the first virtual object is displayed is determined according to the first shape of the first virtual object. For example, in some embodiments, when the computer system determines that the virtual object is a first virtual object with a first shape corresponding to a box shape, the computer system displays the virtual object at the first orientation with respect to the input element associated with the selection input during the subsequent movement of the virtual object, in which a longitudinal axis of the input element is oriented normal to a surface of the virtual object. Additionally or alternatively, in some embodiments, when the computer system determines that the virtual object is a second virtual object, different from the first virtual object, the computer system displays the second virtual object at a second orientation, different from the first orientation, with respect to the input element associated with the selection input during the subsequent movement of the virtual object. For example, in some embodiments, the second orientation at which the second virtual object is displayed is determined according to the second shape of the second virtual object. For example, in some embodiments, when the computer system determines that the virtual object is a second virtual object with a second shape corresponding to a ball shape, the computer system displays the virtual object at a second orientation with respect to the input element associated with the selection input during the subsequent movement of the virtual object, in which a longitudinal axis of the input element is oriented at an angle relative to a surface of the virtual object (e.g., 30, 45, or 60 degrees). Displaying the virtual object according to determinations as to the portion of the selection region to which the selection input is directed and a shape of the virtual object improves the user experience of the computer system by reducing obstruction of a view of the virtual object (e.g., by the input element) during the subsequent movement of the virtual object, making the interface simpler and easier to use, thereby improving immersion and facilitating intuitive interaction between the user and the computer system, reducing input errors, and improving the functionality of the computer system and the efficiency of the user interaction with the computer system.

In some embodiments, displaying the first virtual object at the first orientation with respect to the input element associated with the selection input during the subsequent movement of the virtual object comprises displaying the first virtual object such that the input element is oriented at a first angle of alignment between the input element and a vector perpendicular to a surface of the first virtual object that is closest to the center of movement of the first virtual object (optionally independent of and/or different than an angle of alignment between the input element and the surface of the second virtual object at a time when the selection input was detected), such as virtual object 760 oriented perpendicularly with respect to the input element of hand 714 illustrated in FIG. 7BD. In some embodiments, displaying the second virtual object at the second orientation with respect to the input element associated with the selection input during the subsequent movement of the virtual object includes displaying the second virtual object such that the input element is at a second angle of alignment between the input element and a surface of the second virtual object that is closest to the center of movement of the second virtual object, in which the second angle of alignment is based on an angle of alignment between the input element and the surface of the second virtual object at a time when the selection input was detected, such as the orientation of virtual object 708 with respect to the input element of hand 714 illustrated in FIG. 7BD. In some embodiments, displaying the virtual object at the first orientation with respect to the input element associated with the selection input during the subsequent movement of the virtual object includes displaying the first virtual object such that the input element is oriented at a first angle of alignment measured relative to or between a longitudinal axis of the input element and a vector oriented perpendicular to a surface (e.g., surface portion) of the first virtual object that is closest to the center of movement of the first virtual object. For example, in some embodiments, displaying the first virtual object such that the input element is perpendicular to the surface of the first virtual object that is closest to the center of movement of the first virtual object includes determining that the selection input, including the input element, is directed to a first selection portion of the selection region of the first virtual object at which a first point was defined in association with the center of movement, and detecting the input element of the selection input at a location corresponding to the first position at which the center of movement is located in association with the first virtual object. Additionally or alternatively, in some embodiments, displaying the virtual object such that the input element is oriented at the first angle of alignment includes displaying the virtual object and the input element in a first display arrangement in which the first angle of alignment corresponds to the angle of alignment between the input element and a vector oriented perpendicular to the surface portion of the virtual object that is closest to the center of movement of the virtual object at the point in time at which the input element is detected as being directed to the virtual object, and is oriented at the first angle of alignment relative to the virtual object. In some embodiments, displaying the virtual object at the first orientation with respect to the input element associated with the selection input during the subsequent movement of the virtual object includes displaying the second virtual object such that the input element is oriented at a second angle of alignment measured between a longitudinal axis of the input element and vector (not shown) oriented perpendicular to a surface of the second virtual object that is closest to the center of movement of the second virtual object. For example, in some embodiments, displaying the second virtual object such that the input element is at the second angle of alignment between the input element and the surface of the second virtual object that is closest to the center of movement of the second virtual object includes determining that the selection input, including the input element, is directed to a second selection portion of the selection region of the second virtual object at which a second point was defined in association with the center of movement, and detecting the input element of the selection input at a location corresponding to the second position at which the center of movement is located in association with the second virtual object. Additionally or alternatively, in some embodiments, displaying the virtual object such that the input element is oriented at the second angle of alignment includes displaying the virtual object and the input element in a second display arrangement, different from the first display arrangement, in which the second angle of alignment corresponds to the angle of alignment between the input element and a vector oriented perpendicular to the surface portion of the virtual object that is closest to the center of movement of the virtual object at the point in time at which the input element is detected as being directed to the virtual object, and is oriented at the first angle of alignment relative to the virtual object. Displaying the virtual object at different orientations with respect to the input element associated with the selection input during the subsequent movement of the virtual object, in which the different orientations are based on respective shapes of the virtual object, improves the user experience of the computer system by enabling clear indications as to the manipulation of a respective virtual object based on the shape of the virtual object during the manipulation of the object, thereby improving immersion and facilitating intuitive interaction between the user and the computer system, reducing input errors, and improving the functionality of the computer system and the efficiency of the user interaction with the computer system.

In some embodiments, the center of movement corresponds to a point that moves towards a center of an input element associated with the selection input during the subsequent movement of the virtual object, such as center of movement 736-1 moving towards input 732 in FIGS. 7K-7O. In some embodiments, when the computer system determines that the selection input is directed to a selection portion of the selection region of a virtual object, the computer system defines a point as a center of movement located at a position associated with the virtual object. In some embodiments, the center of movement is defined to correspond to a point that moves towards a center of the input element associated with the selection input during the subsequent movement of the virtual object. For example, in some embodiments, moving the point towards the center of the input element includes moving the point from a first reference position and to a second reference position, different from the first reference position. In some embodiments, moving the point towards the center of the input element shares one or more characteristics of moving a point towards a center of an input element as described with reference to methods 800 and 900. Additionally or alternatively, in some embodiments, the first reference position is located at a first control point coinciding with or otherwise corresponding to the location of the center of movement when the selection input is initially detected (e.g., located at a first position associated with the virtual object), as described herein. Additionally or alternatively, in some embodiments, the second reference position is located at a second control point coinciding with or otherwise corresponding to the location at which the selection input is detected when the computer system determines that the selection input is directed to the selection portion of the selection region of the virtual object. In some embodiments, during the subsequent movement of the virtual object, the computer system moves the point from the reference position and to the second reference position substantially continuously and/or at predetermined intervals. Moving the reference point corresponding to the center of movement towards the center of the input element associated with the selection input during the subsequent movement of the virtual object improves the user experience by enabling interpolation the object manipulation behaviors associated with virtual objects in the three-dimensional environment, thereby improving immersion and facilitating intuitive interaction between the user and the computer system, reducing input errors, and improving the functionality of the computer system and the efficiency of the user interaction with the computer system.

In some embodiments, in accordance with a determination that a pinch point of the input element is positioned at a first pinch location in the three-dimensional environment, the center of the input element is at a first input location in the three-dimensional environment (optionally the first location in the three-dimensional environment) such as the position of the pinch point associated with hand 714 in FIG. 7M. In some embodiments, in accordance with a determination that the pinch point of the input element is positioned at a second pinch location in the three-dimensional environment, different from the first pinch location, the center of the input element is at a second input location in the three-dimensional environment (optionally the third location in the three-dimensional environment), different from the second location in the three-dimensional environment, such as the movement of the hand 714 causing the pinch point associated with hand 714 to move in FIG. 7N. In some embodiments, a location of the center of the input element is determined according to a location at which the selection input is detected. For example, in some embodiments, the computer system determines and thereby defines the location of the center of the input element according to the location at which an action event associated with the selection input is detected, in which the action event is detected in connection with the selection input when the input element is positioned within the first portion of the selection region, or within a predetermined threshold distance of the first portion of the selection region. For example, in some embodiments, an action event indicates or otherwise corresponds to an act of selecting an object in the three-dimensional environment (e.g., the location at which two fingers of the hand of the user have come together and touched in the air pinch shape to select an object). In some embodiments, the computer system determines a location of the center of the input element according to a determination as to the location of an action event caused by the input element in which the action event coincides with a location of a pinch point. For example, in some embodiments, when the computer system determines that the selection input is directed to the selection portion of the selection region of the virtual object, the computer system locates a position of the center of the input element of the selection input at a first pinch location in the three-dimensional environment. For example, in some embodiments, when the input element of the selection input is a hand, and the selection input corresponds to an air gesture such as an air pinch, the center of the input element is located at the point at which two fingers of the hand meet in the air pinch shape. Additionally or alternatively, in some embodiments, when the computer system locates the position of the selection input at the first pinch location, the computer system locates a position of the center of the input element of the selection input at a first input location in the three-dimensional environment. Additionally or alternatively, in some embodiments, when the computer system locates the position of the input element of the selection input at a second pinch location in the three-dimensional environment, different from the first pinch location, the computer system locates a position of the center of the input element of the selection input at a second input location in the three-dimensional environment, different from the first input location in the three-dimensional environment. Locating the center of the input element at a point coinciding with a predetermined portion of the input element improves the user experience by facilitating consistency in the actions required to provide inputs to the computer system, thereby improving immersion and facilitating intuitive interaction between the user and the computer system, reducing input errors, and improving the functionality of the computer system and the efficiency of the user interaction with the computer system.

In some embodiments, in accordance with a determination that a palm of the hand of the user associated with the input element is positioned at a first palm location in the three-dimensional environment, the center of the input element is at a first input location in the three-dimensional environment, such as if the center of the input 732 in FIG. 7M were at the center of the palm of hand 714. In some embodiments, in accordance with a determination that the palm of the hand of the user associated with the input element is positioned at a second palm location in the three-dimensional environment, different from the first palm location, the center of the input element is positioned a second input location in the three-dimensional environment, different from the first input location in the three-dimensional environment, such as the movement of the hand 714 causing the center of the palm associated with hand 714 to move in FIG. 7N. In some embodiments, a location of the center of the input element is determined according to a location at which the selection input is detected, as described herein. In some embodiments, the computer system determines a location of the center of the input element according to a determination as to the location of an action event caused by the input element in which the action event coincides with a location of a palm of a hand of the user. For example, in some embodiments, when the computer system determines that the selection input is directed to the selection portion of the selection region of the virtual object, the computer system locates a position of the center of the input element of the selection input at a first palm location in the three-dimensional environment. For example, in some embodiments, when the selection input corresponds to an air pinch shape, the computer system uses the palm of the hand that performed the pinch as the center of movement of the input element. Additionally or alternatively, in some embodiments, when the computer system locates the position of the selection input at the first palm location, the computer system locates a position of the center of the input element of the selection input at a first input location in the three-dimensional environment. Additionally or alternatively, in some embodiments, when the computer system locates the position of the input element of the selection input at a second palm location in the three-dimensional environment, different from the first palm location, the computer system locates a position of the center of the input element of the selection input at a second input location in the three-dimensional environment, different from the first input location in the three-dimensional environment. Locating the center of the input element at a point coinciding with a predetermined portion of the input element improves the user experience by facilitating consistency in the actions required to provide inputs to the computer system, thereby improving immersion and facilitating intuitive interaction between the user and the computer system, reducing input errors, and improving the functionality of the computer system and the efficiency of the user interaction with the computer system.

In some embodiments, in accordance with a determination that a wrist of the hand of the user associated with the input element is positioned at a first wrist location in the three-dimensional environment, the center of the input element is at a first input location in the three-dimensional environment, such as if the center of the input 732 in FIG. 7M were at the wrist of hand 714.

In some embodiments, in accordance with a determination that the wrist of the hand of the user associated with the input element is positioned at a second wrist location in the three-dimensional environment, different from the first wrist location, the center of the input element is positioned at a second input location in the three-dimensional environment, different from the first input location in the three-dimensional environment, such as the movement of the hand 714 causing the wrist associated with hand 714 to move in FIG. 7N. In some embodiments, a location of the center of the input element is determined according to a location at which the selection input is detected, as described herein. In some embodiments, the computer system determines a location of the center of the input element according to a determination as to the location of an action event caused by the input element in which the action event coincides with a location of a palm of a wrist of the user. For example, in some embodiments, when the computer system determines that the selection input is directed to the selection portion of the selection region of the virtual object, the computer system locates a position of the center of the input element of the selection input at a first wrist location in the three-dimensional environment. For example, in some embodiments, when the selection input corresponds to an air pinch shape, the computer system uses the wrist of the hand that performed the pinch as the center of movement of the input element. Additionally or alternatively, in some embodiments, when the computer system locates the position of the selection input at the first wrist location, the computer system locates a position of the center of the input element of the selection input at a first input location in the three-dimensional environment. Additionally or alternatively, in some embodiments, when the computer system locates the position of the input element of the selection input at a second wrist location in the three-dimensional environment, different from the first wrist location, the computer system locates a position of the center of the input element of the selection input at a second input location in the three-dimensional environment, different from the first input location in the three-dimensional environment. Locating the center of the input element at a point coinciding with a predetermined portion of the input element improves the user experience by facilitating consistency in the actions required to provide inputs to the computer system, thereby improving immersion and facilitating intuitive interaction between the user and the computer system, reducing input errors, and improving the functionality of the computer system and the efficiency of the user interaction with the computer system.

In some embodiments, the center of input is located based on a position of an object, different from the virtual object, in the three-dimensional environment, such as if the center of the input applied by hand 714 were based on an object in the three-dimensional environment 702 in FIG. 7K. In some embodiments, a location of the center of the input element is determined according to a location at which the selection input is detected, as described herein. In some embodiments, the computer system determines a location of the center of the input element according to a determination as to the location of an action event caused by the input element in which the action event coincides with a location of an object in the three-dimensional environment and/or the physical environment of the computer system. For example, in some embodiments, when the computer system determines that the selection input is directed to the selection portion of the selection region of the virtual object, the computer system locates a position of the center of the input element of the selection input at a first location in the three-dimensional environment. Additionally or alternatively, in some embodiments, when the computer system locates the position of the selection input at the first location, the computer system locates a position of the center of the input element of the selection input at a second location in the three-dimensional environment. Additionally or alternatively, in some embodiments, when the computer system locates the position of the input element of the selection input at a third location in the three-dimensional environment, different from the first location, the computer system locates a position of the center of the input element of the selection input at a fourth location in the three-dimensional environment, different from the second location in the three-dimensional environment. Locating the center of the input element at a point coinciding with a predetermined portion of the input element improves the user experience by facilitating consistency in the actions required to provide inputs to the computer system, thereby improving immersion and facilitating intuitive interaction between the user and the computer system, reducing input errors, and improving the functionality of the computer system and the efficiency of the user interaction with the computer system.

In some embodiments, the center of movement of the virtual object is offset from a surface of the virtual object, such as the center of movement 736-1 being offset from the surface of table that virtual object 704 is resting on in FIG. 7K. In some embodiments, the computer system defines a point as a center of movement located at a position associated with the virtual object. For example, in some embodiments, the computer system defines a point as the center of movement relative to a position of one or more surface portions of the virtual object. In some embodiments, the computer system defines the point with an offset from a position of one or more surface portions of the virtual object. For example, in some embodiments, the offset corresponds to a distance of 0.1 cm, 0.5 cm, 1 cm, 2 cm, 5 cm, 50 cm, 100 cm, 250 cm, 500 cm, 1000 cm, or the like. In some embodiments, the offset includes a predetermined offset for which a value or magnitude is determined according to a value of a virtual parameter of the virtual object. Defining the center of movement of a virtual object with an offset improves the user experience by facilitating the interactions between the user and the computer system, thereby improving immersion and facilitating intuitive interaction between the user and the computer system, reducing input errors, and improving the functionality of the computer system and the efficiency of the user interaction with the computer system.

In some embodiments, in accordance with a determination that the virtual object is a first virtual object, the center of movement is offset from the surface of the first virtual object by a first distance such as the difference in offset from the table between center of movement 736-1 associated with virtual object 704 (shown in FIG. 7K). In some embodiments, in accordance with a determination that the virtual object is a second virtual object, different from the first virtual object, the center of movement is offset from the surface of the second virtual object by a second distance, different from the first distance such as the difference in offset from the table between center of movement 736-1 associated with virtual object 704 (shown in FIG. 7K) and center of movement 718-2 associated with virtual object 706 (shown in FIG. AT). In some embodiments, the computer system defines a point as the center of movement at a position offset from one or more surface portions of the virtual object according to a determination that the virtual object is a first virtual object. In some embodiments, a magnitude of the position offset is defined by or selected at the computer system or an application associated with which the virtual object is associated. For example, in some embodiments, a magnitude of the offset between the first virtual object and a position of the center of movement of the first virtual object corresponds to a first distance. Additionally or alternatively, in some embodiments, the computer system defines a point as the center of movement at a position offset from one or more surface portions of the virtual object according to a determination that the virtual object is a second virtual object. For example, in some embodiments, a magnitude of the offset between the second virtual object and a position of the center of movement of the first virtual object corresponds to a second distance, different from the first distance. Defining the center of movement of a virtual object with an offset improves the user experience by reducing an extent of the obstruction of a view of the virtual object by the input element during the subsequent movement of the virtual object, thereby facilitating the interactions between the user and the computer system, improving immersion and facilitating intuitive interaction between the user and the computer system, reducing input errors, and improving the functionality of the computer system and the efficiency of the user interaction with the computer system.

In some embodiments, the first virtual object has a first degree of irregularity, such as the degree of irregularity associated with virtual object 706 in FIG. 7A. In some embodiments, the second virtual object has a second degree of irregularity, larger than the first degree of irregularity, such as the degree of irregularity associated with virtual object 704 in FIG. 7A. In some embodiments, the second distance is larger than the first distance such as if the difference in offset from the table between center of movement 736-1 associated with virtual object 704 (shown in FIG. 7K) and center of movement 718-2 associated with virtual object 706 (shown in FIG. AT) was due to the difference in the degree of irregularity between virtual object 704 and virtual object 706. In some embodiments, the computer system defines a point as the center of movement at a position offset from one or more surface portions of the virtual object according to a determination that a virtual parameter of the virtual object indicates the virtual object has an irregular shape. For example, in some embodiments, when a shape of the virtual has a first degree of irregularity, the computer system defines the point of the center of movement at a position with a first offset. Additionally or alternatively, in some embodiments, when the virtual has a second degree of irregularity, greater than the first degree of irregularity, the computer system defines the point of the center of movement at a position with a second offset, greater than the first offset. In some embodiments, a degree of irregularity in the shape of a virtual object refers to the extent by which a shape of the virtual object differs from an example of a corresponding, ordinarily shaped object. For example, in some embodiments, the degree of irregularity in the shape of a virtual object indicates or otherwise corresponds to an extent or measure of non-uniformity of the shape of the virtual object, such as in when the shape of the virtual object includes a deviation, a contour, and/or the like. Additionally or alternatively, in some embodiments, the degree of irregularity in the shape of a virtual object corresponds to a measure of a unit quantity of irregularities per unit area of the surface region of the virtual object. In some embodiments, the measure of a unit quantity of irregularities per unit area of the surface region of the virtual object includes a measure of a quantity of protrusions from the surface region of the virtual object, a measure of a size of the protrusions from the surface region of the virtual object, and/or the like. For example, in some embodiments, when the virtual has the second degree of irregularity, greater than the first degree of irregularity, the second degree of irregularity indicates that the unit quantity of irregularities and/or number or protrusions per unit area of the surface region of the virtual object with the second degree of irregularity (e.g., 2 irregularities, protrusions and/or number of protrusions per square millimeter of the surface region of the virtual object with the second degree of irregularity) is greater than that of the virtual object with the first degree of irregularity (e.g., 1 irregularity and/or number of protrusions per square millimeter of the surface region of the virtual object with the first degree of irregularity). Additionally or alternatively, in some embodiments, the degree of irregularity in the shape of a virtual object corresponds to a measure of a symmetry of the surface region and/or shape and/or volume of the virtual object. For example, in some embodiments, a measure of symmetry of the surface region of the virtual object is determined in accordance with a quantity of irregularities in the surface region relative to a plane of symmetry arranged relative to the surface region of the virtual object such that the measure of symmetry increases with an increasing quantity of irregularities (e.g., present on a first side of the plane of symmetry but not present on a second side of the plane of symmetry) and decreases with a decreasing quantity of irregularities of the virtual object (e.g., if the virtual object can be divided into identical halves by a line, a measure of the otherwise identical halves that could have been created if not for the presence of an irregularity present in one of the halves). In some embodiments, the measure of irregularity increases as the halves increasingly mismatch in shape, volume, and/or surface area. Additionally or alternatively, in some embodiments, the measure of irregularity decreases as the halves decreasingly mismatch in shape, volume, and/or surface area. For example, in some embodiments, the measure of irregularity is determined in accordance with a quantity of asymmetrical features of the virtual object across a plane of symmetry (e.g., the more asymmetrical features, the greater the irregularity). Defining the center of movement of a virtual object with an offset improves the user experience by facilitating the interactions between the user and the computer system, thereby improving immersion and facilitating intuitive interaction between the user and the computer system, reducing input errors, and improving the functionality of the computer system and the efficiency of the user interaction with the computer system.

It should be understood that the particular order in which the operations in method 1200 have been described is merely exemplary and is not intended to indicate that the described order is the only order in which the operations could be performed. One of ordinary skill in the art would recognize various ways to reorder the operations described herein. In some embodiments, aspects/operations of method 1200 may be interchanged, substituted, and/or added between these methods. For example, various object manipulation techniques and/or object movement techniques of method 1200 is optionally interchanged, substituted, and/or added between these methods. For brevity, these details are not repeated here.

FIG. 13 is a flowchart illustrating an example method 1300 of moving a virtual object in a three-dimensional environment to a respective resting pose that is based on a designated resting behavior of the virtual object. In some embodiments, the method 1300 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1300 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1300 are, optionally, combined and/or the order of some operations is, optionally, changed.

In some embodiments, method 1300 is performed at a computer system (e.g., computer system 101) in communication with one or more display generation components (e.g., display generation component 120) and one or more input devices (e.g., image sensors 314a through 314c of the one or more image sensors 314 as shown in FIG. 3A). The computer system optionally has one or more characteristics of the computer systems described with reference to methods 800, 900, 1000, 1100, and/or 1200. The one or more display generation components optionally have one or more characteristics of the one or more display generation components described with reference to methods 800, 900, 1000, 1100, and/or 1200. The one or more input devices optionally have one or more characteristics of the one or more inputs devices described with reference to methods 800, 900, 1000, 1100, and/or 1200.

In some embodiments, while displaying, via the one or more display generation components, a virtual object (e.g., virtual object 704 shown in FIGS. 7BG to 7BH), and while movement of the virtual object within a three-dimensional environment is controlled by movement of an input element (e.g., hand 714 shown in FIGS. 7BG to 7BH), (e.g., a controller or hand that is optionally associated with a user of the computer system) the computer system detects (1302), via the one or more input devices, an end of a first input associated with the input element (e.g., the input element that was controlling the movement of the virtual object), such as computer system 101 detecting the end of the first selection input performed by hand 714 in FIG. 7BQ. The three-dimensional environment optionally has one or more characteristics of the three-dimensional environments described with reference to methods 800, 900, 1000, 1100, and/or 1200. The virtual object optionally has one or more characteristics of the virtual objects described with reference to methods 800, 900, 1000, 1100, and/or 1200. In some embodiments, the input element has one or more characteristics of the input elements described with reference to methods 800, 900, 1000, 1100, and/or 1200. In some embodiments, controlling movement of the virtual object has one or more characteristics of controlling movement of a virtual object as described with reference to methods 800, 900, 1000, 1100, and/or 1200. In some embodiments, the first input associated with the input element has one or more characteristics of the selection inputs described with reference to methods 800, 900, 1000, 1100, and/or 1200. In some embodiments, detecting an end of the first input includes detecting termination of an air gesture. For example, detecting an end of the first input includes detecting a release of the air gesture. For example, detecting an end of the first input includes detecting that a user of the computer system ceases to perform an air pinch with their hand (e.g., the computer system detects that two fingers of the hand no longer contact each other). For example, detecting an end of the first input includes detecting something more than an end of movement of the input element (e.g., detecting release of an air pinch gesture in addition to detecting an end of movement of the hand of the user). In some embodiments, detecting an end of the first input includes detecting termination of actuation of a hardware component of the input element (e.g., the computer system detects that a previously selected hardware button, switch, trigger, and/or dial is released).

In some embodiments, in response to detecting the end of the first input, the computer system ceases (1304) controlling of the virtual object by the input element, including, in accordance with a determination that the virtual object is designated as having a first resting behavior, moving the virtual object to a first resting pose (e.g., first location and/or orientation) in the three-dimensional environment after detecting the end of the first input (1306), such as computer system 101 ceasing to control movement of virtual object 704 by hand 714 and moving virtual object 704 to the second resting pose in three-dimensional environment 702 shown in FIG. 7BR in response to detecting the end of the first selection input in FIG. 7BQ. In some embodiments, ceasing controlling of the virtual object by the input element includes ceasing movement of the virtual object in accordance with movement of the input element (e.g., after ceasing control of the virtual object by the input element, the computer system forgoes moving the virtual object within the three-dimensional environment in response to movement of the input element). In some embodiments, the first resting behavior corresponds to a first set of parameters (e.g., one or more of the parameters discussed below) that define one or more poses (e.g., one or more locations and/or orientations) in the three-dimensional environment that the computer system is permitted to display the virtual object at while the virtual object is in a resting state (e.g., while the virtual object is not selected and/or while the input element does not control movement of the virtual object in the three-dimensional environment). The first resting behavior optionally includes a parameter that defines one or more first locations of the three-dimensional environment (e.g., a single location, or a plurality of locations within a region and/or volume of the three-dimensional environment) that the computer system is permitted to display the virtual object at while the virtual object is in the resting state (e.g., the computer system is not permitted to display the virtual object at locations in the three-dimensional environment different from the one or more first locations while the virtual object is not selected). The first resting behavior optionally includes a parameter that defines one or more first orientations that the computer system is permitted to display the virtual object at in the three-dimensional environment while the virtual object is in the resting state (e.g., the computer system is not permitted to display the virtual object at orientations different from the one or more first orientations while the virtual object is not selected). The first resting behavior optionally includes a parameter associated with one or more characteristics of the end of the first input. For example, the computer system moves the virtual object to the first resting pose based on a direction, magnitude, speed, velocity (e.g., angular velocity), and/or acceleration of the movement of the input element when an end of the first input is detected (e.g., in conjunction with detecting an end of the first input, the computer system detects movement of the input element that includes a trajectory directed toward a location in the three-dimensional environment corresponding to the first resting pose). For example, the computer system moves the virtual object to the first resting pose based on attention (e.g., gaze, cursor, and/or hand position optionally detected in conjunction with the end of the first input) that is detected by the computer system (e.g., the attention is directed to a location in the three-dimensional environment corresponding to the first resting pose). In some embodiments, at least one or more parameters of the first resting behavior is not defined by one or more characteristics of the first input. For example, the first resting behavior defines a resting pose (e.g., location and/or orientation in the three-dimensional environment) that is independent of the one or more characteristics of the first input described above). In some embodiments, the first resting behavior is defined by an application associated with the virtual object. In some embodiments, the first resting behavior is defined by a user of the computer system (e.g., in one or more settings of the computer system and/or of an application associated with the virtual object). In some embodiments, the computer system moves the virtual object to the first resting pose automatically (e.g., without additional user input after an end of the first input is detected). In some embodiments, the virtual object is designated as having the first resting behavior prior to detecting the first input and/or prior to detecting an end of the first input. In some embodiments, designating the virtual object as having the first resting behavior includes storing metadata that associates the virtual object with the first resting behavior in a memory of the computer system.

In some embodiments, ceasing controlling of the virtual object by the input element includes, in accordance with a determination that the virtual object is designated as having a second resting behavior, different from the first resting behavior, moving the virtual object to a second resting pose (e.g., second location and/or orientation), different from the first resting pose, in the three-dimensional environment after detecting the end of the first input (1308), such as computer system 101 ceasing to control movement of virtual object 704 by hand 714 and moving virtual object 704 to the third resting pose in three-dimensional environment 702 shown in FIG. 7BS in response to detecting the end of the first selection input in FIG. 7BQ. In some embodiments, the second resting behavior has one or more characteristics of the first resting behavior described above. In some embodiments, the second resting behavior corresponds to a second set of parameters, different from the first set of parameters, that define one or more poses in the three-dimensional environment that the computer system is permitted to display the virtual object at while the virtual object is in the resting state. For example, the second resting behavior includes a parameter that defines one or more second locations, different from the one or more first locations, of the three-dimensional environment that the computer system is permitted to display the virtual object at while the virtual object is in the resting state. For example, the second resting behavior includes a parameter that defines one or more second orientations, different from the one or more first orientations, that the computer system is permitted to display the virtual object at in the three-dimensional environment while the virtual object is in the resting state. For example, the first resting behavior permits the virtual object to be moved to a resting pose in the three-dimensional environment that is based on one or more characteristics of the end of the first input (e.g., as described above), and the second resting behavior does not permit the virtual object to be moved to a resting pose in the three-dimensional environment that is based on one or more characteristics of the end of the first input (e.g., when the virtual object is designated as having the second resting behavior, the computer system is required to move the virtual object to the second resting pose in response to detecting an end of the first input independent of a trajectory of movement of the input element and/or attention of a user of the computer system). In some embodiments, the computer system designates the virtual object as having the first resting behavior in accordance with a determination that the virtual object is a first type of virtual object, and designates the virtual object as having the second resting behavior in accordance with a determination that the virtual object is a second type of virtual object different from the first type of virtual object. In some embodiments, the computer system designates the virtual object as having the first resting behavior in accordance with a determination that the virtual object is associated with a first application, and designates the virtual object as having the second resting behavior in accordance with a determination that the virtual object is associated with a second application different from the first application. In some embodiments, the computer system designates the virtual object as having the first resting behavior in accordance with a determination that one or more user-defined settings (e.g., one or more settings of the computer system and/or one or more settings of an application) associated with the virtual object have a first value, and designates the virtual object as having the second resting behavior in accordance with a determination that the one or more user-defined settings associated with the virtual object have a second value, different from the first value. In some embodiments, the virtual object is designated as having the second resting behavior prior to detecting the first input and/or prior to detecting an end of the first input. In some embodiments, designating the virtual object as having the second resting behavior includes storing metadata that associates the virtual object with the second resting behavior in a memory of the computer system. In some embodiments, the computer system moves the virtual object to the second resting pose automatically (e.g., without additional user input). Moving a virtual object in a three-dimensional environment after a user ceases to control the virtual object to a first resting pose when the virtual object is designated as having a first resting behavior or to a second resting pose when the virtual object is designated as having a second resting behavior provides the user a predictable result to the end of control that is based on the designated resting behavior of the virtual object, which reduces errors and improves efficiency in user-device interaction.

In some embodiments, the first resting pose is based on a first user input parameter of the first input and a first set of constraints, such as the first resting pose of the virtual object 706 shown in FIG. 7BW being based on the fourth velocity of movement of hand 714 (e.g., shown in FIG. 7BV) and the fourth resting behavior of virtual object 706 designating virtual object 706 to rest on the surface of the table in three-dimensional environment 702. In some embodiments, the second resting pose is based on the first user input parameter and a second set of constraints, different from the first set of constraints, such as the second resting pose of the virtual object 704 shown in FIG. 7BR being based on a velocity of movement of hand 714 and the second resting behavior of virtual object 704 designating virtual object 704 to rest at any location in three-dimensional environment 702 other than the surface of the table. In some embodiments, the first user input parameter includes speed, magnitude, direction, velocity, and/or acceleration of the input element (e.g., before and/or during and/or at the end of the first input). In some embodiments, the first user input parameter includes a representative gaze location (e.g., having one or more characteristics of the representative gaze location described below). In some embodiments, in accordance with a determination that the first user input parameter of the first input is a first value (e.g., a first value of speed, magnitude, direction, velocity, and/or angular velocity of movement of the input element before and/or during and/or at the end of the first input), the respective resting pose (e.g., the first resting pose or the second resting pose) will have a first set of spatial characteristics (e.g., location and/or orientation), and in accordance with a determination that the first input parameter of the first input is a second value (e.g., a second value of speed, magnitude, direction, velocity, and/or angular velocity of movement of the input element before and/or during and/or at the end of the first input), different from the first value, the respective resting pose of the virtual object will have a second set of spatial characteristics, different from the first set of spatial characteristics. In some embodiments, the first set of constraints are spatial constraints (e.g., constraints on where and/or how the virtual object can rest in the three-dimensional environment when movement of the virtual object is not being controlled by the input element). For example, the first set of constraints includes a constraint that restricts movement of the virtual object to a first resting location and/or region in the three-dimensional environment, and the second set of constraints includes a constraint that restricts movement of the virtual object to a second resting location and/or region, different from the first resting location and/or region, in the three-dimensional environment. For example, the first set of constraints includes a constraint that restricts movement of the virtual object to a first resting orientation (and/or a first set of resting orientations) in the three-dimensional environment, and the second set of constraints includes a constraint that restricts movement of the virtual object to a second resting orientation (and/or second set of resting locations), different from the first resting orientation (and/or first set of resting orientations). Moving a virtual object in a three-dimensional environment after a user ceases to control the virtual object based on a user input parameter and a first set of constraints when the virtual object is designated as having a first resting behavior or based on the user input parameter and a second set of constraints when the virtual object is designated as having the second resting behavior provides the user a predictable result to the end of control of the virtual object that is based on the designated resting behavior of the virtual object, which reduces errors and improves efficiency in user-device interaction.

In some embodiments, moving the virtual object to the first resting pose includes, in accordance with a determination that a first user input parameter of the first input is a first value, moving the virtual object to the first resting pose that includes a first set of spatial characteristics, such as computer system 101 moving virtual object 706 to the location on the table shown in FIG. 7BW based on the fourth velocity of hand 714 (e.g., represented by vectors 794a and 794b) detected by computer system 101 in FIG. 7BV. In some embodiments, the first user input parameter has one or more characteristics of the first user input parameter described above. In some embodiments, the first value of the first user input parameter includes a first value of speed, velocity, magnitude, distance, and/or direction of movement of the input element (e.g., before and/or during and/or at the end of the first input). In some embodiments, the first set of spatial characteristics of the first resting pose includes a first resting orientation (e.g., of a first set of orientations) and/or first resting location (e.g., within a first set of locations) in the three-dimensional environment.

In some embodiments, moving the virtual object to the first resting pose includes, in accordance with a determination that the first user input parameter of the first input is a second value, different from the first value, moving the virtual object to the first resting pose that includes a second set of spatial characteristics, different from the first set of spatial characteristics, such as computer system 101 moving virtual object 706 to the location on the table shown in FIG. 7BY based on the fifth velocity of hand 714 (e.g., represented by vectors 795a and 795b) detected by computer system 101 in FIG. 7BX. In some embodiments, the second value of the first user input parameter includes a second value of speed, velocity, magnitude, distance, and/or direction of movement of the input element (e.g., before and/or during and/or at the end of the first input, different from the first value of speed, velocity, magnitude, distance, and/or direction of movement of the input element. In some embodiments, the second set of spatial characteristics of the first resting pose includes a second resting orientation (e.g., of a second set of orientations) and/or second resting location (e.g., within a second set of locations) in the three-dimensional environment.

In some embodiments, moving the virtual object to the second resting pose includes moving the virtual object in accordance with the second resting behavior that is based on a first resting location in the three-dimensional environment associated with the virtual object (e.g., without being impacted by a value of the first user input parameter of the first input), such as computer system 101 moving virtual object 704 to the resting location 770a in three-dimensional environment 702 associated with the first resting behavior of virtual object 704 from FIG. 7BH to FIG. 7BK. In some embodiments, designating the virtual object with the second resting behavior includes defining a respective location (e.g., a predetermined location) and/or orientation (e.g., a predetermined orientation) in the three-dimensional environment that the virtual object is displayed at (e.g., and/or moved to) when the movement of the virtual object is not controlled by the input element (e.g., in response to detecting the end of the first input and in accordance with the determination that the virtual object is designated as having the second resting behavior, the computer system moves the virtual object to the respective location and/or respective orientation in the three-dimensional environment). In some embodiments, the first resting locations in the three-dimensional environment is independent of one or more or all user input parameters (e.g., the first user input parameter) of the first input (e.g., when the virtual object is designated with the second resting behavior, movement of the input element before and/or during and/or at the end of the first input does not impact the resting location and/or resting orientation of the virtual object). Designating the virtual object with the first resting behavior optionally does not include defining a respective location and/or a respective orientation in the three-dimensional environment that the virtual object is displayed at (e.g., and/or moved to) when the movement of the virtual object is not controlled by the input element (e.g., the virtual object is permitted to be moved to a location and/or orientation in the three-dimensional environment that is based on the first user input parameter). In some embodiments, in accordance with a determination that the second resting behavior is associated with a first resting orientation in the three-dimensional environment, the second resting pose includes the first resting orientation (e.g., in addition to including the first resting location). Moving a virtual object in a three-dimensional environment after a user ceases to control the virtual object based on a user input parameter when the virtual object is designated as having a first resting behavior or based on a defined resting location when the virtual object is designated as having a second resting behavior provides the user a predictable result to the end of control of the virtual object that is based on the designated resting behavior of the virtual object, which reduces errors and improves efficiency in user-device interaction.

In some embodiments, the first user input parameter includes a representative gaze location (e.g., at a time at or within 0.1 0.2, 0.5, 1, 2, 5, or 10 seconds of the end of the first input), such as the location of gaze 780a detected by computer system 101 in FIG. 7BZ. In some embodiments, the representative gaze location corresponds to a location of a gaze of a user of the computer system. In some embodiments, the representative gaze location corresponds to a location of a cursor in the three-dimensional environment. In some embodiments, the representative gaze location corresponds to a position (e.g., location) of the input element relative to the three-dimensional environment (e.g., a hand and/or controller position relative to the three-dimensional environment). In some embodiments, a first value of the first user input parameter is a representative gaze location having a first location in the three-dimensional environment, and a second value of the first user input parameter is a representative gaze location having a second location, different from the first location, in the three-dimensional environment. Moving a virtual object in a three-dimensional environment after a user ceases to control the virtual object based on a representative gaze position when the virtual object is designated as having a first resting behavior or based on a defined resting location when the virtual object is designated as having a second resting behavior provides the user a predictable result to the end of control of the virtual object that is based on the designated resting behavior of the virtual object, which reduces errors and improves efficiency in user-device interaction.

In some embodiments, the representative gaze location is a location of a gaze of a user of the computer system (optionally in the three-dimensional environment) while motion of the gaze of the user was below a threshold amount of movement prior to detection of the end of the first input. (e.g., the location of the gaze was stable prior to detection of the end of the first input), such as the first location of gaze 780a detected by computer system 101 in FIG. 7BZ that is below the threshold amount of movement prior to computer system 101 detecting the end of the second selection input in FIG. 7CA. In some embodiments, the threshold amount of movement is 0.001, 0.002, 0.005, 0.01, 0.02, 0.05, or 0.1 meters (e.g., optionally within a predetermined period of time, such as 0.1, 0.2, 0.5, 1, 2, 5 or 10 seconds). In some embodiments, the location of the gaze of the user is detected within a threshold amount of time of the end of the first input (e.g., 0.1, 0.2, 0.5, 1, 2, 5, or 10 seconds). For example, the computer system detects the motion of the gaze of the user before the end of the first input (e.g., 0.05, 0.1, 0.2, 0.5, 1, 2, or 5 seconds before the end of the first input). In some embodiments, in accordance with a determination that first motion of the gaze of the user is below the threshold amount of movement during first time period prior to detection of the end of the first input and that second motion of the gaze of the user is below the threshold amount of movement during second time period, after the first time period, prior to detection of the end of the first input, the representative gaze location is a location of the gaze of the user during the second motion (e.g., the representative gaze location is a location during motion of the gaze of the user below the threshold amount of movement that occurs closest to the end of the first input). Moving a virtual object in a three-dimensional environment after detecting an end of an input controlling movement of the virtual object based on a stable gaze location (e.g., prior to the end of control of the virtual object) when the virtual object is designated as having a first resting behavior or based on a defined resting location when the virtual object is designated as having a second resting behavior provides a user a predictable result to the end of control of the virtual object that is based on the designated resting behavior of the virtual object, which reduces errors and improves efficiency in user-device interaction.

In some embodiments, the representative gaze location is a location of a gaze of a user of the computer system detected in conjunction with (e.g., concurrently with, just before, or just after) detecting the end of the first input, such as the first location of gaze 780b that computer system 101 detects in conjunction with the end of the second selection input in FIG. 7CA. In some embodiments, the computer system detects the location of the gaze of the user while (e.g., concurrently with) detecting the end of the first input. In some embodiments, the user has the location of the gaze when releasing an air gesture (e.g., the location of the gaze is the respective location of the gaze when two fingers of the hand no longer contact). In some embodiments, the computer system detects the location of the gaze of the user within a threshold amount of time (e.g., 0.1, 0.2, 0.5, 1, 2, 5, or 10 seconds) before or after the computer system detects the end of the first input. In some embodiments, the computer system determines the location of the gaze of the user in response to detecting the end of the first input. Moving a virtual object in a three-dimensional environment after detecting an end of an input (e.g., for controlling movement of the virtual object) based on a gaze location detected at the end of the input when the virtual object is designated as having a first resting behavior or based on a defined resting location when the virtual object is designated as having a second resting behavior provides the user a predictable result to the end of the input that is based on the designated resting behavior of the virtual object, which reduces errors and improves efficiency in user-device interaction.

In some embodiments, the first user input parameter includes a direction of movement associated with the input element. (e.g., at a time at or within 0.1, 0.2, 0.5, 1, 2, 5, or 10 seconds of the end of the first input), such as the direction of the fourth velocity of hand 714 (e.g., represented by vectors 794a and 794b) detected by computer system 101 in FIG. 7BV. In some embodiments, a first value of the first user input parameter is a first direction of movement associated with the input element, and a second value of the first user input parameter is a second direction, different from the first direction, of movement associated with the input element. In some embodiments, the direction of the movement associated with the input element corresponds to a direction of a velocity (e.g., angular velocity) of the movement of the input element. In some embodiments, the computer system detects the direction of the movement associated with the input element prior to detecting the end of the first input. In some embodiments, the computer system detects the direction of the movement associated with the input element while (e.g., concurrently with) detecting the end of the first input. For example, the first user input parameter corresponds to a direction of movement a hand of a user of the computer system had while releasing an air gesture (e.g., performed by the hand). In some embodiments, in accordance with a determination that the direction of the movement associated with the input element is a first direction, the computer system moves the virtual object in a first respective direction in the three-dimensional environment to the first resting pose (e.g., the first respective direction corresponds to the first direction of the movement of the input element). In some embodiments, in accordance with a determination that the direction of the movement associated with the input element is a second direction, different from the first direction, the computer system moves the virtual object in a second respective direction, different from the first respective direction, in the three-dimensional environment to the first resting pose (e.g., the second respective direction corresponds to the second direction of the movement of the input element). In some embodiments, the direction of movement associated with the input element is a direction of movement of an input provided on a hardware input device (e.g., a switch, dial, joystick, button, mouse, keyboard, and/or touchpad) of the input element. In some embodiments, the input element is a hardware device (e.g., a controller), and the direction of movement associated with the input element is a direction of physical movement of the input element itself (e.g., detected by one or more accelerometers, gyroscopes, and/or image sensors of the input element). Moving a virtual object in a three-dimensional environment after detecting an end of an input (e.g., for controlling movement of the virtual object) based on a direction of movement of an input element (e.g., which performed the input) when the virtual object is designated as having a first resting behavior or based on a defined resting location when the virtual object is designated as having a second resting behavior provides the user a predictable result to the end of the input that is based on the designated resting behavior of the virtual object, which reduces errors and improves efficiency in user-device interaction.

In some embodiments, the first user input parameter includes a magnitude of movement associated with the input element (e.g., at a time at or within 0.1, 0.2, 0.5, 1, 2, 5, or 10 seconds from the end of the first input), such as the magnitude of the fifth velocity of movement of hand 714 (e.g., represented by vectors 795a and 795b) detected by computer system 101 in FIG. 7BX. In some embodiments, a first value of the first user input parameter is a first magnitude of movement associated with the input element, and a second value of the first user input parameter is a second magnitude, different from the first magnitude, of movement associated with the input element. In some embodiments, the magnitude of the movement associated with the input element corresponds to an amount (e.g., a distance) of movement of the input element relative to the three-dimensional environment. In some embodiments, the magnitude of the movement associated with the input element corresponds to a magnitude of a velocity (e.g., angular velocity) of the movement associated with the input element. In some embodiments, the computer system detects the magnitude of the movement associated with the input element prior to detecting the end of the first input. In some embodiments, the computer system detects the magnitude of the movement associated with the input element while (e.g., concurrently with) detecting the end of the first input. For example, the first user input parameter corresponds to a magnitude of movement a hand of a user of the computer system had while (and optionally prior to) releasing an air gesture performed by the hand. For example, the first user input parameter corresponds to a magnitude of movement the hand of the user had (e.g., collectively) over a duration of 0.1, 0.2, 0.5, 1, 2, 5, or 10 seconds (e.g., the duration is before and/or includes the detection of the end of the first input). In some embodiments, in accordance with a determination that the magnitude of the movement associated with the input element is a first value, the computer system moves the virtual object by a first amount (e.g., distance) in the three-dimensional environment to the first resting pose. In some embodiments, in accordance with a determination that the magnitude of the movement associated with the input element is a second value, different from the first value, the computer system moves the virtual object by a second amount, different from the first amount, in the three-dimensional environment to the first resting pose. In some embodiments, the magnitude of movement associated with the input element is a magnitude of movement of an input provided on a hardware input device (e.g., a switch, dial, joystick, button, mouse, keyboard, and/or touchpad) of the input element. In some embodiments, the input element is a hardware device (e.g., a controller), and the magnitude of movement associated with the input element is a magnitude of physical movement of the input element itself (e.g., detected by one or more accelerometers, gyroscopes, and/or image sensors of the input element). Moving a virtual object in a three-dimensional environment after detecting an end of an input (e.g., for controlling movement of the virtual object) based on a magnitude of movement of an input element (e.g., which performed the input) when the virtual object is designated as having a first resting behavior or based on a defined resting location when the virtual object is designated as having a second resting behavior provides the user a predictable result to the end of the input that is based on the designated resting behavior of the virtual object, which reduces errors and improves efficiency in user-device interaction.

In some embodiments, the first resting pose includes a first spatial property (e.g., a resting location and/or orientation of the virtual object in the three-dimensional environment) that satisfies one or more spatial constraints, such as the first resting pose of virtual object 706 in FIG. 7BW satisfying the fourth set of spatial constraints associated with the fourth resting behavior of virtual object 706 (e.g., which designates virtual object 706 to rest at any location on the surface of the table when movement of virtual object 706 is not controlled by an input element, such as hand 714). In some embodiments, the one or more spatial constraints are associated with the first resting behavior. In some embodiments, the one or more spatial constraints restrict where in the three-dimensional environment the virtual object may rest when the virtual object is not being controlled by the input element. In some embodiments, the one or more spatial constraints define one or more respective resting poses (e.g., the first resting pose or the second resting pose) the virtual object may be moved to when the computer system ceases control of the virtual object by the input element. In some embodiments, the one or more spatial constraints restrict movement of the virtual object (e.g., automatic movement of the virtual object in response to detecting the end of the first input) to one or more locations in the three-dimensional environment. In some embodiments, the one or more spatial constraints restrict movement of the virtual object (e.g., automatic movement of the virtual object in response to detecting the end of the first input) to one or more objects (e.g., and/or one or more respective surfaces of the one or more objects) in the three-dimensional environment. In some embodiments, the one or more spatial constraints restrict movement of the virtual object (e.g., automatic movement of the virtual object in response to detecting the end of the first input) to one or more regions (e.g., one or more volumes optionally including a plurality of locations) of the three-dimensional environment. The one or more spatial constraints are optionally independent of any input parameter(s) associated with the first input and/or the end of the first input (e.g., having one or more characteristics of the first input parameter described above). The one or more spatial constraints are optionally independent of a first subset of input parameter(s) associated with the first input and optionally dependent on a second subset of input parameter(s) associated with the first input. For example, the one or more spatial constraints are independent of movement associated with the first input and/or the end of the first input, but are dependent on a representative gaze location associated with the first input and/or the end of the first input (e.g., in accordance with a determination that the representative gaze location corresponds to a first region of the three-dimensional environment, the one or more spatial constraints restrict movement of the virtual object to the first region of the three-dimensional environment). In some embodiments, in response to detecting the end of the first input, the computer system moves the virtual object to a respective resting pose that satisfies the one or more spatial constraints independent of one or more user input parameters of the first input (e.g., the first user input parameter described above). For example, in accordance with a determination that the first input (and/or the end of the first input) includes a direction of movement away from a location and/or region of the three-dimensional environment that satisfies the one or more spatial constraints, the computer system, in a first portion of movement, moves the virtual object in a first direction corresponding to the direction of movement of the first input and, during a second portion of movement (after the first portion of movement), moves the virtual object in a second direction toward the location and/or region of the three-dimensional environment that satisfies the one or more spatial constraints (e.g., such that the respective resting pose the virtual object is moved to at the end of the movement is at the location and/or within the region of the three-dimensional environment that satisfies the one or more spatial constraints). In some embodiments, the second resting pose is not based on the one or more spatial constraints. For example, the second resting pose is based on a user input parameter (e.g., having one or more characteristics of the first user input parameter described above) that is independent of the one or more spatial constraints. In some embodiments, the one or more spatial constraints are associated with a respective application (e.g., the virtual object is associated with the respective application). In some embodiments, the one or more spatial constraints are associated with the virtual object (e.g., independent of a respective application the virtual object is associated with). For example, the virtual object includes the one or more spatial constraints in accordance with a determination that virtual object is a virtual object of a first respective type, and the virtual object includes one or more second spatial constraints, different from the one or more spatial constraints, in accordance with a determination that the virtual object is a virtual object of a second respective type, different from the first respective type (e.g., a first respective type of virtual object is a virtual window, and a second respective type of virtual object is a virtual representation of a user or of a physical object). In some embodiments, the one or more spatial constraints are defined by a user of the computer system (e.g., in one or more settings associated with a user profile). Moving a virtual object in a three-dimensional environment after a user ceases to control the virtual object based on a user input parameter and one or more spatial constraints when the virtual object is designated as having a first resting behavior or based on a defined resting location when the virtual object is designated as having a second resting behavior provides the user a predictable result to the end of control of the virtual object that is based on the designated resting behavior of the virtual object, which reduces errors and improves efficiency in user-device interaction.

In some embodiments, the one or more spatial constraints include a constraint that restricts the first resting pose to a respective surface (e.g., one or more locations of a respective surface) in the three-dimensional environment, such as the fourth set of spatial constraints associated with the fourth resting behavior of virtual object 706 restricting the first resting pose of virtual object 706 shown in FIG. 7BW to the surface of the table in three-dimensional environment 702. In some embodiments, moving the virtual object to the first resting pose includes moving the virtual object onto the respective surface (e.g., snapping the virtual object to the respective surface). In some embodiments, the respective surface is a representation of a physical surface (e.g., a real-world surface from the physical environment) visible in the three-dimensional environment (e.g., through video passthrough) that is, optionally, detected using one or more sensors of the computer system. In some embodiments, the respective surface is a representation of a virtual surface (e.g., included in a virtual environment) visible in the three-dimensional environment. In some embodiments, the constraint restricts the first resting pose to a first resting location on the respective surface (e.g., moving the virtual object to the first resting pose includes moving the virtual object to the first resting location on the respective surface). In some embodiments, the constraint restricts the first resting pose to a plurality of locations (e.g., included in a region) of the respective surface (e.g., moving the virtual object to the first resting pose includes moving the virtual object to a location of the plurality of locations of the respective surface). In some embodiments, the constraint restricts the first resting pose to the respective surface without restricting the first resting pose to a respective location and/or region of the respective surface (e.g., the first resting pose may include any location on the respective surface). In some embodiments, the constraint restricts movement of the virtual object to the surface (e.g., the virtual object must be moved while remaining snapped to the surface such that the virtual object optionally slides on the surface). In some embodiments, the one or more spatial constraints are defined by a representative gaze location associated with the first input and/or the end of the first input (e.g., having one or more characteristics of the representative gaze location described above). For example, in accordance with a determination that the representative gaze location corresponds to a first surface in the three-dimensional environment, the one or more spatial constraints restricts the first resting pose to the first surface, and in accordance with a determination that the representative gaze location corresponds to a second surface, different from the first surface, in the three-dimensional environment, the one or more spatial constraints restricts the first resting pose to the second surface. The first resting pose on the respective surface optionally has a first set of characteristics that are based on a representative gaze location and a first user input parameter (e.g., having one or more characteristics of the first user input parameter described above) different from the representative gaze location (e.g., in accordance with a determination that the representative gaze location corresponds to a first surface and/or region in the three-dimensional environment, the first resting pose includes a location and/or orientation on the first surface and/or with the first region that is based on a speed, magnitude, direction, and/or velocity of movement associated with the input element during and/or before and/or at the end of the first input). Moving a virtual object in a three-dimensional environment after a user ceases to control the virtual object to a location on a respective surface that is based on a user input parameter when the virtual object is designated as having a first resting behavior or to a defined resting location when the virtual object is designated as having a second resting behavior provides the user a predictable result to the end of control of the virtual object that is based on the designated resting behavior of the virtual object, which reduces errors and improves efficiency in user-device interaction.

In some embodiments, the one or more spatial constraints include a constraint that restricts the first resting pose to a respective region of the three-dimensional environment, such as the fifth set of spatial constraints associated with the fifth resting behavior of virtual object 706 restricting the resting pose of virtual object 706 shown in FIG. 7CB to the surface of the table in three-dimensional environment 702. In some embodiments, the respective region is a set of locations in the three-dimensional environment. For example, moving the virtual object to the first resting pose includes moving the virtual object to a respective location of the set of locations in the three-dimensional environment (e.g., the respective location of the set of locations is based on the first user input parameter). In some embodiments, the respective region is a volume of the three-dimensional environment. In some embodiments, the respective region corresponds to a respective object (e.g., a representation of a physical object or a representation of a virtual object) in the three-dimensional environment (e.g., and/or a surface of the respective object). For example, moving the virtual object to the first resting pose includes moving the virtual object to the respective object in the three-dimensional environment (e.g., snapping the virtual object to the respective object). In some embodiments, the respective region of the three-dimensional environment is defined by a respective application that is associated with the virtual object. For example, the computer system displays content associated with the respective application (e.g., the virtual object) within the respective region of the three-dimensional environment (e.g., the computer system does not display content associated with the respective application, such as the virtual object, outside of the respective region of the three-dimensional environment). For example, the respective application requires the virtual object to rest at one or more designated locations in the three-dimensional environment (e.g., the respective application is associated with a virtual game, such as a video game or a virtual board game, and the virtual object may rest at one or more locations defined by the virtual game, such as at one or more locations on a virtual playing surface). In some embodiments, the one or more spatial constraints include a constraint that restricts the first resting pose to a plurality of regions of the three-dimensional environment that are non-contiguous (e.g., the first resting pose is within a respective region of the plurality of regions of the three-dimensional environment that is based on a user input parameter and/or based on a location of the virtual object at the end of the first input). Moving a virtual object in a three-dimensional environment after a user ceases to control the virtual object to a location within a region of the three-dimensional environment that is based on a user input parameter when the virtual object is designated as having a first resting behavior or to a defined resting location when the virtual object is designated as having a second resting behavior provides the user a predictable result to the end of control of the virtual object that is based on the designated resting behavior of the virtual object, which reduces errors and improves efficiency in user-device interaction.

In some embodiments, in accordance with a determination that the virtual object corresponds to a first respective type of virtual object (e.g., virtual object 704), the respective region of the three-dimensional environment is a first region (e.g., and/or first location) of the three-dimensional environment, such as computer system 101 designating virtual object 704 to rest at resting location 770a in three-dimensional environment 702 in FIGS. 7BH to FIG. 7BO. In some embodiments, in accordance with a determination that the virtual object corresponds to a second respective type of virtual object (e.g., virtual object 706), different from the first respective type of virtual object, the respective region of the three-dimensional environment is a second region (e.g., and/or second location), different from the first region, of the three-dimensional environment, such as computer system 101 designating virtual object 706 to rest at any location on the surface of the table in three-dimensional environment 702 in FIGS. 7BT to FIG. 7CE. In some embodiments, the virtual object is associated with a respective application (e.g., as described above) that defines different resting regions for different types of virtual objects. For example, the respective application is associated with a virtual game (e.g., a video game or a virtual board game), the first respective type of virtual object is a first object of the virtual game that has one or more first designated resting locations, and the second respective type of virtual object is a second object, different from the first object, of the virtual game that has one or more second designated resting locations, different from the one or more first designated resting locations. For example, the first respective type of virtual object may rest anywhere on a respective surface in the three-dimensional environment, and the second respective type of virtual object must rest at one or more defined locations on the surface in the three-dimensional environment (e.g., the first respective type of virtual object is a card that may be placed at one or more first locations on a surface, and the second respective type of virtual object is a die that may be placed at any location on the surface). In some embodiments, the respective region is the first region in accordance with a determination that the virtual object is associated with a first application (e.g., the first application is permitted to display content within the first region of the three-dimensional environment), and the respective region is the second region in accordance with a determination that the virtual object is associated with a second application, different from the first application (e.g., the second application is permitted to display content within the second region of the three-dimensional environment). Moving a virtual object in a three-dimensional environment after a user ceases to control the virtual object to a first region when the virtual object is a first respective type of virtual object and to a second region when the virtual object is a second respective type of virtual object provides the user a predictable result to the end of control of the virtual object that is based on the type of virtual object, which reduces errors and improves efficiency in user-device interaction.

In some embodiments, the first resting pose is defined by the first user input parameter (e.g., by a respective value of the first user input parameter) without being defined by one or more (or any) spatial constraints (e.g., without restricting movement of the virtual object to a respective surface and/or region of the three-dimensional environment), such as the third resting pose of virtual object 704 shown in FIG. 7BS being defined by the velocity (e.g., angular velocity) of hand 714 detected by computer system 101 in FIG. 7BQ without being defined by a predetermined location, region, and/or orientation associated with the third resting behavior of virtual object 704. In some embodiments, the virtual object may rest at any location (e.g., that is not already occupied by an object) and/or orientation in the three-dimensional environment (e.g., one or more spatial properties of the first resting pose are not required to satisfy one or more spatial constraints). For example, the first resting pose is based (e.g., solely) on a speed, direction, magnitude, and/or velocity of the input element (e.g., before and/or during and/or at the end of the first input). For example, in accordance with a determination that the first input (and/or the end of the first input) includes movement in a first direction, the computer system moves the virtual object in a first respective direction corresponding to the first direction in response to detecting the end of the first input (e.g., the first resting pose includes a location in the three-dimensional environment at the end of a path movement of the virtual object in the first respective direction), and in accordance with a determination that the first input (and/or the end of the first input) includes movement in a second direction, different from the first direction, the computer system moves the virtual object in a second respective direction, different from the first respective direction, corresponding to the second direction in response to detecting the end of the first input (e.g., the first resting pose includes a location in the three-dimensional environment at the end of a path of movement of the virtual object in the second respective direction). In some embodiments, the second resting pose is defined by one or more spatial constraints without being defined by one or more user input parameters (e.g., the first user input parameter). For example, in response to detecting the end of the first input, and in accordance with the determination that the virtual object is designated as having the second resting behavior, the computer system moves the virtual object to a predetermined location (or region) and/or orientation in the three-dimensional environment (e.g., the predetermined location (or region) and/or orientation is independent of the movement of the input element before and/or during and/or at the end of the first input). Moving a virtual object in a three-dimensional environment after a user ceases to control the virtual object based on one or more user input parameters without spatial constraints when the virtual object is designated as having a first resting behavior or based on a defined resting location when the virtual object is designated as having a second resting behavior provides the user a predictable result to the end of control of the virtual object that is based on the designated resting behavior of the virtual object, which reduces errors and improves efficiency in user-device interaction.

In some embodiments, moving the virtual object to the first resting pose includes, in accordance with a determination that a first user input parameter of the first input is a first value, moving the virtual object over a first portion of a movement of the virtual object to the first resting pose in a first manner corresponding to the first user input parameter, such as computer system 101 rotating virtual object 704 in FIG. 7BQ in response to the angular rotation of hand 714 during the movement of virtual object 704 along path 774 to the second resting pose shown in FIG. 7BR. In some embodiments, moving the virtual object to the first resting pose includes, in accordance with a determination that the first user input parameter of the first input is a second value, different from the first value, moving the virtual object over a first portion of a movement of the virtual object to the first resting pose in a second manner, different from the first manner, corresponding to the first user input parameter. In some embodiments, the first user input parameter has one or more characteristics of the first user input parameter described above (e.g., and the first value of the first user input parameter has one or more characteristics of the first value of the first user input parameter described above). In some embodiments, the movement of the virtual object to the first resting pose includes the first portion of the movement and a second portion, after the first portion, of the movement. In some embodiments, the movement of the virtual object during the first portion of the movement is at least partially based on the first user input parameter, and the movement of the virtual object during the second portion of the movement includes movement from the location of the virtual object in the three-dimensional environment at the end of the first portion of the movement to the first resting pose. The first portion of the movement of the virtual object optionally includes movement in a first direction away from a location in the three-dimensional environment corresponding to the first resting pose (e.g., the first direction corresponds to a respective direction of movement of the input element before and/or during and/or at the end of the first input), and the second portion of the movement of the virtual object optionally includes movement in a second direction toward the location in the three-dimensional environment corresponding to the first resting pose (e.g., the second direction does not correspond to the respective direction of movement of the input element before and/or during and/or at the end of the first input). In some embodiments, the first portion of the movement of the virtual object includes rotation of the virtual object in a first direction corresponding to an angular velocity of the input element before and/or during and/or at the end of the first input (e.g., the first resting pose includes a predefined orientation, and the rotation of the virtual object during the first portion of the movement is in a direction that is greater than 180 degrees about an axis from the predefined orientation). In some embodiments, the first portion of the movement includes a distance and/or magnitude that is independent from a distance from the location of the virtual object at the end of the first input and a location corresponding to the first resting pose (e.g., the distance and/or magnitude of movement of the virtual object during the first portion of the movement of the virtual object is at least partially based on a distance, magnitude, velocity, and/or acceleration of movement of the input element before and/or during and/or at the end of the first input). The computer system optionally transitions from moving the virtual object based at least partially on the first user input parameter (e.g., during the first portion of movement of the virtual object) to moving the virtual object to the first resting pose (e.g., over a period of time, such as 0.1, 0.2, 0.5, 1, 2, 5, or 10 seconds). In some embodiments, moving the virtual object to the first resting pose in the first manner includes moving the virtual object with a velocity (e.g., angular velocity) that corresponds to the first value of the first user input parameter (e.g., the speed, velocity, angular velocity, acceleration, and/or distance of movement of the input element before and/or during and/or at the end of the first input). In some embodiments, moving the virtual object to the first resting pose in the first manner includes changing an orientation (e.g., rotating) the virtual object in a direction and/or by a magnitude (e.g., with an angular velocity) that corresponds to the first value of the first user parameter (e.g., the angular velocity of movement of the input element before and/or during and/or at the end of the first input).

In some embodiments, moving the virtual object to the second resting pose includes, in accordance with the determination that the first user input parameter of the first input is the first value, moving the virtual object over a first portion of a movement of the virtual object to the second resting pose in the first manner corresponding to the first user input parameter, such as computer system 101 rotating virtual object 704 in FIG. 7BQ in response to the angular rotation of hand 714 during the movement of virtual object 704 along path 774 to the third resting pose shown in FIG. 7BS. In some embodiments, moving the virtual object to the second resting pose includes, in accordance with the determination that the first user input parameter of the first input is the second value, moving the virtual object over a first portion of a movement of the virtual object to the second resting pose in the second manner corresponding to the first user input parameter. In some embodiments, moving the virtual object over the first portion of the movement of the virtual object to the second resting pose in the first manner has one or more characteristics of moving the virtual object over the first portion of the movement of the virtual object to the first resting pose as described above. Moving a virtual object in a three-dimensional environment after a user ends an input that controls movement of the virtual object based on a user input parameter of the input provides the user a predictable result to the end of control of the virtual object that is based on the user input parameter performed by the user, which reduces errors and improves efficiency in user-device interaction.

In some embodiments, the first resting pose includes a first resting orientation, such as the resting orientation of virtual object 704 shown in FIG. 7BR. In some embodiments, the first resting orientation corresponds to an orientation relative to the three-dimensional environment (e.g., independent of a display location and/or a current viewpoint of a user of the computer system). In some embodiments, the first resting orientation corresponds to an orientation relative to a current viewpoint of a user of the computer system (e.g., a display location that is independent of a location of the virtual object relative to the three-dimensional environment). In some embodiments, the first resting orientation includes a first surface and/or feature of the virtual object having a respective orientation in the three-dimensional environment (e.g., a first surface is required to rest on a respective surface in the three-dimensional environment, or a first feature of the virtual, such as a head of a representation of an animal, is required to rest in an upright position). In some embodiments, moving the virtual object to the first resting orientation includes changing an orientation of the virtual object from the orientation of the virtual object at the end of the first input (e.g., automatically and/or based on a user input parameter having one or more characteristics of the first user input parameter described above). In some embodiments, the first resting orientation is a predetermined orientation associated with the first resting behavior of the virtual object. For example, in response to detecting an end of an input corresponding to controlling movement of the virtual object, and in accordance with a determination that the virtual object is designated as having the first resting behavior, the computer system moves the virtual object to the first resting orientation (e.g., automatically without additional user input). In some embodiments, the first resting orientation is a predetermined orientation, and in accordance with a determination that the first input and/or the end of the first input movement includes an angular velocity in a direction toward the predetermined orientation (e.g., in a direction that corresponds to the shortest orientation change of the virtual object to the predetermined orientation), the computer system moves the virtual object to the predetermined orientation over a first period of time, and in accordance with a determination that the first input and/or the end of the first input includes an angular velocity in a direction away from the predetermined orientation (e.g., in a direction that does not correspond to the shortest orientation change of the virtual object to the predetermined orientation), the computer system moves the virtual object to the predetermined orientation over a second period of time, longer than the first period of time. In some embodiments, the first resting orientation is based on a respective value of a user input parameter (e.g., an angular velocity of the input element before and/or during and/or at the end of the first input).

In some embodiments, the second resting pose includes a second resting orientation, different from the first resting orientation, such as the resting orientation of virtual object 704 shown in FIG. 7BS. In some embodiments, the first resting orientation corresponds to a first respective orientation relative to the three-dimensional environment, and the second resting orientation corresponds to a second respective orientation, different from the first respective orientation, relative to the three-dimensional environment. In some embodiments, the first resting orientation corresponds to a first respective orientation relative to a current viewpoint of a user of the computer system, and the second resting orientation corresponds to a second respective orientation, different from the first respective orientation, relative to the current viewpoint of the user of the computer system. In some embodiments, the first resting orientation includes a first surface and/or feature of the virtual object having a first respective orientation in the three-dimensional environment, and the second resting orientation includes the first surface and/or feature of the virtual object having a second respective orientation, different from the first respective orientation, in the three-dimensional environment. In some embodiments, the first resting orientation is a first predetermined orientation associated with the first resting behavior of the virtual object, and the second resting orientation is a second predetermined orientation, different from the first predetermined orientation, associated with the second resting behavior of the virtual object. In some embodiments, the first resting orientation is based on one or more respective values of one or more user input parameters associated with the first input and/or the end of the first input (e.g., the one or more user input parameters have one or more characteristics of the first user input parameter described above), and the second resting orientation is not based on any user input parameter associated with the first input and/or the end of the first input. For example, the first resting orientation is based on a first user input parameter associated with the first input and/or the end of the first input, and the second resting orientation is a predetermined resting orientation (e.g., that is not impacted by a value of any user input parameter associated with the first input and/or the end of the first input). In some embodiments, the first resting orientation is based on a respective value of a first user input parameter (e.g., direction of movement associated with the input element) associated with the first input and/or the end of the first input, and the second resting orientation is based on a second user input parameter (e.g., magnitude of movement associated with the input element), different from the first user input parameter, associated with the first input and/or the end of the first input. In some embodiments, the first resting pose includes a same resting orientation as the second resting pose but a different resting location in the three-dimensional environment. In some embodiments, the first resting pose includes a same resting location in the three-dimensional environment as the second resting pose but a different resting orientation. Moving a virtual object in a three-dimensional environment after a user ceases to control the virtual object to a first resting orientation when the virtual object is designated as having a first resting behavior or to a second resting orientation when the virtual object is designated as having a second resting behavior provides the user a predictable result to the end of control that is based on the designated resting behavior of the virtual object, which reduces errors and improves efficiency in user-device interaction.

In some embodiments, ceasing controlling of the virtual object by the input element includes, in accordance with a determination that the end of the first input includes movement of the input element having a first angular velocity in a first angular direction, rotating the virtual object in a first manner that corresponds to the first angular velocity, such as computer system 101 rotating virtual object 704 in the second manner represented by second row 798b in FIG. 7BP in response to detecting the first angular rotation of the input element (e.g., hand 714). In some embodiments, ceasing controlling of the virtual object by the input element includes, in accordance with a determination that the end of the first input includes movement of the input element having a second angular velocity in a second angular direction, different from the first angular direction, rotating the virtual object in a second manner, different from the first manner, that corresponds to the second angular velocity, such as computer system 101 rotating virtual object 704 in the third manner represented by third row 798c in response to detecting the third angular rotation of the input element (e.g., hand 714). In some embodiments, the rotation of the virtual object in the first manner and/or the rotation of the virtual object in the second manner occurs over a first portion of the movement of the virtual object to its respective resting pose (e.g., having one or more characteristics of the first portion of the movement of the virtual object to the first resting pose described above). In some embodiments, the movement of the virtual object to its respective resting pose (e.g., the first resting pose or the second resting pose) includes a direction of rotation that is based on the direction of rotation of the input element (e.g., before and/or during and/or at the end of the first input). In some embodiments, rotating the virtual object in the first manner includes rotating the virtual object about one or more first axes of the virtual object (e.g., an X, Y, and/or Z axis of the virtual object), and rotating the virtual object in the second manner includes rotating the virtual object about one or more second axes of the virtual object, different from the one or more first axes of the virtual object (e.g., rotating the virtual object in the first manner includes rotating the virtual object about a X-axis of the virtual object, and rotating the virtual object in the second manner includes rotating the virtual object about a Y-axis of the virtual object, or rotating the virtual object in the first manner includes rotating the virtual object about a X-axis and a Y-axis of the virtual object, and rotating the virtual object in the second manner includes rotating the virtual object about the X-axis and a Z-axis of the virtual object). In some embodiments, rotating the virtual object in the first manner includes rotating the virtual object about a first axis in a first direction, and rotating the virtual object in the second manner includes rotating the virtual object about the first axis in a second direction, different from the first direction. In some embodiments, rotating the virtual object in the first manner includes rotating the virtual object in a first direction with a first magnitude, and rotating the virtual object in the second manner includes rotating the virtual object in the first direction with a second magnitude, different from the first magnitude. In some embodiments, rotating the virtual object in the first manner and/or the second manner includes rotating the virtual object in a direction that is independent of a direction corresponding to the shortest orientation change to a respective resting orientation (e.g., a predefined resting orientation associated with the first resting pose or the second resting pose). In some embodiments, rotating the virtual object in the first manner and/or the second manner includes rotating the virtual object no more than 360, 720, or 1080 degrees from the orientation of the virtual object at the end of the first input to a respective resting orientation (e.g., a predefined resting orientation associated with the first resting pose or the second resting pose). In some embodiments, in accordance with a determination that the end of the first input includes movement having a translational velocity of a first direction, the computer system moves the virtual object in a first respective direction in the three-dimensional environment (e.g., during a first portion of the movement of the virtual object to its respective resting pose, as described above) corresponding to the first direction of the translational velocity, and in accordance with a determination that the end of the first input includes movement having a translational velocity of a second direction, different from the first direction, the computer system moves the virtual object in a second respective direction, different from the first respective direction, in the three-dimensional environment corresponding to the second direction of the translational velocity (e.g., during a first portion of the movement of the virtual object to its respective resting pose, as described above). In some embodiments, in accordance with a determination that the end of the first input does not include movement of the input element, the computer system rotates the virtual object in a third manner, different from the first manner and the second manner. For example, the computer system moves the virtual object directly to a respective resting orientation (e.g., as described below). Rotating a virtual object in a three-dimensional environment after detecting an end of an input for controlling movement of the virtual object in a first manner based on an angular velocity of a first direction associated with the end of the input or in a second manner based on an angular velocity of a second direction associated with the end of the input provides the user a predictable result to the end of the input that is based on a user input parameter, which reduces errors and improves efficiency in user-device interaction.

In some embodiments, ceasing controlling of the virtual object by the input element includes, in accordance with a determination that the end of the first input includes movement of the input element having an angular velocity of a first angular magnitude, rotating the virtual object in a first manner that corresponds to the angular velocity of the first magnitude, such as computer system 101 rotating virtual object 704 in the third manner represented by third row 798c in FIG. 7BP in response to detecting the third angular rotation of the input element (e.g., hand 714). In some embodiments, ceasing controlling of the virtual object by the input element includes, in accordance with a determination that the end of the first input includes movement of the input element having an angular velocity of a second angular magnitude, different from the first angular magnitude, rotating the virtual object in a second manner, different from the first manner, that corresponds to the angular velocity of the second magnitude, such as computer system 101 rotating virtual object 704 in the fourth manner represented by fourth row 798d in FIG. 7BP in response to detecting the fourth angular rotation of the input element (e.g., hand 714). In some embodiments, the rotation of the virtual object in the first manner and/or the rotation of the virtual object in the second manner occurs over a first portion of the movement of the virtual object to its respective resting pose (e.g., having one or more characteristics of the first portion of the movement of the virtual object described above). In some embodiments, rotating the virtual object in the first manner includes rotating the virtual object with an angular velocity and/or rotational speed that is based on the magnitude of movement of the input element before and/or during and/or at the end of the first input. For example, in accordance with a determination that the first angular magnitude of the movement of the input element is greater than the second angular magnitude of the movement of the input element, rotating the virtual object in the first manner includes rotating the virtual object with an angular velocity and/or rotational speed (e.g., a rate of rotation) that is greater than rotating the virtual object in the second manner. In some embodiments, the respective resting pose (e.g., the first resting pose or the second resting pose) of the virtual object includes a predefined orientation, and rotating the virtual object in the first manner or the second manner does not include passing the predefined orientation (e.g., in accordance with a determination that the current orientation of the virtual object during the movement of the virtual object to the respective resting pose is the predefined orientation, the computer system ceases to rotate the virtual object). In some embodiments, in accordance with a determination that the end of the first input includes movement of the input element having a translational velocity of a first magnitude, the computer system moves the virtual object with a first speed and/or velocity corresponding to the translational velocity of the first magnitude (e.g., during a first portion of the movement of the virtual object to its respective resting pose, as described above), and in accordance with a determination that the end of the first input includes movement of the input element having a translational velocity of a second magnitude, different from the first magnitude, the computer system moves the virtual object with a second speed and/or velocity, different from the first speed and/or velocity, corresponding to the translational velocity of the second magnitude (e.g., during a first portion of the movement of the virtual object to its respective resting pose, as described above). Rotating a virtual object in a three-dimensional environment after detecting an end of an input for controlling movement of the virtual object in a first manner based on an angular velocity of a first magnitude associated with the end of the input or in a second manner based on an angular velocity of a second magnitude associated with the end of the input provides the user a predictable result to the end of the input that is based on a user input parameter (e.g., angular velocity of an input element), which reduces errors and improves efficiency in user-device interaction.

In some embodiments, ceasing controlling of the virtual object by the input element includes, in accordance with a determination that the end of the first input does not include angular movement of the input element, and in accordance with a determination that a shortest angular distance to a respective resting orientation (e.g., the first resting orientation or the second resting orientation) of the virtual object is in a first angular direction, rotating the virtual object in the first angular direction to the respective resting orientation, such as computer system 101 rotating virtual object 704 in the angular direction represented in first row 798a in FIG. 7BP in response to detecting no angular rotation of the input element (e.g., hand 714). In some embodiments, ceasing controlling of the virtual object by the input element includes, in accordance with a determination that the end of the first input does not include angular movement of the input element, and in accordance with a determination that the shortest angular distance to the respective resting orientation of the virtual object is in a second angular direction, different from the first angular direction, rotating the virtual object in the second angular direction to the respective resting orientation, such as computer system 101 rotating virtual object 704 in the angular direction shown in FIGS. 7BL to FIG. 7BN in response to detecting no translational and/or rotational movement of hand 714 during the end of the first selection input. In some embodiments, the respective resting orientation is a predetermined orientation in the three-dimensional environment associated with the first resting behavior and/or the second resting behavior of the virtual object. In some embodiments, moving the virtual object to the respective resting orientation includes rotating the virtual object by the least amount possible (e.g., by the least magnitude) between the orientation of the virtual object at the end of the first input to the respective resting orientation. In some embodiments, rotating the virtual object in the first angular direction and/or the second angular direction includes rotating the virtual object by less than 180 degrees (e.g., about a first axis of the virtual object). In some embodiments, in accordance with a determination that the end of the first input does not include movement (e.g., translational and/or angular movement) of the input element, the computer system moves the virtual object from a location of the virtual object at the end of the first input directly to a respective resting location (e.g., a location associated with the first resting pose or the second resting pose). For example, the respective resting location is a predetermined location in the three-dimensional environment associated with the first resting behavior and/or the second resting behavior of the virtual object. In some embodiments, moving the virtual object directly to the respective resting location includes moving the virtual object by the least amount possible (e.g., by the least distance and/or magnitude) between the location of the virtual object at the end of the first input to the respective resting location. In some embodiments, the computer system rotates the virtual object to the respective resting orientation while moving the virtual object to the respective resting location (e.g., gradually over the duration of the movement of the virtual object to the respective resting location). In some embodiments, in accordance with a determination that the orientation of the virtual object at the end of the first input is the respective resting orientation, the computer system forgoes rotating the virtual object (e.g., and moves the virtual object to a respective resting location associated with the first resting behavior and/or the second resting behavior). Moving a virtual object in a three-dimensional environment directly to a respective resting orientation after detecting an end of an input for controlling movement of the virtual object when the end of the first input does not include movement provides a predictable result to the end of the first input that is based on a user input parameter (e.g., angular velocity of an input element), which reduces errors and improves efficiency in user-device interaction.

In some embodiments, the first resting orientation is based on one or more first orientation constraints (e.g., a restriction on the resting orientation of the virtual object), such as the first resting orientation of virtual object 704 shown in FIG. 7BK being based on the first set of spatial constraints associated with the first resting behavior that designates virtual object 704 to rest in an upright orientation in three-dimensional environment 702. In some embodiments, the one or more first orientation constraints have one or more characteristics of the one or more spatial constraints described above. In some embodiments, the one or more first orientation constraints are associated with the first resting behavior of the virtual object and restrict movement of the virtual object to one or more resting orientations in the three-dimensional environment including the first resting orientation. For example, the one or more first orientation constraints include a constraint that restricts movement of the virtual object to a range of orientations that includes the first orientation. In some embodiments, the one or more first orientation constraints are independent of any input user parameter (e.g., a speed, direction, magnitude, and/or velocity of movement associated with the input element before and/or during and/or at the end of the first input does not affect the first resting orientation). In some embodiments, the one or more first orientation constraints are independent of a first subset of user input parameters but dependent on a second subset of user input parameters. For example, the first resting orientation is not based on a speed, direction, magnitude and/or velocity of movement associated with the input element but the first resting orientation is based on a representative gaze location (e.g., in accordance with a determination that the representative gaze location corresponds to a surface, the first resting orientation includes a respective surface of the virtual object snapped to the surface).

In some embodiments, the second resting orientation is based on one or more second orientation constraints, different from the one or more first orientation constraints, such as the resting orientation of virtual object 704 in FIG. 7BS being based on the third set of spatial constraints associated with the third resting behavior that designates virtual object 704 to rest at any orientation in three-dimensional environment 702 (e.g., based on an angular velocity of the hand 714 detected in conjunction with the end of the first selection input). In some embodiments, the one or more second orientation constraints have one or more characteristics of the one or more spatial constraints described above. In some embodiments, the one or more second orientation constraints are associated with the second resting behavior of the virtual object and restrict movement of the virtual object to one or more orientations in the three-dimensional environment including the second resting orientation. In some embodiments, in accordance with a determination that the virtual object is a first respective type of virtual object, the movement of the virtual object in response to the detection of the end of the first input is restricted based on the one or more first orientation constraints, and in accordance with a determination that the virtual object is a second respective type of virtual object, different from the first respective type of virtual object, the movement of the virtual object in response to the detection of the end of the first input is restricted based on the one or more second orientation constraints. For example, the first respective type of virtual object is required to rest in a respective orientation (e.g., an upright orientation) in the three-dimensional environment (e.g., on a respective surface in the three-dimensional environment), and the second respective type of virtual object is not required to rest in the respective orientation in the three-dimensional environment (e.g., the second respective type of virtual object may rest in an orientation that is based on one or more user input parameters associated with the first input, such as the first user input parameter described above, without being constrained to one or more locations and/or regions of the three-dimensional environment). Moving a virtual object in a three-dimensional environment after a user ceases to control the virtual object to a first resting pose when the virtual object is designated as having one or more first orientation constraints or to a second resting orientation when the virtual object is designated one or more second orientation constraints provides the user a predictable result to the end of control that is based on one or more respective orientation constraints the virtual object has, which reduces errors and improves efficiency in user-device interaction.

In some embodiments, while movement of the virtual object within the three-dimensional environment is controlled by the movement of the input element, before detecting the end of the first input, and in accordance with a determination that one or more snapping criteria are satisfied, the computer system moves the virtual object to a location in the three-dimensional environment corresponding to a surface (e.g., a physical surface or a virtual surface) in the three-dimensional environment (e.g., snapping the virtual object to the surface in the three-dimensional environment), such as computer system 101 moving virtual object 708 to the location in three-dimensional environment 702 corresponding to the surface of the table from FIG. 7CH to FIG. 7CI when virtual object 708 is moved within the threshold distance 786 of the surface of the table during the third selection input. In some embodiments, the surface in the three-dimensional environment has one or more characteristics of the respective surface described above. In some embodiments, the one or more snapping criteria include a criterion that is satisfied when the virtual object is moved (e.g., based on the movement of the input element while movement of the virtual object is controlled by the input element) within a threshold distance of the surface (e.g., 0.001, 0.005, 0.01, 0.02, 0.05, or 0.1 meter from the surface). For example, the criterion is satisfied when a respective side of the virtual object is within the threshold distance of the surface (e.g., in accordance with a determination that a side of the virtual object different from the respective side of the virtual object is within the threshold distance of the surface, the computer system optionally forgoes snapping the virtual object to the surface). In some embodiments, after moving the virtual object to the location corresponding to the surface in the three-dimensional environment, subsequent movement of the virtual object during the first input (e.g., while the one or more snapping criteria are satisfied and/or while the movement of the virtual object is controlled by the input element) occurs while the virtual object has a current location corresponding to the surface (e.g., while the virtual object is snapped to the surface). For example, in accordance with a determination that the one or more snapping criteria are satisfied, the virtual object moves on the surface with a speed and/or direction that corresponds to a speed and/or direction of movement of the input element during the first input. In some embodiments, in accordance with a determination that the one or more snapping criteria are not satisfied (e.g., virtual object does not move within the threshold distance of the surface) during the first input, the computer system moves the virtual object to its respective resting pose (e.g., the first resting pose or the second resting pose) optionally without moving the virtual object to the location corresponding to the surface in the three-dimensional environment (e.g., the first resting pose and/or the second resting pose include locations that do not correspond to the surface in the three-dimensional environment). Moving a virtual object in a three-dimensional environment to a location corresponding to a surface in the three-dimensional environment while movement of the virtual object is controlled by a user (e.g., based on movement of a user input performed by the user) provides a user a predictable result based on their control of the movement of the virtual object and limits the need for additional inputs (e.g., for displaying the virtual object snapped to the surface), which reduces errors, improves efficiency in user-device interaction, and conserves computing resources associated with the additional inputs.

In some embodiments, moving the virtual object to the first resting pose in the three-dimensional environment after detecting the end of the first input includes, in accordance with a determination that a current location of the virtual object corresponds to the surface when the end of the first input is detected (and/or in accordance with a determination that the one or more snapping criteria are satisfied and/or that the virtual object is snapped to the surface when the end of the first input is detected), moving the virtual object along the surface to the first resting pose in the three-dimensional environment (e.g., moving the virtual object in the three-dimensional environment while the current location of the virtual object continues to correspond to the surface) without moving the virtual object along a first axis relative to the surface, such as computer system 101 moving virtual object 708 to the resting location 770b from FIG. 7CJ to FIG. 7CK while maintaining virtual object 708 snapped to the surface of the table in response to detecting virtual object 708 snapped to the table during the end of the third selection input. In some embodiments, the first resting pose corresponds to a location on the surface in the three-dimensional environment (e.g., the virtual object is snapped to the surface when at the first resting pose in the three-dimensional environment). The first axis relative to the surface is optionally perpendicular to the surface. For example, the computer system does not move the virtual object to a location above and/or below the surface during the movement of the virtual object to the first resting pose (e.g., the computer system does not move the virtual object off of and/or through the surface). For example, the computer system moves the virtual object along a plane that is on and/or parallel to the surface in the three-dimensional environment. For example, the computer system moves the virtual object along a second axis and/or a third axis, different from the first axis, to the first resting pose in the three-dimensional environment (e.g., the second axis and the third axis are orthogonal axes on the plane of the surface). In some embodiments, before detecting the end of the first input, the computer system moves the virtual object to a location corresponding to the surface in the three-dimensional environment (e.g., snaps the virtual object to the surface). In some embodiments, moving the virtual object to the first resting pose along the surface includes moving the virtual object in the three-dimensional environment to the first resting pose while the virtual object remains snapped to the surface (e.g., moving the virtual object while the virtual object remains in contact with the surface). In some embodiments, an object is snapped to a surface when at least a portion of the object makes virtual contact with the surface (e.g., a portion of the virtual object coincides with a portion of the surface). For example, the first resting pose includes a location that corresponds to the surface, and the computer system moves the virtual object to the location that corresponds to the surface associated with the first resting pose while a respective side (e.g., surface) of the virtual object is snapped to the surface. In some embodiments, the first resting pose of the virtual object includes an orientation that includes a respective side of the virtual object snapped to the surface. The movement of the virtual object to the first resting pose along the surface optionally does not include rotation of the virtual object such that the respective side of the virtual object remains snapped on the surface during the movement of the virtual object. Alternatively, the movement of the virtual object to the first resting pose optionally includes rotation about a first axis of the virtual object (e.g., about a Y-axis of the virtual object) and optionally does not include rotation about a second axis or a third axis of the virtual object (e.g., about a X-axis or a Z-axis of the virtual object) such that the respective side of the virtual object remains snapped on the surface during the movement of the virtual object. In some embodiments, in accordance with the determination that the current location of the virtual object corresponds to the surface when the end of the first input is detected, the computer system maintains display of the virtual object on the surface independent (e.g., regardless of) a direction and/or magnitude of movement of the input element before and/or during and/or at the end of the first input. In some embodiments, ceasing controlling of the virtual object by the input element further includes, in accordance with a determination that the virtual object is designated as having the second resting behavior, moving the virtual object to the second resting pose after detecting the end of the first input includes, in accordance with a determination that a current location of the virtual object corresponds to the surface when the end of the first input is detected, moving the virtual object away from the surface to the second resting pose (e.g., the second resting pose is associated with a location in the three-dimensional environment that does not correspond to the surface).

In some embodiments, moving the virtual object to the first resting pose in the three-dimensional environment after detecting the end of the first input includes, in accordance with a determination that the current location of the virtual object does not correspond to the surface when the end of the first input is detected (and/or in accordance with a determination that the one or more snapping criteria are not satisfied and/or that the virtual object is not snapped to the surface when the end of the first input is detected), moving the virtual object along the first axis relative to the surface to the first resting pose in the three-dimensional environment (e.g., moving the virtual object toward the surface in the three-dimensional environment), such as computer system 101 moving to resting location 772a from FIG. 7BH to FIG. 7BK in response to detecting the end of the first selection input while virtual object 704 is not snapped to the surface of the table. For example, the computer system moves the virtual object along the first axis, second axis, and/or third axis (e.g., the first axis is perpendicular to the surface as described above, and the computer system optionally moves the virtual object in a first direction along the first axis toward the surface). In some embodiments, before detecting the end of the first input, the computer system moves the virtual object in the three-dimensional environment without the virtual object being snapped to a location in the three-dimensional environment corresponding to the surface. In some embodiments, the first resting pose includes a location that corresponds to the surface (e.g., on the surface), and moving the virtual object relative to the surface includes moving the virtual object from a location that does not correspond to the surface to the location associated with the first resting pose (e.g., snapping the virtual object to the surface in the three-dimensional environment at a location on the surface associated with the first resting pose). In some embodiments, moving the virtual object relative to the surface includes moving the virtual object based on a direction and/or magnitude of movement of the input element before and/or during and/or at the end of the first input. In some embodiments, ceasing controlling of the virtual object by the input element further includes, in accordance with a determination that the virtual object is designated as having the second resting behavior, moving the virtual object to the second resting pose includes, in accordance with a determination that the current location of the virtual object does not correspond to the surface when the end of the first input is detected, moving the virtual object in the three-dimensional environment without moving the virtual object relative to (e.g., toward) the surface (e.g., the second resting pose is associated with a location in the three-dimensional environment that does not correspond to the surface). Moving a virtual object to a respective resting pose in a three-dimensional environment after a user ceases to control the virtual object along a surface if the virtual object is on the surface or relative to the surface if the virtual object is not on the surface provides predictable movement of the virtual object from its location when the user ceases control to its respective resting pose (e.g., that is on the surface), which reduces errors and improves efficiency in user-device interaction.

In some embodiments, moving the virtual object along the surface includes moving the virtual object to a respective destination (e.g., location and/or a location within a region) on the surface, wherein the respective destination is associated with a respective resting behavior (e.g., the first resting behavior or the second resting behavior) associated with the virtual object, such as computer system 101 moving virtual object 708 to the resting location 770b associated with the sixth resting behavior of virtual object 708 along the surface of the table from FIG. 7CJ to FIG. 7CK. In some embodiments, the respective destination is a predetermined resting location and/or region in the three-dimensional environment that the computer system moves the virtual object to in response to detecting the end of the first input (e.g., when the input element ceases to control movement of the virtual object in the three-dimensional environment). In some embodiments, in accordance with a determination that the virtual object is designated as having the first resting behavior, moving the virtual object along the surface includes moving the virtual object to a first resting destination on the surface, and in accordance with a determination that the virtual object is designated as having the second resting behavior, moving the virtual object along the surface includes moving the virtual object to a second resting destination on the surface. In some embodiments, moving the virtual object along the surface includes moving the virtual object to a respective orientation on the surface (e.g., rotating the virtual object about an axis (e.g., a Y-axis of the virtual object) while the virtual object remains snapped on the surface). Moving a virtual object along a surface in a three-dimensional environment to a resting location and/or region on the surface if the virtual object is on the surface when a user ceases to control movement of the virtual object provides predictable movement of the virtual object from its location when the user ceases control to the resting location and/or region on the surface, which reduces errors and improves efficiency in user-device interaction.

In some embodiments, moving the virtual object along the surface includes, in accordance with a determination that the end of the first input includes a user input parameter of a first value, moving the virtual object along the surface in a first manner, such as computer system 101 moving virtual object 708 along path 788 while maintaining virtual object 708 snapped to the table in three-dimensional environment 702 from FIG. 7CJ to FIG. 7CK in response to detecting the end of the third selection input and movement of hand 714 including the sixth velocity of movement (e.g., represented by vectors 796a and 796b). In some embodiments, the user input parameter includes one or more characteristics of the first user input parameter described above (e.g., and the first value of the user input parameter includes one or more characteristics of the first value of the first user input parameter described above). In some embodiments, moving the virtual object along the surface in the first manner includes moving the virtual object with a speed, direction, distance, magnitude, and/or velocity that corresponds to the first value of the user input parameter. For example, the computer system moves the virtual object along the surface in the first manner (e.g., based on the first value of the user input parameter) during a first portion of the movement of the virtual object to its respective resting pose (e.g., having one or more characteristics of the first portion of the movement of the virtual object described above). For example, the computer system moves the virtual object along the surface in a direction away from a location associated with the respective resting pose during a first portion of movement (e.g., based on the first value of the user input parameter), and in a direction toward a location associated with the respective resting pose during a second portion of movement after the first portion of movement. In some embodiments, in accordance with a determination that the end of the first input includes a direction and/or magnitude of movement of the input element away from the surface, the computer system forgoes moving the virtual object away from the surface and moves the virtual object along the surface (e.g., while the virtual object remains snapped to the surface). For example, the computer system moves the virtual object along the surface based on movement of the input element at the end of the first input that is parallel (e.g., and/or within 1, 2, 5, 10, 15, 20, or 25 degrees of parallel) to the surface.

In some embodiments, moving the virtual object along the surface includes, in accordance with a determination that the end of the first input includes a user input parameter of a second value, different from the first value, moving the virtual object along the surface in a second manner, different from the first manner, such as computer system 101 moving the virtual object 708 on a direct path on the surface of the table to the resting location of virtual object 708 shown in FIG. 7CK in accordance with a determination that end of the third selection input does not include movement of hand 714. In some embodiments, the second value of the user input parameter includes one or more characteristics of the second value of the first user input parameter described above. In some embodiments, moving the virtual object along the surface in the second manner includes one or more characteristics of moving the virtual object along the surface in the first manner (e.g., the computer system moves the virtual object along the surface in the second manner during a first portion of the movement of the virtual object to its respective resting pose). In some embodiments, moving the virtual object along the surface in the first manner includes moving the virtual object along a first path on the surface (e.g., to a respective resting destination having one or more characteristics of the respective resting destination described above), and moving the virtual object along the surface in the second manner includes moving the virtual object along a second path, different from the first path, on the surface (e.g., to the respective resting destination). In some embodiments, moving the virtual object along the surface in the first manner includes moving the virtual object with a first velocity (e.g., direction and/or speed) along the surface corresponding to the first value of the user input parameter (e.g., the first velocity of the virtual object corresponds to a first respective velocity of movement of the input element before and/or during and/or at the end of the first input), and moving the virtual object along the surface in the second manner includes moving the virtual object with a second velocity (e.g., direction and/or speed), different form the first velocity, along the surface corresponding to the second value of the user input parameter (e.g., the second velocity of the virtual object corresponds to a second respective velocity of movement of the input element before and/or during and/or at the end of the first input). In some embodiments, moving the virtual object along the surface in the first manner includes moving the virtual object by a first distance along the surface corresponding to the first value of the user input parameter, and moving the virtual object along the surface in the second manner includes moving the virtual object by a second distance, different from the first distance, along the surface corresponding to the second value of the user input parameter. In some embodiments, moving the virtual object along the surface in the first manner includes rotating the virtual object with a first angular velocity (e.g., speed and/or direction of rotation) along the surface corresponding to the first value of the user input parameter (e.g., the first angular velocity of the virtual object corresponds to a first respective angular velocity of movement of the input element before and/or during and/or at the end of the first input), and moving the virtual object along the surface in the second manner includes rotating the virtual object with a second angular velocity (e.g., speed and/or direction of rotation), different from the first angular velocity, along the surface corresponding to the second value of the user input parameter (e.g., the second angular velocity of the virtual object corresponds to a second respective angular velocity of movement of the input element before and/or during and/or at the end of the first input). Moving a virtual object along a surface in a three-dimensional environment in response to an end of an input controlling movement of the virtual object in a first manner based on a first value of a user input parameter of the end of the input or in a second manner based on a second value of the user input parameter provides predictable movement of the virtual object along the surface in response to the end of the input that is based on the respective value of the user input parameter, which reduces errors and improves efficiency in user-device interaction.

In some embodiments, the end of the first input includes movement having a velocity away from the surface (e.g., along the first axis described above) in the three-dimensional environment, such as the fifth velocity of movement of hand 714 detected by computer system 101 in FIG. 7BX. In some embodiments, moving the virtual object relative to the surface includes, in accordance with the determination that the current location of the virtual object does not correspond to the surface when the end of the first input is detected (and/or in accordance with a determination that the one or more snapping criteria are not satisfied and/or that the virtual object is not snapped to the surface when the end of the first input is detected), during a first portion of the movement of the virtual object relative to the surface, moving the virtual object in the three-dimensional environment away from the surface, such as computer system 101 moving virtual object 706 upward (e.g., away from the surface of the table) along the first portion of path 778a in FIG. 7BX in accordance with a determination that the current location of virtual object 706 does not correspond to the surface of the table when the end of the second selection input is detected. In some embodiments, the first portion of the movement of the virtual object has one or more characteristics of the first portion of the movement of the virtual object described above. For example, the first portion of the movement of the virtual object includes movement of the virtual object that is based on the velocity (e.g., angular velocity) of the input element (e.g., before and/or during and/or at the end of the first input) and that is independent of the respective resting behavior of the virtual object (e.g., independent of a predetermined resting location and/or orientation in the three-dimensional environment).

In some embodiments, moving the virtual object relative to the surface includes, in accordance with the determination that the current location of the virtual object does not correspond to the surface when the end of the first input is detected, during a second portion, after the first portion, of the movement of the virtual object relative to the surface, moving the virtual object in the three-dimensional environment toward the surface (e.g., until the virtual object is snapped to the surface), such as computer system 101 moving virtual object 706 downward (e.g., toward the surface of the table) along the second portion of path 778a from FIG. 7BX to FIG. 7BY in accordance with the determination that the current location of virtual object 706 does not correspond to the surface of the table when the end of the second selection input is detected. In some embodiments, the second portion of the movement of the virtual object has one or more characteristics of the second portion of the movement of the virtual object described above. In some embodiments, the first portion of the movement of the virtual object is based on the velocity of the end of the first input (e.g., independent of the respective resting behavior of the virtual object), and the second portion of the movement of the virtual object is based on the respective resting pose (e.g., the first resting pose or the second resting pose) of the virtual object. For example, the second portion of the movement of the virtual object includes movement of the virtual object from a location of the virtual object at the end of the first portion of the movement of the virtual object to a location in the three-dimensional environment associated with the respective resting pose (e.g., the first resting pose or the second resting pose). For example, the respective resting pose includes a location that corresponds to the surface, and the second portion of the movement of the virtual object includes movement of the virtual object to the location that corresponds to the surface. For example, the respective resting pose includes a resting orientation, and the second portion of the movement of the virtual object includes rotation of the virtual object to the resting orientation. In some embodiments, at the end of the movement of the virtual object relative to the surface, the virtual object is snapped to the surface (e.g., future movement of the virtual object that is controlled by the input element begins with the virtual object snapped to the surface). Moving a virtual object in a three-dimensional environment after a user ends an input that controls movement of the virtual object based on a velocity of the end of the input provides the user a predictable result to the end of control of the virtual object that is based on a user input parameter performed by the user, which reduces errors and improves efficiency in user-device interaction.

In some embodiments, while movement of the virtual object within the three-dimensional environment is controlled by the movement of the input element, before detecting the end of the first input, and in accordance with the determination that the one or more snapping criteria are satisfied, such as the movement of virtual object 708 shown in FIGS. 7CG to 7CH, the computer system generates, via one or more output devices (e.g., one or more speakers, earbuds, and/or headphones) that are in communication with the computer system, first audio feedback that corresponds to snapping the virtual object, such as generating audio output 1520g as shown in FIG. 15B. For example, the first audio has one or more characteristics similar to, the same as, and/or that correspond to audio described with reference to method 1600. Thus, in some embodiments, the computer system generates first audio in response to, and/or in accordance with a determination that the one or more snapping criteria are satisfied. For example, the computer system optionally generates the first audio in response to detecting the selection by the input element. In some embodiments, the computer system generates the first audio before moving the virtual object toward the surface (e.g., before snapping the virtual object to the surface). For example, in response to detecting movement of the input element and in accordance with the determination that the one or more snapping criteria are satisfied, the computer system optionally generates the first audio before moving the virtual object to a location that corresponds to the surface as described above. In some embodiments, the computer system generates the first audio concurrently with moving the virtual object toward the surface. For example, in response to detecting that the one or more snapping criteria are satisfied, the computer system optionally generates the first audio. In some embodiments, the first audio is generated after (or in response to) the computer system has moved the virtual object toward and/or to the surface. Generating the first audio when the one or more snapping criteria are satisfied optionally provides feedback that the virtual object is and/or will be moved to a location corresponding to an object, thus optionally reducing power consumed by the computer system based on operations performed in response to detecting input by the computer system erroneously moving the object away from the location.

In some embodiments, while displaying the virtual object at the location corresponding to the surface in the three-dimensional environment and while the virtual object is snapped to the surface, the computer system detects, via the one or more input devices, a second input, different from the first input, such as movement of hand 714 corresponding to movement away from the position of virtual object 718 that is shown in FIG. 7CI. For example, the second input optionally has one or more characteristics similar to, the same as, and/or that correspond to one or more characteristics of the first input and/or other inputs described herein.

In some embodiments, in response to detecting the second input and in accordance with a determination that one or more unsnapping criteria are satisfied, the computer system moves the virtual object away from the first surface in accordance with the second input, such as moving virtual object 708 away from the position of virtual object 708 as shown in FIG. 7CI. For example, the one or more unsnapping criteria optionally dictate the condition(s) that are satisfied before (and/or in response to which) a virtual object that is snapped to a surface (e.g., the one or more snapping criteria were satisfied) is moved away from the surface. For example, the one or more unsnapping criteria optionally include a criterion that is satisfied when the second input includes movement by a magnitude (e.g., a distance, speed, and/or acceleration) greater than a threshold magnitude (e.g., 0.005, 0.01, 0.05, 0.1, 0.25, 0.5, 0.75, 1, 1.5, 3, 5, or 10 m, m/s, and/or m/s²), optionally away from the surface. Additionally or alternatively, the one or more unsnapping criteria optionally include a criterion that is satisfied when the second input includes movement by a distance away from a location on the first surface (and/or away from the first surface) greater than the threshold distance described previously (e.g., away from a center of the virtual object, a location on the first surface closest to the input element performing the second input, and/or a location occupied by the virtual object that is closest to the input element performing the second input). In some embodiments, the one or more unsnapping criteria include a criterion that is satisfied when the second input is initiated with, and/or includes a particular gesture and/or series of inputs. For example, the second input optionally begins with and/or includes a double-pinching of two fingers in rapid succession, a pinching between specific two or more fingers that optionally differ from fingers used to perform an air gesture that does not satisfy the criterion, and/or a rapid contacting with a trackpad and/or a button included in a controller. In some embodiments, the second input includes an air gesture (e.g., an air pinch and/or an air pointing of one or more fingers) while attention is directed toward the virtual object and/or movement of the air gesture while an air shape or air pose is maintained (e.g., contact between fingers in an air pinch and/or the extension of the one or more fingers performing the air pointing maintained). In some embodiments, the one or more unsnapping criteria include a criterion that is satisfied when the input element remains within the threshold distance of the virtual object and/or the first surface, but for a period of time that is greater than a threshold period of time (e.g., 0, 0.05, 0.1, 0.5, 1, 1.5, 2, 2.5, 3, or 5 seconds).

In some embodiments, the computer system moves the virtual object away from the first surface in a manner that is similar to, the same as, and/or corresponds to the manners by which the computer system moves the virtual object in accordance with movement of an input element as described herein. In this way, the computer system optionally “unsnaps” the virtual object from the first surface and/or optionally resumes movement of the virtual object in accordance with movement of the input element. It is understood that the computer system optionally performs unsnapping of additional or alternative virtual objects, different from the virtual object, based on the one or more unsnapping criteria being satisfied with respect to the additional or alternative objects.

In some embodiments, in response to detecting the second input and in accordance with a determination that one or more unsnapping criteria are satisfied, the computer system generates, via one or more output devices (e.g., one or more speakers, earbuds, and/or headphones) that are in communication with the computer system, second audio feedback corresponding to moving the virtual object away from the first surface, different from the first audio feedback (e.g., similar to, the same as, and/or corresponding to the audio described with reference to method 1600), such as audio output 1520h corresponding to the detected object unsnapping event as shown in FIG. 15B. For example, the second audio optionally includes a different tone, sequence of tones, combination of concurrently generated tones, words, sound effects, and/or spatialization (e.g., an effect in which the computer system uses a series of delays and/or amplitudes of audio generated on one or more audio channels to simulate a sound source generating the audio from a location in the three-dimensional environment relative to the viewpoint of the user) that are different from, similar, or the same audio characteristics of the first audio. For example, first audio optionally includes one or more first tones, and the second audio optionally includes one or more second tones, different from the one or more first tones. Additionally or alternatively, the first audio is optionally generated to simulate emanating from one or more first sound sources located at one or more first locations in the three-dimensional environment, and the second audio is optionally generated to simulate emanating from one or more second sound sources, different from the one or more first sound sources, that are located at one or more second locations, different from the one or more first locations, in the three-dimensional environment. Generating second audio based on unsnapping of the virtual object that differs from first audio generated based on snapping of the virtual object optionally reduces the likelihood that the user of the computer system is not apprised about whether the virtual object is snapped to the first surface, thus reducing inputs erroneously moving the virtual object along or away from the first surface, thereby reducing processing required to perform operations based on the erroneous inputs.

It should be understood that the particular order in which the operations in method 1300 have been described is merely exemplary and is not intended to indicate that the described order is the only order in which the operations could be performed. One of ordinary skill in the art would recognize various ways to reorder the operations described herein. In some embodiments, aspects/operations of method 1300 may be interchanged, substituted, and/or added between these methods. For example, various object manipulation techniques and/or object movement techniques of method 1300 is optionally interchanged, substituted, and/or added between these methods. For brevity, these details are not repeated here.

FIGS. 15A through 15I illustrate examples of a computer system generating an audio output corresponding to a respective type of object manipulation event that is associated with spatial manipulation of a virtual object, in accordance with some embodiments.

FIG. 15A illustrates an example of computer system 101 displaying virtual object 1510 within a three-dimensional environment 1500 (e.g., a three-dimensional user interface), in accordance with some embodiments. It should be understood that, in some embodiments, computer system 101 utilizes one or more techniques described with reference to FIGS. 15A-15I in a two-dimensional environment without departing from the scope of the disclosure. As described above with reference to FIGS. 1-6, computer system 101 optionally includes one or more display generation components 120 (e.g., a head-mounted display) and a plurality of image sensors 114a-114c. Image sensors 114a-114c optionally include one or more of a visible light camera, an infrared camera, a depth sensor, or any other sensor computer system 101 would be able to use to capture one or more images of a user or a portion of user (e.g., one or more hands of the user, such as hand 1502, or attention 1504 of the user (e.g., based on gaze)) while the user interacts with computer system 101. In some embodiments, image sensors 114a-114c optionally capture gestures or movements of hand 1502, such as the act of pinching or the release thereof, as described in greater detail herein. In some embodiments, computer system 101 displays the user interface or three-dimensional environment 1500 to a user of computer system 101 (and/or three-dimensional environment 1500 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 15A, computer system 101 displays three-dimensional environment 1500 including virtual object 1510. In some embodiments, virtual object 1510 shares one or more characteristics with the one or more virtual objects described with respect to methods 800, 900, 1000, 1100, 1200, 1300, 1600, and/or 1800. In some embodiments, in response to detecting an object pick-up event (e.g., detecting hand 1502 perform a gesture, such as an air pinch, while attention 1504 is directed to virtual object 1510), computer system 101 performs a pick-up operation associated with virtual object 1510 (e.g., coupling subsequent spatial updates of virtual object 1510 to the motion of hand 1502). In some embodiments, in response to detecting the object pick-up event, computer system 101 generates audio output 1520 corresponding to the detected object pick-up event. Other object manipulation events likewise optionally trigger their own distinct audio outputs, as illustrated by examples 1501a-1501i in FIG. 15B.

FIG. 15B illustrates examples 1501a-1501i of computer system 101 generating different audio outputs corresponding to different types of object manipulation events associated with different spatial manipulations of virtual object 1510, in accordance with some embodiments. It is understood that attention 1504 is directed to virtual object 1510 in all examples 1501a-1501i illustrated in FIG. 15B as part of the input provided to the computer system to perform the object manipulation depicted. In some embodiments, audio outputs 1520a-1520i described below are different from each other.

As illustrated in example 1501a, in response to detecting an object pick-up event (e.g., detecting hand 1502 perform an air pinch gesture while attention 1504 is directed to virtual object 1510), computer system 101 optionally performs a pick-up operation associated with virtual object 1510 (e.g., coupling subsequent spatial updates of virtual object 1510 to the motion of hand 1502) and generates audio output 1520a corresponding to the detected object pick-up event. In some embodiments, the object pick-up event illustrated in example 1501a shares one or more characteristics with the object pick-up events described with respect to FIGS. 7A-7CK and methods 800, 900, 1000, 1100, 1200, and/or 1300.

As illustrated in example 1501b, in response to detecting an object drop event (e.g., detecting hand 1502 release the air pinch gesture performed in example 1501a), computer system 101 optionally performs a drop operation (e.g., decouples the motion of hand 1502 to subsequent spatial updates of virtual object 1510 and positions virtual object 1510 within three-dimensional environment 1500) and generates audio output 1520b corresponding to the detected object drop event. In some embodiments, the object drop event illustrated in example 1501b shares one or more characteristics with the object drop events described with respect to FIGS. 7A-7CK and methods 800, 900, 1000, 1100, 1200, and/or 1300.

As illustrated in example 1502c, in response to detecting an object approach event (e.g., detecting hand 1502 is within a selection region of virtual object 1510, as described in greater detail with respect to method 800), computer system 101 optionally performs an approach operation (e.g., highlighting virtual object 1510) and generates audio output 1520c corresponding to the detected approach event. In some embodiments, the object approach event illustrated in example 1501c shares one or more characteristics with the object approach events described with respect to FIGS. 7A-7CK and methods 800, 900, 1000, 1100, 1200, and/or 1300.

As illustrated in example 1504d, in response to detecting an object hand-off event (e.g., detecting hand 1503 perform an air pinch gesture while hand 1502 maintains the air pinch gesture performed in example 1501a and subsequently detecting hand 1502 release the air pinch gesture, as described in greater detail with respect to method 1100), computer system 101 optionally performs a hand-off operation (e.g., re-coupling subsequent spatial updates of virtual object 1510 from the motion of hand 1502 to the motion of hand 1503) and generates audio output 1520d corresponding to the detected object hand-off event. In some embodiments, the object hand-off event illustrated in example 1501d shares one or more characteristics with the object hand-off events described with respect to FIGS. 7A-7CK and methods 800, 900, 1000, 1100, 1200, and/or 1300.

As illustrated in example 1504e, in response to detecting an object drag event (e.g., detecting a translation of hand 1502 while the air pinch performed in example 1501a is maintained, as described in greater detail in methods 900, 1000, and/or 1100), computer system 101 optionally performs a drag operation (e.g., translating virtual object 1510 within three-dimensional environment 1500 in accordance with the motion of hand 1502) and generates audio output 1520e corresponding to the detected object drag event. In some embodiments, the object drag event illustrated in example 1501e shares one or more characteristics with the object drag events described with respect to FIGS. 7A-7CK and methods 800, 900, 1000, 1100, 1200, and/or 1300.

As illustrated in example 1504f, in response to detecting an object rotation event (e.g., detecting a rotation of hand 1502 while the air pinch performed in example 1501a is maintained, as described in greater detail in methods 900, 1000, and/or 1100), computer system 101 optionally performs a rotation operation (e.g., rotating virtual object 1510 within three-dimensional environment 1500 in accordance with the motion of hand 1502) and generates audio output 1520f corresponding to the detected object rotation event. In some embodiments, the object rotation event illustrated in example 1501f shares one or more characteristics with the object rotation events described with respect to FIGS. 7A-7CK and methods 800, 900, 1000, 1100, 1200, and/or 1300.

As illustrated in example 1504g, in response to detecting an object snapping event (e.g., detecting a downwards translation of hand 1502 that would result in virtual object 1510 crossing snapping threshold 1512 while the air pinch performed in example 1501a is maintained, as described in greater detail in method 1600), computer system 101 optionally performs a snapping operation (e.g., automatically repositioning and/or reorienting virtual object 1510 to a targeted position on a surface) and generates audio output 1520g corresponding to the detected object snapping event. In some embodiments, the object snapping event illustrated in example 1501c shares one or more characteristics with the object unsnapping events described with respect to FIGS. 7A-7CK and methods 800, 900, 1000, 1100, 1200, and/or 1300.

As illustrated in example 1504h, in response to detecting an object unsnapping event (e.g., while virtual object 1510 is snapped to a surface, detecting an upwards translation of hand 1502 that would result in virtual object 1510 crossing snapping threshold 1512 while an air pinch is maintained, as described in greater detail in method 1600), computer system 101 optionally performs an unsnapping operation (e.g., removing the snap constraint and restoring free spatial manipulation of virtual object 1510) and generates audio output 1520h corresponding to the detected object unsnapping event. In some embodiments, the object unsnapping event illustrated in example 1501c shares one or more characteristics with the object unsnapping events described with respect to FIGS. 7A-7CK and methods 800, 900, 1000, 1100, 1200, and/or 1300.

As illustrated in example 1504i, in response to detecting an object toss event (e.g., detecting a translation of hand 1502 that has a velocity and/or acceleration exceeding a respective threshold immediately before releasing the air pinch performed in example 1501a, as described in greater detail with respect to method 1300), computer system 101 optionally performs a toss operation (e.g., translating virtual object 1510 within three-dimensional environment 1500 in accordance with the motion of hand 1502 while the air pinch was maintained after detecting hand 1502 has released the pinch) and generates audio output 1520i corresponding to the detected object toss event. In some embodiments, the object toss event illustrated in example 1501c shares one or more characteristics with the object toss events described with respect to FIGS. 7A-7CK and methods 800, 900, 1000, 1100, 1200, and/or 1300.

In some embodiments, computer system 101 generates any of audio outputs 1520a-1520i by applying a randomization or pseudo-randomization to one or more audio characteristics of a baseline audio output corresponding to an object manipulation event (e.g., the object manipulation events described above) on a virtual object (e.g., virtual object 1510), as described in greater detail with respect to method 1600. In some embodiments, computer system 101 applies a randomization or pseudo-randomization to different instances of the same object manipulation event for the same virtual object. As an illustrative example, for a baseline audio output that has a pitch of 440 Hz, a volume of 50 dB, and a length of 0.25 s, computer system 101 optionally generates audio output 1520a with the following audio characteristics by applying one or more randomizations or pseudo-randomizations:

| | Pitch (Hz) | Volume (dB) | Length (s) |
|---|---|---|---|
| 1 | 440 | 50 | 0.25 |
| 2 | 435 | 50 | 0.23 |
| 3 | 448 | 48 | 0.25 |
| 4 | 439 | 55 | 0.28 |

FIG. 15C illustrates an example of computer system 101 generating the same audio output corresponding to the same type of object manipulation event associated with the same spatial manipulation of different virtual objects 1532a-1532b, in accordance with some embodiments. In some embodiments, while displaying an application 1530a, in response to detecting an object pick-up event on a virtual object 1532a associated with application 1530a, computer system 101 performs a pick-up operation on virtual object 1532a and generates audio output 1520a corresponding to the detected pick-up event. In some embodiments, while displaying an application 1530b, which is a different application than application 1530a, in response to detecting an object pick-up event on a virtual object 1532b associated with application 1530b, computer system 101 performs a pick-up operation on virtual object 1532b and generates audio output 1520a corresponding to the detected pick-up operation. In some embodiments, despite virtual object 1532a and 1532b being different from each other (and are optionally different types of objects having different relevant characteristics), computer system 101 generates audio output 1520a for the same type of object manipulation events (e.g., the detected object pick-up events). In some embodiments, computer system 101 selects audio output 1520a from a list of system default audio outputs associated with one or more object manipulation events. In some embodiments, computer system 101 generates audio output 1520a for object pick-up events of virtual objects inside applications where a developer has not set custom audio outputs (e.g., virtual objects 1532a-1532b of applications 1530a-1530b).

FIG. 15D illustrates an example of computer system 101 generating different audio outputs corresponding to the same type of object manipulation event associated with the same spatial manipulation of different virtual objects 1532a and 1532c, in accordance with some embodiments. In some embodiments, while displaying application 1530a, in response to detecting an object pick-up event on virtual object 1532a associated with application 1530a, computer system 101 performs a pick-up operation on virtual object 1532a and generates audio output 1520a corresponding to the detected pick-up operation on virtual object 1532a. In some embodiments, while displaying application 1530a, in response to detecting an object pick-up event on virtual object 1532c associated with application 1530a, computer system 101 performs a pick-up operation on virtual object 1532c (e.g., the virtual turn timer) and generates audio output 1520b, different from audio output 1520a, corresponding to the detected pick-up operation on virtual object 1532c. Accordingly, in some embodiments, the audio output generated by computer system 101 is based on the particular object (or object type) being picked up.

FIGS. 15E-15H illustrate examples of computer system 101 generating different audio outputs based on one or more different characteristics. It is understood that the individual approaches to determining the audio characteristics of the audio outputs shown in FIGS. 15E-15H are presented separately only for clarity, and in practice computer system 101 optionally evaluates any combination of object-location, room, environment, object-attribute, interaction-metric, and surface-material characteristics—individually or in combination—to select, modify, and/or otherwise generate the audio outputs.

FIG. 15E illustrates an example of computer system 101 generating different audio outputs based on different locations of virtual object 1510 relative to a viewpoint of a user 1506 and/or spatial characteristics of a room or environment, in accordance with some embodiments. As illustrated in example 1501j, in response to detecting an object manipulation event (e.g., an object pick-up event) on virtual object 1510, computer system 101 optionally performs an operation corresponding to the object manipulation event and generates an audio output 1520j with respective audio characteristics determined by a distance D1 between viewpoint of the user 1506 and virtual object 1510 and/or by one or more spatial characteristics of room 1505a, as described in greater detail with respect to method 1600.

As illustrated in example 1501k, in response to detecting an object manipulation event (e.g., the same type of object manipulation event as in example 1501j) on virtual object 1510, computer system 101 optionally performs an operation corresponding to the object manipulation event and generates an audio output 1520k with respective audio characteristics, different from the audio characteristics of audio output 1520j, determined by a distance D2 between viewpoint of the user 1506 and virtual object 1510 and/or by one or more spatial characteristics of room 1505a. In some embodiments, the audio characteristics of audio outputs 1520j and 1520k differ due to the difference in distance between D1 and D2. For example, when virtual object 1510 is at distance D1 from viewpoint of the user 1506, computer system 101 optionally generates audio output 1520j by applying a first attenuation based on distance D1 to one or more audio characteristics of an audio output associated with the detected object manipulation event, and when virtual object 1510 is at distance D2 from viewpoint of the user 1506, computer system optionally generates audio output 1520b by applying a second attenuation, greater than the first attenuation, based on distance D2 to the one or more audio characteristics of the audio output associated with the detected object manipulation event. In this example, audio outputs 1520j and 1520k optionally share the same audio characteristics, except for a volume level which is determined by the distance between viewpoint of the user 1506 and virtual object 1510 and is greater for audio output 1520j than for audio output 1520k.

As illustrated in example 15011, while computer system 101 displays virtual object 1510 within a virtual environment 1505b, in response to detecting an object manipulation event (e.g., the same type of object manipulation event as in examples 1501j-k) on virtual object 1510, computer system 101 optionally performs an operation corresponding to the object manipulation event and generates an audio output 15201 with respective audio characteristics, different from the audio characteristics of audio outputs 1520j-1520k, determined by a distance D1 between viewpoint of the user 1506 and virtual object 1510 and/or by one or more spatial characteristics of virtual environment 1505b. In some embodiments, the audio characteristics of audio outputs 1520j and 15201 differ due to the difference in one or more spatial characteristics between room 1505a and virtual environment 1505b (e.g., despite the distance between virtual object 1510 and viewpoint of the user 1506, D1, being the same in examples 1501j and 1501l). For example, when virtual object 1510 is displayed in room 1505a, computer system 101 optionally generates audio output 1520j by applying a first modification based on one or more spatial characteristics of room 1505a to one or more audio characteristics of an audio output associated with the detected object manipulation event, and when virtual object 1510 is displayed in virtual environment 1505b, computer system 101 optionally generates audio output 15201 by applying a second modification, different from the first modification (despite the distance between virtual object 1510 and viewpoint of the user 1506, D1, being the same as in example 1501j), based on one or more spatial characteristics of virtual environment 1505b to the one or more audio characteristics of the audio output associated with the detected object manipulation event. For instance, when room 1505a is a small, furnished room, and virtual environment 1505b is a church dome, audio outputs 1520j and 15201 optionally share the same audio characteristics, except for an audio characteristic that defines an echo level, which is greater for virtual environment 1505b than it is for room 1505a.

FIG. 15F illustrates an example of computer system 101 generating different audio outputs based on different object characteristics, in accordance with some embodiments. As illustrated in example 1501m, virtual objects 1510a-1510c differ in at least one object characteristic. For example, virtual object 1510a is a cube, virtual object 1510b is a sphere, and virtual object 1510c is a cube of a larger size than virtual object 1510a. In some embodiments, as illustrated in example 1501m, in response to detecting an object manipulation event (e.g., an object pick-up event) on virtual object 1510a, computer system 101 optionally performs an operation corresponding to the object manipulation event and generates an audio output 1520m with respective audio characteristics determined by one or more object characteristics of virtual object 1510a (e.g., simulated material, mass, size, weight, color, surface texture, rigidity, and/or semantic category).

In some embodiments, as illustrated in example 1501n, in response to detecting an object manipulation event (e.g., the same type of object manipulation event as in example 1501m) on virtual object 1510b, computer system 101 optionally performs an operation corresponding to the object manipulation event and generates an audio output 1520n with respective audio characteristics, different from the audio characteristics of audio output 1520m, determined by one or more object characteristics of virtual object 1510b. For example, for virtual object 1510a, computer system 101 optionally generates audio output 1520m by applying a first modification based on one or more object characteristics of virtual object 1510a to one or more audio characteristics of an audio output associated with the detected object manipulation event, and for virtual object 1510b, computer system 101 optionally generates audio output 1520n by applying a second modification, different from the first modification, based on one or more object characteristics of virtual object 1510b to the one or more audio characteristics of the audio output associated with the detected object manipulation event. For instance, audio outputs 1520m and 1520n optionally share the same audio characteristics, except for one or more characteristics (e.g., timbre) that are different because virtual object 1510a is a cube and virtual object 1510b is a sphere.

In some embodiments, as illustrated in example 15010, in response to detecting an object manipulation event (e.g., the same type of object manipulation event as in examples 1501m-1501n) on virtual object 1510c, computer system 101 optionally performs an operation corresponding to the object manipulation event and generates an audio output 15200 with respective audio characteristics, different from the audio characteristics of audio output 1520m-1520n, determined by one or more object characteristics of virtual object 1510c. For example, for virtual object 1510a, computer system 101 optionally generates audio output 1520m by applying a first modification based on one or more object characteristics of virtual object 1510a to one or more audio characteristics of an audio output associated with the detected object manipulation event, and for virtual object 1510c, computer system 101 optionally generates audio output 15200 by applying a third modification, different from the first and second modifications, based on one or more object characteristics of virtual object 1510c to the one or more audio characteristics of the audio output associated with the detected object manipulation event. For instance, audio outputs 1520m and 15200 optionally share the same audio characteristics, except for one or more characteristics (e.g., amplitude, duration, or pitch) that are different because virtual object 1510c is larger than virtual object 1510a.

FIG. 15G illustrates an example of computer system 101 generating different audio outputs based on different interaction characteristics, in accordance with some embodiments. In some embodiments, as illustrated in example 1501p, in response to detecting an object manipulation event 1540a (e.g., an object drag event) on virtual object 1510, computer system 101 optionally performs an operation corresponding to the object manipulation event (e.g., translates virtual object 1510 within three-dimensional environment 1500) and generates an audio output 1520p with respective audio characteristics determined by one or more interaction characteristics (e.g., speed, velocity, acceleration, gesture sharpness, duration, angular velocity, and/or angular acceleration) of object manipulation event 1540a on virtual object 1510, such as speed 1542a. In some embodiments, as illustrated in example 1501q, in response to detecting an object manipulation event 1540b (e.g., the same type of object manipulation event as in example 1501p) on virtual object 1510, computer system 101 optionally performs an operation corresponding to the object manipulation event (e.g., translates virtual object 1510 further than in example 1501p within three-dimensional environment 1500) and generates an audio output 1520q with respective audio characteristics, different from the audio characteristics of audio output 1520p, determined by one or more interaction characteristics of object manipulation event 1540b on virtual object 1510, such as speed 1542b. For example, in example 1501p, computer system 101 optionally generates audio output 1520p by applying a first modification based on speed 1542a to one or more audio characteristics of an audio output associated with an object drag event on virtual object 1510, and in example 1501q, computer system 101 optionally generates audio output 1520q by applying a second modification, different from the first modification, based on speed 1542b to the one or more audio characteristics of the audio output associated with the object drag event on virtual object 1510.

FIG. 15H illustrates an example of computer system 101 generating different audio outputs based on different surface characteristics, in accordance with some embodiments. In some embodiments, as illustrated in example 1501r, in response to detecting an object manipulation event (e.g., an object snapping event) on virtual object 1510, computer system 101 optionally performs an operation corresponding to the object manipulation event (e.g., automatically repositions and/or reorients virtual object 1510 to a targeted position on a surface 1550a) and generates an audio output 1520r with respective audio characteristics determined by one or more surface characteristics (e.g., material and/or softness, whether real or simulated) of surface 1550a, such as surface 1550a being made of wood. In some embodiments, as illustrated in example 1501s, in response to detecting an object manipulation event (e.g., the same type of object manipulation event as in example 1501r) on virtual object 1510, computer system 101 optionally performs an operation corresponding to the object manipulation event (e.g., automatically repositions and/or reorients virtual object 1510 to a targeted position on a surface 1550b) and generates an audio output 1520s with respective audio characteristics, different from the audio characteristics of audio output 1520r, determined by one or more surface characteristics of surface 1550b, such as surface 1550b being made of felt. For example, in example 1501r, computer system 101 optionally generates audio output 1520r by applying a first modification based on surface 1550a being made of wood to one or more audio characteristics of an audio output associated with an object snapping event on virtual object 1510, and in example 1501s, computer system 101 optionally generates audio output 1520s by applying a second modification, different from the first modification, based on surface 1550b being made of felt to the one or more audio characteristics of the audio output associated with the object snapping event on virtual object 1510 (e.g., audio output 1520s corresponds to a more muted sound than audio output 1520r).

FIG. 15I illustrates examples of computer system 101 determining whether to display a virtual object with one or more object controls based on movement of the virtual object. In some embodiments, computer system 101 displays virtual object 1510 with one or more object controls, such as object control 1514a (e.g., a grabber that is selectable to move virtual object 1510 within three-dimensional environment 1500) and object control 1514b (e.g., a label), that have a spatial arrangement relative to virtual object 1510. As illustrated in examples 1501t-1501v, virtual object 1510 is optionally enclosed by a scene boundary 1560 (an area or volume in the three-dimensional environment, the boundary of which is optionally not displayed via display generation component 120) that computer system 101 uses to determine whether to update a position of object controls 1514a-1514b. Virtual object 1510 and objects controls 1514a and 1514b are optionally included within scene boundary 1560. In some embodiments, as illustrated in examples 1501t-1501v, when computer system 101 detects an object drag event directed to virtual object 1510, computer system 101 ceases to display object controls 1514a-1514b.

In some embodiments, as illustrated in example 1501t, in accordance with a determination that virtual object 1510 remains within scene boundary 1560 in response to an object drag event (e.g., upon detecting hand 1502 release an air pinch gesture after dragging virtual object 1510 while maintaining the air pinch gesture), computer system 101 does not update a position of object controls 1514a-1514b to match a new position of virtual object 1510. In some embodiments, upon detecting hand 1502 release the air pinch gesture, computer system 101 automatically displays object controls 1514a-141b at their original position before the object drag event. In some embodiments, upon detecting hand 1502 release the air pinch gesture, computer system 101 does not display object controls 1514a-1514b. In some embodiments, computer system 101 does not display object controls 1514a-1514b while moving virtual object 1510 until computer system 101 detects hand 1502 release the air pinch.

In some embodiments, as illustrated in example 1501u, in accordance with a determination that virtual object 1510 is outside scene boundary 1560 in response to an object drag event (e.g., upon detecting hand 1502 release an air pinch gesture after dragging virtual object 1510 while maintaining the air pinch gesture), computer system 101 updates a position of object controls 1514a-1514b to match a new position of virtual object 1510 and automatically displays object controls 1514a-1514b at the new position with the same spatial arrangement without requiring further input. In some embodiments, computer system 101 does not display object controls 1514a-1514b while moving virtual object 1510 until computer system 101 detects hand 1502 release the air pinch. In some embodiments, upon moving virtual object 1510 to the new position, computer system 101 updates scene boundary 1560 to match the new position of virtual object 1510 (e.g., having the same spatial arrangement as before the object drag event).

In some embodiments, as illustrated in example 1501v, in accordance with a determination that virtual object 1510 is outside scene boundary 1560 in response to an object drag event (e.g., upon detecting hand 1502 release an air pinch gesture after dragging virtual object 1510 while maintaining the air pinch gesture), computer system 101 does not update a position of object controls 1514a-1514b to match a new position of virtual object 1510 and does not display object controls 1514a-1514b at the new position of virtual object 1510. In some embodiments, upon detecting a new object manipulation event (e.g., an object pick-up event, an object selection event, or otherwise) on virtual object 1510 following the earlier object drag event, computer system 101 updates a position of object controls 1514a-1514b to match a new position of virtual object 1510 and displays object controls 1514a-1514b at the new position with the same spatial arrangement. In some embodiments, in accordance with a determination that virtual object 1510 is outside scene boundary 1560 in response to an object drag event, computer system 101 updates a position of object controls 1514a-1514b to match a new position of virtual object 1510 but does not display object controls 1514a-1514b at the new position of virtual object 1510 until detecting the new object manipulation event on virtual object 1510 following the earlier object drag event. In some embodiments, upon moving virtual object 1510 to the new position, computer system 101 updates scene boundary 1560 to match the new position of virtual object 1510 (e.g., having the same spatial arrangement as before the object drag event).

FIG. 16 is a flowchart illustrating method 1600 of generating an audio output corresponding to a respective object manipulation event in accordance with some embodiments. In some embodiments, method 1600 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, method 1600 is performed at a computer system in communication with one or more display generation components and one or more input devices, such as computer system 101 in communication with display generation component 120 and input devices 114-114c in FIGS. 15A-15I. In some embodiments, the computer system, the one or more display generation components, and the one or more input devices share one or more characteristics of the computer systems, the one or more display generation components, and/or the one or more input devices described with reference to methods 800, 900, 1000, 1100, 1200, and/or 1300.

The devices, methods, and/or computer-readable storage media described below enhance the operability of the device and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved audio feedback (such as by generating, via the audio output devices, different first and second audio outputs when the same user action is classified as different types of object manipulation events, or by applying location-dependent attenuation to the first audio output) enhances the operability of the device by reducing accidental and mistaken inputs, thereby lowering the number of corrective interactions and the energy the device must expend. Performing an operation when a set of conditions has been met without requiring further user input (such as by automatically repositioning the virtual object to a target pose and emitting a snap sound once the object satisfies positional and angular thresholds in a snapping event) enhances the operability of the device by reducing unnecessary inputs and steps, thereby lowering processor cycles and overall energy usage. Displaying user-interface elements (such as by hiding the object controls while the object is in motion and then automatically restoring those controls in the original spatial arrangement when the motion ends) with different appearances at different times helps to avoid image persistence or burn in effects that can occur with some display technologies when the same object is displayed with the same appearance at the same location repeatedly or for a long period of time.

In some embodiments, while displaying, via the one or more display generation components, a first virtual object that can be spatially manipulated (e.g., moved, rotated, and/or resized) in a three-dimensional environment based on movement of a portion of a user of the computer system (e.g., within the three-dimensional environment), the computer system detects (1602), via the one or more input devices, a first input directed to the first virtual object, such as computer system 101 detecting, via input devices 114a-114c, hand 1502 perform an air pinch gesture while attention 1504 is directed to virtual object 1510 in FIG. 15A. In some embodiments, the first virtual object shares one or more characteristics of the virtual objects described with reference to methods 800, 900, 1000, 1100, 1200, and/or 1300. In some embodiments, the first virtual object being spatially manipulable refers to the first virtual object being recognized by the computer system as capable of having one or more of its virtual properties (e.g., position, orientation, size, or state) changed in response to a user interaction. In some embodiments, the three-dimensional environment shares one or more characteristics of the three-dimensional environments described with reference to methods 800, 900, 1000, 1100, 1200, and/or 1300. In some embodiments, the first input includes one or more manipulations of the virtual object (e.g., grabbing, dropping, picking up, handing off, rotating, dragging, tossing, snapping, unsnapping, hovering, or otherwise changing the position, orientation, or state of the first virtual object). In some embodiments, the first input includes the portion of the user touching (e.g., virtually coming into contact with the virtual object) and/or hovering or coming into proximity of the virtual object. In some embodiments, the portion of the user of the computer system refers to a representation of a physical part of the body of the user (e.g., a hand, arm, finger, foot, head, torso, and/or eye) that is tracked or recognized by the computer system as interacting with the first virtual object. In some embodiments, the portion of the user refers to one or more body parts detected by various sensing inputs (e.g., optical sensors and/or wearable trackers) without being limited to a specific limb or extremity. Some examples of inputs directed to the first virtual object performed by a portion of the user include, but are not limited to, hand air gestures (e.g., the user extending a hand and making an air pinch gesture to pick up or move the first virtual object), attention (e.g., the user's gaze remaining on the first virtual object, triggering a selection of the first virtual object), combined hand and attention input (e.g., the user looking at the first virtual object to select it and moving their hand to perform an action with the first virtual object), and/or head movement (e.g., the user tilting or turning their head in a certain direction to move the first virtual object in a particular direction). In some embodiments, the first input shares one or more characteristics of the interaction(s) and/or inputs directed to virtual objects described with reference to methods 800, 900, 1000, 1100, 1200, and/or 1300.

In some embodiments, in response to (and/or while) detecting the first input (1604), in accordance with a determination that the first input corresponds to a first type of object manipulation event that is associated with spatial manipulation of the first virtual object (1606), such as the object drag event in example 1501e of FIG. 15B, the computer system performs (1608) a first operation associated with the first virtual object, such as translating virtual object 1510 in accordance with the movement of hand 1502 in example 1501e of FIG. 15B. In some embodiments, an object manipulation event refers to an event or condition that involves manipulation of a virtual object via input from one or more portions of the user. In some embodiments, the first type of object manipulation event that is associated with spatial manipulation of the object refers to a distinct classification of user-input-driven interaction recognized by the computer system in which one or more spatial parameters of the first virtual object (e.g., position, orientation, size, and/or state) are altered within the three-dimensional environment. In some embodiments, each type of object manipulation event is a distinct grouping governed by its own detection criteria (e.g., how the user or portion of the user engages with the first virtual object) and linked to a corresponding operation and/or audio output, as described in greater detail below. For example, the computer system optionally distinguishes between object manipulation events such as grabbing, dropping, picking up, handing off, rotating, dragging, tossing, snapping, unsnapping, and/or hovering (and assigns each such event or groupings of such events to a specific type of object manipulation event). In some embodiments, the computer system determines the first type of object manipulation event based on one or more characteristics of the first input (e.g., movement, speed, direction, and/or force). For instance, a quick flick is optionally classified as a “toss,” while a slower movement is optionally classified as a “drag.” In some embodiments, the computer system relies on one or more contextual factors (e.g., proximity to a surface and/or another object) to categorize an event, such as a snap or unsnap event. In some embodiments, different types of object manipulation events are assigned to different user inputs or air gestures, such as air pinching vs. tapping. In some embodiments, the types of object manipulation events identified by the computer system share one or more characteristics with the types of object manipulation events described with respect to methods 800, 900, 1000, 1100, 1200, and/or 1300.

In some embodiments, the first operation refers to an action or process performed by the computer system on the first virtual object in response to an event (e.g., an object manipulation event associated with spatial manipulation). In some embodiments, the first operation changes one or more properties of the first virtual object (e.g., position, orientation, size, and/or state) or triggers an outcome related to the first input (e.g., snapping or unsnapping the first virtual object from a surface or another object). In some embodiments, performing the first operation associated with the object shares one or more characteristics with performing an operation(s) or action(s) in response to an event(s) or interaction(s) directed to virtual object(s) described with reference to methods 800, 900, 1000, 1100, 1200, and/or 1300.

In some embodiments, in response to (and/or while) detecting the first input (1604), in accordance with the determination that the first input corresponds to the first type of object manipulation event that is associated with spatial manipulation of the first virtual object (1606), such as the object drag event in example 1501e of FIG. 15B, the computer system generates (1610), via one or more audio output devices, a first audio output corresponding to the first type of object manipulation event that is associated with spatial manipulation of the first virtual object, such as generating audio output 1520e corresponding to the object drag event in example 1501e of FIG. 15B. In some embodiments, the first audio output refers to an audible signal, sound, or sequence of sounds produced by the computer system in response to an event (e.g., the first input) within the three-dimensional environment. Some examples of audio outputs include, but are not limited to, recorded sounds, synthesized sounds, musical tones, voice prompts, or other audible cues. In some embodiments, the first audio output is dynamically generated or modified in real time, based on one or more characteristics of the first input (e.g., speed, force, or the virtual object or type of virtual object involved). In some embodiments, generating the first audio output refers to a process undertaken by or on behalf of the computer system to produce, play, emit, or otherwise render an audible signal in response to the first object manipulation event. Some examples of generating the first audio output include, but are not limited to, the computer system: retrieving a pre-recorded sound from local storage and playing it through one or more speakers; synthesizing the audio output in real time based on the first object manipulation event; layering multiple audio samples together to create a complex sound effect (e.g., a snap followed by a short reverberation); streaming audio data from a remote service or server; and/or manipulating parameters (e.g., pitch, volume, or timing) of an existing sound file to generate a distinct audio output. In some embodiments, the computer system generates the first audio output at the onset of the first operation, thereby conveying to the user that the object manipulation has begun and that subsequent user inputs will continue to perform the same type of object manipulation. In some embodiments, the computer system provides a continuous or periodic audio output (e.g., the first audio output) to indicate that the first operation remains active, thereby conveying to the user that the system is still performing the corresponding action(s). In some embodiments, the computer system generates a concluding audio output (e.g., at least a portion of the first audio output or a separate audio output), thereby conveying to the user that the first operation has ended and that subsequent user inputs will no longer produce the same type of object manipulation.

In some embodiments, in response to (and/or while) detecting the first input (1604), in accordance with a determination that the first input corresponds to a second type of object manipulation event that is associated with spatial manipulation of the first virtual object, different from the first type of object manipulation event (1612), such as the object rotation event in example 1501f of FIG. 15B, the computer system performs (1614) a second operation associated with the first virtual object, different from the first operation, such as rotating virtual object 1510 in accordance with the rotation of hand 1502 in example 1502f of FIG. 15B. In some embodiments, the second type of object manipulation event shares one or more characteristics with the first type of object manipulation event. In some embodiments, the second type of object manipulation event being different from the first type of object manipulation event refers to the second type of object manipulation event having one or more characteristics (e.g., motion profile, user input patter, and/or object state change) that are different from corresponding characteristic(s) of the first type of object manipulation event. For example, the difference between an event classified as a “toss” and an event classified as a “drag” is optionally the speed of a movement of the portion of the user. In some embodiments, the computer system differentiates between the first and second types of object manipulation events by applying unique detection criteria (e.g., different motion thresholds or trigger conditions) that distinguish one object manipulation event type from another, as described in greater detail herein. In some embodiments, differentiating between the first and second types of object manipulation events shares one or more characteristics with differentiating between events or interactions described with reference to methods 800, 900, 1000, 1100, 1200, and/or 1300. In some embodiments, the computer system relies on contextual factors such as proximity to other objects and/or surfaces to determine whether the first input is classified as the first or second type of object manipulation event. In some embodiments, the second operation shares one or more characteristics with the first operation. In some embodiments, the second operation being different from the first operation refers to the second operation having one or more characteristics that are different from corresponding characteristic(s) of the first operation.

In some embodiments, in response to (and/or while) detecting the first input (1604), in accordance with the determination that the first input corresponds to the second type of object manipulation event that is associated with spatial manipulation of the first virtual object, different from the first type of object manipulation event (1612), such as the object rotation event in example 1501f of FIG. 15B, the computer system generates (1616), via the one or more audio output devices, a second audio output, different from the first audio output, corresponding to the second type of object manipulation event that is associated with spatial manipulation of the first virtual object, such as generating audio output 1520f corresponding to the object rotation event in example 1501f of FIG. 15B. In some embodiments, the second audio output shares one or more characteristics with the first audio output described above. In some embodiments, the second audio output being different from the first audio output indicates that when the first input is determined to be of the second type of object manipulation event instead of the first type of object manipulation event, the computer system generates a distinct audible response compared to what would be generated for the first type of object manipulation event. In some embodiments, an audio output consists of a unique set of one or more audio characteristics (e.g., pitch, timbre, tone, volume, duration, character (e.g., a “click” vs. a “thud”), a specific multi-component sound pattern or layered effect, or overall sound effect), such that the difference between the first audio output and the second audio output corresponds to a difference in at least one of the one or more audio characteristics of the first audio output and the second audio output. For example, when the computer system determines the first input is a “tap” type of object manipulation event, the system optionally generates a short, high-pitched “click” sound effect; and when the computer system determines the first input is a “grab” type of object manipulation event, the system optionally generates a deeper, low-pitched “thud” or “clamp” sound effect.

In some embodiments, the first type of object manipulation event is an object drop event (e.g., the object drop event in example 1501b of FIG. 15B) and the second type of object manipulation event is an object pick-up event (e.g., the object pick-up event in example 1501a of FIG. 15B). In some embodiments, the object drop event and the object pick-up event share one or more characteristics with the object drop events and the object pick-up events described with respect to methods 800, 900, 1000, 1100, 1200, and/or 1300. In some embodiments, the object drop event is a type of object manipulation event in which the computer system detects that a portion of the user has released control of the first virtual object (e.g., the portion of the user is not controlling the first virtual object via direct or indirect input). In some embodiments, the computer system thereafter positions (or allows to move under system-defined spatial rules (e.g., gravity, snapping, or placement logic)) the first virtual object within the three-dimensional environment (e.g., via the first operation). For example, the computer system optionally detects an object drop event is optionally detected when the system registers a transition from an air pinch gesture to an open-hand gesture or from a controller-button hold to release. In some embodiments, when the first type of object manipulation event is the object drop event, the first audio output has one or more characteristics (e.g., pitch, volume, timbre, decay length, reverberation level, stereo or spatial positioning, harmonic content, envelope shape, and/or slight randomization of pitch, volume, and/or decay length) associated with the object drop event (e.g., the first audio output audibly signifies the object drop event). For example, the first audio output for an object drop event is optionally a soft release “click” to signify the first virtual object transitioning to not being controlled by the user. In some embodiments, the object pick-up event is a type of object manipulation event in which the computer system detects that a portion of the user has established control of the first virtual object such that the object transitions from not being controlled by the user to being controlled by the user. For example, an object pick-up event is optionally detected when the system registers a transition from an open-hand gesture to an air pinch gesture (optionally while an attention of the user is directed to the first virtual object). In some embodiments, when the second type of object manipulation event is the object pick-up event, the second operation corresponds to coupling subsequent spatial updates of the first virtual object to the motion of the portion of the user (optionally the same portion of the user that performed the object pick-up event). In some embodiments, when the second type of object manipulation event is the object pick-up event, the second audio output has one or more characteristics associated with the object pick-up event (e.g., the second audio output audibly signifies the object pick-up event). For example, the second audio output for an object pick-up event is optionally a “clamp” sound to signify the first virtual object transitioning to a being controlled by the portion of the user.

In some embodiments, the first type of object manipulation event is an object drop event (e.g., the object drop event in example 1501b of FIG. 15B) and the second type of object manipulation event is an object hand-off event (e.g., the object hand-off event in example 1501d of FIG. 15B). In some embodiments, the object hand-off event shares one or more characteristics with the object hand-off event described with respect to methods 800, 900, 1000, 1100, 1200, and/or 1300. In some embodiments, the object hand-off event is a type of object manipulation event in which the computer system detects that control of the first virtual object is transferred from a first portion of the user (e.g., one hand) to a second, different portion of the user (e.g., the opposite hand), as described in greater detail with respect to method 1100. For example, an object hand-off event is optionally detected when, while a first hand of a user is performing a gesture to control movement the first virtual object, the system detects a second hand of the user perform a hand-off gesture (e.g., a gesture specifically associated with an object hand-off event or a gesture associated with an object pick-up event, such as an air pinch) before detecting the first hand release the gesture (and optionally subsequently detects the first hand release the gesture). In some embodiments, when the second type of object manipulation event is an object hand-off event, the second operation corresponds to re-coupling subsequent spatial updates of the first virtual object from the motion of a first portion of the user to a second portion of the user. In some embodiments, when the second type of object manipulation event is the object hand-off event, the second audio output has one or more characteristics associated with the object hand-off event (e.g., the second audio output audibly signifies the object hand-off event). For example, the second audio output for an object hand-off event is optionally a two-note pattern that pans from a side of the first portion of the user to a side of the second portion of the user. In some embodiments, the computer system classifies an input as an object hand-off event when a first portion of the user drops and a second portion of the user picks up the first virtual object within a hand-off time window (e.g., 0.01 s, 0.05 s, 0.1 s, 0.3 s, 0.8 s, 1 s, 1.5 s, and/or 3 s).

In some embodiments, the first type of object manipulation event is an object approach event (e.g., the object approach event in example 1501c of FIG. 15B) and the second type of object manipulation event is an object pick-up event (e.g., the object pick-up event in example 1501a of FIG. 15B). In some embodiments, the object approach event is a type of object manipulation event in which the computer system detects that an input element (e.g., the portion of the one or more hands) is within a selection region (e.g., within a threshold distance of portion(s) of the first virtual object), as described in greater detail with respect to method 800. For example, an object approach event is optionally detected when the computer system detects the first virtual object's distance to a target plane falls below an approach threshold while the user maintains control of the first virtual object (e.g., by holding an air pinch gesture). In some embodiments, when the first type of object manipulation event is an object approach event, the second operation corresponds to preview-aligning, highlighting, and/or otherwise preparing the first virtual object for a potential placement. In some embodiments, the object approach event and/or the second operation share one or more characteristics with the simulated glow described with reference to method 800. In some embodiments, when the first type of object manipulation event is the object approach event, the first audio output has one or more characteristics associated with the object approach event (e.g., the first audio output audibly signifies the object approach event). For example, the first audio output for an object approach event is optionally a low-level hum that persists while the approach threshold condition is satisfied. In some embodiments, as the computer system detects the first virtual object approaching a target plane associated with an approach threshold, the computer system dynamically modifies one or more characteristics of the first audio output. For example, the computer system optionally ramps up the pitch of the first audio output as the first virtual object approaches the target plane.

In some embodiments, the first type of object manipulation event is an object snapping event (e.g., the object snapping event in example 1501g of FIG. 15B) and the second type of object manipulation event is an object unsnapping event (e.g., the object unsnapping event in example 1501h of FIG. 15B). In some embodiments, the object snapping event is a type of object manipulation event in which the computer system detects that the first virtual object satisfies one or more snapping conditions relative to a designated snap target (e.g., a surface, socket, grid point, or alignment guide). For example, an object snapping event is optionally detected when the computer system detects the first virtual object lies within a snapping threshold (and optionally an angular threshold) of a target. In some embodiments, when the first type of object manipulation event is an object snapping event, the first operation corresponds to automatically repositioning and/or reorienting the first virtual object to a precise, target-defined position. In some embodiments, the object snapping event and/or the first operation share one or more characteristics with the virtual objects snapping described with reference to methods 800, 900, 1000, 1100, 1200, and/or 1300. In some embodiments, when the first type of object manipulation event is the object snapping event, the first audio output has one or more characteristics associated with the object snapping event (e.g., the first audio output audibly signifies the object snapping event). For example, the first audio output for an object snapping event is optionally a “click” (e.g., emulating a mechanical latch). In some embodiments, the computer system modifies one or more characteristics of the first audio output based on a distance over which the first virtual object is automatically translated during the snap. For example, the computer system optionally modifies a volume of the first audio output to be proportional to said distance to signify how far the first virtual object has traveled under automatic control, such as having a lower volume for smaller distances traveled and a higher volume for larger distances traveled. In some embodiments, the object unsnapping event is a type of object manipulation event in which the computer system detects that the first virtual object, previously constrained to a snap target (e.g., a surface in the three-dimensional environment), is detached or released from the snap target. For example, an object unsnapping event is optionally detected when the computer system detects the user pull the first virtual object (e.g., virtually via an air pinch-and-drag gesture) away from the snap target with a linear virtual force and/or distance that exceeds an unsnap threshold. Other examples of the computer system detecting an object unsnapping event include, but are not limited to, the computer system detecting a rotation of the first virtual object beyond an angular threshold or an actuation of a button that serves as an unlock control. In some embodiments, when the second type of object manipulation event is an object unsnapping event, the second operation corresponds to removing the snap constraint and restoring free spatial manipulation of the first virtual object. In some embodiments, when the second type of object manipulation event is the object unsnapping event, the second audio output has one or more characteristics associated with the object unsnapping event (e.g., the second audio output audibly signifies the object unsnapping event). For example, the second audio output for an object unsnapping event is optionally a release “click” (e.g., an inverse of one or more audio characteristics of a latch “click” corresponding to an object snapping event).

In some embodiments, the first type of object manipulation event is an object rotation event (e.g., the object rotation event in example 1501f of FIG. 15B) and the second type of object manipulation event is an object drop event (e.g., the object drop event in example 1501b of FIG. 15B). In some embodiments, the object rotation event is a type of object manipulation event in which the computer system detects that a portion of the user is causing an orientation of the first virtual object (e.g., about one or more axes) to change while the object is being controlled by the portion of the user. For example, an object rotation event is optionally detected when the computer system detects a hand of the user perform an air pinch-and-rotate gesture beyond an angular threshold while the first virtual object is being controlled by the hand. In some embodiments, when the first type of object manipulation event is an object rotation event, the first operation corresponds to updating the orientation of the first virtual object within the three-dimensional environment. In some embodiments, the object rotation event and/or the first operation share one or more characteristics with the rotation of virtual objects described with reference to methods 800, 900, 1000, 1100, 1200, and/or 1300. In some embodiments, when the first type of object manipulation event is the object rotation event, the first audio output has one or more characteristics associated with the object rotation event (e.g., the first audio output audibly signifies the object rotation event). For example, the first audio output for an object rotation event is optionally a tonal glide whose pitch rises or falls as the object is rotated (e.g., proportionally to the angular velocity of the rotation). As another example, the first audio output for an object rotation event optionally includes a “tick” that the computer system generates each time the rotation of the first virtual object causes the object to cross a predefined angular increment.

In some embodiments, the first type of object manipulation event is an object rotation event (e.g., the object rotation event in example 1501f of FIG. 15B) and the second type of object manipulation event is an object drag event (e.g., the object drag event in example 1501e of FIG. 15B). In some embodiments, the object drag event is a type of object manipulation event in which the computer system detects that a portion of the user is translating the first virtual object (e.g., changing the position of the first virtual object within the three-dimensional environment along one or more axes) while the first virtual object is being controlled by the portion of the user (optionally with little to no change to the orientation of the first virtual object). For example, an object drag event is optionally detected when the computer system detects a hand of the user perform an air pinch-and-drag gesture whose linear distance and/or velocity exceeds a drag threshold (and optionally while a rotation angle and/or angular velocity of the hand performing the air pinch-and-drag gesture remains below a rotation threshold) while the first virtual object is being controlled by the hand. In some embodiments, when the second type of object manipulation event is an object drag event, the second operation corresponds to updating the position of the first virtual object within the three-dimensional environment. In some embodiments, the object drag event and/or the second operation share one or more characteristics with the translation of virtual objects described with reference to methods 800, 900, 1000, 1100, 1200, and/or 1300. In some embodiments, when the second type of object manipulation event is the object drag event, the second audio output has one or more characteristics associated with the object drag event (e.g., the second audio output audibly signifies the object drag event). For example, the second audio output for an object drag event is optionally a low-frequency rumble whose amplitude scales with the velocity of the translation of the first virtual object (e.g., the velocity of the portion of the user controlling the first virtual object). As another example, the second audio output for an object drag event optionally includes a “tick” that the computer system generates each time the translation of the first virtual object causes the object to cross a predefined distance increment. In some embodiments, when the second type of object manipulation event is the object drag event, the computer system does not generate and/or output the second audio output.

In some embodiments, the first type of object manipulation event is an object drop event (e.g., the object drop event in example 1501b of FIG. 15B) and the second type of object manipulation event is an object toss event (e.g., the object toss event in example 1501i of FIG. 15B). In some embodiments, the object toss event shares one or more characteristics with moving the virtual object in the three-dimensional environment to the respective resting pose that is based on the designated resting behavior of the virtual object described with respect to method 1300. In some embodiments, the object toss event is a type of object manipulation event in which the computer system detects that a portion of the user moves (or otherwise imparts movement to the first virtual object) with sufficient linear velocity and/or acceleration (e.g., exceeding a velocity and/or acceleration threshold) while controlling the first virtual object immediately prior to releasing the first virtual object. For example, an object toss event is optionally detected when the computer system detects a hand of the user perform a sharp acceleration spike (e.g., performing an air pinch-and-drag gesture with an acceleration exceeding a respective threshold) or move with a velocity exceeding a respective threshold immediately prior to releasing the first virtual object (e.g., by opening the hand or otherwise ceasing to perform the gesture that maintains control of the first virtual object). In some embodiments, when the second type of object manipulation event is an object toss event, the second operation corresponds to displaying the first virtual object moving within the three-dimensional environment after being released by the portion of the user previously controlling the first virtual object. In some embodiments, upon detecting the portion of the user release the first virtual object, the computer system displays the first virtual object moving within the three-dimensional environment with a respective velocity and/or computed based on a velocity and/or acceleration of the portion of the user immediately prior to releasing the first virtual object. In some embodiments, the computer system applies a deceleration to the first virtual object moving within the three-dimensional environment while the first virtual object is no longer being controlled by the portion of the user. In some embodiments, when the second type of object manipulation event is the object toss event, the second audio output has one or more characteristics associated with the object toss event (e.g., the second audio output audibly signifies the object toss event). For example, the second audio output for an object toss event is optionally a “whoosh” whose amplitude scales with the velocity of the first virtual object upon being released by the portion of the user.

In some embodiments, the first input and the first virtual object are associated with a first application running on the computer system, such as the object pick-event on virtual object 1532a of application 1530a in FIG. 15C. In some embodiments, the first audio output and the second audio output are selected from a plurality of system default audio outputs, such as computer system 101 selecting audio output 1520a from a plurality of system default audio outputs for use in applications 1530a and 1530b in FIG. 15C.

In some embodiments, the system default audio outputs are a set of audio assets (and/or audio parameters, such as frequency, amplitude, timbre, and/or duration) supplied by the computer system and made available to multiple independent applications. In some embodiments, each system default audio output is associated with one or more object manipulation events. In some embodiments, when an application calls for an audio output to an object manipulation event, the computer system selects a corresponding system default audio output to output for the object manipulation event (unless the application overrides the system default audio output with a custom asset). In some embodiments, a system default audio output is a static recording (e.g., a full-length audio file). In some embodiments, a system default audio output is not a static recording but a preset for a real-time synthesizer and, when generating an audio output for an object manipulation event, the computer system injects one or more characteristics of the object manipulation event (e.g., a velocity, size, material, and/or other characteristic of the first virtual object) into the preset to synthesize the audio output in real time. In some embodiments, when the first input corresponds to the first object manipulation event, the computer system selects, from the plurality of system default audio outputs, a first preset associated with the first type of object manipulation event defining one or more first audio parameters and modifies at least one of the one or more first audio parameters (e.g., frequency, amplitude, duration, and/or timbre) as a function of one or more first characteristics of the first input to generate the first audio output. In some embodiments, when the first input corresponds to the second object manipulation event, the computer system optionally selects, from the plurality of system default audio outputs, a second preset (optionally different from the first preset) associated with the second type of object manipulation event defining one or more second audio parameters (optionally different from the one or more first audio parameters) and modifies at least one of the one or more second audio parameters as a function of one or more second characteristics (optionally different from the one or more first characteristics) of the first input to generate the second audio output. In some embodiments, the plurality of system default audio outputs is grouped by one or more categories (e.g., object manipulation event types or material of the first virtual object or a related object or surface).

In some embodiments, the computer system detects, via the one or more input devices, a second input directed to a second virtual object, wherein the second input and the second virtual object are associated with a second application running on the computer system, different from the first application, such as the object pick-up event on virtual object 1532b of application 1530b in FIG. 15C. In some embodiments, the second input and the second virtual object share one or more characteristics with the first input and the first virtual object described herein.

In some embodiments, in response to detecting the second input, in accordance with a determination that the second input corresponds to the first type of object manipulation event that is associated with spatial manipulation of the second virtual object (e.g., the air pinch of hand 1502 while attention 1504 is directed to virtual object 1532b corresponding to an object pick-up event in FIG. 15C), the computer system performs the first operation associated with the second virtual object, such as coupling subsequent spatial updates of virtual object 1532b to the motion of hand 1502 in FIG. 15C. In some embodiments, determining that the second input corresponds to the first type of object manipulation event that is associated with the spatial manipulation of the second virtual object shares one or more characteristics with determining that the first input corresponds to the first type of object manipulation event that is associated with the spatial manipulation of the first virtual object described herein. In some embodiments, the first operation associated with the second virtual object shares one or more characteristics with the first and/or second operations associated with the first virtual object described herein.

In some embodiments, in response to detecting the second input, in accordance with the determination that the second input corresponds to the first type of object manipulation event that is associated with spatial manipulation of the second virtual object (e.g., the air pinch of hand 1502 while attention 1504 is directed to virtual object 1532b corresponding to an object pick-up event in FIG. 15C), the computer system generates, via the one or more audio output devices, the first audio output corresponding to the first type of object manipulation event that is associated with spatial manipulation of the second virtual object, such as generating audio output 1520a corresponding to the object pick-up event associated with virtual object 1532b in FIG. 15C. In some embodiments, generating the first audio output corresponding to the first type of object manipulation event that is associated with spatial manipulation of the second virtual object shares one or more characteristics with generating the first audio output corresponding to the first type of object manipulation event that is associated with spatial manipulation of the first virtual object described herein.

In some embodiments, in response to detecting the second input, in accordance with a determination that the second input corresponds to the second type of object manipulation event that is associated with spatial manipulation of the second virtual object (e.g., an object drop event on virtual object 1532b following the object pick-up event on virtual object 1532b in FIG. 15C), the computer system performs the second operation associated with the second virtual object., such as decoupling the motion of hand 1502 to subsequent spatial updates of virtual object 1532b in FIG. 15C. In some embodiments, determining that the second input corresponds to the second type of object manipulation event that is associated with the spatial manipulation of the second virtual object shares one or more characteristics with determining that the first input corresponds to the second type of object manipulation event that is associated with the spatial manipulation of the first virtual object described herein. In some embodiments, the second operation associated with the second virtual object shares one or more characteristics with the first and/or second operations associated with the first virtual object described herein.

In some embodiments, in response to detecting the second input, in accordance with the determination that the second input corresponds to the second type of object manipulation event that is associated with spatial manipulation of the second virtual object (e.g., an object drop event on virtual object 1532b following the object pick-up event on virtual object 1532b in FIG. 15C), the computer system generates, via the one or more audio output devices, the second audio output corresponding to the second type of object manipulation event that is associated with spatial manipulation of the second virtual object, such as generating an audio output 1520b that would correspond to an object drop event associated with virtual object 1532b that is the same as an audio output 1520b that would correspond to an object drop event associated with virtual object 1532a in FIG. 15C. In some embodiments, generating the second audio output corresponding to the second type of object manipulation event that is associated with spatial manipulation of the second virtual object shares one or more characteristics with generating the second audio output corresponding to the second type of object manipulation event that is associated with spatial manipulation of the first virtual object described herein.

In some embodiments, the first audio output is defined by an application associated with the first virtual object, and is different from a system default audio output for the first type of object manipulation event, such as audio output 1520b being defined by application 1530a associated with virtual object 1532c and being different from a system default audio output for object pick-up events in FIG. 15D. In some embodiments, the first audio output being defined by the application associated with the first virtual object means that the audio data and/or generation instructions (e.g., recorded sample, synthesis preset, and/or parameter set) originate from, or are distributed with, the software application that instantiated (or otherwise owns) the first virtual object. In some embodiments, the first audio output replacing the system default audio output means that, when the respective object manipulation event is determined, the computer system selects the application-defined audio output (e.g., the first audio output) rather than the audio output that would ordinarily be drawn from a system-wide default library (e.g., the system default audio output which is associated with the first type of object manipulation event). In some embodiments, replacing the system default audio output refers to the computer system substituting the entire system default audio output for the first audio output. In some embodiments, replacing the system default audio output refers to the computer system modifying one or more characteristics of the system default audio output (e.g., frequency, amplitude, timbre, and/or duration) to generate the first audio output while still using the system default audio output as the base. For example, the application optionally transmits a set of parameters and/or parameter deltas (e.g., +200 Hz pitch shift, −6 dB gain) for the first object manipulation event and/or the first virtual object that the computer system applies to the system default audio output to generate the first audio output. In some embodiments, when an application-defined audio output is unavailable (e.g., not provided by the application, missing file, network connectivity error, or another such error), the computer system revers to the system default audio output. In some embodiments, the second audio output is defined by an application associated with the first virtual object (e.g., the application that defines the first audio output), and is different from a system default audio output for the second type of object manipulation event. In some embodiments, different applications (e.g., a first application and a second application) define different audio outputs (e.g., a first respective audio output and a second respective audio output) for the same object manipulation event (e.g., the first type of object manipulation event).

In some embodiments, generating the first audio output includes, in accordance with a determination that the first virtual object is a first object, generating a first respective audio output, such as generating audio output 1520a for the object pick-up event on virtual object 1532a in FIG. 15D. In some embodiments, determining that the first virtual object is the first object refers to the computer system identifying the first virtual object as belonging to a first object identity or category (e.g., a particular asset ID, object class, material tag, and/or size range). In some embodiments, the first respective audio output is an audible signal expressly associated with the first object identity or category for the relevant object manipulation event (e.g., the first object manipulation event).

In some embodiments, generating the first audio output includes, in accordance with a determination that the first virtual object is a second object, different from the first object, generating a second respective audio output, different than the first respective audio output, such as generating audio output 1520b, different from audio output 1520a, for the object pick-up event on virtual object 1532c in FIG. 15D. In some embodiments, determining that the first virtual object is the second object shares one or more characteristics with determining that the first virtual object is the first object. In some embodiments, generating the second respective audio output shares one or more characteristics with generating the first respective audio output. As an illustrative example, when the first object is a metal box, the first respective audio output optionally has brighter overtones and when the second object is a wooden box, the second respective audio output optionally has duller characteristics. In some embodiments, the first respective audio output and the second respective audio output are different audio outputs altogether or differ in at least one audio characteristic (e.g., pitch, timbre, tone, volume, duration, character (e.g., a “click” vs. a “thud”), a specific multi-component sound pattern or layered effect, or overall sound effect). In some embodiments, the computer system enables an application, developer, or end-user to change one or more audio outputs for one or more virtual objects and/or one or more object manipulation events. In some embodiments, changing one or more audio outputs includes substituting a different audio asset for a respective virtual object and/or object manipulation event and/or modifying one or more audible characteristics (e.g., frequency, amplitude, timbre, duration, pattern, and/or waveform) of a baseline audio asset.

In some embodiments, in response to detecting the first input, in accordance with a determination that the first input corresponds to a third type of object manipulation event that is associated with spatial manipulation of the first virtual object and that audio generation for the third type of object manipulation event is deactivated (e.g., audio generation for object drag events being deactivated in example 1501e of FIG. 15B), the computer system performs a third operation associated with the first virtual object without generating an audio output corresponding to the third type of object manipulation event, such as translating virtual object 1510 within three-dimensional environment 1500 without generating audio output 1520e in example 1501e of FIG. 15B. In some embodiments, the third type of object manipulation event shares one or more characteristics with the first and/or second object manipulation events described herein. In some embodiments, the audio generation for the third type of object manipulation event being deactivated refers to the computer system operating under a configuration state (e.g., set by the operating system, an application associated with the first virtual object and/or the first input, a developer, and/or a user preference) in which no audible signal is produced when the third type of object manipulation event is detected.

In some embodiments, the third operation shares one or more characteristics with the first and/or second operations described herein. In some embodiments, preforming the third operation associated with the first virtual object without generating the audio output corresponding to the third type of object manipulation event means that, when the first input corresponds to the third type of object manipulation event, although the computer system performs the third operation, the computer system does not generate any audible signal in response to detecting the first input. In some embodiments, an application, developer, and/or end-user sets a configuration indicating that audio feedback for the third type of object manipulation event (and/or the first virtual object, a particular environment, and/or another related context) is disabled, such that when the computer system detects the third type of object manipulation event (and/or detects that an object manipulation event involves the first virtual object, a particular environment, and/or another related context), the system executes the third operation but does not fetch or synthesize an audio output associated to the third type of object manipulation event. In some embodiments, in response to detecting the first input, when the first input corresponds to the third type of object manipulation event that is associated with spatial manipulation of the first virtual object and that audio generation for the third type of object manipulation event is activated, the computer system generates a third audio output corresponding to the third type of object manipulation event.

In some embodiments, generating the first audio output includes, in accordance with a determination that the first virtual object is at a first location in the three-dimensional environment when the first input is detected (e.g., virtual object 1510 at the location that is at the distance D1 from user 1506 within room 1505a in example 1501j of FIG. 15E), generating, via the one or more audio output devices, a respective audio output (e.g., either the first audio output or the second audio output, depending on the operation that is performed) with first audio characteristics (e.g., pitch, timbre, tone, volume, duration, character (e.g., a “click” vs. a “thud”), a specific multi-component sound pattern or layered effect, or overall sound effect), such as generating audio output 1520j with audio characteristics based on the location of virtual object 1510 in example 1501j of FIG. 15E. In some embodiments, the first location refers to a spatial position or region, within the three-dimensional environment, that the computer system identifies for the first virtual object at the moment the first input is detected. In some embodiments, the respective audio output is the audible feedback that the computer system selects and/or synthesizes when the first virtual object is determined to be at the first location at the moment the first input is detected (e.g., such that the first respective audio output audibly signifies that the first virtual object is in the first location). In some embodiments, the first audio characteristics of the respective audio output are selected and/or synthesized based on one or more characteristics of the first location. For example, when the first location is in a left side relative to the viewpoint of the user, the first audio characteristics are determined such that the respective audio output is optionally rendered with a stereo pan bias to the left (e.g., the audio is spatial audio that is presented as if emanating from the first location).

In some embodiments, generating the first audio output includes, in accordance with a determination that the first virtual object is at a second location, different from the first location, in the three-dimensional environment when the first input is detected (e.g., virtual object 1510 at the location that is at the distance D2 from user 1506 within room 1505a in example 1501k of FIG. 15E), generating, via the one or more audio output devices, a respective audio output (e.g., either the first audio output or the second audio output, depending on the operation that is performed) with second audio characteristics, different from the first audio characteristics, such as generating audio output 1520k with audio characteristics based on the location of virtual object 1510 in example 1501k of FIG. 15E. In some embodiments, the second location shares one or more characteristics with the first location described above. In some embodiments, the respective audio output of the second location shares one or more characteristics with the respective audio output of the first location described above. In some embodiments, the respective audio output of the second location differs from the respective audio output of the first location in one or more audible characteristics (e.g., frequency, amplitude, timbre, and/or duration) such that a user is able to distinguish between the first input being detected when the first virtual object is in the first location versus the second location (e.g., the audio is spatial audio that is presented as if emanating from the first location or the second location).

In some embodiments, generating the first audio output includes, in accordance with a determination that the first virtual object is at a first location in the three-dimensional environment relative to a viewpoint of a user when the first input is detected (e.g., virtual object 1510 being at the location that is at the distance D1 from user 1506 within room 1505a in example 1501j of FIG. 15E), generating the first audio output with a first attenuation applied to the first audio output, such as generating audio output 1520j with an attenuation applied based on distance D1 in example 1501j of FIG. 15E. In some embodiments, the first attenuation refers to a predetermined and/or dynamically computed reduction (e.g., expressed as a gain factor, dB offset, or another equivalent loudness-scaling parameter) that the computer system applies to the first audio output when the first virtual object is determined to be at the first location at the moment the first input is detected. In some embodiments, the computer system applies the first attenuation based on which zone of one or more zones mapped within the three-dimensional environment the first location is within. In some embodiments, the computer system applies the first attenuation by interpolating along a continuous distance-attenuation curve.

In some embodiments, generating the first audio output includes, in accordance with a determination that the first virtual object is at a second location, different from the first location, relative to a viewpoint of a user in the three-dimensional environment when the first input is detected (e.g., virtual object 1510 being at the location that is at the distance D2 from user 1506 within room 1505a in example 1501, of FIG. 15E), generating the first audio output with a second attenuation, different from the first attenuation, applied to the first audio output, such as generating audio output 1520k with an attenuation applied based on distance D2 in example 1501k of FIG. 15E. In some embodiments, the second attenuation shares one or more characteristics with the first attenuation. In some embodiments, the second attenuation is different in magnitude and/or spectral profile from the first attenuation based on the difference between the second location and the first location from the viewpoint of the user. For example, when the first location corresponds to a nearer location from the viewpoint of the user than the second location (e.g., the first location is 5 m away from the user and the second location is 10 m away from the user), the first attenuation corresponds to a smaller magnitude than the second attenuation (e.g., the first sound is attenuated by 3 dB and the second sound is attenuated by 12 dB).

In some embodiments, generating the first audio output includes, in accordance with a determination that the three-dimensional environment includes a first set of spatial characteristics (e.g., room 1505a having a respective set of spatial characteristics in FIG. 15E), generating, via the one more audio output devices, the first audio output with a first modification, such as generating audio outputs 1520j and 1520k with a modification based on a set of spatial characteristics specific to room 1505a in examples 1501j and 1501k of FIG. 15E. In some embodiments, generating the first audio output with the first modification means that, after the computer system classifies the first input as the first object manipulation event, the system renders or plays the first audio output while applying at least one signal-processing change (e.g., the first modification) that is selected and/or parameterized according to a first set of spatial characteristics (e.g., room/environment size, room/environment volume, ceiling/environment height, wall material (and/or reflectivity), enclosure/environment type (e.g., indoor room versus open courtyard), room/environment object density (e.g., how sparsely or full a space is filled with objects), and/or ambient noise level) of the current three-dimensional environment (e.g., the physical environment and/or a virtual environment). In some embodiments, the first modification includes modifications to one or more characteristics of the first audio output, such as pitch, amplitude, timbre, duration, reverb, echo amount, bass level, treble level, stereo width, left-right panning, and/or attack and decay times). For example, when the system determines that the three-dimensional environment exhibits a first set of characteristics corresponding to a small room, the first modification optionally includes a reverb to the first audio output corresponding to a tight, intimate ambience. As another example, when ambient environmental noise exceeds a respective threshold, the first modification optionally includes raising the volume level of the first audio output to counter the loud environment.

In some embodiments, generating the first audio output includes, in accordance with a determination that the three-dimensional environment includes a second set of spatial characteristics, different from the first set of spatial characteristics (e.g., such as virtual environment 1505b having a respective set of spatial characteristics in FIG. 15E), generating, via the one or more audio output devices, the first audio output with a second modification, different from the first modification, such as generating audio output 1520l with a modification based on a set of spatial characteristics specific to virtual environment 1505b 1505 in example 15011 of FIG. 15E. In some embodiments, the second modification shares one or more characteristics with the first modification described above. As an illustrative example, when the first set of characteristics define a small room and the second set of characteristics define a large, stone-walled hall, the first modification optionally includes softening the first audio output and shortening its reverb while the second modification optionally includes brightening the first audio output and lengthening its reverb. In some embodiments, a virtual environment refers to a computer-generated spatial scene (e.g., two-dimensional or three-dimensional) that is displayed by the one or more display generation components. In some embodiments, the virtual environment is wholly synthetic, a reconstruction of physical space, or a blend of real-world imagery with synthetic elements (mixed or augmented reality).

In some embodiments, generating the first audio output includes generating the first audio output with a first randomization or pseudo-randomization applied to one or more characteristics of a baseline first audio output, such as generating one of audio outputs 1520a-1520i with a randomization or pseudo-randomization applied to one or more characteristics of a baseline audio output corresponding to a respective object manipulation event, as described with respect to FIG. 15B. In some embodiments, the baseline first audio output is a non-randomized sound that the computer system designates for the first type of object manipulation event before any run-time alterations (e.g., due to randomization, spatial characteristics, first virtual object characteristics, and/or interaction characteristics) are applied. In some embodiments, the first randomization or pseudo-randomization refers to a range (e.g., a numeric span, a percentage of a base parameter, a standard deviation for a random distribution, and/or a probability of toggling among discrete variants) within which the computer system intentionally varies one or more audible characteristics of the first audio output (e.g., frequency, amplitude, timbre, duration, start-time, and/or spatial position). For example, when the first randomization or pseudo-randomization is a distribution (e.g., a uniform distribution or a normal distribution) bounded at ±5 dB relative to a nominal loudness, such as 65 dB, the computer system selects a random loudness value for the first audio output from the range of 60 dB to 70 dB. Some examples of the one or more characteristics associated with the first audio output that the first randomization or pseudo-randomization is able to be applied to include, but are not limited to, pitch, amplitude, timbre, duration, reverb, echo amount, bass level, treble level, stereo width, left-right panning, and/or attack and decay times. In some embodiments, in response to detecting a subsequent input, in accordance with a determination that the subsequent input corresponds to the first type of object manipulation event that is associated with spatial manipulation of the first virtual object, the computer system generates an audio output similar to the first audio output but with a second randomization or pseudo-randomization applied to the one or more characteristics of the baseline first audio output. In some embodiments, generating the second audio output corresponding to the second object manipulation event includes generating the second audio output with the first randomization or pseudo-randomization (or a different randomization or pseudo-randomization) applied to one or more characteristics of a baseline second audio output. In some embodiments, pseudo-randomization refers to a pseudorandom value applied to the one or more characteristics of the baseline first audio output (e.g., generated by a seeded algorithm such that future instances are able to reproduce the exact same variations when the seed is reused). In some embodiments, the first randomization or pseudo-randomization is a quantitative measure (e.g., a numeric range, percentage offset, or standard deviation) that specifies how far the randomized characteristics diverge from the baseline characteristics.

In some embodiments, after performing the first operation associated with the first virtual object, and after generating the first audio output (e.g., after performing the drag operation on virtual object 1510 and generating audio output 1520e in example 1501e of FIG. 15B), the computer system detects, via the one or more input devices, a subsequent input directed to the first virtual object, such as computer system 101 detecting a subsequent object drag event on virtual object 1510 at some point in time after detecting the first object drag event in example 1501e of FIG. 15B. In some embodiments, the subsequent input shares one or more characteristics with the first input described herein.

In some embodiments, in response to detecting the subsequent input, in accordance with a determination that the subsequent input corresponds to the first type of object manipulation event that is associated with spatial manipulation of the first virtual object, the computer system performs the first operation associated with the first virtual object, such as translating virtual object 1510 in accordance with motion of hand 1502 detected after detecting the motion corresponding to the first object drag event in example 1501e of FIG. 15B.

In some embodiments, in response to detecting the subsequent input, in accordance with the determination that the subsequent input corresponds to the first type of object manipulation event that is associated with spatial manipulation of the first virtual object, the computer system generates, via the one or more audio output devices, the first audio output corresponding to the first type of object manipulation event that is associated with spatial manipulation of the first virtual object, wherein generating the first audio output includes generating the first audio output with a second randomization or pseudo-randomization, different than the first randomization or pseudo-randomization, applied to the one or more characteristics of the baseline first audio output, such as generating audio output 1520e for the object drag event in example 1501e of FIG. 15B with a distinct randomization or pseudo-randomization applied to one or more characteristics of a baseline drag audio output, different from a randomization or pseudo-randomization applied in an earlier object drag event. In some embodiments, the second randomization or pseudo-randomization shares one or more characteristics with the first randomization or pseudo-randomization. In some embodiments, despite the subsequent input being classified as the first type of object manipulation event and being directed to the first virtual object, the system generates the first audio output with the second randomization or pseudo-randomization applied to one or more characteristics of the first audio output such that the audio output associated with the first input is audibly distinguishable from the audio output associated with the subsequent input. In some embodiments, each time an operation is performed on the first virtual object, the computer system replays the corresponding audio cue with its own independent randomization or pseudo-randomization. As an example, the system optionally plays the audio output corresponding to the first input with a pitch shifted by 2% from a nominal value and a volume level up by 1 dB from a nominal value and plays the audio output corresponding to the second input with a pitch shifted by 5% from the nominal value, a volume level down by 3 dB from the nominal value, and duration that is 3% longer than a nominal value. In some embodiments, one or more first operations are mapped to non-randomized audio cues (or to no audio at all) while one or more second operations are mapped to randomized audio cues. In some embodiments, generating the second audio output corresponding to the second type of object manipulation event includes generating the second audio output with the second randomization or pseudo-randomization or a different randomization or pseudo-randomization) applied to one or more characteristics of a baseline second audio output.

In some embodiments, generating the first audio output includes, in accordance with a determination that the first virtual object includes a first set of one or more object characteristics (e.g., virtual object 1510a including a set of object characteristics, such as a cube shape with a respective size, in FIG. 15F), generating, via the one or more audio output devices, the first audio output with a first set of one or more audio characteristics (e.g., pitch, timbre, tone, volume, duration, character (e.g., a “click” vs. a “thud”), a specific multi-component sound pattern or layered effect, or overall sound effect) having a first set of one or more values, such as generating audio output 1520m with a set of one or more audio characteristics having one or more values based on the object characteristics of virtual object 1510a in example 1501m of FIG. 15F. In some embodiments, the first set of one or more object characteristics refers to one or more attributes assigned to, or computed for, the first virtual object (e.g., simulated material, mass, size, weight, color, surface texture, rigidity, and/or semantic category) that the computer system uses to distinguish the first virtual object from other virtual objects for purposes of selecting and/or shaping audio outputs. In some embodiments, the first set of one or more audio characteristics share one or more characteristics with other audio characteristics described herein. In some embodiments, the first set of one or more audio characteristics having the first set of one or more values refers to the computer system defining a set of audio characteristics with specific numerical or descriptive settings (e.g., 440 Hz pitch, −6 dB gain, 120 ms decay).

In some embodiments, generating the first audio output includes, in accordance with a determination that the first virtual object includes a second set of one or more object characteristics, different from the first set of one or more object characteristics (e.g., one of virtual objects 1510b or 1510c including respective sets of object characteristics, such as being a sphere shape or a cube shape with a size larger than the size of virtual object 1510a, in FIG. 15F), generating, via the one or more audio output devices, the first audio output with the first set of one or more audio characteristics having a second set of one or more values, different from the first set of one or more values, such as generating one of audio outputs 1520n or 1520 with respective sets of one or more audio characteristics having one or more values based on the object characteristics of virtual objects 1510b or 1510c, respectively, in examples 1501n and 1501m of FIG. 15F. In some embodiments, the second set of one or more object characteristics shares one or more characteristics with the first set of one or more object characteristics. As an illustrative example, when the first set of one or more object characteristics defines the first virtual object as being metal, the first set of one or more values optionally includes higher frequencies of the first audio output (e.g., resulting in a “clang” sound effect), whereas when the second set of one or more object characteristics defines the first virtual object as being rubber, the second set of one or more values optionally includes muted sharp overtones of the first audio output (e.g., resulting in a dull “thump” sound effect). As another example, when the first set of one or more object characteristics defines the first virtual object as having a simulated weight of 5 kg, the first set of one or more values optionally includes an increased loudness of the first audio output by 5 dB, whereas when the second set of one or more object characteristics defines the first virtual object as having a simulated weight of 0.2 kg, the second set of one or more values optionally includes a reduced loudness of the first audio output by 2 dB. In some embodiments, the first set of one or more audio characteristics having the second set of one or more values shares one or more characteristics with the first set of one or more audio characteristics having the first set of one or more values. In some embodiments, generating the second audio output includes, in accordance with a determination that the first virtual object includes the first or second set of one or more object characteristics, generating the second audio output with a second set of one or more audio characteristics having a first or second set of one or more values, respectively.

In some embodiments, generating the first audio output includes, in accordance with a determination that a first interaction characteristic of the first input has a first value (e.g., speed 1542a of object manipulation event 1540a in example 1501p of FIG. 15G), generating, via the one or more audio output devices, the first audio output with a first set of one or more audio characteristics (e.g., pitch, timbre, tone, volume, duration, character (e.g., a “click” vs. a “thud”), a specific multi-component sound pattern or layered effect, or overall sound effect) having a first set of one or more values, such as generating audio output 1520p with a set of one or more audio characteristics having one or more values based on speed 1542a of object manipulation event 1540a in example 1501p of FIG. 15G. In some embodiments, the first interaction characteristic is a measurable and/or computable parameter of the first input (e.g., velocity, acceleration, gesture sharpness, duration, angular velocity, and/or angular acceleration) that the computer system uses to quantify how the portion of the user manipulates the first virtual object. In some embodiments, when the first interaction characteristic has the first value, the computer system generates the first audio output with the first set of one or more audio characteristics having the first set of one or more values corresponding to the first value.

In some embodiments, generating the first audio output includes, in accordance with a determination that the first interaction characteristic of the first input has a second value, different than the first value (e.g., speed 1542b of object manipulation event 1540b in example 1501q of FIG. 15G), generating, via the one or more audio output devices, the first audio output with the first set of one or more audio characteristics having a second set of one or more values, different from the first set of one or more values, such as generating audio output 1520q with a set of one or more audio characteristics having one or more values based on speed 1542b of object manipulation event 1540b in example 1501q of FIG. 15G. In some embodiments, the second value shares one or more characteristics with the first value described above. As an illustrative example, when the first interaction is a linear velocity of the portion of the user performing the first input, when the first value corresponds to a slower velocity, the first set of one or more values optionally include a lower a volume level of the first audio output and when the second value corresponds to a faster velocity, the second set of one or more values optionally include a greater volume level of the first audio output. In some embodiments, generating the second audio output includes, in accordance with a determination that the first interaction characteristic of the first input has the first or second value, generating the second audio output with a second set of one or more audio characteristics having a first or second set of one or more values, respectively.

In some embodiments, generating the first audio output includes, in accordance with a determination that performing the first operation associated with the first virtual object includes the first virtual object interacting with a first surface material (e.g., the snapping operation including virtual object 1510 interacting with the “wood” material of surface 1550a in example 1501r of FIG. 15H), generating, via the one or more audio output devices, the first audio output with a first set of one or more audio characteristics (e.g., pitch, timbre, tone, volume, duration, character (e.g., a “click” vs. a “thud”), a specific multi-component sound pattern or layered effect, or overall sound effect) having a first set of one or more values, such as generating audio output 1520r with a set of one or more audio characteristics having one or more values based on the interaction between virtual object 1510 and surface 1550a in example 1501r of FIG. 15H. In some embodiments, the first surface material is a physical surface material that is detected or estimated by the computer system or a simulated surface material for a virtual surface. In some embodiments, the first surface material is a virtual or real-world material that the computer system associates with a surface (e.g., a plane, socket, rail, or panel) involved when the first operation is performed on the first virtual object (e.g., when the first input is classified as an object snapping or unsnapping event). Some examples of surface materials include, but are not limited to, metal, glass, wood, plastic, fabric, stone, and/or composite materials. In some embodiments, when the system determines the first operation involves a surface having the first surface material, the system generates the first audio output with the first set of one or more audio characteristics having the first set of one or more values that audibly reflect an acoustic character of the first surface material. In some embodiments, the first set of one or more values are generated and/or selected based on one or more properties (e.g., softness or hardness) of the first surface material (or a first surface associated with the first surface material).

In some embodiments, generating the first audio output includes, in accordance with a determination that performing the first operation associated with the first virtual object includes the first virtual object interacting with a second surface material, different from the first surface material (e.g., the snapping operation including virtual object 1510 interacting with the “felt” material of surface 1550b in example 1501s of FIG. 15H), generating, via the one or more audio output devices, the first audio output with the first audio set of one or more characteristics having a second set of one or more values, different from the first set of one or more values, such as generating audio output 1520s with a set of one or more audio characteristics having one or more values based on the interaction between virtual object 1510 and surface 1550b in example 1501s of FIG. 15H. In some embodiments, the second surface material shares one or more characteristics with the first surface material described above. As an illustrative example, when the first surface material is wood, the first set of one or more values optionally include lower high-frequency content of the first audio output, whereas when the second surface material is glass, the second set of one or more values optionally include greater higher frequencies and extended duration or decay of the first audio output. In some embodiments, generating the second audio output includes, in accordance with a determination that performing the second operation associated with the first virtual object includes the first virtual object interacting with the first or second surface material, generating the second audio output with a second set of one or more audio characteristics having a first or second set of one or more values, respectively.

In some embodiments, before displaying the first virtual object, the computer system detects, via the one or more input devices, a second input directed to the first virtual object corresponding to a request to display the first virtual object, such as if before displaying virtual object 1510, computer system 101 detected an input from hand 1502 and/or attention 1504 corresponding to a request to display virtual object in one of examples 1501t-1501v of FIG. 15I. In some embodiments, the second input shares one or more characteristics with the first input described herein.

In some embodiments, in response to detecting the second input, the computer system displays the first virtual object at a first location within the three-dimensional environment and one or more object controls associated with the first virtual object, wherein the one or more object controls have a first spatial arrangement (e.g., position and/or orientation) relative to the first virtual object, such as displaying virtual object 1510 at a location within three-dimensional environment 1500 and object controls 1514a-1514b associated with virtual object 1510 and having a respective spatial arrangement relative to virtual object 1510 in examples 1501t-1501v of FIG. 15I. In some embodiments, object controls are graphical or other user-perceivable interface elements that the computer system renders in a fixed spatial relationship (e.g., the first spatial arrangement) to the first virtual object and that enable, indicate, and/or facilitate actions, states, and/or metadata associated with the first virtual object. In some embodiments, each object control is selectable, continuously interactive, and/or purely informational. In some embodiments, the one or more object controls change one or more characteristics of the first virtual object (e.g., visual characteristics, such as size and/or color, and/or spatial characteristics, such as position and/or orientation). Some examples of object controls include, but are not limited to, an object grabber, a sharing-status indicator, a file-name label, resizing affordances, a progress bar, a context menu button, a color-swatch picker, and/or a rotation affordance. In some embodiments, when the computer system detects an input directed to a respective object control, the computer system performs a respective operation corresponding to the input and the respective object control. In some embodiments, the first spatial arrangement refers to a fixed geometric relationship between the one or more object controls and the first virtual object (e.g., including relative positions, orientations, distances, and/or anchoring rules).

In some embodiments, while displaying the first virtual object at the first location within the three-dimensional environment, and while displaying the one or more object controls with the first spatial arrangement (e.g., position and/or orientation) relative to the first virtual object, the computer system detects, via the one or more input devices, a third input directed to the first virtual object, corresponding to moving the first virtual object from the first location in the three-dimensional environment, to a second location in the three-dimensional environment, such as detecting hand 1502 move corresponding to movement of virtual object 1510 from its original location to a new location in three-dimensional environment 1500 in example 1501u of FIG. 15I. In some embodiments, the third input shares one or more characteristics with the first and/or second input described herein. For example, the third input is optionally an air pinch-and-drag gesture directed to the first virtual object.

In some embodiments, in response to detecting the third input, the computer system moves the first virtual object from the first location to the second location, such as moving virtual object 1510 from its original location to a new location in three-dimensional environment 1500 in accordance with movement of hand 1502 in example 1501u of FIG. 15I. In some embodiments, in response to detecting the third input, while displaying the first virtual object at the second location, the computer system displays, via the one or more display generation components, the one or more object controls with the first spatial arrangement relative to the first virtual object, such as displaying object controls 1514a-1514b at the new location with the respective spatial arrangement relative to virtual object 1510 in example 1501u of FIG. 15I. In some embodiments, when the computer system translates, rotates, scales, and/or otherwise transforms the first virtual object, the system maintains the first spatial arrangement of the one or more object controls such that each control remains in the same relative position (e.g., same offset vector and orientation) with respect to the object (e.g., so that the overall visual layout remains constant from the viewpoint of the user). In some embodiments, displaying the one or more object controls with the first spatial arrangement relative to the first virtual object in response to detecting the third input includes moving the one or more object controls within the three-dimensional environment and positioning the one or more controls such that they maintain the same orientation with respect to the first virtual object at the second location.

In some embodiments, while moving the first virtual object from the first location to the second location (and/or while detecting the third input), the computer system forgoes display of (or, optionally ceases display of) the one or more object controls, such as computer system 101 ceasing to display object controls 1514a-1514b while moving virtual object 1510 from its original location to the new location in three-dimensional environment 1500 in examples 1501t-1501v of FIG. 15I. In some embodiments, forgoing display of the one or more object controls while moving the object from the first location to the second location refers to the computer system temporarily suppressing, hiding, and/or otherwise withholding displaying the one or more controls during the motion interval (e.g., so that they are not visible (or are partially diminished) while the object is in transit) and then restores their full visibility (and spatial arrangement relative to the first virtual object) when the move is complete (e.g., upon detecting termination of the third input, such as detecting a release, such as an open hand, after an air pinch-and-drag gesture). In some embodiments, forgoing display applies to all of the one or more object controls. In some embodiments, forgoing display applies to a subset of the one or more object controls, while the remaining object controls are displayed and move with the first virtual object, maintaining their spatial arrangement relative to the first virtual object. For example, non-essential controls (e.g., annotation pins and file-name labels) are hidden during motion, while critical controls (e.g., an object grabber) remain visible. In some embodiments, the computer system displays the one or more object controls during motion of the first virtual object at a first level of opacity and returns the one or more object controls to full opacity once the object is stationary. In some embodiments, the computer system displays the one or more object controls during motion of the first virtual object at a reduced size and returns the one or more object controls to full size once the object is stationary.

In some embodiments, while displaying the first virtual object at the second location, the computer system detects, via the one or more input devices, termination of the third input, such as detecting hand 1502 release the air pinch gesture after performing the air pinch-and-drag gesture in example 1501v of FIG. 15I. In some embodiments, termination of the third input refers to the computer system detecting that the user action which was previously recognized as the third input (e.g., an air pinch-and-drag gesture) has ended (e.g., an opening of the hand performing the third input).

In some embodiments, in response to detecting termination of the third input, the computer system displays (e.g., maintains display of), via the one or more display generation components, the first virtual object at the second location without displaying the one or more object controls, such as displaying virtual object 1510 at the new location without displaying object controls 1514a-1514b in response to detecting hand 1502 release the air pinch gesture in example 1501v of FIG. 15I.

In some embodiments, while displaying the first virtual object at the second location without displaying the one or more object controls, the computer system detects a fourth input directed to the first virtual object, such as detecting hand 1502 perform the air pinch gesture while attention 1504 is directed to virtual object 1510 while displaying virtual object 1510 without displaying object controls 1514a-1514b in example 1501v of FIG. 15I. In some embodiments, the fourth input shares one or more characteristics with the first, second, and/or third inputs described herein. For example, the fourth input optionally corresponds to an air pinch gesture or an attention of the user directed at the first virtual object for longer than a threshold amount of time. In some embodiments, the fourth input is not an input associated with movement of the first virtual object.

In some embodiments, in response to detecting the fourth input, the computer system displays, via the one or more display generation components, the one or more object controls with the first spatial arrangement relative to the first virtual object, while displaying the first virtual object at the second location, such as displaying virtual controls 1514a-1514b at the new location with the respective spatial arrangement relative to virtual object 1510 in response to detecting hand 1502 perform the air pinch gesture while attention 1504 is directed to virtual object 1510 in example 1501v of FIG. 15I. In some embodiments, rather than displaying the one or more object controls moving with the first virtual object as the computer system moves the first virtual object within the three-dimensional environment in response to the second input, the computer system ceases to display the one or more object controls (or maintains display of the one or more object controls at the first location) until the computer system detects the fourth input (at which point the computer system displays the one or more object controls at the second location with the first spatial arrangement relative to the first virtual object).

In some embodiments, while displaying the object at the second location without displaying the one or more object controls, the computer system detects, via the one or more input devices, termination of the third input, such as detecting hand 1502 release the air pinch gesture after performing the air pinch-and-drag gesture while displaying virtual object 1510 at the second location without displaying object controls 1514a-1514b in example 1501u of FIG. 15I. In some embodiments, detecting termination of the third input refers to the computer system recognizing an end-of-action condition for the third input (e.g., a release of an air pinch-and-drag gesture).

In some embodiments, in response to detecting termination of the third input, the computer system displays, via the one or more display generation components, the one or more object controls with the first spatial arrangement relative to the object at the second location, such as displaying virtual controls 1514a-1514b at the new location with the respective spatial arrangement relative to virtual object 1510 automatically in response to detecting hand 1502 release the air pinch in example 1501u in FIG. 15I. In some embodiments, upon detecting termination of the third input, the system automatically restores the one or more object controls and positions them in the first spatial arrangement relative to the object without requiring additional input (e.g., the fourth input) from the user. In some embodiments, while moving the first virtual object from the first location to the second location, the computer system forgoes display of the one or more object controls.

It should be understood that the particular order in which the operations in method 1600 have been described is merely exemplary and is not intended to indicate that the described order is the only order in which the operations could be performed. One of ordinary skill in the art would recognize various ways to reorder the operations described herein. In some embodiments, aspects/operations of method 1600 may be interchanged, substituted, and/or added between these methods. For example, various object manipulation techniques and/or object movement techniques of method 1600 are optionally interchanged, substituted, and/or added between these methods. For brevity, these details are not repeated here.

FIGS. 17A through 17K illustrate methods of moving virtual objects relative to a pivot point defined based on attention of a user in accordance with some embodiments of the disclosure. In some embodiments, the operations illustrated with respect to FIGS. 17A through 17K illustrate at least some of the operations described with reference to method 1800.

FIG. 17A illustrates movement of a virtual object relative to a respective pivot point that is defined based on a location of attention of a user of a computer system. For example, computer system 101 described with reference to FIGS. 17B through 17K optionally perform the operations illustrated in FIG. 17A. In FIG. 17A, input is detected by the computer system including an air pinch which includes contact between a thumb and an index finger of hand 1714 while hand 1714 has an orientation 1722a. As shown in FIG. 17A, hand 1714 has orientation 1722a, which optionally corresponds to an orientation at which the fingertips of hand 1714 are directed away from the user (e.g., parallel to the ground and/or away in a depth direction from the viewpoint of the user) with a palm of hand 1714 being oriented toward the ground. In some embodiments, the computer system detects attention directed to a location that corresponds to a respective location on a virtual object concurrently with detecting the initiation of the input hand 1714 forming the air pinch while having the orientation 1722a relative to a three-dimensional environment. A location of attention corresponding to pivot point 1780a, pivot point 1780c, and pivot point 1780e correspond to alternative locations at which attention of the user (e.g., based on gaze, a position of a focus selector such as a cursor, and/or placement of the fingers of hand 1714) optionally target the same virtual object 1708. For example, the attention location corresponding to pivot point 1780a corresponds to a forehead of the octopus corresponding to virtual object 1708. Pivot point 1780c corresponds to a tentacle on a left side of the virtual object 1708. Pivot point 1780e correspond to a middle tentacle, toward a far end of the tentacle of virtual object 1708.

In some embodiments, based on the location that the attention of the user is directed to, the computer system moves the virtual object relative in accordance with a “pivot point” as described with reference to method 1800. In some embodiments, the pivot point is based on the location of attention. For example, the pivot point optionally corresponds to a location of attention corresponding to a pivot point 1780a, pivot point 1780c, and/or pivot point 1780e. In some embodiments, the pivot point is used as a basis for rotation of virtual object 1708. For example, the computer system optionally detects a twisting of hand 1714 while the air pinch is maintained after detecting the initiation of the air pinch. In response to detecting the twisting of the hand 1714 to the orientation 1722b, the computer system optionally rotates virtual object 1708, such as twisting such that the palm of hand 1714 rotates from facing toward the ground, to at least partially facing toward the right of the viewpoint of the user while the fingers of hand 1714 remain pointing backwards in a depth direction, away from the viewpoint of the user. In some embodiments, the pivot point that corresponds to where attention of the user was directed when the input initiated defines the point relative to which the virtual object 1708 is rotated. For example, when the attention location corresponding to pivot point 1780a is present when the input by hand 1714 is detected, the computer system rotates virtual object 1708 from the orientation 1720a to the orientation 1720b in response to detecting hand 1714 twist from orientation 1722a to orientation 1722b. Thus, the center of the forehead of the octopus corresponding to virtual object 1708 remains in place, and the computer system rotates the virtual object 1708 relative to the pivot point 1780a on the forehead of the virtual object 1708. Similarly, when attention of the user is directed to pivot point 1780c when input by hand 1714 is detected, the computer system rotates virtual object 1708 from the orientation 1720c to orientation 1720d. In such an example, the pivot point 1780c rotates the virtual object 1708 about pivot point 1780c (e.g., the pivot point on the left-tentacle of the octopus) in response to detecting hand 1714 twist from orientation 1722a to orientation 1722b. In some embodiments, when attention of the user is directed to pivot point 1780e when input by hand 1714 is detected, the computer system rotates virtual object 1708 from the orientation 1720e to the orientation 1720f in response to detecting hand 1714 twist from orientation 1722a to orientation 1722b. Thus, in some embodiments, the computer system defines a pivot point about which the computer system moves the virtual object that is at least partially based on the location that attention of the user is directed towards, relative to the virtual object. It is understood that as described with reference to method 1800, the computer system optionally rotates virtual object 1708 along a plurality of different rotational axes based on rotation of hand 1714 and/or other rotational input from other types of input elements. Additionally or alternatively, the rotating of virtual object 1708 as shown in FIG. 17A optionally applies to the rotation of virtual object 1708 as described with reference to FIGS. 17B through 17K.

FIG. 17B illustrates a computer system 101 (e.g., tablet, smartphone, wearable computer, or head mounted device) displaying, via a display generation component (e.g., display generation component 120 of FIG. 1A such as a computer display, touch screen, or one or more display modules of a head mounted device), a three-dimensional environment 1700 (e.g., an AR, AV, VR, MR, or XR environment) from a viewpoint of the user of the computer system 101 (e.g., tablet, smartphone, wearable computer, or head mounted device), for example, facing a back wall of the physical environment in which computer system 101 is located. In some embodiments, computer system includes a display generation component 120 and a plurality of image sensors 314B-314c (e.g., image sensors 314 of FIG. 3A). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101 (e.g., tablet, smartphone, wearable computer, or head mounted device). In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., based on gaze and/or a location of a focus selector such as a cursor) of the user (e.g., internal sensors facing inwards towards the face of the user).

As shown in FIG. 17B, computer system 101 captures one or more images of the physical environment around computer system, including one or more objects in the physical environment around computer system 101. In some embodiments, computer system 101 displays representations of the physical environment included in three-dimensional environment 1700. For example, three-dimensional environment 1700 optionally presents an image of a physical pedestal, and/or the physical pedestal is optionally physically visible via a transparent or semi-transparent material.

In FIG. 17B, three-dimensional environment 1700 also includes one or more virtual objects. For example, as shown in FIG. 17B, the computer system 101 is displaying virtual object 1708 in the three-dimensional environment 1700 (e.g., an AR, AV, VR, MR, or XR environment). In some embodiments, the virtual object is or includes one or more of user interfaces of an application (e.g., an application running on the computer system 101 (e.g., tablet, smartphone, wearable computer, or head mounted device)) containing content (e.g., windows displaying photographs, playback user interface displaying content, and/or web-browsing user interface displaying text), three-dimensional objects (e.g., virtual clocks, virtual animals, virtual balls, and/or virtual cars) or any other element displayed by computer system 101 (e.g., tablet, smartphone, wearable computer, or head mounted device) that is not included in the physical environment of display generation component 120. For example, three-dimensional environment 1700 in FIG. 17B includes a volumetric virtual object 1708, corresponding to virtual object 708 as described in greater detail herein.

In FIG. 17B, computer system 101 displays virtual object 1708 (e.g., similar to, or the same as virtual object 708 described with reference to FIG. 7A). In particular, virtual object 1708 is displayed at a first position and with a first orientation within the three-dimensional environment 1700. In FIG. 17B, computer system 101 detects attention 1780 of the user of computer system 101 directed to a position overlaying virtual object 1708. In FIG. 17B, computer system 101 displays visual feedback 1718, which optionally corresponds to the glow preselection feedback described with reference to method 800. In FIG. 17B, outside the dimensions of the housing of computer system 101, the position of hand 1714 is shown overhead relative to three-dimensional environment 1700. The overhead view of three-dimensional environment 1700 includes a set of axes 1712, which optionally illustrates the relative movement of virtual object 1708 and/or hand 1714 in three-dimensional environment 1700, relative to the viewpoint of the user of computer system 101. The vertical axis on the set of axes 1712 optionally corresponds to a depth axis, extending away from the viewpoint of the user of computer system 101. The horizontal axis on the set of axes 1712 optionally corresponds to a lateral axis of three-dimensional environment 1700, extending to the left and the right of the viewpoint of the user of computer system 101. In FIG. 17B, attention 1780 is directed to a location in three-dimensional environment 1700 that corresponds to virtual object 1708. In particular, as described with reference to FIG. 17C, the location of attention 1780 in FIG. 17B corresponds to a potential pivot point, such as pivot point 1780a (e.g., indicated by the “x”).

From FIG. 17B to FIG. 17C, computer system 101 detects a selection input including an air pinch formed by hand 1714. In response to detecting the air pinch as shown in FIG. 17C, computer system 101 optionally displays feedback indicating that virtual object 1708 is selected (e.g., as described with reference to method 800). Additionally, computer system 101 optionally establishes the pivot point 1780a, which corresponds to the location of attention as indicated in FIG. 17B. In some embodiments, pivot point 1780a is displayed, and in some embodiments, pivot point 1780a is not displayed. As shown in the overhead view of three-dimensional environment 1700, the pivot point 1780a optionally is offset from a center of virtual object 1708. As described with reference to FIG. 17B, the axes of rotation for virtual object 1708 optionally extend from pivot point 1780a and/or are optionally anchored to the pivot point 1780a. In FIG. 17C, the axes are illustrated as a set of Cartesian coordinate axes extending rightward relative to the viewpoint of the user, and/or backwards (e.g., toward the back wall of the room of the user), as indicated by the “x” notation at the pivot point 1780a.

In FIG. 17C, as shown in the overhead view, computer system 101 detects and/or determines a vector 1768 indicating a current orientation and/or direction of an input element, such as hand 1714 relative to three-dimensional environment 1700. In some embodiments, the vector 1768 is used as a basis for movement of virtual object 1708 as described in detail herein.

From FIG. 17C to FIG. 17D, computer system 101 detects hand 1714 rotating in three-dimensional environment 1700 while the air pinch is maintained. For example, hand 1714 rotates by a first angle (e.g., a first amount) corresponding to the offset between vector 1768 (e.g., the current orientation of hand 1714) relative to the vector 1770 (e.g., corresponding to a previous orientation of hand 1714, such as indicated by vector 1768 as shown in FIG. 17C). From FIG. 17C to FIG. 17D, computer system 101 rotates virtual object 1708 by a second amount, based on, but different from the first amount of rotation of hand 1714. For example, virtual object 1708 in FIG. 17D is facing a left wall of the three-dimensional environment 1700 based on the rotation of hand 1714, as indicated in the overhead view of three-dimensional environment 1700 illustrating a 90-degree clockwise rotation of the virtual object 1708 and a 90-degree clockwise rotation of facing vector 1764 (e.g., extending normal from a front face of the virtual object 1708). From FIG. 17C to FIG. 17D, virtual object 1708 is rotated about the pivot point 1780a (e.g., an axis of rotation that extends to the back wall of three-dimensional environment 1700 and passes through pivot point 1780a), which is in a same location in FIG. 17C and FIG. 17D. Thus, from FIG. 17C to FIG. 17D, the computer system rotates the virtual object 1708 about pivot point 1780a while maintaining the position of pivot point 1780a in three-dimensional environment 1700. In FIG. 17D, because hand 1730 (e.g., a different hand than hand 1714 of the user) is not controlling movement of virtual object 1708 (e.g., is not forming an air pinch), computer system 101 forgoes rotation of virtual object 1708 based on movement of hand 1730. Further, in FIG. 17D, computer system 101 detects attention 1780 directed to a respective portion of virtual object 1708 that does not correspond to pivot point 1780a, and does not correspond to the updated position of pivot point 1780a as shown in FIG. 17E.

From FIG. 17D to FIG. 17E, computer system 101 detects a selection input by hand 1730 while the selection input by hand 1714 is maintained, thereby causing a dual input element control of virtual object 1708 based on input from hand 1714 and/or from hand 1730. From FIG. 17D to FIG. 17E, hands 1714 and 1730 do not move, with the exception of hand 1730 forming an air pinch. In response to detecting the selection input by hand 1730 as shown in FIG. 17E, computer system 101 moves the pivot point 1780a to correspond to a center of the virtual object 1708, as illustrated by the movement of pivot point 1780a and/or the axes that originate from pivot point 1780a moving to the center of the head of the octopus corresponding to virtual object 1708. At the same time, computer system 101 maintains the position and/or orientation of virtual object 1708 from FIG. 17D to FIG. 17E. Further, in FIG. 17E, although attention 1780 is directed to the respective portion of virtual object 1708 that does not correspond to pivot point 1780a when the selection input by hand 1730 is detected, computer system 101 moves pivot point 1780a to the center of the virtual object. Thus, in some embodiments, computer system 101 uses a pivot point that is not based on, or is least different from a location of attention of the user when input directed to a virtual object is detected.

In FIG. 17E, based on the selection input by hand 1730 and by hand 1714, computer system 101 optionally begins to forgo use of vector 1768 as a basis for controlling rotation of virtual object 1708, as described in greater detail in the Figures that follow. In FIG. 17E, computer system 101 establishes a vector 1772, which extends from the point at which the air pinch by 1714 is formed to the point at which the air pinch by hand 1730 is formed. As described in the Figures that follow, computer system 101 optionally uses vector 1772 to control the movement of virtual object 1708 relative to pivot point 1780a.

From FIG. 17E to FIG. 17F, computer system 101 detects hand 1714 maintains a position in three-dimensional environment 1700, and detects hand 1730 move in three-dimensional environment 1700 while air pinches are maintained respectively by hands 1714 and 1730. In response to detecting the movement of hand 1730 relative to hand 1714 from FIG. 17E to FIG. 17F, computer system 101 rotates virtual object 1708 in a direction and/or by an amount based on the relative movement. For example, vector 1772 rotates counterclockwise relative to the overhead view of three-dimensional environment 1700 from FIG. 17E to FIG. 17F by a third angle, and in response, computer system 101 rotates virtual object by a fourth angle, different from and/or based on the third angle. In particular, computer system 101 over-rotates virtual object 1708 from FIG. 17E to FIG. 17F about pivot point 1708a (e.g., about the center of virtual object 1708 by an amount that is greater than the amount of rotation of the hands 1714 and 1730). Additionally, because the vector 1772 is offset from its position as shown in FIG. 17E based on a first direction of rotation, virtual object 1708 is rotated in the same direction (e.g., counter-clockwise as shown in the overhead view of three-dimensional environment 1700).

In some embodiments, computer system 101 scales virtual object 1708 in response to detecting movement of hands 1714 and 1730 relative to one another. For example, computer system 101 detects hand 1730 move away from hand 1714 while hand 1714 maintains its position in three-dimensional environment, as shown from FIG. 17F to FIG. 17G. in particular, the location 1774 indicated with the dashed circle in the overhead view of three-dimensional environment 1700 illustrates the offset of hand 1730 from its position as shown in FIG. 17F to its position as shown in FIG. 17G. In response to detecting the movement of hand 1730 while the air pinch is maintained, computer system 101 scales virtual object 1708 by an amount that is based on the offset between location 1774 to the position of the air pinch of hand 1730 as shown in FIG. 17G. In particular, the virtual object 1708 remains centered on pivot point 1780a from FIG. 17F to FIG. 17G, and optionally increases in scale relative to three-dimensional environment 1700.

From FIG. 17G to FIG. 17H, computer system 101 detects termination of input from hand 1730, and in response, maintains the position of virtual object 1708 in three-dimensional environment 1700 and maintains the location of pivot point 1780a relative to virtual object 1708. In FIG. 17H, hand 1730 no longer controls movement of virtual object 1708. Further, because hand 1714 is the input element that controls movement of virtual object 1708, vector 1768 is used to determine movement of virtual object 1708 away from its position as shown in FIG. 17H. Thus, in FIG. 17H, computer system 101 determines a spatial correspondence between vector 1768 and facing vector 1764 (e.g., in response to input from hand 1730 terminating).

From FIG. 17H to FIG. 17I, computer system 101 detects movement of hand 1714. For example, in FIG. 17I, vector 1768 rotates away from vector 1770 (e.g., where vector 1768 was oriented in FIG. 17H) based on the movement of hand 1714 while the air pinch is maintained. The angular offset between vector 1768 relative to vector 1770 is optionally used as a basis for rotation of virtual object 1708 from FIG. 17H to FIG. 17I. For example, the rotation of facing vector 1764 of virtual object 1708 away from facing vector 1766 (e.g., corresponding to the facing vector 1764 that existed in FIG. 17H) is in a same direction as the rotation of vector 1768 from FIG. 17H to FIG. 17I. Further, the amount of rotation of facing vector 1764 from FIG. 17H to FIG. 17I is optionally based on the amount of rotation of vector 1768 between the same Figures. It can be appreciated that the spatial correspondence between a vector associated with hand 1714 in FIG. 17H relative to the facing vector 1764 of virtual object 1708 is optionally different from the spatial correspondence between the vector associated with hand 1714 and facing vector 1764 in FIG. 17C.

From FIG. 17I to FIG. 17J, computer system 101 detects termination of the input by hand 1714. In response to detecting the termination of the input by hand 1714, the computer system 101 optionally rotates the virtual object 1708 to assume a spatial relationship relative to the viewpoint of the user (e.g., and/or based on the pivot point that last-existed when the input terminated). For example, computer system 101 rotates virtual object 1708 in place from FIG. 17I to FIG. 17J such that the facing vector 1764 is parallel to a respective vector extending normal from the front-surface of computer system 101 about the pivot point 1780a illustrated in the overhead view of three-dimensional environment 1700.

FIG. 17K illustrates different vectors that computer system 101 is able to use to determine the direction and/or amount of movement of a virtual object based on a pivot point. For example, when an air pinch by hand 1714 is active while an air pinch by hand 1730 is active, the computer system optionally uses vector 1782 which optionally extends between where the respective air pinches meet. As the hands 1714 and 1730 move relative to each other, the vector 1782 optionally scales and/or rotates relative to the three-dimensional environment, which the computer system optionally uses as a basis to scale and/or move the virtual object. In some embodiments, vector 1784 is used by the computer system. For example, vector 1784 extends from a portion of a palm of hand 1714, and/or through where the index and thumb fingers meet. In some embodiments, the computer system detects the movement of vector 1784 relative to the three-dimensional environment and causes a virtual object to move in accordance with the movement of vector 1784. In some embodiments, the computer system uses a vector extending from a back portion of hand 1714, such as vector 1786 extending from knuckles included in the hand 1714. In some embodiments, the computer system moves the virtual object in accordance with movement of vector 1786 (e.g., instead of in accordance with movement of vector 1784).

FIG. 18 is a flowchart illustrating an exemplary method of moving virtual objects relative to a pivot point defined based on attention of a user in accordance with some embodiments. In some embodiments, the method 1800 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

The devices, methods, and/or computer-readable storage mediums described below enhance the operability of the device and makes the user-device interface more efficient (e.g., by helping the suer to provide proper inputs and reducing user mistakes when operating/interacting with the device) which, additionally, reduces power usage and/or improves battery life of the devices by enabling the user to use the device more quickly and efficiently. Providing improved feedback (such as by displaying a visual indication corresponding to a location of attention) enhances the operability of the device by reducing accidental and mistaken inputs, reducing energy usage by the device. Reducing the number of inputs needed to perform an operation (such as by orienting a virtual object to align with one or more input elements, moving virtual object about a pivot point based on attention, and/or assume an orientation in response to detecting termination of movement input) enhances the operability of the device by reducing the number of inputs and time required to perform a particular operation, reducing energy usage by the device. Performing an operation when a set of conditions has been met without requiring further user input (such as by selecting a pivot point based on attention and/or using displaying a virtual object with an orientation in response to detecting termination of an input) enhances the operability of the device by reducing unnecessary inputs and/or steps to navigate through different user interfaces or sets of controls, reducing energy usage by the device.

In some embodiments, a method 1800 is performed at a computer system in communication with one or more input devices and one or more display generation components, such as computer system 101 in communication with a display generation component 120 and a plurality of image sensors 314a-314c (e.g., image sensors 314 of FIG. 3A), as shown in FIG. 17A. For example, the computer system optionally has one or more characteristics of the computer system(s) described with reference to methods 800, 900, 1000, 1100, 1200 and/or 1300. Additionally or alternatively, the one or more input devices optionally have one or more characteristics described with reference to the one or more inputs devices described with reference to methods 800, 900, 1000, 1100, 1200 and/or 1300. Additionally or alternatively, the one or more display generation components optionally have one or more characteristics of the one or more display generation components described with reference to methods 800, 900, 1000, 1100, 1200 and/or 1300.

In some embodiments, while displaying, via the one or more display generation components, a virtual object in a three-dimensional environment, the computer system detects (1802), via the one or more input devices, a first input directed to the virtual object that includes movement, such as selection input including an air pinch by hand 1714 as shown in FIG. 17C. For example, the virtual object optionally has one or more characteristics of the virtual object(s) described with reference to methods 800, 900, 1000, 1100, 1200 and/or 1300. In some embodiments, the first input has one or more characteristics of the other input(s) described with reference to methods 800, 900, 1000, 1100, 1200 and/or 1300. For example, the first input optionally corresponds to a request to move (e.g., translate and/or rotate) the virtual object in the three-dimensional environment. Thus, the first input optionally includes movement, such as movement of an air gesture as described further below, movement of a controller, movement of muscles of the user, and/or a request for movement directed to a button, trackpad, joystick, and/or another hardware interface included in the controller. In some embodiments, the three-dimensional environment has one or more characteristics of the three-dimensional environment(s) described with reference to methods 800, 900, 1000, 1100, 1200 and/or 1300. In some embodiments, the first input is associated with a type of input. For example, the first input is optionally an indirect or a direct type of input. An indirect input, for example, optionally includes attention of the user (e.g., based on gaze and/or a cursor location) directed toward a location in the three-dimensional environment such as a location that the virtual object occupies and optionally includes a selection input such as an air pinch (e.g., contacting two or more fingers). In some embodiments, the direct input type has one or more characteristics of similar inputs described with reference to methods 800, 900, 1000, 1100, 1200 and/or 1300, such as selection input directed toward the virtual object while a portion of the body of the user performing the input is within a threshold distance (e.g., 0, 0.005, 0.01, 0.05, 0.1, 0.25, 0.4, or 0.5 m) of the virtual object (e.g., optionally without detecting attention directed to the virtual object). It is understood that such inputs are optionally performed in accordance with input directed to a controller in communication with the computer system, as described further at least with reference to methods 800, 900, 1000, 1100, 1200 and/or 1300.

In some embodiments, in response to detecting the first input (1804), and in accordance with a determination that attention of a user of the computer system is directed to a first location in the three-dimensional environment when the first input is detected, the computer system moves (1806) the virtual object in accordance with the movement of the first input (e.g., moving the virtual object with an amount of movement based on an amount of movement of the input and/or moving the virtual object in a direction based on a direction of movement of the input), such as movement of hand 1714 from the orientation as shown in FIG. 17C to the orientation as shown in FIG. 17D, and in accordance with a first pivot point that corresponds to the first location (e.g., rotating the virtual object relative to and/or about the first location in a first manner), such as pivot point 1780a as shown in FIG. 17C. For example, the computer system optionally rotates and/or translates the virtual object in accordance with the first input and/or about the first pivot point. In some embodiments, the computer system moves the virtual object in accordance with the first input and the first pivot point, without moving other virtual objects and/or the viewpoint of the user in the three-dimensional environment. In some embodiments, the computer system rotates the virtual object in a manner similar to, or the same as described at least with reference to methods 900, 1000, 1100, 1200, and/or 1300 based on user input. Additionally or alternatively, the computer system optionally translates the virtual object in a manner similar to, or the same as described at least with reference to methods 900, 1000, 1100, 1200, and/or 1300 based on user input. In some embodiments, the first pivot point is a location in the three-dimensional environment that defines the origin between different axes of rotation for the virtual object, such as an origin for a coordinate system that is comprised of the one or more axes of rotation of the virtual object. In some embodiments, the first location does not coincide with a location in the three-dimensional environment that is occupied by the virtual object. For example, the first location is optionally offset from and/or away from one or more surfaces of the virtual object and/or a center of the virtual object. In some embodiments, the first location coincides with a location in the three-dimensional environment that is occupied by the virtual object, and/or is within a bounding volume that surrounds the virtual object. In some embodiments, the first location is on a surface and/or within the virtual object. For example, the first location optionally is along a front of a window, a panel of a virtual car door, and/or a rounded surface of a virtual chess pawn. In some embodiments, the first pivot point corresponds to a portion of a selection region and/or a grabbing region as described with reference to methods 800, 900, 1000, 1100, 1200, and/or 1300. For example, in accordance with a determination that the location targeted by attention of the user is closest to a first portion or first segment of a selection region and/or grabbing region associated with the first virtual object, the first pivot point optionally corresponds to a first location (e.g., a point as described with reference to method 1200 used as a center for controlling movement of the virtual object). In accordance with a determination that the location targeted by attention of the user is closest to a second portion or segment of the selection region and/or grabbing region, different from the first selection region and/or grabbing region, the first pivot point optionally corresponds to a second location, different from the first location (e.g., a point as described with reference to method 1200 used as a center for controlling movement of the virtual object).

In some embodiments, the first pivot point corresponds to an intersection between one or more rays cast from the viewpoint of the user and/or the computer system and a portion of the virtual object, such as based on the viewpoint of the user as shown in the overhead view of three-dimensional environment 1700 as shown in FIG. 17C. For example, the first pivot point is optionally located where a ray cast from a center of the head of the user and/or a center of a surface of the computer system intersects with a surface of the virtual object. In some embodiments, the first pivot point is associated with a volume and/or area occupied by the virtual object. For example, the first pivot point is optionally a center of the virtual object and/or a bounding volume that surrounds the virtual object, similar to, the same as, and/or based on the selection region described with reference to method 1200.

In some embodiments, the computer system rotates the first virtual object about a first axis that intersects with the pivot point in response to detecting an input element (e.g., a hand, a peripheral device such as a controller described with reference to at least method 800, and/or additional or alternative input devices such as wearable input devices such as a glove or ring) request rotation about the first axis, such as the axis corresponding to the pivot point 1780c as shown in FIG. 17A. Additionally or alternatively, the computer system optionally rotates the virtual object about a second axis, different from the first axis, that optionally intersects the pivot point and the first axis at the pivot point in response to detecting the input element request rotation about the second axis. Additionally or alternatively, the computer system optionally translates the virtual object along the first and/or the second axis in response to detecting input requesting such movement. In some embodiments, the computer system rotates the virtual object about a plurality of axes in response to detecting rotation of the input element along a plurality of axes, as described with reference to methods 900, 1000, 1100, 1200, and/or 1300.

In some embodiments, in response to detecting the first input (1804), in accordance with a determination that the attention of the user of the computer system is directed to a second location, different from the first location in the three-dimensional environment when the first input is detected, such as pivot point 1780e as shown in FIG. 17A, the computer system moves (1808) the virtual object in accordance with the movement of the first input (e.g., moving the virtual object with an amount of movement based on an amount of movement of the input and/or moving the virtual object in a direction based on a direction of movement of the input) and in accordance with a second pivot point, different from the first pivot point, that corresponds to the second location (e.g., rotating the virtual object relative to the second location and/or moving the virtual object in a manner different from or the same as described with reference to the first manner), such as rotating virtual object 1708 from orientation 1720c to orientation 1720d as shown in FIG. 17A. For example, the computer system optionally uses a second pivot point that is different from the first pivot point when the attention of the user is directed to a different location than the first location. In some embodiments, the computer system moves the virtual object in accordance with the first input and the second pivot point, without moving other virtual objects and/or the viewpoint of the user in the three-dimensional environment. In some embodiments, the second location coincides with a location in the three-dimensional environment that is occupied by the virtual object, and/or is within a bounding volume that surrounds the virtual object. In some embodiments, the second location is on and/or within the virtual object, and/or is different from the first location. For example, the virtual object is optionally a volumetric virtual object having one or more surfaces, and the first location and the second location correspond to different locations on a shared surface or correspond to different locations on different surfaces of the volumetric virtual object. In some embodiments, the second location that corresponds to the second pivot point is associated with the grabbing and/or selection region of the virtual object. For example, the second location is optionally a center and/or is within a second segment of the selection and/or grabbing region, different from the first segment described above. In some embodiments, the second location and/or the second pivot points have one or more characteristics similar to, the same as, and/or that correspond to the one or more characteristics of the first location and/or the first pivot point described above. Further, it is understood that the computer system optionally uses a plurality of pivot points other than the first and/or the second pivot points in response to detecting attention target respective locations near respective pivot points included in the plurality of pivot points. Additionally or alternatively, the plurality of pivot points optionally have one or more characteristics that are similar to, the same as, and/or that correspond to the one or more characteristics of the first location and/or the first pivot point described above.

In this way, in accordance with a determination that the location that attention of the user is detected as being closer to the first segment of the selection region and/or the first location than the second segment of the selection region and/or the second location, the pivot point for subsequent rotation of the virtual object is optionally performed relative to the first location. In accordance with a determination that the location that attention of the user is targeting is closer to the second segment of the selection region and/or the second location than to the first segment of the selection region and/or the first location, the pivot point for subsequent rotation of the virtual object is optionally performed relative to the second location. Using a pivot point that is associated with the target of attention of the user reduces the likelihood that subsequent movement of the virtual object relies upon a pivot point that differs from a desired pivot of the user, thus reducing the likelihood that processing based on erroneous movement of the virtual object is performed by the computer system.

In some embodiments, the first input includes input from a first input element including selection of the virtual object by the first input element (e.g., as described with reference at least to method 800), such as input including the air pinch by hand 1714 as shown in FIG. 17C. In some embodiments, while displaying the virtual object in the three-dimensional environment, and while the virtual object is selected by the first input element based on the first input, the computer system detects, via the one or more input devices, a selection input by a second input element, different from the first input element (e.g., as described with reference at least to method 1300), such as selection input by hand 1730 as shown in FIG. 17E. For example, the computer system optionally detects selection input from the second input element and in response, ceases control of the virtual object based on movement of the first input element. In some embodiments, detecting the selection input includes detecting contact between fingers on a hand of a user (e.g., an air pinch) while attention (e.g., based on gaze and/or a focus selector location, such as a cursor) is directed to the virtual object. In some embodiments, selection input includes tapping on a trackpad while a cursor is directed to the virtual object. In some embodiments, selection input includes a voice command directed to the virtual object. Additionally or alternatively, as described further herein, in response to detecting selection input from the second input element, the computer system optionally initiates control of the virtual object based on movement of the first input element and/or the second input element. In some embodiments, the computer system detects the selection input by the second input element after moving the virtual object in accordance with the first or second pivot point, but while the virtual object is still being controlled by the first input element, as described with reference to method 1100.

In some embodiments, after detecting the selection input by the second input element, the computer system detects movement of the second input element, such as movement of hand 1730 from the position as shown in FIG. 17E to the position as shown in FIG. 17F. For example, the movement of the second input element shares one or more characteristics described with reference to movement of the first input element herein.

In some embodiments, in response to detecting movement of the second input element, in accordance with a determination that the selection input by the second input element satisfies one or more handoff criteria for handoff of the virtual object between the first input element and the second input element (e.g., as described with reference to method 1100), the computer system moves the virtual object in accordance with the movement of the second input element and in accordance with a respective pivot point that is different from the first pivot point and different from the second pivot point, such as if virtual object 1708 moved in accordance with movement of hand 1730 in FIG. 17B to 17C, similar to as shown with respect to hand 1714 as shown in FIGS. 17B and 17C. In some embodiments, the respective pivot point shares one or more characteristics of the first pivot point and/or the second pivot point. In some embodiments, the respective pivot point is the first pivot point. In some embodiments, the respective pivot point is the second pivot point. In some embodiments, the respective pivot point is determined based on attention. For example, the respective pivot point is based on a location of attention of the user when the second input is detected. In some embodiments, the respective pivot point is different from the first pivot and/or the second pivot point. For example, the respective pivot point is associated with a bounding volume and/or box (e.g., that is displayed or not displayed), as described further below. In some embodiments, the respective pivot point is maintained (e.g., does not change) in response to detecting the selection input by the second input element.

In some embodiments, moving the virtual object in accordance with the movement of the second input element and in accordance with the respective pivot point includes, in accordance with a determination that attention of the user of the computer system is directed to a third location that corresponds to the virtual object, different from the first location and different from the second location, when the second selection input is initiated, moving the virtual object in accordance with the movement of the second input element and a third pivot point that corresponds to (e.g., is or is based on) the third location (e.g., the respective pivot point is the third pivot point), such as moving virtual object 1708 in accordance with movement of hand 1730 and pivot point 1780c (e.g., shown in FIG. 17A), similar to as shown with respect to hand 1714 as shown in FIGS. 17B and 17C. In some embodiments, the movement of the virtual object in accordance with the third pivot point is similar to the movement of the virtual object in accordance with the first pivot point and/or the second pivot point. For example, the attention is based on gaze and/or location of a focus indicator such as a cursor. In some embodiments, the third location shares one or more characteristics of the first location and/or the second location described herein (e.g., corresponds to the third pivot point for moving the virtual object). In some embodiments, the third location corresponds to a portion of a selection region (e.g., in a manner similar to, or the same as described with reference to method 1200). In some embodiments, the initiating of the selection input shares one or more characteristics of initiating of other selection inputs described with reference to methods 800, 900, 1000, 1100, and/or 1200, such as detecting contact between fingers forming an air pinch and/or detecting contacting of a trackpad.

In some embodiments, moving the virtual object in accordance with the movement of the second input element and in accordance with the respective pivot point includes, in accordance with a determination that the attention of the user of the computer system is directed to a fourth location, different from the third location, that corresponds to the virtual object when the second selection input is initiated, moving the virtual object in accordance with the movement of the second input element and a fourth pivot point (e.g., the respective pivot point is the fourth pivot point), different from the third pivot point, that corresponds to (e.g., is or is based on) the fourth location (e.g., analogously to moving the virtual object in accordance with the first pivot point, the second pivot point, and/or the third pivot point), such as moving virtual object 1708 in accordance with movement of hand 1730 and pivot point 1780e (e.g., shown in FIG. 17A), similar to as shown with respect to hand 1714 as shown in FIGS. 17B and 17C. For example, the fourth location shares one or more characteristics of the first location, the second location, and/or the third location described herein (e.g., corresponds to the fourth pivot point for moving the virtual object). In some embodiments, the location of the respective pivot point is independent of the position and/or orientation of a portion of the user's body providing a selection input. For example, in accordance with a determination that the attention is directed to the first, second, third, and/or fourth location, the computer system optionally uses a pivot point that corresponds to the first, second, third, and/or fourth location respectively, without regard to whether a position and/or orientation of a hand providing an air pinch (e.g., the selection input) corresponds to a first position and/or orientation or a second position and/or orientation, different from the first position and/or orientation.

In some embodiments, moving the virtual object in accordance with the movement of the second input element and in accordance with the respective pivot point includes, in accordance with a determination that a center of the virtual object is a first location, moving the virtual object in accordance with the movement of the second input element and in accordance with the respective pivot point located at a location that corresponds to (e.g., is or is based on) the first location (e.g., independent of a location of attention of the user when the selection input from the second input element is detected, or based on both the location of attention of the user and the center of the virtual object), such as moving virtual object 1708 based on pivot point 1780a as shown in FIG. 17E. In some embodiments, moving the virtual object in accordance with movement of the second input element and the respective pivot point is optionally analogous to moving the virtual object in accordance with the first input element and the first pivot point and/or second pivot point). For example, a developer of the virtual object defines the center of the virtual object, which the computer system uses to define the center of the virtual object for movement of the virtual object based on the respective pivot point. In some embodiments, the respective pivot point is determined based on a location between the center of the virtual object and a location of attention when the second input element is detected. For example, the computer system determines an average between the center of the virtual object and the location of attention of the user when the second input is detected, and in response, uses the average location as the respective pivot point. In some embodiments, the respective pivot point corresponds to a location at a center of a selection region for the virtual object (e.g., a selection region described in greater detail with reference to method 1200). For example, the computer system moves the virtual object relative to the first location located at a center of the virtual object when the selection input by the second input element is detected. In some embodiments, the center of the virtual object is a center of simulated mass of the virtual object determined by the computer system and/or indicated by a developer of an application used to generate the virtual object. In some embodiments, the movement of the virtual object includes rotation about the first location and/or translation away from the first location based on the movement of the second input element.

In some embodiments, moving the virtual object in accordance with the movement of the second input element and in accordance with the respective pivot point includes, in accordance with a determination that the center of the virtual object is a second location, different from the first location, moving the virtual object in accordance with the movement of the second input element and in accordance with the respective pivot point located at a location that corresponds to (e.g., is or is based on) the second location (e.g., independent of a location of attention of the user when the selection input from the second input element is detected, or based on both the location of attention of the user and the center of the virtual object), such as moving virtual object 1708 based on a pivot point that is different from pivot point 1780a as shown in FIG. 17E. In some embodiments, moving the virtual object in accordance with movement of the second input element and the respective pivot point is optionally analogous to moving the virtual object in accordance with the first input element and the first pivot point and/or second pivot point. For example, the computer system moves the virtual object relative to the second location located at a center of the virtual object when the selection input by the second input element is detected. In some embodiments, the movement of the virtual object includes rotation about the second location and/or translation away from the first location based on the movement of the second input element.

In some embodiments, the one or more handoff criteria include a requirement that the selection input by the second input element was detected before termination of the selection of the virtual object by the first input element in order for the one or more handoff criteria to be satisfied, such as detecting selection input by hand 1730 as shown in FIG. 17E while the input by hand 1714 is active. For example, as described in greater detail with reference to method 1100, the computer system optionally hands control of the virtual object from the first input element to the second input element when the selection input is detected before the selection input by the first input element has terminated. In some embodiments, the one or more handoff criteria share one or more characteristics with the handoff criteria described with respect to method 1100.

In some embodiments, while displaying the virtual object, and while the virtual object is not controlled by movement of the first input, such as if hand 1730 is controlling movement and hand 1714 is not controlling movement of virtual object 1708, different from but optionally similar to as shown in FIG. 17C, the computer system detects, via the one or more input devices, a second input, different from the first input, directed to the virtual object, wherein the second input includes respective first input from a first input element and includes respective second input, different from the respective first input, from a second input element, different from the first input element, such as detecting input from hand 1714 and hand 1730 as shown in FIG. 17E. For example, as described further with reference to methods 800, 900, 1000, 1100, 1200, and/or 1300, the computer system detects a first selection input by the first input element and/or a second selection input by the second input element. In some embodiments, the second selection input has one or more characteristic of the first selection input. For example, detecting the second selection input includes detecting contact between fingers on a hand of a user (e.g., an air pinch) while attention (e.g., based on gaze and/or a focus selector location, such as a cursor) is directed to the virtual object, tapping on a trackpad while a cursor is directed to the virtual object, and/or a voice command directed to the virtual object. In some embodiments, the second input is detected before the first input described with reference to method 1600 is detected (e.g., selection input by the first input element) or after the first input has terminated. In some embodiments, the second input, respective first input from the first input element, and/or the respective second input from the second input element share one or more characteristics described with reference to the first input. In some embodiments, the first input element and/or the second input element share one or more characteristics of input element(s) described with reference to methods 800, 900, 1000, 1100, 1200, and/or 1300.

In some embodiments, in response to detecting the second input, the computer system moves the virtual object in accordance with movement of the first input element relative to the second input element (e.g., and/or moving the virtual object in accordance with movement of the second input element relative to the first input element), such as moving virtual object 1708 as shown in FIGS. 17E and/or 17F. For example, as described below, the computer system detects the relative change in position and/or orientation of the first input element to the second input element (and/or vice-versa), and in response, manipulates the virtual object in the three-dimensional environment. In some embodiments, the manipulation includes rotation, translation, scaling, and/or snapping (e.g., causing instantaneous or rapid movement) of the virtual object to a surface and/or a predetermined position, as described in greater detail with reference to operations performed relative to the respective pivot point herein. For example, as two hands controlling a virtual object move apart, the computer system enlarges the virtual object. Additionally or alternatively, as the two hands rotate relative to each other, the computer system optionally rotates the virtual object based on the relative movement of the hands. In some embodiments, the snapping includes displaying the virtual object with an orientation relative to the three-dimensional environment. For example, in accordance with a determination that an orientation of the virtual object corresponds to an orientation defined by a developer associated with the virtual object, the computer system optionally rotates the virtual object to assume the orientation in the three-dimensional environment. As an example, the computer system optionally displays a virtual toy with a front face of the toy oriented parallel to the head and/or shoulders of the user of the computer system. Additionally or alternatively, the computer system optionally displays a virtual trophy with an orientation such that a flat base of the virtual trophy is parallel with a ground of the three-dimensional environment of the user and/or at a distance from the ground (e.g., 0.5, 0.6, 0.7, 0.8, 0.9, 1, 2, 3, or 5 m).

In some embodiments, moving the virtual object includes rotation of the virtual object in accordance with movement of the first input element relative to the second input element, such as virtual object 1708 moving based on input from hand 1714 and hand 1730 as shown from FIG. 17E to FIG. 17F. In some embodiments, the movement of the first input element includes rotation of the first input element relative to the second input element. In some embodiments, the computer system rotates the virtual object based on an amount of rotation of a vector extending from the first input element to the second input element (e.g., between contact of two fingers on a left hand relative to two fingers on a right hand, a portion of a housing of a first controller relative to a same portion of a housing of the second controller, and/or contacts on a trackpad). For example, in response to detecting the second input and in accordance with a determination that the orientation of the vector relative to the three-dimensional environment changes by a first angle, the computer system rotates the virtual object about the respective pivot point by a respective first angle (e.g., the same as or based on the first angle). Additionally or alternatively, in response to detecting the second input and in accordance with a determination that the orientation of the vector relative to the three-dimensional environment changes by a second angle, different from the first angle, the computer system rotates the virtual object about the respective pivot point by a respective second angle (e.g., the same as or based on the second angle). In some embodiments, the rotating includes “over-rotating” the virtual object. In some embodiments, over-rotating includes rotating the virtual object based on an angle of rotation greater than a change in angle of the vector between the first and/or the second input elements. For example, the computer system uses one or more of the multipliers described with reference to method 1000 to scale the angular change in the vector.

In some embodiments, the axis of rotation is based on the orientation of the vector between the first and second input elements relative to the three-dimensional environment, such as an axis of rotation based on vector 1772 as shown in FIG. 17E. For example, the computer system optionally determines the orientation of the vector relative to the three-dimensional environment (e.g., relative to a Cartesian coordinate system, or another suitable coordinate system). In some embodiments, the computer system determines a calculated vector that is mutually orthogonal with the vector extending between the first and second input elements. In some embodiments, the computer system translates the calculated vector to intersect with the respective pivot point and uses the translated version of the calculated vector as an axis of rotation. Thus, the computer system optionally moves the virtual object in a manner similar to as though the user was physically grasping and/or rotating the virtual object.

In some embodiments, the rotation of the virtual object is performed relative to a respective pivot point, different from the first pivot point and different from the second pivot point (and optionally independent of and/or not based on a location of the attention of the user when the input from the first and second input elements is detected), such as the pivot point 1780a as shown in FIG. 17F. For example, the computer system rotates the virtual object about a center of the virtual object and/or a center of a selection region for the virtual object. Additionally or alternatively, the respective pivot point optionally corresponds to center of a bounding box and/or a bounding volume that surrounds the dimensions of the virtual object. In some embodiments, the center of the bounding box is offset from the center of the virtual object. In some embodiments, the respective pivot point is based on the spatial relationship between the first input element and the second input element. For example, the respective pivot point is optionally a center between a ray that extends between the first input element and the second input element (e.g., between where respective fingers forming air pinches meet, between palms of hands, and/or between respective portions of housing of two controllers).

In some embodiments, moving the virtual object includes, in accordance with a determination that the second input includes changing a distance between the first input element and the second element by a first distance, scaling the virtual object by a first amount that is based on the first distance, such as scaling virtual object 1708 by a first amount based on movement of hand 1714 and/or hand 1730 relative to each other from as shown in FIG. 17F to as shown in FIG. 17G. For example, the computer system optionally scales the virtual object in accordance with changes in distance between the first input element and the second input element while the selection inputs by both input elements are maintained. In some embodiments, in response to detecting movement of the first input element away from the second input element, the computer system scales the virtual object in a first direction (e.g., bigger or smaller in the three-dimensional environment). In some embodiments, in response to detecting movement of the first input element towards the second input element, the computer system scales the virtual object in a second direction, different from the first direction (e.g., smaller or bigger in the three-dimensional environment). In some embodiments, the relationship between the change in distance and the change in scale of the virtual object is linear or is non-linear.

In some embodiments, moving the virtual object includes, in accordance with a determination that the second input includes changing the distance between the first input element and the second input element by a second distance, different from the first distance, scaling the virtual object by a second amount that is based on the second distance, wherein the second amount of scaling is different from the first amount of scaling, such as scaling virtual object 1708 by a second amount, different from the amount of scaling as shown in FIG. 17F to as shown in FIG. 17G based on movement of hand 1714 and/or hand 1730 relative to each other. For example, the computer system scales the virtual object based on the first amount when the distance between the first input element and the second input element changes by the first distance (e.g., 0.1, 0.2, 0.3, 0.5, 1, 2, 5, 10, 50, or 100 cm). Additionally or alternatively, the computer system scales the virtual object based on the second amount when the distance between the first input element and the second input element changes by the second distance (e.g., 0.3, 0.5, 1, 2, 5, 10, 50, 100, 150, or 200 cm). In some embodiments, the direction of scaling is based on a direction of movement of the first and the second input element relative to each other. For example, in accordance with a determination that the input elements move toward each other, the computer system optionally decreases the scale of the virtual object, and in accordance with a determination that the input elements move away from each other, the computer system optionally increases the scale of the virtual object.

In some embodiments, while the virtual object is being controlled by the second input (e.g., including being controlled by the first input element and the second input element, such as while or after moving the virtual object in accordance with the second input), the computer system detects, via the one or more input devices, a termination of the second input, wherein detecting the termination of the second input includes detecting termination of input from the second input element, while input from the first input element is maintained, such as termination of input by hand 1730 as shown in FIG. 17H. For example, the computer system detects a ceasing of contact between fingers on a second hand that were forming an air pinch, a selection of a button on a controller disabling an object manipulation mode on a second controller, and/or release of a button on a controller that was being held for the duration of the second input. Concurrently, the computer system optionally detects that contact between the fingers on a first hand, different from the second hand, remain in an air pinch pose, that a button on a secondary controller has not been pressed while the object manipulation mode for the secondary controller is in the manipulation mode, and/or does not detect release of a button on a controller that was being held for the duration of the second input. In this way, the computer system optionally detects that input from the first input element remains ongoing or active while input from the second input element terminates.

In some embodiments, in response to detecting the termination of the second input, and in accordance with a determination that the input from the first input element is maintained, the computer system moves the virtual object in accordance with subsequent movement of the first input element (e.g., and/or forgoing moving the virtual object in accordance with subsequent movement by the second input element), such as movement of virtual object 1708 based on movement of hand 1714 as shown in FIG. 17H to FIG. 17I. For example, in response to detecting the termination of the second input, the computer system maintains the position and/or orientation of the virtual object in the three-dimensional environment (e.g., absent additional movement input after the termination). While the input from the first input element is active, the computer system optionally detects movement of the first input element, and in response, optionally moves the virtual object in accordance with the first input element in a manner similar to, or the same as described with reference to the first input herein. In this way, the computer system ceases control of the movement of the virtual object in accordance with the second input element while preserving control of the movement of the virtual object in accordance with the first input element. In some embodiments, while the first input is not maintained, the computer system forgoes moving of the virtual object based on movement of the first input element (e.g., maintains the location of the virtual object).

In some embodiments, the movement of the first input includes movement of a first portion of a body of the user of the computer system (e.g., one or more fingers and/or a hand of the user, as described with reference to air gestures herein), such as movement of hand 1714, and moving the virtual object in accordance with movement of the first input and in accordance with the first pivot point comprises rotating the virtual object about the first pivot point based on the movement of the first portion of the body of the user (e.g., as described in greater detail herein), such as moving virtual object 1708 from the orientation as shown in FIG. 17C to the orientation as shown in FIG. 17D and/or from the orientation as shown in FIG. 17H to the orientation as shown in FIG. 17I. For example, the computer system rotates the virtual object relative to the first pivot point based on movement included in the first input, as described in greater detail herein.

In some embodiments, in accordance with a determination that a first vector corresponding to the first portion of the body of the user of the computer system moves from pointing in a first direction to pointing in a second direction, such as vector 1768 moving from the direction as shown in FIG. 17C to the direction as shown in FIG. 17D, the computer system rotates the virtual object by a first amount about the first pivot point corresponding to the change in direction of the first vector, such as moving virtual object 1708 from the orientation as shown in FIG. 17C to the orientation as shown in FIG. 17D. For example, the first vector points and/or extends from a portion of a hand of the user, such as normal to a surface of the palm, originating from the palm and extending through a thumb and index finger forming an air pinch pose, normal to a back of a hand, and/or normal to the part of the hand of the user between an index and middle finger knuckles. In accordance with a determination that the first vector moves in a first direction, the computer system optionally rotates the virtual object in a respective first direction, based on or the same as the first direction. In some embodiments, the movement of the first input includes movement of the first portion of the body of the user from a first orientation to a second orientation, different from the first orientation, relative to the three-dimensional environment. In some embodiments, corresponding to the change in orientation of an input element, the computer system moves the first vector from a first direction (e.g., corresponding to the first orientation) to a second direction, different from the first direction (e.g., corresponding to the second orientation), thus updating the first vector from pointing in a first direction to pointing in a second direction. In some embodiments, the computer system detects the amount of rotation and/or direction of rotation of the first vector relative to a spherical coordinate system (or another coordinate system) having an origin corresponding to the first portion of the user, such as a point on the surface of the palm, the back surface of the hand, and/or the location where the index and thumb forming an air pinch gesture meet, and in response, rotates the virtual object about the first pivot point based on the amount and/or in a direction of the change in the first vector moving from the first direction to the second direction.

In some embodiments, in accordance with a determination that the first vector corresponding to the first portion of the body of the user of the computer system moves from pointing in the first direction to pointing in a third direction, different from the second direction, such as vector 1768 moving from the direction as shown in FIG. 17H to the direction as shown in FIG. 17I the computer system rotates the virtual object by a second amount, different from the first amount, about the first pivot point corresponding to the change in direction of the first vector, such as an amount corresponding to the change in direction of facing vector 1764 from the direction as shown in FIG. 17H to the direction as shown in FIG. 17I. For example, in accordance with a determination that the first vector moves to point in the third direction, the computer system optionally rotates the virtual object in a second direction, based on or the same as the third direction, and/or different from the first direction. In some embodiments, the third direction of the first vector corresponds to a third orientation of the first portion of the body of the user relative to the three-dimensional environment, such as a different orientation of the palm, of the air pinch, of the back surface of the hands of the user, and/or some combination of orientations thereof. As described above, the computer system optionally detects the amount of rotation of the first vector and/or the direction of rotation of the first vector moving from the first direction to the third direction relative to spherical coordinate system, and in response, optionally rotates the virtual object based on the amount of rotation (e.g., the second amount of rotation) and/or in a direction of the change in the first vector about the first pivot point. It is understood that the computer system optionally rotates the first virtual object about the second pivot point in a manner that is the same as described with reference to rotating the virtual object about the first pivot point (e.g., based on the orientation of the first portion of the body of the user rotating in the three-dimensional environment).

In some embodiments, rotating the virtual object about the first pivot point based on the movement of the first portion of the body of the user includes rotating the virtual object by maintaining a respective spatial correspondence between (e.g., an offset between) an input vector of the first portion of the body of the user (e.g., a vector extending outward from a palm of the user) to a reference vector for the virtual object (e.g., a vector that points up from a center of the object), such as the spatial correspondence between vector 1768 and facing vector 1764 as illustrated in FIG. 17B. For example, the computer system optionally maintains difference in position and/or orientation of (e.g., the spatial correspondence between) the input vector relative to the reference vector for the virtual object.

In some embodiments, rotating the virtual object about the first pivot point based on the movement of the first portion of the body of the user includes in accordance with a determination that the virtual object has a first orientation (e.g., a first facing direction of the virtual object) relative to the three-dimensional environment when the input that includes the movement of the first portion of the body of the user started, such as the orientation of vector 1768 as shown in FIG. 17C, using a first spatial correspondence between the input vector of the first portion of the body of the user and the reference vector for the virtual object when rotating the virtual object about the first pivot point based on the movement of the first portion of the body of the user, such as the spatial correspondence between vector 1768 and facing vector 1764 as shown in FIG. 17C. For example, the computer system determines, based on a spherical or other suitable coordinate system, one or more angular offsets between the input vector and the reference vector when the first input including movement of the first portion of the body of the user begins (e.g., without second input from the second input element, such as in response to detecting the second input terminate while the first input is maintained). In some embodiments, the first spatial correspondence (and/or the second spatial correspondence described in greater detail herein) relates to the angular offset and/or distance-based offset between the input vector and the reference vector for the virtual object in the spherical or other coordinate system. For example, the input vector or the reference vector optionally originate at the origin of a spherical coordinate system, and the first spatial relationship includes a polar and/or azimuthal angular offset between the input vector relative to the reference vector, or the reference vector relative to the input vector.

In some embodiments, the first spatial correspondence is used as a basis to determine the amount of movement of the virtual object (e.g., and/or of the reference vector for the virtual object) relative to the amount of movement of the first portion of the body of the user (e.g., and/or the input vector for the first portion of the body of the user). For example, in response to detecting movement of the first portion of the body of the user including a first amount of movement, the computer system moves the virtual object and/or the reference vector by a respective first amount, based on (e.g., similar to or the same as) the first amount.

In some embodiments, in response to detecting movement of the first portion of the body of the user including a second amount of movement, different from the first amount of movement, the computer system moves the virtual object and/or the reference vector by a respective second amount, based on (e.g., similar to or the same as) the second amount and/or different from the respective first amount of movement. In some embodiments, the direction of movement of the virtual object is based on the direction of movement of the first portion of the body of the user. For example, in response to detecting movement of the first portion of the body of the user including a first direction of movement, the computer system moves the virtual object and/or the reference vector in a respective first direction, based on (e.g., similar to or the same as) the first direction. In some embodiments, in response to detecting movement of the first portion of the body of the user including a second direction of movement, different from the first direction of movement, the computer system moves the virtual object and/or the reference vector in a respective second direction, based on (e.g., similar to or the same as) the second direction and/or different from the respective first direction of movement. In this way, the computer system optionally maintains an angular and/or distance-based offset between the input vector and the reference vector.

In some embodiments, rotating the virtual object about the first pivot point based on the movement of the first portion of the body of the user includes in accordance with a determination that the virtual object has a second orientation, different from the first orientation (e.g., a second facing direction of the virtual object, different from the first facing direction), relative to the three-dimensional environment when the input that includes the movement of the first portion of the body of the user started (e.g., due to other rotation of the virtual object such as based on a two-handed rotation input or due to a change in angle of the hand of the user prior to starting the input), such as the orientation of vector 1768 as shown in FIG. 17H, using a second spatial correspondence, different from the first spatial correspondence, between the input vector of the first portion of the body of the user and the reference vector for the virtual object when rotating the virtual object about the first pivot point based on the movement of the first portion of the body of the user, such as the spatial correspondence between vector 1768 and facing vector 1764 as shown in FIG. 17H. For example, the computer system optionally moves the virtual object away from the first orientation and/or moves the virtual object to assume the second orientation based on dual input element movement as described in greater detail herein. Additionally or alternatively, the computer system optionally moves the virtual object to the second orientation based on automatic movement of the virtual object controlled by an application, and/or based on an event being detected that optionally causes the computer system to display the virtual object with the second orientation, such as an input rearranging virtual content in the three-dimensional environment to correspond (e.g., be centered with) the viewpoint of the user. In some embodiments, the input by the first portion of the body of the user starts and/or is re-defined to “start” in response to detecting termination of input from a second portion of the body of the user and/or the second input element, such as detecting a release of a button on a second controller, a de-pinching of a second hand of the user, and/or detecting a voice command terminating control of the virtual object by the second input element.

In some embodiments, the second spatial correspondence is used as a basis to control subsequent movement of the virtual object about the first pivot point. For example, the computer system detects the orientation of the input vector for the first portion of the body of the user when the first input starts, which optionally is a respective first orientation. In some embodiments, similar to as described with reference to the first spatial correspondence, the computer system optionally uses and/or defines a second spatial correspondence based on the orientation of the input vector when the first input starts. For example, the computer system detects movement of the first portion of the body of the user causing the input vector to move to a respective second orientation, different from the respective first orientation. In some embodiments, the computer system detects the amount and/or direction(s) of offset of the input vector and moves the virtual object in a manner similar to as described with reference to moving the virtual object based on the input vector when the virtual object has the first orientation. For example, the computer system detects the input vector move in a third direction, and in response, optionally moves the virtual object in a respective third direction.

In some embodiments, the respective third direction is based on or the same as the third direction, is the same as or different from the first direction of movement of the input vector, and/or is different from the respective first direction of movement of the virtual object. Additionally or alternatively, the computer system optionally detects the input vector move in a fourth direction, different from the third direction, and in response, optionally moves the virtual object in a respective fourth direction. In some embodiments, the respective fourth direction is based on and/or the same as the fourth direction of movement of the input vector, is different from the respective third direction, and/or is the same as or different from the respective second direction of movement of the virtual object.

In some embodiments, the virtual object has a first orientation relative to the three-dimensional environment prior to the first input being initiated, such as the orientation of virtual object 1708 as shown in FIG. 17B. For example, the virtual object is displayed in the three-dimensional environment with a first orientation before the first input is detected (e.g., within 0.01, 0.05, 0.1, 0.2, 0.3, 0.4, 0.5, 1, 5, 10 or 30 seconds of detecting the first input) and/or is in the first orientation when initiation of the first input is detected. As described in greater detail herein, the orientation of the virtual object optionally includes the rotation of the virtual object relative to the reference frame defined by the three-dimensional environment of the computer system.

In some embodiments, while moving the virtual object in accordance with the first input, the computer system detects, via the one or more input devices, termination of the first input (e.g., as described in greater detail herein, such as terminating an air pinch gesture, releasing a button press on a mouse or other controller, and/or removing a finger from contact with a trackpad) while the virtual object has a second orientation, different from the first orientation, relative to the three-dimensional environment, such as termination of input by hand 1714 while the orientation of virtual object 1708 is as shown in FIG. 17I. For example, the computer system moves the virtual object based on movement included in the first input as described in greater detail herein, which optionally includes movement of the virtual object to the second orientation in the three-dimensional environment. In some embodiments, the virtual object is displayed at an initial location prior to detecting the first input.

In some embodiments, in response to detecting the termination of the first input, the computer system displays, via the one or more display generation components, the virtual object with the first orientation relative to the three-dimensional environment, such as virtual object 1708 as displayed in FIG. 17J. For example, while the viewpoint of the user is optionally maintained relative to the three-dimensional environment, the computer system detects the termination of the first input (e.g., as described in greater detail herein, which optionally includes ceasing of contact between fingers that formed an air pinch gesture and/or ceasing of contact on a trackpad). While the viewpoint of the user optionally continues to be maintained relative to the three-dimensional environment, and without detecting additional or alternative inputs aside from the termination of the first input, the computer system optionally moves and/or reorients the virtual object to assume the first orientation. In some embodiments, prior to detecting the first input by the first input element, the virtual object is displayed facing toward the viewpoint of the user. In some embodiments, displaying the virtual object with the first orientation in response to detecting termination of the first input includes rotating a virtual object that is facing away from the viewpoint of the user to face toward the viewpoint of the user. In some embodiments, the computer system moves the virtual object back to the initial location of the virtual object prior to detecting the first input (e.g., away from a second position of the virtual object when the first input terminates). In some embodiments, the movement is animated, such as by showing the gradual or rapid snapping of the virtual object away from the second orientation to the first orientation. In some embodiments, the computer system ceases display of the virtual object having the second orientation and re-displays the virtual object having the first orientation in response to detecting the termination of the first input.

In some embodiments, the virtual object has a first orientation relative to the three-dimensional environment prior to the first input being initiated, such as the orientation of virtual object 1708 as shown in FIG. 17B. For example, the virtual object is displayed in the three-dimensional environment with a first orientation (e.g., as described in greater detail above) before the first input is detected and/or is in the first orientation when initiation of the first input is detected.

In some embodiments, while moving the virtual object in accordance with the first input, the computer system detects, via the one or more input devices, termination of the first input while the virtual object has a second orientation, different from the first orientation, relative to the three-dimensional environment, such as termination of input by hand 1714 while the orientation of virtual object 1708 is as shown in FIG. 17I. For example, while the viewpoint of the user is maintained relative to the three-dimensional environment, the computer system detects the termination of the first input (e.g., as described in greater detail herein, which optionally includes ceasing of contact between fingers that formed an air pinch gesture, releasing a button press on a mouse or other controller, and/or ceasing of contact on a trackpad). For example, the computer system moves the virtual object based on movement included in the first input as described in greater detail herein, which optionally includes movement of the virtual object to the second orientation in the three-dimensional environment (e.g., as described in greater detail above).

In some embodiments, in response to detecting the termination of the first input, the computer system maintains display of the virtual object with the second orientation relative to the three-dimensional environment, such as maintaining the orientation of virtual object 1708 from FIG. 17I in response to the termination of the input in FIG. 17J. While the viewpoint of the user continues to be maintained relative to the three-dimensional environment, and without detecting additional or alternative inputs aside from the termination of the first input, the computer system optionally forgoes further movement of the virtual object (e.g., maintains the second orientation of the virtual object). For example, in response to detecting termination of an air pinch that controls movement of the virtual object, the computer system optionally does not change (e.g., maintains) the orientation of the virtual object that exists when the air pinch terminates, such as maintaining a facing direction and/or not rotating a virtual chess piece in the three-dimensional environment.

In some embodiments, while displaying the virtual object, in accordance with the determination that the attention of the user is directed to the first location in the three-dimensional environment, the computer system displays, via the one or more display generation components, visual feedback of the attention of the user (e.g., as described with reference to method 800) at a third location in the three-dimensional environment corresponding to the first location (e.g., displays visual feedback at the first location), such as visual feedback 1718 as shown in FIG. 17B. For example, as described with reference to method 800, the computer system displays visual feedback at a location that is associated with the position of attention and/or an input element relative to the virtual object. In some embodiments, the third location, for example, corresponds to the location where attention (e.g., based on gaze, head direction, and/or a cursor) is directed to, relative to the virtual object. In some embodiments, the visual feedback is displayed centered on the third location, extending in one or more directions by one or more distances (e.g., 1, 2, 3, 4, 5, 10, or 20 cm). In some embodiments, in response to detecting attention of the user being directed to a location in the three-dimensional environment that does not include the virtual object, the computer system forgoes display of the visual feedback.

In some embodiments, while displaying the virtual object, in accordance with the determination that the attention of the user is directed to the second location in the three-dimensional environment, the computer system displays, via the one or more display generation components, visual feedback of the attention of the user (e.g., as described with reference to method 800) at a fourth location in the three-dimensional environment corresponding to the second location (e.g., displays visual feedback at the second location), wherein the fourth location is different from the third location, such as visual feedback 1718 displayed at a location that is different from the location as shown in FIG. 17B. For example, the computer system forgoes display of the visual feedback at the third location and displays the visual feedback at the fourth location when attention of the user is directed to the second location in a three-dimensional environment, as described in greater detail with reference to method 800. In some embodiments, the third and fourth locations of the visual feedback of the attention of the user are independent of and/or different from the location(s) of the first and/or second input elements relative to the virtual object.

In some embodiments, moving the virtual object in accordance with the movement of the first input and in accordance with the first pivot point comprises, in accordance with a determination that the first input includes input from a first input element but not a second input element (e.g., as described in greater detail herein), such as input from hand 1714 and not from hand 1730 as shown in FIG. 17B and/or 17C, moving the virtual object based on movement of a first vector associated with the first input element (e.g., that has a direction that is independent of a location of a second input element), such as vector 1768 as shown in FIG. 17C. For example, while the first input element and not the second input element controls movement of the virtual object, the computer system uses the first vector as described further herein to define movement of the virtual object in the three-dimensional environment. For example, the first vector extends from the palm of the user, the knuckles of the hand of the user, and/or between the fingers, forming an air pinch. In some embodiments, the first vector is normal to a back surface of the hand of the user. As described in greater detail herein, in response to detecting change in orientation of the first input element (e.g., causing a change in the first vector) by a first amount, the computer system changes the orientation of the virtual object by a respective first amount, based on the first amount. In some embodiments, in response to detecting a change in orientation of the first input element by a second amount, the computer system changes the orientation of the virtual object by a respective second amount, based on the second amount. In some embodiments, in response to detecting change in orientation of the first input element (e.g., causing change in the first vector) in a first direction, the computer system changes the orientation of the virtual object in a respective first direction corresponding to the first direction, and in response to detecting change in orientation of the first input element (e.g., causing change in the first vector) in a second direction, different from the first direction, the computer system changes the orientation of the virtual object in a respective second direction corresponding to the second direction, wherein the respective second direction is different from the respective first direction.

In some embodiments, moving the virtual object in accordance with the movement of the first input and in accordance with the first pivot point comprises, in accordance with a determination the first input includes input from both the first input element and a second input element (e.g., as described in greater detail herein), different from the first input element, such as input from hand 1714 and hand 1730 as shown in FIG. 17E and FIG. 17F, moving the virtual object based on movement of a second vector that is different from the first vector, wherein the second vector is based on a location of the first input element and a location of the second input element (e.g., extends between the first input element and the second input element), such as vector 1772 as shown in FIG. 17E and FIG. 17F. The second vector is optionally independent of the first vector of the first input element (e.g., as described in more detail above) and/or a corresponding first vector of the second input element. For example, while the first input element and the second input element control movement of the virtual object, the computer system uses the second vector as described further herein to define movement of the virtual object in the three-dimensional environment. For example, the second vector extends from the palm of the first hand of the user, the knuckles of the first hand of the user, and/or between the fingers forming an air pinch of the first hand of the user to the palm of a second hand of the user, to the knuckles of the second hand of the user, and/or to between the fingers forming an air pinch of the second hand of the user. As described in greater detail herein, in response to detecting change in orientation of the first input element (e.g., causing change in the second vector) relative to the second input element by a third amount (e.g., the same as or different from first amount), the computer system changes the orientation of the virtual object by a respective third amount, based on the third amount. In some embodiments, in response to detecting change in orientation of the first input element relative to the second input element by a fourth amount (e.g., the same as or different from the second amount), the computer system changes the orientation of the virtual object by a respective fourth amount, based on the fourth amount. In some embodiments, in response to detecting change in orientation of the first input element relative to the second input element in a first direction, the computer system changes the orientation of the virtual object in a respective first direction corresponding to the first direction, and in response to detecting change in orientation of the first input element relative to the second input element in a second direction, different from the first direction, the computer system changes the orientation of the virtual object in a respective second direction corresponding to the second direction, wherein the respective second direction is different from the respective first direction. In some embodiments, in response to detecting a change in orientation of the first input element (e.g., that changes a direction of the first vector) and/or a change in orientation of the second input element, without a change in orientation of the first input element relative to the second input element, the computer system does not move the virtual object.

In some embodiments, while displaying, via the one or more display generation components, the virtual object in the three-dimensional environment, the computer system detects, via the one or more input devices, a second input directed to the virtual object that includes movement, different from the first input, such as movement by hand 1730 from the position as shown in FIG. 17F to the position as shown in FIG. 17G. For example, the second input shares one or more characteristics described with reference to the first input.

In some embodiments, in response to detecting the second input (and optionally while the viewpoint of the user is maintained), in accordance with a determination that the second input corresponds to a first type of manipulation operation and that the first type of manipulation is enabled (e.g., a setting for the virtual object corresponding to the first type of manipulation operation is in a first state that causes the first type of manipulation to be enabled for the virtual object), such as a scaling operation as shown from FIG. 17F to FIG. 17G that is enabled, the computer system performs the first type of manipulation operation in accordance with the movement of the second input, such as scaling of virtual object 1708 from the scale as shown in FIG. 17F to the scale as shown in FIG. 17G. For example, the computer system performs the one or more operations described with reference to the first input and/or other inputs herein such as translation and/or rotation of the virtual object based on a selection input by an input element and/or a plurality of inputs based on a plurality of input elements. In some embodiments, the value of the setting is received from and/or defined by an application that generates the virtual object (e.g., the virtual object is content of the application), and the application that indicates to the computer system where to communicate in order to receive assets for the virtual object, and/or the virtual object is otherwise associated with the application. For example, the setting optionally enables rotation by one input element, rotation by two input elements, translation by one input element and/or translation by two input elements. In some embodiments, the setting enables two-input element manipulation operations and/or enables one-input element manipulation operations. For example, the setting for one-handed rotation being enabled allows the computer system to rotate the virtual object based on rotation of a hand forming an air pinch, and the setting for two-handed rotation being enabled allows the computer system to rotate the virtual object based on rotation of a first hand forming an air pinch rotating in the three-dimensional environment relative to a second hand forming an air pinch. In some embodiments, different types of manipulations of the virtual object as described herein can be independently enabled or disabled. In some embodiments, different virtual objects can have different types of manipulations enabled or disabled for them (e.g., as defined by their corresponding applications).

In some embodiments, in response to detecting the second input (and optionally while the viewpoint of the user is maintained), in accordance with a determination that the second input corresponds to the first type of manipulation operation, and that the first type of manipulation is not enabled (e.g., the setting for the virtual object corresponding to the first type of manipulation operation is in a second state that causes the first type of manipulation to be disabled for the virtual object), such as a scaling operation as shown from FIG. 17F to FIG. 17G that is disabled, the computer system forgoing performs the first type of manipulation operation in accordance with the movement of the second input, such as forgoing scaling of virtual object 1708 from the scale as shown in FIG. 17F to the scale as shown in FIG. 17G. For example, the computer system optionally forgoes one or more of translation and/or rotation of the virtual object based on input from an input element and/or the plurality of input elements. In some embodiments, the computer system disables one-handed rotation but enables two-handed rotation. Thus, the setting optionally corresponds to an enabling of the one-handed rotation of the virtual object. In some embodiments, different types of manipulations of the virtual object as described herein can be independently enabled or disabled. In some embodiments, different virtual objects can have different types of manipulations enabled or disabled for them (e.g., as defined by their corresponding applications).

It should be understood that the particular order in which the operations in method 1800 have been described is merely exemplary and is not intended to indicate that the described order is the only order in which the operations could be performed. One of ordinary skill in the art would recognize various ways to reorder the operations described herein. In some embodiments, aspects/operations of method 1800 may be interchanged, substituted, and/or added between these methods. For example, various object manipulation techniques and/or object movement techniques of method 1800 is optionally interchanged, substituted, and/or added between these methods. For brevity, these details are not repeated here.

FIGS. 19A through 19AN illustrate exemplary ways in which a computer system applies transformations on a virtual object based on movement of one or more input elements, in accordance with some embodiments.

FIG. 19A illustrates an example of computer system 101 displaying virtual object 1910 within a three-dimensional environment 1900 (e.g., a three-dimensional user interface), in accordance with some embodiments. It should be understood that, in some embodiments, computer system 101 utilizes one or more techniques described with reference to FIGS. 19A-19AN in a two-dimensional environment without departing from the scope of the disclosure. As described above with reference to FIGS. 1-6, computer system 101 optionally includes one or more display generation components 120 (e.g., a head-mounted display) and a plurality of image sensors 114a-114c. Image sensors 114a-114c optionally include one or more of a visible light camera, an infrared camera, a depth sensor, or any other sensor computer system 101 would be able to use to capture one or more images of a user or a portion of user (e.g., one or more hands of the user, such as hand 1902, or attention 1904 of the user (e.g., based on gaze)) while the user interacts with computer system 101. In some embodiments, image sensors 114a-114c optionally capture gestures or movements of hand 1902, such as the act of pinching or the release thereof, as described in greater detail herein. In some embodiments, computer system 101 displays the user interface or three-dimensional environment 1900 to a user of computer system 101 (and/or three-dimensional environment 1900 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 19A, computer system 101 displays three-dimensional environment 1900 including virtual object 1910. In some embodiments, virtual object 1910 shares one or more characteristics with one or more virtual objects described with respect to methods 800, 900, 1000, 1100, 1200, 1300, 1600, 1800, and/or 2000. In some embodiments, in response to detecting an input directed to virtual object 1910 (e.g., an object control or pick-up gesture, such as hand 1902 performing an air pinch while attention 1904 is directed to virtual object 1910), computer system 101 associates hand 1902 with virtual object 1910 such that subsequent spatial updates of virtual object 1910 are tied to the motion of hand 1902. FIG. 19A also illustrates spatial coordinates 1920 that illustrate a start location 1922 of hand 1902. In subsequent figures FIGS. 19B-19J, movement of hand 1902 is tracked by spatial coordinates 1920 and compared to start location 1922 of hand 1902.

FIGS. 19B-19J illustrate examples of computer system 101 applying spatial transformations (e.g., rotating and/or translating) on virtual object 1910 based on movement of hand 1902, in accordance with some embodiments. Although FIGS. 19B-19J illustrate attention 1904 directed to virtual object 1910 at all times, upon detecting the start of the input directed to virtual object 1910 (e.g., the moment hand 1902 performs the air pinch), attention 1904 optionally does not need to remain directed to virtual object 1910 for any of the subsequent transformations to be applied while hand 1902 maintains the air pinch. In some embodiments, the transformations illustrated in FIGS. 19B-19J share one or more characteristics with one or more transformations described with respect to methods 900, 1000, 1100, 1600, 1800, and/or 2000.

FIG. 19B illustrates an example of computer system 101 translating virtual object 1910 in accordance with a translation movement of hand 1902 from start location 1922 to current location 1924. In some embodiments, as illustrated in FIG. 19B, computer system 101 translates virtual object 1910 in a +X direction (e.g., to the right with respect to the viewpoint of the user) based on detecting translation movement of hand 1902 in a +X direction (e.g., the direction from start location 1922 to current location 1924). In some embodiments, as illustrated in FIG. 19B, computer system 101 translates virtual object 1910 by an amount proportional to a magnitude of the displacement between start location 1922 and current location 1924. In some embodiments, computer system 101 translates virtual object 1910 based on translation movement of hand 1902 in accordance with a determination that translation movement in the +X direction is not suppressed.

FIG. 19C illustrates an example of computer system 101 rotating virtual object 1910 in accordance with a rotation movement of hand 1902 from start location 1922 to current location 1924. In some embodiments, as illustrated in FIG. 19C, computer system 101 rotates virtual object 1910 about the Z-axis in a +Z direction based on detecting rotation movement of hand 1902 about the Z-axis in a +Z direction (e.g., the clockwise direction about the Z-axis from start location 1922 to current location 1924). In some embodiments, as illustrated in FIG. 19C, computer system 101 rotates virtual object 1910 by an amount proportional to a magnitude of the angle between start location 1922 and current location 1924.

FIG. 19D illustrates an example of computer system 101 rotating virtual object 1910 in accordance with a translation movement of hand 1902 from start location 1922 to current location 1924. As illustrated in FIG. 19D, computer system 101 optionally includes a setting 1930 that dictates that translation in the +X direction be converted to rotation about the +Y-axis. In some embodiments, as illustrated in FIG. 19D, in accordance with setting 1930 that converts translation in the +X direction to rotation about the +Y-axis, computer system 101 rotates virtual object 1910 in a clockwise direction about the Y-axis based on detecting translation movement of hand 1902 in a +X direction (e.g., the direction from start location 1922 to current location 1924). In some embodiments, as illustrated in FIG. 19D, computer system 101 rotates virtual object 1910 by an amount (e.g., 90 degrees) proportional to a magnitude of the displacement between start location 1922 and current location 1924 (e.g., a normalized 0.5 unit on a 0-1 scale). In some embodiments, setting 1930 is selectable by a user and/or is set by the application associated with virtual object 1910 as discussed with respect to method 2000.

FIG. 19E illustrates an example of computer system 101 rotating virtual object 1910 in accordance with a translation movement of hand 1902 from start location 1922 to current location 1924. As illustrated in FIG. 19E, computer system 101 optionally includes setting 1930 that converts translation in the +X direction to rotation about the +Y-axis. In some embodiments, as illustrated in FIG. 19E, in accordance with setting 1930 that converts translation in the +X direction to rotation about the +Y-axis, computer system 101 rotates virtual object 1910 in a clockwise direction about the Y-axis in response to detecting translation movement of hand 1902 in a +X direction (e.g., the direction from start location 1922 to current location 1924). In some embodiments, as illustrated in FIG. 19E, computer system 101 rotates virtual object 1910 by an amount (e.g., 180 degrees) proportional to a magnitude of the displacement between start location 1922 and current location 1924 (e.g., a normalized 1 unit on a 0-1 scale).

FIG. 19F illustrates an example of computer system 101 rotating virtual object 1910 in accordance with a translation movement of hand 1902 from start location 1922 to current location 1924. As illustrated in FIG. 19F, computer system 101 optionally includes a setting 1930 that dictates that translation in the +X direction be converted to rotation about the +Y-axis. In some embodiments, as illustrated in FIG. 19F, in accordance with setting 1930 dictating that translation in the +X direction be converted to rotation about the +Y-axis, computer system 101 rotates virtual object 1910 in a counterclockwise direction about the Y-axis based on detecting translation movement of hand 1902 in a-X direction (e.g., the direction from start location 1922 to current location 1924). In some embodiments, as illustrated in FIG. 19F, computer system 101 rotates virtual object 1910 by an amount (e.g., 90 degrees) proportional to a magnitude of the displacement between start location 1922 and current location 1924 (e.g., a normalized 0.5 unit on a 0-1 scale).

FIG. 19G illustrates an example of computer system 101 rotating virtual object 1910 in accordance with a translation movement of hand 1902 from start location 1922 to current location 1924. As illustrated in FIG. 19G, computer system 101 optionally includes a setting 1930 that converts translation in the +X direction to rotation about the +Z-axis. In some embodiments, as illustrated in FIG. 19G, in accordance with setting 1930 converting translation in the +X direction to rotation about the +Z-axis, computer system 101 rotates virtual object 1910 in a clockwise direction about the Z-axis based on detecting translation movement of hand 1902 in a +X direction (e.g., the direction from start location 1922 to current location 1924). In some embodiments, as illustrated in FIG. 19G, computer system 101 rotates virtual object 1910 by an amount (e.g., 120 degrees) proportional to a magnitude of the displacement between start location 1922 and current location 1924 (e.g., a normalized 0.5 unit on a 0-1 scale). In some embodiments, the amount of rotation based on the magnitude of the displacement between locations 1922 and 1924 is different depending on the direction of the displacement and/or setting 1930. For example, when the displacement between locations 1922 and 1924 is 0.5 units, for a +X translation direction converted to a +Y rotation direction, the amount of rotation is optionally 90 degrees (as illustrated in FIG. 19D), and for a +X translation direction converted to a +Z rotation direction, the amount of rotation is optionally 120 degrees (e.g., as illustrated in FIG. 19G). In some embodiments, the amount of rotation based on the magnitude of the displacement between locations 1922 and 1924 is the same regardless of the direction of the displacement.

FIG. 19H illustrates an example of computer system 101 rotating virtual object 1910 in accordance with a translation movement of hand 1902 from start location 1922 to current location 1924. As illustrated in FIG. 19H, computer system 101 optionally includes a setting 1930 that converts translation in the +Y direction to rotation about the −X-axis (e.g., counterclockwise). In some embodiments, as illustrated in FIG. 19H, in accordance with setting 1930 dictating that translation in the +Y direction be converted to rotation about the −X-axis, computer system 101 rotates virtual object 1910 in a counterclockwise direction about the X-axis based on detecting translation movement of hand 1902 in a +Y direction (e.g., the direction from start location 1922 to current location 1924). In some embodiments, as illustrated in FIG. 19H, computer system 101 rotates virtual object 1910 by an amount (e.g., 90 degrees) proportional to a magnitude of the displacement between start location 1922 and current location 1924 (e.g., a normalized 0.5 unit on a 0-1 scale).

FIGS. 19I-19J illustrates an example of computer system 101 rotating virtual object 1910 in different directions in accordance with translation movements of hand 1902 in different directions (e.g., from start location 1922 to intermediate location 1923, and from intermediate location 1923 to current location 1924). As illustrated in FIGS. 19I-19J, computer system 101 optionally includes a setting 1930a that converts translation in the +X direction to rotation about the +Y-axis and a setting 1930b that converts translation in the +Y direction to rotation about the −X-axis. In some embodiments, as illustrated in FIG. 19I, in accordance with setting 1930a dictating that translation in the +X direction be converted to rotation about the +Y-axis, computer system 101 rotates virtual object 1910 in a clockwise direction about the Y-axis based on detecting translation movement of hand 1902 in a +X direction (e.g., the direction from start location 1922 to intermediate location 1923). In some embodiments, as illustrated in FIG. 19I, computer system 101 rotates virtual object 1910 by an amount (e.g., 90 degrees) proportional to a magnitude of the displacement between start location 1922 and intermediate location 1923 (e.g., a normalized 0.5 unit on a 0-1 scale). In some embodiments, as illustrated in FIG. 19J, in accordance with setting 1930b dictating that translation in the +Y direction be converted to rotation about the −X-axis, computer system 101 rotates virtual object 1910 in a counterclockwise direction about the X-axis based on detecting translation movement of hand 1902 in a Y direction (e.g., the direction from intermediate location 1923 to current location 1924). In some embodiments, as illustrated in FIG. 19J, computer system 101 rotates virtual object 1910 by an amount (e.g., 90 degrees) proportional to a magnitude of the displacement between intermediate location 1923 and current location 1924 (e.g., a normalized 0.5 unit on a 0-1 scale).

In some embodiments, as illustrated in FIG. 19K, in response to detecting an input directed to virtual object 1910 (e.g., an object control or pick-up gesture, such as hands 1902 and 1903 performing an air pinch while attention 1904 is directed to virtual object 1910), computer system 101 associates hands 1902 and 1903 with virtual object 1910 such that subsequent spatial updates of virtual object 1910 are tied to the motion of hands 1902 and 1903 (e.g., control of the virtual object is controlled by both hands concurrently rather than one hand as discussed in the examples of FIGS. 19B-19J). As illustrated in FIG. 19K, hands 1902 and 1903 form an axis 1925 (not displayed via display generation component 120). In some embodiment, the movement of the hands is determined based on a midpoint of hands 1902 and 1903 along axis 1925 at a start location 1922. FIG. 19K also illustrates spatial coordinates 1920 that illustrate start location 1922 of the midpoint between hand 1902 and hand 1903. In subsequent figures FIGS. 19L-19AE, and 19AH-19AJ, movement of hands 1902 and 1903 is tracked by spatial coordinates 1920 via the midpoint between hands 1902 and 1903, whose location is compared to start location 1922.

FIGS. 19L-19AN illustrate examples of computer system 101 applying transformations on virtual object 1910 based on movement of hands 1902 and 1903 (and/or movement of the midpoint between hands 1902 and 1903), in accordance with some embodiments. Although FIGS. 19L-19AN illustrate attention 1904 directed to virtual object 1910 at all times, upon detecting the start of the input directed to virtual object 1910 (e.g., the moment hands 1902 and/or 1903 perform the air pinch), attention 1904 optionally does not need to remain directed to virtual object 1910 for any of the subsequent transformations to be applied while hands 1902 and 1903 maintain the air pinch. In some embodiments, the transformations illustrated in FIGS. 19L-19AN share one or more characteristics with one or more transformations described with respect to methods 900, 1000, 1100, 1600, 1800, and/or 2000.

FIG. 19L illustrates an example of computer system 101 translating virtual object 1910 in accordance with a translation movement of the midpoint of hands 1902 and 1903 from start location 1922 to current location 1924. In some embodiments, as illustrated in FIG. 19L, computer system 101 translates virtual object 1910 in a +X direction based on detecting translation movement of the midpoint of hands 1902 and 1903 in a +X direction (e.g., the direction from start location 1922 to current location 1924). In some embodiments, as illustrated in FIG. 19L, computer system 101 translates virtual object 1910 by an amount proportional to a magnitude of the displacement between start location 1922 and current location 1924. In some embodiments, computer system 101 translates virtual object 1910 based on translation movement of the midpoint of hands 1902 and 1903 in accordance with a determination that translation movement in the +X direction is not suppressed.

FIG. 19M illustrates an example of computer system 101 rotating virtual object 1910 in accordance with a translation movement of the midpoint of hands 1902 and 1903 from start location 1922 to current location 1924. As illustrated in FIG. 19M, computer system 101 optionally includes a setting 1930 that dictates that translation in the +X direction be converted to rotation about the +Y-axis. In some embodiments, as illustrated in FIG. 19M, in accordance with setting 1930 that converts translation in the +X direction to rotation about the +Y-axis, computer system 101 rotates virtual object 1910 in a clockwise direction about the Y-axis based on detecting translation movement of the midpoint of hands 1902 and 1903 in a +X direction (e.g., the direction from start location 1922 to current location 1924). In some embodiments, as illustrated in FIG. 19M, computer system 101 rotates virtual object 1910 by an amount (e.g., 90 degrees) proportional to a magnitude of the displacement between start location 1922 and current location 1924 (e.g., a normalized 0.5 unit on a 0-1 scale).

FIG. 19N illustrates an example of computer system 101 rotating virtual object 1910 in accordance with a translation movement of the midpoint of hands 1902 and 1903 from start location 1922 to current location 1924. As illustrated in FIG. 19N, computer system 101 optionally includes setting 1930 that converts translation in the +X direction to rotation about the +Y-axis. In some embodiments, as illustrated in FIG. 19N, in accordance with setting 1930 converting translation in the +X direction to rotation about the +Y-axis, computer system 101 rotates virtual object 1910 in a clockwise direction about the Y-axis based on detecting translation movement of the midpoint of hands 1902 and 1903 in a +X direction (e.g., the direction from start location 1922 to current location 1924). In some embodiments, as illustrated in FIG. 19N, computer system 101 rotates virtual object 1910 by an amount (e.g., 180 degrees) proportional to a magnitude of the displacement between start location 1922 and current location 1924 (e.g., a normalized 1 unit on a 0-1 scale).

FIG. 19O illustrates an example of computer system 101 rotating virtual object 1910 in accordance with a translation movement of the midpoint of hands 1902 and 1903 from start location 1922 to current location 1924. As illustrated in FIG. 19O, computer system 101 optionally includes a setting 1930 that dictates that translation in the +X direction be converted to rotation about the +Y-axis. In some embodiments, as illustrated in FIG. 19O, in accordance with setting 1930 that converts translation in the +X direction to rotation about the +Y-axis, computer system 101 rotates virtual object 1910 in a counterclockwise direction about the Y-axis based on detecting translation movement of the midpoint of hands 1902 and 1903 in a-X direction (e.g., the direction from start location 1922 to current location 1924). In some embodiments, as illustrated in FIG. 19O, computer system 101 rotates virtual object 1910 by an amount (e.g., 90 degrees) proportional to a magnitude of the displacement between start location 1922 and current location 1924 (e.g., a normalized 0.5 unit on a 0-1 scale).

FIG. 19P illustrates an example of computer system 101 rotating virtual object 1910 in accordance with a translation movement of the midpoint of hands 1902 and 1903 from start location 1922 to current location 1924. As illustrated in FIG. 19P, computer system 101 optionally includes a setting 1930 that converts translation in the +X direction to rotation about the +Z-axis. In some embodiments, as illustrated in FIG. 19P, in accordance with setting 1930 converting translation in the +X direction to rotation about the +Z-axis, computer system 101 rotates virtual object 1910 in a clockwise direction about the Z-axis based on detecting translation movement of the midpoint of hands 1902 and 1903 in a +X direction (e.g., the direction from start location 1922 to current location 1924). In some embodiments, as illustrated in FIG. 19P, computer system 101 rotates virtual object 1910 by an amount (e.g., 120 degrees) proportional to a magnitude of the displacement between start location 1922 and current location 1924 (e.g., a normalized 0.5 unit on a 0-1 scale). In some embodiments, the amount of rotation based on the magnitude of the displacement between locations 1922 and 1924 is different depending on the direction of the displacement and/or setting 1930. For example, when the displacement between locations 1922 and 1924 is 0.5 units, for a +X translation direction converted to a +Y direction, the amount of rotation is optionally 90 degrees (as illustrated in FIG. 19M), and for a +X translation direction converted to a +Z rotation direction, the amount of rotation is optionally 120 degrees (as illustrated in FIG. 19O). In some embodiments, the amount of rotation based on the magnitude of the displacement between locations 1922 and 1924 is the same regardless of the direction of the displacement.

FIG. 19Q illustrates an example of computer system 101 rotating virtual object 1910 in accordance with a translation movement of the midpoint of hands 1902 and 1903 from start location 1922 to current location 1924. As illustrated in FIG. 19Q, computer system 101 optionally includes a setting 1930 that dictates that translation in the +Y direction be converted to rotation about the −X-axis. In some embodiments, as illustrated in FIG. 19Q, in accordance with setting 1930 dictating that translation in the +Y direction be converted to rotation about the −X-axis, computer system 101 rotates virtual object 1910 in a counterclockwise direction about the X-axis based on detecting translation movement of the midpoint of hands 1902 and 1903 in a +Y direction (e.g., the direction from start location 1922 to current location 1924). In some embodiments, as illustrated in FIG. 19Q, computer system 101 rotates virtual object 1910 by an amount (e.g., 90 degrees) proportional to a magnitude of the displacement between start location 1922 and current location 1924 (e.g., a normalized 0.5 unit on a 0-1 scale).

FIGS. 19R-19T illustrates an example of computer system 101 applying different transformations to virtual object 1910 in accordance with translation movements of the midpoint of hands 1902 and 1903 in different directions (e.g., from start location 1922 to intermediate location 1923 in FIG. 19R, from intermediate location 1923 to current location 1924 in FIG. 19S, and from start location 1922 to current location 1924 in FIG. 19T). As illustrated in FIGS. 19R-19T, computer system 101 optionally includes a setting 1930a that converts translation in the +X direction to rotation about the +Y-axis and a setting 1930b that converts translation in the +Y direction to rotation about the −X-axis.

In some embodiments, as illustrated in FIG. 19R, in accordance with setting 1930a that converts translation in the +X direction to rotation about the +Y-axis, computer system 101 rotates virtual object 1910 in a clockwise direction about the Y-axis based on detecting translation movement of the midpoint of hands 1902 and 1903 in a +X direction (e.g., the direction from start location 1922 to intermediate location 1923). In some embodiments, as illustrated in FIG. 19R, computer system 101 rotates virtual object 1910 by an amount (e.g., 90 degrees) proportional to a magnitude of the displacement between start location 1922 and intermediate location 1923 (e.g., a normalized 0.5 unit on a 0-1 scale).

In some embodiments, as illustrated in FIG. 19S, in accordance with setting 1930b that converts translation in the +Y direction to rotation about the −X-axis, computer system 101 rotates virtual object 1910 in a counterclockwise direction about the X-axis based on detecting translation movement of the midpoint of hands 1902 and 1903 in a +Y direction (e.g., the direction from intermediate location 1923 to current location 1924). In some embodiments, as illustrated in FIG. 19S, computer system 101 rotates virtual object 1910 by an amount (e.g., 90 degrees) proportional to a magnitude of the displacement between intermediate location 1923 and current location 1924 (e.g., a normalized 0.5 unit on a 0-1 scale).

In some embodiments, as illustrated in FIG. 19T, computer system 101 translates virtual object 1910 in a +Z direction based on detecting translation movement of the midpoint of hands 1902 and 1903 in a +Z direction (e.g., the direction from start location 1922 to current location 1924). In some embodiments, as illustrated in FIG. 19T, computer system 101 translates virtual object 1910 by an amount proportional to a magnitude of the displacement between start location 1922 and current location 1924. In some embodiments, computer system 101 translates virtual object 1910 based on translation movement of the midpoint of hands 1902 and 1903 in accordance with a determination that translation movement in the +Z direction is not suppressed. For example, while settings 1930a and 1930b indicate that translation is suppressed in the X and Y directions, they do not specify that translation be suppressed in the Z direction.

FIGS. 19U-19X illustrate examples of computer system 101 rotating virtual object 1910 in accordance with rotation movements of hands 1902 and 1903, in accordance with some embodiments. FIGS. 19U-19X also illustrate spatial coordinates that illustrate start locations 1922a and 1922b and current locations 1924a and 1924b of hand 1902 and hand 1903 respectively with respect to an X-Y plane 1920a, an X-Z plane 1920b, and a Z-Y plane 1920c. In some embodiments, the rotations illustrated in FIGS. 19U-19X share one or more characteristics with one or more rotations described with respect to methods 900, 1000, 1100, 1600, 1800, and/or 2000.

FIG. 19U illustrates an example of computer system 101 rotating virtual object 1910 in accordance with a rotation movement of hands 1902 and 1903 in X-Y plane 1920a from start locations 1922a and 1922b to current locations 1924a and 1924b. In some embodiments, as illustrated in FIG. 19U, computer system 101 rotates virtual object 1910 in a +Z direction based on detecting rotation movement of hands 1902 and 1903 in a +Z direction (e.g., the clockwise direction about the Z-axis in X-Y plane 1920a from start locations 1922a and 1922b to current locations 1924a and 1924b). In some embodiments, as illustrated in FIG. 19U, computer system 101 rotates virtual object 1910 by an amount proportional to a magnitude of the angle between start locations 1922a and 1922b and current locations 1924a and 1924b (e.g., compared to the X- and/or Y-axis). Thus, computer system 101 optionally rotates virtual object 1910 in the same direction as and by an amount proportional to the rotation of axis 1925 about the Z-axis in X-Y plane 1920a.

FIG. 19V illustrates an example of computer system 101 rotating virtual object 1910 in accordance with a rotation movement of hands 1902 and 1903 in X-Y plane 1920a from start locations 1922a and 1922b to current locations 1924a and 1924b. In some embodiments, as illustrated in FIG. 19U, computer system 101 rotates virtual object 1910 in a −Z direction based on detecting rotation movement of hands 1902 and 1903 in a −Z direction (e.g., the counterclockwise direction about the Z-axis in X-Y plane 1920a from start locations 1922a and 1922b to current locations 1924a and 1924b). In some embodiments, as illustrated in FIG. 19V, computer system 101 rotates virtual object 1910 by an amount proportional to a magnitude of the angle between start locations 1922a and 1922b and current locations 1924a and 1924b (e.g., compared to the X- and/or Y-axis). Thus, computer system 101 optionally rotates virtual object 1910 in the same direction as and by an amount proportional to the rotation of axis 1925 about the Z-axis in X-Y plane 1920a.

FIGS. 19W-19X illustrate an example of computer system 101 rotating virtual object 1910 in accordance with a rotation movement of hands 1902 and 1903 in the X-Z plane 1920b from start locations 1922a and 1922b to intermediate locations 1923a and 1923b and a rotation movement of hands 1902 and 1903 in Z-Y plane 1920c from intermediate locations 1923a and 1923b to current locations 1924a and 1924b. In some embodiments, as illustrated in FIG. 19W, computer system 101 rotates virtual object 1910 in a −Y direction based on detecting rotation movement of hands 1902 and 1903 in a −Y direction (e.g., the counterclockwise direction about the Y-axis in X-Z plane 1920b from start locations 1922a and 1922b to intermediate locations 1923a and 1923b). In some embodiments, as illustrated in FIG. 19W, computer system 101 rotates virtual object 1910 by an amount proportional to a magnitude of the angle between start locations 1922a and 1922b and intermediate locations 1923a and 1923b (e.g., compared to the X- and/or Z-axis). Thus, computer system 101 optionally rotates virtual object 1910 in the same direction as and by an amount proportional to the rotation of axis 1925 about the Y-axis in X-Z plane 1920b. In some embodiments, as illustrated in FIG. 19X, computer system 101 rotates virtual object 1910 in a −X direction based on detecting rotation movement of hands 1902 and 1903 in a −X direction (e.g., the counterclockwise direction about the X-axis in Z-Y plane 1920c from intermediate locations 1923a and 1923b to current locations 1924a and 1924b). In some embodiments, as illustrated in FIG. 19X, computer system 101 rotates virtual object 1910 by an amount proportional to a magnitude of the angle between intermediate locations 1923a and 1923b and current locations 1924a and 1924b (e.g., compared to the Z- and/or Y-axis). Thus, computer system 101 optionally rotates virtual object 1910 in the same direction as and by an amount proportional to the rotation of axis 1925 about the X-axis in Z-Y plane 1920c.

FIGS. 19Y-19Z illustrate examples of computer system 101 scaling virtual object 1910 in accordance with separation movements of hands 1902 and 1903 along the X-axis (e.g., axis 1925), in accordance with some embodiments. FIGS. 19Y-19Z also illustrate spatial coordinates that illustrate start locations 1922a and 1922b and current locations 1924a and 1924b of hand 1902 and hand 1903 with respect to X-Y plane 1920a. In some embodiments, the scaling transformations illustrated in FIGS. 19Y-19Z share one or more characteristics with one or more scaling transformations described with respect to methods 900, 1000, 1100, 1600, 1800, and/or 2000.

FIG. 19Y illustrates an example of computer system 101 scaling virtual object 1910 in accordance with a separation movement of hands 1902 and 1903 in the X-axis (e.g., axis 1925) from start locations 1922a and 1922b to current locations 1924a and 1924b. In some embodiments, as illustrated in FIG. 19Y, computer system 101 increases the size of virtual object 1910 based on detecting the separation movement of hands 1902 and 1903 corresponding to an increase in the distance between hands 1902 and 1903 (e.g., the distance between start locations 1922a and 1922b is less than the distance between current locations 1924a and 1924b). In some embodiments, as illustrated in FIG. 19Y, computer system 101 scales virtual object 1910 by an amount proportional to the difference in the distances between start locations 1922a and 1922b and current locations 1924a and 1924b.

FIG. 19Z illustrates an example of computer system 101 scaling virtual object 1910 in accordance with a separation movement of hands 1902 and 1903 in the X-axis (e.g., axis 1925) from start locations 1922a and 1922b to current locations 1924a and 1924b. In some embodiments, as illustrated in FIG. 19Z, computer system 101 decreases the size of virtual object 1910 based on detecting the separation movement of hands 1902 and 1903 corresponding to a decrease in the distance between hands 1902 and 1903 (e.g., the distance between start locations 1922a and 1922b is greater than the distance between current locations 1924a and 1924b). In some embodiments, as illustrated in FIG. 19Z, computer system 101 scales virtual object 1910 by an amount proportional to the difference in the distances between start locations 1922a and 1922b and current locations 1924a and 1924b.

FIGS. 19AA-19AE illustrate examples of computer system 101 applying one transformation or concurrently applying two transformations in accordance with the degrees of prominence of two movements of hands 1902 and 1903 corresponding to two types of manipulations, in accordance with some embodiments. FIGS. 19AA-19AE also illustrate a graph 1940a that plots a separation component versus a translation component that computer system 101 optionally detects in the movement of hands 1902 and 1903, a graph 1940b that plots the amount of rotation that computer system 101 optionally applies to virtual object 1910 in accordance with the translation component of the movement of hands 1902 and 1903, and a graph 1940c that plots the amount of scaling that computer system 101 optionally applies to virtual object 1910 in accordance with the separation component of the movement of hands 1902 and 1903.

Graph 1940a illustrates a prominence threshold 1942a that optionally governs whether computer system 101 applies a scaling transformation to virtual object 1910 based on a magnitude of separation in the movement of hands 1902 and 1903 and a prominence threshold 1942b that optionally governs whether computer system 101 applies a rotation transformation to virtual object 1910 based on a magnitude of translation in the movement of hands 1902 and 1903. In some embodiments, as illustrated in FIGS. 19AA-19AE, prominence thresholds 1942a-1942b are variable and change with the magnitude of translation and/or the magnitude of separation, respectively, detected in the movement of hands 1902 and 1903. In some embodiments, prominence thresholds 1942a-1942b are not variable, as described in greater detail with respect to method 2000.

Graph 1940a also illustrates a prominence threshold 1944a that governs whether computer system 101 suppresses (e.g., dampens) a scaling transformation on virtual object 1910 based on the magnitude of separation in the movement of hands 1902 and 1903 and a prominence threshold 1944b that governs whether computer system 101 suppresses (e.g., dampens) a rotation transformation on virtual object 1910 based on the magnitude of translation in the movement of hands 1902 and 1903. In some embodiments, suppressing refers to computer system 101 reducing, limiting, and/or omitting the amount of scaling, rotating, translating, or other transformation applied to virtual object 1910 when the corresponding movement does not exceed a respective threshold, as described in greater detail with respect to method 2000. In some embodiments, as illustrated in FIGS. 19AA-19AE, prominence thresholds 1944a-1944b are variable and change with the magnitude of translation and/or the magnitude of separation, respectively, detected in the movement of hands 1902 and 1903. In some embodiments, prominence thresholds 1944a-1944b are not variable, as described in greater detail with respect to method 2000. In some embodiments, when the magnitudes of separation and translation detected in the movement of hands 1902 and 1903 are such that a point 1946a, corresponding to the combined magnitude of the movement of hands 1902 and 1903, lies between prominence thresholds 1944a-1944b in unsuppressed transformation area 1948a, computer system 101 does not suppress (e.g., dampen) the respective scaling and rotation transformations.

Graph 1940b illustrates curve 1948b that optionally corresponds to the baseline relationship between the amount of rotation computer system 101 applies to virtual object 1910 and the magnitude of the translation movement when the rotation transformation is not suppressed (e.g., point 1946a lies to the right of prominence threshold 1944b). In some embodiments, the baseline relationship between the amount of rotation computer system 101 applies to virtual object 1910 and the magnitude of the translation movement when the rotation transformation is not suppressed is linear or non-linear, as described in greater detail with respect to method 2000. Graph 1940b also illustrates a point 1946b that corresponds an amount of rotation computer system 101 applies to virtual object 1910 with respect to a magnitude of the detected translation component in the movement of hands 1902 and 1903. In some embodiments, when point 1946b lies below curve 1948b, computer system 101 is applying a suppressed (e.g., dampened) rotation transformation to virtual object 1910.

Graph 1940c illustrates curve 1948c that optionally corresponds to the baseline relationship between the amount of scaling computer system 101 applies to virtual object 1910 and the magnitude of the separation movement when the scaling transformation is not suppressed (e.g., point 1946a lies above prominence threshold 1944a). In some embodiments, the baseline relationship between the amount of scaling computer system 101 applies to virtual object 1910 and the magnitude of the separation movement when the scaling transformation is not suppressed is linear or non-linear, as described in greater detail with respect to method 2000. Graph 1940c also illustrates a point 1946c that corresponds an amount of scaling computer system 101 applies to virtual object 1910 with respect to a magnitude of the detected separation component in the movement of hands 1902 and 1903. In some embodiments, when point 1946c lies below curve 1948c, computer system 101 is applying a suppressed (e.g., dampened) scaling transformation to virtual object 1910.

FIG. 19AA illustrates an example of computer system 101 rotating virtual object 1910 in accordance with a translation magnitude of the movement of midpoint of hands 1902 and 1903 from start location 1922 to current location 1924 and forgoing scaling virtual object 1910 in accordance with a separation magnitude of the movement of hands 1902 and 1903 in the X-axis (e.g., axis 1925) from start locations 1922a and 1922b to current locations 1924a and 1924b lying below prominence threshold 1942a. As illustrated in FIG. 19AA, given that point 1946a lies below prominence threshold 1944b (e.g., the translation component of the movement of hands 1902 and 1903 has a prominence greater than prominence threshold 1944b), computer system 101 rotates virtual object 1910 by an amount that is proportional (e.g., by the baseline relationship defined by curve 1948b) to the magnitude of the displacement between start location 1922 and current location 1924, as shown by point 1946b lying on curve 1948b. As illustrated in FIG. 19AA, given that point 1946a lies below prominence threshold 1942a (e.g., the separation component of the movement of hands 1902 and 1903 has a prominence less than prominence threshold 1942a), computer system 101 forgoes scaling virtual object 1910, as shown by point 1946c having a scaling component equal to zero.

FIG. 19AB illustrates an example of computer system 101 rotating virtual object 1910 in accordance with a translation magnitude of the movement of midpoint of hands 1902 and 1903 from start location 1922 to current location 1924 and scaling virtual object 1910 with a suppressed (e.g., dampened) scaling transformation in accordance with a separation magnitude of the movement of hands 1902 and 1903 in the X-axis (e.g., axis 1925) from start locations 1922a and 1922b to current locations 1924a and 1924b lying below prominence threshold 1944a, but above prominence threshold 1942a. As illustrated in FIG. 19AB, given that point 1946a is below prominence threshold 1944b (e.g., the translation component of the movement of hands 1902 and 1903 has a prominence greater than prominence threshold 1944b), computer system 101 rotates virtual object 1910 by an amount that is proportional (e.g., by the baseline relationship defined by curve 1948b) to the magnitude of the displacement between start location 1922 and current location 1924, as shown by point 1946b lying on curve 1948b. As illustrated in FIG. 19AB, given that point 1946a lies above prominence threshold 1942a, but below prominence threshold 1944a (e.g., the separation component of the movement of hands 1902 and 1903 has a prominence greater than prominence threshold 1942a, but less than prominence threshold 1944a), computer system 101 scales virtual object 1910 with a suppressed (e.g., dampened) scaling transformation, as shown by point 1946c lying below curve 1948c.

FIG. 19AC illustrates an example of computer system 101 rotating virtual object 1910 in accordance with a translation magnitude of the movement of midpoint of hands 1902 and 1903 from start location 1922 to current location 1924 and scaling virtual object 1910 in accordance with a separation magnitude of the movement of hands 1902 and 1903 in the X-axis (e.g., axis 1925) from start locations 1922a and 1922b to current locations 1924a and 1924b. As illustrated in FIG. 19AC, given that point 1946a lies below prominence threshold 1944b (e.g., the translation component of the movement of hands 1902 and 1903 has a prominence greater than prominence threshold 1944b), computer system 101 rotates virtual object 1910 by an amount that is proportional (e.g., by the baseline relationship defined by curve 1948b) to the magnitude of the displacement between start location 1922 and current location 1924, as shown by point 1946b lying on curve 1948b. As illustrated in FIG. 19AC, given that point 1946a lies above prominence threshold 1944a (e.g., the separation component of the movement of hands 1902 and 1903 has a prominence greater than prominence threshold 1944a), computer system 101 scales virtual object 1910 by an amount that is proportional (e.g., by the baseline relationship defined by curve 1948c) to the magnitude of the displacements between start locations 1922a and 1922b and current locations 1924a and 1924b, respectively, as shown by point 1946c lying on curve 1948c.

FIG. 19AD illustrates an example of computer system 101 rotating virtual object 1910 with a suppressed (e.g., dampened) rotation transformation in accordance with a translation magnitude of the movement of midpoint of hands 1902 and 1903 from start location 1922 to current location 1924 lying to the right of prominence threshold 1942b, but to the left of prominence threshold 1944b, and scaling virtual object 1910 in accordance with a separation magnitude of the movement of hands 1902 and 1903 in the X-axis (e.g., axis 1925) from start locations 1922a and 1922b to current locations 1924a and 1924b. As illustrated in FIG. 19AD, given that point 1946a lies below prominence threshold 1942b, but above prominence threshold 1944b (e.g., the translation component of the movement of hands 1902 and 1903 has a prominence greater than prominence threshold 1942b, but less than prominence threshold 1944b), computer system 101 rotates virtual object 1910 with a suppressed (e.g., dampened) rotation transformation, as shown by point 1946b lying below curve 1948b. As illustrated in FIG. 19AD, given that point 1946a lies above prominence threshold 1944a (e.g., the separation component of the movement of hands 1902 and 1903 has a prominence greater than prominence threshold 1944a), computer system 101 scales virtual object 1910 by an amount that is proportional (e.g., by the baseline relationship defined by curve 1948c) to the magnitude of the displacements between start locations 1922a and 1922b and current locations 1924a and 1924b, respectively, as shown by point 1946c lying on curve 1948c.

FIG. 19AE illustrates an example of computer system 101 forgoing rotating virtual object 1910 in accordance with a translation magnitude of the movement of midpoint of hands 1902 and 1903 from start location 1922 to current location 1924 lying below prominence threshold 1944b, and scaling virtual object 1910 in accordance with a separation magnitude of the movement of hands 1902 and 1903 in the X-axis (e.g., axis 1925) from start locations 1922a and 1922b to current locations 1924a and 1924b. As illustrated in FIG. 19AE, given that point 1946a lies above prominence threshold 1944b (e.g., the translation component of the movement of hands 1902 and 1903 has a prominence less than prominence threshold 1944b), computer system 101 forgoes rotating virtual object 1910, as shown by point 1946b having a rotation component equal to zero. As illustrated in FIG. 19AD, given that point 1946a lies above prominence threshold 1944a (e.g., the separation component of the movement of hands 1902 and 1903 has a prominence greater than prominence threshold 1944a), computer system 101 scales virtual object 1910 by an amount that is proportional (e.g., by the baseline relationship defined by curve 1948c) to the magnitude of the displacements between start locations 1922a and 1922b and current locations 1924a and 1924b, respectively, as shown by point 1946c lying on curve 1948c.

FIGS. 19AF-19AG illustrate examples of computer system 101 applying a transformation to virtual object 1910 relative to axis 1925 or to a reference axis associated with computer system 101 based on whether axis 1925 is within a threshold angle of the reference axis associated with computer system 101, in accordance with some embodiments. FIGS. 19AF-19AG illustrate examples of computer system 101 rotating virtual object 1910 in accordance with a rotation movement of hands 1902 and 1903 in three-dimensions (e.g., X-Y-Z coordinates) from start locations 1922a and 1922b to current locations 1924a and 1924b. FIGS. 19AF-19AG also illustrate reference X-, Y-, and Z-axes that are based on an orientation of computer system 101 and threshold angles 1926 that computer system 101 uses to determine whether to apply a rotation transformation to virtual object 1910 relative to the reference X-, Y-, and/or Z-axes or relative to X′-, Y′-, and/or Z′-axes with respect to an orientation of the movement of hands 1902 and 1903 (e.g., an orientation of axis 1925).

In some embodiments, as illustrated in FIG. 19AF, computer system 101 detects hands 1902 and 1903 rotating about an X′-axis within a Z′-Y′ plane (e.g., along the Y′-axis in X-Y plane 1920a) that is offset by an angle 1928 to the reference X-axis and the reference Z-Y plane 1920c, respectively. In some embodiments, in accordance with a determination that the movement that is associated with the Y′-axis is within threshold angle 1926, computer system 101 rotates virtual object 1910 in a-X direction based on detecting the rotation movement of hands 1902 and 1903 in the −X′ direction (e.g., the counterclockwise direction about the X′-axis from start locations 1922a and 1922b to 1924a and 1924b). In some embodiments, as illustrated in FIG. 19AF, computer system 101 rotates virtual object 1910 by an amount proportional to a magnitude of the angle between start locations 1922a and 1922b and current locations 1924a and 1924b. Thus, computer system 101 optionally rotates virtual object 1910 by an amount proportional to the rotation of axis 1925 about the X′-axis, but in a direction about the X-axis.

In some embodiments, as illustrated in FIG. 19AG, computer system 101 detects hands 1902 and 1903 rotating about an X′-axis within a Z′-Y′ plane (e.g., along the Y′-axis in X-Y plane 1920a) that is offset by an angle 1928 to the reference X-axis and the reference Z-Y plane 1920c, respectively. In some embodiments, in accordance with a determination that the movement that is associated with the Y′-axis is outside threshold angle 1926, computer system 101 rotates virtual object 1910 in a-X′ direction based on detecting the rotation movement of hands 1902 and 1903 in the −X′ direction (e.g., the counterclockwise direction about the X′-axis from start locations 1922a and 1922b to 1924a and 1924b). In some embodiments, as illustrated in FIG. 19AG, computer system 101 rotates virtual object 1910 by an amount proportional to a magnitude of the angle between start locations 1922a and 1922b and current locations 1924a and 1924b. Thus, computer system 101 optionally rotates virtual object 1910 in the same direction as and by an amount proportional to the rotation of axis 1925 about the X′-axis.

FIGS. 19AH-19AJ illustrate examples of computer system 101 applying scaling transformations to virtual object 1910 based on whether the scaling transformation spatially conflicts with another object within three-dimensional environment 1900, in accordance with some embodiments. In some embodiments, the scaling transformations illustrated in FIGS. 19AH-19AJ share one or more characteristics with one or more scaling transformations described with respect to methods 900, 1000, 1100, 1600, 1800, and/or 2000. FIG. 19AH illustrates an example of computer system 101 displaying virtual object 1910 near a lamp 1901 while detecting hands 1902 and 1903 perform an air pinch gesture (e.g., maintain control of virtual object 1910) at start locations 1922a and 1922b within three-dimensional environment 1900.

FIG. 19AI illustrates an example of computer system 101 scaling virtual object 1910 in accordance with a separation movement of hands 1902 and 1903 in the X-axis (e.g., axis 1925) from start locations 1922a and 1922b to intermediate locations 1923a and 1923b. In some embodiments, as illustrated in FIG. 19AI, computer system 101 increases the size of virtual object 1910 based on detecting the separation movement of hands 1902 and 1903 corresponds to an increase in the distance between hands 1902 and 1903 (e.g., the distance between start locations 1922a and 1922b is less than the distance between intermediate locations 1923a and 1923b). In some embodiments, as illustrated in FIG. 19AI, computer system 101 scales virtual object 1910 by an amount that is proportional (e.g., by the baseline relationship defined by curve 1948c) to the magnitude of the displacements between start locations 1922a and 1922b and intermediate locations 1923a and 1923b, respectively, as shown by point 1946c lying on curve 1948c. As illustrated in FIG. 19AI, the scaling transformation applied on virtual object 1910 optionally causes a boundary of virtual object 1910 to be next to a boundary of lamp 1901 such that further scaling of virtual object 1910 would cause virtual object 1910 to intersect lamp 1901.

FIG. 19AJ illustrates an example of computer system 101 scaling virtual object 1910 with a suppressed (e.g., dampened) scaling transformation in accordance with a separation movement of hands 1902 and 1903 in the X-axis (e.g., axis 1925) from intermediate locations 1923a and 1923b to current locations 1924a and 1924b. In some embodiments, as illustrated in FIG. 19AJ, in accordance with a determination that virtual object 1910 has a spatial conflict with (e.g., intersects) virtual object 1901 within three-dimensional environment 1900, computer system 101 applies a suppressed (e.g., dampened) scaling transformation on virtual object 1910 based on detecting the separation movement of hands 1902 and 1903 corresponds to an increase in the distance between hands 1902 and 1903 (e.g., the distance between start locations 1922a and 1922b is less than the distance between intermediate locations 1923a and 1923b). In some embodiments, as illustrated in FIG. 19AI, the suppressed scaling transformation corresponds to a dampened scaling transformation, as shown by point 1946c lying below curve 1948c. In some embodiments, and as illustrated in FIG. 19AJ, when suppressed, computer system 101 scales virtual object 1910 in response to detecting the separation movement of hands 1902 and 1903, but the rate at which the virtual object 1910 is scaled is reduced when compared to the scaling that occurs when the scaling is not suppressed (e.g., the scaling defined by curve 1948c). In some embodiments, the suppressed scaling transformation corresponds to computer system 101 forgoing the scaling transformation altogether and maintaining the size of virtual object 1910 in FIG. 19AI despite the movement of hands 1902 and 1903.

FIGS. 19AK-19AN illustrate an example of computer system 101 applying a scaling transformation to virtual object 1910 based on whether virtual object 1910 intersects a virtual object 1912 by more than a threshold 1914, in accordance with some embodiments. In some embodiments, the scaling transformations illustrated in FIGS. 19AK-19AN share one or more characteristics with one or more scaling transformations described with respect to methods 900, 1000, 1100, 1600, 1800, and/or 2000. FIG. 19AK illustrates an example of computer system 101 displaying virtual object 1910 near a virtual object 1912 while detecting hands 1902 and 1903 perform an air pinch gesture (e.g., maintain control of virtual object 1910) at start locations 1922a and 1922b within three-dimensional environment 1900. FIG. 19AK also illustrates threshold 1914 that computer system 101 uses to determine whether to reduce a size of virtual object 1910 in response to detecting the termination of a scaling input.

FIG. 19AL illustrates an example of computer system 101 scaling virtual object 1910 in accordance with a separation movement of hands 1902 and 1903 in the X-axis (e.g., axis 1925) from start locations 1922a and 1922b to intermediate locations 1923a and 1923b. In some embodiments, as illustrated in FIG. 19AL, computer system 101 increases the size of virtual object 1910 based on detecting the separation movement of hands 1902 and 1903 corresponds to an increase in the distance between hands 1902 and 1903 (e.g., the distance between start locations 1922a and 1922b is less than the distance between intermediate locations 1923a and 1923b). In some embodiments, as illustrated in FIG. 19AL, computer system 101 scales virtual object 1910 by an amount proportional to the difference in the distances between start locations 1922a and 1922b and intermediate locations 1923a and 1923b, causing virtual object 1910 to begin overlapping (e.g., spatially conflict with) virtual object 1912.

FIG. 19AM illustrates an example of computer system 101 scaling virtual object 1910 in accordance with a separation movement of hands 1902 and 1903 in the X-axis (e.g., axis 1925) from intermediate locations 1923a and 1923b to current locations 1924a and 1924b. In some embodiments, as illustrated in FIG. 19AM, computer system 101 increases the size of virtual object 1910 based on detecting the separation movement of hands 1902 and 1903 corresponds to an increase in the distance between hands 1902 and 1903 (e.g., the distance between intermediate locations 1923a and 1923b is less than the distance between current locations 1924a and 1924b). In some embodiments, as illustrated in FIG. 19AM, computer system 101 scales virtual object 1910 by an amount proportional to the difference in the distances between intermediate locations 1923a and 1923b and current locations 1924a and 1924b, causing virtual object 1910 to overlap more of virtual object 1912, past threshold 1914.

In some embodiments, as illustrated between FIGS. 19AM and 19AN, in response to detecting the termination of the scaling input (e.g., hands 1902 and/or 1903 release the air pinch gesture), in accordance with a determination that virtual object 1910 intersects with virtual object 1912 by more than threshold 1914, computer system 101 reduces the size of virtual object 1910 such that virtual object 1910 at the reduced size intersects virtual object 1912 by threshold 1914. In some embodiments, if computer system 101 had detected termination of the scaling input (e.g., hands 1902 and/or 1903 release the air pinch gesture) when hands 1902 and 1903 were at intermediate locations 1923a and 1923b, in accordance with a determination that virtual object 1910 does not intersect virtual object 1912 by more than threshold 1914, computer system 101 would not reduce the size of virtual object 1910 (e.g., would maintain the size of virtual object 1910 as illustrated in FIG. 19AL).

FIG. 20 is a flowchart illustrating an exemplary method of applying transformations to a virtual object based on movement of one or more input elements, in accordance with some embodiments. In some embodiments, the method 2000 is performed at a computer system (e.g., computer system 101 in FIG. 1 such as a tablet, smartphone, wearable computer, or head mounted device) including a display generation component (e.g., display generation component 120 in FIGS. 1, 3A, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2000 are, optionally, combined and/or the order of some operations is, optionally, changed.

The devices, methods, and/or computer-readable storage media described below enhance the operability of the device and makes the user-device interface more efficient (e.g., by helping the user to provide proper inputs and reducing user mistakes when operating/interacting with the device) which, additionally, reduces power usage and/or improves battery life of the devices by enabling the user to use the device more quickly and efficiently. Reducing the number of inputs needed to perform an operation (such as by interpreting a two-handed translation in different directions to rotate the virtual object about corresponding axes—for example, translating both hands to the right to yaw the object or upward to pitch the object—rather than requiring separate rotation gestures) enhances the operability of the device by shortening interaction sequences (e.g., fewer inputs and/or time), thus reducing energy usage by the computer system. Performing an operation when a set of conditions has been met without requiring further user input (such as by automatically transitioning from one-handed to two-handed object manipulation upon detection of a selection input from the second hand) enhances the operability of the system by reducing unnecessary inputs and/or steps to navigate through different user interfaces or sets of control, thus reducing energy usage by the system. Providing additional control options (such as by selecting only the gesture component that is most prominent—for example, performing rotation but not translation when rotational input dominates, or damping the less-prominent component when both are present) without cluttering the user interface with extra controls enhances the operability of the device by reducing unnecessary inputs and/or steps to navigate through different user interfaces or sets of controls, thus reducing energy usage by the system.

In some embodiments, a method 2000 is performed at a computer system in communication with one or more display generation components and one or more input devices, such as computer system 101 in communication with display generation component 120 and input devices 114a-114c in FIGS. 19A-19AN. In some embodiments, the computer system shares one or more characteristics with the computer system(s) described with reference to methods 800, 900, 1000, 1100, 1200, 1300, 1600, and/or 1800. In some embodiments, the one or more display generation components share one or more characteristics with the display generation component(s) described with reference to methods 800, 900, 1000, 1100, 1200, 1300, 1600, and/or 1800. In some embodiments, the one or more input devices share one or more characteristics with the input device(s) described with reference to methods 800, 900, 1000, 1100, 1200, 1300, 1600, and/or 1800.

In some embodiments, while displaying, via the one or more display generation components, a first virtual object in a three-dimensional environment, the computer system detects (2002), via the one or more input devices, a first input directed to the first virtual object, wherein the first input includes concurrent input from a first input element and a second input element that is different from the first input element, such as computer system 101 detecting concurrent input from hands 1902 and 1903 in FIGS. 19K-19AN. In some embodiments, the first virtual object shares one or more characteristics with the virtual object(s) described with reference to methods 800, 900, 1000, 1100, 1200, 1300, 1600, and/or 1800. In some embodiments, the three-dimensional environment shares one or more characteristics with the three-dimensional environment(s) described with reference to methods 800, 900, 1000, 1100, 1200, 1300, 1600, and/or 1800. In some embodiments, the first input shares one or more characteristics with the input(s) described with reference to methods 800, 900, 1000, 1100, 1200, 1300, 1600, and/or 1800. In some embodiments, the first input element and/or the second input element share one or more characteristics with the input element(s) described with reference to methods 800, 900, 1000, 1100, 1200, 1300, 1600, and/or 1800. In some embodiments, the first input is a compound user interaction detected by the computer system that includes concurrent input from two or more input elements. In some embodiments, concurrent input means that input from the two or more input elements overlap in time by at least a threshold duration (e.g., 1 ms, 5 ms, 10 ms, 70 ms, 100 ms, 500 ms, 1 s, 2 s, or 5 s) such that the computer system interprets the overlapped input as a single input (e.g., the inputs from the first and second input elements are interpreted to perform one operation based on the concurrent input) rather than two independent inputs (e.g., a first input from the first input element is interpreted to perform one operation based on the first input, and the second input from the second input element is interpreted to perform a different operation based on the second input). In some embodiments, the computer system detects the first input when the first input element and the second input element share a concurrent state (e.g., share one or more input characteristics at the same time). For example, when the first and second input elements correspond to the hands of a user of the computer system (e.g., the right and left hands of the user), the computer system detects the first input when both hands are detected as performing a selection gesture, which is optionally the same gesture (e.g., an air pinch), and/or when both hands have the same pose (e.g., are both maintaining an air pinch hand shape), at the same time. As another example, when the first and second input elements correspond to two hand-held controllers, the computer system detects the first input when both controllers share an input state (e.g., one or more buttons being depressed on both input elements), at the same time. In some embodiments, the computer system detects the first input when the first and second input elements maintain the shared concurrent state for at least a minimum amount of time threshold (e.g., 10 ms, 30 ms, 50 ms, 100 ms, 250 ms, 500 ms, 1 s, 2 s, or 5 s). In some embodiments, the computer system does not detect the first input when the first and second input elements do not maintain the shared concurrent state for at least the minimum amount of time threshold.

In some embodiments, in response to detecting the first input (2004), in accordance with a determination that the first input includes translation movement (e.g., movement of the two input elements in a linear direction, where both of the input elements move in substantially the same direction, such as movement to the left, to the right, upward, downward, forward, and/or backward relative to a viewpoint of the user) of the first input element and the second input element corresponding to a translation input that has a first magnitude (e.g., hands 1902 and 1903 translating with a respective magnitude in FIG. 19M), the computer system rotates (2006) the first virtual object by a first amount in accordance with the translation movement of the first input element and the second input element, such as computer system 101 rotating virtual object 1910 by 90 degrees in accordance with the respective movement of hands 1902 and 1903 in FIG. 19M. In some embodiments, the translation movement shares one or more characteristics with one or more translation movement(s) of the input elements described with reference to methods 800, 900, 1000, 1100, 1200, 1300, 1600, and/or 1800. In some embodiments, the one or more first criteria include a requirement that the first input element and/or the second input element remain further than a threshold distance (e.g., 0.1, 0.3, 0.5, 1, 3, 5, 10, 25 or 50 meters) from the first virtual object throughout the duration of the first input (or when the computer system detected the start of the first input) in order for the one or more first criteria to be satisfied (e.g., the input must be an indirect input rather than a direct input). In some embodiments, the one or more first criteria include a requirement that attention (e.g., based on gaze) of the user be directed at the first virtual object when the computer system detects the start of the first input (or throughout the duration of the first input). In some embodiments, when the one or more first criteria are satisfied, the first input corresponds to a first hand and a second hand of a user of the computer system performing a gesture (e.g., both performing an air pinch-and-drag gesture) while attention of the user (e.g., based on gaze) is directed to the first virtual object (or when the attention of the user was directed to the first virtual object at the start of the first input). In some embodiments, when the one or more first criteria are satisfied, the first input corresponds to a first contact and a second contact on a touchpad (or a different touch-sensitive surface, such as a touchscreen) of the computer system moving (e.g., while a distance between the first and second contacts is relatively constant, as described in greater detail below) while the first virtual object is being controlled by the first and second contacts. In some embodiments, when the one or more first criteria are satisfied, the first input corresponds to concurrent deflection of left and right analog sticks on a handheld controller (e.g., both sticks pushed in parallel) while the first virtual object is selected. In some embodiments, the translation movement refers to a change in position of the first and second input elements within the three-dimensional environment between corresponding start positions and corresponding end positions that are separated by a distance. In some embodiments, the translation movement refers to a change in position of a midpoint between the first and second input elements within the three-dimensional environment (or a different point within the three-dimensional environment based on the locations of the first and/or second input elements) between a start position and an end position for the first input (e.g., while a distance between the first and second input elements remains relatively constant, as described in greater detail below). In some embodiments, the computer system determines the translation movement by computing a displacement vector between two input states associated with the first and second input elements (e.g., the beginning of the input, and the end of the input). In some embodiments, the translation movement includes linear displacement and excludes rotational and/or scaling components that are optionally present in the input states detected by the computer system. In some embodiments, the computer system updates the first magnitude incrementally in accordance with a continuation of the first input until the first input surpasses a maximum threshold (e.g., a maximum distance and/or time interval). In some embodiments, the first amount refers to a rotational value (e.g., an angular step size measured in degrees or radians) the computer system applies to the first virtual object in response to the translation movement having the first magnitude. In some embodiments, a larger magnitude corresponds to a larger amount of rotation and a smaller magnitude corresponds to a smaller amount of rotation. In some embodiments, the first amount is computed by multiplying the first magnitude by a constant or variable gain factor (e.g., 1 degree per millimeter). In some embodiments, the computer system rotates and updates the display of the first virtual object dynamically (e.g., in real time or near real-time) while the computer system detects the first input. In some embodiments, the first amount is zero when the first magnitude does not exceed a threshold (e.g., 1 mm, 5 mm, 1 cm, 3 cm, or 5 cm). In some embodiments, the computer system determines the first amount from the first magnitude according to a non-linear transfer function (e.g., polynomial, exponential, logarithmic, or piece-wise mapping) such that equal increments of the first magnitude produce differing increments in the amount the first virtual object is rotated. For example, the computer system optionally applies a quadratic mapping that causes small translation movements to yield fine rotational adjustments while larger movements accelerate the rotation at an increasing rate.

In some embodiments, in response to detecting the first input (2004), in accordance with a determination that the first input includes translation movement of the first input element and the second input element corresponding to a translation input that has a second magnitude, different from the first magnitude (e.g., hands 1902 and 1903 translating with a respective magnitude in FIG. 19N), the computer system rotates (2008) the first virtual object by a second amount, different from the first amount, in accordance with the translation movement of the first input element and the second input element, such as computer system 101 rotating virtual object 1910 by 180 degrees in accordance with the respective movement of hands 1902 and 1903 in FIG. 19N. In some embodiments, the second magnitude shares one or more characteristics with the first magnitude. In some embodiments, the second amount shares one or more characteristics with the first amount. In some embodiments, in response to detecting the first input and when the first input does not satisfy the one or more first criteria (e.g., the first and second input elements do not maintain a relatively constant distance between each other throughout the translation movement, the first and/or second input elements are closer than the above-described threshold distance from the first virtual object or cross the threshold distance during the first input, and/or attention of the user is not directed to the first virtual object), the computer system does not rotate the first virtual object by a respective amount in accordance with respective translation movement (e.g., the computer system scales the first virtual object in accordance with a change in the distance between the first and second input elements).

In some embodiments, in response to detecting the first input, in accordance with a determination that the first input includes translation movement of the first input element and the second input element corresponding to a translation input that has a first translation direction (e.g., the +X translation direction of the movement of hands 1902 and 1903 in FIG. 19M), the computer system rotates the first virtual object in a first rotation direction in accordance with the translation movement of the first input element and the second input element, such as computer system 101 rotating virtual object 1910 in a +Y direction in accordance with the +X translation direction of the movement of hands 1902 and 1903 in FIG. 19M. In some embodiments, the first translation direction refers to an orientation of the displacement vector within the three-dimensional environment that characterizes the translation movement of the first input element and the second input element. In some embodiments, the translation direction is derived from the displacement of a midpoint between the first and second input elements as the computer system detects movement of the first and second input elements. In some embodiments, rotating the first virtual object in the first rotation direction refers to applying an angular transformation to the first virtual object about a rotation axis (e.g., an axis that crosses a centroid of the first virtual object) that the computer system selects according to the first translation direction (e.g., yaw about a vertical axis for right-left translation or pitch about a horizontal axis for up-down translation). In some embodiments, the rotation axis passes through a centroid of the first virtual object or through a user-defined pivot point on the first virtual object (e.g., such as a pivot point defined by the gaze of the user described with respect to method 1800). In some embodiments, rotating the first virtual object in the first rotation direction includes applying an angular transformation to the first virtual object about a rotation axis such that the sign (e.g., clockwise or counterclockwise) of the angular displacement corresponds to the first rotation direction that the computer system associates with the first translation direction. For example, the first rotation direction is optionally counterclockwise about a vertical axis through the centroid of the first virtual object when the first translation direction is classified as rightward and clockwise about the vertical axis when the first translation direction is classified as leftward. In some embodiments, the computer system determines an amount of rotation (e.g., an angular magnitude in either the first or second rotation direction) by mapping the magnitude of the corresponding translation movement (e.g., through a constant gain for a linear relationship or through a lookup table, polynomial, logarithmic, or other non-linear function).

In some embodiments, in accordance with a determination that the first input includes translation movement of the first input element and the second input element corresponding to a translation input that has a second translation direction, different from the first translation direction (e.g., the −X translation direction of the movement of hands 1902 and 1903 in FIG. 19O), the computer system rotates the first virtual object in a second rotation direction, different from the first rotation direction, in accordance with the translation movement of the first input element and the second input element, such as computer system 101 rotating virtual object 1910 in a-Y direction in accordance with the −X translation direction of the movement of hands 1902 and 1903 in FIG. 19O. In some embodiments, the second translation direction shares one or more characteristics with the first translation direction. In some embodiments, the second translation direction is different from the first translation direction when an angle between the first and second translation directions is greater than a respective threshold (e.g., 1°, 2°, 5°, 10°, 15°, 25°, or 45°). In some embodiments, rotating the first virtual object in the second rotation direction shares one or more characteristics with rotating the first virtual object in the first rotation direction. In some embodiments, the first and second rotation directions differ in that they are applied about distinct rotation axes (e.g., yaw vs. pitch) and/or have opposite senses on a common axis, such that the orientation of the first virtual object changes in a different manner for translation movements classified in the respective first and second translation directions.

In some embodiments, in accordance with a determination that the first translation direction and the second translation direction are within a threshold angle of being opposite to each other (e.g., translation directions +X and −X in FIGS. 19M and 19O, respectively), the first rotation direction corresponds to a first direction about a first axis, such as the +Y rotation direction in FIG. 19M. In some embodiments, the threshold angle of being opposite to each other is an angular tolerance (e.g., ±α° around 180°, such as ±0°, 1°, 3°, 5°, 10°, 15°, 25°, 35°, or 45°) used by the computer system to determine that the first translation direction and the second translation direction are sufficiently anti-parallel to be treated as opposite. For example, for an angular tolerance of 5°, the first and second translation directions are treated as being opposite to each other when an angle between the first and second translation directions is between 175° and 185°. In some embodiments, the computer system dynamically adapts the threshold angle based on a magnitude of the translation movement(s). In some embodiments, the first rotation direction corresponds to a first sense of angular motion (e.g., clockwise, positive-yaw, or positive-pitch) about the first axis that the computer system selects based on the first translation direction.

In some embodiments, in accordance with a determination that the first translation direction and the second translation direction are within a threshold angle of being opposite to each other (e.g., translation directions +X and −X in FIGS. 19M and 19O, respectively), the second rotation direction corresponds to a second direction about the first axis, opposite to the first direction about the first axis, such as the −Y rotation direction in FIG. 19O. In some embodiments, the second rotation direction corresponds to a second sense of angular motion, opposite from the first sense of angular motion (e.g., counterclockwise when the first direction is clockwise or negative-yaw when the first direction is positive-yaw), about the same first axis. For example, when the first translation direction is rightward and the second translation direction is leftward (e.g., within the threshold angle of being opposite to each other), the first rotation direction optionally corresponds to a counterclockwise direction about a vertical axis and the second rotation direction optionally corresponds to a clockwise direction about the same vertical axis.

In some embodiments, in accordance with a determination that the first translation direction and the second translation direction are within a threshold angle of being perpendicular to each other (e.g., translation directions +X and +Y in FIGS. 19M and 19Q, respectively), the first rotation direction corresponds to a first direction about a first axis (e.g., the +Y rotation direction in FIG. 19M), and the second rotation direction corresponds to a first direction about a second axis, different from the first axis (e.g., the −X rotation in FIG. 19Q). In some embodiments, the first rotation direction corresponds to a direction of angular motion (e.g., clockwise, positive-yaw, or positive-pitch) about the first axis that the computer system selects based on the first translation direction. In some embodiments, the second rotation direction corresponds to the same direction of angular motion (e.g., clockwise, positive-yaw, or positive-pitch) but about a second axis that is different from (e.g., orthogonal to) the first axis. For example, when the first translation direction is rightward and the second translation direction is upward (e.g., within the threshold angle of being perpendicular to each other), the first rotation direction optionally corresponds to a counterclockwise direction about a vertical axis and the second rotation direction optionally corresponds to a counterclockwise direction about a horizontal axis, perpendicular to the vertical axis. In some embodiments, the threshold angle of being perpendicular to each other is an angular tolerance (e.g., ±α° around 90°, such as ±0°, 1°, 3°, 5°, 10°, 15°, 25°, 35°, or) 45° used by the computer system to determine that the first translation direction and the second translation direction are sufficiently orthogonal to be treated as perpendicular. For example, for an angular tolerance of 10°, the first and second translation directions are treated as being perpendicular to each other when an angle between the first and second translation directions is between 80° and 100°. In some embodiments, the computer system dynamically adapts the threshold angle based on a magnitude of the translation movement(s).

In some embodiments, in response to detecting the first input, in accordance with a determination that the first input includes rotation movement of the first input element and the second input element that rotates a first axis between the first input element and the second input element within the three-dimensional environment (e.g., the rotation of axis 1925 in FIGS. 19U-19X), the computer system rotates the first virtual object in accordance with the rotation movement of the first input element and the second input element, such as computer system rotating virtual object 1910 in accordance with the rotation of axis 1925 in FIGS. 19U-19X. In some embodiments, a rotation movement is detected when the orientation of a first axis (e.g., defined by a line segment connecting the contemporaneous positions of the first input element and the second input element within the three-dimensional environment) changes by at least a threshold angle between a start time and an end time (optionally while a distance between the first and second input elements remains within a tolerance band such that the motion is primarily rotational rather than translational or scaling). For example, a rotation movement is optionally detected when the first and second input elements move along substantially circular arcs about a midpoint between them, such that the axis connecting the first and second input elements (e.g., the first axis) rotates by a respective angle. In some embodiments, rotating the first virtual object in accordance with the rotation movement of the first and second input elements refers to applying to the first virtual object an angular transformation whose axis is orthogonal to the plane in which the line connecting the first and second input element pivots (e.g., a Z-axis when the line pivots within the X-Y plane) and whose angle equals the amount that this line has pivoted (e.g., such that the first virtual object turns in lock-step with the circular hand motion). For example, when the rotation movement yaw-rotates the first axis clockwise about the +Z axis by 30°, the computer system rotates the first virtual object clockwise about its own +Z axis by 30°. In some embodiments, a magnitude of the rotation movement of the first input element and the second input element is different from a magnitude of the rotation applied to the first virtual object. In some embodiments, the computer system rotates the first virtual object by an angular amount that is proportional to the angle through which the first axis rotates (e.g., an amount of rotation of the first axis), and the direction of the angular amount (e.g., clockwise versus counter-clockwise or pitch-up versus pitch-down) is based on (e.g., matches) the direction of the rotation of the first axis.

In some embodiments, rotating the first virtual object in accordance with the rotation movement of the first input element and the second input element includes, in accordance with a determination that the first axis is in a first orientation relative to the three-dimensional environment, rotating the first virtual object about a second axis that has a second orientation relative to the three-dimensional environment, wherein the second orientation is based on the first orientation, such as rotating virtual object 1910 about the Z-axis (e.g., the second orientation) in accordance with the determination that the axis 1925 rotates within X-Y plane 1920a (e.g., the first orientation) in FIG. 19U. In some embodiments, the first orientation corresponds to a plane within the three-dimensional environment in which the line joining the first and second input elements (e.g., the first axis) lies (e.g., a vertical X-Y plane, a horizontal X-Z plane, or a different plane captured at start of the first input). In some embodiments, rotating the first virtual object about the second axis includes selecting an axis whose second orientation is based on the first orientation (e.g., a normal/perpendicular vector to a plane) so the applied rotation consistently relates to how the first and second input elements are arranged in the first orientation. For example, when the first orientation is a vertical X-Y plane, the computer system optionally selects the second axis to be the Z-axis (normal to the X-Y plane) and rotates the first virtual object about the Z-axis in response to the circular motion executed by the first and second input elements within the X-Y plane. In some embodiments, when the first axis is in the first orientation, the computer system rotates the first virtual object about the second axis based on the rotational direction of rotation of the first and second input elements (e.g., rotates the first virtual object in the same rotational direction) and by an angular amount proportional to the angle through which the first axis pivots (e.g., based on an amount of movement of the first and second input elements).

In some embodiments, rotating the first virtual object in accordance with the rotation movement of the first input element and the second input element includes, in accordance with a determination that the first axis is in a third orientation, different from the first orientation, relative to the three-dimensional environment, rotating the first virtual object about a third axis that has a fourth orientation, different from the second orientation, relative to the three-dimensional environment, wherein the fourth orientation is based on the third orientation, such as rotating virtual object 1910 about the Y-axis (e.g., the fourth orientation) in accordance with the determination that the axis 1925 rotates within X-Z plane 1920b (e.g., the third orientation) in FIG. 19W. In some embodiments, the third orientation shares one or more characteristics with the first orientation described above. In some embodiments, the third axis and the fourth orientation share one or more characteristics with the second axis and the third orientation described above, respectively. In some embodiments, the computer system uses an analogous rule when determining the second orientation and the fourth orientation from the first orientation and the third orientation (e.g., the second and fourth orientations are orthogonal to or a fixed angular offset from the first and third orientations) to yield second and fourth orientations that are different from each other given the difference in the hand-axis direction between the first orientation and the third orientation. For example, when the third orientation is a horizontal X-Z plane, the computer system optionally selects the fourth orientation to be the Y-axis (normal to the X-Z plane) and rotates the first virtual object about the Y-axis in response to the circular motion executed by the first and second input elements within the X-Z plane. In some embodiments, when the first axis is in the third orientation, the computer system rotates the first virtual object about the third axis based on the rotational direction of rotation of the first and second input elements (e.g., rotates the first virtual object in the same rotational direction) and by an angular amount proportional to the angle through which the first axis pivots (e.g., based on an amount of movement of the first and second input elements).

In some embodiments, in response to detecting the first input, in accordance with a determination that the first input includes translation movement of the first input element and the second input element corresponding to a translation input that has a first translation direction (e.g., translation movement of hands 1902 and 1903 in the +X direction in FIG. 19R), the computer system rotates the first virtual object in accordance with the translation movement of the first input element and the second input element, such as computer system 101 rotating virtual object 1910 in accordance with the translation movement of hands 1902 and 1903 in FIG. 19R while settings 1930a and 1930b are active. In some embodiments, the first translation direction shares one or more characteristics with one or more of the translation directions described above. In some embodiments, rotating the first virtual object in accordance with the translation movement of the first input element and the second input element shares one or more characteristics with rotating the first virtual object in accordance with one or more translation movements described above.

In some embodiments, in accordance with a determination that the first input includes translation movement of the first input element and the second input element corresponding to a translation input that has a second translation direction, different from the first translation direction (e.g., translation movement of hands 1902 and 1903 in the +Z direction in FIG. 19T), the computer system translates the first virtual object in accordance with the translation movement of the first input element and the second input element in the second translation direction, such as computer system 101 translating virtual object 1910 in accordance with the translation movement of hands 1902 and 1903 in FIG. 19T while settings 1930a and 1930b are active. In some embodiments, the second translation direction shares one or more characteristics with one or more of the translation directions described above. In some embodiments, translating the first virtual object in accordance with the translation movement entails linearly displacing the position of the first virtual object by a vector that is equal to (or proportional to) the displacement vector computed from the concurrent motion of the first and second input elements. In some embodiments, the computer system employs a direction-based manipulation rule where, when the translation movement is classified in the first translation direction, the computer system interprets movement in the first translation direction as a request to rotate the first virtual object, and when the translation movement is classified in the second translation direction, the computer system interprets movement is the second translation direction as a request to translate the first virtual object, resulting in a positional shift instead of a rotation. For example, the direction-based manipulation rule optionally specifies that lateral translation rotates the first virtual object about a vertical axis, whereas forward-or-backward translation moves the first virtual object closer or farther along the same depth axis. In some embodiments, when the translation input has the second translation direction, a larger displacement of the first and second input elements (and/or of a midpoint between the first and second input elements) corresponds to a larger displacement of the translation of the first virtual object in a direction based on the second translation direction (e.g., the same direction). In some embodiments, when the translation input has the second translation direction, a smaller displacement of the first and second input elements (and/or of the midpoint between the first and second input elements) corresponds to a smaller displacement of the translation of the first virtual object in a direction based on the second translation direction (e.g., the same direction). In some embodiments, the computer system stores a setting (e.g., determined by an application or developer associated with the first virtual object) that specifies whether translation movement in a given direction should be treated as a rotation operation or as a translation operation on the first virtual object. In some embodiments, the computer system determines whether translation movement in a given direction should be treated as a rotation operation or as a translation operation on the first virtual object based on one or more contextual factors (e.g., particular object, object type, object characteristics, environment characteristics, application mode, and/or recent user behavior). In some embodiments, the user of the computer system determines whether translation movement in a given direction should be treated as a rotation operation or as a translation operation on the first virtual object (e.g., by configuring a setting that governs manipulation for the first virtual object, an object type, one or more object characteristics, the environment, an application, or the system as a whole).

In some embodiments, while displaying, via the one or more display generation components, the first virtual object in the three-dimensional environment, and while the first virtual object is being controlled the first input element but not the second input element (e.g., virtual object 1910 being controlled by hand 1902 in FIGS. 19A-19J), the computer system detects, via the one or more input devices, a second input directed to the first virtual object, wherein the second input includes input from the first input element and does not include input from the second input element, such as computer system 101 detecting input from hand 1902 directed to virtual object 1910 in FIGS. 19B-19J. In some embodiments, the computer system deems the first virtual object as not being controlled when no active input from the first input element and/or the second input element satisfies one or more control-eligibility criteria (e.g., the first input element and/or the second input element are not maintaining a selection gesture, such as an air pinch or a press of a button). In some embodiments, the one or more control-eligibility criteria share one or more characteristics with one or more requirements for one or more input elements to establish control over one or more virtual objects described with respect to methods 800, 900, 1000, 1100, 1200, 1300, 1600, and/or 1800. In some embodiments, the first virtual object is controlled by the first input element but not the second input element. In some embodiments, the first virtual object is controlled by the second input element but not the first input element.

In some embodiments, the second input is a user interaction detected by the computer system that satisfies the one or more control-eligibility criteria based on the first input element and does not satisfy the control-eligibility criteria based on the second input element. For example, the second input optionally includes the first input element performing and maintaining a selection pose (e.g., an air pinch hold) and the second input element not performing or maintaining a selection pose (e.g., an open hand), while attention of the user (e.g., based on gaze) is directed to the first virtual object.

In some embodiments, in response to detecting the second input, in accordance with a determination that the second input includes movement of the first input element, the computer system moves the first virtual object in accordance with the movement of the first input element, such as computer system 101 moving virtual object 1910 in accordance with movement of hand 1902 in FIG. 19B. In some embodiments, moving the first virtual object in accordance with the movement of the first input element refers to applying one or more transformations (e.g., translation, rotation, scaling, or a combination thereof) to the first virtual object based on one or more parameters (e.g., displacement, orientation change, and/or distance change between two digits) measured for the first input element during the second input. In some embodiments, moving the first virtual object in accordance with the movement of the first input element shares one or more characteristics with translating, rotating, scaling, or a combination thereof the first virtual object in accordance with the movement of the first and second input elements described herein. In some embodiments, moving the first virtual object in accordance with the movement of the first input element shares one or more characteristics with moving one or more virtual objects in accordance with movement of an input element described with respect to methods 900, 1000, 1100, 1600, and/or 1800.

In some embodiments, while the second input is active, the computer system detects, via the one or more input devices, a third input directed to the first virtual object, wherein the third input includes input from the second input element, such as computer system 101 detecting input from hand 1903 in FIGS. 19K-19AN after detecting input from hand 1902 in FIGS. 19A-19J. In some embodiments, the second input remains active so long as the first input element continuously satisfies the one or more control-eligibility criteria (e.g., or while the computer system detects the first input element moving). In some embodiments, the third input is a user interaction detected by the computer system that satisfies the one or more control-eligibility criteria based on the second input element (and optionally does not satisfy the control-eligibility criteria based on the second input element). For example, the third input optionally includes the second input element performing and maintaining a selection pose (e.g., an air pinch hold) while attention of the user (e.g., based on gaze) is directed to the first virtual object. In some embodiments, the computer system detects the third input when the second input element independently satisfies the one or more control-eligibility criteria (e.g., while the second input remains active). In some embodiments, the third input is treated as a single-element addition when the second input element alone satisfies the one or more control-eligibility criteria, or as a compound input when both the first and second input elements simultaneously satisfy the one or more control-eligibility criteria, thus enabling seamless transition from one-element to two-element manipulation without canceling the ongoing control session.

In some embodiments, in response to detecting the third input and while the second input is active, in accordance with a determination that the second input or the third input includes movement of the first input element or the second input element respectively (e.g., computer system 101 detecting input from hands 1902 and 1903 in FIGS. 19L-19AN), the computer system moves the first virtual object in accordance with the movement of the first input element and the second input element, such as computer system 101 moving virtual object 1910 in accordance with the movement of hands 1902 and 1903 in FIG. 19L. In some embodiments, moving the first virtual object in accordance with the movement of the first input element or the second input element includes, while the second input and the third input are active, the computer system applying one or more transformations (e.g., translation, rotation, scaling, or a combination thereof) to the first virtual object whose parameters are computed based on the positional and/or orientational change of whichever input element (or both) the system detects as moving. In some embodiments, moving the first virtual object in accordance with the movement of the first input element and the second input element shares one or more characteristics with translating, rotating, scaling, or a combination thereof the first virtual object in accordance with the movement of the first and second input elements described herein. In some embodiments, the computer system moves the first virtual object in accordance with movement of the first input element or the second input element in situations where only one of the input elements is detected as moving while the both the second input and third inputs are active.

In some embodiments, moving the virtual object in accordance with the movement of the first input element includes, in accordance with a determination that the second input includes translation movement of the first input element (e.g., translation movement of hand 1902 in FIG. 19B), translating the first virtual object in accordance with the translation movement of the first input element, such as computer system 101 translating virtual object 1910 in accordance with the translation movement of hand 1902 in FIG. 19B. In some embodiments, translating the first virtual object in accordance with the translation movement of the first input element refers to linearly displacing the position of the first virtual object by a vector that is equal to (or proportional to) the displacement vector computed from the motion of the first input element measured during the second input. In some embodiments, translating the first virtual object in accordance with the translation movement of the first input element shares one or more characteristics with translating the first virtual object in accordance with the translation movement of the first and second input elements described herein. In some embodiments, translating the first virtual object in accordance with the translation movement of the first input element shares one or more characteristics with translating one or more virtual objects in accordance with the translation movement of one or more virtual objects described with respect to methods 900, 1000, 1100, 1600, and/or 1800.

In some embodiments, moving the virtual object in accordance with the movement of the first input element includes, in accordance with a determination that the second input includes rotation movement of the first input element (e.g., rotation movement of hand 1902 in FIG. 19C), rotating the first virtual object in accordance with the rotation movement of the first input element, such as computer system 101 rotating virtual object 1910 in accordance with the rotation movement of hand 1902 in FIG. 19C. In some embodiments, rotating the first virtual object in accordance with the rotation movement of the first input element refers to applying an angular transformation whose axis and angle are derived from the rotation movement measured for the first input element during the second input by the computer system. In some embodiments, rotating the first virtual object in accordance with the rotation movement of the first input element shares one or more characteristics with rotating the first virtual object in accordance with the rotation movement of the first and second input elements described herein. In some embodiments, rotating the first virtual object in accordance with the rotation movement of the first input element shares one or more characteristics with rotating one or more virtual objects in accordance with the rotation movement of one or more input elements described with respect to methods 900, 1000, 1100, 1600, and/or 1800. In some embodiments, the direction and/or amount of rotation of the virtual object is based on the movement (e.g., rotation) of the first input element. For example, the movement of the first input element includes rotation of the first input element relative to the three-dimensional environment in a first direction. In response to detecting the rotation of the first input element in the first direction, the computer system optionally moves (e.g., rotates) the virtual object in a respective first direction, based on or the same as the first direction. In accordance with a determination that the rotation of the first input element is in a second direction, the computer system optionally moves (e.g., rotates) the virtual object in a respective second direction, different from the respective first direction, that is based on or the same as the second direction of rotation of the first input element. In some embodiments, in response to detecting the rotation of the first input element by a first amount, the computer system moves the virtual object by a respective first amount, based on or the same as the first amount. In some embodiments, in response to detecting the rotation of the first input element by a second amount, different from the first amount, the computer system moves the virtual object by a respective second amount, different from the respective first amount, that is based on or the same as the second amount. In some embodiments, the computer system detects movement of the second input element while the second input element (e.g., and not the first input element) controls the movement of the virtual object, and in response, moves the virtual object in a manner similar to as described with reference to the first input element, but based on the movement of the second input element.

In some embodiments, moving the virtual object in accordance with the movement of the first input element includes, in accordance with a determination that the second input includes translation movement of the first input element and that translation of the first virtual object is suppressed (e.g., translation movement of hand 1902 while setting 1930 is active in FIG. 19C), rotating the first virtual object in accordance with the translation movement of the first input element, such as computer system 101 rotating virtual object 1910 in accordance with the translation movement of hand 1902 in FIG. 19C. In some embodiments, translation of the first virtual object being suppressed refers to a property or state of the first virtual object (e.g., a “translation-locked” flag set by an application, developer, or user) disables positional displacement in one or more translational directions such that detected translation movement in said one or more translational directions is redirected to a different manipulation mode (e.g., rotation). In some embodiments, the computer system suppresses translation of the first virtual object based on a user-selectable option provided in a settings menu. In some embodiments, the computer system suppresses translation of the first virtual object based on a parameter defined by an application associated with the first virtual object. In some embodiments, rotating the first virtual object in accordance with the translation movement of the first input element refers to applying an angular transformation whose axis and angle are proportional to the displacement vector computed from the motion of the first input element measured during the second input. In some embodiments, rotating the first virtual object in accordance with the translation movement of the first input element shares one or more characteristics with rotating the first virtual object in accordance with the translation movement of the first and second input elements described herein. In some embodiments, for inputs involving the first input element, the computer system determines how to manipulate the first virtual object using the location of the first input element in a similar manner for inputs involving the first and second input elements (e.g., the computer system determines how to manipulate the first virtual object using the location of a midpoint between the first and second input elements). In some embodiments, in accordance with a determination that translation of the first virtual object is not suppressed, the computer system translates the first virtual object in accordance with the translation movement of the first input element.

In some embodiments, the direction and/or amount of rotation of the virtual object is based on the movement (e.g., translation) of the first input element. For example, the movement of the first input element includes translation of the first input element relative to the three-dimensional environment in a first direction. In response to detecting the rotation of the first input element in the first direction, the computer system optionally moves (e.g., rotates) the virtual object in a respective first direction, based on or the same as the first direction. In accordance with a determination that the translation of the first input element is in a second direction, different from the first direction, the computer system optionally moves (e.g., rotates) the virtual object in a respective second direction, different from the respective first direction, that is based on or the same as the second direction of rotation of the first input element. In some embodiments, in response to detecting the translation of the first input element by a first amount, the computer system moves the virtual object by a respective first amount, based on or the same as the first amount. In some embodiments, in response to detecting the translation of the first input element by a second amount, different from the first amount, the computer system moves the virtual object by a respective second amount, different from the respective first amount, that is based on or the same as the second amount. In some embodiments, the computer system detects translation of the second input element while the second input element (e.g., and not the first input element) controls the movement of the virtual object, and in response, moves the virtual object in a manner similar to as described with reference to the first input element, but based on the translation of the second input element.

In some embodiments, in response to detecting the first input, in accordance with a determination that the first input includes a change in distance between the first input element and the second input element that has a first magnitude (e.g., the change in distance between hands 1902 and 1903 having a respective magnitude in FIG. 19Y), the computer system scales the first virtual object by a first amount in accordance with the first magnitude of the change in distance between the first input element and the second input element, such as computer system 101 scaling virtual object 1910 by an amount proportional to the respective magnitude of the change in distance between hands 1902 and 1903 in FIG. 19Y. In some embodiments, the change in distance between the first input element and the second input element refers to a scalar difference (e.g., the first magnitude) between a distance between the first and second elements before detecting the first input (or at the moment the first input begins) and a distance between the first and second elements in response to detecting the first input end (or at a moment in time during the first input). In some embodiments, scaling the first virtual object by the first amount entails applying a uniform or non-uniform scale transform whose scale factor (e.g., the first amount) is derived from the first magnitude of the change in distance between the first and second input elements. In some embodiments, scaling the first virtual object shares one or more characteristics with scaling one or more virtual objects described with respect to methods 900, 1000, 1100, and/or 1800.

In some embodiments, in accordance with a determination that the first input includes a change in distance between the first input element and the second input element that has a second magnitude, different from the first magnitude (e.g., the change in distance between hands 1902 and 1903 having a respective magnitude in FIG. 19Z), the computer system scales the first virtual object by a second amount, different from the first amount, in accordance with the second magnitude of the change in distance between the first input element and the second input element, such as computer system 101 scaling virtual object 1910 by an amount proportional to the respective magnitude of the change in distance between hands 1902 and 1903 in FIG. 19Z. In some embodiments, the second magnitude and the second amount share one or more characteristics with the first magnitude and the first amount, respectively, described above. In some embodiments, because the change in distance that has the second magnitude differs from the change in distance that has the first magnitude, the corresponding second amount scales the first virtual object by a different proportion than the first amount, thereby producing a different size adjustment that reflects the larger or smaller separation of the first and second input elements.

In some embodiments, scaling the first virtual object by the first amount in accordance with the first magnitude of the change in distance between the first input element and the second input element includes, during a first portion of the scaling of the first virtual object and in accordance with a determination that the first virtual object does not have a spatial conflict with an object (e.g., physical or virtual) within the three-dimensional environment (e.g., the portion of the scaling transformation computer system 101 applies on virtual object 1910 between FIGS. 19AH and 19AI where virtual object 1910 does not have a spatial conflict with lamp 1901), scaling the first virtual object with a first relationship between an amount of scaling of the first virtual object and a magnitude of the change in the distance between the first input element and the second input element during the first portion of the scaling, such as computer system 101 scaling virtual object 1910 with the baseline relationship defined by curve 1948c between FIGS. 19AH and 19AI. In some embodiments, the first portion of the scaling of the first virtual object refers to a subset of the overall scaling operation (e.g., defined by an accumulated scale change, an elapsed time, a user-input phase, or other measurable segment) that occurs before the computer system determines that the first virtual object has a spatial conflict with another object in the three-dimensional environment. In some embodiments, the computer system detects the spatial conflict when the first virtual object, at its proposed size and/or orientation, would intersect, contact, or otherwise encroach within a tolerance distance of another object represented in the three-dimensional environment (e.g., scene geometry, user interface panels, and/or other physical or virtual bodies) with respect to the viewpoint of the user. Some examples of spatial conflict detection methods include, but are not limited to, intersection tests (e.g., a bounding box of the first virtual object overlaps the bounding box of another object), penetration depth (e.g., a penetration depth is greater than zero (or another threshold) between the meshes of two objects), and/or proximity threshold (e.g., the minimum distance between a vertex of the first virtual object and a vertex of another object falls below a threshold (e.g., 0 mm, 1 mm, 5 mm, 1 cm, 5 cm, or 10 cm)). In some embodiments, scaling the first virtual object with the first relationship means that, throughout the first portion (e.g., before detecting a spatial conflict), the computer system determines each incremental amount of scale change for the first virtual object by evaluating a fixed functional relationship (e.g., the first relationship) between the current magnitude of the change in distance between the first and the second input elements and the resulting amount of scaling applied to the first virtual object. Some examples of the first relationship include, but are not limited to, linear gain (e.g., applying a uniform scale factor), non-linear formulas (e.g., quadratic or logarithmic curves), piecewise (e.g., mapping distance-change ranges to discrete scale steps), and/or velocity-weighting (e.g., applying a speed-dependent coefficient).

In some embodiments, scaling the first virtual object by the first amount in accordance with the first magnitude of the change in distance between the first input element and the second input includes, during a second portion of the scaling, different from (e.g., after) the first portion of the scaling, and in accordance with a determination that the first virtual object does have the spatial conflict with the object (e.g., physical or virtual) within the three-dimensional environment (e.g., the portion of the scaling transformation computer system 101 applies on virtual object 1910 between FIGS. 19AI and 19AJ where virtual object 1910 does have a spatial conflict with lamp 1901), forgoing scaling the first virtual object with the first relationship between an amount of scaling of the first virtual object and a magnitude of the change in the distance between the first input element and the second input element during the second portion of the scaling, such as computer system 101 forgoing scaling virtual object 1910 with the baseline relationship defined by curve 1948c between FIGS. 19AH and 19AI. In some embodiments, the second portion of the scaling shares one or more characteristics with the first portion of the scaling. In some embodiments, during the second portion of the scaling, in accordance with a determination that first virtual object does not have the spatial conflict with the object within the three-dimensional environment, the computer system scales the first virtual object with the first relationship between the amount of scaling of the first virtual object and the magnitude of the change in the distance between the first input element and the second input element during the second portion of the scaling. In some embodiments, the second portion of the scaling refers to a subset of the overall scaling operation that occurs after (and optionally while) the computer system determines that the first virtual object has the spatial conflict with the object. In some embodiments, forgoing scaling the first virtual object with the first relationship means that, during the second portion (e.g., while detecting the spatial conflict), the computer system stops using the first relationship to determine additional scale changes to the first virtual object and either does not scale the first virtual object further or scales the first virtual object according to a second relationship, different from the first relationship, in response to a further change in the distance between the first input element and the second input element. In some embodiments, the second relationship is a mapping between the amount of scaling of the first virtual object and the magnitude of the change in the distance between the first input element and the second input element during the second portion of the scaling, where an amount of scaling of the first virtual object with the second relationship is less than an amount of scaling of the first virtual object with the first relationship for the same magnitude of the change in the distance between the first and second input elements. For example, the second relationship optionally includes a smaller gain factor than the first relationship and/or an inverse mapping (e.g., increasing the distance the first virtual object travels within the object reduces the scale factor). In some embodiments, in response to detecting termination of the first input, in accordance with a determination that the first virtual object intersects with the object within the three-dimensional environment by more than a threshold amount, the computer system reduces a size of the first virtual object such that the first virtual object at the reduced size intersects with the object by the threshold amount, as described in greater detail below.

In some embodiments, while scaling the first virtual object by the first amount in accordance with the first magnitude of the change in distance between the first input element and the second input element, the computer system detects, via the one or more input devices, termination of the first input, such as computer system 101 detecting hands 1902 and/or 1903 release the air pinch gesture in FIG. 19AN after a scaling input. In some embodiments, detecting termination of the first input means that the computer system identifies that the compound gesture (e.g., including concurrent input from the first and second input elements) has ceased to satisfy one or more criteria that originally qualified it as the first input (e.g., a selection-state release, such as an opened air pinch or a release of a pressed state of a button of at least one of the first and second input elements, an idle timeout, a proximity breach, or another gesture disqualification).

In some embodiments, in response to detecting the termination of the first input, in accordance with a determination that the first virtual object intersects with an object (e.g., physical or virtual) within the three-dimensional environment by more than a threshold amount (e.g., virtual object 1910 intersecting virtual object 1912 by more than threshold 1914 in FIG. 19AM), the computer system reduces a size of the first virtual object such that the first virtual object at the reduced size intersects with the object by the threshold amount, such as computer system 101 reducing the size of virtual object 1910 such that virtual object 1910 at the reduced size intersects virtual object 1912 by threshold amount 1914 in FIG. 19AN. In some embodiments, the first virtual object intersecting with the object shares one or more characteristics with the first virtual object having the spatial conflict with the object described above. In some embodiments, the computer system determines a quantitative intersection metric (e.g., penetration depth, overlap volume, and/or percentage-of-volume overlap) between the first virtual object and another object in the three-dimensional environment. In some embodiments, the computer system determines that the first virtual object intersects the object by more than the threshold amount when the quantitative intersection metric exceeds the threshold amount (e.g., 0 mm, 5 mm, 1 cm, 5 cm, or 10 cm penetration depth; 0 cm3, 5 cm3, 30 cm3, 100 cm³, or 500 cm3 overlap volume; and/or 0%, 2%, 5%, 10%, or 25% percentage-of-overlap volume). In some embodiments, reducing the size of the first virtual object when the first virtual object intersects with the object by more than the threshold amount means that the computer system applies one or more scale transformations (e.g., uniform or axis-selective) until one or more quantitative intersection metrics (e.g., penetration depth, overlap volume, and/or percentage-of-volume overlap) falls to (or just inside) the threshold amount, thereby leaving the first virtual object penetrating the object by as much as is allowed by the threshold amount. In some embodiments, in response to detecting the termination of the first input, in accordance with a determination that the first virtual object does not intersect the object within the three-dimensional environment by more than the threshold amount, the computer system does not reduce the size of the first virtual object (e.g., maintains the size of the first virtual object in accordance with the first input).

In some embodiments, the first input includes a first movement of the first input element and the second input element that satisfies one or more first input criteria associated with a first type of manipulation, such as translation movement of hands 1902 and 1903 in FIGS. 19AA-19AE. In some embodiments, the first movement of the first input element and the second input element satisfying the one or more input criteria means that the computer system identifies the first movement as belonging to the first type of manipulation (e.g., rotation, translation, scaling, and/or another manipulation defined by the system). In some embodiments, the one or more first input criteria include one or more requirements related to the displacement direction, distance, relative orientation change, relative spacing, and/or other input criteria described herein for the one or more first input criteria to be satisfied. For example, the computer system optionally classifies the first movement as a translation gesture when the midpoint of the first and second input elements is displaced within the three-dimensional environment by at least a threshold distance; as a rotation gesture when the axis that joins the first and second input elements pivots by at least a threshold angle; or as a scaling gesture when the distance between the first and second input elements changes by at least a threshold distance, as described in greater detail herein.

In some embodiments, the first input includes a second movement of the first input element and the second input element that satisfies one or more second input criteria, different from the one or more first input criteria, associated with a second type of manipulation (optionally different from the first type of manipulation), such as separation movement of hands 1902 and 1903 in FIGS. 19AA-19E. For example, the first input optionally includes concurrent input by the first input element and the second input element that satisfies the one or more first input criteria. In some embodiments, the second movement of the first input element and the second input element shares one or more characteristics with the first movement of the first input element and the second input element described above. In some embodiments, the one or more second input criteria share one or more characteristics with the one or more first input criteria described above. In some embodiments, the second type of manipulation shares one or more characteristics with the first type of manipulation described above. In some embodiments, the first type of manipulation and the second type of manipulation are different types of manipulation (e.g., rotation versus translation, translation versus scaling, or scaling versus rotation). In some embodiments, the first type of manipulation and the second type of manipulation are the same type of manipulation, but the first movement has a first direction and/or a first magnitude, and the second movement has a second direction and/or a second magnitude, different from the first direction and/or the first magnitude. For example, the first movement is optionally a translation movement in a right-ward direction (+X) with a 5 cm displacement, whereas the second movement is optionally a translation movement in an upward direction (+Y) with a 1 cm displacement.

In some embodiments, the first movement exceeds the second movement by more than a first threshold amount of prominence, such as the translation movement exceeding the separation movement by a respective amount such that separation movement has a prominence less than prominence threshold 1942a in FIG. 19AA. In some embodiments, the computer system computes a prominence metric for each concurrent movement which quantifies how strongly the movement satisfies its associated input criteria (e.g., by magnitude, velocity, duration, classification score, or any weighted combination thereof). In some embodiments, the first threshold amount of prominence is a preset comparison value that the computer system uses to decide when the first movement is sufficiently more prominent than the second movement to warrant a predetermined action, as described below. In some embodiments, the first movement is considered more prominent than the second movement when its prominence value is greater than the prominence value of the second movement by at least the first threshold amount of prominence (e.g., a displacement of at least 5 mm, 1 cm, 2 cm, 3 cm, 5 cm, 10 cm, or 20 cm more). For example, when the first threshold amount of prominence is set to 3 cm of displacement, the first movement is optionally deemed more prominent when it moves at least 3 cm farther than the second movement. In this example, when the first movement corresponds to a rightward 8 cm translation and the second movement corresponds to an upward 4 cm translation, the computer system optionally translates the first virtual object by 8 cm to the right (or an amount based on an 8 cm translation of the first and second input elements) and does not translate the first virtual object upwards by any amount (or translates the first virtual object by a suppressed amount, as described in greater detail below). In some embodiments, the first movement is considered more prominent than the second movement when its prominence value is more than a specified multiple (e.g., the first threshold amount, optionally 1.1×, 1.2×, 1.5×, 2×, 3×, 5×, 7×, 10×, or 20×) of the prominence value of the second movement. For example, when the first threshold amount of prominence is a 4× multiple, the first movement is deemed more prominent when its prominence value is more than four times that of the second movement. In some embodiments, the first movement is considered more prominent than the second movement when the prominence value of the second movement is less than a factor (e.g., the first threshold amount, optionally 1%, 2%, 5%, 10%, 25%, 50%, or 75%) of the prominence value of the first movement. For example, when the first threshold amount of prominence is defined such that the second movement must be less than 10% of the prominence value of the first movement, the first movement is deemed more prominent when the prominence value of the second value is less than a tenth of the prominence value of the first movement.

In some embodiments, in response to detecting the first input, in accordance with a determination that the first input includes the first movement of the first input element and the second input element that satisfies the one or more first input criteria associated with the first type of manipulation, the first input includes the second movement of the first input element and the second input element that satisfies the one or more second input criteria, different from the one or more first input criteria, associated with the second type of manipulation, and the first movement exceeds the second movement by more than a first threshold amount of prominence (e.g., the translation movement exceeding the separation movement by a respective amount such that separation movement has a prominence less than prominence threshold 1942a in FIG. 19AA), the computer system performs the first type of manipulation of the first virtual object corresponding to the first movement without performing the second type of manipulation of the first virtual object corresponding to the second movement, such as computer system 101 performing the rotation transformation without performing the scaling transformation in FIG. 19AA. In some embodiments, performing the first and/or second types of manipulation of the first virtual object corresponding to the first and/or second movements shares one or more characteristics with translating, rotating, scaling, or a combination thereof the first virtual object in accordance with the movement of the first and second inputs described herein. For example, when the first type of manipulation corresponds to rotation and the second type of manipulation corresponds to translation, the computer system optionally rotates the first virtual object in accordance with the first movement without translating the first virtual object. In some embodiments, the computer system performs the first type of manipulation of the first virtual object with an amount and/or direction corresponding to a magnitude and/or direction of the first movement. As another example, when the first movement corresponds to translation movement in a right-ward direction (+X) with a 5 cm displacement and the second movement corresponds to a translation movement in an upward direction (+Y) with a 1 cm displacement, and the first and second types of manipulation correspond to rotation in different directions (e.g., based on the direction of the translation movement), the computer system optionally rotates the first virtual object in accordance with the translation movement in the right-ward direction and does not rotate the first virtual object in accordance with the translation movement in the upward direction.

In some embodiments, in response to detecting the first input, in accordance with a determination that the first input includes the first movement of the first input element and the second input element that satisfies the one or more first input criteria associated with the first type of manipulation (e.g., such as the movement of hands 1903 and 1902 in FIG. 19AE), the first input includes the second movement of the first input element and the second input element that satisfies the one or more second input criteria, different from the one or more first input criteria, associated with the second type of manipulation (e.g., such as the movement of hands 1903 and 1902 in FIG. 19AE), and the second movement exceeds the first movement by more than the first threshold amount of prominence (e.g., the separation movement exceeding the translation movement by a respective amount such that translation movement has a prominence less than prominence threshold 1942b in FIG. 19AE), the computer system performs the second type of manipulation of the first virtual object corresponding to the second movement without performing the first type of manipulation of the first virtual object corresponding to the first movement, such as computer system 101 performing the scaling transformation without performing the rotation transformation in FIG. 19AE. In some embodiments, the first movement, the one or more first input criteria, and the first type of manipulation share one or more characteristics with one or more movements, input criteria, and types of manipulation described herein. In some embodiments, second first movement, the one or more second input criteria, and the second type of manipulation share one or more characteristics with one or more movements, input criteria, and types of manipulation described herein. In some embodiments, the second movement exceeding the first movement by more than the first threshold amount of prominence shares one or more characteristics with the first movement exceeding the second movement by more than the first threshold amount of prominence. In some embodiments, performing the second type of manipulation corresponding to the second movement without performing the first type of manipulation corresponding to the first movement shares one or more characteristics with performing the first type of manipulation corresponding to the first movement without performing the second type of manipulation corresponding to the second movement. In some embodiments, the computer system performs the second type of manipulation of the first virtual object with an amount and/or direction corresponding to a magnitude and/or direction of the second movement.

In some embodiments, in response to detecting the first input, in accordance with a determination that the first input includes the first movement of the first input element and the second input element that satisfies the one or more first input criteria associated with the first type of manipulation, the first input includes the second movement of the first input element and the second input element that satisfies the one or more second input criteria, different from the one or more first input criteria, associated with the second type of manipulation, and the first movement exceeds a second threshold amount of prominence and the second movement exceeds the second threshold amount of prominence (e.g., the translation movement and the separation movement exceeding prominence thresholds 1942a and 1942b in FIGS. 19AB-19AD), the computer system concurrently performs the first type of manipulation of the first virtual object corresponding to the first movement and the second type of manipulation of the first virtual object corresponding to the second movement, such as computer system 101 performing the rotation transformation and the scaling transformation in FIGS. 19AB-AD. In some embodiments, the first movement, the one or more first input criteria, and the first type of manipulation share one or more characteristics with one or more movements, input criteria, and types of manipulation described herein. In some embodiments, second first movement, the one or more second input criteria, and the second type of manipulation share one or more characteristics with one or more movements, input criteria, and types of manipulation described herein. In some embodiments, the second threshold amount of prominence shares one or more characteristics with the first threshold amount of prominence described above. In some embodiments, the second threshold amount of prominence is a predefined criterion (e.g., an absolute value, a ratio, or another quantitative rule) that specifies when both the first movement and the second movement are considered sufficiently prominent for the computer system to apply both corresponding manipulation types to the first virtual object during the same input. For example, the second threshold amount of prominence optionally specifies that respective prominence values of the first and/or second movements exceed a given value on a normalized scale (e.g., greater than 0.1 on a 0-1 scale), exceed a given displacement (e.g., 5 mm, 1 cm, 3 cm, 5 cm, or 10 cm), exceed a given velocity (e.g., 0.01 m/s, 0.05 m/s, 0.10 m/s, or 0.15 m/s), and/or a given ratio (e.g., the lesser of the two prominence values must be at least 5%, 10%, 20%, 35%, or 50% of the greater prominence value).

In some embodiments, performing the first type of manipulation of the first virtual object corresponding to the first movement shares one or more characteristics with performing one or more types of manipulation of the first virtual object corresponding to movement of the first and/or second input elements described herein. In some embodiments, concurrently performing the first and/or second types of manipulation of the first virtual object corresponding to the first and/or second movements includes determining an amount and/or direction of the first and/or second types of manipulation from a magnitude and/or direction of the first and/or second movements. In some embodiments, performing the second type of manipulation of the first virtual object corresponding to the second movement shares one or more characteristics with performing one or more types of manipulation of the first virtual object corresponding to movement of the first and/or second input elements described herein. In some embodiments, the computer system updates the first virtual object with the first and second types of manipulation during the same rendering interval (e.g., concurrently), such that the transformations are applied together, rather than in sequence. For example, when the first movement corresponds to a translation of the first and second input elements above the threshold amount of prominence in the +X direction and the second movement simultaneously corresponds to a translation of the first and second input elements above the threshold amount of prominence in the +Z direction, the computer system concurrently translates the first virtual object in the +X direction and in the +Z direction.

In some embodiments, performing the first type of manipulation of the first virtual object corresponding to the first movement includes, in accordance with a determination that the first movement of the first input element and the second input element is associated with a respective axis that is within a threshold angle of a reference axis associated with the computer system (e.g., axis 1925 being within threshold 1926 in FIG. 19AF), performing the first type of manipulation relative to the reference axis associated with a viewpoint of a user of the computer system (e.g., a reference axis of a head mounted computer system or a head of the user), optionally instead of performing the first type of manipulation relative to the respective axis that is within the threshold angle of the reference axis (e.g., when the reference axis is offset from the reference axis)), such as computer system rotating virtual object 1910 about the X-axis in FIG. 19AF. In some embodiments, the reference axis associated with the computer system is a predetermined (e.g., world-fixed) or dynamically determined (e.g., fixed to an orientation of the computer system, such as a vector normal to a gaze plane of the user or a +Y axis fixed to the computer system) axis to which the computer system compares and/or aligns certain gesture-based manipulations. In some embodiments, the reference axis is determined once at system initialization, updated periodically (e.g., every 10 ms, 30 ms, 70 ms, 150 ms, 500 ms, 1 s, 3 s, or 5 s), and/or recalculated on demand (e.g., in response to detecting an input). In some embodiments, the threshold angle of the reference axis associated with the computer system is an angular tolerance (e.g., 0°, 1°, 5°, 10°, 15°, 25°, or) 45° that the computer system uses to decide whether an axis derived from the first movement (e.g., the respective axis) is close enough to the reference axis so as to perform the first type of manipulation relative to the reference axis rather than relative to the gesture-derived axis itself. In some embodiments, the threshold angle of the reference axis is a variable that is based on one or more characteristics of the first movement (e.g., displacement, rotation, separation, direction, velocity, acceleration, or any weighted combination thereof). In some embodiments, the respective axis associated with the first movement shares one or more characteristics with the first axis between the first input element and the second input element described above. In some embodiments, the respective axis associated with the first movement is an axis that the computer system derives from the concurrent motion of the first input element and the second input element (e.g., by analyzing the direction of the combined displacement of the first and second input elements or the displacement of a midpoint between the first and second elements, the line that connects the positions of the first and second input elements, and/or the normal of a plane defined by the motion trajectories of the first and second input elements) such that the respective axis represents the direction and/or orientation most closely aligned with the first movement itself rather than a pre-defined reference. In some embodiments, performing the first type of manipulation relative to the reference axis associated with the computer system includes the computer system executing the transformation defined by the first movement (e.g., rotation, translation, scaling, or a combination thereof) using a corresponding axis based on the reference axis (or the reference axis itself) as the operative direction and/or pivot, rather than the respective axis derived from the gesture itself. For example, when the reference axis is a Y-axis (or a Y-Z plane) defined by the orientation of the computer system and the first movement corresponds to a rotation movement in a substantially Y-Z plane (e.g., a Y′-Z′ plane within the threshold angle of the reference axis), the computer system rotates the first virtual object about an X-axis defined by the Y-axis (or the Y-Z plane) defined by the orientation of the computer system, and not about an X′-axis defined by the Y′-Z′ plane.

In some embodiments, performing the first type of manipulation of the first virtual object corresponding to the first movement includes, in accordance with a determination that the first movement of the first input element and the second input element is associated with a respective axis that is outside of the threshold angle of the reference axis associated with the computer system (e.g., axis 1925 being outside threshold 1926 in FIG. 19AF), performing the first type of manipulation relative to the respective axis that is outside of the threshold angle of the reference axis associated with viewpoint of the user (e.g., a reference axis of a head mounted computer system or a head of the user), optionally instead of performing the first type of manipulation relative to the reference axis that is within the threshold angle of the reference axis (e.g., when the reference axis is offset from the reference axis)), such as computer system 101 rotating virtual object 1910 about the X-axis in FIG. 19AG. In some embodiments, the respective axis that is outside of the threshold angle of the reference axis shares one or more characteristics with the respective axis that is within the threshold angle of the reference axis described above. In some embodiments, the respective axis being outside of the threshold angle of the reference axis means that the respective axis is outside the angular tolerance that the computer system uses to decide whether the axis derived from the first movement (e.g., the respective axis) is close enough to the reference axis to justify performing the first type of manipulation relative to the reference axis rather than relative to the gesture-derived axis itself. For example, when the reference axis is a Y-axis (or a Y-Z plane) defined by the orientation of the computer system and the first movement corresponds to a rotation movement in a Y′-Z′ plane outside the threshold angle of the reference axis, the computer system rotates the first virtual object about an X′-axis defined by the Y′-Z′ plane, and not about an X-axis defined by the Y-axis (or the Y-Z plane) defined by the orientation of the computer system.

In some embodiments, in response to detecting the first input, in accordance with a determination that the first input includes a first movement of the first input element and the second input element that satisfies one or more first input criteria associated with a first type of manipulation, such as the movement of hands 1902 and 1903 in FIGS. 19AB-19AD, and the first input includes a second movement of the first input element and the second input element that satisfies one or more second input criteria, different from the one or more first input criteria, associated with a second type of manipulation, such as the movement of hands 1902 and 1903 in FIGS. 19AB-19AD, the computer system concurrently performs the first type of manipulation of the first virtual object corresponding to the first movement and the second type of manipulation of the first virtual object corresponding to the second movement, such as computer system 101 concurrently rotating and scaling virtual object 1910 in FIGS. 19AB-19AD. In some embodiments, the first movement, the one or more first input criteria, and the first type of manipulation share one or more characteristics with one or more movements, input criteria, and types of manipulation described herein. In some embodiments, the second movement, the one or more second input criteria, and the second type of manipulation share one or more characteristics with one or more movements, input criteria, and types of manipulation described herein. In some embodiments, concurrently performing the first type of manipulation of the first virtual object corresponding to the first movement and the second type of manipulation of the first virtual object corresponding to the second movement shares one or more characteristics with performing the first and second types of manipulation of the first virtual object corresponding to the first and second movements when the first movement and the second movement exceed the second threshold amount of prominence described above. In some embodiments, the computer system performs the first type of manipulation of the first virtual object with an amount and/or direction corresponding to a magnitude and/or direction of the first movement. In some embodiments, the computer system performs the second type of manipulation of the first virtual object with an amount and/or direction corresponding to a magnitude and/or direction of the second movement. In some embodiments, the computer system concurrently performs the first and second types of manipulation corresponding to the first and second movements regardless of the prominence of the first and/or second movements.

In some embodiments, concurrently performing the first type of manipulation of the first virtual object corresponding to the first movement and the second type of manipulation of the first virtual object corresponding to the second movement includes, in accordance with a determination that the first movement is more prominent than the second movement (e.g., the translation movement being more prominent than the separation movement such that the separation movement is below prominence threshold 1944a in FIG. 19AB), suppressing the performance of the second type of manipulation of the first virtual object corresponding to the second movement, such as computer system 101 suppressing the performance of the scaling transformation on virtual object 1910 in FIG. 19AB. In some embodiments, determining that the first movement is more prominent shares one or more characteristics with the first movement exceeding the second movement by more than the first threshold amount of prominence described above. In some embodiments, suppressing the performance of the second type of manipulation corresponding to the second movement includes, after determining the first movement is more prominent than the second movement, diminishing, limits, and/or nullifies the transformation that would otherwise be produced by the second movement. For example, the computer system optionally scales the parameters of the performance of the second type of manipulation by a fractional gain (e.g., 0.00×, 0.01×, 0.05×, 0.10×, 0.20×, 0.40×, 0.75×, 0.90×, or 0.99×) that is optionally based on the difference between the prominence of the first movement and the prominence of the second movement.

In some embodiments, concurrently performing the first type of manipulation of the first virtual object corresponding to the first movement and the second type of manipulation of the first virtual object corresponding to the second movement includes, in accordance with a determination that the second movement is more prominent than the first movement (e.g., the separation movement being more prominent than the translation movement such that the translation movement is below prominence threshold 1944b in FIG. 19AD), suppressing the performance of the first type of manipulation of the first virtual object corresponding to the first movement, such as computer system 101 suppressing the performance of the rotation transformation on virtual object 1910 in FIG. 19AD. In some embodiments, determining that the second movement is more prominent shares one or more characteristics with the second movement exceeding the first movement by more than the first threshold amount of prominence described above. In some embodiments, suppressing the performance of the first type of manipulation corresponding to the first movement shares one or more characteristics with suppressing the performance of the second type of manipulation corresponding to the second movement. In some embodiments, in accordance with a determination that neither the first movement nor the second movement are more prominent (e.g., the first and second movements are within a threshold amount of prominence with respect to each other), the computer system does not suppress the performance of the first type of manipulation and the second type of manipulation.

In some embodiments, suppressing the performance of the second type of manipulation of the first virtual object corresponding to the second movement includes, while detecting the first input, in accordance with a determination that the second movement has a first degree of prominence relative to a degree of prominence of the first movement (e.g., the separation movement having a degree of prominence relative to the prominence of the translation movement such that the separation movement is below prominence threshold 1942a in FIG. 19AA), suppressing the performance of the second type of manipulation corresponding to the second movement by a first amount in accordance with the first degree of prominence relative to the degree of prominence of the first movement, such as computer system 101 suppressing the scaling transformation as shown by point 1946c having a value corresponding to zero scaling in FIG. 19AA. In some embodiments, the second movement has the first degree of prominence relative to the degree of prominence of the first movement when the computer system quantifies the first and second movements and determines that the prominence of the second movement has a respective relationship to the prominence of the first movement (e.g., a specified difference value, percentage, or ratio of the prominence of the first movement). In some embodiments, upon determining that the second movement exhibits the first degree of prominence relative to the degree of prominence of the first movement, the computer system derives a corresponding first amount of suppression from the first degree of prominence relative to the degree of prominence of the first movement and applies the first amount of suppression such that the second type of manipulation influences the first virtual object to the extent defined by the first amount.

In some embodiments, suppressing the performance of the second type of manipulation of the first virtual object corresponding to the second movement includes, while detecting the first input, in accordance with a determination that the second movement has a second degree of prominence, greater than the first degree of prominence, relative to the degree of prominence of the first movement (e.g., the separation movement having a degree of prominence relative to the prominence of the translation movement such that the separation movement is above prominence threshold 1942a, but below prominence threshold 1944a in FIG. 19AB), suppressing the performance of the second type of manipulation corresponding to the second movement by a second amount, less than the first amount, in accordance with the second degree of prominence relative to the degree of prominence of the first movement, such as computer system 101 suppressing the scaling transformation as shown by point 1946c being below curve 1948c in FIG. 19AB. In some embodiments, the second movement having the second degree of prominence relative to the degree of prominence of the first movement shares one or more characteristics with the second movement having the first degree of prominence relative to the degree of prominence of the first movement. In some embodiments, suppressing the performance of the second type of manipulation corresponding to the second movement by the second amount in accordance with the second degree of prominence relative to the degree of prominence of the first movement shares one or more characteristics with suppressing the performance of the second type of manipulation corresponding to the second movement by the first amount in accordance with the first degree of prominence relative to the degree of prominence of the first movement. For example, when the first degree of prominence is 30% and the second degree of prominence is 50% relative to the degree of prominence of the first movement, the first amount of suppression is optionally 90% and the second amount of suppression is optionally 50% of the performance of the second type of manipulation. In some embodiments, suppressing the performance of the first type of manipulation of the first virtual object corresponding to the first movement includes, in accordance with a determination that the first movement has a first degree of prominence relative to a degree of prominence of the second movement, suppressing the performance of the first type of manipulation corresponding to the first movement by a first amount in accordance with the first degree of prominence relative to the degree of prominence of the second movement. In some embodiments, suppressing the performance of the first type of manipulation of the first virtual object corresponding to the first movement includes, in accordance with a determination that the first movement has a second degree of prominence, greater than the first degree of prominence, relative to the degree of prominence of the second movement, suppressing the performance of the first type of manipulation corresponding to the first movement by a second amount, less than the first amount, in accordance with the second degree of prominence relative to the degree of prominence of the second movement.

In some embodiments, the computer system performs a respective type of manipulation of the first virtual object in response to detecting the first input, including, during a first time period of the first input, in accordance with a determination that movement of the first input element and the second input element that satisfies the one or more first input criteria is more prominent than movement of the first input element and the second input element that satisfies the one or more second input criteria (e.g., the translation movement being more prominent than the separation movement in FIG. 19AA), forgoing performing (e.g., suppressing or continuing to suppress the performance of) the second type of manipulation of the first virtual object, such as computer system 101 forgoing scaling virtual object 1910 in FIG. 19AA. In some embodiments, the first time period of the first input is a segment (e.g., 10 ms, 30 ms, 70 ms, 150 ms, 500 ms, 1 s, or 3 s) of the overall interval during which the first input is active. In some embodiments, determining that movement of the first input element and the second input element that satisfies the one or more first input criteria is more prominent than movement of the first input element and the second input element that satisfies the one or more second input criteria shares one or more characteristics with determining that the first movement exceeds the second movement by more than a first threshold amount of prominence described above. In some embodiments, suppressing the performance of the second type of manipulation of the first virtual object shares one or more characteristics with the suppressing the performance of the second type of manipulation of the first virtual object corresponding to the second movement described above.

In some embodiments, the computer system performs a respective type of manipulation of the first virtual object in response to detecting the first input, including, during a first time period of the first input, in accordance with a determination that the movement of the first input element and the second input element that satisfies the one or more second input criteria is more prominent than the movement of the first input element and the second input element that satisfies the one or more first input criteria (e.g., the separation movement being more prominent than the translation movement in FIG. 19AE), performing (e.g., ceasing to suppress the performance of) the second type of manipulation of the first virtual object (and optionally suppressing the performance of the first type of manipulation of the first virtual object), such as computer system 101 performing scaling and forgoing rotating virtual object in FIG. 19AE. In some embodiments, determining that movement of the first input element and the second input element that satisfies the one or more second input criteria is more prominent than movement of the first input element and the second input element that satisfies the one or more first input criteria shares one or more characteristics with determining that the second movement exceeds the first movement by more than a first threshold amount of prominence described above. In some embodiments, ceasing to suppress the performance of the second type of manipulation of the first virtual object means the computer system stops applying the attenuation measures previously applied to the performance of the second type of manipulation such that the transformation associated with the second movement is thereafter applied to the first virtual object according to the non-suppressed mapping rules (e.g., with no intentional reduction in gain or rate).

In some embodiments, the computer system performs a respective type of manipulation of the first virtual object in response to detecting the first input, including, during a second time period of the first input, after the first time period of the first input, in accordance with a determination that movement of the first input element and the second input element that satisfies the one or more first input criteria is more prominent than movement of the first input element and the second input element that satisfies the one or more second input criteria (e.g., the translation movement being more prominent than the separation movement in FIG. 19AA), forgoing performing (e.g., suppressing or continuing to suppress the performance of) the second type of manipulation of the first virtual object, such as computer system 101 forgoing scaling virtual object 1910 in FIG. 19AA. In some embodiments, the second time period shares one or more characteristics with the first time period. In some embodiments, the second time period occurs immediately after the first time period ends. In some embodiments, the second time period occurs after the first time period but with a third time period in between the first time period and the second time period. In some embodiments, determining that movement of the first input element and the second input element that satisfies the one or more first input criteria is more prominent than movement of the first input element and the second input element that satisfies the one or more second input criteria shares one or more characteristics with determining that the first movement exceeds the second movement by more than a first threshold amount of prominence described above. In some embodiments, suppressing the performance of the second type of manipulation of the first virtual object shares one or more characteristics with suppressing the suppressing the performance of the second type of manipulation of the first virtual object corresponding to the second movement described above.

In some embodiments, the computer system performs a respective type of manipulation of the first virtual object in response to detecting the first input, including, during a second time period of the first input, after the first time period of the first input, in accordance with a determination that the movement of the first input element and the second input element that satisfies the one or more second input criteria is more prominent than the movement of the first input element and the second input element that satisfies the one or more first input criteria (e.g., such as the separation movement being more prominent than the translation movement in FIG. 19AE), performing (e.g., ceasing to suppress the performance of) the second type of manipulation of the first virtual object (and optionally suppressing the performance of the first type of manipulation of the first virtual object), such as computer system 101 scaling the virtual object and forgoing rotating virtual object in FIG. 19AE. In some embodiments, determining that movement of the first input element and the second input element that satisfies the one or more second input criteria is more prominent than movement of the first input element and the second input element that satisfies the one or more first input criteria shares one or more characteristics with determining that the second movement exceeds the first movement by more than a first threshold amount of prominence described above. In some embodiments, ceasing to suppress the performance of the second type of manipulation of the first virtual object means the computer system stops applying the attenuation measures previously applied to the performance of the second type of manipulation such that the transformation associated with the second movement is thereafter applied to the first virtual object according to the non-suppressed mapping rules (e.g., with no intentional reduction in gain or rate). In some embodiments, the computer system re-evaluates which component of the first input (e.g., which of the movements of the first and second input element that satisfy the one or more first and/or second input criteria) is prominent periodically (e.g., based on a 70 ms rolling window).

In some embodiments, while displaying, via the one or more display generation components, the first virtual object in the three-dimensional environment, the computer system detects, via the one or more input devices, a second input directed to the first virtual object, wherein the second input includes translation movement of the first input element and the second input element corresponding to a translation input, such as computer system 101 detecting translation movement of hands 1902 and 1903 in FIGS. 19L-19M. In some embodiments, the second input including translation movement of the first input element and the second input element corresponding to the translation input shares one or more characteristics with one or more inputs including translation movement of the first input and/or the second input element corresponding to translation input described above.

In some embodiments, in response to detecting the second input, in accordance with a determination that translation is suppressed for the first virtual object (e.g., setting 1930 being active in FIG. 19M), the computer system rotates the first virtual object in accordance with the translation movement of the first input element and the second input element in the second input (e.g., rotating the first virtual object with a direction of rotation based on a direction of the translation movement of the first input element and the second input element and/or with a magnitude of rotation based on a magnitude of the translation movement of the first input element and the second input element), such as computer system 101 rotating virtual object 1910 in accordance with the translation movement of hands 1902 and 1903 in FIG. 19M. In some embodiments, translation of the first virtual object being suppressed refers to a property or state of the first virtual object (e.g., a “translation-locked” flag set by an application or developer) that disables positional displacement in one or more translational directions such that detected translation movement in said one or more translational directions is redirected to a different manipulation mode (e.g., rotation). In some embodiments, translation being suppressed shares one or more characteristics with translation being suppressed described above. In some embodiments, rotating the first virtual object in accordance with the translation movement of the first input element and the second input element in the second input shares one or more characteristics with rotating the first virtual object in accordance with one or more translation movements of the first and second input elements described above.

In some embodiments, in response to detecting the second input, in accordance with a determination that translation is not suppressed for the first virtual object (e.g., setting 1930 not being active in FIG. 19L), the computer system translates the first virtual object in accordance with the translation movement of the first input element and the second input element in the second input (e.g., translating the first virtual object with a direction of translating based on a direction of the translation movement of the first input element and the second input element and/or with a magnitude of translating based on a magnitude of the translation movement of the first input element and the second input element), such as computer system 101 translating virtual object 1910 in accordance with the translation movement of hands 1902 and 1903 in FIG. 19L. In some embodiments, translating the first virtual object in accordance with the translation movement of the first input element and the second input element in the second input shares one or more characteristics with translating the first virtual object in accordance with one or more translation movements of the first and second input elements described above.

It should be understood that the particular order in which the operations in method 2000 have been described is merely exemplary and is not intended to indicate that the described order is the only order in which the operations could be performed. One of ordinary skill in the art would recognize various ways to reorder the operations described herein. In some embodiments, aspects/operations of method 2000 may be interchanged, substituted, and/or added between these methods. For example, various object manipulation techniques and/or object movement techniques of method 2000 are optionally interchanged, substituted, and/or added between these methods. For brevity, these details are not repeated here.

The flowchart and block diagrams in the figures illustrate the architecture, functionality, and operation of possible implementations of systems, methods, and computer readable media according to various examples of the present disclosure. In this regard, each block in the flowchart or block diagrams may represent a module, segment, or portion of instructions, which comprises one or more executable instructions for implementing the specified logical function(s) as described herein. In some implementations, the functions noted in the blocks may occur out of the order shown and noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In some embodiments, aspects/operations of methods 800, 900, 1000, 1100, 1200, 1300, 1600, 1800, and/or 2000 may be interchanged, substituted, and/or added between these methods. For example, the characteristics of the computer system, input devices including controllers, and/or display generation components of 800, 900, 1000, 1100, 1200, 1300, 1600, 1800, and/or 2000, the characteristics of the input to the computer system of methods 800, 900, 1000, 1100, 1200, 1300, 1600, 1800, and/or 2000, the types of input to the computer system, including the types of input gestures and/or detected motion of the input devices of methods 800, 900, 1000, 1100, 1200, 1300, 1600, 1800, and/or 2000, the virtual objects of methods 800, 900, 1000, 1100, 1200, 1300, 1600, 1800, and/or 2000, the content that is interacted with in methods 800, 900, 1000, 1100, 1200, 1300, 1600, 1800, and/or 2000, the interactions with virtual objects in methods 800, 900, 1000, 1100, 1200, 1300, 1600, 1800, and/or 2000, and/or the three-dimensional environments of methods 800, 900, 1000, 1100, 1200, 1300, 1600, 1800, and/or 2000, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-32. (canceled)

33. A method comprising:
at a computer system in communication with one or more input devices and one or more display generation components:
while displaying, via the one or more display generation components, a virtual object within a three-dimensional environment, detecting, via the one or more input devices, a first input provided by an input element, wherein a center of movement associated with the virtual object and an input center associated with the input element are separated by a first distance when a first portion of the first input is detected; and
while detecting, via the one or more input devices, a second portion of the first input, after the first portion of the first input, that includes movement of the input element, in accordance with a determination that the movement of the input element satisfies one or more first criteria, as the input center associated with the input element moves, moving the virtual object relative to the input center associated with the input element in a manner that is selected so as to reduce a distance between the center of movement of the virtual object and the input center associated with the input element to less than the first distance.

34. The method of claim 33, wherein the input center associated with the input element corresponds to a location in the three-dimensional environment associated with a plurality of fingers forming an air gesture.

35. The method of claim 33, wherein center of movement corresponds to a virtual handle associated with moving the virtual object relative to the three-dimensional environment.

36. The method of claim 33, wherein the center of movement is associated with a selection region of the virtual object.

37. The method of claim 33, wherein:
the movement of the input element in the second portion of the first input includes a first amount of movement, and
in response to detecting the first amount of movement the virtual object is moved with a second amount less than the first amount of movement.

38. The method of claim 37, wherein moving the virtual object with the second amount less than the first amount of movement includes:
while an amount of the movement of the input element included in the second portion of the first input is less than a threshold amount of movement, forgoing moving of the virtual object; and
in response to detecting the amount of the movement of the input element in the second portion of the first input being greater than the threshold amount of movement, initiating the moving of the virtual object relative to the input center.

39. The method of claim 38, wherein:
in accordance with a determination that a value of a virtual parameter associated with the virtual object is a first value, the threshold amount of movement is a first threshold magnitude, and
in accordance with a determination that the value of the virtual parameter associated with the virtual object is a second value, different from the first value, the threshold amount of movement is a second threshold magnitude, different from the first threshold magnitude.

40. The method of claim 39, wherein in accordance with a determination that the value of the virtual parameter associated with the virtual object is a third value, different from the second value and different from the first value, the threshold amount of movement is a third threshold magnitude, different from the second threshold magnitude and different from the first threshold magnitude.

41. The method of claim 39, wherein the virtual parameter is associated with a size of the virtual object relative to the three-dimensional environment.

42. The method of claim 39, wherein the virtual parameter is associated with a simulated mass of the virtual object.

43. The method of claim 40, wherein the second portion of the first input includes a translation component and a rotation component, and wherein moving the virtual object with the second amount less than the first amount of movement includes:
translating the virtual object in accordance with less than the translation component of the second portion of the first input that includes movement of the input element; and
rotating the virtual object in accordance with the rotation component of the second portion of the first input.

44. The method of claim 33, including:
while an amount of the movement of the second portion of the first input is below a threshold amount of movement, moving the virtual object relative to the input center at a first rate of movement relative to the movement of the input element; and
wherein moving the virtual object relative to the input center associated with the input element in a manner that is selected so as to reduce a distance between the center of movement of the virtual object and the input center associated with the input element to less than the first distance comprises, in response to detecting that the amount of the movement of the second portion of the first input is above the threshold amount of movement, moving the virtual object relative to the input center at a second rate of movement, greater than the first rate of movement, relative to the movement of the input element.

45. The method of claim 44, wherein the center of movement of the virtual object and the input center associated with the input element correspond to a same location in the three-dimensional environment while a respective portion of the second portion of the first input is being detected.

46. The method of claim 44, wherein moving the virtual object in accordance with the movement of the input element comprises changing, over time, a rate of movement of the virtual object toward the input element relative to the movement of the input element.

47. The method of claim 46, wherein the second portion of the first input includes a respective first portion and a respective second portion, wherein the respective first portion occurs prior to the respective second portion, and wherein changing the rate of movement of the virtual object toward the input element relative to the movement of the input element over time comprises:
in response to detecting the first respective portion of the second portion of the first input, increasing the rate of movement of the virtual object toward the input element relative to the movement of the input element over time.

48. The method of claim 46, wherein the second portion of the first input includes a first respective portion and a second respective portion, wherein the first respective portion occurs prior to the second respective portion, and wherein changing the rate of movement of the virtual object toward the input element relative to the movement of the input element over time comprises:
in response to detecting the second respective portion of the second portion of the first input, decreasing the rate of movement of the virtual object toward the input element relative to the movement of the input element over time.

49. The method of claim 44, wherein moving the virtual object relative to the input center associated with the input element in a manner that is selected so as to reduce the distance between the center of movement of the virtual object and the input center associated with the input element to less than the first distance comprises:
in accordance with a determination that the distance between the center of the movement of the virtual object and the input center associated with the input element is the first distance when the first input is detected, moving the virtual object a second distance per unit of movement of the input element; and
in accordance with a determination that the distance between the center of the movement of the virtual object and the input center associated with the input element is a third distance when the first input is detected, different than the first distance, moving the virtual object by a fourth distance per unit of movement of the input element, different than the second distance per unit of movement of the input element.

50. The method of claim 33, wherein the movement of the input element of the second portion of the first input is in a first direction, wherein the first input includes a third portion that includes movement of the input element in a second direction, different from the first direction occurring after the first portion and the second portion, and wherein the method further comprises:
while displaying, via the one or more display generation components, the virtual object within the three-dimensional environment, after moving the virtual object in response to detecting the second portion of the first input in accordance with the determination that the movement of the input element satisfies the one or more first criteria, and in response to detecting, via the one or more input devices, the third portion of the first input:
moving the virtual object relative to the input center associated with the input element in a manner that does not reduce the distance between the center of movement of the virtual object and the input center associated with the input element.

51. The method of claim 50, wherein moving the virtual object in the manner that does not reduce the distance between the center of movement of the virtual object and the input center associated with the input element includes increasing the distance between the center of movement of the virtual object and the input center associated with the input element.

52. The method of claim 33, wherein:
the movement of the input element of the second portion of the first input is in a first direction, wherein the first input includes a third portion that includes movement of the input element in a second direction, different from the first direction occurring after the first portion and the second portion, and wherein the method further comprises:
while displaying, via the one or more display generation components, the virtual object within the three-dimensional environment, after moving the virtual object in response to detecting the second portion of the first input in the manner that is selected to reduce the distance between the distance between the center of movement of the virtual object and the input center associated with the input element, detecting, via the one or more input devices, the third portion of the first input; and
in response to detecting the third portion of the first input, moving the virtual object in accordance with the third portion of the first input, in a manner that is selected so as to maintain the distance between the movement of the virtual object and the input center associated with the input element.

53. The method of claim 33, wherein the movement of the input element of the second portion of the first input is in a first direction, wherein the first input includes a third portion that includes movement of the input element in a second direction, different from the first direction occurring after the first portion and the second portion, and wherein the method further comprises:
while displaying, via the one or more display generation components, the virtual object within the three-dimensional environment, after moving the virtual object in response to detecting the second portion of the first input in accordance with the determination that the movement of the input element satisfies the one or more first criteria, and in response to detecting, via the one or more input devices, the third portion of the first input:
in accordance with a determination that the moving of the virtual object in accordance with the second portion of the first input includes moving the virtual object to an updated location where the center of movement corresponds to the location of the input center, moving the virtual object in a respective first manner that is selected so as to maintain the distance between the center of movement of the virtual object and the input center; and
in accordance with a determination that the moving of the virtual object in accordance with the second portion of the first input includes moving the virtual object to an updated location where the center of movement is different from the location of the input center, moving the virtual object in a respective second manner, different from the respective first manner, that is selected so as to increase the distance between the center of movement of the virtual object and the input center.

54. A computer system that is in communication with one or more display generation components and one or more input devices, the computer system comprising:
one or more processors;
memory; and
one or more programs, wherein the one or more programs are stored in the memory and configured to be executed by the one or more processors, the one or more programs including instructions for:
while displaying, via the one or more display generation components, a virtual object within a three-dimensional environment, detecting, via the one or more input devices, a first input provided by an input element, wherein a center of movement associated with the virtual object and an input center associated with the input element are separated by a first distance when a first portion of the first input is detected; and
while detecting, via the one or more input devices, a second portion of the first input, after the first portion of the first input, that includes movement of the input element, in accordance with a determination that the movement of the input element satisfies one or more first criteria, as the input center associated with the input element moves, moving the virtual object relative to the input center associated with the input element in a manner that is selected so as to reduce a distance between the center of movement of the virtual object and the input center associated with the input element to less than the first distance.

55. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the one or more display generation components, a virtual object within a three-dimensional environment, detecting, via the one or more input devices, a first input provided by an input element, wherein a center of movement associated with the virtual object and an input center associated with the input element are separated by a first distance when a first portion of the first input is detected; and
while detecting, via the one or more input devices, a second portion of the first input, after the first portion of the first input, that includes movement of the input element, in accordance with a determination that the movement of the input element satisfies one or more first criteria, as the input center associated with the input element moves, moving the virtual object relative to the input center associated with the input element in a manner that is selected so as to reduce a distance between the center of movement of the virtual object and the input center associated with the input element to less than the first distance.

56-260. (canceled)
